SEQUENCE LISTING (18 sequences)

SEQ ID NO: 1 - protein, 373 aa, Artificial Sequence
  amino acid sequence of ADV resistant HBV polymerase
NSKPCSDYCLSHIVNLLEDWGPCAEHGEHHIRIPRTPARVTGGVFLVDKNPHNTAESRLVVDFSQFSRGNYRVSWPKFAVPNLQSLTNLLSSNLSWLSLDVSAAFYHLPLHPAAMPHLLVGSSGLSRYVARLSSNSRIFNYQHGTMQNLHDSCSRNLYVSLLLLYQTFGRKLHLYSHPIILGFRKIPMGVGLSPFLLAQFTSAICSVVRRAFPHCLAFSYMDDVVLGAKSVQHLESLFTAVTNFLLSLGIHLNPNKTKRWGYSLHFMGYVIGCYGSLPQDHIIQKIKECFRKLPVNRPIDWKVCQRIVGLLGFAAPFTQCGYPALMPLYACIQSKQAFTFSPTYKAFLCKQYLNLYPVARQRPGLCQVFADAT

SEQ ID NO: 2 - protein, 12 aa, Artificial Sequence
  amino acid sequence of motif 1 from HBV
GGVFLVDKNPHN

SEQ ID NO: 3 - protein, 12 aa, Artificial Sequence
  amino acid sequence of motif 1 from WHV
GGVFLVDKNPNN

SEQ ID NO: 4 - protein, 12 aa, Artificial Sequence
  amino acid sequence of motif 1 from DHBV
GRLFLVDKNSRN

SEQ ID NO: 5 - protein, 10 aa, Artificial Sequence
  amino acid sequence of motif 1 from HIV
TPVFAIKKKD

SEQ ID NO: 6 - protein, 11 aa, Artificial Sequence
  amino acid sequence of motif 2 from HBV
TTESRLVVDFS

SEQ ID NO: 7 - protein, 11 aa, Artificial Sequence
  amino acid sequence of motif 2 from WHV
SSESRLVVDFS

SEQ ID NO: 8 - protein, 11 aa, Artificial Sequence
  amino acid sequence of motif 2 from DHBV
TTEARLVVDFS

SEQ ID NO: 9 - protein, 11 aa, Artificial Sequence
  amino acid sequence of motif 2 from HIV
STKWRKLVDFR

SEQ ID NO: 10 - protein, 11 aa, Artificial Sequence
  amino acid sequence of motif 2 from PV
QGKSRLIEASS

SEQ ID NO: 11 - protein, 12 aa, Artificial Sequence
  amino acid sequence of motif 2 from HCV
GRKPARLIVFPD

SEQ ID NO: 12 - protein, 12 aa, Artificial Sequence
  amino acid sequence of motif 2 from DEN
RAKGSRAIWYMW

SEQ ID NO: 13 - protein, 12 aa, Artificial Sequence
  amino acid sequence of motif 2 from BVDV
VEKRPRVIQYPE

SEQ ID NO: 14 - protein, 12 aa, Artificial Sequence
  amino acid sequence of motif 2 from Sindbis
HTEERPKVQVIQ

SEQ ID NO: 15 - protein, 12 aa, Artificial Sequence
  amino acid sequence of motif 2 from HBV
PQKSLDHSWWTS

SEQ ID NO: 16 - protein, 10 aa, Artificial Sequence
  amino acid sequence of motif 2 from WHV
AQNLDWWWTS

SEQ ID NO: 17 - protein, 10 aa, Artificial Sequence
  amino acid sequence of motif 2 from DHBV
LRRLDWWWIS

SEQ ID NO: 18 - protein, 373 aa, Artificial Sequence; identical to SEQ ID NO: 1
  amino acid sequence showing the primary and secondary mutative binding sites for nucleoside and nucleotide analogs

(19) United States
(12) Patent Application Publication
(10) Pub. No.: US 2006/0190186 A1
(43) Pub. Date: Aug. 24, 2006

(54) Viral polymerase and modulation thereof

(75) Inventors: Angeline Ingrid Bartholomeusz, Carnegie (AU); David Chalmers, North Fitzroy (AU); Mike Kuiper, Carlton South (AU); Ben Tehan, Harlow (GB)

Correspondence Address: BAKER & BOTTS, 30 ROCKEFELLER PLAZA, 44TH FLOOR, NEW YORK, NY, 10112, US

(73) Assignee: Melbourne Health, Parkville (AU)

(21) Appl. No.: 11/301,314

(22) Filed: Dec. 12, 2005

Related U.S. Application Data
(63) Continuation of application No. PCT/AU04/00781, filed on Jun. 11, 2004.

(30) Foreign Application Priority Data
Jun. 13, 2003 (AU) 2003902983

(51) Int. Cl. G06F 19/00

(52) U.S. Cl. 702/19

(57) ABSTRACT

The present invention provides the tertiary structure of a Hepatitis B Virus (HBV) polymerase reverse transcriptase (rt) domain from which a variant HBV polymerase mutations associated with resistance to or having reduced sensitivity to an anti-viral drug have been mapped. The present invention further provides methods of identifying, designing and/or modifying agents capable of modulating the functional activity of the HBV polymerase based on the atomic co-ordinates provided by the tertiary structure. The present invention still further provides a method of modulating HBV polymerase functional activity and agents useful for same. The agents identified in accordance with the method of the present invention are particularly useful inter alia in the treatment and/or prophylaxis of infection by an HBV resistant to or exhibiting reduced sensitivity to an anti-viral drug. The agents may also have utility as diagnostic agents such as to distinguish between resistance mutations. Furthermore, the present invention enables responses of particular potential anti-viral drugs to be predicted. In addition, new targets within the polymerase have been identified.

### CROSS-REFERENCE TO RELATED APPLICATIONS

This application is a continuation of International Patent Application No. PCT/AU2004/000781 filed Jun. 11, 2004, which published in English and designated the United States, and which claims priority to Australian Patent Application No. 2003902983 filed Jun. 13, 2003.

### BACKGROUND OF THE INVENTION

1. Field of the Invention

The present invention provides the tertiary structure of a Hepatitis B Virus (HBV) polymerase reverse transcriptase (rt) domain from which a variant HBV polymerase mutations associated with resistance to or having reduced sensitivity to an anti-viral drug have been mapped. The present invention further provides methods of identifying, designing and/or modifying agents capable of modulating the functional activity of the HBV polymerase based on the atomic co-ordinates provided by the tertiary structure. The present invention still further provides a method of modulating HBV polymerase functional activity and agents useful for same. The agents identified in accordance with the method of the present invention are particularly useful inter alia in the treatment and/or prophylaxis of infection by an HBV resistant to or exhibiting reduced sensitivity to an anti-viral drug. The agents may also have utility as diagnostic agents such as to distinguish between resistance mutations. Furthermore, the present invention enables responses of particular potential anti-viral drugs to be predicted. In addition, new targets within the polymerase have been identified.

2. Description of the Prior Art

Bibliographic details of the publications referred to in this specification are also collected at the end of the description.

Reference to any prior art in this specification is not, and should not be taken as, an acknowledgment or any form of suggestion that this prior art forms part of the common general knowledge in any country.

HBV is the leading cause of chronic hepatitis throughout the world. Notwithstanding the availability of a safe and effective vaccine, the world prevalence of HBV has not declined significantly thus resulting in the need for selective anti-viral agents. HBV is a small, partially double-stranded DNA virus which replicates through an RNA intermediate. Most efforts to develop anti-HBV agents have been targeted to the viral DNA polymerase which possesses reverse transcriptase activity. Currently, the most promising anti-HBV agents are nucleoside analogs which interfere with viral DNA replication. Although earlier nucleoside analogs such as fialuridine (FIAU) have displayed unacceptable toxicities, newer analogs such as lamivudine (3TC/LMV), BMS-200,475 and Adefovir Dipivoxial (ADV) have demonstrated clinical utility. In particular, the use of LMV has generated considerable interest in the development of other L-enantiomeric nucleoside analogs for use against HBV.

To date, small molecules have been screened for activity against the HBV polymerase utilizing in vitro assays. Although such screening technology facilitates the preliminary identification of molecules exhibiting anti-viral activity, such technology provides no scope for rationally designing or modifying agents to bind to the polymerase of the virus in order to maximize its functional impact. Rational design requires a detailed knowledge of the tertiary structure of the polymerase and in particular the nucelotide binding pocket.

To date, a number of polymerase molecules have been crystallized Klenow fragment of Escherichia coli DNA polymerase I, HIV-1 reverse transcriptase and bacteriophage T7 RNA polymerase (Sawaya et al., Science 264: 1930-1935, 1994). Several groups have developed structural models of HBV polymerase based on homology with the human immunodeficiency virus (HIV) reverse transcriptase (Bartholomeusz et al., Viral Hepatitis reviews 4: 167-187, 1998; Allen et al., Hepatology 27(6): 1670-1677, 1998; Das et al., V. Virol. 75(10): 4771-4779, 2001; Sawaya, 1994, supra). HIV polymerase and the resulting HBV models are described as having a “right hand structure”. The palm subdomain (FIG. 1, 1) of all polymerases has significant amino acid homology. The two conserved aspartic acid residues of the YMDD motif (FIG. 2, 2) in the C domain form part of a β-turn (Rodgers et al., Proc. Natl. Acad. Sci. USA 92(4): 1222-1226, 1995). The conserved aspartic acid residue within the A domain (FIG. 1, 3) is in close proximity to the two aspartic acid residues in the β-turn and together they form part of the active site. In HIV, this active site is part of a cavity which is bordered on one side by an alpha helix which is comprised of the conserved amino acid residues of the Domain B. These amino acid residues of the α helix are positioned near the template strand of the bound template-primer and form part of the template grip of Domain B (103, 104, 105). Wrobel et al. (Proc. Natl. Acad. Sci. USA 95(2): 638-645, 1998) examined the genetic variability of a number of HIV strains compared to the X-ray crystal structure. They found the residues predicted to be external were highly variable and the functional/catalytic residues (especially in the predicted nucleotide binding pocket) were highly conserved between the different HIV strains.

In facilitating the design or modification of HBV polymerase modulatory agents, knowledge of the primary, and even secondary structure, of the amino acid sequence of the protein is insufficient. Rather, it is necessary to know the precise tertiary structure of the subject viral polymerase in order to determine the residues critical to functions such as template binding and dNTP binding. Accordingly, there is a need to elucidate the structure of HBV polymerases from HBV agents resistant to particular nucleoside analogs in order to facilitate both small molecule screening and rational drug design/modification for the purpose of modulating the activity of such polymerases and thereby providing agents for therapeutic and/or prophylactic use in conditions such as infections by HBV agents which have become unresponsive to anti-viral agents such as ADV.

Recently, LMV was approved to treat chronic HBV infection (Dienstag, et al., N. Engl. J. Med. 341: 1256-1263, 1999). LMV is a dideoxycytidine analog that is active against human immunodeficiency virus (HIV) and HBV (Coates, et al., Antimicrob. Agents Chemother. 36: 733-739, 1992; Doong, et al., Proc. Natl. Acad. Sci. USA 88: 8495-8499, 1991). It is also shown that LMV acts as a chain terminator against viral DNA synthesis (Zhu, et al., Antimicrob. Agents Chemother. 42: 1805-1810, 1998). However, prolonged LMV treatment results in the emergence of LMV-resistant HBV mutants in 17 to 46% of patients treated for one year and more than 50% of patients within two years of treatment (Allen et al., Hepatology 27: 1670-1677, 1998; Dienstag, et al., 1998, supra; Jarvis and Faulds, Drugs 58: 101-141, 1999; Liaw, et al., Hepatology 30: 567-572, 1999). The emergence of drug-resistant HBV emphasizes the need to develop other anti-viral agents and therapeutic strategies.

In HBV, LMV resistance has been well documented and is primarily associated with changes at rtM204I/V (C domain) in combination with rtL180M (B domain) of the HBV polymerase. A number of other amino acid changes in the HBV polymerase have also been selected during LMV treatment and also Famciclovir (FCV) treatment.

ADV resistance has been recently described in HBV infected patients and this has been confirmed in vitro. ADV resistance was associated with mutations at rtN236T (Domain D) +/−rtA181V/T (Domain B). The modeling of these mutations within the polymerase is described.

Entecavir (ETV) resistance has also been identified two patients. In the first patient, this was associated with mutations at rtA38E, rtT184G (B domain) and rtS202I (C domain) in addition to the LMV resistant mutations at rtM204V and rtL80M. Phenotypic anti-viral testing revealed reduced ETV susceptibility when both the rtT184G and rtS202I changes were combined with the LMV-R mutations. In the second patient, ETV resistant mutations at rtI169T (B Domain) and rtM250V (E Domain) as well as the LMV resistant mutations rtL180M, rtM204V and rtV173V/L were detected.

Furthermore, the tertiary structure of the rt domain of wild-type HBV polymerase has been elucidated. The elucidation of this unique tertiary structure enables the rational analysis, design and/or modification of agents for use in modulating the functional activity of this anti-viral agent resistant HBV polymerase. This rational design is based on mapping of particular mutations to the wild-type HBV polymerase structure. This enables identification of agents capable of interacting with any HBV polymerase from an HBV such as HBV resistant to or exhibiting reduced sensitivity to an anti-viral drug such as a nucleoside analog. The present invention further enables mapping to other areas of an anti-viral drug binding pockets. In addition, the model can be used to identify other regions that are useful targets for anti-viral agents.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

Nucleotide and amino acid sequences are referred to by a sequence identifier number (SEQ ID NO:). The SEQ ID NOs: correspond numerically to the sequence identifiers <400>1 (SEQ ID NO:1), <400>2 (SEQ ID NO:2), etc. A summary of the sequence identifiers is provided in Table 1. A sequence listing is provided after the claims.

Specific mutations in an amino acid sequence are represented herein as “Xaa₁nXaa₂” where Xaa₁ is the original amino acid residue before mutation, n is the residue number and Xaa₂ is the mutant amino acid. The abbreviation “Xaa” may be the three letter or single letter (i.e. “X”) code. An “rt” before “Xaa₁nXaa₂” means “reverse transcriptase”. An “s” means an envelope gene. The amino acid residues for HBV DNA polymerase are numbered with the residue methionine in the motif Tyr Met Asp Asp (YMDD) being residue number 204 (Stuyver et al., Hepatology 33: 751-757, 2001). The amino acid residues for hepatitis B virus surface antigen are number according to Norder et al. (J. Gen. Virol. 74: 341-1348, 1993). Both single and three letter abbreviations are used to define amino acid residues and these are summarized in Table 2.

The present invention is predicated in part on the elucidation of the tertiary structure of the rt domain of wild-type HBV polymerase. The tertiary structure of the rt domain is defined by a data set of atomic co-ordinates presented in Table 6. This elucidated structure provides the molecular basis for mapping resistance to nucleoside analogs or other anti-viral agents and, therefore, permits the identification, screening, analysis, rational design and/or modification of agents which interact with a particular HBV polymerase and optionally modulate the functional activity of the HBV polymerase. These agents may be used inter alia as either agonists or antagonists in the therapy and prophylaxis of infection by an HBV resistant to or exhibiting reduced sensitivity to an anti-viral agent. They may also be used as diagnostic agents such as having a capacity to distinguish between variant HBV polymerases having different or similar resistances to anti-viral drugs.

Accordingly, one aspect of the present invention is directed to a data set of atomic co-ordinates from a reverse transcriptase (rt) domain of an HBV polymerase, wherein said atomic co-ordinates are as set forth in Table 6.

Another aspect of the present invention is directed to a method of identifying an agent capable of interacting with an HBV polymerase or a homolog, derivative, analog or fragment thereof and modulating at least one functional activity associated with said polymerase, said method comprising contacting said polymerase with an agent and assessing the degree of interactive complementarity of said agent with said polymerase.

In one preferred embodiment, mutations in an HBV polymerase are mapped to the wild-type rt domain mutant HBV polymerase and generally have at least one of the following characteristics:
(i) displays increased resistance to a nucleoside analog such as but not limited to ADV, LMV, FCV, FTC, ETV, DAPD, TDF and DXG compared to native HBV polymerase;
(ii) comprises a mutation within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R17I, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion; and/or
(iii) comprises the amino acid sequence set forth in SEQ ID NO:1 or an amino acid sequence defining an HBV polymerase and having a sequence which is at least 70% similar after optimal alignment to SEQ ID NO:1.

The present invention further identifies the primary and second amino acid residues in the HBV polymerase involved in nucleoside or nucleotide analog binding. The primary residues are at position numbers 28-36, 39-45, 59-66, 69-70, 73-93, 167-184, 198-213, 230-241 and 245-257 (FIG. 16). The secondary residues are at position numbers 4-10, 24-27, 46-58, 67-68, 71-72, 94-120, 165-166, 185-197, 214-227, 242-244 and 258-266 (FIG. 16).

Accordingly, the present invention extends to any mutation within amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 which confer resistance or reduced sensitivity to any anti-viral drug such as a nucleoside or nucleotide analog.

One particularly exemplified HBV polymerase is resistant to ADV and is mapped to the tertiary structure of the wild-type HBV polymerase.

Another aspect of the present invention provides a computer-assisted method for identifying agents potentially able to bind to a domain of HBV polymerase and optionally modulate at least one functional activity of the HBV polymerase using a programmed computer comprising the steps of:
(a) inputting into the progammed computer data comprising the atomic co-ordinates of an HBV polymerase having a mutation within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
(b) generating, using computer methods, a set of atomic co-ordinates of a structure that possesses stereochemical complementarity to the atomic co-ordinates defined in (a) or a subset thereof, thereby generating a criteria data set;
(c) comprising, using the processor, the criteria data set to a computer database of chemical structures;
(d) selecting from the database, using computer methods, chemical structures which are similar to a portion f said criteria data set; and
(e) outputting the selected chemical structures which are similar to a portion of the criteria data set.

Preferably, the method further comprises the step of obtaining an agent with a chemical structure selected in steps (d) and (e) and testing the compound for the ability to modulate at least one functional activity of an HBV polymerase.

Yet another aspect of the present invention provides a computer or a software component thereof for producing a three-dimensional representation of a molecule or molecular complex, which comprises a three-dimensional representation of a homolog of the molecule or molecular complex, in which the homolog comprises a domain that has a root mean square deviation from the backbone atoms of the amino acids of not more than 1.5 Å, in which the computer comprises:
(a) a machine-readable data storage medium comprising a data storage material encoded with machine-readable data, wherein the data comprises the structure co-ordinates of an HBV polymerase having a mutation within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
(b) a working memory for storing instructions for processing the machine-readable data;
(c) a central-processing unit coupled to the working memory and to the machine-readable data storage medium for processing the machine-readable data into the three-dimensional representation; and
(d) a display coupled to the central-processing unit for displaying the three-dimensional representation.

In one embodiment, the three-dimensional representation is of an HBV polymerase rt defined by the set of structure co-ordinates set out in Table 6 or wherein the three-dimensional representation is of a homolog of the molecule or molecular complex, the homolog having a root mean square deviation from the backbone atoms of the amino acids of not more than 1.5 Å.

An additional aspect of the present invention provides a computer or a software component thereof for determining at least a portion of the structure co-ordinates corresponding to a three-dimensional structure of a molecule or molecular complex comprising an HBV polymerase rt in which the computer comprises:
(a) a machine-readable data storage medium comprising a data storage material encoded with machine-readable data, in which the data comprises at least a portion of the structural co-ordinates of an HBV polymerase having a mutation within a region selected from amino acid residues 28-36, 39-45, 59-66, 69-70, 73-93, 167-184, 198 213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
(b) a machine-readable data storage medium comprising a data storage material encoded with machine-readable data, wherein the data comprises atomic co-ordinates of the molecule or molecular complex;
(c) a working memory for storing instructions for processing the machine-readable data of (a) and (b);
(d) a central-processing unit coupled to the working memory and to the machine-readable data storage medium of (a) and (b) for performing a transformation of the machine readable data of (a) and for processing the machine-readable data of (b) into structure co-ordinates; and
(e) a display coupled to the central-processing unit for displaying the structure co-ordinates of the molecule or molecular complex.

Another aspect of the present invention provides a computer-assisted method for identifying agents potentially able to bind to a domain of HBV polymerase and optionally modulate at least one functional activity of the HBV polymerase using a programmed computer comprising the steps of:
(a) inputting into the progammed computer data comprising the atomic co-ordinates of an HBV polymerase rt or fragment thereof at positions 28-36, 39-45, 59-66, 69-70, 73-93, 167-184, 198-213, 230-241 and 245-257 and/or at position numbers 4-10, 24-27, 46-58, 67-68, 71-72, 94-120, 165-166, 185-197, 214-227, 242-244 and 258-266;
(b) generating, using computer methods, a set of atomic co-ordinates of a structure that possesses stereochemical complementarity to the atomic co-ordinates defined in (a) or a subset thereof, thereby generating a criteria data set;
(c) comprising, using the processor, the criteria data set to a computer database of chemical structures;
(d) selecting from the database, using computer methods, chemical structures which are similar to a portion f said criteria data set; and
(e) outputting the selected chemical structures which are similar to a portion of the criteria data set.

In another aspect, the present invention contemplates identifying an agent capable of interacting with an HBV polymerase or fragment thereof and optionally down-regulating at least one functional activity associated with said HBV polymerase wherein said HBV polymerase has at least one of the following characteristics:
(i) displays increased resistance or decreased sensitivity to a nucleoside analog such as ADV, LMV, FCV, FTC, ETV, TDF, DAPD and DXG compared to native HBV polymerase;
(ii) comprises a mutation within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL801, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion; and/or
(iii) comprises the amino acid sequence set forth in SEQ ID NO:1 or an amino acid sequence defining an HBV polymerase and having a sequence which is at least 70% similar after optimal alignment to SEQ ID NO:1;
   said method comprising contacting said HBV polymerase with an agent to be tested and assessing the degree of interactive complementarity of said agent with said HBV polymerase.

In a particularly preferred embodiment, the method of the present invention is directed to identification of agents, such as nucleoside analogs, which bind to the nucleotide binding pocket of the nucleoside-resistant HBV polymerase molecule, or other regions of the polymerase that alters polymerase activity and to agents so identified. These may be useful as either therapeutic agents or diagnostic agents. The present method further provides an ability to map resistance to other areas of the rt domain of the HBV polymerase.

Preferably, the agent can bind to the nucleotide binding pocket of the HBV polymerase.

In another preferred embodiment, the functional activity is measured by inhibition of replication of an HBV.

In yet another preferred embodiment, identifies three potential metal binding regions with clusters of histidine and cysteine residues within the HBV polymerase structure. These new binding sites may be involved in polymerase activity or associated functions such as RNA/DNA binding or strand transfer of the newly elongated strand.

A further aspect of this invention three additional metal binding sites within the HBV polymerase and is directed to identification of agents, which bind to the metal binding sites within the HBV polymerase molecule, that alters polymerase activity and to agents so identified. These may be useful as either therapeutic agents or diagnostic agents. The present method further provides an ability to map resistance to other areas of the rt domain of the HBV polymerase including these three metal binding sites.

A further aspect of the present invention relates to the use of agents identified utilizing the methods described herein to modulate wild-type or anti-viral drug-resistant HBV polymerase activity and, in particular, the use of these agents in the therapeutic and/or prophylactic treatment of HBV infection. Other agents which interact with the HBV polymerase are useful as diagnostic agents.

Yet another aspect of the present invention provides a method modulating at least one functional activity associated with an HBV polymerase, said method comprising introducing into said subject an effective amount of an agent, which agent is identified in accordance with the methods herein defined, for a time and under conditions sufficient for said agent to interact with said HBV polymerase molecule and to inhibit or reduce its activity.

Preferably, the agent inhibits replication of the HBV.

This aspect of the present invention should be understood to encompass both in vivo treatment as well as modulating the activity of HBV polymerase in in vitro culture systems. The latter may be of benefit, for example, when screening for agents with antagonistic activity toward the HBV polymerase.

In yet another aspect, the present invention relates to a method for the treatment and/or prophylaxis of HBV infection, said method comprising administering to said subject an effective amount of an agent capable of modulating the HBV polymerase of said HBV, which agent is identified in accordance with the methods herein defined, for a time and under conditions sufficient for said agent to interact with said HBV polymerase molecule and inhibit or reduce its activity.

In a preferred embodiment, the subject of the prophylactic or therapeutic treatment is a mammal and more preferably a human.

In another aspect, the present invention relates to the use of an agent capable of modulating at least one functional activity associated with an HBV polymerase, which agent is identified in accordance with the methods herein defined, in the manufacture of a medicament for the treatment and/or prophylaxis of infection of a subject by HBV.

Yet another aspect of the present invention relates to a pharmaceutical composition comprising an agent which inhibits or reduces the activity of an HBV polymerase. Such compositions generally further comprise one or more pharmaceutically acceptable carriers and/or diluents.

The present invention should also be understood to extend to the use of the three-dimensional structural co-ordinates of an HBV polymerase or a domain thereof in the analysis and/or elucidation of the nucleic acid replication mechanism of a HBV. The present invention further extends to the diagnostic, therapeutic and/or prophylactic developments derived therefrom.

The present invention should still further be understood to extend to any non-naturally occurring form of the HBV polymerase molecule. Examples of non-naturally occurring forms of the HBV polymerase molecule include inter alia crystallized forms of the molecules.

The present invention further enables predictions to be made on the likelihood or otherwise of an agent inhibiting an HBV polymerase from a particular isolate.

A summary of sequence identifiers used throughout the subject specification is provided in Table 1.

TABLE 1
Summary of sequence identifiers

| SEQUENCE | |
|---|---|
| ID NO: | DESCRIPTION |
| 1 | amino acid sequence of ADV resistant HBV polymerase |
| 2 | amino acid sequence of motif 1 from HBV (FIG. 3) |
| 3 | amino acid sequence of motif 1 from WHV (FIG. 3) |
| 4 | amino acid sequence of motif 1 from DHBV (FIG. 3) |
| 5 | amino acid sequence of motif 1 from HIV (FIG. 3) |
| 6 | amino acid sequence of motif 2 from HBV (FIG. 3) |
| 7 | amino acid sequence of motif 2 from WHV (FIG. 3) |
| 8 | amino acid sequence of motif 2 from DHBV (FIG. 3) |
| 9 | amino acid sequence of motif 2 from HIV (FIG. 3) |
| 10 | amino acid sequence of motif 2 from PV (FIG. 3) |
| 11 | amino acid sequence of motif 2 from HCV (FIG. 3) |
| 12 | amino acid sequence of motif 2 from DEN (FIG. 3) |
| 13 | amino acid sequence of motif 2 from BVDV (FIG. 3) |
| 14 | amino acid sequence of motif 2 from Sindbis (FIG. 3) |
| 15 | amino acid sequence of motif 2 from HBV (FIG. 3) |
| 16 | amino acid sequence of motif 2 from WHV (FIG. 3) |
| 17 | amino acid sequence of motif 2 from DHBV |
| | protein (FIG. 3) |
| 18 | amino acid sequence showing the primary and secondary |
| | mutative binding sites for nucleoside and nucleotide analogs |

Single and three letter abbreviations used throughout the specification are provided in Table 2.

TABLE 2
Single and three letter amino acid abbreviations

| | THREE-LETTER | ONE-LETTER |
|---|---|---|
| AMINO ACID | ABBREVIATION | SYMBOL |
| Alanine | Ala | A |
| Arginine | Arg | R |
| Asparagine | Asn | N |
| Aspartic acid | Asp | D |
| Cysteine | Cys | C |
| Glutamine | Gln | Q |
| Glutamic acid | Glu | E |
| Glycine | Gly | G |
| Histidine | His | H |
| Isoleucine | Ile | I |
| Leucine | Leu | L |
| Lysine | Lys | K |
| Methionine | Met | M |
| Phenylalanine | Phe | F |
| Proline | Pro | P |
| Serine | Ser | S |
| Threonine | Thr | T |
| Tryptophan | Trp | W |
| Tyrosine | Tyr | Y |
| Valine | Val | V |
| Any residue | Xaa | X |

A list of abbreviations used herein is provided in Table 3.

TABLE 3
Abbreviations

| ABBREVIATION | DESCRIPTION |
|---|---|
| 3TC | (LMV); (−)-β-2′-deoxy-3′-thiacytidine |
| ADV | adefovir |
| DAPD | diaminopurine dioxolane |
| DXG | dioxolane guanine |
| ETV | entecavir |
| FCV | famciclovir |
| FTC | emtricitabine |
| HBV | hepatitis B virus |
| TDF | tenofovir disoproxil fumarate |
| LMV | lamividuine |
| rt | reverse transcriptase |
| YMDD | Tyr Met Asp Asp-a motif in the polymerase |
| | protein; where the Met residue is designated |
| | residue number 204 of the reverse transcriptase |

### BRIEF DESCRIPTION OF THE FIGURES

FIG. 1 is an alignment of HBV and HIV showing resistance mutations. A colored version of this Figure is available from the Applicant upon request.

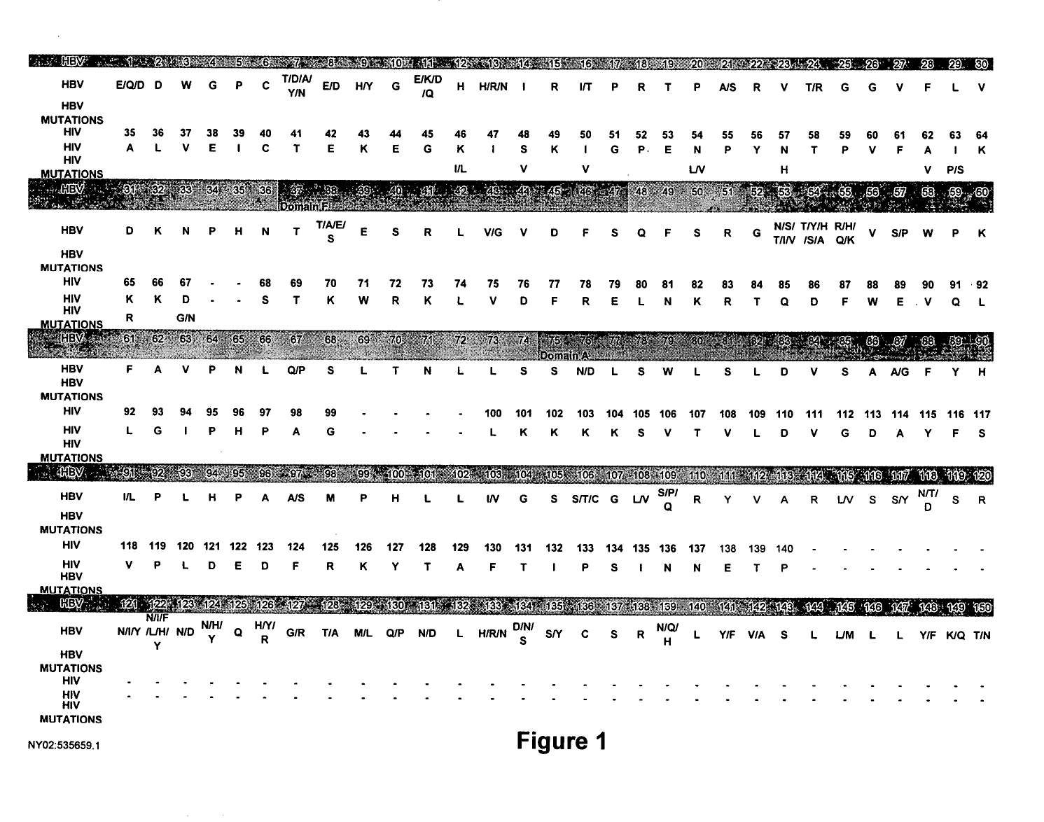

FIG. 2 is a photomicrographic representation of the homology model of HBV polymerase showing domains based on HIV reverse transcriptase. The model was constructed based on the crystal structure 1RTD (Das et al., Journal of Virology 75: 4771-4779, 2001) and the alignment of the HBV and HIV polymerase proteins (FIG. 1). The structurally conserved domains are highlighted; Domains F (red), A (orange), B (yellow), C (green). D (white) and E (pink). The template and primer strands of DNA are shown in blue and green. The magnesium ions present in the catalytic site are shown in purple. Three proposed metal binding sites are shown in grey. A colored version of this Figure is available from the Applicant upon request.

FIG. 3 is a representation showing motifs F and G domains.

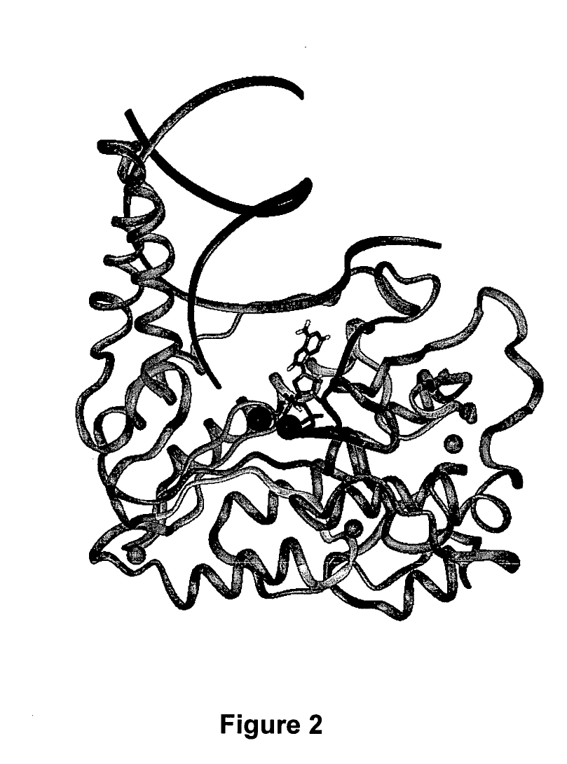

FIG. 4 is a structural representation showing the binding site of the HBV double mutant rtM204V/rtL180M with LMV bound. The mutation of residue 180 is proposed to alter the conformation of rtF188 and cause an unfavourable steric interaction with LMV. A colored version of this Figure is available from the Applicant upon request.

FIG. 5 is a structural representation showing the binding site of native HBV (green) and HBV mutant V173L (white) with LMV bound showing the proximity between rtL173 and rtF88 Mutation at position 173 rotates the aromatic ring of F88 causing it to encroach upon the binding pocket blocking the binding of LMV. A colored version of this Figure is available from the Applicant upon request.

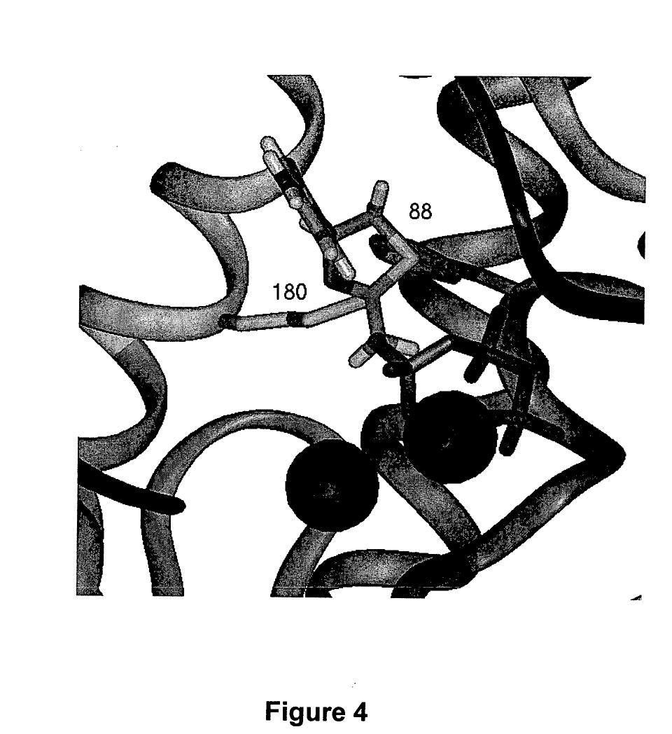

FIG. 6 is a structural representation showing binding site model of native HBV with ADV and magnesium ions (purple) showing the proximity (3.4 Å) of residue rtN236 to S85 and the active site. A colored version of this Figure is available from the Applicant upon request.

FIG. 7 is a diagrammatic representation of a system used to carry out the instructions encoded by the storage medium.

FIG. 8 is a diagrammatic representation of a cross-section of a magnetic storage medium.

FIG. 9 is a diagrammatic representation of a cross-section of an optically readable data storage system.

FIG. 10 is a structural representation showing the leucine to isoleucine mutation at position 80 involved in LMV resistance. A colored version of this Figure is available from the Applicant upon request.

FIG. 11 is a structural representation showing the valine to leucine mutation at position 173 leading to LMV resistance. A colored version of this Figure is available from the Applicant upon request.

FIG. 12 is a structural representation showing the alanine to threonine mutation at position 181 leading to ADV resistance.

FIG. 13 is structural representation showing the asparagine to threonine mutation at position 236 leading to ADV resistance.

FIG. 14 is a structural representation showing the alanine to glutamic mutation at position 38 leading to entecavir resistance.

FIG. 15 is a structural representation showing the serine to isoleucine mutation at position 202 leading to entecavir resistance.

FIG. 16 is an alignment of amino acid sequence showing the primary and secondary mutative binding sites for nucleoside and nucleotide analogs.

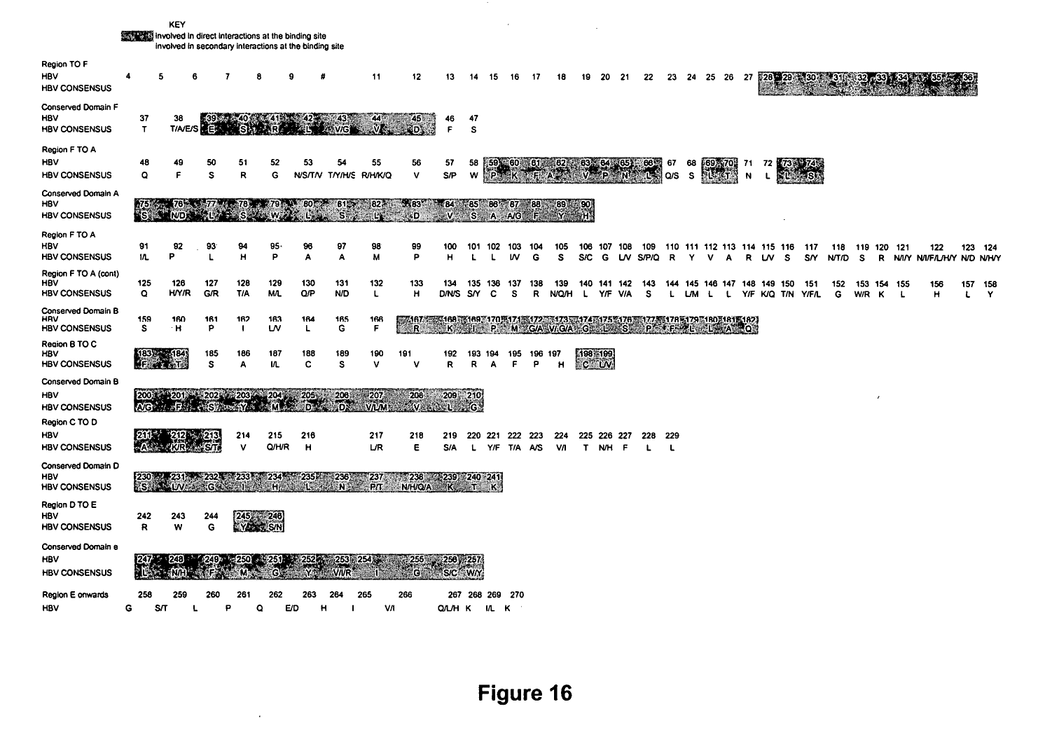

FIG. 17 is a structural representation showing the proposed metal binding Site 1. Residues forming the site are rtE1, rtH12, rtH13, rtH160 and rtA162.

FIG. 18 is a structural representation showing the proposed metal binding Site 2. Residues forming the site are: rtC-9, rtH-6, rtH90, rtL93 and rtH234.

FIG. 19 is a structural representation showing proposed metal binding Site 3. Residues forming the site are: rtH197, rtC198, rtH216 and rtC213.

FIG. 20 is representation of Southern blot showing HBV replicative intermediates detected in cells treated with ADV (0, 0.1, 0.5, 1.0, 5.0 10 μM) or LMV (0, 0.001, 0.01, 0.1, 1, 10 μM).

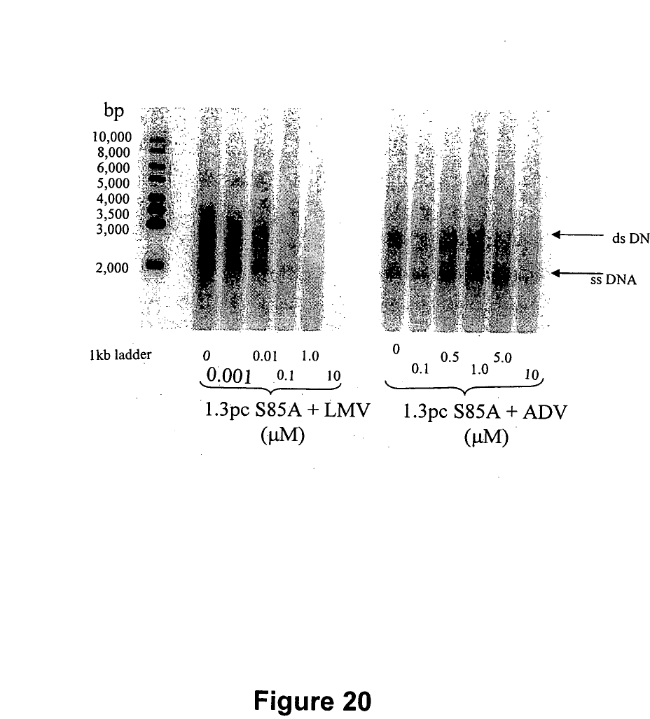

### DETAILED DESCRIPTION OF THE INVENTION

The present invention provides of the tertiary structure of an rt domain of the wild-type HBV polymerase. This structure demonstrates the molecular basis for resistance of the HBV polymerases to anti-viral agents and, therefore, permits the identification, screening, analysis, rational design and/or modification of agents for modulating the functional activity of HBV polymerases and in particular HBV polymerases resistant to one or more of ADV, LMV, FCV, FTC, ETV, TDF, DAPD or DXG or nucleoside/nucleotide analogues. These agents may be used inter alia as either agonists or antagonists in the therapy and prophylaxis of conditions involving replication of HBV infection. The agents may also be used for diagnostic purposes.

Before describing the present invention in detail, it is to be understood that unless otherwise indicated, the subject invention is not limited to specific formulations of agents, manufacturing methods, dosage regimens, or the like, as such may vary. It is also to be understood that the terminology used herein is for the purpose of describing particular embodiments only and is not intended to be limiting.

It must be noted that, as used in the subject specification, the singular forms “a”, “an” and “the” include plural aspects unless the context clearly dictates otherwise. Thus, for example, reference to “an agent” includes a single agent, as well as two or more agents; “a nucleoside analog” includes a single analog, as well as two or more analogs; reference to “an HBV variant” includes reference to two or more HBV variants; and so forth.

In describing and claiming the present invention, the following terminology is used in accordance with the definitions set forth below.

The terms “agent”, “compound”, “active ingredient”, “pharmacologically active agent”, “medicament”, “active” and “drug” are used interchangeably herein to refer to a chemical compound that induces a desired effect such as inhibiting viral replication by inhibiting HBV DNA polymerase activity or function. The terms also encompass pharmaceutically acceptable and pharmacologically active ingredients of those active agents specifically mentioned herein including but not limited to salts, esters, amides, pro-drugs, active metabolites, analogs and the like. When the terms “agents”, “compound”, “active ingredient”, “pharmacologically active agent”, “medicament”, “active” and “drug” are used, then it is to be understood that this includes the active agent per se as well as pharmaceutically acceptable, pharmacologically active salts, esters, amides, pro-drugs, metabolites, analogs, etc.

The present invention contemplates, therefore, compounds useful in inhibiting HBV DNA polymerase or interacting with HBV polymerase such as diagnostic agents. Reference to a “nucleoside analog such as ADV, LMV, FCV, FTC, ETV, TDF, DAPD and/or DXG including combinations of two or more analogs.

The terms “effective amount” and “therapeutically effective amount” of an agent as used herein mean a sufficient amount of the agent to provide the desired therapeutic or physiological effect of inhibiting HBV polymerase or for use as a diagnostic reagent. Furthermore, an “effective HBV-inhibiting amount” or “effective symptom-ameloriating amount” of an agent is a sufficient amount of the agent to directly or indirectly inhibit replication. Undesirable effects, e.g. side effects, are sometimes manifested along with the desired therapeutic effect; hence, a practitioner balances the potential benefits against the potential risks in determining what is an appropriate “effective amount”. The exact amount required will vary from subject to subject, depending on the species, age and general condition of the subject, mode of administration and the like. Thus, it may not be possible to specify an exact “effective amount”. However, an appropriate “effective amount” in any individual case may be determined by one of ordinary skill in the art using only routine experimentation.

By “pharmaceutically acceptable” carrier, excipient or diluent is meant a pharmaceutical vehicle comprised of a material that is not biologically or otherwise undesirable, i.e. the material may be administered to a subject along with the selected active agent without causing any or a substantial adverse reaction. Carriers may include excipients and other additives such as diluents, detergents, coloring agents, wetting or emusifying agents, pH buffering agents, preservatives, and the like.

Similarly, a “pharmacologically acceptable” salt, ester, emide, prodrug or derivative of a compound as provided herein is a salt, ester, amide, prodrug or derivative that this not biologically or otherwise undesirable.

The terms “treating” and “treatment” as used herein refer to reduction in severity and/or frequency of symptoms, elimination of symptoms and/or underlying cause, prevention of the occurrence of symptoms and/or their underlying cause, and improvement or remediation of damage in relation to HBV infection. Thus, for example, “treating” a patient involves prevention of HBV infection as well as treatment of a clinically HBV symptomatic individual by inhibiting HBV replication by inhibiting HBV polymerase. Thus, for example, the present method of “treating” a patient with HBV infection or with a propensity for one to develop encompasses both prevention of HBV infection as well as treating HBV infection or symptoms thereof. In any event, the present invention contemplates the treatment or prophylaxis of HBV infection.

“Patient” as used herein refers to an animal, preferably a mammal and more preferably a primate including a lower primate and even more preferably, a human who can benefit from the formulations and methods of the present invention. A patient regardless of whether a human or non-human animal may be referred to as an individual, subject, animal, host or recipient. The compounds and methods of the present invention have applications in human medicine, veterinary medicine as well as in general, domestic or wild animal husbandry. For convenience, an “animal” includes an avian species such as a poultry bird (including ducks, chicken, turkeys and geese), an aviary bird or game bird. The condition in a non-human animal may not be a naturally occurring HBV infection but HBV-like infection may be induced.

As indicated above, the preferred animals are humans, non-human primates such as marmossets, baboons, orangutangs, lower primates such as tupia, livestock animals, laboratory test animals, companion animals or captive wild animals. A human is the most preferred target. However, non-human animal models may be used.

Examples of laboratory test animals include mice, rats, rabbits, guinea pigs and hamsters. Rabbits and rodent animals, such as rats and mice, provide a convenient test system or animal model as do primates and lower primates. Livestock animals include sheep, cows, pigs, goats, horses and donkeys. Non-mammalian animals such as avian species, zebrafish, amphibians (including cane toads) and Drosophila species such as Drosophila melanogaster are also contemplated. Instead of a live animal model, a test system may also comprise a tissue culture system.

HBV is a member of the Hepdnaviridae that includes also avian hepatitis viruses such as Duck hepatitis B virus (DHBV) and hepatitis viruses from mammals such as woodchuck hepatitis virus (WHV). These viruses have similarity to HBV and may be used in in vitro and in vivo or animal model systems to investigate HBV polymerases having resistance or reduced sensitivity to an anti-viral drug such as a nucleoside or nucleotide analog.

An “anti-HBV drug” includes a nucleoside or nucleotide analog, protein or chemical compound.

The present invention is directed to a method of identifying an agent capable of interacting with an HBV polymerase and preferably modulating at least one functional activity associated with said HBV polymerase, said method comprising contacting said HBV polymerase with an agent to be tested and assessing the degree of interactive complementarity of said agent with said polymerase.

The HBV polymerase may also be referred to as “pol”. The largest open reading frame (ORF) in the HBV genome encodes for the HBV polymerase. The pol is 90 kd in size and has RNA and DNA dependant polymerase activity (Toh, et al., Nature 305: 827-829, 1983). Pol plays a key role in HBV genome generation as well as pgRNA encapsidation. Pol is packaged together with pgRNA within HBV nucleocapsids (Mack et al., J. Virol. 62: 4786-4790, 1988).

The HBV polymerase has been divided into four characterized domains. Based on sequence homologies and studies on the mechanism of viral genome replication, most parts of pol are indispensable. The N-terminus portion of the protein acts in priming (−) DNA strand synthesis and ends up covalently linked to the 5′ end of the (−) DNA strand. This domain is termed terminal protein The subsequent domain does not appear to have any enzymatic function, but acts as a spacer between the first and third domains. The third domain has the reverse transcriptase functions. It occupies approximately 40% of the protein and exhibits the RNA and DNA dependent polymerase activity (Lanford et al., J. Virol. 73: 1885-1893, 1999). However, pol also requires the presence of metal ions and the presence of the stem loop for polymerase/rt activity to occur (Urban et al., J. Gen. Virol. 79: 1121-1131, 1998; Bartenschlager and Schaller, EMBO J. 7: 4185-4192, 1992; Tavis et al., J. Virol. 72: 5789-5796, 1998). The fourth domain of possesses its RNase H activity (Chang et al., Proc. Natl. Acad. Sci. USA 87: 5158-5162, 1990; Radziwill et al., J. Virol. 64: 613-620, 1990). This domain also plays a key role in HBV genome replication.

HBV polymerase also contains a number of regions that are homologous to other RNA dependent polymerases (Poch et al., European Molecular Biology Organisation 8: 3867-3874, 1989; Lesburg et al., Nat. Struct. Biol. 6(10): 937-943, 1999). These regions have been designated Domains A-G, where the recently designated Domains F and G are prior to Domain A in the deduced protein sequence (Lesburg, 1999, supra). Domain F was previously called motif 2 and Domain G was motif 1 in other reverse transcriptase proteins (Nakamura et al., Science 277: 955-959, 1997; Xiong and Eickbush, EMBO J. 9(10): 3353-3362, 1990). A general numbering system has been developed by Stuyver et al., 2001, supra, to provide uniformity in the numbering system of the amino acids for the HBV polymerase protein. In this system, the methionine in the YMDD motif (using single amino acid nomenclature) has been assigned to be residue 204 (formerly codon 539, 550 or 552; Table 4). In addition each of the four functional regions of the polymerase (terminal protein, spacer, reverse transcriptase and RNase H) are individually numbered.

TABLE 4
Accepted domain-specific numbering system for HBV polymerase,
RT domain, modified from Stuyver et al., 2001, supra

| HBV | | | | | | |
|---|---|---|---|---|---|---|
| Gen- | 1^{st} amino acid | | B domain B LMV- | | C domain LMV- | |
| o- | rt domain | | associated mutation | | associated mutation | |
| type | Previously | New | Previously | New | Previously | New |
| A | 349 | rt1 | L528M | rtL180M | M552I/V | rtM204I/V |
| B/C/ | 347 | rt1 | L526M | rtL180M | M550I/V | rtM204I/V |
| F/H | | | | | | |
| D | 336 | rt1 | L515M | rtL180M | M539I/V | rtM204I/V |
| E/G | 346 | rt1 | L525M | rtL180M | M549I/V | rtM204I/V |

Anti-viral drugs contemplated by the present invention to which an HBV polymerase may become resistant comprise, but are in no way limited, to nucleoside analog drugs such as ADV, LMV, FCV, FTC, ETV, TDF, DAPD and DXG.

Non-limiting examples of methods of assessing activity of a drug which acts on an HBV polymerase including assessing the level of resistance to a drug include:

assessment of the clinical activity of the anti-viral agent in a patient infected with HBV;

the ability of the anti-viral agent to inhibit the replication of a virus in cell culture;

the in vitro measurement of the Km value between the anti-viral agent and the viral polymerase (Das et al., 2001, supra); and

the interaction between the anti-viral agent and viral polymerase using in-silico modeling (Das et al., 2001, supra).

An HBV polymerase resistant to an anti-viral agent includes an HBV polymerase which maintains functional activity in the presence of anti-viral drugs. Preferred anti-viral drugs are nucleoside analogs such as ADV, LMV, FCV, FTC, ETV, TDF, DAPD and DXG. For the purposes of the present invention, the term “native HBV polymerase” is to be understood as an HBV polymerases which is sensitive to inactivation by a nucleoside analog.

Nucleoside reverse transcriptase inhibitors (NRTIs) are also examples of nucleoside analogs or dideoxynucleoside analogs due to the absence of a 3′-hydroxyl group on the ribose moiety. As with endogenous nucleosides, the nucleoside analogs must be triphosphorylated into a nucleotide. Initially, the nucleoside analog biotransformation requires enzymes such as thymidine kinase, deoxycytidine kinase or inosine phosphotransferase to form the monophosphate metabolite. Once in the triphosphorylated form, the dideoxynucleotide can compete with naturally occurring nucleotides for DNA incorporation. The dideoxynucleotide will bind onto reverse transcriptase and become incorporated into the elongating viral complement DNA (cDNA). The absence of the 3′-hydroxyl group on the ribose moiety of these nucleosides/nucleotides causes DNA elongation to terminate.

An anti-viral drug-resistant HBV polymerase generally comprises one or more of the following characteristics:
(i) displays increased resistance or decreased sensitivity to a nucleoside analog such as ADV, LMV, FCV, FTC, ETV, TDF, DAPD and DXG compared to native HBV polymerase;
(ii) comprises a mutation selected from within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/V/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion; and/or
(iii) comprises the amino acid sequence set forth in SEQ ID NO:1 or an amino acid sequence defining an HBV polymerase and having a sequence which is at least 70% similar after optimal alignment to SEQ ID NO:1.

Reference to “at least 70% similarity” includes 70, 71, 72, 73, 74, 75, 76, 77, 78, 79, 80, 81, 82, 83, 84, 85, 86, 87, 88, 89, 90, 91, 92, 93, 94, 95, 96, 97, 98 or 100% similarity.

The atomic co-ordinates of the rt domain of wild-type HBV polymerase to which various mutants have been mapped are set forth in Table 6. The present invention extends to the co-ordinates of HBV polymerases resistant to any other drug such as a nucleoside or nucleotide analog.

A range of HBV polymerases are contemplated herein including a wild-type HBV polymerase as well as a variant polymerase such as those carrying a mutation within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK15R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, s110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/P/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and/or V251A/R/N/D/C/Q/E/G/H/I/L/K/M/F/P/S/T/W/Y/deletion.

The present invention further identifies the primary and second amino acid residues in the HBV polymerase involved in nucleoside or nucleotide analog binding. The primary residues are at position numbers 28-36, 39-45, 59-66, 69-70, 73-93, 167-184, 198-213, 230-241 and 245-257. The secondary residues are at position numbers 4-10, 24-27, 46-58, 67-68, 71-72, 94-120, 165-166, 185-197, 214-227, 242-244 and 258-266.

The present invention further identifies three new potential metal binding sites. Polymerase molecules require metal ions for catalysis. In addition to the known metal binding region (residues 205 and 206 in our model) three regions are identified containing clusters of histidine and cysteine residues. The proposed metal binding Site 1 includes residues rtE1, rtH12, rtH13 rtH160 and rtA162. The proposed metal binding Site 2 includes residues rtC-9, rtH-6, rtH90, rtL93 and rtH234. The proposed metal binding Site 3 includes residues rtH197, rtC198, rtH216 and rtC213. These additional metal binding sites for the HBV polymerase have not been previously identified and may be targets for antiviral compounds.

It should be understood that the HBV polymerase of the present invention, which is contacted with the putative agent for evaluation of interactive complementarity, may be a naturally occurring form of the protein or it may be recombinantly or synthetically produced. However, it should also be understood that the subject protein may take the form of an image, such as an electron density map, molecular models (including, but not limited to, stick, ball and stick, space filling or surface representation models) or other digital or non-digital surface representation models or image, which facilitates the analysis of said HBV polymerase: agent interactions utilizing techniques and software which would be known to those of skill in the art. For example, interaction analyzes can be performed utilizing techniques such as Biacore real-time analysis of on and off-rates and dissociation constants for binding of ligands (Gardsvoll et al., J Biol. Chem. 274(53): 37995-38003, 1999; Hoyer-Hansen et al., FEBS Lett. 420(1): 79-85, 1997; Ploug, Biochemistry 37(47): 16494-16505, 1998; Ploug et al., Biochemistry 33(30): 8991-8997, 1994; Ploug et al., Biochemistry 34(39): 12524-12534, 1995; Ploug et al., Biochemistry 37(11): 3612-3622, 1998) and NMR perturbation studies (Stephens et al., Biochemistry 31:7572-7579, 1992).

Reference to “assessing the degree of interactive complementarity” of an agent with the subject HBV polymerase should be understood as a reference to elucidating any feature of interest including, but not limited to, the nature and/or degree of interaction between the subject HBV polymerase and an agent of interest. As detailed above, any suitable technique can be utilized. Such techniques would be known to the person of skill in the art. In terms of the nature of the subject interaction, it may be desirable to assess the types of interactive mechanisms which occur between specific residues of any given agent and those of the HBV polymerase (for example, peptide bonding or formation of hydrogen bonds, ionic bonds, van der Waals forces, etc.) and/or their relative strengths. It may also be desirable to assess the degree of interaction which occurs between an agent of interest and the subject HBV polymerase. For example, by analyzing the location of actual sites of interaction between the subject agent and HBV polymerase, it is possible to determine the quality of fit of the agent into any region of the HBV polymerase and the relative strength and stability of that binding interaction. This is of particular relevance to determining the nature and position of the binding of the agent. For example, where it is desirable to inhibit HBV polymerase activity, a nucleoside analog agent which binds to the nucleotide binding pocket could be designed or identified. Alternatively, an agent which interacts with the HBV polymerase such that it blocks or otherwise hinders (for example, sterically hinders or chemically or electrostatically repels) the binding of a nucleotide or the nucleic acid template to the HBV polymerase molecule may be identified. Accordingly, reference to “interacting” should be understood to include reference to an agent associating with one or more HBV binding regions for the purpose of inhibiting replication of HBV. In this regard, the form of association which is required in relation to inhibiting HBV polymerase activity may not involve the formation of any interactive bonding mechanism, as this is traditionally understood, but may involve a non-bonding mechanism such as the proximal location of a region of the agent relative to the subject binding region of the HBV polymerase, for example, to effect steric hindrance with respect to the binding of a nucleotide to the binding pocket. Where the interaction takes the form of hindrance or the creation of other replusive forces, this should nevertheless be understood as a form of “interaction” despite the lack of formation of any of the traditional forms of bonding mechanisms.

It should also be understood that the anti-viral drug-resistant HBV polymerase of the present invention, which is utilized either in a physical form or as an image, as discussed herein, to assess the interactive complementarity of a putative agent may be a naturally occurring form of the HBV polymerase or it may be a derivative, homolog, analog, mutant, fragment or equivalent thereof. As detailed in relation to the polymerase itself, the derivative, homolog, analog, mutant, fragment or equivalent thereof may also take either a physical or non-physical (such as an image) form.

Derivatives include fragments, parts, portions, variants and mimetics from any source including fusion proteins. Parts or fragments include, for example, active regions of the HBV polymerase molecule. This is of particular relevance, for example, if one is interested in analysing the nucleotide binding regions. For example, and without limiting the present invention in any way, the incoming nucleotide is thought to interact with residues present in the “palm” sub-domain of the HBV polymerase. In some circumstances, it may be useful to examine only the fragment of the HBV polymerase molecule comprising these binding regions. Accordingly, it may only be necessary to isolate, synthesize, produce or depict one or more HBV domains or parts of domains in isolation. The present invention should, therefore, be understood to extend to the use of any fragment, part or portion of the HBV polymerase molecule.

Derivatives may be derived from insertion, deletion or substitution of amino acids. Amino acid insertional derivatives include amino and/or carboxylic terminal fusions as well as intrasequence insertions of single or multiple amino acids. This may be of particular relevance where it is desirable to apply the method of the present invention to analyzing interactions between a putative agent and mutants, variants or mimetics of the HBV polymerase. Insertional amino acid sequence variants are those in which one or more amino acid residues are introduced into a predetermined site in the protein although random insertion is also possible with suitable screening of the resulting product. Deletional variants are characterized by the removal of one or more amino acids from the sequence. Substitutional amino acid variants are those in which at least one residue in the sequence has been removed and a different residue inserted in its place. An example of substitutional amino acid variants are conservative amino acid substitutions. Conservative amino acid substitutions typically include substitutions within the following groups: glycine and alanine; valine, isoleucine and leucine; aspartic acid and glutamic acid; asparagine and glutamine; serine and threonine; lysine and arginine; and phenylalanine and tyrosine. Additions to amino acid sequences include fusions with other peptides, polypeptides or proteins.

Equivalents of the HBV polymerase of the present invention should be understood as encompassing molecules such as chemical equivalents exhibiting any one or more of the structural features of said HBV polymerase and may be derived from any source such as being chemically synthesized, theoretically predicted or identified via screening processes such as natural product screening.

The derivatives also include fragments having particular regions or parts of the entire protein fused to peptides, polypeptides or other proteinaceous or non-proteinaceous molecules.

Reference to “homologs” should be understood as a reference to polymerases derived from other viruses or to other substantially similar molecules from viruses or splicing variants of the same molecule.

Analogs contemplated herein include, but are not limited to, modification to side chains, incorporating of unnatural amino acids and/or their derivatives during peptide, polypeptide or protein synthesis and the use of crosslinkers and other methods which impose conformational constraints on the proteinaceous molecules or their analogs. The study and use of anti-viral resistant HBV polymerase analogs may also be useful in relation to identifying, studying and/or modulating the activity of said polymerase mutants, variants or mimetics.

Examples of side chain modifications contemplated by the present invention include modifications of amino groups such as by reductive alkylation by reaction with an aldehyde followed by reduction with NaBH4; amidination with methylacetimidate; acylation with acetic anhydride; carbamoylation of amino groups with cyanate; trinitrobenzylation of amino groups with 2,4,6-trinitrobenzene sulphonic acid (TNBS); acylation of amino groups with succinic anhydride and tetrahydrophthalic anhydride; and pyridoxylation of lysine with pyridoxal-5-phosphate followed by reduction with NaBH4.

The guanidine group of arginine residues may be modified by the formation of heterocyclic condensation products with reagents such as 2,3-butanedione, phenylglyoxal and glyoxal.

The carboxyl group may be modified by carbodiimide activation via O-acylisourea formation followed by subsequent derivitization, for example, to a corresponding amide.

Sulphydryl groups may be modified by methods such as carboxymethylation with iodoacetic acid or iodoacetamide; performic acid oxidation to cysteic acid; formation of a mixed disulphides with other thiol compounds; reaction with maleimide, maleic anhydride or other substituted maleimide; formation of mercurial derivatives using 4-chloromercuribenzoate, 4-chloromercuriphenylsulphonic acid, phenylmercury chloride, 2-chloromercuri-4-nitrophenol and other mercurials; carbamoylation with cyanate at alkaline pH.

Tryptophan residues may be modified by, for example, oxidation with N-bromosuccinimide or alkylation of the indole ring with 2-hydroxy-5-nitrobenzyl bromide or sulphenyl halides. Tyrosine residues on the other hand, may be altered by nitration with tetranitromethane to form a 3-nitrotyrosine derivative.

Modification of the imidazole ring of a histidine residue may be accomplished by alkylation with iodoacetic acid derivatives or N-carboethoxylation with diethylpyrocarbonate.

Examples of incorporating unnatural amino acids and derivatives during protein synthesis include, but are not limited to, use of norleucine, 4-amino butyric acid, 4-amino-3-hydroxy-5-phenylpentanoic acid, 6-aminohexanoic acid, t-butylglycine, norvaline, phenylglycine, ornithine, sarcosine, 4-amino-3-hydroxy-6-methylheptanoic acid, 2-thienyl alanine and/or D-isomers of amino acids. A list of unnatural amino acids contemplated herein is shown in Table 5.

TABLE 5
Codes for non-conventional amino acids

| | | Non-conventional | |
|---|---|---|---|
| Non-conventional amino acid | Code | amino acid | Code |
| α-aminobutyric acid | Abu | L-N-methylalanine | Nmala |
| α-amino-α-methylbutyrate | Mgabu | L-N-methylarginine | Nmarg |
| aminocyclopropane- | Cpro | L-N-methylasparagine | Nmasn |
| carboxylate | | L-N-methylaspartic acid | Nmasp |
| aminoisobutyric acid | Aib | L-N-methylcysteine | Nmcys |
| aminonorbornyl- | Norb | L-N-methylglutamine | Nmgln |
| carboxylate | | L-N-methylglutamic acid | Nmglu |
| cyclohexylalanine | Chexa | L-Nmethylhistidine | Nmhis |
| cyclopentylalanine | Cpen | L-N-methylisolleucine | Nmile |
| D-alanine | Dal | L-N-methylleucine | Nmleu |
| D-arginine | Darg | L-N-methyllysine | Nmlys |
| D-aspartic acid | Dasp | L-N-methylmethionine | Nmmet |
| D-cysteine | Dcys | L-N-methylnorleucine | Nmnle |
| D-glutamine | Dgln | L-N-methylnorvaline | Nmnva |
| D-glutamic acid | Dglu | L-N-methylornithine | Nmorn |
| D-histidine | Dhis | L-N-methylphenylalanine | Nmphe |
| D-isoleucine | Dile | L-N-methylproline | Nmpro |
| D-leucine | Dleu | L-N-methylserine | Nmser |
| D-lysine | Dlys | L-N-methylthreonine | Nmthr |
| D-methionine | Dmet | L-N-methyltryptophan | Nmtrp |
| D-ornithine | Dorn | L-N-methyltyrosine | Nmtyr |
| D-phenylalanine | Dphe | L-N-methylvaline | Nmval |
| D-proline | Dpro | L-N-methylethylglycine | Nmetg |
| D-serine | Dser | L-N-methyl-t-butylglycine | Nmtbug |
| D-threonine | Dthr | L-norleucine | Nle |
| D-tryptophan | Dtrp | L-norvaline | Nva |
| D-tyrosine | Dtyr | α-methyl-aminoisobutyrate | Maib |
| D-valine | Dval | α-methyl-γ-aminobutyrate | Mgabu |
| D-α-methylalanine | Dmala | α-methylcyclohexylalanine | Mchexa |
| D-α-methylarginine | Dmarg | α-methylcylcopentylalanine | Mcpen |
| D-α-methylasparagine | Dmasn | α-methyl-α-napthylalanine | Manap |
| D-α-methylaspartate | Dmasp | α-methylpenicillamine | Mpen |
| D-α-methylcysteine | Dmcys | N-(4-aminobutyl)glycine | Nglu |
| D-α-methylglutamine | Dmgln | N-(2-aminoethyl)glycine | Naeg |
| D-α-methylhistidine | Dmhis | N-(3-aminopropyl)glycine | Norn |
| D-α-methylisoleucine | Dmile | N-amino-α-methylbutyrate | Nmaabu |
| D-α-methylleucine | Dmleu | α-napthylalanine | Anap |
| D-α-methyllysine | Dmlys | N-benzylglycine | Nphe |
| D-α-methylmethionine | Dmmet | N-(2-carbamylethyl)glycine | Ngln |
| D-α-methylornithine | Dmorn | N-(carbamylmethyl)glycine | Nasn |
| D-α-methylphenylalanine | Dmphe | N-(2-carboxyethyl)glycine | Nglu |
| D-α-methylproline | Dmpro | N-(carboxymethyl)glycine | Nasp |
| D-α-methylserine | Dmser | N-cyclobutylglycine | Ncbut |
| D-α-methylthreonine | Dmthr | N-cycloheptylglycine | Nchep |
| D-α-methyltryptophan | Dmtrp | N-cyclohexylglycine | Nchex |
| D-α-methyltyrosine | Dmty | N-cyclodecylglycine | Ncdec |
| D-α-methylvaline | Dmval | N-cylcododecylglycine | Ncdod |
| D-N-methylalanine | Dnmala | N-cyclooctylglycine | Ncoct |
| D-N-methylarginine | Dnmarg | N-cyclopropylglycine | Ncpro |
| D-N-methylasparagine | Dnmasn | N-cycloundecylglycine | Ncund |
| D-N-methylaspartate | Dnmasp | N-(2,2-diphenylethyl)glycine | Nbhm |
| D-N-methylcysteine | Dnmcys | N-(3,3-diphenylpropyl)glycine | Nbhe |
| D-N-methylglutamine | Dnmgln | N-(3-guanidinopropyl)glycine | Narg |
| D-N-methylglutamate | Dnmglu | N-(1-hydroxyethyl)glycine | Nthr |
| D-N-methylhistidine | Dnmhis | N-(hydroxyethyl))glycine | Nser |
| D-N-methylisoleucine | Dnmile | N-(imidazolylethyl))glycine | Nhis |
| D-N-methylleucine | Dnmleu | N-(3-indolylyethyl)glycine | Nhtrp |
| D-N-methyllysine | Dnmlys | N-methyl-γ-aminobutyrate | Nmgabu |
| N-methylcyclohexylalanine | Nmchexa | D-N-methylmethionine | Dnmmet |
| D-N-methylornithine | Dnmorn | N-methylcyclopentylalanine | Nmcpen |
| N-methylglycine | Nala | D-N-methylphenylalanine | Dnmphe |
| N-methylaminoisobutyrate | Nmaib | D-N-methylproline | Dnmpro |
| N-(1-methylpropyl)glycine | Nile | D-N-methylserine | Dnmser |
| N-(2-methylpropyl)glycine | Nleu | D-N-methylthreonine | Dnmthr |
| D-N-methyltryptophan | Dnmtrp | N-(1-methylethyl)glycine | Nval |
| D-N-methyltyrosine | Dnmtyr | N-methyla-napthylalanine | Nmanap |
| D-N-methylvaline | Dnmval | N-methylpenicillamine | Nmpen |
| γ-aminobutyric acid | Gabu | N-(p-hydroxyphenyl)glycine | Nhtyr |
| L-t-butylglycine | Tbug | N-(thiomethyl)glycine | Ncys |
| L-ethylglycine | Etg | penicillamine | Pen |
| L-homophenylalanine | Hphe | L-α-methylalanine | Mala |
| L-α-methylarginine | Marg | L-α-methylasparagine | Masn |
| L-α-methylaspartate | Masp | L-α-methyl-t-butylglycine | Mtbug |
| L-α-methylcysteine | Mcys | L-methylethylglycine | Metg |
| L-α-methylglutamine | Mgln | L-α-methylglutamate | Mglu |
| L-α-methylhistidine | Mhis | L-α-methylhomophenylalanine | Mhphe |
| L-α-methylisoleucine | Mile | N-(2-methylthioethyl)glycine | Nmet |
| L-α-methylleucine | Mleu | L-α-methyllysine | Mlys |
| L-α-methylmethionine | Mmet | L-α-methylnorleucine | Mnle |
| L-α-methylnorvaline | Mnva | L-α-methylornithine | Morn |
| L-α-methylphenylalanine | Mphe | L-α-methylproline | Mpro |
| L-α-methylserine | Mser | L-α-methylthreonine | Mthr |
| L-α-methyltryptophan | Mtrp | L-α-methyltyrosine | Mtyr |
| L-α-methylvaline | Mval | L-N-methylhomophenylalanine | Nmhphe |
| N-(N-(2,2-diphenylethyl) | Nnbhm | N-(N-(3,3-diphenylpropyl) | Nnbhe |
| carbamylmethyl)glycine | | carbamylmethyl)glycine | |
| 1-carboxy-1-(2,2-diphenyl- | Nmbc | | |
| ethylamino)cyclopropane | | | |

Crosslinkers can be used, for example, to stabilize 3D conformations, using homo-bifunctional crosslinkers such as the bifunctional imido esters having (CH₂)ₙ spacer groups with n=1 to n=6, glutaraldehyde, N-hydroxysuccinimide esters and hetero-bifunctional reagents which usually contain an amino-reactive moiety such as N-hydroxysuccinimide and another group specific-reactive moiety.

Elucidation of the three dimensional structure of the HBV polymerase molecule facilitates the identification and analysis of regions involved in the binding between the HBV polymerase and anti-viral drugs. Examples of anti-viral drugs include inter alia a nucleoside or nucleotide analog such as ADV, LMV, FCV, FTC, ETV, TDF, DAPD and DXG. For example, and without limiting the present invention to any one theory or mode of action, the location of individual residues and residue regions present on the HBV polymerase molecule has been analyzed in terms of their potential to function as part of the nucleotide binding pocket or alter the conformation of the nucleotide binding pocket. Based on this analysis, the HBV polymerase residues involved in determining the conformation of the binding pocket, or altering access to the nucleotide-binding pocket have been identified in accordance with the present invention. Mutations at these residues have the potential to alter which nucleotides or nucleoside analogs can bind to the nucleotide binding pocket of HBV polymerase. These residues are defined by reference to a numerical identification of amino acid residues or an amino acid residue region corresponding to the numbered residues as detailed in SEQ ID NO:1 or an amino acid sequence defining an HBV polymerase having at least 70% similarity to SEQ ID NO:1. Single residues are indicated by a single number and contiguous peptide regions as numerical ranges.

One or more of the following amino acids or amino acid regions are proposed to be involved in the binding of nucleotide and nucleoside analogs within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 as well as rtA21, rtA38, rtY54, rtN76, rtL91, rtF122, rtY124, rtT128, rtQ130, rtT184, rtM204, rtS202, rtH248, rtY252, rtS21, rtN/S/T/I/V53, rtY54, rtS57, rtL91, rtS116, rtL122, rtF122, rtN124, rtY124 rtH126, rtY126, rtT128N, rtP130, rtD131, rtV134, rtY135, rtY141, rtL145, rtF151, rtL180, rtA181, rtS202, rtI204, rtK212, rtL217, rtS219, rtI235, rtN236, rtN238, sP120, sM125, sS126, sT127, sT118, sM133, sM133, sF134, sS143, sD144, sG145, sW172, sI195, sS207, sY225, spacerL97, spacerK115, spacerH116, spacerL128, spacerS137, spacerR139, spacerF142, rtA97, rtH126, rtS135, rtM204, PreS1 N114, PreS1 T115, PreS2 F22, PreS2 V39, PreS2 P52, sL89, sT118, sF161, sE164, sI195, sI208, PreS1 E86, PreS1 N91, PreS2 P41, sQ30, sP120, sL176, sV194, rtS21, rtL122, rtN124, rtH126, rtP130, rtD131, rtY135, rtN/S/T/I/V53, rtY126, rtS202, rtI204, rtI235, sM125, sT127, sT118, sM133, sF134, sI195, sS207, sY225, rtG172, rtG174, rtP177, rtL180, rtT184, sR160, sE164, sF170, sL175, sQ181, sC/W182, sW196, sW196, sW196, sM198, sW199, sS204, sY206, sS210, sS210, sL216, sY255, rtL77, rtL77, rtL80, rtL80, rtH90, rtS117, rt125, rt128, rtQ125, rtQ125, rtY126Q, rtL128, rtT128, rtL132, rtN134, rtS137, rtN139, rtN139, rtY141, rtV/G142, rtL147, rtK149, rtG153, rtR153, rtW153, rtW153, rtF166, rtI169, rtF178, rtI187, rtI187, rtV191, rtV191, rtN202, rtS202, rtS202, rtS213, rtV/G214, rtS219, rtS219, rtN/Q238, rtN/S/H238, rtN/S/H/T238, rtR242, rtR242, rtN248, rtI253, s118-207, s117-120, sI68, sC69, sL109, sG112, sS17, sT118, sK122, sT123, sT126, sT131, sN131, sM133, sM133, sY/F134, sC139, sK141, sD144, sG145, rtT128, rtL82, rtT135, rtT150, rtV163, rtT184, rtA200, rtF202, rtS213, rtQ215, rtS219, rtA222, rtI224, rtL229, rtL235, rtN238, rtS78, rt116DEL122, rtI163, rtL180, rtE8, rtV23, rtD31, rtY53, rtV58, rtA/S21, rtV/I/N/S/T53, rtV/I/N/S/T53, rtS/T/N/H/A54, PreS2 L11, PreS2 R17, DEL PreS2 18-21, PreS2 T30, PreS2 N54, sT13, PreS2 Q1, PreS2 Q1, rtH90, rtL/F108, rtL157, rtA181, rtV207, rtP109, rtN/H/A/S/Q238, s181, sP214, sF83, sL173, sW199, sI126, sK160, sS174, sA84, sS210, sC69, sC76, s110, sY134 or sW172.

Another aspect of the present invention provides a computer-assisted method for identifying agents potentially able to bind to a domain of HBV polymerase and optionally modulate at least one functional activity of the HBV polymerase including predicting an anti-viral response to an agent using a programmed computer comprising the steps of:
(a) inputting into the progammed computer data comprising the atomic co-ordinates of an HBV polymerase having a mutation selected from within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
(b) generating, using computer methods, a set of atomic co-ordinates of a structure that possesses stereochemical complementarity to the atomic co-ordinates defined in (a) or a subset thereof, thereby generating a criteria data set;
(c) comprising, using the processor, the criteria data set to a computer database of chemical structures;
(d) selecting from the database, using computer methods, chemical structures which are similar to a portion of said criteria data set; and
(e) outputting the selected chemical structures which are similar to a portion of the criteria data set.

Preferably, the method further comprises the step of obtaining an agent with a chemical structure selected in steps (d) and (e) and testing the compound for the ability to modulate at least one functional activity of an HBV polymerase.

Yet another aspect of the present invention provides a computer or a software component thereof for producing a three-dimensional representation of a molecule or molecular complex, which comprises a three-dimensional representation of a homolog of the molecule or molecular complex, which comprises a three-dimensional representation of a homolog of the molecule or molecular complex, in which the homolog comprises a domain that has a root mean square deviation from the backbone atoms of the amino acids of not more than 1.5 Å, in which the computer comprises:
(a) a machine-readable data storage medium comprising a data storage material encoded with machine-readable data, wherein the data comprises the structure co-ordinates of an HBV polymerase having a mutation selected from within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
(b) a working memory for storing instructions for processing the machine-readable data;
(c) a central-processing unit coupled to the working memory and to the machine-readable data storage medium for processing the machine-readable data into the three-dimensional representation; and
(d) a display coupled to the central-processing unit for displaying the three-dimensional representation.

In one embodiment, the three-dimensional representation is of an HBV polymerase defined by the set of structure co-ordinates set out in Table 6 or wherein the three-dimensional representation is of a homolog of the molecule or molecular complex, the homolog having a root mean square deviation from the backbone atoms of the amino acids of not more than 1.5 Å.

An additional aspect of the present invention provides a computer or a software component thereof for determining at least a portion of the structure co-ordinates corresponding to a three-dimensional structure of a molecule or molecular complex comprising an HBV polymerase in which the computer comprises:
(a) a machine-readable data storage medium comprising a data storage material encoded with machine-readable data, in which the data comprises at least a portion of the structural co-ordinates of an HBV polymerase having a mutation selected from within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/1, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
(b) a machine-readable data storage medium comprising a data storage material encoded with machine-readable data, wherein the data comprises atomic co-ordinates of the molecule or molecular complex;
(c) a working memory for storing instructions for processing the machine-readable data of (a) and (b);
(d) a central-processing unit coupled to the working memory and to the machine-readable data storage medium of (a) and (b) for performing a transformation of the machine readable data of (a) and for processing the machine-readable data of (b) into structure co-ordinates; and
(e) a display coupled to the central-processing unit for displaying the structure co-ordinates of the molecule or molecular complex.

More particularly, the computer product is based on amino acid resides involved in binding of nucleoside or nucleotide analogs. Accordingly, the present invention provides a computer-assisted method for identifying agents potentially able to bind to a domain of HBV polymerase and optionally modulate at least one functional activity of the HBV polymerase including predicting an anti-viral response to an agent using a programmed computer comprising the steps of:
(a) inputting into the progammed computer data comprising the atomic co-ordinates of an HBV polymerase or fragment thereof at positions 28-36, 39-45, 59-66, 69-70, 73-93, 167-184, 198-213, 230-241 and 245-257 and/or at position numbers 4-10, 24-27, 46-58, 67-68, 71-72, 94-120, 165-166, 185-197, 214-227, 242-244 and 258-266;
(b) generating, using computer methods, a set of atomic co-ordinates of a structure that possesses stereochemical complementarity to the atomic co-ordinates defined in (a) or a subset thereof, thereby generating a criteria data set;
(c) comprising, using the processor, the criteria data set to a computer database of chemical structures;
(d) selecting from the database, using computer methods, chemical structures which are similar to a portion f said criteria data set; and
(e) outputting the selected chemical structures which are similar to a portion of the criteria data set.

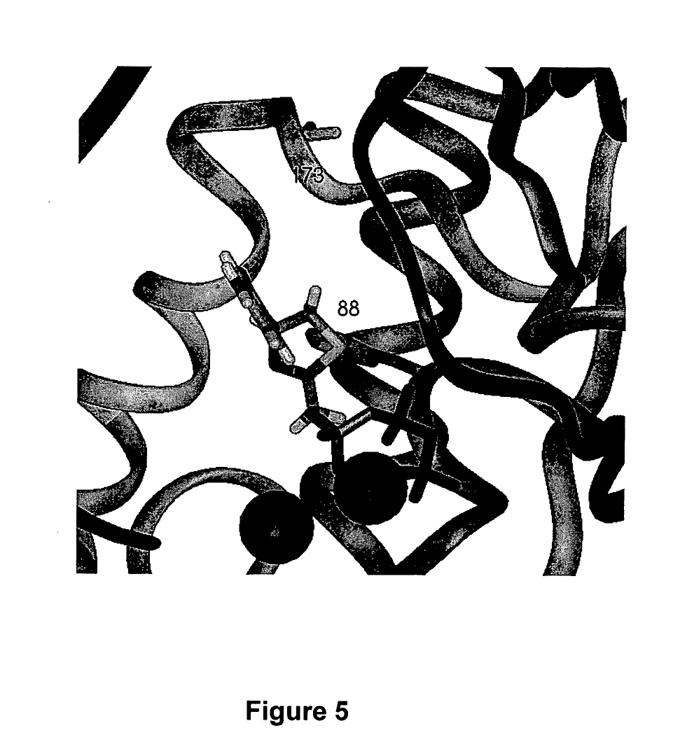

The binding of ADV to HBV polymerase has been particularly investigated in accordance with the present invention. This interaction is schematically depicted in FIG. 6. Based on this analysis, the HBV polymerase molecule binding regions and specific residues which are thought to be involved in ADV binding have been identified. HBV polymerases with substitutions at particular amino acid residues (when compared to native HBV polymerase) which exhibit resistance to ADV have also been identified. The specific amino acid substitutions which are involved in the binding of ADV to HBV polymerase which are reflected in the anti-viral drug-resistant HBV polymerase amino acid sequence provided in SEQ ID NO:1 have also been identified. These are detailed as substitutions with reference to native HBV polymerase: rtN236T, rtA181T, rtA181V, rtV84N and rtH90D.

However, to the extent that any other HBV polymerase is utilized for the purpose of the method defined herein, the precise residue numbers of the location of these regions may vary. The present invention should be understood to encompass equivalent regions and residues which are present on forms of the HBV polymerase molecule other than that identified by SEQ ID NO:1. In particular, HBV polymerases resistant to ADV, LMV, FCV, FTC, ETV, TDF, DAPD and DXG are also contemplated by the present invention. Such polymerases are encompassed by reference to an amino acid sequence having at least about 70% similarity to SEQ ID NO:1 after optimal alignment.

The determination of these potential binding regions has been made possible by the elucidation of the three dimensional structure of the HBV polymerase which facilitates the identification and/or rational modification and design of agents which can be used to bind to the nucleotide binding pocket of anti-viral drug-resistant HBV polymerase according to the present invention.

Accordingly, another embodiment of the present invention provides a method for identifying an agent capable of interacting with an anti-viral drug-resistant HBV polymerase, said method comprising contacting an anti-viral drug-resistant HBV polymerase or derivative, homolog, analog, fragment or equivalent thereof, which molecule comprises the amino acid sequence set forth in SEQ ID NO:1 or an amino acid sequence having at least 70% similarity to SEQ ID NO:1 after optimal alignment with an agent and assessing the degree of interactive complementarity of said agent with said HBV polymerase wherein said agent binds to the nucleotide binding pocket of said HBV polymerase.

The agents may modulate at least one functional activity associated with the HBV polymerase. Alternatively or in addition, the interactions alone is sufficient for the agent to be useful as a therapeutic agent.

The term “modulate” should be understood to refer to the up-regulation or down-regulation of at least one functional activity associated with the HBV polymerase. Down-regulation of the HBV polymerase associated functional activity, for example, inhibiting replication of the HBV, is particularly desirable in the treatment of diseases such as hepatitis. Accordingly, the present invention provides a potential therapeutic or prophylactic treatment for hepatitis which is unresponsive to ADV or another anti-viral agent such as a nucleoside or nucleotide analog.

Accordingly, the present invention is directed to a method for identifying an agent capable of interacting with an anti-viral drug-resistant HBV polymerase and/or a wild-type HBV polymerase and optionally down-regulating at least one functional activity associated with said HBV polymerase wherein said anti-viral resistant HBV polymerase and/or wild-type HBV polymerase has at least one of the following characteristics:
(i) displays increased resistance or decreased sensitivity to a nucleoside analog such as ADV, LMV, FCV, FTC, ETV, TDF, DAPD and DXG compared to native HBV polymerase;
(ii) comprises a mutation selected from within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion; and/or
(iii) comprises the amino acid sequence set forth in SEQ ID NO:1 or an amino acid sequence defining an HBV polymerase and having a sequence which is at least 70% similar after optimal alignment to SEQ ID NO:1;
   said method comprising contacting said anti-viral resistant HBV polymerase molecule or derivative, homolog, analog, fragment, mutant or equivalent thereof with an agent and assessing the degree of interactive complementarity of said agent with said anti-viral drug-resistant HBV polymerase.

Preferably, the functional activity of the HBV polymerase involves replication of HBV.

More preferably, insofar as the HBV polymerase is resistant to or has reduced sensitivity to ADV, the HBV polymerase has the atomic co-ordinates substantially as set forth in Table 6.

Alternatively, the agent interacts with but does not inhibit the HBV polymerase. Such agents have potential as diagnostic agents, such as being able to discriminate between HBV polymerases of different strains.

It should be understood that modulation of “at least one functional activity” associated with the HBV polymerase is intended as a reference to the modulation of the functional activities which are associated with the replication of the HBV. “Associated” is meant that the subject functional activity is either directly or indirectly regulated by the level of HBV polymerase molecule activation or deactivation. Directly associated functional activity includes, but is not limited to, duplication of the HBV genome by de novo synthesis of a new nucleic acid strand from a template nucleic acid.

Reference to an “agent” should be understood as a reference to any proteinaceous or non-proteinaceous molecule which achieves the object of the present invention, i.e. the modulation of at least one functional activity associated with the HBV polymerase molecule.

The proteinaceous molecule may be derived from natural or recombinant sources including fusion proteins or following, for example, natural product screening. The non-proteinaceous molecule may be, for example, a synthetic molecule, such as one which is chemically synthesized, or it may be derived from natural sources, such as, for example, obtained through natural product screening. The present invention contemplates chemical analogs of the nucleotide bases or small molecules capable of acting as agonists or antagonists of the HBV polymerase. Chemical agonists may not necessarily be derived from HBV polymerase molecule ligands but may share certain conformational similarities.

Alternatively, chemical agonists may be specifically designed to mimic certain physicochemical properties. Antagonists may be any compound capable of blocking, inhibiting or otherwise preventing the HBV polymerase from carrying out its normal biological functions. Antagonists and agonists include inter alia monoclonal antibodies, small molecules, peptides or drugs.

Without limiting the application of the present invention in any way, the method of the present invention facilitates the identification, analysis, design and/or modification of agents capable of interacting with an anti-viral drug-resistant HBV polymerase molecule. In this regard, such agents may be identified by:
(i) Randomly screening (for example, utilizing routine high-throughput screening technology) to identify agents which exhibit some modulatory capacity with respect to HBV polymerase functional activity and analyzing the precise nature and magnitude of the agent's signaling capacity utilizing the method of the present invention. In this regard, existing crystals may be soaked with the agents or co-crystallization may be performed. A combination of modeling and synthetic modification of the local compound together with mutagenesis of the HBV polymerase may then be performed. In screening for agents which may modulate activity, standard methods of phage display and also combinatorial chemistry may be utilized (Goodson et al., Proc. Natl. Acad. Sci. USA 91(15): 7129-7133, 1994; Terrett, Drug Discov. Today 5(5): 211-212, 2000). Such interaction studies can also be furthered utilizing techniques such as the Biacore analysis and NMR perturbation studies detailed earlier. Such agents are often commonly referred to as “lead” agents in terms of the random screening of proteinaceous or non-proteinaceous molecules for their capacity to function either agonistically or antagonistically. Further, for example, binding affinity and specificity could be enhanced by modifying lead agents to maximize interactions with nearby residues of βc revealed from the structure of the complex. Such analyzes would facilitate the selection of agents which are the most suitable for a given purpose. In this way, the selection step is based not only on in vitro data but also on a technical analysis of sites of agent: HBV polymerase molecule interactions in terms of their frequency, stability and suitability for a given purpose. For example, analysis performed in accordance with the method of the present invention may reveal that what appears to be an acceptable in vitro activity in respect of a randomly identified agent is in fact induced by a highly unstable interaction due to the presence of proximally located agent: HBV polymerase molecule sites which exhibit significant repulsive forces thereby destabilizing the overall interaction between the agent and the HBV polymerase molecule. This would then facilitate the selection of another prospective lead compound, exhibiting an equivalent degree of in vitro activity, but which agent does not, upon further analysis, involve the existence of such destabilizing repulsive forces.
Screening for the modulatory agents herein defined can be achieved by any one of several suitable methods which would be well known to those of skill in the art and which are, for example, routinely used to randomly screen proteinaceous and non-proteinaceous molecules for the purpose of identifying lead compounds. For example, such techniques would include contacting a cell infected with HBV expressing the anti-viral resistant HBV and screening for the modulation of HBV polymerase functional activity or for HBV polymerase induced down-stream functional activity including modulation of the replication of the virus. Detecting such modulation can be achieved utilizing techniques such as Western Blotting, electrophoretic mobility shift assays and/or the titre of the virus in cell culture or animal models. The choice of detection technique will depend entirely on the nature of the HBV polymerase feature which is the subject of detection.
It should be understood that the HBV polymerase molecule or functional equivalent or derivative thereof may be transgenically expressed in the cell which is the subject of testing in the absence of viral infection or it may be as a result of HBV infection of said cell. Further, the gene may be constitutively expressed or may require stimulation in order to effect expression. Further, the HBV polymerase may comprise the entire HBV polymerase molecule gene or it may merely comprise a portion of the gene such as the portion which codes for some of the HBV polymerase domains.
These methods provide a mechanism for performing high throughput screening of putative modulatory agents such as the proteinaceous or non-proteinaceous agents comprising synthetic, recombinant, chemical and natural libraries.
(ii) The candidate or lead agent (for example, the agent identified in accordance with the methodology described in relation to point (i)) could be modified in order to maximize desired interactions (for example, binding affinity to specificity) with the anti-viral resistant HBV polymerase molecule and to minimize undesirable interactions (such as repulsive or otherwise destabilizing interactions). Such modification is only possible in light of a detailed knowledge of the three-dimensional structure of the anti-viral resistant HBV polymerase and the capacity therefore to identify regions of functional importance, thereby facilitating the structural modification of an agent to maximize an agonistic or antagonistic interaction. Such methodology is particularly applicable to rational drug design. Methods of modification of a candidate or lead agent in accordance with the purpose as defined herein would be well known to those of skill in the art. For example, a molecular replacement program such as Amore (Navaza, Acta Cryst. A50: 157-163, 1994) may be utilized in this regard. The method of the present invention also facilitates the mutagenesis of known signal inducing agents in order to ablate or improve signaling activity.
(iii) In addition to analyzing fit and/or structurally modifying existing molecules, the method of the present invention also facilitates the rational design and synthesis of an agent, such as an agonistic or antagonistic agent, based on theoretically modeling an agent exhibiting the desired HBV polymerase molecule interactive structural features followed by the synthesis and testing of the subject agent.

It should be understood that any one or more of applications (i) to (iii) above may be utilized in identifying a particular agent.

As detailed earlier, reference to HBV polymerase includes reference to parts or fragments thereof since it may be useful to identify, analyze, design and/or modify agents which interact with only part of the HBV polymerase molecule structure. Accordingly, the method of the present invention should be understood to extend inter alia to the design of synthetic peptides to parts of the structure predicated to be important to the biological activity of the HBV polymerase or resistance of the HBV polymerase to anti-viral agents.

In this regard and in a particularly preferred embodiment, the method of the present invention is applied to the identification, analysis, design and/or modification of agents, such as nucleoside analogs, which bind to the nucleotide binding pocket of the anti-viral resistant HBV polymerase molecule.

In a related aspect, the present invention should be understood to encompass agents identified utilizing the methods herein defined.

Accordingly, the present invention is directed to an agent capable of interacting with an anti-viral resistant HBV polymerase molecule and/or a wild-type HBV polymerase and optionally modulating at least one functional activity associated with said polymerase wherein said anti-viral resistant HBV polymerase and/or wild-type HBV polymerase has at least one of the following characteristics:
(i) displays increased resistance or decreased sensitivity to a nucleoside analog such as ADV, LMV, FCV, FTC, ETV, DAPD and DXG compared to native HBV polymerase;
(ii) comprises a mutation selected from within a region selected from amino acid residues 28-36, 39-45, 59-66, 69-70, 73-93, 167-184, 198-213, 230-241 and 245-257 or 4-10, 24-27, 46-58, 67-68, 71-72, 94-120, 165-166, 185-197, 214-227, 242-244 and 258-266 such as but not limited to rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T15, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, s110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion; and/or
(iii) comprises the amino acid sequence set forth in SEQ ID NO:1 or an amino acid sequence defining an HBV polymerase and having a sequence which is at least 70% similar after optimal alignment to SEQ ID NO:1;
   wherein said agent is identified in accordance with the methods hereinbefore defined.

Preferably, the agent can bind to the nucleotide binding pocket of the anti-viral resistant HBV polymerase.

Even more preferably, the anti-viral resistant HBV polymerase molecule is mapped to the atomic co-ordinates set forth in Table 6.

In another preferred embodiment, the functional activity of the HBV polymerase is associated with HBV replication.

In the context of this aspect of the present invention, the term “identified” includes an agent which has been analyzed, designed and/or modified in accordance with the methods herein defined.

A further aspect of the present invention relates to the use of agents identified utilizing the methods herein defined to modulate an HBV polymerase activity such as an anti-viral drug resistant HBV polymerase and in particular the use of these agents in the therapeutic and/or prophylactic treatment of conditions characterized by infection by an HBV. For example, antagonistic agents are particularly useful in anti-viral therapy in HBV infection in a subject wherein the HBV is resistant to an existing anti-viral agent, such as ADV, LMV, FCV, FTC, ETV, TDF, DAPD and DXG.

Accordingly, another aspect of the present invention provides a method modulating at least one functional activity associated with an anti-viral drug-resistant HBV polymerase in a subject, said method comprising introducing into said subject an effective amount of an agent, which agent is identified in accordance with the methods herein defined, for a time and under conditions sufficient for said agent to interact with said HBV polymerase molecule and to inhibit or reduce its activity.

In one embodiment, the agent inhibits HBV replication.

This aspect of the present invention encompasses both in vivo therapy as well as in vitro culture systems. The latter may be of benefit, for example, when screening for agents with antagonistic activity toward the anti-viral resistant HBV polymerase.

In yet another aspect, the present invention relates to a method for the treatment and/or prophylaxis of HBV infection, said method comprising administering to a subject an effective amount of an agent capable of modulating the activity of HBV polymerase of said virus, which agent is identified in accordance with the methods herein defined, for a time and under conditions sufficient for said agent to interact with said anti-viral resistant HBV polymerase molecule and inhibits its activity.

The molecule which may be administered to a subject in accordance with the present invention may also be linked to a targeting means such as a monoclonal antibody, which provides specific delivery of these molecules to the target cells.

In a preferred embodiment, the subject of the prophylactic or therapeutic treatment is a mammal and still more preferably a human.

Administration of the agent, in the form of a pharmaceutical composition, may be performed by any convenient means. The modulatory agent of the pharmaceutical composition is contemplated to exhibit therapeutic activity when administered in an amount which depends on the particular case. The variation depends, for example, on the human or animal and the modulatory agent chosen. A broad range of doses may be applicable. Considering a patient, for example, from about 0.01 μg to about 10 g of modulatory agent may be administered per kilogram of body weight per day. Dosage regimes may be adjusted to provide the optimum therapeutic response. For example, several divided doses may be administered daily, weekly, monthly or other suitable time intervals or the dose may be proportionally reduced as indicated by the exigencies of the situation. Exemplary amounts include 0.01, 0.02, 0.03, 0.04, 0.05, 0.06, 0.07, 0.08, 0.09 or 0.1 μg; 1, 2, 3, 4, 5, 6, 7, 8, 9 or 10 μg; 0.1, 0.2, 0.3, 0.4, 0.5, 0.6, 0.7, 0.8, 0.9 or 1 mg; 1, 2, 3, 4, 5, 6, 7, 8, 9 or 10 mg, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 mg; 100, 200, 300, 400, 500, 600, 700, 800, 900 or 1000 mg and 1, 2, 3, 4, 5, 6, 7, 8, 9 or 10 g. The agent may be administered in the form of pharmaceutically acceptable nontoxic salts, such as acid addition salts or metal complexes, e.g. with zinc, iron or the like (which are considered as salts for purposes of this application). Illustrative of such acid addition salts are hydrochloride, hydrobromide, sulphate, phosphate, maleate, acetate, citrate, benzoate, succinate, malate, ascorbate, tartrate and the like. If the active ingredient is to be administered in tablet form, the tablet may contain a binder such as tragacanth, corn starch or gelatin; a disintegrating agent, such as alginic acid; and a lubricant, such as magnesium stearate.

Routes of administration include, but are not limited to, respiratorally, intratracheally, nasopharyngeally, intravenously, intraperitoneally, subcutaneously, intracranially, intradermally, intramuscularly, intraoccularly, intrathecally, intracereberally, intranasally, infusion, orally, rectally, via IV drip patch and implant. Preferably, the route of administration is a route which permits directed delivery of the agent. For example, aerosol administration (such as by nebulization) into the airways permits directed delivery to the airways region, in contrast to systemic delivery which results in delivery to the whole body.

The formulation is administered in a therapeutically effective amount. A therapeutically effective amount means that amount necessary at least partly to attain the desired effect, or to delay the onset of, inhibit the progression of, or halt altogether, the onset or progression of the particular condition being treated. Such amounts will depend, of course, on the particular conditions being treated, the severity of the condition and individual subject parameters including age, physical conditions, size, weight and concurrent treatment. These factors are well known to those of ordinary skill in the art and can be addressed with no more than routine experimentation. It is preferred generally that a maximum dose be used, that is, the highest safe dose according to sound medical judgement. It will be understood by those of ordinary skill in the art, however, that a lower dose or tolerable dose may be administered for medical reasons, psychological reasons or for virtually any other reasons.

As indicated above, daily, weekly or monthly doses of formulation may be from about 0.01 μg/kg per day to 1000 mg/kg per day. Small doses (0.01-1 mg) may be administered initially, followed by increasing doses up to about 1000 mg/kg per day. In the event that the response in a subject is insufficient at such doses, even higher doses (or effective higher doses by a different, more localized delivery route) may be employed to the extent patient tolerance permits. A single dose may be administered or multiple doses may be required on an hourly, daily, weekly or monthly basis. Effective amounts of formulation vary depending on the individual but may range from about 0.1 μg to about 20 mg, alternatively from about 1 μg to about 10 mg and more preferably from about 1 μg to 5 mg per dose.

In another aspect the present invention relates to the use of an agent capable of modulating at least one functional activity associated with an anti-viral drug-resistant HBV polymerase, which agent is identified in accordance with the methods herein defined, in the manufacture of a medicament for the treatment and/or prophylaxis of HBV infection.

In another aspect, the present invention relates to the use of an agent, which agent is identified in accordance with the methods herein defined, in the manufacture of a medicament for the modulation of anti-viral drug-resistant HBV polymerase functional activity.

Yet another aspect relates to agents for use in modulating the functional activity of the anti-viral drug-resistant HBV polymerase molecule wherein said agent is identified in accordance with the methods herein defined.

Yet another aspect relates to agents for use in the treatment and/or prophylaxis of HBV infection wherein said agent is identified in accordance with the methods herein defined.

In a related aspect of the present invention the subject undergoing treatment may be a human or an animal in need of therapeutic or prophylactic treatment.

Reference herein to “treatment” and “prophylaxis” is to be considered in its broadest context. The term “treatment” does not necessarily imply that a mammal is treated until total recovery. Similarly, “prophylaxis” does not necessarily mean that the subject will not eventually contract a disease condition. Accordingly, treatment and prophylaxis include amelioration of the symptoms of a particular condition or preventing or otherwise reducing the risk of developing a particular condition. The term “prophylaxis” may be considered as reducing the severity of onset of a particular condition. “Treatment” may also reduce the severity of an existing condition or the frequency of acute attacks.

In accordance with these methods, the agent defined in accordance with the present invention may be co-administered with one or more other compounds or molecules. By “co-administered” is meant simultaneous administration in the same formulation or in two different formulations via the same or different routes or sequential administration by the same or different routes. By “sequential” administration is meant a time difference of from seconds, minutes, hours or days between the administration of the two types of molecules. These molecules may be administered in any order.

In yet another aspect, the present invention relates to a pharmaceutical composition comprising an agent as herein defined together with one or more pharmaceutically acceptable carriers and/or diluents.

The pharmaceutical forms of the subject compositions suitable for injectable use include sterile aqueous solutions (where water soluble) or dispersions and sterile powders for the extemporaneous preparation of sterile injectable solutions or dispersion or may be in the form of a cream or other form suitable for topical application. It must be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol and liquid polyethylene glycol, and the like), suitable mixtures thereof, and vegetable oils. The proper fluidity can be maintained, for example, by the use of a coating such as lecithin, by the maintenance of the required particle size in the case of dispersion and by the use of superfactants. The preventions of the action of microorganisms can be brought about by various antibacterial and antifungal agents, for example, parabens, chlorobutanol, phenol, sorbic acid, thimerosal and the like. In many cases, it will be preferable to include isotonic agents, for example, sugars or sodium chloride. Prolonged absorption of the injectable compositions can be brought about by the use in the compositions of agents delaying absorption, for example, aluminum monostearate and gelatin.

Sterile injectable solutions are prepared by incorporating the active compounds in the required amount in the appropriate solvent with various of the other ingredients enumerated above, as required, followed by filtered sterilization. Generally, dispersions are prepared by incorporating the various sterilized active ingredient into a sterile vehicle which contains the basic dispersion medium and the required other ingredients from those enumerated above. In the case of sterile powders for the preparation of sterile injectable solutions, the preferred methods of preparation are vacuum drying and the freeze-drying technique which yield a powder of the active ingredient plus any additional desired ingredient from previously sterile-filtered solution thereof.

When the active ingredients are suitably protected they may be orally administered, for example, with an inert diluent or with an assimilable edible carrier, or it may be enclosed in hard or soft shell gelatin capsule, or it may be compressed into tablets, or it may be incorporated directly with the food of the diet. For oral therapeutic administration, the active compound may be incorporated with excipients and used in the form of ingestible tablets, buccal tablets, troches, capsules, elixirs, suspensions, syrups, wafers, and the like. Such compositions and preparations should contain at least 1% by weight of active compound. The percentage of the compositions and preparations may, of course, be varied and may conveniently be between about 5 to about 80% of the weight of the unit. The amount of active compound in such therapeutically useful compositions is such that a suitable dosage will be obtained. Preferred compositions or preparations according to the present invention are prepared so that an oral dosage unit form contains between about 0.01 μg and 10 mg of active compound.

The tablets, troches, pills, capsules and the like may also contain the components as listed hereafter: a binder such as gum, acacia, corn starch or gelatin; excipients such as dicalcium phosphate; a disintegrating agent such as corn starch, potato starch, alginic acid and the like; a lubricant such as magnesium stearate; and a sweetening agent such as sucrose, lactose or saccharin may be added or a flavouring agent such as peppermint, oil of wintergreen, or cherry flavouring. When the dosage unit form is a capsule, it may contain, in addition to materials of the above type, a liquid carrier. Various other materials may be present as coatings or to otherwise modify the physical form of the dosage unit. For instance, tablets, pills, or capsules may be coated with shellac, sugar or both. A syrup or elixir may contain the active compound, sucrose as a sweetening agent, methyl and propylparabens as preservatives, a dye and flavouring such as cherry or orange flavour. Of course, any material used in preparing any dosage unit form should be pharmaceutically pure and substantially non-toxic in the amounts employed. In addition, the active compound(s) may be incorporated into sustained-release preparations and formulations.

The present invention should also be understood to extend to the use of the three-dimensional anti-viral drug-resistant HBV polymerase molecular structure in respect of the analysis and/or elucidation of the nucleic acid replication mechanism of HBV. The present invention further extends to the diagnostic, therapeutic and/or prophylactic developments derived therefrom.

The present invention should still further be understood to extend to any non-naturally occurring form of the anti-viral resistant HBV polymerase molecule. Examples of non-naturally occurring forms of the anti-viral resistant HBV polymerase molecule include inter alia crystallized forms of the molecules.

As indicated above, the present invention contemplates a computer program product for assessing nucleotide sequence differences between a wild-type HBV polymerase and an anti-viral drug-resistant HBV polymerase comprising:
(1) code that receives as input values atomic co-ordinates from an anti-viral drug-resistant HBV polymerase or a fragment thereof;
(2) code that compares those atomic co-ordinates with the atomic co-ordinates of a wild-type HBV polymerase or fragment thereof; and
(3) a computer readable medium that stores the codes.

Still another aspect of the present invention extends to a computer for assessing nucleotide sequence differences between a wild-type HBV polymerase and an anti-viral drug-resistant HBV polymerase comprising:
(1) a machine-readable data storage medium comprising a data storage material encoded with machine-readable data, wherein said machine-readable data comprise values for the identity of atomic co-ordinates of wild-type HBV polymerase or a fragment thereof;
(2) a working memory for storing instructions for processing said machine-readable data and comparing input data comprising atomic co-ordinates of an anti-viral drug-resistant HBV polymerase;
(3) a central-processing unit coupled to said working memory and to said machine-readable data storage medium, for processing said machine readable data to compare said values to provide an assessment of the identity of tags from reference databases; and
(4) an output hardware coupled to said central processing unit, for receiving the results of the comparison.

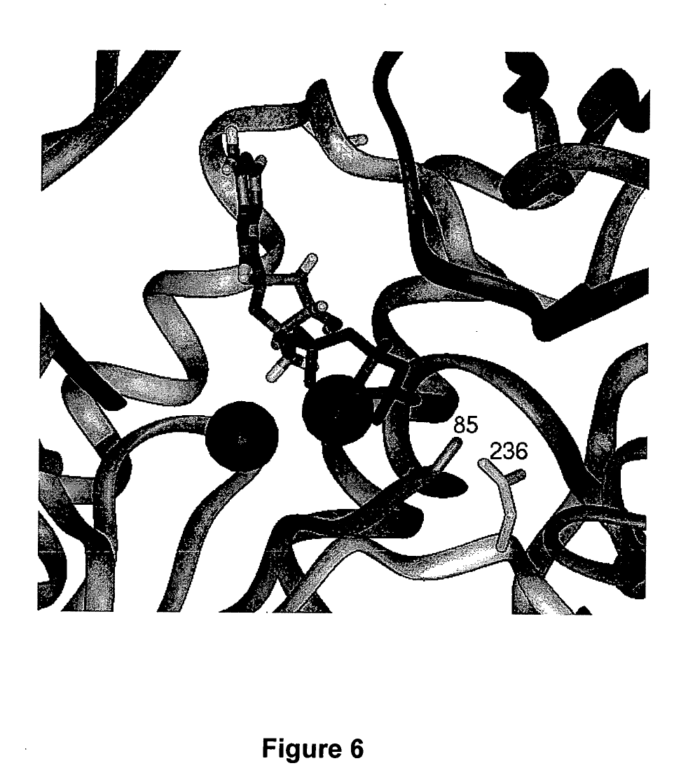

A version of these embodiments is presented in FIG. 7, which shows a system 10 including a computer 11 comprising a central processing unit (“CPU”) 20, a working memory 22 which may be, e.g. RAM (random-access memory) or “core” memory, mass storage memory 24 (such as one or more disk drives or CD-ROM drives), one or more cathode-ray tube (“CRT”) display terminals 26, one or more keyboards 28, one or more input lines 30, and one or more output lines 40, all of which are interconnected by a conventional bidirectional system bus 50.

Input hardware 36, coupled to computer 11 by input lines 30, may be implemented in a variety of ways. For example, machine-readable data of this invention may be inputted via the use of a modem or modems 32 connected by a telephone line or dedicated data line 34. Alternatively or additionally, the input hardware 36 may comprise CD. Alternatively, ROM drives or disk drives 24 in conjunction with display terminal 26, keyboard 28 may also be used as an input device.

Output hardware 46, coupled to computer 11 by output lines 40, may similarly be implemented by conventional devices. By way of example, output hardware 46 may include CRT display terminal 26 for displaying a synthetic polynucleotide sequence or a synthetic polypeptide sequence as described herein. Output hardware might also include a printer 42, so that hard copy output may be produced, or a disk drive 24, to store system output for later use.

In operation, CPU 20 co-ordinates the use of the various input and output devices 36,46 co-ordinates data accesses from mass storage 24 and accesses to and from working memory 22, and determines the sequence of data processing steps. A number of programs may be used to process the machine readable data of this invention.

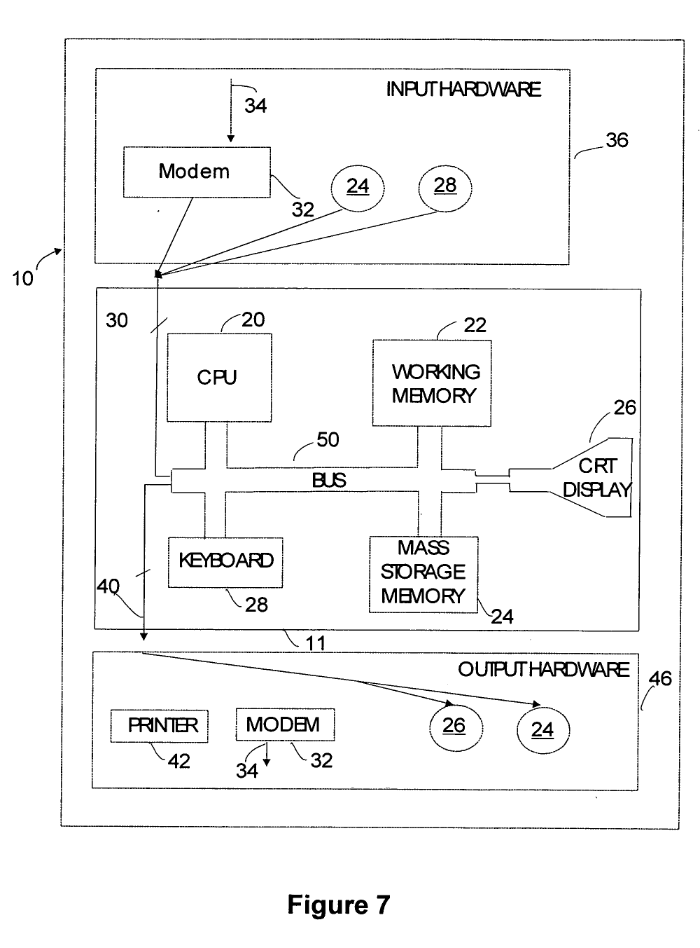

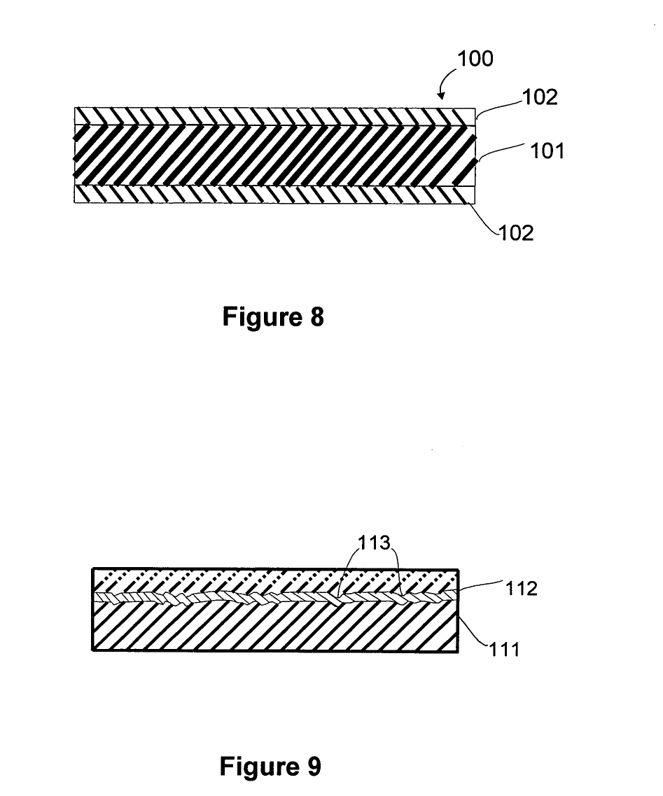

FIG. 9 shows a cross section of a magnetic data storage medium 100 which can be encoded with machine readable data, or set of instructions, for designing a synthetic molecule of the invention, which can be carried out by a system such as system 10 of FIG. 8. Medium 100 can be a conventional floppy diskette or hard disk, having a suitable substrate 101, which may be conventional, and a suitable coating 102, which may be conventional, on one or both sides, containing magnetic domains (not visible) whose polarity or orientation can be altered magnetically. Medium 100 may also have an opening (not shown) for receiving the spindle of a disk drive or other data storage device 24. The magnetic domains of coating 102 of medium 100 are polarized or oriented so as to encode in manner which may be conventional, machine readable data such as that described herein, for execution by a system such as system 10 of FIG. 8.

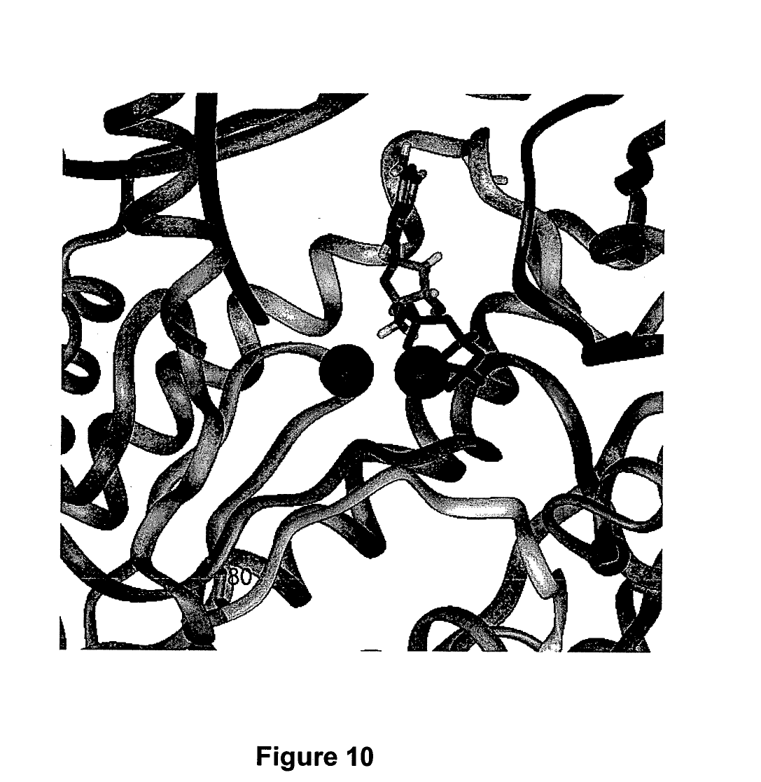

FIG. 10 shows a cross section of an optically readable data storage medium 110 which also can be encoded with such a machine-readable data, or set of instructions, for designing a synthetic molecule of the invention, which can be carried out by a system such as system 10 of FIG. 8. Medium 110 can be a conventional compact disk read only memory (CD-ROM) or a rewritable medium such as a magneto-optical disk, which is optically readable and magneto-optically writable. Medium 100 preferably has a suitable substrate 111, which may be conventional, and a suitable coating 112, which may be conventional, usually of one side of substrate 111.

In the case of CD-ROM, as is well known, coating 112 is reflective and is impressed with a plurality of pits 113 to encode the machine-readable data. The arrangement of pits is read by reflecting laser light off the surface of coating 112. A protective coating 114, which preferably is substantially transparent, is provided on top of coating 112.

In accordance with another aspect of the present invention, metal binding sites or regions are identified in the HBV DNA polymerase. Polymerase molecules require metal ions for catalysis. Two magnesium ions are required in the HIV polymerase and these are located near the aspartic acid residues 185 and 186. In addition to this metal binding region (defined by residues 205 and 206 in the present model), according to the present invention, three regions are identified containing clusters of histidine and cysteine residues.

These regions are defined by the amino acid residues selected from the list comprising: Metal Binding Site 1: rtE1, rtH12, rtH13, rtH160 and rtA162; Metal Binding Site 2: rtC-9, rtH-6, rtH90, rtL93, rtH234; Metal Binding Site 3: rtH197, rtC198, rtH216 and rtC213.

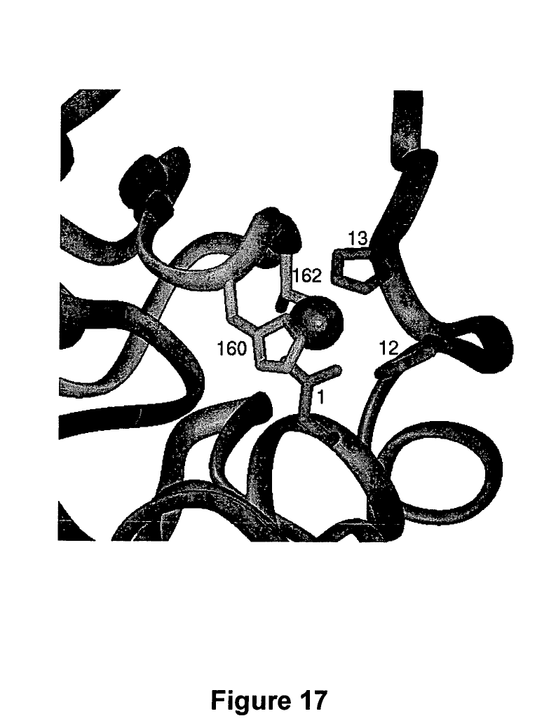

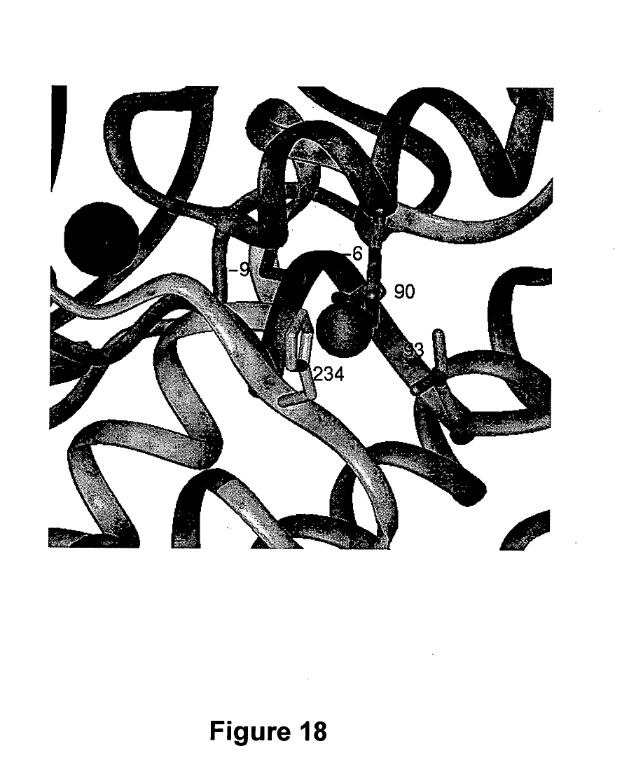

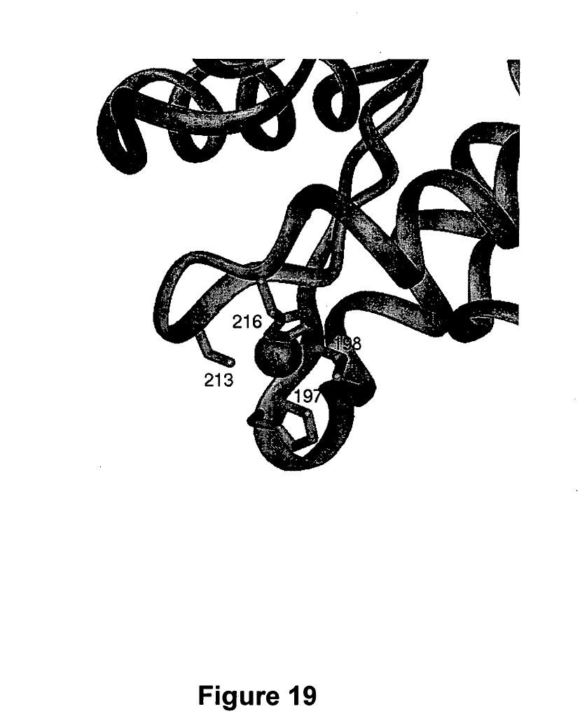

These metal binding sites are also shown in FIGS. 17, 18 and 19.

It has been previously demonstrated in other polymerase proteins that cysteine and histidine residues have an effect on metal-ion preference and are important for activity in that they affect the sensitivity and magnitude of induction. (Khan et al., Biochem Biophys Res Commun. 299(3):438-45, 2002; Wulfing et al., J Biol. Chem. 269(4):2895-901, 1994). These new binding sites are proposed to be involved in polymerase activity or associated functions such as RNA/DNA binding or strand transfer of the newly elongated strand. These additional metal binding sites for the HBV polymerase have not been previously identified are targets for antiviral compounds or diagnostic agents.

Accordingly, another aspect of the present invention is directed to an isolated fragment of an HBV polymerase comprising amino acid residues selected from (i) rtE1, rtH12, rtH13, rtH160, rtA162; (ii) rtC-9, rtH-6, rtH90, rtL93, rtH234; and (iii) rtH197, rtC198, rtH216 and rtC213, wherein said fragment is capable of binding a metal ion as shown in FIGS. 17, 18 and 19 and wherein said fragment is capable of binding a metal ion.

A further embodiment contemplates a method for screening for an anti-HBV agent or diagnostic agent said method comprising identifying a compound which is capable of binding, assocaiting with or otherwise interactng with a region of an HBV polymerase defind by amino acid residues selected from (i) rtE1, rtH12, rtH13, rtH160 and rtA162; (ii) rtC-9, rtH-6, rtH90, rtL93, rtH234; and (iii) rtH197, rtC198, rtH216 and rtC213 wherein said region is a metal ion binding site as shown in FIGS. 17, 18 and 19.

Anti-HBV agents identified according to this method may be used in a vaccine or as a diagnostic agent. In relation to the latter embodiment, a diagnostic agent is provided comprising a molecule capable of binding, associating with or interacting with a region of an HBV polymerase defined at or near amino acid residues selected from (i) rtE1, rtH12, rtH13, rtH160 and rtA162; (ii) rtC-9, rtH-6, rtH90, rtL93, rtH234; and (iii) rtH197, rtC198, rtH216 and rtC213, wherein said region is a metal ion binding site as shown in FIGS. 17, 18 and 19 wherein said region is a metal ion binding site. As a diagnostic agent, the agent may be labeled directly with a reporter molecule capable of providing an identifiable signal or the agent may be identified by use of, for example, antibodies or other ligands of the agent.

The present invention further provides the use of metal ion binding sites in the HBV DNA polymerase in the identification of an HBV binding agent or a metal ion binding-inhibiting agent in the manufacture of a medicament or diagnostic agent for the treatment or detection of HBV infection.

The present invention is further described by the following non-limiting examples.

### EXAMPLE 1

### Molecular Modeling of HBV Polymerase

HBV polymerase models were constructed using the crystal structures of human immunodeficiency virus (HIV) reverse transcriptase (1RTD) reported by Das et al., 2001, supra and moloney murine leukemia virus (MMLV) reverse transcriptase (1MML) by Georgiadis M M, Jessen S M, Ogata C M, Telesnitsky A, Goff S P, Hendrickson W A., Structure 3: 879, 1995 as the template for homology modeling.

The initial sequence alignment of HBV polymerase of sequence number −25 to 299 against HIV RT and MMLV RT was originally generated with ClustalW (Thompson J. D., Higgins, D. G. and Gibson, T. J. Nucleic Acids Research, 1994 22:4673-4680) using a BLOSUM 62 matrix followed by further manual alignment.

Secondary structure predictions of the HBV polymerase was based on the consensus of five independent secondary structure prediction algorithms: GORIV (Garnier J, Gibrat J-F, Robson B Methods in Enzymology 1996 R. F. Doolittle Ed., vol 266, 540-553), PHD (Rost B, Sander C Proc Natl Acad Sci USA. 1993 Aug. 15; 90(16):7558-62.), PsiPred (Jones D T. (1999), J. Mol. Biol. 292: 195-202), Sspro (G. Pollastri, D. Przybylski, B. Rost, and P. Baldi, Proteins, 47(2):228-235, 2002.), and SOMPA (Geourjon C, Deleage G, Comput Appl Biosci 1995 December; 11(6):681-684.).

Homology models of HBV polymerase were constructed manually using Sybyl6.9 (Tripos Sybyl; version 6.9 ed: 1699 South Hanley Road, St Louis, Mo. 63144, USA) such that regions of high sequence identity to the HIV and MMLV RT shared the same backbone conformation while flanking regions were modeled consistant with secondary structure predictions. A double stranded DNA molecule was also included before the model was further geometrically optimised using molecular dynamics simulations in Sybyl. Drug molecules were manually docked into the model with changes made to the complementary strand of DNA such that optimal base pairing could still occur. Molecular models were solvated in a 81 angstrom cube of water and subjected to NAMD molecular dynamics simulations (L Kale, R Skeel, M Bhandarkar, R Brunner, A Gursoy, N Krawetz, J Phillips, A Shinozaki, K Varadarajan, and K Schulten. Journal of Computational Physics, 151:283-312, 1999) for 1 nanosecond for a final structural equilibration.

### EXAMPLE 2

### HBV Polymerase

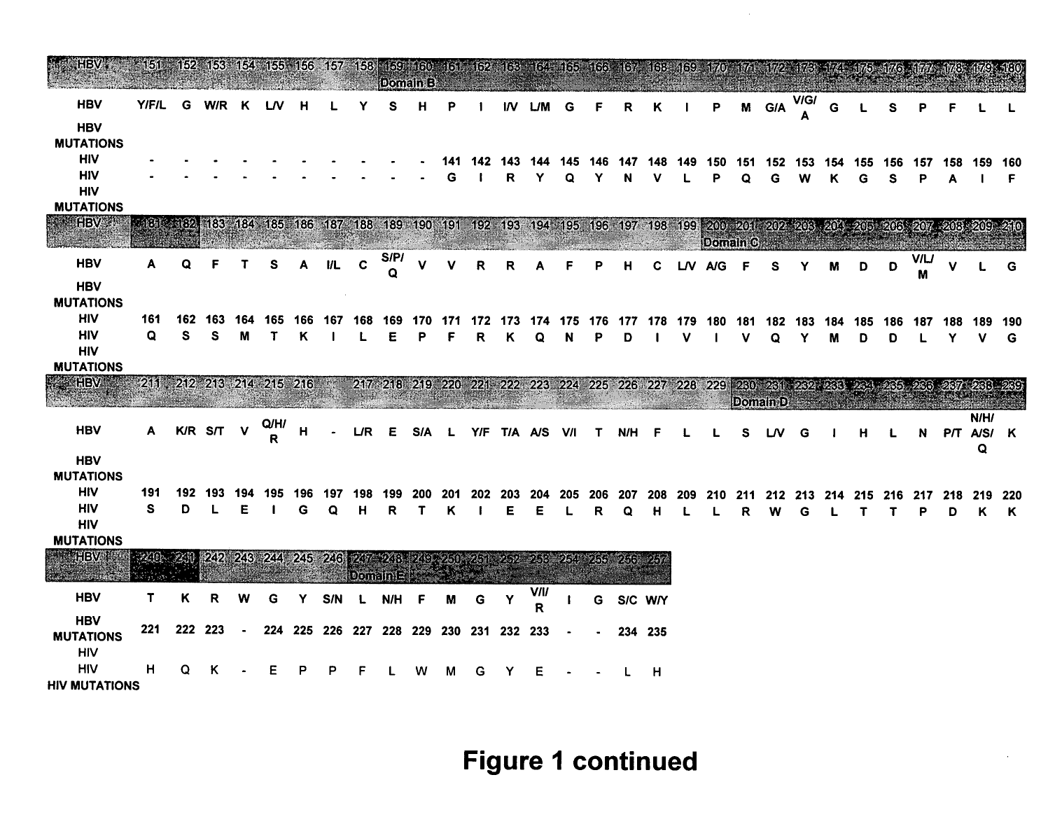

The molecular model of an HBV polymerase was determined. The model is shown in FIG. 2.

### EXAMPLE 3

### Atomic Co-Ordinates

The atomic co-ordinates of the HBV polymerase are shown in Table 6.

### EXAMPLE 4

### LMV Resistance

L180M and M204 V and L180M and M204I

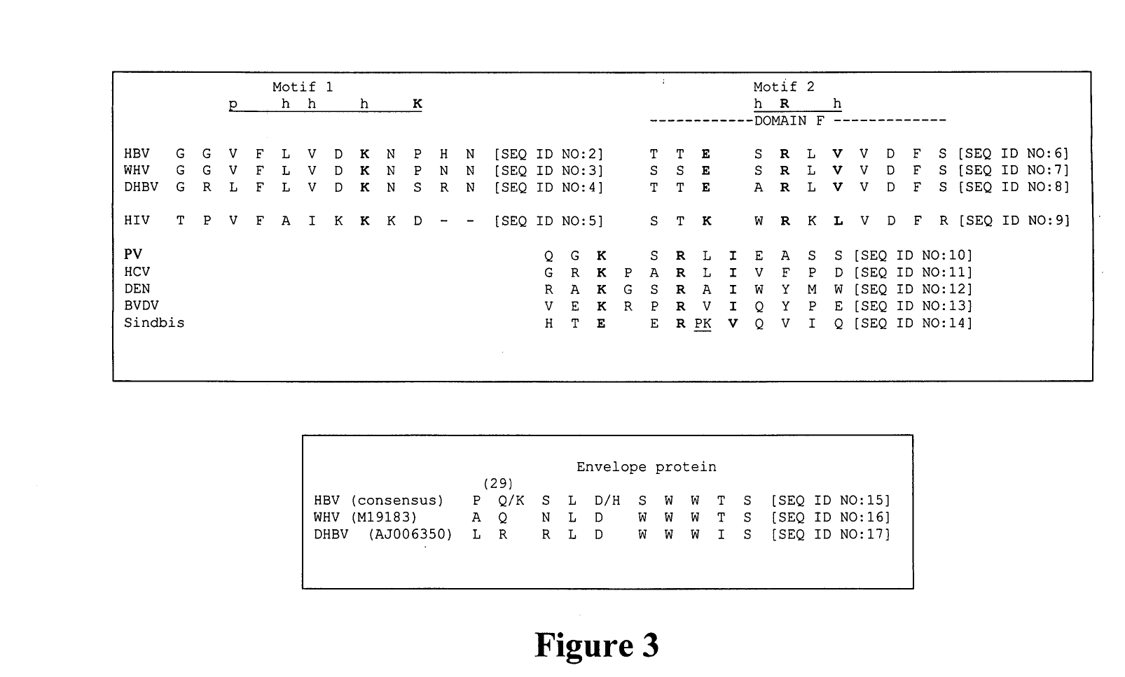

L180 has been mutated to methionine and M204 has been mutated to valine (FIG. 4). This steric hindrance gives rise to the resistance of LMV as it can no longer bind tightly in the binding site. The same effect is seen when M204 is mutated to isoleucine.

L80I

The leucine 80 mutation to isoleucine is a relatively conservative mutation, however, the branching of isoleucine at the β carbon as opposed to the γ carbon restricts the movement of this residue and reduces its backbone flexibility in comparison to leucine. As Leu80 is located in the junction of palm/thumb region of the binding site, it would be involved in some flexing of the binding site, the reduced flexing ability that isoleucine would possess compared to leucine may explain in part some of the drug resistance arising from this mutation. The results are shown in FIG. 10.

V173L

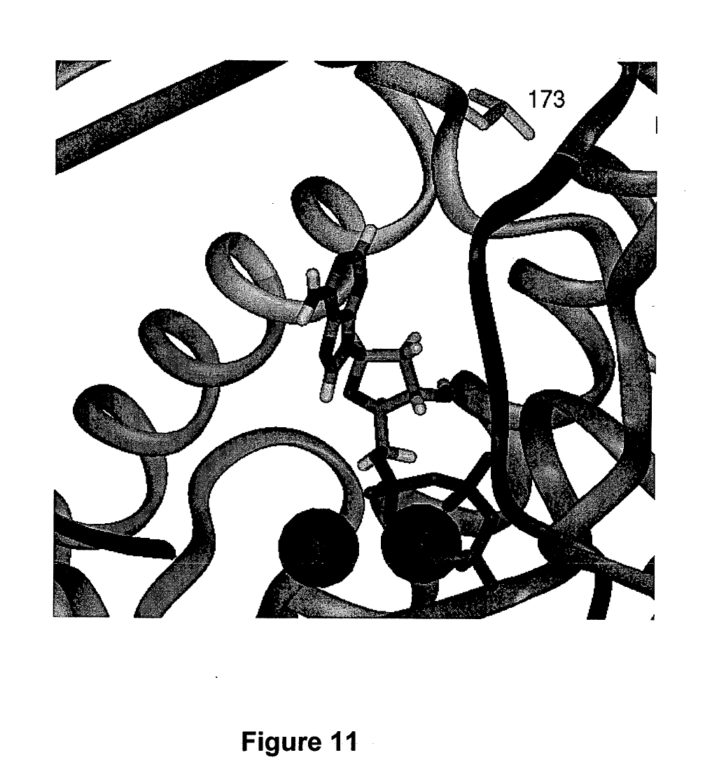

The mutation of valine 173 to Leucine alters the shape of the binding site by interacting with the phenylalanine 88, which forms part of the binding site. The additional space taken up by the larger leucine causes the aromatic ring of the phenylalanine to rotate further into the cavity of the bind site and thus altering the binding sites shape. It is proposed that this modification in the shape of the binding site gives rise to drug resistance. The results are shown in FIG. 11.

### EXAMPLE 5

### ADV Resistance

A181T

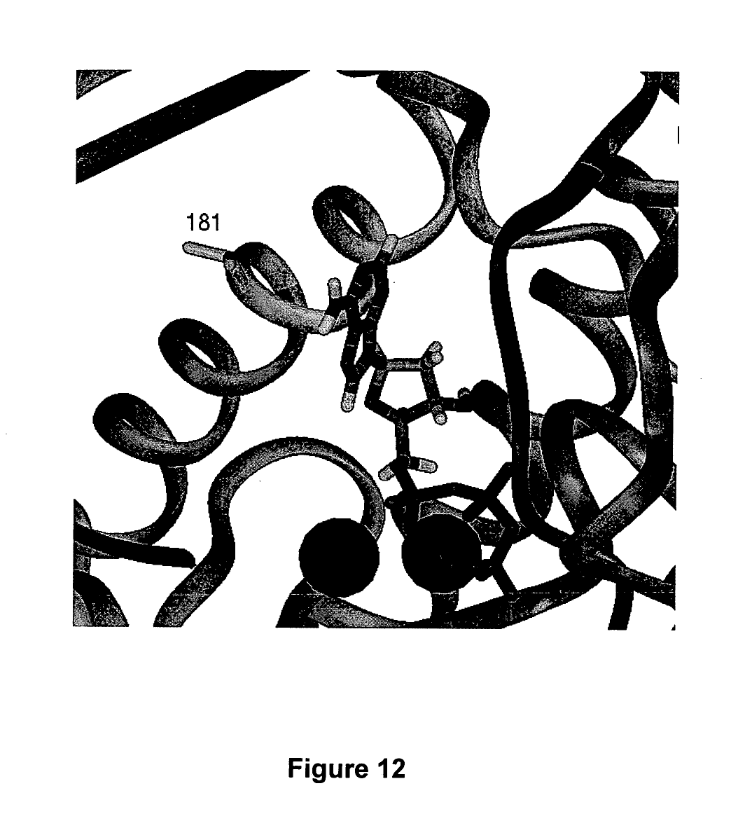

The alanine 181 mutation to threonine enables an additional hydrogen bond to be formed between the hydroxyl portion of threonine and the carbonyl oxygen of proline 177. This additional hydrogen bond will cause the helix, which is part of domain B, to bend and thus alter the shape of the binding site. This altered shape of the binding site is proposed to give rise to drug resistance. The results are shown in FIG. 12.

N236T

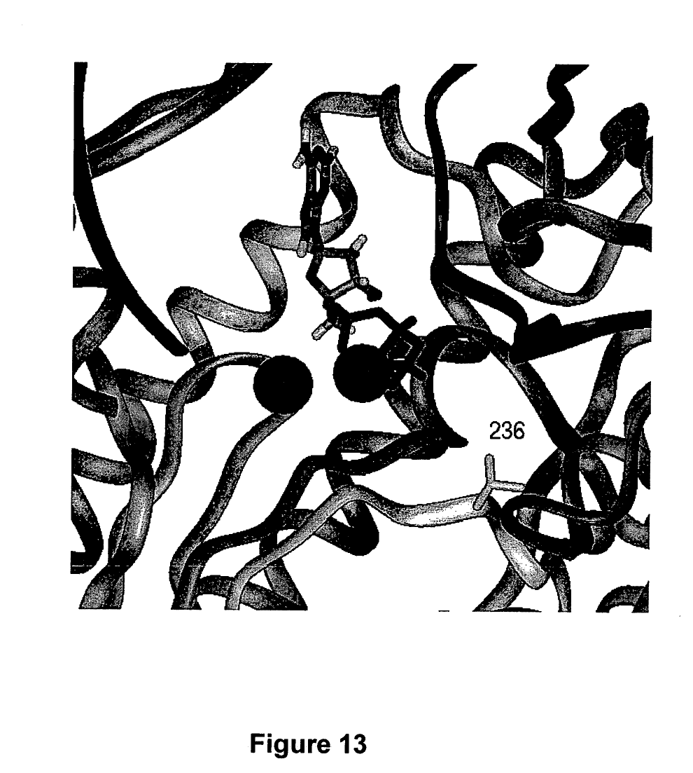

The mutation of asparagine 236 to threonine will result in the loss of a hydrogen bond between 236 and serine 85. The loss of this hydrogen bond may result in the binding site changing shape. In addition to this possible modification of the binding site serine 85 is directly involved in the binding of nucleoside inhibitors via a hydrogen bond to the y phosphate group. Thus the mutation of Asn 236 to Thr 236 may give rise to drug resistance via modifications of the binding site. The results are shown in FIG. 13.

### EXAMPLE 6

### ETV Resistance

A38E

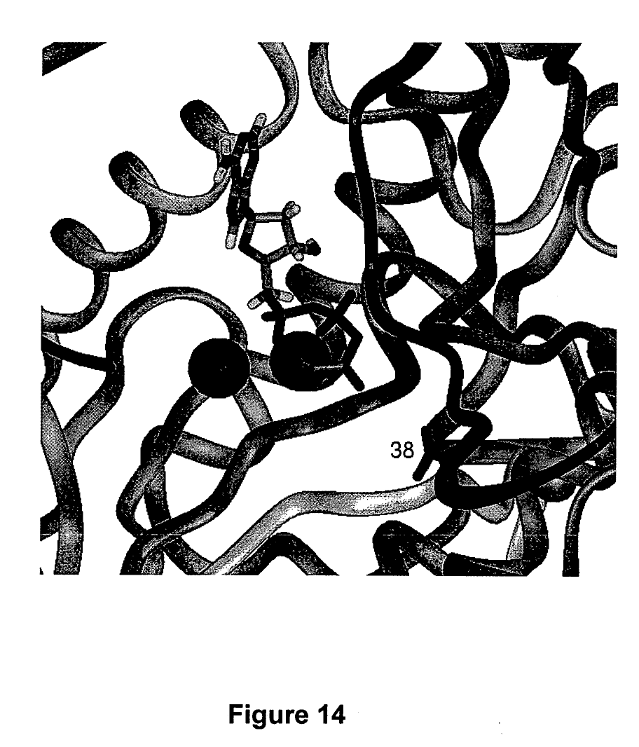

The mutation of alanine 38 to glutamic acid would alter the shape of domain F, which is involved in the binding of the nucleoside. As there is already a high concentration of negatively charged residues in domain F, additional negatively charged residues would hinder the binding of ETV due to unfavourable negative/negative charge interactions between these residues and the negatively charged phosphate groups. The results are shown in FIG. 14.

T184G

This mutation is similar to the A181T mutation in that both mutations result in a change in the bend of the helix. The highly flexible glycine residue enables the helix in domain B to bend to a much greater extent which in turn modifies the binding site of the nucleosides, resulting in drug resistance.

S202I

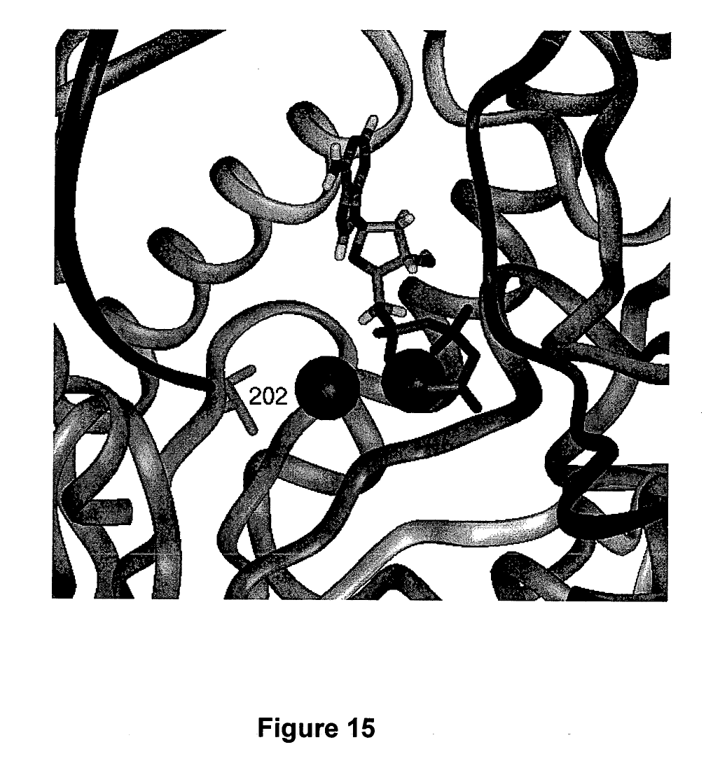

The mutation of serine 202 to isoleucine could cause a number of changes due to the much greater space that the isoleucine requires. The isoleucine 202 mutant occupies additional space between domains B and C where it is not present in the wild-type virus. The additional space isoleucine 202 requires causes slight movements of domain C up and domain B down; this in turn alters the binding site which gives rise to drug resistance. The results are shown in FIG. 15.

M250V

The methionine 250 to valine mutation is located at the turn in domain E that is in close proximity to the nucleoside-binding site. It is thought that this mutation will affect the packing of residues in the vicinity of the binding site and thus give rise to drug resistance.

### EXAMPLE 7

### Identification of Metal Binding Sites in HBV Polymerase

Polymerase molecules require metal ions for catalysis. Two magnesium ions are required in the HIV polymerase and these are located near the aspartic acid residues 185 and 186. In addition to this metal binding region (defined by residues 205 and 206 in the present model) three further regions are identified containing clusters of histidine and cysteine residues. It has been previously demonstrated in other polymerase proteins that cysteine and histidine residues have an effect on metal-ion preference and are important for activity in that they affect the sensitivity and magnitude of induction. (Khan et al., Biochem Biophys Res Commun. 299(3):438-45, 2002; Wulfing et al., J Biol. Chem. 269(4):2895-901, 1994). The proposed metal binding sites in the HBV polymerase model are shown in FIGS. 17, 18 and 19. Metal binding Site 1 includes residues rtE1, rtH12, rtH13 rtH160 and rtA162. Metal binding Site 2 includes residues rtC-9, rtH-6, rtH90, rtL93 and rtH234. Metal binding Site 3 includes residues rtH197, rtC198, rtH216 and rtC213. These new binding sites may be involved in polymerase activity or associated functions such as RNA/DNA binding or strand transfer of the newly elongated strand. These additional metal binding sites for the HBV polymerase have not been previously identified and may be targets for antiviral compounds.

### EXAMPLE 8

### In Vitro Resistance Testing

The mutation rtS85A was chosen to test in an antiviral resistance testing assay due to (a) it proposed location near rtN236T and the tri-phosphate binding site in a homology model of the HBV polymerase (b) This mutation was detected in HBV isolated from a patient not on ADV suggesting that this mutation could exist as a dominate replicating species in a patient

(a) Creation of Mutations by Site-Directed Mutagenesis in the HBV Infectious Clone

The plasmid containing 1.3×HBV genome in the vector pBlueBac4.5 was used as the infectious HBV clone. This clone already had the precore mutation at G1896A. The point mutation were created by site directed mutagenesis using the commercial kits according to the manufacturers specifications (QuikChange, Stratagene). A HBV recombinant encoding the reverse transcriptase mutations rtS85A was created. The nucleotide sequence of the plasmid and the point mutations generated by site directed mutagenesis were confirmed by sequencing using the ABI Prism Big Dye Terminator Cycle Sequencing Ready Reaction Kit according to the manufacturer's specifications (Perkin Elmer, Cetus Norwalk, Conn.).

(b) Transfection of HepG2 Cells with Plasmid DNA and Antiviral Treatments

Huh7 cells were seeded at approximately 20-40% confluency and then were grown for 16-24 hours before transfection. Plasmid DNA containing HBV encoding specific mutations was transfected using Fugene according to the manufacturers protocols.

ADV and LMV were resuspended in sterile water, aliquoted, and frozen at −20° C. to avoid repeated freezing and thawing of the drug. Medium containing ADV or LMV were prepared daily as needed. In experiments in which ADV or LMV treatment was initiated 2 hr prior to transfection, Huh7 cells were exposed to the indicated concentration of ADV or LMV immediately after transfection with the HBV plasmid.

(c) Analysis of HBV Replicative Intermediates

Analysis of Secreted HBV Antigen

Detection of hepatitis Be antigen (HBeAg) and hepatitis B surface antigen (HBsAg) were performed by radioimmunoassay and microparticle enzyme immunoassay using kits purchased from Abbott Laboratories (Abbott Park, Ill., USA). Medium from Huh7 cells was collected, centrifuged at 6,000 g to remove cellular debris, transferred to clean tubes, and stored at 20° C. until analysis. HBeAg and HBsAg values are expressed as fold of positive control. Medium samples were diluted appropriately so that radioimmunassay results were below positive control values for HBeAg or HBsAg, respectively.

Detection of Intracellular Replicative Intermediates

HBV core particles were isolated from the cytoplasmic fraction of Huh7 cells lysis buffer which includes 0.5% w/v NP-40. Cytoplasmic extracts were treated with DNAse, adjusted to 10 mmol/l McCl2 and unprotected DNA was removed by an incubation to 500 g/ml Proteinase K for 1.5 hours at 37° C. HBV DNA in the samples were then extracted using commercial DNA extraction kits such as Qiagen (DNA extraction) or in-house methods using sequential phenol and chloroform extractions, and the nucleic acids were recovered by ethanol precipitation. Nucleic acids were resuspended in 50 μl/1 TE (10 mmol/l Tris, 1 mmol/l ethylenediaminetetraacetic acid) or 5 mmol/l ethylenediaminetetraacetic acid, normalized by OD260, before analysis by electrophoresis and Southern blotting. After southern blot analysis a BioRad Phosphoimager and the Quantity One Analysis software (BioRad, Hecules Calif.) was used to analyze suitable exposures of Southern blots. Densitometry data was fitted to logistic dose response curves using the TableCurve 2D software package from Jandel Scientific. Logistic dose response equations were used to calculate IC₅₀ and IC₉₀ values and co-efficients of variation.

Antiviral Testing Performed with HBV Plasmid Encoding rtS85A

The dose effect of ADV and LMV on HBV encoding rtS85A is shown in FIG. 21 using the ADV (0 μM) and LMV (0 μM) as controls, There was reduced sensitivity to ADV by the recombinant HBV encoding the mutant rtS85A. The HBV precore mutant has an IC50 of 0.43 μM for ADV and an IC50 for LMV at 0.005 μM. In contrast, the mutant encoding the additional rtS85A had an IC50 for LMV at 0.01 μM and between 5-10 μM for ADV.

TABLE 6
Atomic co-ordinates
HBV polymerase model_040504_a1

| | | | | | | | | | | | |
|---|---|---|---|---|---|---|---|---|---|---|---|
| ATOM | 1 | N | GLY | A | 975 | 9.098 | −21.241 | 2.066 | 1.00 | 1.00 | N |
| ATOM | 2 | CA | GLY | A | 975 | 8.102 | −20.156 | 1.866 | 1.00 | 1.00 | C |
| ATOM | 3 | C | GLY | A | 975 | 8.475 | −19.295 | 0.703 | 1.00 | 1.00 | C |
| ATOM | 4 | O | GLY | A | 975 | 9.547 | −19.538 | 0.180 | 1.00 | 1.00 | O |
| ATOM | 5 | HA2 | GLY | A | 975 | 8.160 | −19.464 | 2.700 | 1.00 | 1.00 | H |
| ATOM | 6 | HA1 | GLY | A | 975 | 7.068 | −20.429 | 1.711 | 1.00 | 1.00 | H |
| ATOM | 7 | HN | GLY | A | 975 | 10.068 | −21.038 | 2.032 | 1.00 | 1.00 | H |
| ATOM | 8 | H | GLY | A | 975 | 8.831 | −22.032 | 2.624 | 1.00 | 1.00 | H |
| ATOM | 9 | N | PRO | A | 976 | 7.694 | −18.239 | 0.381 | 1.00 | 1.00 | N |
| ATOM | 10 | CA | PRO | A | 976 | 8.239 | −17.093 | −0.391 | 1.00 | 1.00 | C |
| ATOM | 11 | C | PRO | A | 976 | 9.103 | −16.394 | 0.644 | 1.00 | 1.00 | C |
| ATOM | 12 | O | PRO | A | 976 | 8.839 | −15.286 | 1.103 | 1.00 | 1.00 | O |
| ATOM | 13 | CB | PRO | A | 976 | 6.968 | −16.248 | −0.736 | 1.00 | 1.00 | C |
| ATOM | 14 | CG | PRO | A | 976 | 6.153 | −16.498 | 0.584 | 1.00 | 1.00 | C |
| ATOM | 15 | CD | PRO | A | 976 | 6.316 | −18.040 | 0.847 | 1.00 | 1.00 | C |
| ATOM | 16 | HA | PRO | A | 976 | 8.746 | −17.334 | −1.341 | 1.00 | 1.00 | H |
| ATOM | 17 | HD2 | PRO | A | 976 | 5.743 | −18.680 | 0.172 | 1.00 | 1.00 | H |
| ATOM | 18 | HD1 | PRO | A | 976 | 6.032 | −18.268 | 1.873 | 1.00 | 1.00 | H |
| ATOM | 19 | HG2 | PRO | A | 976 | 5.092 | −16.273 | 0.332 | 1.00 | 1.00 | H |
| ATOM | 20 | HG1 | PRO | A | 976 | 6.431 | −15.956 | 1.524 | 1.00 | 1.00 | H |
| ATOM | 21 | HB1 | PRO | A | 976 | 6.340 | −16.596 | −1.618 | 1.00 | 1.00 | H |
| ATOM | 22 | HB2 | PRO | A | 976 | 7.130 | −15.172 | −0.885 | 1.00 | 1.00 | H |
| ATOM | 23 | N | CYS | A | 977 | 10.213 | −17.040 | 1.020 | 1.00 | 1.00 | N |
| ATOM | 24 | CA | CYS | A | 977 | 10.934 | −16.779 | 2.278 | 1.00 | 1.00 | C |
| ATOM | 25 | C | CYS | A | 977 | 11.315 | −18.145 | 2.923 | 1.00 | 1.00 | C |
| ATOM | 26 | O | CYS | A | 977 | 10.624 | −19.138 | 2.692 | 1.00 | 1.00 | O |
| ATOM | 27 | CB | CYS | A | 977 | 10.232 | −16.076 | 3.452 | 1.00 | 1.00 | C |
| ATOM | 28 | SG | CYS | A | 977 | 8.579 | −16.705 | 3.742 | 1.00 | 1.00 | S |
| ATOM | 29 | HA | CYS | A | 977 | 11.884 | −16.200 | 2.086 | 1.00 | 1.00 | H |
| ATOM | 30 | HB1 | CYS | A | 977 | 10.119 | −15.007 | 3.159 | 1.00 | 1.00 | H |
| ATOM | 31 | HB2 | CYS | A | 977 | 10.873 | −16.007 | 4.345 | 1.00 | 1.00 | H |
| ATOM | 32 | HG | CYS | A | 977 | 8.328 | −16.030 | 4.413 | 1.00 | 1.00 | H |
| ATOM | 33 | HN | CYS | A | 977 | 10.586 | −17.761 | 0.446 | 1.00 | 1.00 | H |
| ATOM | 34 | N | TRP | A | 978 | 12.404 | −18.253 | 3.753 | 1.00 | 1.00 | N |
| ATOM | 35 | CA | TRP | A | 978 | 12.903 | −19.526 | 4.280 | 1.00 | 1.00 | C |
| ATOM | 36 | C | TRP | A | 978 | 12.971 | −19.279 | 5.751 | 1.00 | 1.00 | C |
| ATOM | 37 | O | TRP | A | 978 | 14.045 | −19.317 | 6.312 | 1.00 | 1.00 | O |
| ATOM | 38 | CB | TRP | A | 978 | 14.210 | −19.696 | 3.508 | 1.00 | 1.00 | C |
| ATOM | 39 | CG | TRP | A | 978 | 13.858 | −19.779 | 2.007 | 1.00 | 1.00 | C |
| ATOM | 40 | CD1 | TRP | A | 978 | 14.255 | −18.931 | 1.034 | 1.00 | 1.00 | C |
| ATOM | 41 | CD2 | TRP | A | 978 | 13.135 | −20.910 | 1.361 | 1.00 | 1.00 | C |
| ATOM | 42 | NE1 | TRP | A | 978 | 13.746 | −19.324 | −0.125 | 1.00 | 1.00 | N |
| ATOM | 43 | CE2 | TRP | A | 978 | 13.011 | −20.448 | 0.067 | 1.00 | 1.00 | C |
| ATOM | 44 | CE3 | TRP | A | 978 | 12.659 | −22.140 | 1.784 | 1.00 | 1.00 | C |
| ATOM | 45 | CZ2 | TRP | A | 978 | 12.224 | −21.127 | −0.872 | 1.00 | 1.00 | C |
| ATOM | 46 | CZ3 | TRP | A | 978 | 11.866 | −22.882 | 0.854 | 1.00 | 1.00 | C |
| ATOM | 47 | CH2 | TRP | A | 978 | 11.660 | −22.335 | −0.450 | 1.00 | 1.00 | C |
| ATOM | 48 | HA | TRP | A | 978 | 12.303 | −20.426 | 4.162 | 1.00 | 1.00 | H |
| ATOM | 49 | HB1 | TRP | A | 978 | 14.781 | −20.559 | 3.898 | 1.00 | 1.00 | H |
| ATOM | 50 | HB2 | TRP | A | 978 | 14.787 | −18.761 | 3.703 | 1.00 | 1.00 | H |
| ATOM | 51 | HE1 | TRP | A | 978 | 13.851 | −18.871 | −1.036 | 1.00 | 1.00 | H |
| ATOM | 52 | HD1 | TRP | A | 978 | 14.890 | −18.065 | 1.234 | 1.00 | 1.00 | H |
| ATOM | 53 | HZ2 | TRP | A | 978 | 12.028 | −20.755 | −1.865 | 1.00 | 1.00 | H |
| ATOM | 54 | HH2 | TRP | A | 978 | 11.070 | −22.901 | −1.196 | 1.00 | 1.00 | H |
| ATOM | 55 | HZ3 | TRP | A | 978 | 11.510 | −23.880 | 1.096 | 1.00 | 1.00 | H |
| ATOM | 56 | HE3 | TRP | A | 978 | 12.886 | −22.518 | 2.785 | 1.00 | 1.00 | H |
| ATOM | 57 | HN | TRP | A | 978 | 12.874 | −17.448 | 4.099 | 1.00 | 1.00 | H |
| ATOM | 58 | N | TRP | A | 979 | 11.812 | −18.977 | 6.404 | 1.00 | 1.00 | N |
| ATOM | 59 | CA | TRP | A | 979 | 11.780 | −18.720 | 7.806 | 1.00 | 1.00 | C |
| ATOM | 60 | C | TRP | A | 979 | 10.375 | −18.911 | 8.325 | 1.00 | 1.00 | C |
| ATOM | 61 | O | TRP | A | 979 | 9.652 | −19.534 | 7.591 | 1.00 | 1.00 | O |
| ATOM | 62 | CB | TRP | A | 979 | 12.411 | −17.325 | 8.050 | 1.00 | 1.00 | C |
| ATOM | 63 | CG | TRP | A | 979 | 11.563 | −16.098 | 7.828 | 1.00 | 1.00 | C |
| ATOM | 64 | CD1 | TRP | A | 979 | 10.474 | −15.996 | 7.075 | 1.00 | 1.00 | C |
| ATOM | 65 | CD2 | TRP | A | 979 | 11.906 | −14.754 | 8.421 | 1.00 | 1.00 | C |
| ATOM | 66 | NE1 | TRP | A | 979 | 10.179 | −14.746 | 7.060 | 1.00 | 1.00 | N |
| ATOM | 67 | CE2 | TRP | A | 979 | 10.933 | −13.967 | 7.829 | 1.00 | 1.00 | C |
| ATOM | 68 | CE3 | TRP | A | 979 | 12.887 | −14.240 | 9.249 | 1.00 | 1.00 | C |
| ATOM | 69 | CZ2 | TRP | A | 979 | 10.853 | −12.583 | 8.059 | 1.00 | 1.00 | C |
| ATOM | 70 | CZ3 | TRP | A | 979 | 12.875 | −12.856 | 9.348 | 1.00 | 1.00 | C |
| ATOM | 71 | CH2 | TRP | A | 979 | 11.857 | −12.015 | 8.842 | 1.00 | 1.00 | C |
| ATOM | 72 | HA | TRP | A | 979 | 12.390 | −19.555 | 8.245 | 1.00 | 1.00 | H |
| ATOM | 73 | HB1 | TRP | A | 979 | 13.281 | −17.243 | 7.359 | 1.00 | 1.00 | H |
| ATOM | 74 | HB2 | TRP | A | 979 | 12.885 | −17.287 | 9.026 | 1.00 | 1.00 | H |
| ATOM | 75 | HE1 | TRP | A | 979 | 9.422 | −14.396 | 6.502 | 1.00 | 1.00 | H |
| ATOM | 76 | HD1 | TRP | A | 979 | 10.001 | −16.788 | 6.498 | 1.00 | 1.00 | H |
| ATOM | 77 | HZ2 | TRP | A | 979 | 10.044 | −12.046 | 7.630 | 1.00 | 1.00 | H |
| ATOM | 78 | HH2 | TRP | A | 979 | 11.868 | −10.941 | 9.048 | 1.00 | 1.00 | H |
| ATOM | 79 | HZ3 | TRP | A | 979 | 13.717 | −12.380 | 9.866 | 1.00 | 1.00 | H |
| ATOM | 80 | HE3 | TRP | A | 979 | 13.638 | −14.910 | 9.707 | 1.00 | 1.00 | H |
| ATOM | 81 | HN | TRP | A | 979 | 10.934 | −18.878 | 5.904 | 1.00 | 1.00 | H |
| ATOM | 82 | N | LEU | A | 980 | 9.949 | −18.352 | 9.492 | 1.00 | 1.00 | N |
| ATOM | 83 | CA | LEU | A | 980 | 8.536 | −18.570 | 9.907 | 1.00 | 1.00 | C |
| ATOM | 84 | C | LEU | A | 980 | 7.678 | −17.767 | 8.911 | 1.00 | 1.00 | C |
| ATOM | 85 | O | LEU | A | 980 | 8.165 | −16.797 | 8.351 | 1.00 | 1.00 | O |
| ATOM | 86 | CB | LEU | A | 980 | 8.093 | −18.124 | 11.304 | 1.00 | 1.00 | C |
| ATOM | 87 | CG | LEU | A | 980 | 8.558 | −19.071 | 12.431 | 1.00 | 1.00 | C |
| ATOM | 88 | CD1 | LEU | A | 980 | 7.859 | −20.460 | 12.488 | 1.00 | 1.00 | C |
| ATOM | 89 | CD2 | LEU | A | 980 | 10.106 | −19.229 | 12.414 | 1.00 | 1.00 | C |
| ATOM | 90 | HA | LEU | A | 980 | 8.217 | −19.654 | 9.833 | 1.00 | 1.00 | H |
| ATOM | 91 | HB1 | LEU | A | 980 | 7.002 | −18.077 | 11.361 | 1.00 | 1.00 | H |
| ATOM | 92 | HB2 | LEU | A | 980 | 8.499 | −17.104 | 11.459 | 1.00 | 1.00 | H |
| ATOM | 93 | HG | LEU | A | 980 | 8.335 | −18.497 | 13.389 | 1.00 | 1.00 | H |
| ATOM | 94 | HD21 | LEU | A | 980 | 10.686 | −18.251 | 12.496 | 1.00 | 1.00 | H |
| ATOM | 95 | HD22 | LEU | A | 980 | 10.412 | −19.746 | 11.469 | 1.00 | 1.00 | H |
| ATOM | 96 | HD23 | LEU | A | 980 | 10.400 | −19.792 | 13.299 | 1.00 | 1.00 | H |
| ATOM | 97 | HD11 | LEU | A | 980 | 6.770 | −20.393 | 12.300 | 1.00 | 1.00 | H |
| ATOM | 98 | HD12 | LEU | A | 980 | 8.089 | −20.994 | 13.463 | 1.00 | 1.00 | H |
| ATOM | 99 | HD13 | LEU | A | 980 | 8.273 | −21.106 | 11.703 | 1.00 | 1.00 | H |
| ATOM | 100 | HN | LEU | A | 980 | 10.501 | −17.727 | 10.060 | 1.00 | 1.00 | H |
| ATOM | 101 | N | GLN | A | 981 | 6.356 | −18.115 | 8.799 | 1.00 | 1.00 | N |
| ATOM | 102 | CA | GLN | A | 981 | 5.528 | −17.601 | 7.675 | 1.00 | 1.00 | C |
| ATOM | 103 | C | GLN | A | 981 | 4.223 | −17.145 | 8.243 | 1.00 | 1.00 | C |
| ATOM | 104 | O | GLN | A | 981 | 3.245 | −17.266 | 7.532 | 1.00 | 1.00 | O |
| ATOM | 105 | CB | GLN | A | 981 | 5.310 | −18.750 | 6.639 | 1.00 | 1.00 | C |
| ATOM | 106 | CG | GLN | A | 981 | 6.619 | −19.544 | 6.286 | 1.00 | 1.00 | C |
| ATOM | 107 | CD | GLN | A | 981 | 6.335 | −20.618 | 5.259 | 1.00 | 1.00 | C |
| ATOM | 108 | OE1 | GLN | A | 981 | 6.635 | −20.365 | 4.105 | 1.00 | 1.00 | O |
| ATOM | 109 | NE2 | GLN | A | 981 | 5.814 | −21.810 | 5.657 | 1.00 | 1.00 | N |
| ATOM | 110 | HA | GLN | A | 981 | 5.976 | −16.723 | 7.194 | 1.00 | 1.00 | H |
| ATOM | 111 | HB1 | GLN | A | 981 | 4.962 | −18.353 | 5.657 | 1.00 | 1.00 | H |
| ATOM | 112 | HB2 | GLN | A | 981 | 4.561 | −19.485 | 6.957 | 1.00 | 1.00 | H |
| ATOM | 113 | HG1 | GLN | A | 981 | 7.096 | −19.978 | 7.189 | 1.00 | 1.00 | H |
| ATOM | 114 | HG2 | GLN | A | 981 | 7.383 | −18.836 | 5.880 | 1.00 | 1.00 | H |
| ATOM | 115 | HE22 | GLN | A | 981 | 5.601 | −22.529 | 4.974 | 1.00 | 1.00 | H |
| ATOM | 116 | HE21 | GLN | A | 981 | 5.512 | −22.039 | 6.591 | 1.00 | 1.00 | H |
| ATOM | 117 | HN | GLN | A | 981 | 5.961 | −18.762 | 9.399 | 1.00 | 1.00 | H |
| ATOM | 118 | N | PHE | A | 982 | 4.105 | −16.633 | 9.472 | 1.00 | 1.00 | N |
| ATOM | 119 | CA | PHE | A | 982 | 2.784 | −16.333 | 10.045 | 1.00 | 1.00 | C |
| ATOM | 120 | C | PHE | A | 982 | 2.726 | −15.137 | 10.982 | 1.00 | 1.00 | C |
| ATOM | 121 | O | PHE | A | 982 | 2.312 | −15.283 | 12.123 | 1.00 | 1.00 | O |
| ATOM | 122 | CB | PHE | A | 982 | 2.224 | −17.590 | 10.765 | 1.00 | 1.00 | C |
| ATOM | 123 | CG | PHE | A | 982 | 2.227 | −18.789 | 9.742 | 1.00 | 1.00 | C |
| ATOM | 124 | CD1 | PHE | A | 982 | 1.206 | −18.844 | 8.816 | 1.00 | 1.00 | C |
| ATOM | 125 | CD2 | PHE | A | 982 | 3.225 | −19.759 | 9.780 | 1.00 | 1.00 | C |
| ATOM | 126 | CE1 | PHE | A | 982 | 1.288 | −19.743 | 7.747 | 1.00 | 1.00 | C |
| ATOM | 127 | CE2 | PHE | A | 982 | 3.160 | −20.822 | 8.855 | 1.00 | 1.00 | C |
| ATOM | 128 | CZ | PHE | A | 982 | 2.212 | −20.803 | 7.821 | 1.00 | 1.00 | C |
| ATOM | 129 | HA | PHE | A | 982 | 2.169 | −16.042 | 9.196 | 1.00 | 1.00 | H |
| ATOM | 130 | HB1 | PHE | A | 982 | 1.207 | −17.356 | 11.119 | 1.00 | 1.00 | H |
| ATOM | 131 | HB2 | PHE | A | 982 | 2.838 | −17.955 | 11.617 | 1.00 | 1.00 | H |
| ATOM | 132 | HD2 | PHE | A | 982 | 4.060 | −19.775 | 10.510 | 1.00 | 1.00 | H |
| ATOM | 133 | HE2 | PHE | A | 982 | 3.844 | −21.670 | 8.866 | 1.00 | 1.00 | H |
| ATOM | 134 | HZ | PHE | A | 982 | 2.191 | −21.608 | 7.073 | 1.00 | 1.00 | H |
| ATOM | 135 | HE1 | PHE | A | 982 | 0.618 | −19.693 | 6.890 | 1.00 | 1.00 | H |
| ATOM | 136 | HD1 | PHE | A | 982 | 0.356 | −18.149 | 8.915 | 1.00 | 1.00 | H |
| ATOM | 137 | HN | PHE | A | 982 | 4.885 | −16.435 | 10.024 | 1.00 | 1.00 | H |
| ATOM | 138 | N | ARG | A | 983 | 2.979 | −13.908 | 10.540 | 1.00 | 1.00 | N |
| ATOM | 139 | CA | ARG | A | 983 | 2.796 | −12.715 | 11.368 | 1.00 | 1.00 | C |
| ATOM | 140 | C | ARG | A | 983 | 1.340 | −12.382 | 11.184 | 1.00 | 1.00 | C |
| ATOM | 141 | O | ARG | A | 983 | 1.082 | −11.344 | 10.610 | 1.00 | 1.00 | O |
| ATOM | 142 | CB | ARG | A | 983 | 3.793 | −11.545 | 11.056 | 1.00 | 1.00 | C |
| ATOM | 143 | CG | ARG | A | 983 | 5.246 | −11.751 | 11.711 | 1.00 | 1.00 | C |
| ATOM | 144 | CD | ARG | A | 983 | 6.078 | −12.805 | 10.867 | 1.00 | 1.00 | C |
| ATOM | 145 | NE | ARG | A | 983 | 7.506 | −12.891 | 11.153 | 1.00 | 1.00 | N |
| ATOM | 146 | CZ | ARG | A | 983 | 8.378 | −13.721 | 10.578 | 1.00 | 1.00 | C |
| ATOM | 147 | NH1 | ARG | A | 983 | 8.002 | −14.619 | 9.726 | 1.00 | 1.00 | N |
| ATOM | 148 | NH2 | ARG | A | 983 | 9.624 | −13.679 | 10.845 | 1.00 | 1.00 | N |
| ATOM | 149 | HA | ARG | A | 983 | 2.885 | −12.968 | 12.437 | 1.00 | 1.00 | H |
| ATOM | 150 | HB1 | ARG | A | 983 | 3.335 | −10.663 | 11.481 | 1.00 | 1.00 | H |
| ATOM | 151 | HB2 | ARG | A | 983 | 3.883 | −11.340 | 9.959 | 1.00 | 1.00 | H |
| ATOM | 152 | HG1 | ARG | A | 983 | 5.151 | −12.042 | 12.764 | 1.00 | 1.00 | H |
| ATOM | 153 | HG2 | ARG | A | 983 | 5.836 | −10.850 | 11.621 | 1.00 | 1.00 | H |
| ATOM | 154 | HD1 | ARG | A | 983 | 6.046 | −12.546 | 9.805 | 1.00 | 1.00 | H |
| ATOM | 155 | HD2 | ARG | A | 983 | 5.652 | −13.830 | 11.091 | 1.00 | 1.00 | H |
| ATOM | 156 | HE | ARG | A | 983 | 7.841 | −12.217 | 11.851 | 1.00 | 1.00 | H |
| ATOM | 157 | HH12 | ARG | A | 983 | 8.675 | −15.220 | 9.280 | 1.00 | 1.00 | H |
| ATOM | 158 | HH11 | ARG | A | 983 | 7.057 | −14.760 | 9.402 | 1.00 | 1.00 | H |
| ATOM | 159 | HH22 | ARG | A | 983 | 10.306 | −14.333 | 10.437 | 1.00 | 1.00 | H |
| ATOM | 160 | HH21 | ARG | A | 983 | 9.927 | −13.118 | 11.581 | 1.00 | 1.00 | H |
| ATOM | 161 | HN | ARG | A | 983 | 3.300 | −13.774 | 9.618 | 1.00 | 1.00 | H |
| ATOM | 162 | N | ASN | A | 984 | 0.370 | −13.280 | 11.623 | 1.00 | 1.00 | N |
| ATOM | 163 | CA | ASN | A | 984 | −1.048 | −12.964 | 11.440 | 1.00 | 1.00 | C |
| ATOM | 164 | C | ASN | A | 984 | −1.253 | −11.669 | 12.172 | 1.00 | 1.00 | C |
| ATOM | 165 | O | ASN | A | 984 | −0.487 | −11.361 | 13.084 | 1.00 | 1.00 | O |
| ATOM | 166 | CB | ASN | A | 984 | −1.992 | −14.031 | 12.086 | 1.00 | 1.00 | C |
| ATOM | 167 | CG | ASN | A | 984 | −1.687 | −15.381 | 11.509 | 1.00 | 1.00 | C |
| ATOM | 168 | OD1 | ASN | A | 984 | −0.957 | −16.111 | 12.155 | 1.00 | 1.00 | O |
| ATOM | 169 | ND2 | ASN | A | 984 | −2.127 | −15.663 | 10.252 | 1.00 | 1.00 | N |
| ATOM | 170 | HA | ASN | A | 984 | −1.166 | −12.815 | 10.323 | 1.00 | 1.00 | H |
| ATOM | 171 | HB1 | ASN | A | 984 | −3.041 | −13.772 | 11.961 | 1.00 | 1.00 | H |
| ATOM | 172 | HB2 | ASN | A | 984 | −1.801 | −14.115 | 13.177 | 1.00 | 1.00 | H |
| ATOM | 173 | HD22 | ASN | A | 984 | −1.772 | −16.510 | 9.835 | 1.00 | 1.00 | H |
| ATOM | 174 | HD21 | ASN | A | 984 | −2.660 | −15.012 | 9.719 | 1.00 | 1.00 | H |
| ATOM | 175 | HN | ASN | A | 984 | 0.608 | −14.108 | 12.210 | 1.00 | 1.00 | H |
| ATOM | 176 | N | SER | A | 985 | −2.310 | −10.838 | 11.864 | 1.00 | 1.00 | N |
| ATOM | 177 | CA | SER | A | 985 | −2.464 | −9.571 | 12.582 | 1.00 | 1.00 | C |
| ATOM | 178 | C | SER | A | 985 | −3.890 | −9.044 | 12.469 | 1.00 | 1.00 | C |
| ATOM | 179 | O | SER | A | 985 | −4.570 | −8.908 | 13.484 | 1.00 | 1.00 | O |
| ATOM | 180 | CB | SER | A | 985 | −1.550 | −8.495 | 12.070 | 1.00 | 1.00 | C |
| ATOM | 181 | OG | SER | A | 985 | −1.775 | −8.276 | 10.692 | 1.00 | 1.00 | O |
| ATOM | 182 | HA | SER | A | 985 | −2.364 | −9.676 | 13.679 | 1.00 | 1.00 | H |
| ATOM | 183 | HB1 | SER | A | 985 | −0.497 | −8.698 | 12.362 | 1.00 | 1.00 | H |
| ATOM | 184 | HB2 | SER | A | 985 | −1.799 | −7.533 | 12.509 | 1.00 | 1.00 | H |
| ATOM | 185 | HG | SER | A | 985 | −1.421 | −9.033 | 10.207 | 1.00 | 1.00 | H |
| ATOM | 186 | HN | SER | A | 985 | −2.933 | −11.139 | 11.181 | 1.00 | 1.00 | H |
| ATOM | 187 | N | LYS | A | 986 | −4.472 | −8.771 | 11.259 | 1.00 | 1.00 | N |
| ATOM | 188 | CA | LYS | A | 986 | −5.841 | −8.195 | 11.267 | 1.00 | 1.00 | C |
| ATOM | 189 | C | LYS | A | 986 | −6.890 | −9.331 | 11.210 | 1.00 | 1.00 | C |
| ATOM | 190 | O | LYS | A | 986 | −6.565 | −10.364 | 10.644 | 1.00 | 1.00 | O |
| ATOM | 191 | CB | LYS | A | 986 | −6.052 | −7.401 | 9.923 | 1.00 | 1.00 | C |
| ATOM | 192 | CG | LYS | A | 986 | −5.447 | −5.985 | 10.068 | 1.00 | 1.00 | C |
| ATOM | 193 | CD | LYS | A | 986 | −3.901 | −6.078 | 10.176 | 1.00 | 1.00 | C |
| ATOM | 194 | CE | LYS | A | 986 | −3.139 | −4.722 | 9.880 | 1.00 | 1.00 | C |
| ATOM | 195 | NZ | LYS | A | 986 | −3.423 | −3.698 | 10.894 | 1.00 | 1.00 | N |
| ATOM | 196 | HA | LYS | A | 986 | −6.043 | −7.510 | 12.083 | 1.00 | 1.00 | H |
| ATOM | 197 | HB1 | LYS | A | 986 | −5.699 | −7.987 | 9.129 | 1.00 | 1.00 | H |
| ATOM | 198 | HB2 | LYS | A | 986 | −7.168 | −7.243 | 9.805 | 1.00 | 1.00 | H |
| ATOM | 199 | HG1 | LYS | A | 986 | −5.756 | −5.471 | 10.982 | 1.00 | 1.00 | H |
| ATOM | 200 | HG2 | LYS | A | 986 | −5.724 | −5.419 | 9.167 | 1.00 | 1.00 | H |
| ATOM | 201 | HD1 | LYS | A | 986 | −3.598 | −6.761 | 9.353 | 1.00 | 1.00 | H |
| ATOM | 202 | HD2 | LYS | A | 986 | −3.593 | −6.452 | 11.162 | 1.00 | 1.00 | H |
| ATOM | 203 | HE1 | LYS | A | 986 | −3.490 | −4.323 | 8.919 | 1.00 | 1.00 | H |
| ATOM | 204 | HE2 | LYS | A | 986 | −2.078 | −4.881 | 9.845 | 1.00 | 1.00 | H |
| ATOM | 205 | HZ1 | LYS | A | 986 | −3.115 | −2.702 | 10.657 | 1.00 | 1.00 | H |
| ATOM | 206 | HZ2 | LYS | A | 986 | −2.954 | −3.856 | 11.827 | 1.00 | 1.00 | H |
| ATOM | 207 | HZ3 | LYS | A | 986 | −4.500 | −3.527 | 10.979 | 1.00 | 1.00 | H |
| ATOM | 208 | HN | LYS | A | 986 | −4.013 | −8.934 | 10.416 | 1.00 | 1.00 | H |
| ATOM | 209 | N | PRO | A | 987 | −8.126 | −9.236 | 11.778 | 1.00 | 1.00 | N |
| ATOM | 210 | CA | PRO | A | 987 | −9.006 | −10.400 | 11.720 | 1.00 | 1.00 | C |
| ATOM | 211 | C | PRO | A | 987 | −9.613 | −10.588 | 10.350 | 1.00 | 1.00 | C |
| ATOM | 212 | O | PRO | A | 987 | −10.763 | −10.220 | 10.160 | 1.00 | 1.00 | O |
| ATOM | 213 | CB | PRO | A | 987 | −9.915 | −10.077 | 12.949 | 1.00 | 1.00 | C |
| ATOM | 214 | CG | PRO | A | 987 | −10.027 | −8.545 | 12.833 | 1.00 | 1.00 | C |
| ATOM | 215 | CD | PRO | A | 987 | −8.590 | −8.066 | 12.478 | 1.00 | 1.00 | C |
| ATOM | 216 | HA | PRO | A | 987 | −8.450 | −11.343 | 11.970 | 1.00 | 1.00 | H |
| ATOM | 217 | HD2 | PRO | A | 987 | −8.531 | −7.158 | 11.853 | 1.00 | 1.00 | H |
| ATOM | 218 | HD1 | PRO | A | 987 | −7.999 | −8.031 | 13.403 | 1.00 | 1.00 | H |
| ATOM | 219 | HG2 | PRO | A | 987 | −10.367 | −8.061 | 13.786 | 1.00 | 1.00 | H |
| ATOM | 220 | HG1 | PRO | A | 987 | −10.725 | −8.284 | 11.979 | 1.00 | 1.00 | H |
| ATOM | 221 | HB1 | PRO | A | 987 | −9.293 | −10.308 | 13.848 | 1.00 | 1.00 | H |
| ATOM | 222 | HB2 | PRO | A | 987 | −10.875 | −10.546 | 13.010 | 1.00 | 1.00 | H |
| ATOM | 223 | N | CYS | A | 988 | −8.819 | −11.183 | 9.400 | 1.00 | 1.00 | N |
| ATOM | 224 | CA | CYS | A | 988 | −9.371 | −11.366 | 7.995 | 1.00 | 1.00 | C |
| ATOM | 225 | C | CYS | A | 988 | −9.853 | −10.019 | 7.328 | 1.00 | 1.00 | C |
| ATOM | 226 | O | CYS | A | 988 | −9.225 | −9.570 | 6.395 | 1.00 | 1.00 | O |
| ATOM | 227 | CB | CYS | A | 988 | −10.478 | −12.406 | 7.852 | 1.00 | 1.00 | C |
| ATOM | 228 | SG | CYS | A | 988 | −9.925 | −14.093 | 7.858 | 1.00 | 1.00 | S |
| ATOM | 229 | HA | CYS | A | 988 | −8.585 | −11.752 | 7.376 | 1.00 | 1.00 | H |
| ATOM | 230 | HB1 | CYS | A | 988 | −10.883 | −12.287 | 6.861 | 1.00 | 1.00 | H |
| ATOM | 231 | HB2 | CYS | A | 988 | −11.233 | −12.178 | 8.622 | 1.00 | 1.00 | H |
| ATOM | 232 | HG | CYS | A | 988 | −10.804 | −14.532 | 7.549 | 1.00 | 1.00 | H |
| ATOM | 233 | HN | CYS | A | 988 | −7.862 | −11.354 | 9.618 | 1.00 | 1.00 | H |
| ATOM | 234 | N | SER | A | 989 | −10.944 | −9.439 | 7.817 | 1.00 | 1.00 | N |
| ATOM | 235 | CA | SER | A | 989 | −11.548 | −8.248 | 7.159 | 1.00 | 1.00 | C |
| ATOM | 236 | C | SER | A | 989 | −11.700 | −8.450 | 5.645 | 1.00 | 1.00 | C |
| ATOM | 237 | O | SER | A | 989 | −12.801 | −8.795 | 5.247 | 1.00 | 1.00 | O |
| ATOM | 238 | CB | SER | A | 989 | −10.678 | −7.018 | 7.508 | 1.00 | 1.00 | C |
| ATOM | 239 | OG | SER | A | 989 | −10.707 | −6.766 | 8.937 | 1.00 | 1.00 | O |
| ATOM | 240 | HA | SER | A | 989 | −12.526 | −8.132 | 7.678 | 1.00 | 1.00 | H |
| ATOM | 241 | HB1 | SER | A | 989 | −11.273 | −6.158 | 7.107 | 1.00 | 1.00 | H |
| ATOM | 242 | HB2 | SER | A | 989 | −9.661 | −7.017 | 7.080 | 1.00 | 1.00 | H |
| ATOM | 243 | HG | SER | A | 989 | −10.409 | −7.536 | 9.410 | 1.00 | 1.00 | H |
| ATOM | 244 | HN | SER | A | 989 | −11.357 | −9.790 | 8.665 | 1.00 | 1.00 | H |
| ATOM | 245 | N | ASP | A | 990 | −10.653 | −8.340 | 4.750 | 1.00 | 1.00 | N |
| ATOM | 246 | CA | ASP | A | 990 | −10.799 | −8.615 | 3.268 | 1.00 | 1.00 | C |
| ATOM | 247 | C | ASP | A | 990 | −9.684 | −9.479 | 2.765 | 1.00 | 1.00 | C |
| ATOM | 248 | O | ASP | A | 990 | −9.266 | −9.300 | 1.629 | 1.00 | 1.00 | O |
| ATOM | 249 | CB | ASP | A | 990 | −10.994 | −7.278 | 2.552 | 1.00 | 1.00 | C |
| ATOM | 250 | CG | ASP | A | 990 | −11.870 | −7.403 | 1.302 | 1.00 | 1.00 | C |
| ATOM | 251 | OD1 | ASP | A | 990 | −13.139 | −7.167 | 1.381 | 1.00 | 1.00 | O |
| ATOM | 252 | OD2 | ASP | A | 990 | −11.324 | −7.833 | 0.273 | 1.00 | 1.00 | O |
| ATOM | 253 | HA | ASP | A | 990 | −11.682 | −9.234 | 3.115 | 1.00 | 1.00 | H |
| ATOM | 254 | HB1 | ASP | A | 990 | −10.020 | −6.828 | 2.325 | 1.00 | 1.00 | H |
| ATOM | 255 | HB2 | ASP | A | 990 | −11.585 | −6.562 | 3.234 | 1.00 | 1.00 | H |
| ATOM | 256 | HN | ASP | A | 990 | −9.673 | −8.229 | 5.070 | 1.00 | 1.00 | H |
| ATOM | 257 | N | TYR | A | 991 | −9.296 | −10.445 | 3.615 | 1.00 | 1.00 | N |
| ATOM | 258 | CA | TYR | A | 991 | −8.287 | −11.480 | 3.236 | 1.00 | 1.00 | C |
| ATOM | 259 | C | TYR | A | 991 | −6.926 | −10.954 | 2.710 | 1.00 | 1.00 | C |
| ATOM | 260 | O | TYR | A | 991 | −5.839 | −11.105 | 3.245 | 1.00 | 1.00 | O |
| ATOM | 261 | CB | TYR | A | 991 | −8.950 | −12.475 | 2.208 | 1.00 | 1.00 | C |
| ATOM | 262 | CG | TYR | A | 991 | −10.298 | −12.880 | 2.832 | 1.00 | 1.00 | C |
| ATOM | 263 | CD1 | TYR | A | 991 | −10.351 | −13.931 | 3.745 | 1.00 | 1.00 | C |
| ATOM | 264 | CD2 | TYR | A | 991 | −11.465 | −12.205 | 2.437 | 1.00 | 1.00 | C |
| ATOM | 265 | CE1 | TYR | A | 991 | −11.595 | −14.375 | 4.248 | 1.00 | 1.00 | C |
| ATOM | 266 | CE2 | TYR | A | 991 | −12.642 | −12.571 | 3.062 | 1.00 | 1.00 | C |
| ATOM | 267 | CZ | TYR | A | 991 | −12.732 | −13.582 | 4.034 | 1.00 | 1.00 | C |
| ATOM | 268 | OH | TYR | A | 991 | −13.907 | −13.771 | 4.790 | 1.00 | 1.00 | O |
| ATOM | 269 | HA | TYR | A | 991 | −7.956 | −12.077 | 4.124 | 1.00 | 1.00 | H |
| ATOM | 270 | HB2 | TYR | A | 991 | −8.335 | −13.345 | 2.041 | 1.00 | 1.00 | H |
| ATOM | 271 | HB1 | TYR | A | 991 | −9.170 | −12.024 | 1.253 | 1.00 | 1.00 | H |
| ATOM | 272 | HD2 | TYR | A | 991 | −11.470 | −11.486 | 1.604 | 1.00 | 1.00 | H |
| ATOM | 273 | HE2 | TYR | A | 991 | −13.504 | −11.980 | 2.760 | 1.00 | 1.00 | H |
| ATOM | 274 | HE1 | TYR | A | 991 | −11.699 | −15.301 | 4.793 | 1.00 | 1.00 | H |
| ATOM | 275 | HD1 | TYR | A | 991 | −9.448 | −14.408 | 4.025 | 1.00 | 1.00 | H |
| ATOM | 276 | HH | TYR | A | 991 | −13.778 | −14.303 | 5.583 | 1.00 | 1.00 | H |
| ATOM | 277 | HN | TYR | A | 991 | −9.794 | −10.612 | 4.496 | 1.00 | 1.00 | H |
| ATOM | 278 | N | CYS | A | 992 | −6.938 | −10.246 | 1.549 | 1.00 | 1.00 | N |
| ATOM | 279 | CA | CYS | A | 992 | −5.661 | −9.753 | 1.042 | 1.00 | 1.00 | C |
| ATOM | 280 | C | CYS | A | 992 | −5.042 | −8.756 | 1.934 | 1.00 | 1.00 | C |
| ATOM | 281 | O | CYS | A | 992 | −3.817 | −8.694 | 1.938 | 1.00 | 1.00 | O |
| ATOM | 282 | CB | CYS | A | 992 | −5.774 | −9.219 | −0.409 | 1.00 | 1.00 | C |
| ATOM | 283 | SG | CYS | A | 992 | −4.078 | −8.786 | −1.022 | 1.00 | 1.00 | S |
| ATOM | 284 | HA | CYS | A | 992 | −4.927 | −10.570 | 0.998 | 1.00 | 1.00 | H |
| ATOM | 285 | HB1 | CYS | A | 992 | −6.423 | −8.358 | −0.502 | 1.00 | 1.00 | H |
| ATOM | 286 | HB2 | CYS | A | 992 | −6.183 | −10.002 | −1.123 | 1.00 | 1.00 | H |
| ATOM | 287 | H4 | CYS | A | 992 | −4.051 | −7.962 | −0.506 | 1.00 | 1.00 | H |
| ATOM | 288 | HN | CYS | A | 992 | −7.783 | −10.051 | 1.063 | 1.00 | 1.00 | H |
| ATOM | 289 | N | LEU | A | 993 | −5.708 | −7.900 | 2.699 | 1.00 | 1.00 | N |
| ATOM | 290 | CA | LEU | A | 993 | −4.931 | −6.981 | 3.584 | 1.00 | 1.00 | C |
| ATOM | 291 | C | LEU | A | 993 | −4.006 | −7.727 | 4.503 | 1.00 | 1.00 | C |
| ATOM | 292 | O | LEU | A | 993 | −2.983 | −7.197 | 4.952 | 1.00 | 1.00 | O |
| ATOM | 293 | CB | LEU | A | 993 | −5.755 | −5.795 | 4.079 | 1.00 | 1.00 | C |
| ATOM | 294 | CG | LEU | A | 993 | −6.872 | −6.064 | 5.130 | 1.00 | 1.00 | C |
| ATOM | 295 | CD1 | LEU | A | 993 | −6.247 | −6.740 | 6.375 | 1.00 | 1.00 | C |
| ATOM | 296 | CD2 | LEU | A | 993 | −7.701 | −4.786 | 5.439 | 1.00 | 1.00 | C |
| ATOM | 297 | HA | LEU | A | 993 | −4.239 | −6.443 | 2.929 | 1.00 | 1.00 | H |
| ATOM | 298 | HB1 | LEU | A | 993 | −6.247 | −5.367 | 3.168 | 1.00 | 1.00 | H |
| ATOM | 299 | HB2 | LEU | A | 993 | −5.033 | −5.063 | 4.537 | 1.00 | 1.00 | H |
| ATOM | 300 | HG | LEU | A | 993 | −7.475 | −6.810 | 4.641 | 1.00 | 1.00 | H |
| ATOM | 301 | HD21 | LEU | A | 993 | −8.008 | −4.367 | 4.484 | 1.00 | 1.00 | H |
| ATOM | 302 | HD22 | LEU | A | 993 | −7.104 | −4.034 | 5.935 | 1.00 | 1.00 | H |
| ATOM | 303 | HD23 | LEU | A | 993 | −8.507 | −5.069 | 6.022 | 1.00 | 1.00 | H |
| ATOM | 304 | HD11 | LEU | A | 993 | −5.894 | −7.759 | 6.203 | 1.00 | 1.00 | H |
| ATOM | 305 | HD12 | LEU | A | 993 | −7.002 | −6.762 | 7.187 | 1.00 | 1.00 | H |
| ATOM | 306 | HD13 | LEU | A | 993 | −5.412 | −6.152 | 6.774 | 1.00 | 1.00 | H |
| ATOM | 307 | HN | LEU | A | 993 | −6.697 | −7.968 | 2.796 | 1.00 | 1.00 | H |
| ATOM | 308 | N | SER | A | 994 | −4.399 | −8.953 | 4.875 | 1.00 | 1.00 | N |
| ATOM | 309 | CA | SER | A | 994 | −3.499 | −9.815 | 5.622 | 1.00 | 1.00 | C |
| ATOM | 310 | C | SER | A | 994 | −2.420 | −10.265 | 4.652 | 1.00 | 1.00 | C |
| ATOM | 311 | O | SER | A | 994 | −1.250 | −10.269 | 4.986 | 1.00 | 1.00 | O |
| ATOM | 312 | CB | SER | A | 994 | −4.271 | −10.985 | 6.296 | 1.00 | 1.00 | C |
| ATOM | 313 | OG | SER | A | 994 | −3.331 | −11.707 | 7.161 | 1.00 | 1.00 | O |
| ATOM | 314 | HA | SER | A | 994 | −3.102 | −9.208 | 6.457 | 1.00 | 1.00 | H |
| ATOM | 315 | HB1 | SER | A | 994 | −4.675 | −11.655 | 5.535 | 1.00 | 1.00 | H |
| ATOM | 316 | HB2 | SER | A | 994 | −5.075 | −10.513 | 6.901 | 1.00 | 1.00 | H |
| ATOM | 317 | HG | SER | A | 994 | −3.713 | −12.379 | 7.719 | 1.00 | 1.00 | H |
| ATOM | 318 | HN | SER | A | 994 | −5.256 | −9.398 | 4.569 | 1.00 | 1.00 | H |
| ATOM | 319 | N | HIE | A | 995 | −2.775 | −10.642 | 3.397 | 1.00 | 1.00 | N |
| ATOM | 320 | CA | HIE | A | 995 | −1.656 | −10.790 | 2.414 | 1.00 | 1.00 | C |
| ATOM | 321 | C | HIE | A | 995 | −0.735 | −9.562 | 2.453 | 1.00 | 1.00 | C |
| ATOM | 322 | O | HIE | A | 995 | 0.465 | −9.767 | 2.467 | 1.00 | 1.00 | O |
| ATOM | 323 | CB | HIE | A | 995 | −1.911 | −11.029 | 0.873 | 1.00 | 1.00 | C |
| ATOM | 324 | CG | HIE | A | 995 | −2.366 | −12.414 | 0.468 | 1.00 | 1.00 | C |
| ATOM | 325 | ND1 | HIE | A | 995 | −2.546 | −12.824 | −0.932 | 1.00 | 1.00 | N |
| ATOM | 326 | CD2 | HIE | A | 995 | −2.825 | −13.476 | 1.162 | 1.00 | 1.00 | C |
| ATOM | 327 | CE1 | HIE | A | 995 | −2.989 | −14.014 | −0.959 | 1.00 | 1.00 | C |
| ATOM | 328 | NE2 | HIE | A | 995 | −3.171 | −14.382 | 0.287 | 1.00 | 1.00 | N |
| ATOM | 329 | HA | HIE | A | 995 | −1.131 | −11.692 | 2.792 | 1.00 | 1.00 | H |
| ATOM | 330 | HB1 | HIE | A | 995 | −2.554 | −10.236 | 0.493 | 1.00 | 1.00 | H |
| ATOM | 331 | HB2 | HIE | A | 995 | −0.951 | −11.012 | 0.413 | 1.00 | 1.00 | H |
| ATOM | 332 | HD2 | HIE | A | 995 | −2.954 | −13.634 | 2.228 | 1.00 | 1.00 | H |
| ATOM | 333 | HE2 | HIE | A | 995 | −3.514 | −15.315 | 0.582 | 1.00 | 1.00 | H |
| ATOM | 334 | HE1 | HIE | A | 995 | −3.176 | −14.614 | −1.833 | 1.00 | 1.00 | H |
| ATOM | 335 | HN | HIE | A | 995 | −3.757 | −10.856 | 3.165 | 1.00 | 1.00 | H |
| ATOM | 336 | N | ILE | A | 996 | −1.238 | −8.320 | 2.478 | 1.00 | 1.00 | N |
| ATOM | 337 | CA | ILE | A | 996 | −0.333 | −7.197 | 2.482 | 1.00 | 1.00 | C |
| ATOM | 338 | C | ILE | A | 996 | 0.493 | −7.337 | 3.749 | 1.00 | 1.00 | C |
| ATOM | 339 | O | ILE | A | 996 | 1.732 | −7.170 | 3.672 | 1.00 | 1.00 | O |
| ATOM | 340 | CB | ILE | A | 996 | −1.046 | −5.780 | 2.448 | 1.00 | 1.00 | C |
| ATOM | 341 | CG1 | ILE | A | 996 | −1.727 | −5.590 | 1.063 | 1.00 | 1.00 | C |
| ATOM | 342 | CG2 | ILE | A | 996 | 0.027 | −4.664 | 2.711 | 1.00 | 1.00 | C |
| ATOM | 343 | CD1 | ILE | A | 996 | −2.657 | −4.333 | 0.923 | 1.00 | 1.00 | C |
| ATOM | 344 | HA | ILE | A | 996 | 0.390 | −7.229 | 1.669 | 1.00 | 1.00 | H |
| ATOM | 345 | HB | ILE | A | 996 | −1.793 | −5.805 | 3.293 | 1.00 | 1.00 | H |
| ATOM | 346 | HG11 | ILE | A | 996 | −2.387 | −6.447 | 0.825 | 1.00 | 1.00 | H |
| ATOM | 347 | HG12 | ILE | A | 996 | −0.881 | −5.474 | 0.385 | 1.00 | 1.00 | H |
| ATOM | 348 | HD11 | ILE | A | 996 | −3.465 | −4.328 | 1.687 | 1.00 | 1.00 | H |
| ATOM | 349 | HD12 | ILE | A | 996 | −3.110 | −4.393 | −0.023 | 1.00 | 1.00 | H |
| ATOM | 350 | HD13 | ILE | A | 996 | −2.099 | −3.413 | 0.981 | 1.00 | 1.00 | H |
| ATOM | 351 | HG21 | ILE | A | 996 | 0.425 | −4.816 | 3.711 | 1.00 | 1.00 | H |
| ATOM | 352 | HG22 | ILE | A | 996 | −0.426 | −3.652 | 2.616 | 1.00 | 1.00 | H |
| ATOM | 353 | HG23 | ILE | A | 996 | 0.807 | −4.746 | 1.980 | 1.00 | 1.00 | H |
| ATOM | 354 | HN | ILE | A | 996 | −2.229 | −8.105 | 2.534 | 1.00 | 1.00 | H |
| ATOM | 355 | N | VAL | A | 997 | −0.096 | −7.589 | 4.917 | 1.00 | 1.00 | N |
| ATOM | 356 | CA | VAL | A | 997 | 0.794 | −7.743 | 6.053 | 1.00 | 1.00 | C |
| ATOM | 357 | C | VAL | A | 997 | 1.783 | −8.897 | 5.798 | 1.00 | 1.00 | C |
| ATOM | 358 | O | VAL | A | 997 | 2.974 | −8.626 | 5.799 | 1.00 | 1.00 | O |
| ATOM | 359 | CB | VAL | A | 997 | 0.029 | −7.900 | 7.429 | 1.00 | 1.00 | C |
| ATOM | 360 | CG1 | VAL | A | 997 | 1.072 | −8.097 | 8.607 | 1.00 | 1.00 | C |
| ATOM | 361 | CG2 | VAL | A | 997 | −0.763 | −6.606 | 7.909 | 1.00 | 1.00 | C |
| ATOM | 362 | HA | VAL | A | 997 | 1.363 | −6.834 | 6.137 | 1.00 | 1.00 | H |
| ATOM | 363 | HB | VAL | A | 997 | −0.708 | −8.675 | 7.338 | 1.00 | 1.00 | H |
| ATOM | 364 | HG11 | VAL | A | 997 | 1.672 | −9.091 | 8.459 | 1.00 | 1.00 | H |
| ATOM | 365 | HG12 | VAL | A | 997 | 0.584 | −8.105 | 9.574 | 1.00 | 1.00 | H |
| ATOM | 366 | HG13 | VAL | A | 997 | 1.714 | −7.278 | 8.694 | 1.00 | 1.00 | H |
| ATOM | 367 | HG21 | VAL | A | 997 | −0.238 | −5.628 | 7.797 | 1.00 | 1.00 | H |
| ATOM | 368 | HG22 | VAL | A | 997 | −1.156 | −6.668 | 8.928 | 1.00 | 1.00 | H |
| ATOM | 369 | HG23 | VAL | A | 997 | −1.621 | −6.574 | 7.157 | 1.00 | 1.00 | H |
| ATOM | 370 | HN | VAL | A | 997 | −1.082 | −7.731 | 5.024 | 1.00 | 1.00 | H |
| ATOM | 371 | N | ASN | A | 998 | 1.272 | −10.137 | 5.620 | 1.00 | 1.00 | N |
| ATOM | 372 | CA | ASN | A | 998 | 2.188 | −11.299 | 5.428 | 1.00 | 1.00 | C |
| ATOM | 373 | C | ASN | A | 998 | 3.273 | −10.974 | 4.449 | 1.00 | 1.00 | C |
| ATOM | 374 | O | ASN | A | 998 | 4.451 | −11.167 | 4.679 | 1.00 | 1.00 | O |
| ATOM | 375 | CB | ASN | A | 998 | 1.367 | −12.559 | 5.002 | 1.00 | 1.00 | C |
| ATOM | 376 | CG | ASN | A | 998 | 2.231 | −13.810 | 4.997 | 1.00 | 1.00 | C |
| ATOM | 377 | OD1 | ASN | A | 998 | 2.670 | −14.140 | 3.905 | 1.00 | 1.00 | O |
| ATOM | 378 | ND2 | ASN | A | 998 | 2.467 | −14.470 | 6.132 | 1.00 | 1.00 | N |
| ATOM | 379 | HA | ASN | A | 998 | 2.616 | −11.521 | 6.386 | 1.00 | 1.00 | H |
| ATOM | 380 | HB1 | ASN | A | 998 | 0.891 | −12.436 | 4.052 | 1.00 | 1.00 | H |
| ATOM | 381 | HB2 | ASN | A | 998 | 0.514 | −12.665 | 5.696 | 1.00 | 1.00 | H |
| ATOM | 382 | HD22 | ASN | A | 998 | 2.897 | −15.364 | 6.112 | 1.00 | 1.00 | H |
| ATOM | 383 | HD21 | ASN | A | 998 | 2.312 | −14.069 | 7.033 | 1.00 | 1.00 | H |
| ATOM | 384 | HN | ASN | A | 998 | 0.313 | −10.286 | 5.719 | 1.00 | 1.00 | H |
| ATOM | 385 | N | LEU | A | 999 | 2.881 | −10.391 | 3.316 | 1.00 | 1.00 | N |
| ATOM | 386 | CA | LEU | A | 999 | 3.856 | −9.988 | 2.322 | 1.00 | 1.00 | C |
| ATOM | 387 | C | LEU | A | 999 | 4.903 | −9.201 | 3.064 | 1.00 | 1.00 | C |
| ATOM | 388 | O | LEU | A | 999 | 6.060 | −9.601 | 3.015 | 1.00 | 1.00 | O |
| ATOM | 389 | CB | LEU | A | 999 | 3.158 | −9.272 | 1.177 | 1.00 | 1.00 | C |
| ATOM | 390 | CG | LEU | A | 999 | 4.179 | −8.528 | 0.215 | 1.00 | 1.00 | C |
| ATOM | 391 | CD1 | LEU | A | 999 | 4.903 | −9.527 | −0.718 | 1.00 | 1.00 | C |
| ATOM | 392 | CD2 | LEU | A | 999 | 3.464 | −7.520 | −0.646 | 1.00 | 1.00 | C |
| ATOM | 393 | HA | LEU | A | 999 | 4.320 | −10.935 | 1.944 | 1.00 | 1.00 | H |
| ATOM | 394 | HB1 | LEU | A | 999 | 2.441 | −8.548 | 1.532 | 1.00 | 1.00 | H |
| ATOM | 395 | HB2 | LEU | A | 999 | 2.559 | −10.037 | 0.608 | 1.00 | 1.00 | H |
| ATOM | 396 | HG | LEU | A | 999 | 4.865 | −7.916 | 0.821 | 1.00 | 1.00 | H |
| ATOM | 397 | HD21 | LEU | A | 999 | 4.178 | −7.005 | −1.284 | 1.00 | 1.00 | H |
| ATOM | 398 | HD22 | LEU | A | 999 | 2.997 | −6.758 | −0.017 | 1.00 | 1.00 | H |
| ATOM | 399 | HD23 | LEU | A | 999 | 2.668 | −7.932 | −1.257 | 1.00 | 1.00 | H |
| ATOM | 400 | HD11 | LEU | A | 999 | 4.130 | −10.167 | −1.186 | 1.00 | 1.00 | H |
| ATOM | 401 | HD12 | LEU | A | 999 | 5.538 | −10.184 | −0.160 | 1.00 | 1.00 | H |
| ATOM | 402 | HD13 | LEU | A | 999 | 5.521 | −8.939 | −1.445 | 1.00 | 1.00 | H |
| ATOM | 403 | HN | LEU | A | 999 | 1.910 | −10.254 | 3.145 | 1.00 | 1.00 | H |
| ATOM | 404 | N | LEU | A | 1000 | 4.585 | −8.059 | 3.731 | 1.00 | 1.00 | N |
| ATOM | 405 | CA | LEU | A | 1000 | 5.596 | −7.203 | 4.354 | 1.00 | 1.00 | C |
| ATOM | 406 | C | LEU | A | 1000 | 6.383 | −7.980 | 5.400 | 1.00 | 1.00 | C |
| ATOM | 407 | O | LEU | A | 1000 | 7.598 | −7.999 | 5.425 | 1.00 | 1.00 | O |
| ATOM | 408 | CB | LEU | A | 1000 | 5.062 | −5.871 | 5.014 | 1.00 | 1.00 | C |
| ATOM | 409 | CG | LEU | A | 1000 | 4.991 | −4.651 | 4.032 | 1.00 | 1.00 | C |
| ATOM | 410 | CD1 | LEU | A | 1000 | 3.821 | −4.842 | 3.112 | 1.00 | 1.00 | C |
| ATOM | 411 | CD2 | LEU | A | 1000 | 4.850 | −3.309 | 4.826 | 1.00 | 1.00 | C |
| ATOM | 412 | HA | LEU | A | 1000 | 6.291 | −6.869 | 3.564 | 1.00 | 1.00 | H |
| ATOM | 413 | HB1 | LEU | A | 1000 | 5.764 | −5.548 | 5.752 | 1.00 | 1.00 | H |
| ATOM | 414 | HB2 | LEU | A | 1000 | 4.085 | −6.045 | 5.513 | 1.00 | 1.00 | H |
| ATOM | 415 | HG | LEU | A | 1000 | 5.902 | −4.675 | 3.478 | 1.00 | 1.00 | H |
| ATOM | 416 | HD21 | LEU | A | 1000 | 5.685 | −3.136 | 5.555 | 1.00 | 1.00 | H |
| ATOM | 417 | HD22 | LEU | A | 1000 | 3.875 | −3.197 | 5.322 | 1.00 | 1.00 | H |
| ATOM | 418 | HD23 | LEU | A | 1000 | 4.969 | −2.550 | 4.059 | 1.00 | 1.00 | H |
| ATOM | 419 | HD11 | LEU | A | 1000 | 3.817 | −3.955 | 2.444 | 1.00 | 1.00 | H |
| ATOM | 420 | HD12 | LEU | A | 1000 | 2.860 | −4.843 | 3.696 | 1.00 | 1.00 | H |
| ATOM | 421 | HD13 | LEU | A | 1000 | 3.881 | −5.728 | 2.498 | 1.00 | 1.00 | H |
| ATOM | 422 | HN | LEU | A | 1000 | 3.624 | −7.798 | 3.854 | 1.00 | 1.00 | H |
| ATOM | 423 | N | GLU | A | 1001 | 5.657 | −8.475 | 6.433 | 1.00 | 1.00 | N |
| ATOM | 424 | CA | GLU | A | 1001 | 6.268 | −9.068 | 7.581 | 1.00 | 1.00 | C |
| ATOM | 425 | C | GLU | A | 1001 | 6.909 | −10.414 | 7.205 | 1.00 | 1.00 | C |
| ATOM | 426 | O | GLU | A | 1001 | 8.065 | −10.623 | 7.537 | 1.00 | 1.00 | O |
| ATOM | 427 | CB | GLU | A | 1001 | 5.333 | −9.253 | 8.748 | 1.00 | 1.00 | C |
| ATOM | 428 | CG | GLU | A | 1001 | 4.709 | −7.928 | 9.242 | 1.00 | 1.00 | C |
| ATOM | 429 | CD | GLU | A | 1001 | 5.624 | −6.853 | 9.748 | 1.00 | 1.00 | C |
| ATOM | 430 | OE1 | GLU | A | 1001 | 5.510 | −5.615 | 9.530 | 1.00 | 1.00 | O |
| ATOM | 431 | OE2 | GLU | A | 1001 | 6.579 | −7.191 | 10.502 | 1.00 | 1.00 | O |
| ATOM | 432 | HA | GLU | A | 1001 | 7.154 | −8.474 | 7.896 | 1.00 | 1.00 | H |
| ATOM | 433 | HB1 | GLU | A | 1001 | 5.768 | −9.714 | 9.702 | 1.00 | 1.00 | H |
| ATOM | 434 | HB2 | GLU | A | 1001 | 4.420 | −9.845 | 8.450 | 1.00 | 1.00 | H |
| ATOM | 435 | HG1 | GLU | A | 1001 | 4.044 | −8.152 | 10.121 | 1.00 | 1.00 | H |
| ATOM | 436 | HG2 | GLU | A | 1001 | 4.147 | −7.407 | 8.451 | 1.00 | 1.00 | H |
| ATOM | 437 | HN | GLU | A | 1001 | 4.675 | −8.541 | 6.420 | 1.00 | 1.00 | H |
| ATOM | 438 | N | ASP | A | 1002 | 6.228 | −11.349 | 6.578 | 1.00 | 1.00 | N |
| ATOM | 439 | CA | ASP | A | 1002 | 6.803 | −12.664 | 6.307 | 1.00 | 1.00 | C |
| ATOM | 440 | C | ASP | A | 1002 | 7.640 | −12.784 | 5.070 | 1.00 | 1.00 | C |
| ATOM | 441 | O | ASP | A | 1002 | 8.690 | −13.475 | 5.131 | 1.00 | 1.00 | O |
| ATOM | 442 | CB | ASP | A | 1002 | 5.790 | −13.787 | 6.372 | 1.00 | 1.00 | C |
| ATOM | 443 | CG | ASP | A | 1002 | 5.207 | −13.948 | 7.743 | 1.00 | 1.00 | C |
| ATOM | 444 | OD1 | ASP | A | 1002 | 4.236 | −13.227 | 8.054 | 1.00 | 1.00 | O |
| ATOM | 445 | OD2 | ASP | A | 1002 | 5.770 | −14.768 | 8.508 | 1.00 | 1.00 | O |
| ATOM | 446 | HA | ASP | A | 1002 | 7.461 | −12.913 | 7.107 | 1.00 | 1.00 | H |
| ATOM | 447 | HB1 | ASP | A | 1002 | 6.336 | −14.701 | 6.059 | 1.00 | 1.00 | H |
| ATOM | 448 | HB2 | ASP | A | 1002 | 4.982 | −13.617 | 5.641 | 1.00 | 1.00 | H |
| ATOM | 449 | HN | ASP | A | 1002 | 5.301 | −11.170 | 6.191 | 1.00 | 1.00 | H |
| ATOM | 450 | N | TRP | A | 1003 | 7.309 | −12.155 | 3.916 | 1.00 | 1.00 | N |
| ATOM | 451 | CA | TRP | A | 1003 | 8.028 | −12.521 | 2.712 | 1.00 | 1.00 | C |
| ATOM | 452 | C | TRP | A | 1003 | 9.347 | −11.717 | 2.607 | 1.00 | 1.00 | C |
| ATOM | 453 | O | TRP | A | 1003 | 10.188 | −12.008 | 1.776 | 1.00 | 1.00 | O |
| ATOM | 454 | CB | TRP | A | 1003 | 7.245 | −12.350 | 1.425 | 1.00 | 1.00 | C |
| ATOM | 455 | CG | TRP | A | 1003 | 5.928 | −13.105 | 1.426 | 1.00 | 1.00 | C |
| ATOM | 456 | CD1 | TRP | A | 1003 | 5.234 | −13.742 | 2.370 | 1.00 | 1.00 | C |
| ATOM | 457 | CD2 | TRP | A | 1003 | 5.081 | −13.269 | 0.214 | 1.00 | 1.00 | C |
| ATOM | 458 | NE1 | TRP | A | 1003 | 4.125 | −14.238 | 1.928 | 1.00 | 1.00 | N |
| ATOM | 459 | CE2 | TRP | A | 1003 | 3.974 | −13.995 | 0.622 | 1.00 | 1.00 | C |
| ATOM | 460 | CE3 | TRP | A | 1003 | 5.245 | −12.863 | −1.108 | 1.00 | 1.00 | C |
| ATOM | 461 | CZ2 | TRP | A | 1003 | 2.896 | −14.356 | −0.205 | 1.00 | 1.00 | C |
| ATOM | 462 | CZ3 | TRP | A | 1003 | 4.207 | −13.291 | −1.962 | 1.00 | 1.00 | C |
| ATOM | 463 | CH2 | TRP | A | 1003 | 3.067 | −13.986 | −1.528 | 1.00 | 1.00 | C |
| ATOM | 464 | HA | TRP | A | 1003 | 8.356 | −13.571 | 2.796 | 1.00 | 1.00 | H |
| ATOM | 465 | HB1 | TRP | A | 1003 | 7.953 | −12.648 | 0.620 | 1.00 | 1.00 | H |
| ATOM | 466 | HB2 | TRP | A | 1003 | 7.032 | −11.308 | 1.373 | 1.00 | 1.00 | H |
| ATOM | 467 | HE1 | TRP | A | 1003 | 3.372 | −14.672 | 2.522 | 1.00 | 1.00 | H |
| ATOM | 468 | HD1 | TRP | A | 1003 | 5.553 | −13.819 | 3.437 | 1.00 | 1.00 | H |
| ATOM | 469 | HZ2 | TRP | A | 1003 | 2.034 | −14.863 | 0.176 | 1.00 | 1.00 | H |
| ATOM | 470 | HH2 | TRP | A | 1003 | 2.311 | −14.188 | −2.323 | 1.00 | 1.00 | H |
| ATOM | 471 | HZ3 | TRP | A | 1003 | 4.220 | −13.039 | −3.034 | 1.00 | 1.00 | H |
| ATOM | 472 | HE3 | TRP | A | 1003 | 6.091 | −12.270 | −1.397 | 1.00 | 1.00 | H |
| ATOM | 473 | HN | TRP | A | 1003 | 6.524 | −11.504 | 3.913 | 1.00 | 1.00 | H |
| ATOM | 474 | N | GLY | A | 1004 | 9.574 | −10.669 | 3.477 | 1.00 | 1.00 | N |
| ATOM | 475 | CA | GLY | A | 1004 | 10.789 | −9.895 | 3.350 | 1.00 | 1.00 | C |
| ATOM | 476 | C | GLY | A | 1004 | 12.070 | −10.653 | 2.944 | 1.00 | 1.00 | C |
| ATOM | 477 | O | GLY | A | 1004 | 12.762 | −10.229 | 2.015 | 1.00 | 1.00 | O |
| ATOM | 478 | HA2 | GLY | A | 1004 | 11.108 | −9.589 | 4.337 | 1.00 | 1.00 | H |
| ATOM | 479 | HA1 | GLY | A | 1004 | 10.654 | −9.048 | 2.670 | 1.00 | 1.00 | H |
| ATOM | 480 | HN | GLY | A | 1004 | 8.925 | −10.435 | 4.206 | 1.00 | 1.00 | H |
| ATOM | 481 | N | PRO | A | 1005 | 12.579 | −11.765 | 3.541 | 1.00 | 1.00 | N |
| ATOM | 482 | CA | PRO | A | 1005 | 13.852 | −12.345 | 3.150 | 1.00 | 1.00 | C |
| ATOM | 483 | C | PRO | A | 1005 | 13.998 | −12.666 | 1.707 | 1.00 | 1.00 | C |
| ATOM | 484 | O | PRO | A | 1005 | 15.042 | −12.420 | 1.155 | 1.00 | 1.00 | O |
| ATOM | 485 | CB | PRO | A | 1005 | 13.861 | −13.680 | 3.989 | 1.00 | 1.00 | C |
| ATOM | 486 | CG | PRO | A | 1005 | 12.906 | −13.370 | 5.191 | 1.00 | 1.00 | C |
| ATOM | 487 | CD | PRO | A | 1005 | 11.799 | −12.434 | 4.617 | 1.00 | 1.00 | C |
| ATOM | 488 | HA | PRO | A | 1005 | 14.610 | −11.606 | 3.479 | 1.00 | 1.00 | H |
| ATOM | 489 | HD2 | PRO | A | 1005 | 11.403 | −11.683 | 5.350 | 1.00 | 1.00 | H |
| ATOM | 490 | HD1 | PRO | A | 1005 | 10.996 | −13.058 | 4.147 | 1.00 | 1.00 | H |
| ATOM | 491 | HG2 | PRO | A | 1005 | 13.524 | −12.917 | 5.947 | 1.00 | 1.00 | H |
| ATOM | 492 | HG1 | PRO | A | 1005 | 12.483 | −14.261 | 5.628 | 1.00 | 1.00 | H |
| ATOM | 493 | HB1 | PRO | A | 1005 | 14.879 | −13.938 | 4.352 | 1.00 | 1.00 | H |
| ATOM | 494 | HB2 | PRO | A | 1005 | 13.430 | −14.571 | 3.445 | 1.00 | 1.00 | H |
| ATOM | 495 | N | CYS | A | 1006 | 13.035 | −13.296 | 1.074 | 1.00 | 1.00 | N |
| ATOM | 496 | CA | CYS | A | 1006 | 13.140 | −13.592 | −0.390 | 1.00 | 1.00 | C |
| ATOM | 497 | C | CYS | A | 1006 | 12.762 | −12.375 | −1.245 | 1.00 | 1.00 | C |
| ATOM | 498 | O | CYS | A | 1006 | 13.351 | −12.102 | −2.280 | 1.00 | 1.00 | O |
| ATOM | 499 | CB | CYS | A | 1006 | 12.201 | −14.795 | −0.743 | 1.00 | 1.00 | C |
| ATOM | 500 | SG | CYS | A | 1006 | 12.536 | −15.488 | −2.352 | 1.00 | 1.00 | S |
| ATOM | 501 | HA | CYS | A | 1006 | 14.177 | −13.862 | −0.671 | 1.00 | 1.00 | H |
| ATOM | 502 | HB1 | CYS | A | 1006 | 11.120 | −14.461 | −0.654 | 1.00 | 1.00 | H |
| ATOM | 503 | HB2 | CYS | A | 1006 | 12.290 | −15.623 | −0.005 | 1.00 | 1.00 | H |
| ATOM | 504 | HG | CYS | A | 1006 | 12.338 | −14.714 | −2.962 | 1.00 | 1.00 | H |
| ATOM | 505 | HN | CYS | A | 1006 | 12.202 | −13.577 | 1.509 | 1.00 | 1.00 | H |
| ATOM | 506 | N | ALA | A | 1007 | 11.768 | −11.607 | −0.809 | 1.00 | 1.00 | N |
| ATOM | 507 | CA | ALA | A | 1007 | 11.279 | −10.496 | −1.619 | 1.00 | 1.00 | C |
| ATOM | 508 | C | ALA | A | 1007 | 12.309 | −9.452 | −1.823 | 1.00 | 1.00 | C |
| ATOM | 509 | O | ALA | A | 1007 | 12.480 | −9.009 | −2.932 | 1.00 | 1.00 | O |
| ATOM | 510 | CB | ALA | A | 1007 | 9.999 | −9.818 | −1.009 | 1.00 | 1.00 | C |
| ATOM | 511 | HA | ALA | A | 1007 | 11.063 | −10.943 | −2.589 | 1.00 | 1.00 | H |
| ATOM | 512 | HB1 | ALA | A | 1007 | 9.218 | −10.616 | −0.823 | 1.00 | 1.00 | H |
| ATOM | 513 | HB2 | ALA | A | 1007 | 9.534 | −9.139 | −1.712 | 1.00 | 1.00 | H |
| ATOM | 514 | HB3 | ALA | A | 1007 | 10.199 | −9.277 | −0.051 | 1.00 | 1.00 | H |
| ATOM | 515 | HN | ALA | A | 1007 | 11.257 | −11.726 | 0.080 | 1.00 | 1.00 | H |
| ATOM | 516 | N | GLU | A | 1008 | 13.008 | −9.091 | −0.725 | 1.00 | 1.00 | N |
| ATOM | 517 | CA | GLU | A | 1008 | 13.693 | −7.774 | −0.696 | 1.00 | 1.00 | C |
| ATOM | 518 | C | GLU | A | 1008 | 14.665 | −7.691 | 0.450 | 1.00 | 1.00 | C |
| ATOM | 519 | O | GLU | A | 1008 | 15.831 | −7.723 | 0.199 | 1.00 | 1.00 | O |
| ATOM | 520 | CB | GLU | A | 1008 | 12.634 | −6.641 | −0.630 | 1.00 | 1.00 | C |
| ATOM | 521 | CG | GLU | A | 1008 | 13.185 | −5.193 | −0.873 | 1.00 | 1.00 | C |
| ATOM | 522 | CD | GLU | A | 1008 | 12.086 | −4.246 | −1.424 | 1.00 | 1.00 | C |
| ATOM | 523 | OE1 | GLU | A | 1008 | 12.389 | −3.101 | −1.843 | 1.00 | 1.00 | O |
| ATOM | 524 | OE2 | GLU | A | 1008 | 10.882 | −4.552 | −1.441 | 1.00 | 1.00 | O |
| ATOM | 525 | HA | GLU | A | 1008 | 14.197 | −7.740 | −1.668 | 1.00 | 1.00 | H |
| ATOM | 526 | HB1 | GLU | A | 1008 | 12.101 | −6.630 | 0.347 | 1.00 | 1.00 | H |
| ATOM | 527 | HB2 | GLU | A | 1008 | 11.851 | −6.902 | −1.395 | 1.00 | 1.00 | H |
| ATOM | 528 | HG1 | GLU | A | 1008 | 13.975 | −5.220 | −1.627 | 1.00 | 1.00 | H |
| ATOM | 529 | HG2 | GLU | A | 1008 | 13.598 | −4.707 | 0.027 | 1.00 | 1.00 | H |
| ATOM | 530 | HN | GLU | A | 1008 | 12.900 | −9.511 | 0.168 | 1.00 | 1.00 | H |
| ATOM | 531 | N | HIS | A | 1009 | 14.191 | −7.702 | 1.721 | 1.00 | 1.00 | N |
| ATOM | 532 | CA | HIS | A | 1009 | 15.129 | −7.834 | 2.854 | 1.00 | 1.00 | C |
| ATOM | 533 | C | HIS | A | 1009 | 14.531 | −8.513 | 4.111 | 1.00 | 1.00 | C |
| ATOM | 534 | O | HIS | A | 1009 | 13.334 | −8.355 | 4.185 | 1.00 | 1.00 | O |
| ATOM | 535 | CB | HIS | A | 1009 | 15.698 | −6.460 | 3.242 | 1.00 | 1.00 | C |
| ATOM | 536 | CG | HIS | A | 1009 | 16.848 | −6.553 | 4.172 | 1.00 | 1.00 | C |
| ATOM | 537 | ND1 | HIS | A | 1009 | 17.993 | −7.099 | 3.790 | 1.00 | 1.00 | N |
| ATOM | 538 | CD2 | HIS | A | 1009 | 16.866 | −6.123 | 5.466 | 1.00 | 1.00 | C |
| ATOM | 539 | CE1 | HIS | A | 1009 | 18.802 | −6.981 | 4.779 | 1.00 | 1.00 | C |
| ATOM | 540 | NE2 | HIS | A | 1009 | 18.240 | −6.420 | 5.737 | 1.00 | 1.00 | N |
| ATOM | 541 | HA | HIS | A | 1009 | 15.965 | −8.437 | 2.557 | 1.00 | 1.00 | H |
| ATOM | 542 | HB1 | HIS | A | 1009 | 14.890 | −5.845 | 3.691 | 1.00 | 1.00 | H |
| ATOM | 543 | HB2 | HIS | A | 1009 | 15.993 | −5.933 | 2.353 | 1.00 | 1.00 | H |
| ATOM | 544 | HD2 | HIS | A | 1009 | 16.119 | −5.622 | 6.058 | 1.00 | 1.00 | H |
| ATOM | 545 | HE1 | HIS | A | 1009 | 19.819 | −7.310 | 4.776 | 1.00 | 1.00 | H |
| ATOM | 546 | HD1 | HIS | A | 1009 | 18.137 | −7.520 | 2.864 | 1.00 | 1.00 | H |
| ATOM | 547 | HN | HIS | A | 1009 | 13.219 | −7.738 | 1.935 | 1.00 | 1.00 | H |
| ATOM | 548 | N | GLY | A | 1010 | 15.273 | −9.256 | 5.002 | 1.00 | 1.00 | N |
| ATOM | 549 | CA | GLY | A | 1010 | 14.575 | −10.077 | 5.994 | 1.00 | 1.00 | C |
| ATOM | 550 | C | GLY | A | 1010 | 14.714 | −9.643 | 7.436 | 1.00 | 1.00 | C |
| ATOM | 551 | O | GLY | A | 1010 | 15.653 | −10.008 | 8.103 | 1.00 | 1.00 | O |
| ATOM | 552 | HA2 | GLY | A | 1010 | 14.989 | −11.128 | 5.893 | 1.00 | 1.00 | H |
| ATOM | 553 | HA1 | GLY | A | 1010 | 13.490 | −10.283 | 5.842 | 1.00 | 1.00 | H |
| ATOM | 554 | HN | GLY | A | 1010 | 16.306 | −9.187 | 5.018 | 1.00 | 1.00 | H |
| ATOM | 555 | N | GLU | A | 1011 | 13.728 | −8.854 | 7.989 | 1.00 | 1.00 | N |
| ATOM | 556 | CA | GLU | A | 1011 | 13.576 | −8.614 | 9.409 | 1.00 | 1.00 | C |
| ATOM | 557 | C | GLU | A | 1011 | 12.120 | −8.382 | 9.661 | 1.00 | 1.00 | C |
| ATOM | 558 | O | GLU | A | 1011 | 11.447 | −7.923 | 8.762 | 1.00 | 1.00 | O |
| ATOM | 559 | CB | GLU | A | 1011 | 14.497 | −7.541 | 10.090 | 1.00 | 1.00 | C |
| ATOM | 560 | CG | GLU | A | 1011 | 15.881 | −7.338 | 9.382 | 1.00 | 1.00 | C |
| ATOM | 561 | CD | GLU | A | 1011 | 16.599 | −6.107 | 9.925 | 1.00 | 1.00 | C |
| ATOM | 562 | OE1 | GLU | A | 1011 | 17.092 | −6.200 | 11.097 | 1.00 | 1.00 | O |
| ATOM | 563 | OE2 | GLU | A | 1011 | 16.641 | −5.074 | 9.204 | 1.00 | 1.00 | O |
| ATOM | 564 | HA | GLU | A | 1011 | 13.813 | −9.563 | 9.869 | 1.00 | 1.00 | H |
| ATOM | 565 | HB1 | GLU | A | 1011 | 14.790 | −7.854 | 11.113 | 1.00 | 1.00 | H |
| ATOM | 566 | HB2 | GLU | A | 1011 | 13.951 | −6.587 | 10.133 | 1.00 | 1.00 | H |
| ATOM | 567 | HG1 | GLU | A | 1011 | 15.735 | −7.095 | 8.320 | 1.00 | 1.00 | H |
| ATOM | 568 | HG2 | GLU | A | 1011 | 16.514 | −8.204 | 9.420 | 1.00 | 1.00 | H |
| ATOM | 569 | HN | GLU | A | 1011 | 13.020 | −8.452 | 7.393 | 1.00 | 1.00 | H |
| ATOM | 570 | N | HIS | A | 1012 | 11.609 | −8.618 | 10.854 | 1.00 | 1.00 | N |
| ATOM | 571 | CA | HIS | A | 1012 | 10.281 | −8.224 | 11.285 | 1.00 | 1.00 | C |
| ATOM | 572 | C | HIS | A | 1012 | 10.120 | −6.697 | 11.403 | 1.00 | 1.00 | C |
| ATOM | 573 | O | HIS | A | 1012 | 8.984 | −6.206 | 11.289 | 1.00 | 1.00 | O |
| ATOM | 574 | CB | HIS | A | 1012 | 10.009 | −8.931 | 12.631 | 1.00 | 1.00 | C |
| ATOM | 575 | CG | HIS | A | 1012 | 8.618 | −8.870 | 13.196 | 1.00 | 1.00 | C |
| ATOM | 576 | ND1 | HIS | A | 1012 | 7.532 | −8.538 | 12.505 | 1.00 | 1.00 | N |
| ATOM | 577 | CD2 | HIS | A | 1012 | 8.326 | −9.177 | 14.481 | 1.00 | 1.00 | C |
| ATOM | 578 | CE1 | HIS | A | 1012 | 6.524 | −8.651 | 13.325 | 1.00 | 1.00 | C |
| ATOM | 579 | NE2 | HIS | A | 1012 | 6.902 | −9.013 | 14.449 | 1.00 | 1.00 | N |
| ATOM | 580 | HA | HIS | A | 1012 | 9.522 | −8.610 | 10.525 | 1.00 | 1.00 | H |
| ATOM | 581 | HB1 | HIS | A | 1012 | 10.152 | −9.977 | 12.534 | 1.00 | 1.00 | H |
| ATOM | 582 | HB2 | HIS | A | 1012 | 10.717 | −8.555 | 13.418 | 1.00 | 1.00 | H |
| ATOM | 583 | HD2 | HIS | A | 1012 | 8.909 | −9.453 | 15.354 | 1.00 | 1.00 | H |
| ATOM | 584 | HE1 | HIS | A | 1012 | 5.463 | −8.501 | 13.067 | 1.00 | 1.00 | H |
| ATOM | 585 | HD1 | HIS | A | 1012 | 7.408 | −8.258 | 11.514 | 1.00 | 1.00 | H |
| ATOM | 586 | HN | HIS | A | 1012 | 12.300 | −8.840 | 11.572 | 1.00 | 1.00 | H |
| ATOM | 587 | N | HIS | A | 1013 | 11.232 | −6.029 | 11.736 | 1.00 | 1.00 | N |
| ATOM | 588 | CA | HIS | A | 1013 | 11.110 | −4.544 | 11.780 | 1.00 | 1.00 | C |
| ATOM | 589 | C | HIS | A | 1013 | 12.444 | −4.134 | 11.211 | 1.00 | 1.00 | C |
| ATOM | 590 | O | HIS | A | 1013 | 13.406 | −4.740 | 11.670 | 1.00 | 1.00 | O |
| ATOM | 591 | CB | HIS | A | 1013 | 10.910 | −4.048 | 13.266 | 1.00 | 1.00 | C |
| ATOM | 592 | CG | HIS | A | 1013 | 9.477 | −4.364 | 13.626 | 1.00 | 1.00 | C |
| ATOM | 593 | ND1 | HIS | A | 1013 | 9.121 | −5.479 | 14.204 | 1.00 | 1.00 | N |
| ATOM | 594 | CD2 | HIS | A | 1013 | 8.373 | −3.633 | 13.366 | 1.00 | 1.00 | C |
| ATOM | 595 | CE1 | HIS | A | 1013 | 7.838 | −5.535 | 14.325 | 1.00 | 1.00 | C |
| ATOM | 596 | NE2 | HIS | A | 1013 | 7.328 | −4.511 | 13.833 | 1.00 | 1.00 | N |
| ATOM | 597 | HA | HIS | A | 1013 | 10.262 | −4.131 | 11.199 | 1.00 | 1.00 | H |
| ATOM | 598 | HB1 | HIS | A | 1013 | 11.679 | −4.363 | 13.999 | 1.00 | 1.00 | H |
| ATOM | 599 | HB2 | HIS | A | 1013 | 10.996 | −2.960 | 13.308 | 1.00 | 1.00 | H |
| ATOM | 600 | HD2 | HIS | A | 1013 | 8.193 | −2.661 | 12.879 | 1.00 | 1.00 | H |
| ATOM | 601 | HE1 | HIS | A | 1013 | 7.261 | −6.389 | 14.794 | 1.00 | 1.00 | H |
| ATOM | 602 | HD1 | HIS | A | 1013 | 9.771 | −6.235 | 14.500 | 1.00 | 1.00 | H |
| ATOM | 603 | HN | HIS | A | 1013 | 12.195 | −6.340 | 11.887 | 1.00 | 1.00 | H |
| ATOM | 604 | N | ILE | A | 1014 | 12.590 | −3.234 | 10.211 | 1.00 | 1.00 | N |
| ATOM | 605 | CA | ILE | A | 1014 | 13.685 | −3.372 | 9.255 | 1.00 | 1.00 | C |
| ATOM | 606 | C | ILE | A | 1014 | 14.754 | −2.275 | 9.212 | 1.00 | 1.00 | C |
| ATOM | 607 | O | ILE | A | 1014 | 14.499 | −1.144 | 9.624 | 1.00 | 1.00 | O |
| ATOM | 608 | CB | ILE | A | 1014 | 13.171 | −3.729 | 7.812 | 1.00 | 1.00 | C |
| ATOM | 609 | CG1 | ILE | A | 1014 | 12.885 | −5.239 | 7.605 | 1.00 | 1.00 | C |
| ATOM | 610 | CG2 | ILE | A | 1014 | 13.960 | −3.076 | 6.642 | 1.00 | 1.00 | C |
| ATOM | 611 | CD1 | ILE | A | 1014 | 12.325 | −5.628 | 6.248 | 1.00 | 1.00 | C |
| ATOM | 612 | HA | ILE | A | 1014 | 14.282 | −4.190 | 9.625 | 1.00 | 1.00 | H |
| ATOM | 613 | HB | ILE | A | 1014 | 12.184 | −3.275 | 7.657 | 1.00 | 1.00 | H |
| ATOM | 614 | HG11 | ILE | A | 1014 | 12.319 | −5.577 | 8.539 | 1.00 | 1.00 | H |
| ATOM | 615 | HG12 | ILE | A | 1014 | 13.857 | −5.787 | 7.696 | 1.00 | 1.00 | H |
| ATOM | 616 | HD11 | ILE | A | 1014 | 11.944 | −6.666 | 6.346 | 1.00 | 1.00 | H |
| ATOM | 617 | HD12 | ILE | A | 1014 | 13.091 | −5.524 | 5.442 | 1.00 | 1.00 | H |
| ATOM | 618 | HD13 | ILE | A | 1014 | 11.464 | −4.987 | 6.026 | 1.00 | 1.00 | H |
| ATOM | 619 | HG21 | ILE | A | 1014 | 14.091 | −1.994 | 6.867 | 1.00 | 1.00 | H |
| ATOM | 620 | HG22 | ILE | A | 1014 | 13.499 | −3.189 | 5.668 | 1.00 | 1.00 | H |
| ATOM | 621 | HG23 | ILE | A | 1014 | 14.973 | −3.496 | 6.609 | 1.00 | 1.00 | H |
| ATOM | 622 | HN | ILE | A | 1014 | 11.903 | −2.580 | 10.056 | 1.00 | 1.00 | H |
| ATOM | 623 | N | ARG | A | 1015 | 16.014 | −2.546 | 8.737 | 1.00 | 1.00 | N |
| ATOM | 624 | CA | ARG | A | 1015 | 16.987 | −1.486 | 8.662 | 1.00 | 1.00 | C |
| ATOM | 625 | C | ARG | A | 1015 | 17.689 | −1.508 | 7.323 | 1.00 | 1.00 | C |
| ATOM | 626 | O | ARG | A | 1015 | 18.822 | −1.972 | 7.278 | 1.00 | 1.00 | O |
| ATOM | 627 | CB | ARG | A | 1015 | 18.007 | −1.842 | 9.771 | 1.00 | 1.00 | C |
| ATOM | 628 | CG | ARG | A | 1015 | 17.456 | −1.744 | 11.238 | 1.00 | 1.00 | C |
| ATOM | 629 | CD | ARG | A | 1015 | 18.060 | −2.774 | 12.261 | 1.00 | 1.00 | C |
| ATOM | 630 | NE | ARG | A | 1015 | 17.231 | −3.975 | 12.319 | 1.00 | 1.00 | N |
| ATOM | 631 | CZ | ARG | A | 1015 | 16.013 | −4.069 | 12.839 | 1.00 | 1.00 | C |
| ATOM | 632 | NH1 | ARG | A | 1015 | 15.292 | −3.038 | 13.241 | 1.00 | 1.00 | N |
| ATOM | 633 | NH2 | ARG | A | 1015 | 15.510 | −5.259 | 12.831 | 1.00 | 1.00 | N |
| ATOM | 634 | HA | ARG | A | 1015 | 16.611 | −0.502 | 8.947 | 1.00 | 1.00 | H |
| ATOM | 635 | HB1 | ARG | A | 1015 | 18.912 | −1.220 | 9.712 | 1.00 | 1.00 | H |
| ATOM | 636 | HB2 | ARG | A | 1015 | 18.351 | −2.906 | 9.577 | 1.00 | 1.00 | H |
| ATOM | 637 | HG1 | ARG | A | 1015 | 16.383 | −1.931 | 11.217 | 1.00 | 1.00 | H |
| ATOM | 638 | HG2 | ARG | A | 1015 | 17.609 | −0.732 | 11.589 | 1.00 | 1.00 | H |
| ATOM | 639 | HD1 | ARG | A | 1015 | 18.248 | −2.319 | 13.240 | 1.00 | 1.00 | H |
| ATOM | 640 | HD2 | ARG | A | 1015 | 19.070 | −2.990 | 11.924 | 1.00 | 1.00 | H |
| ATOM | 641 | HE | ARG | A | 1015 | 17.649 | −4.860 | 11.908 | 1.00 | 1.00 | H |
| ATOM | 642 | HH12 | ARG | A | 1015 | 14.286 | −3.178 | 13.481 | 1.00 | 1.00 | H |
| ATOM | 643 | HH11 | ARG | A | 1015 | 15.708 | −2.115 | 13.328 | 1.00 | 1.00 | H |
| ATOM | 644 | HH22 | ARG | A | 1015 | 14.536 | −5.398 | 13.096 | 1.00 | 1.00 | H |
| ATOM | 645 | HH21 | ARG | A | 1015 | 16.022 | −6.088 | 12.521 | 1.00 | 1.00 | H |
| ATOM | 646 | HN | ARG | A | 1015 | 16.256 | −3.478 | 8.436 | 1.00 | 1.00 | H |
| ATOM | 647 | N | ILE | A | 1016 | 17.112 | −1.036 | 6.187 | 1.00 | 1.00 | N |
| ATOM | 648 | CA | ILE | A | 1016 | 17.744 | −1.151 | 4.861 | 1.00 | 1.00 | C |
| ATOM | 649 | C | ILE | A | 1016 | 17.828 | 0.143 | 4.154 | 1.00 | 1.00 | C |
| ATOM | 650 | O | ILE | A | 1016 | 17.215 | 0.456 | 3.143 | 1.00 | 1.00 | O |
| ATOM | 651 | CB | ILE | A | 1016 | 16.852 | −2.211 | 4.113 | 1.00 | 1.00 | C |
| ATOM | 652 | CG1 | ILE | A | 1016 | 17.464 | −2.750 | 2.756 | 1.00 | 1.00 | C |
| ATOM | 653 | CG2 | ILE | A | 1016 | 15.409 | −1.771 | 3.753 | 1.00 | 1.00 | C |
| ATOM | 654 | CD1 | ILE | A | 1016 | 18.833 | −3.425 | 2.918 | 1.00 | 1.00 | C |
| ATOM | 655 | HA | ILE | A | 1016 | 18.749 | −1.526 | 4.976 | 1.00 | 1.00 | H |
| ATOM | 656 | HB | ILE | A | 1016 | 16.805 | −3.106 | 4.737 | 1.00 | 1.00 | H |
| ATOM | 657 | HG11 | ILE | A | 1016 | 17.570 | −1.916 | 2.057 | 1.00 | 1.00 | H |
| ATOM | 658 | HG12 | ILE | A | 1016 | 16.741 | −3.458 | 2.341 | 1.00 | 1.00 | H |
| ATOM | 659 | HD11 | ILE | A | 1016 | 19.274 | −3.738 | 1.934 | 1.00 | 1.00 | H |
| ATOM | 660 | HD12 | ILE | A | 1016 | 18.735 | −4.359 | 3.455 | 1.00 | 1.00 | H |
| ATOM | 661 | HD13 | ILE | A | 1016 | 19.573 | −2.864 | 3.460 | 1.00 | 1.00 | H |
| ATOM | 662 | HG21 | ILE | A | 1016 | 15.394 | −1.127 | 2.833 | 1.00 | 1.00 | H |
| ATOM | 663 | HG22 | ILE | A | 1016 | 14.863 | −1.247 | 4.557 | 1.00 | 1.00 | H |
| ATOM | 664 | HG23 | ILE | A | 1016 | 14.802 | −2.654 | 3.541 | 1.00 | 1.00 | H |
| ATOM | 665 | HN | ILE | A | 1016 | 16.227 | −0.604 | 6.290 | 1.00 | 1.00 | H |
| ATOM | 666 | N | PRO | A | 1017 | 18.621 | 1.174 | 4.671 | 1.00 | 1.00 | N |
| ATOM | 667 | CA | PRO | A | 1017 | 19.242 | 1.116 | 5.940 | 1.00 | 1.00 | C |
| ATOM | 668 | C | PRO | A | 1017 | 18.335 | 1.725 | 6.950 | 1.00 | 1.00 | C |
| ATOM | 669 | O | PRO | A | 1017 | 17.226 | 1.983 | 6.608 | 1.00 | 1.00 | O |
| ATOM | 670 | CB | PRO | A | 1017 | 20.375 | 2.093 | 5.695 | 1.00 | 1.00 | C |
| ATOM | 671 | CG | PRO | A | 1017 | 19.695 | 3.181 | 4.807 | 1.00 | 1.00 | C |
| ATOM | 672 | CD | PRO | A | 1017 | 18.792 | 2.397 | 3.813 | 1.00 | 1.00 | C |
| ATOM | 673 | HA | PRO | A | 1017 | 19.600 | 0.156 | 6.335 | 1.00 | 1.00 | H |
| ATOM | 674 | HD2 | PRO | A | 1017 | 19.329 | 2.199 | 2.845 | 1.00 | 1.00 | H |
| ATOM | 675 | HD1 | PRO | A | 1017 | 17.866 | 2.928 | 3.603 | 1.00 | 1.00 | H |
| ATOM | 676 | HG2 | PRO | A | 1017 | 20.511 | 3.776 | 4.321 | 1.00 | 1.00 | H |
| ATOM | 677 | HG1 | PRO | A | 1017 | 19.030 | 3.841 | 5.449 | 1.00 | 1.00 | H |
| ATOM | 678 | HB1 | PRO | A | 1017 | 21.116 | 1.507 | 5.158 | 1.00 | 1.00 | H |
| ATOM | 679 | HB2 | PRO | A | 1017 | 20.922 | 2.417 | 6.574 | 1.00 | 1.00 | H |
| ATOM | 680 | N | ARG | A | 1018 | 18.779 | 1.992 | 8.207 | 1.00 | 1.00 | N |
| ATOM | 681 | CA | ARG | A | 1018 | 17.909 | 2.706 | 9.182 | 1.00 | 1.00 | C |
| ATOM | 682 | C | ARG | A | 1018 | 17.542 | 4.047 | 8.616 | 1.00 | 1.00 | C |
| ATOM | 683 | O | ARG | A | 1018 | 18.478 | 4.541 | 8.059 | 1.00 | 1.00 | O |
| ATOM | 684 | CB | ARG | A | 1018 | 18.426 | 2.791 | 10.673 | 1.00 | 1.00 | C |
| ATOM | 685 | CG | ARG | A | 1018 | 19.402 | 4.036 | 10.992 | 1.00 | 1.00 | C |
| ATOM | 686 | CD | ARG | A | 1018 | 20.739 | 4.014 | 10.143 | 1.00 | 1.00 | C |
| ATOM | 687 | NE | ARG | A | 1018 | 21.410 | 5.301 | 10.349 | 1.00 | 1.00 | N |
| ATOM | 688 | CZ | ARG | A | 1018 | 21.016 | 6.405 | 9.756 | 1.00 | 1.00 | C |
| ATOM | 689 | NH1 | ARG | A | 1018 | 20.049 | 6.477 | 8.903 | 1.00 | 1.00 | N |
| ATOM | 690 | NH2 | ARG | A | 1018 | 21.604 | 7.529 | 10.073 | 1.00 | 1.00 | N |
| ATOM | 691 | HA | ARG | A | 1018 | 17.009 | 2.059 | 9.180 | 1.00 | 1.00 | H |
| ATOM | 692 | HB1 | ARG | A | 1018 | 18.926 | 1.763 | 10.841 | 1.00 | 1.00 | H |
| ATOM | 693 | HB2 | ARG | A | 1018 | 17.567 | 2.860 | 11.362 | 1.00 | 1.00 | H |
| ATOM | 694 | HG1 | ARG | A | 1018 | 19.608 | 3.965 | 12.092 | 1.00 | 1.00 | H |
| ATOM | 695 | HG2 | ARG | A | 1018 | 18.800 | 4.907 | 10.742 | 1.00 | 1.00 | H |
| ATOM | 696 | HD1 | ARG | A | 1018 | 20.683 | 3.797 | 9.046 | 1.00 | 1.00 | H |
| ATOM | 697 | HD2 | ARG | A | 1018 | 21.308 | 3.163 | 10.562 | 1.00 | 1.00 | H |
| ATOM | 698 | HE | ARG | A | 1018 | 22.227 | 5.305 | 11.015 | 1.00 | 1.00 | H |
| ATOM | 699 | HH12 | ARG | A | 1018 | 19.677 | 7.409 | 8.592 | 1.00 | 1.00 | H |
| ATOM | 700 | HH11 | ARG | A | 1018 | 19.563 | 5.660 | 8.503 | 1.00 | 1.00 | H |
| ATOM | 701 | HH22 | ARG | A | 1018 | 21.435 | 8.443 | 9.626 | 1.00 | 1.00 | H |
| ATOM | 702 | HH21 | ARG | A | 1018 | 22.377 | 7.548 | 10.756 | 1.00 | 1.00 | H |
| ATOM | 703 | HN | ARG | A | 1018 | 19.689 | 1.690 | 8.504 | 1.00 | 1.00 | H |
| ATOM | 704 | N | THR | A | 1019 | 16.342 | 4.646 | 8.771 | 1.00 | 1.00 | N |
| ATOM | 705 | CA | THR | A | 1019 | 15.963 | 5.870 | 8.099 | 1.00 | 1.00 | C |
| ATOM | 706 | C | THR | A | 1019 | 17.119 | 6.661 | 7.512 | 1.00 | 1.00 | C |
| ATOM | 707 | O | THR | A | 1019 | 17.811 | 7.250 | 8.338 | 1.00 | 1.00 | O |
| ATOM | 708 | CB | THR | A | 1019 | 15.176 | 6.800 | 9.031 | 1.00 | 1.00 | C |
| ATOM | 709 | OG1 | THR | A | 1019 | 14.107 | 6.049 | 9.613 | 1.00 | 1.00 | O |
| ATOM | 710 | CG2 | THR | A | 1019 | 14.667 | 8.092 | 8.334 | 1.00 | 1.00 | C |
| ATOM | 711 | HA | THR | A | 1019 | 15.280 | 5.508 | 7.320 | 1.00 | 1.00 | H |
| ATOM | 712 | HB | THR | A | 1019 | 15.827 | 7.064 | 9.924 | 1.00 | 1.00 | H |
| ATOM | 713 | HG1 | THR | A | 1019 | 13.360 | 5.872 | 9.049 | 1.00 | 1.00 | H |
| ATOM | 714 | HG23 | THR | A | 1019 | 14.028 | 8.640 | 9.037 | 1.00 | 1.00 | H |
| ATOM | 715 | HG21 | THR | A | 1019 | 14.145 | 7.866 | 7.430 | 1.00 | 1.00 | H |
| ATOM | 716 | HG22 | THR | A | 1019 | 15.487 | 8.755 | 8.092 | 1.00 | 1.00 | H |
| ATOM | 717 | HN | THR | A | 1019 | 15.591 | 4.131 | 9.265 | 1.00 | 1.00 | H |
| ATOM | 718 | N | PRO | A | 1020 | 17.430 | 6.731 | 6.176 | 1.00 | 1.00 | N |
| ATOM | 719 | CA | PRO | A | 1020 | 18.658 | 7.406 | 5.722 | 1.00 | 1.00 | C |
| ATOM | 720 | C | PRO | A | 1020 | 18.746 | 8.864 | 6.088 | 1.00 | 1.00 | C |
| ATOM | 721 | O | PRO | A | 1020 | 19.810 | 9.296 | 6.487 | 1.00 | 1.00 | O |
| ATOM | 722 | CB | PRO | A | 1020 | 18.650 | 7.085 | 4.198 | 1.00 | 1.00 | C |
| ATOM | 723 | CG | PRO | A | 1020 | 17.161 | 6.890 | 3.860 | 1.00 | 1.00 | C |
| ATOM | 724 | CD | PRO | A | 1020 | 16.646 | 6.138 | 5.141 | 1.00 | 1.00 | C |
| ATOM | 725 | HA | PRO | A | 1020 | 19.511 | 6.905 | 6.196 | 1.00 | 1.00 | H |
| ATOM | 726 | HD2 | PRO | A | 1020 | 16.893 | 5.028 | 5.160 | 1.00 | 1.00 | H |
| ATOM | 727 | HD1 | PRO | A | 1020 | 15.618 | 6.310 | 5.250 | 1.00 | 1.00 | H |
| ATOM | 728 | HG2 | PRO | A | 1020 | 17.012 | 6.380 | 2.894 | 1.00 | 1.00 | H |
| ATOM | 729 | HG1 | PRO | A | 1020 | 16.726 | 7.913 | 3.768 | 1.00 | 1.00 | H |
| ATOM | 730 | HB1 | PRO | A | 1020 | 19.107 | 6.093 | 4.090 | 1.00 | 1.00 | H |
| ATOM | 731 | HB2 | PRO | A | 1020 | 19.185 | 7.823 | 3.554 | 1.00 | 1.00 | H |
| ATOM | 732 | N | ALA | A | 1021 | 17.585 | 9.577 | 6.038 | 1.00 | 1.00 | N |
| ATOM | 733 | CA | ALA | A | 1021 | 17.602 | 11.032 | 6.320 | 1.00 | 1.00 | C |
| ATOM | 734 | C | ALA | A | 1021 | 16.275 | 11.586 | 5.848 | 1.00 | 1.00 | C |
| ATOM | 735 | O | ALA | A | 1021 | 15.345 | 10.816 | 5.679 | 1.00 | 1.00 | O |
| ATOM | 736 | CB | ALA | A | 1021 | 17.852 | 11.440 | 7.802 | 1.00 | 1.00 | C |
| ATOM | 737 | HA | ALA | A | 1021 | 18.337 | 11.461 | 5.676 | 1.00 | 1.00 | H |
| ATOM | 738 | HB1 | ALA | A | 1021 | 18.764 | 11.098 | 8.306 | 1.00 | 1.00 | H |
| ATOM | 739 | HB2 | ALA | A | 1021 | 17.875 | 12.527 | 7.957 | 1.00 | 1.00 | H |
| ATOM | 740 | HB3 | ALA | A | 1021 | 16.963 | 11.095 | 8.405 | 1.00 | 1.00 | H |
| ATOM | 741 | HN | ALA | A | 1021 | 16.680 | 9.152 | 5.787 | 1.00 | 1.00 | H |
| ATOM | 742 | N | ARG | A | 1022 | 16.120 | 12.927 | 5.722 | 1.00 | 1.00 | N |
| ATOM | 743 | CA | ARG | A | 1022 | 14.899 | 13.481 | 5.135 | 1.00 | 1.00 | C |
| ATOM | 744 | C | ARG | A | 1022 | 15.022 | 13.508 | 3.582 | 1.00 | 1.00 | C |
| ATOM | 745 | O | ARG | A | 1022 | 15.120 | 14.546 | 2.933 | 1.00 | 1.00 | O |
| ATOM | 746 | CB | ARG | A | 1022 | 14.518 | 14.956 | 5.579 | 1.00 | 1.00 | C |
| ATOM | 747 | CG | ARG | A | 1022 | 14.320 | 15.063 | 7.122 | 1.00 | 1.00 | C |
| ATOM | 748 | CD | ARG | A | 1022 | 13.430 | 14.008 | 7.799 | 1.00 | 1.00 | C |
| ATOM | 749 | NE | ARG | A | 1022 | 13.016 | 14.505 | 9.134 | 1.00 | 1.00 | N |
| ATOM | 750 | CZ | ARG | A | 1022 | 11.988 | 15.295 | 9.376 | 1.00 | 1.00 | C |
| ATOM | 751 | NH1 | ARG | A | 1022 | 11.204 | 15.758 | 8.413 | 1.00 | 1.00 | N |
| ATOM | 752 | NH2 | ARG | A | 1022 | 11.687 | 15.636 | 10.601 | 1.00 | 1.00 | N |
| ATOM | 753 | HA | ARG | A | 1022 | 14.045 | 12.836 | 5.326 | 1.00 | 1.00 | H |
| ATOM | 754 | HB1 | ARG | A | 1022 | 13.518 | 15.165 | 5.172 | 1.00 | 1.00 | H |
| ATOM | 755 | HB2 | ARG | A | 1022 | 15.204 | 15.695 | 5.184 | 1.00 | 1.00 | H |
| ATOM | 756 | HG1 | ARG | A | 1022 | 13.996 | 16.071 | 7.407 | 1.00 | 1.00 | H |
| ATOM | 757 | HG2 | ARG | A | 1022 | 15.288 | 14.893 | 7.696 | 1.00 | 1.00 | H |
| ATOM | 758 | HD1 | ARG | A | 1022 | 13.931 | 13.046 | 7.887 | 1.00 | 1.00 | H |
| ATOM | 759 | HD2 | ARG | A | 1022 | 12.565 | 13.774 | 7.151 | 1.00 | 1.00 | H |
| ATOM | 760 | HE | ARG | A | 1022 | 13.595 | 14.141 | 9.934 | 1.00 | 1.00 | H |
| ATOM | 761 | HH12 | ARG | A | 1022 | 10.349 | 16.269 | 8.666 | 1.00 | 1.00 | H |
| ATOM | 762 | HH11 | ARG | A | 1022 | 11.353 | 15.593 | 7.413 | 1.00 | 1.00 | H |
| ATOM | 763 | HH22 | ARG | A | 1022 | 10.872 | 16.223 | 10.882 | 1.00 | 1.00 | H |
| ATOM | 764 | HH21 | ARG | A | 1022 | 12.271 | 15.348 | 11.396 | 1.00 | 1.00 | H |
| ATOM | 765 | HN | ARG | A | 1022 | 16.918 | 13.574 | 5.823 | 1.00 | 1.00 | H |
| ATOM | 766 | N | VAL | A | 1023 | 15.073 | 12.283 | 3.012 | 1.00 | 1.00 | N |
| ATOM | 767 | CA | VAL | A | 1023 | 15.273 | 12.074 | 1.597 | 1.00 | 1.00 | C |
| ATOM | 768 | C | VAL | A | 1023 | 14.378 | 11.000 | 1.024 | 1.00 | 1.00 | C |
| ATOM | 769 | O | VAL | A | 1023 | 14.774 | 10.330 | 0.099 | 1.00 | 1.00 | O |
| ATOM | 770 | CB | VAL | A | 1023 | 16.753 | 11.699 | 1.206 | 1.00 | 1.00 | C |
| ATOM | 771 | CG1 | VAL | A | 1023 | 17.637 | 12.969 | 1.434 | 1.00 | 1.00 | C |
| ATOM | 772 | CG2 | VAL | A | 1023 | 17.181 | 10.477 | 2.104 | 1.00 | 1.00 | C |
| ATOM | 773 | HA | VAL | A | 1023 | 14.944 | 12.951 | 0.998 | 1.00 | 1.00 | H |
| ATOM | 774 | HB | VAL | A | 1023 | 16.778 | 11.494 | 0.137 | 1.00 | 1.00 | H |
| ATOM | 775 | HG11 | VAL | A | 1023 | 18.673 | 12.806 | 1.007 | 1.00 | 1.00 | H |
| ATOM | 776 | HG12 | VAL | A | 1023 | 17.701 | 13.246 | 2.486 | 1.00 | 1.00 | H |
| ATOM | 777 | HG13 | VAL | A | 1023 | 17.170 | 13.814 | 0.863 | 1.00 | 1.00 | H |
| ATOM | 778 | HG21 | VAL | A | 1023 | 17.212 | 10.724 | 3.138 | 1.00 | 1.00 | H |
| ATOM | 779 | HG22 | VAL | A | 1023 | 16.430 | 9.661 | 2.006 | 1.00 | 1.00 | H |
| ATOM | 780 | HG23 | VAL | A | 1023 | 18.136 | 10.112 | 1.690 | 1.00 | 1.00 | H |
| ATOM | 781 | HN | VAL | A | 1023 | 15.004 | 11.454 | 3.568 | 1.00 | 1.00 | H |
| ATOM | 782 | N | THR | A | 1024 | 13.160 | 10.779 | 1.573 | 1.00 | 1.00 | N |
| ATOM | 783 | CA | THR | A | 1024 | 12.372 | 9.608 | 1.227 | 1.00 | 1.00 | C |
| ATOM | 784 | C | THR | A | 1024 | 10.935 | 9.890 | 0.843 | 1.00 | 1.00 | C |
| ATOM | 785 | O | THR | A | 1024 | 10.485 | 11.015 | 1.023 | 1.00 | 1.00 | O |
| ATOM | 786 | CB | THR | A | 1024 | 12.275 | 8.696 | 2.522 | 1.00 | 1.00 | C |
| ATOM | 787 | OG1 | THR | A | 1024 | 11.422 | 9.231 | 3.545 | 1.00 | 1.00 | O |
| ATOM | 788 | CG2 | THR | A | 1024 | 13.640 | 8.367 | 3.107 | 1.00 | 1.00 | C |
| ATOM | 789 | HA | THR | A | 1024 | 12.814 | 9.036 | 0.393 | 1.00 | 1.00 | H |
| ATOM | 790 | HB | THR | A | 1024 | 11.791 | 7.804 | 2.224 | 1.00 | 1.00 | H |
| ATOM | 791 | HG1 | THR | A | 1024 | 10.502 | 9.318 | 3.394 | 1.00 | 1.00 | H |
| ATOM | 792 | HG23 | THR | A | 1024 | 14.197 | 7.868 | 2.298 | 1.00 | 1.00 | H |
| ATOM | 793 | HG21 | THR | A | 1024 | 13.620 | 7.711 | 4.033 | 1.00 | 1.00 | H |
| ATOM | 794 | HG22 | THR | A | 1024 | 14.198 | 9.266 | 3.335 | 1.00 | 1.00 | H |
| ATOM | 795 | HN | THR | A | 1024 | 12.762 | 11.411 | 2.285 | 1.00 | 1.00 | H |
| ATOM | 796 | N | GLY | A | 1025 | 10.185 | 8.874 | 0.351 | 1.00 | 1.00 | N |
| ATOM | 797 | CA | GLY | A | 1025 | 8.734 | 8.969 | 0.398 | 1.00 | 1.00 | C |
| ATOM | 798 | C | GLY | A | 1025 | 8.326 | 8.401 | 1.707 | 1.00 | 1.00 | C |
| ATOM | 799 | O | GLY | A | 1025 | 9.232 | 8.218 | 2.517 | 1.00 | 1.00 | O |
| ATOM | 800 | HA2 | GLY | A | 1025 | 8.166 | 8.441 | −0.345 | 1.00 | 1.00 | H |
| ATOM | 801 | HA1 | GLY | A | 1025 | 8.350 | 9.977 | 0.410 | 1.00 | 1.00 | H |
| ATOM | 802 | HN | GLY | A | 1025 | 10.598 | 7.974 | 0.035 | 1.00 | 1.00 | H |
| ATOM | 803 | N | GLY | A | 1026 | 7.008 | 8.082 | 1.999 | 1.00 | 1.00 | N |
| ATOM | 804 | CA | GLY | A | 1026 | 6.791 | 7.393 | 3.295 | 1.00 | 1.00 | C |
| ATOM | 805 | C | GLY | A | 1026 | 5.418 | 7.637 | 3.830 | 1.00 | 1.00 | C |
| ATOM | 806 | O | GLY | A | 1026 | 4.888 | 8.695 | 3.496 | 1.00 | 1.00 | O |
| ATOM | 807 | HA2 | GLY | A | 1026 | 7.488 | 7.734 | 4.077 | 1.00 | 1.00 | H |
| ATOM | 808 | HA1 | GLY | A | 1026 | 6.929 | 6.286 | 3.267 | 1.00 | 1.00 | H |
| ATOM | 809 | HN | GLY | A | 1026 | 6.294 | 8.212 | 1.295 | 1.00 | 1.00 | H |
| ATOM | 810 | N | VAL | A | 1027 | 4.808 | 6.665 | 4.575 | 1.00 | 1.00 | N |
| ATOM | 811 | CA | VAL | A | 1027 | 3.346 | 6.644 | 4.858 | 1.00 | 1.00 | C |
| ATOM | 812 | C | VAL | A | 1027 | 2.999 | 5.915 | 6.098 | 1.00 | 1.00 | C |
| ATOM | 813 | O | VAL | A | 1027 | 3.709 | 5.029 | 6.544 | 1.00 | 1.00 | O |
| ATOM | 814 | CB | VAL | A | 1027 | 2.616 | 5.960 | 3.638 | 1.00 | 1.00 | C |
| ATOM | 815 | CG1 | VAL | A | 1027 | 2.652 | 6.832 | 2.344 | 1.00 | 1.00 | C |
| ATOM | 816 | CG2 | VAL | A | 1027 | 3.035 | 4.473 | 3.448 | 1.00 | 1.00 | C |
| ATOM | 817 | HA | VAL | A | 1027 | 2.950 | 7.672 | 5.004 | 1.00 | 1.00 | H |
| ATOM | 818 | HB | VAL | A | 1027 | 1.564 | 5.966 | 3.870 | 1.00 | 1.00 | H |
| ATOM | 819 | HG11 | VAL | A | 1027 | 2.444 | 7.827 | 2.695 | 1.00 | 1.00 | H |
| ATOM | 820 | HG12 | VAL | A | 1027 | 3.639 | 6.684 | 1.874 | 1.00 | 1.00 | H |
| ATOM | 821 | HG13 | VAL | A | 1027 | 1.869 | 6.467 | 1.624 | 1.00 | 1.00 | H |
| ATOM | 822 | HG21 | VAL | A | 1027 | 2.938 | 3.815 | 4.333 | 1.00 | 1.00 | H |
| ATOM | 823 | HG22 | VAL | A | 1027 | 2.391 | 4.065 | 2.645 | 1.00 | 1.00 | H |
| ATOM | 824 | HG23 | VAL | A | 1027 | 4.106 | 4.372 | 3.104 | 1.00 | 1.00 | H |
| ATOM | 825 | HN | VAL | A | 1027 | 5.273 | 5.810 | 4.784 | 1.00 | 1.00 | H |
| ATOM | 826 | N | PHE | A | 1028 | 1.894 | 6.323 | 6.764 | 1.00 | 1.00 | N |
| ATOM | 827 | CA | PHE | A | 1028 | 1.539 | 5.707 | 8.037 | 1.00 | 1.00 | C |
| ATOM | 828 | C | PHE | A | 1028 | 0.328 | 4.864 | 7.801 | 1.00 | 1.00 | C |
| ATOM | 829 | O | PHE | A | 1028 | −0.753 | 5.340 | 8.145 | 1.00 | 1.00 | O |
| ATOM | 830 | CB | PHE | A | 1028 | 1.276 | 6.894 | 9.064 | 1.00 | 1.00 | C |
| ATOM | 831 | CG | PHE | A | 1028 | 1.037 | 6.511 | 10.563 | 1.00 | 1.00 | C |
| ATOM | 832 | CD1 | PHE | A | 1028 | 2.061 | 5.823 | 11.222 | 1.00 | 1.00 | C |
| ATOM | 833 | CD2 | PHE | A | 1028 | −0.124 | 6.875 | 11.317 | 1.00 | 1.00 | C |
| ATOM | 834 | CE1 | PHE | A | 1028 | 2.015 | 5.498 | 12.579 | 1.00 | 1.00 | C |
| ATOM | 835 | CE2 | PHE | A | 1028 | −0.111 | 6.607 | 12.703 | 1.00 | 1.00 | C |
| ATOM | 836 | CZ | PHE | A | 1028 | 0.928 | 5.939 | 13.328 | 1.00 | 1.00 | C |
| ATOM | 837 | HA | PHE | A | 1028 | 2.444 | 5.182 | 8.477 | 1.00 | 1.00 | H |
| ATOM | 838 | HB1 | PHE | A | 1028 | 0.372 | 7.381 | 8.624 | 1.00 | 1.00 | H |
| ATOM | 839 | HB2 | PHE | A | 1028 | 2.185 | 7.529 | 9.043 | 1.00 | 1.00 | H |
| ATOM | 840 | HD2 | PHE | A | 1028 | −0.929 | 7.394 | 10.815 | 1.00 | 1.00 | H |
| ATOM | 841 | HE2 | PHE | A | 1028 | −0.997 | 6.943 | 13.184 | 1.00 | 1.00 | H |
| ATOM | 842 | HZ | PHE | A | 1028 | 0.926 | 5.716 | 14.364 | 1.00 | 1.00 | H |
| ATOM | 843 | HE1 | PHE | A | 1028 | 2.791 | 4.888 | 13.051 | 1.00 | 1.00 | H |
| ATOM | 844 | HD1 | PHE | A | 1028 | 2.943 | 5.531 | 10.685 | 1.00 | 1.00 | H |
| ATOM | 845 | HN | PHE | A | 1028 | 1.329 | 7.077 | 6.348 | 1.00 | 1.00 | H |
| ATOM | 846 | N | LEU | A | 1029 | 0.445 | 3.661 | 7.177 | 1.00 | 1.00 | N |
| ATOM | 847 | CA | LEU | A | 1029 | −0.702 | 2.765 | 6.963 | 1.00 | 1.00 | C |
| ATOM | 848 | C | LEU | A | 1029 | −1.381 | 2.346 | 8.273 | 1.00 | 1.00 | C |
| ATOM | 849 | O | LEU | A | 1029 | −1.312 | 1.170 | 8.574 | 1.00 | 1.00 | O |
| ATOM | 850 | CB | LEU | A | 1029 | −0.449 | 1.530 | 6.073 | 1.00 | 1.00 | C |
| ATOM | 851 | CG | LEU | A | 1029 | 0.262 | 1.770 | 4.709 | 1.00 | 1.00 | C |
| ATOM | 852 | CD1 | LEU | A | 1029 | 0.664 | 0.451 | 3.952 | 1.00 | 1.00 | C |
| ATOM | 853 | CD2 | LEU | A | 1029 | −0.588 | 2.712 | 3.750 | 1.00 | 1.00 | C |
| ATOM | 854 | HA | LEU | A | 1029 | −1.428 | 3.398 | 6.420 | 1.00 | 1.00 | H |
| ATOM | 855 | HB1 | LEU | A | 1029 | −1.401 | 1.013 | 5.841 | 1.00 | 1.00 | H |
| ATOM | 856 | HB2 | LEU | A | 1029 | 0.222 | 0.889 | 6.653 | 1.00 | 1.00 | H |
| ATOM | 857 | HG | LEU | A | 1029 | 1.229 | 2.324 | 4.865 | 1.00 | 1.00 | H |
| ATOM | 858 | HD21 | LEU | A | 1029 | −0.643 | 3.703 | 4.237 | 1.00 | 1.00 | H |
| ATOM | 859 | HD22 | LEU | A | 1029 | −0.225 | 2.784 | 2.729 | 1.00 | 1.00 | H |
| ATOM | 860 | HD23 | LEU | A | 1029 | −1.598 | 2.299 | 3.653 | 1.00 | 1.00 | H |
| ATOM | 861 | HD11 | LEU | A | 1029 | −0.162 | −0.245 | 3.883 | 1.00 | 1.00 | H |
| ATOM | 862 | HD12 | LEU | A | 1029 | 1.173 | 0.568 | 3.018 | 1.00 | 1.00 | H |
| ATOM | 863 | HD13 | LEU | A | 1029 | 1.338 | −0.090 | 4.611 | 1.00 | 1.00 | H |
| ATOM | 864 | HN | LEU | A | 1029 | 1.352 | 3.346 | 6.923 | 1.00 | 1.00 | H |
| ATOM | 865 | N | VAL | A | 1030 | −2.036 | 3.276 | 9.017 | 1.00 | 1.00 | N |
| ATOM | 866 | CA | VAL | A | 1030 | −2.514 | 2.944 | 10.363 | 1.00 | 1.00 | C |
| ATOM | 867 | C | VAL | A | 1030 | −3.928 | 3.493 | 10.529 | 1.00 | 1.00 | C |
| ATOM | 868 | O | VAL | A | 1030 | −4.092 | 4.628 | 10.930 | 1.00 | 1.00 | O |
| ATOM | 869 | CB | VAL | A | 1030 | −1.541 | 3.514 | 11.483 | 1.00 | 1.00 | C |
| ATOM | 870 | CG1 | VAL | A | 1030 | −2.162 | 3.124 | 12.889 | 1.00 | 1.00 | C |
| ATOM | 871 | CG2 | VAL | A | 1030 | −0.087 | 2.979 | 11.373 | 1.00 | 1.00 | C |
| ATOM | 872 | HA | VAL | A | 1030 | −2.540 | 1.855 | 10.563 | 1.00 | 1.00 | H |
| ATOM | 873 | HB | VAL | A | 1030 | −1.548 | 4.632 | 11.413 | 1.00 | 1.00 | H |
| ATOM | 874 | HG11 | VAL | A | 1030 | −2.219 | 2.041 | 12.943 | 1.00 | 1.00 | H |
| ATOM | 875 | HG12 | VAL | A | 1030 | −1.504 | 3.425 | 13.753 | 1.00 | 1.00 | H |
| ATOM | 876 | HG13 | VAL | A | 1030 | −3.156 | 3.534 | 13.088 | 1.00 | 1.00 | H |
| ATOM | 877 | HG21 | VAL | A | 1030 | −0.039 | 1.865 | 11.449 | 1.00 | 1.00 | H |
| ATOM | 878 | HG22 | VAL | A | 1030 | 0.249 | 3.224 | 10.390 | 1.00 | 1.00 | H |
| ATOM | 879 | HG23 | VAL | A | 1030 | 0.566 | 3.487 | 12.175 | 1.00 | 1.00 | H |
| ATOM | 880 | HN | VAL | A | 1030 | −2.069 | 4.237 | 8.753 | 1.00 | 1.00 | H |
| ATOM | 881 | N | ASP | A | 1031 | −4.998 | 2.703 | 10.264 | 1.00 | 1.00 | N |
| ATOM | 882 | CA | ASP | A | 1031 | −6.323 | 3.075 | 10.705 | 1.00 | 1.00 | C |
| ATOM | 883 | C | ASP | A | 1031 | −6.418 | 2.597 | 12.147 | 1.00 | 1.00 | C |
| ATOM | 884 | O | ASP | A | 1031 | −6.875 | 1.501 | 12.395 | 1.00 | 1.00 | O |
| ATOM | 885 | CB | ASP | A | 1031 | −7.488 | 2.651 | 9.759 | 1.00 | 1.00 | C |
| ATOM | 886 | CG | ASP | A | 1031 | −8.840 | 2.958 | 10.310 | 1.00 | 1.00 | C |
| ATOM | 887 | OD1 | ASP | A | 1031 | −9.102 | 4.085 | 10.803 | 1.00 | 1.00 | O |
| ATOM | 888 | OD2 | ASP | A | 1031 | −9.828 | 2.098 | 10.213 | 1.00 | 1.00 | O |
| ATOM | 889 | HA | ASP | A | 1031 | −6.432 | 4.192 | 10.719 | 1.00 | 1.00 | H |
| ATOM | 890 | HB1 | ASP | A | 1031 | −7.353 | 1.578 | 9.643 | 1.00 | 1.00 | H |
| ATOM | 891 | HB2 | ASP | A | 1031 | −7.464 | 3.159 | 8.758 | 1.00 | 1.00 | H |
| ATOM | 892 | HN | ASP | A | 1031 | −4.859 | 1.753 | 9.898 | 1.00 | 1.00 | H |
| ATOM | 893 | N | LYS | A | 1032 | −5.862 | 3.344 | 13.110 | 1.00 | 1.00 | N |
| ATOM | 894 | CA | LYS | A | 1032 | −5.706 | 2.950 | 14.510 | 1.00 | 1.00 | C |
| ATOM | 895 | C | LYS | A | 1032 | −4.925 | 1.647 | 14.580 | 1.00 | 1.00 | C |
| ATOM | 896 | O | LYS | A | 1032 | −4.731 | 1.017 | 13.557 | 1.00 | 1.00 | O |
| ATOM | 897 | CB | LYS | A | 1032 | −7.091 | 2.783 | 15.277 | 1.00 | 1.00 | C |
| ATOM | 898 | CG | LYS | A | 1032 | −8.139 | 3.950 | 15.213 | 1.00 | 1.00 | C |
| ATOM | 899 | CD | LYS | A | 1032 | −8.936 | 4.138 | 13.871 | 1.00 | 1.00 | C |
| ATOM | 900 | CE | LYS | A | 1032 | −9.780 | 2.937 | 13.357 | 1.00 | 1.00 | C |
| ATOM | 901 | NZ | LYS | A | 1032 | −10.757 | 3.340 | 12.246 | 1.00 | 1.00 | N |
| ATOM | 902 | HA | LYS | A | 1032 | −5.080 | 3.744 | 14.990 | 1.00 | 1.00 | H |
| ATOM | 903 | HB1 | LYS | A | 1032 | −6.811 | 2.664 | 16.340 | 1.00 | 1.00 | H |
| ATOM | 904 | HB2 | LYS | A | 1032 | −7.618 | 1.874 | 14.876 | 1.00 | 1.00 | H |
| ATOM | 905 | HG1 | LYS | A | 1032 | −8.961 | 3.749 | 15.941 | 1.00 | 1.00 | H |
| ATOM | 906 | HG2 | LYS | A | 1032 | −7.649 | 4.846 | 15.626 | 1.00 | 1.00 | H |
| ATOM | 907 | HD1 | LYS | A | 1032 | −8.175 | 4.437 | 13.137 | 1.00 | 1.00 | H |
| ATOM | 908 | HD2 | LYS | A | 1032 | −9.655 | 4.947 | 13.949 | 1.00 | 1.00 | H |
| ATOM | 909 | HE1 | LYS | A | 1032 | −9.035 | 2.196 | 13.035 | 1.00 | 1.00 | H |
| ATOM | 910 | HE2 | LYS | A | 1032 | −10.376 | 2.455 | 14.189 | 1.00 | 1.00 | H |
| ATOM | 911 | HZ1 | LYS | A | 1032 | −11.791 | 3.366 | 12.555 | 1.00 | 1.00 | H |
| ATOM | 912 | HZ2 | LYS | A | 1032 | −10.523 | 4.239 | 11.643 | 1.00 | 1.00 | H |
| ATOM | 913 | HZ3 | LYS | A | 1032 | −10.702 | 2.515 | 11.579 | 1.00 | 1.00 | H |
| ATOM | 914 | HN | LYS | A | 1032 | −5.520 | 4.269 | 12.905 | 1.00 | 1.00 | H |
| ATOM | 915 | N | ASN | A | 1033 | −4.474 | 1.146 | 15.742 | 1.00 | 1.00 | N |
| ATOM | 916 | CA | ASN | A | 1033 | −4.194 | −0.297 | 15.887 | 1.00 | 1.00 | C |
| ATOM | 917 | C | ASN | A | 1033 | −3.293 | −0.801 | 14.799 | 1.00 | 1.00 | C |
| ATOM | 918 | O | ASN | A | 1033 | −3.750 | −1.617 | 14.000 | 1.00 | 1.00 | O |
| ATOM | 919 | CB | ASN | A | 1033 | −5.670 | −0.883 | 15.792 | 1.00 | 1.00 | C |
| ATOM | 920 | CG | ASN | A | 1033 | −6.578 | −0.353 | 16.832 | 1.00 | 1.00 | C |
| ATOM | 921 | OD1 | ASN | A | 1033 | −6.164 | 0.418 | 17.676 | 1.00 | 1.00 | O |
| ATOM | 922 | ND2 | ASN | A | 1033 | −7.878 | −0.744 | 16.760 | 1.00 | 1.00 | N |
| ATOM | 923 | HA | ASN | A | 1033 | −3.714 | −0.569 | 16.839 | 1.00 | 1.00 | H |
| ATOM | 924 | HB1 | ASN | A | 1033 | −5.611 | −1.978 | 15.909 | 1.00 | 1.00 | H |
| ATOM | 925 | HB2 | ASN | A | 1033 | −6.092 | −0.589 | 14.786 | 1.00 | 1.00 | H |
| ATOM | 926 | HD22 | ASN | A | 1033 | −8.577 | −0.360 | 17.383 | 1.00 | 1.00 | H |
| ATOM | 927 | HD21 | ASN | A | 1033 | −8.205 | −1.419 | 16.074 | 1.00 | 1.00 | H |
| ATOM | 928 | HN | ASN | A | 1033 | −4.525 | 1.717 | 16.563 | 1.00 | 1.00 | H |
| ATOM | 929 | N | PRO | A | 1034 | −2.009 | −0.374 | 14.637 | 1.00 | 1.00 | N |
| ATOM | 930 | CA | PRO | A | 1034 | −1.185 | −0.979 | 13.653 | 1.00 | 1.00 | C |
| ATOM | 931 | C | PRO | A | 1034 | −1.365 | −2.449 | 13.617 | 1.00 | 1.00 | C |
| ATOM | 932 | O | PRO | A | 1034 | −1.454 | −3.054 | 12.573 | 1.00 | 1.00 | O |
| ATOM | 933 | CB | PRO | A | 1034 | 0.269 | −0.630 | 14.070 | 1.00 | 1.00 | C |
| ATOM | 934 | CG | PRO | A | 1034 | 0.067 | 0.748 | 14.701 | 1.00 | 1.00 | C |
| ATOM | 935 | CD | PRO | A | 1034 | −1.283 | 0.562 | 15.468 | 1.00 | 1.00 | C |
| ATOM | 936 | HA | PRO | A | 1034 | −1.446 | −0.588 | 12.622 | 1.00 | 1.00 | H |
| ATOM | 937 | HD2 | PRO | A | 1034 | −1.836 | 1.442 | 15.716 | 1.00 | 1.00 | H |
| ATOM | 938 | HD1 | PRO | A | 1034 | −1.096 | 0.033 | 16.401 | 1.00 | 1.00 | H |
| ATOM | 939 | HG2 | PRO | A | 1034 | 0.017 | 1.617 | 14.013 | 1.00 | 1.00 | H |
| ATOM | 940 | HG1 | PRO | A | 1034 | 0.846 | 0.962 | 15.467 | 1.00 | 1.00 | H |
| ATOM | 941 | HB1 | PRO | A | 1034 | 0.580 | −1.357 | 14.802 | 1.00 | 1.00 | H |
| ATOM | 942 | HB2 | PRO | A | 1034 | 0.947 | −0.601 | 13.175 | 1.00 | 1.00 | H |
| ATOM | 943 | N | HIE | A | 1035 | −1.359 | −3.141 | 14.808 | 1.00 | 1.00 | N |
| ATOM | 944 | CA | HIE | A | 1035 | −1.317 | −4.643 | 14.797 | 1.00 | 1.00 | C |
| ATOM | 945 | C | HIE | A | 1035 | −1.640 | −5.112 | 16.190 | 1.00 | 1.00 | C |
| ATOM | 946 | O | HIE | A | 1035 | −0.673 | −5.423 | 16.834 | 1.00 | 1.00 | O |
| ATOM | 947 | CB | HIE | A | 1035 | 0.039 | −5.159 | 14.265 | 1.00 | 1.00 | C |
| ATOM | 948 | H | HIE | A | 1035 | −1.281 | −2.744 | 15.686 | 1.00 | 1.00 | H |
| ATOM | 949 | CG | HIE | A | 1035 | 0.354 | −6.621 | 14.446 | 1.00 | 1.00 | C |
| ATOM | 950 | ND1 | HIE | A | 1035 | 1.578 | −7.286 | 14.207 | 1.00 | 1.00 | N |
| ATOM | 951 | CD2 | HIE | A | 1035 | −0.421 | −7.629 | 14.836 | 1.00 | 1.00 | C |
| ATOM | 952 | HA | HIE | A | 1035 | −2.089 | −4.989 | 14.115 | 1.00 | 1.00 | H |
| ATOM | 953 | CE1 | HIE | A | 1035 | 1.478 | −8.515 | 14.463 | 1.00 | 1.00 | C |
| ATOM | 954 | NE2 | HIE | A | 1035 | 0.253 | −8.771 | 14.850 | 1.00 | 1.00 | N |
| ATOM | 955 | HB2 | HIE | A | 1035 | 0.855 | −4.624 | 14.759 | 1.00 | 1.00 | H |
| ATOM | 956 | HB1 | HIE | A | 1035 | 0.171 | −4.956 | 13.222 | 1.00 | 1.00 | H |
| ATOM | 957 | HD2 | HIE | A | 1035 | −1.480 | −7.468 | 15.037 | 1.00 | 1.00 | H |
| ATOM | 958 | HE1 | HIE | A | 1035 | 2.355 | −9.189 | 14.363 | 1.00 | 1.00 | H |
| ATOM | 959 | HE2 | HIE | A | 1035 | −0.085 | −9.690 | 15.150 | 1.00 | 1.00 | H |
| ATOM | 960 | N | ASN | A | 1036 | −2.910 | −5.164 | 16.691 | 1.00 | 1.00 | N |
| ATOM | 961 | CA | ASN | A | 1036 | −4.136 | −4.875 | 15.844 | 1.00 | 1.00 | C |
| ATOM | 962 | C | ASN | A | 1036 | −5.263 | −4.472 | 16.807 | 1.00 | 1.00 | C |
| ATOM | 963 | O | ASN | A | 1036 | −4.970 | −4.084 | 17.923 | 1.00 | 1.00 | O |
| ATOM | 964 | CB | ASN | A | 1036 | −4.482 | −6.073 | 14.903 | 1.00 | 1.00 | C |
| ATOM | 965 | CG | ASN | A | 1036 | −5.157 | −7.102 | 15.763 | 1.00 | 1.00 | C |
| ATOM | 966 | OD1 | ASN | A | 1036 | −6.376 | −7.257 | 15.743 | 1.00 | 1.00 | O |
| ATOM | 967 | ND2 | ASN | A | 1036 | −4.383 | −7.913 | 16.523 | 1.00 | 1.00 | N |
| ATOM | 968 | HA | ASN | A | 1036 | −3.959 | −3.937 | 15.251 | 1.00 | 1.00 | H |
| ATOM | 969 | HB1 | ASN | A | 1036 | −5.130 | −5.788 | 14.061 | 1.00 | 1.00 | H |
| ATOM | 970 | HB2 | ASN | A | 1036 | −3.638 | −6.561 | 14.445 | 1.00 | 1.00 | H |
| ATOM | 971 | HD22 | ASN | A | 1036 | −4.686 | −8.580 | 17.131 | 1.00 | 1.00 | H |
| ATOM | 972 | HD21 | ASN | A | 1036 | −3.359 | −7.811 | 16.535 | 1.00 | 1.00 | H |
| ATOM | 973 | HN | ASN | A | 1036 | −3.071 | −5.409 | 17.685 | 1.00 | 1.00 | H |
| ATOM | 974 | N | THR | A | 1037 | −6.594 | −4.481 | 16.470 | 1.00 | 1.00 | N |
| ATOM | 975 | CA | THR | A | 1037 | −7.700 | −4.097 | 17.389 | 1.00 | 1.00 | C |
| ATOM | 976 | C | THR | A | 1037 | −8.906 | −3.861 | 16.522 | 1.00 | 1.00 | C |
| ATOM | 977 | O | THR | A | 1037 | −8.830 | −4.381 | 15.418 | 1.00 | 1.00 | O |
| ATOM | 978 | CB | THR | A | 1037 | −8.207 | −5.234 | 18.307 | 1.00 | 1.00 | C |
| ATOM | 979 | OG1 | THR | A | 1037 | −9.321 | −4.854 | 19.141 | 1.00 | 1.00 | O |
| ATOM | 980 | CG2 | THR | A | 1037 | −7.094 | −6.008 | 19.023 | 1.00 | 1.00 | C |
| ATOM | 981 | HA | THR | A | 1037 | −7.503 | −3.154 | 17.938 | 1.00 | 1.00 | H |
| ATOM | 982 | HB | THR | A | 1037 | −8.637 | −5.986 | 17.627 | 1.00 | 1.00 | H |
| ATOM | 983 | HG1 | THR | A | 1037 | −9.069 | −4.190 | 19.780 | 1.00 | 1.00 | H |
| ATOM | 984 | HG23 | THR | A | 1037 | −6.300 | −6.368 | 18.382 | 1.00 | 1.00 | H |
| ATOM | 985 | HG21 | THR | A | 1037 | −6.691 | −5.266 | 19.751 | 1.00 | 1.00 | H |
| ATOM | 986 | HG22 | THR | A | 1037 | −7.509 | −6.875 | 19.581 | 1.00 | 1.00 | H |
| ATOM | 987 | HN | THR | A | 1037 | −6.787 | −4.808 | 15.557 | 1.00 | 1.00 | H |
| ATOM | 988 | N | ALA | A | 1038 | −10.036 | −3.185 | 16.947 | 1.00 | 1.00 | N |
| ATOM | 989 | CA | ALA | A | 1038 | −11.086 | −2.839 | 15.998 | 1.00 | 1.00 | C |
| ATOM | 990 | C | ALA | A | 1038 | −10.459 | −2.406 | 14.685 | 1.00 | 1.00 | C |
| ATOM | 991 | O | ALA | A | 1038 | −9.377 | −1.845 | 14.612 | 1.00 | 1.00 | O |
| ATOM | 992 | CB | ALA | A | 1038 | −11.861 | −1.612 | 16.556 | 1.00 | 1.00 | C |
| ATOM | 993 | HA | ALA | A | 1038 | −11.736 | −3.734 | 15.885 | 1.00 | 1.00 | H |
| ATOM | 994 | HB1 | ALA | A | 1038 | −12.177 | −1.626 | 17.600 | 1.00 | 1.00 | H |
| ATOM | 995 | HB2 | ALA | A | 1038 | −11.219 | −0.703 | 16.440 | 1.00 | 1.00 | H |
| ATOM | 996 | HB3 | ALA | A | 1038 | −12.749 | −1.455 | 15.917 | 1.00 | 1.00 | H |
| ATOM | 997 | HN | ALA | A | 1038 | −10.095 | −2.929 | 17.911 | 1.00 | 1.00 | H |
| ATOM | 998 | N | GLU | A | 1039 | −11.224 | −2.588 | 13.565 | 1.00 | 1.00 | N |
| ATOM | 999 | CA | GLU | A | 1039 | −10.831 | −2.038 | 12.277 | 1.00 | 1.00 | C |
| ATOM | 1000 | C | GLU | A | 1039 | −9.411 | −2.435 | 11.839 | 1.00 | 1.00 | C |
| ATOM | 1001 | O | GLU | A | 1039 | −9.227 | −3.381 | 11.052 | 1.00 | 1.00 | O |
| ATOM | 1002 | CB | GLU | A | 1039 | −11.140 | −0.513 | 12.279 | 1.00 | 1.00 | C |
| ATOM | 1003 | CG | GLU | A | 1039 | −12.659 | −0.175 | 12.381 | 1.00 | 1.00 | C |
| ATOM | 1004 | CD | GLU | A | 1039 | −12.885 | 1.303 | 12.189 | 1.00 | 1.00 | C |
| ATOM | 1005 | OE1 | GLU | A | 1039 | −13.310 | 1.823 | 11.153 | 1.00 | 1.00 | O |
| ATOM | 1006 | OE2 | GLU | A | 1039 | −12.543 | 2.080 | 13.130 | 1.00 | 1.00 | O |
| ATOM | 1007 | HA | GLU | A | 1039 | −11.423 | −2.499 | 11.439 | 1.00 | 1.00 | H |
| ATOM | 1008 | HB1 | GLU | A | 1039 | −10.629 | −0.012 | 13.114 | 1.00 | 1.00 | H |
| ATOM | 1009 | HB2 | GLU | A | 1039 | −10.771 | −0.052 | 11.363 | 1.00 | 1.00 | H |
| ATOM | 1010 | HG1 | GLU | A | 1039 | −13.223 | −0.735 | 11.639 | 1.00 | 1.00 | H |
| ATOM | 1011 | HG2 | GLU | A | 1039 | −13.019 | −0.610 | 13.320 | 1.00 | 1.00 | H |
| ATOM | 1012 | HN | GLU | A | 1039 | −12.061 | −3.035 | 13.569 | 1.00 | 1.00 | H |
| ATOM | 1013 | N | SER | A | 1040 | −8.357 | −1.708 | 12.312 | 1.00 | 1.00 | N |
| ATOM | 1014 | CA | SER | A | 1040 | −6.977 | −1.982 | 11.941 | 1.00 | 1.00 | C |
| ATOM | 1015 | C | SER | A | 1040 | −6.681 | −2.124 | 10.466 | 1.00 | 1.00 | C |
| ATOM | 1016 | O | SER | A | 1040 | −5.829 | −2.905 | 10.090 | 1.00 | 1.00 | O |
| ATOM | 1017 | CB | SER | A | 1040 | −6.419 | −3.111 | 12.810 | 1.00 | 1.00 | C |
| ATOM | 1018 | OG | SER | A | 1040 | −5.037 | −3.364 | 12.715 | 1.00 | 1.00 | O |
| ATOM | 1019 | HA | SER | A | 1040 | −6.446 | −1.084 | 12.216 | 1.00 | 1.00 | H |
| ATOM | 1020 | HB1 | SER | A | 1040 | −6.614 | −2.873 | 13.943 | 1.00 | 1.00 | H |
| ATOM | 1021 | HB2 | SER | A | 1040 | −6.964 | −4.023 | 12.499 | 1.00 | 1.00 | H |
| ATOM | 1022 | HG | SER | A | 1040 | −4.445 | −2.709 | 13.147 | 1.00 | 1.00 | H |
| ATOM | 1023 | HN | SER | A | 1040 | −8.537 | −1.063 | 13.105 | 1.00 | 1.00 | H |
| ATOM | 1024 | N | ARG | A | 1041 | −7.449 | −1.317 | 9.683 | 1.00 | 1.00 | N |
| ATOM | 1025 | CA | ARG | A | 1041 | −7.344 | −1.379 | 8.197 | 1.00 | 1.00 | C |
| ATOM | 1026 | C | ARG | A | 1041 | −6.081 | −0.713 | 7.740 | 1.00 | 1.00 | C |
| ATOM | 1027 | O | ARG | A | 1041 | −5.471 | 0.037 | 8.471 | 1.00 | 1.00 | O |
| ATOM | 1028 | CB | ARG | A | 1041 | −8.527 | −0.722 | 7.490 | 1.00 | 1.00 | C |
| ATOM | 1029 | CG | ARG | A | 1041 | −9.942 | −1.108 | 8.029 | 1.00 | 1.00 | C |
| ATOM | 1030 | CD | ARG | A | 1041 | −11.066 | −0.380 | 7.217 | 1.00 | 1.00 | C |
| ATOM | 1031 | NE | ARG | A | 1041 | −12.403 | −0.426 | 7.806 | 1.00 | 1.00 | N |
| ATOM | 1032 | CZ | ARG | A | 1041 | −12.755 | 0.418 | 8.744 | 1.00 | 1.00 | C |
| ATOM | 1033 | NH1 | ARG | A | 1041 | −11.904 | 1.343 | 9.199 | 1.00 | 1.00 | N |
| ATOM | 1034 | NH2 | ARG | A | 1041 | −13.937 | 0.325 | 9.230 | 1.00 | 1.00 | N |
| ATOM | 1035 | HA | ARG | A | 1041 | −7.315 | −2.450 | 7.932 | 1.00 | 1.00 | H |
| ATOM | 1036 | HB1 | ARG | A | 1041 | −8.509 | −0.934 | 6.402 | 1.00 | 1.00 | H |
| ATOM | 1037 | HB2 | ARG | A | 1041 | −8.408 | 0.409 | 7.586 | 1.00 | 1.00 | H |
| ATOM | 1038 | HG1 | ARG | A | 1041 | −10.051 | −2.205 | 7.988 | 1.00 | 1.00 | H |
| ATOM | 1039 | HG2 | ARG | A | 1041 | −10.154 | −0.862 | 9.062 | 1.00 | 1.00 | H |
| ATOM | 1040 | HD1 | ARG | A | 1041 | −10.773 | 0.615 | 6.893 | 1.00 | 1.00 | H |
| ATOM | 1041 | HD2 | ARG | A | 1041 | −11.056 | −0.916 | 6.279 | 1.00 | 1.00 | H |
| ATOM | 1042 | HE | ARG | A | 1041 | −13.080 | −1.113 | 7.407 | 1.00 | 1.00 | H |
| ATOM | 1043 | HH12 | ARG | A | 1041 | −12.254 | 2.068 | 9.852 | 1.00 | 1.00 | H |
| ATOM | 1044 | HH11 | ARG | A | 1041 | −10.914 | 1.440 | 8.906 | 1.00 | 1.00 | H |
| ATOM | 1045 | HH22 | ARG | A | 1041 | −14.263 | 0.873 | 10.029 | 1.00 | 1.00 | H |
| ATOM | 1046 | HH21 | ARG | A | 1041 | −14.566 | −0.421 | 8.938 | 1.00 | 1.00 | H |
| ATOM | 1047 | HN | ARG | A | 1041 | −8.034 | −0.634 | 10.099 | 1.00 | 1.00 | H |
| ATOM | 1048 | N | LEU | A | 1042 | −5.644 | −0.940 | 6.496 | 1.00 | 1.00 | N |
| ATOM | 1049 | CA | LEU | A | 1042 | −4.437 | −0.250 | 6.004 | 1.00 | 1.00 | C |
| ATOM | 1050 | C | LEU | A | 1042 | −4.772 | 0.948 | 5.114 | 1.00 | 1.00 | C |
| ATOM | 1051 | O | LEU | A | 1042 | −4.245 | 1.048 | 4.016 | 1.00 | 1.00 | O |
| ATOM | 1052 | CB | LEU | A | 1042 | −3.450 | −1.244 | 5.274 | 1.00 | 1.00 | C |
| ATOM | 1053 | CG | LEU | A | 1042 | −2.920 | −2.438 | 6.131 | 1.00 | 1.00 | C |
| ATOM | 1054 | CD1 | LEU | A | 1042 | −2.109 | −3.503 | 5.362 | 1.00 | 1.00 | C |
| ATOM | 1055 | CD2 | LEU | A | 1042 | −2.109 | −1.928 | 7.332 | 1.00 | 1.00 | C |
| ATOM | 1056 | HA | LEU | A | 1042 | −3.841 | 0.258 | 6.808 | 1.00 | 1.00 | H |
| ATOM | 1057 | HB1 | LEU | A | 1042 | −2.642 | −0.709 | 4.798 | 1.00 | 1.00 | H |
| ATOM | 1058 | HB2 | LEU | A | 1042 | −3.974 | −1.734 | 4.410 | 1.00 | 1.00 | H |
| ATOM | 1059 | HG | LEU | A | 1042 | −3.819 | −2.970 | 6.512 | 1.00 | 1.00 | H |
| ATOM | 1060 | HD21 | LEU | A | 1042 | −1.264 | −1.324 | 6.978 | 1.00 | 1.00 | H |
| ATOM | 1061 | HD22 | LEU | A | 1042 | −2.778 | −1.402 | 8.005 | 1.00 | 1.00 | H |
| ATOM | 1062 | HD23 | LEU | A | 1042 | −1.653 | −2.747 | 7.930 | 1.00 | 1.00 | H |
| ATOM | 1063 | HD11 | LEU | A | 1042 | −1.124 | −3.131 | 5.000 | 1.00 | 1.00 | H |
| ATOM | 1064 | HD12 | LEU | A | 1042 | −1.984 | −4.386 | 5.976 | 1.00 | 1.00 | H |
| ATOM | 1065 | HD13 | LEU | A | 1042 | −2.701 | −3.803 | 4.456 | 1.00 | 1.00 | H |
| ATOM | 1066 | HN | LEU | A | 1042 | −6.182 | −1.548 | 5.926 | 1.00 | 1.00 | H |
| ATOM | 1067 | N | VAL | A | 1043 | −5.622 | 1.878 | 5.608 | 1.00 | 1.00 | N |
| ATOM | 1068 | CA | VAL | A | 1043 | −5.925 | 3.100 | 4.855 | 1.00 | 1.00 | C |
| ATOM | 1069 | C | VAL | A | 1043 | −4.654 | 3.832 | 4.401 | 1.00 | 1.00 | C |
| ATOM | 1070 | O | VAL | A | 1043 | −3.668 | 3.689 | 5.109 | 1.00 | 1.00 | O |
| ATOM | 1071 | CB | VAL | A | 1043 | −6.798 | 4.024 | 5.754 | 1.00 | 1.00 | C |
| ATOM | 1072 | CG1 | VAL | A | 1043 | −6.899 | 5.517 | 5.284 | 1.00 | 1.00 | C |
| ATOM | 1073 | CG2 | VAL | A | 1043 | −8.248 | 3.510 | 5.912 | 1.00 | 1.00 | C |
| ATOM | 1074 | HA | VAL | A | 1043 | −6.428 | 2.818 | 3.926 | 1.00 | 1.00 | H |
| ATOM | 1075 | HB | VAL | A | 1043 | −6.293 | 4.023 | 6.722 | 1.00 | 1.00 | H |
| ATOM | 1076 | HG11 | VAL | A | 1043 | −7.585 | 6.222 | 5.814 | 1.00 | 1.00 | H |
| ATOM | 1077 | HG12 | VAL | A | 1043 | −5.907 | 6.013 | 5.180 | 1.00 | 1.00 | H |
| ATOM | 1078 | HG13 | VAL | A | 1043 | −7.330 | 5.470 | 4.276 | 1.00 | 1.00 | H |
| ATOM | 1079 | HG21 | VAL | A | 1043 | −8.198 | 2.473 | 6.227 | 1.00 | 1.00 | H |
| ATOM | 1080 | HG22 | VAL | A | 1043 | −8.908 | 4.087 | 6.550 | 1.00 | 1.00 | H |
| ATOM | 1081 | HG23 | VAL | A | 1043 | −8.753 | 3.528 | 4.917 | 1.00 | 1.00 | H |
| ATOM | 1082 | HN | VAL | A | 1043 | −5.960 | 1.714 | 6.581 | 1.00 | 1.00 | H |
| ATOM | 1083 | N | VAL | A | 1044 | −4.728 | 4.588 | 3.267 | 1.00 | 1.00 | N |
| ATOM | 1084 | CA | VAL | A | 1044 | −3.533 | 5.277 | 2.772 | 1.00 | 1.00 | C |
| ATOM | 1085 | C | VAL | A | 1044 | −3.361 | 6.662 | 3.317 | 1.00 | 1.00 | C |
| ATOM | 1086 | O | VAL | A | 1044 | −4.313 | 7.272 | 3.794 | 1.00 | 1.00 | O |
| ATOM | 1087 | CB | VAL | A | 1044 | −3.459 | 5.217 | 1.194 | 1.00 | 1.00 | C |
| ATOM | 1088 | CG1 | VAL | A | 1044 | −3.450 | 3.743 | 0.684 | 1.00 | 1.00 | C |
| ATOM | 1089 | CG2 | VAL | A | 1044 | −4.599 | 5.943 | 0.449 | 1.00 | 1.00 | C |
| ATOM | 1090 | HA | VAL | A | 1044 | −2.667 | 4.756 | 3.209 | 1.00 | 1.00 | H |
| ATOM | 1091 | HB | VAL | A | 1044 | −2.441 | 5.641 | 0.958 | 1.00 | 1.00 | H |
| ATOM | 1092 | HG11 | VAL | A | 1044 | −2.639 | 3.243 | 1.145 | 1.00 | 1.00 | H |
| ATOM | 1093 | HG12 | VAL | A | 1044 | −4.341 | 3.202 | 0.917 | 1.00 | 1.00 | H |
| ATOM | 1094 | HG13 | VAL | A | 1044 | −3.321 | 3.707 | −0.385 | 1.00 | 1.00 | H |
| ATOM | 1095 | HG21 | VAL | A | 1044 | −5.592 | 5.595 | 0.774 | 1.00 | 1.00 | H |
| ATOM | 1096 | HG22 | VAL | A | 1044 | −4.560 | 7.010 | 0.734 | 1.00 | 1.00 | H |
| ATOM | 1097 | HG23 | VAL | A | 1044 | −4.492 | 5.940 | −0.650 | 1.00 | 1.00 | H |
| ATOM | 1098 | HN | VAL | A | 1044 | −5.572 | 4.547 | 2.719 | 1.00 | 1.00 | H |
| ATOM | 1099 | N | ASP | A | 1045 | −2.147 | 7.261 | 3.179 | 1.00 | 1.00 | N |
| ATOM | 1100 | CA | ASP | A | 1045 | −1.771 | 8.466 | 3.930 | 1.00 | 1.00 | C |
| ATOM | 1101 | C | ASP | A | 1045 | −0.577 | 9.153 | 3.248 | 1.00 | 1.00 | C |
| ATOM | 1102 | O | ASP | A | 1045 | 0.118 | 8.532 | 2.457 | 1.00 | 1.00 | O |
| ATOM | 1103 | CB | ASP | A | 1045 | −1.359 | 8.087 | 5.397 | 1.00 | 1.00 | C |
| ATOM | 1104 | CG | ASP | A | 1045 | −0.359 | 9.011 | 6.002 | 1.00 | 1.00 | C |
| ATOM | 1105 | OD1 | ASP | A | 1045 | −0.791 | 10.160 | 6.177 | 1.00 | 1.00 | O |
| ATOM | 1106 | OD2 | ASP | A | 1045 | 0.833 | 8.664 | 6.245 | 1.00 | 1.00 | O |
| ATOM | 1107 | HA | ASP | A | 1045 | −2.611 | 9.127 | 3.881 | 1.00 | 1.00 | H |
| ATOM | 1108 | HB1 | ASP | A | 1045 | −1.007 | 7.031 | 5.455 | 1.00 | 1.00 | H |
| ATOM | 1109 | HB2 | ASP | A | 1045 | −2.337 | 8.086 | 5.941 | 1.00 | 1.00 | H |
| ATOM | 1110 | HN | ASP | A | 1045 | −1.392 | 6.783 | 2.693 | 1.00 | 1.00 | H |
| ATOM | 1111 | N | PHE | A | 1046 | −0.285 | 10.477 | 3.475 | 1.00 | 1.00 | N |
| ATOM | 1112 | CA | PHE | A | 1046 | 0.702 | 11.240 | 2.701 | 1.00 | 1.00 | C |
| ATOM | 1113 | C | PHE | A | 1046 | 1.779 | 11.679 | 3.708 | 1.00 | 1.00 | C |
| ATOM | 1114 | O | PHE | A | 1046 | 2.402 | 12.695 | 3.395 | 1.00 | 1.00 | O |
| ATOM | 1115 | CB | PHE | A | 1046 | 0.015 | 12.428 | 1.940 | 1.00 | 1.00 | C |
| ATOM | 1116 | CG | PHE | A | 1046 | −0.522 | 13.524 | 2.908 | 1.00 | 1.00 | C |
| ATOM | 1117 | CD1 | PHE | A | 1046 | 0.278 | 14.639 | 3.196 | 1.00 | 1.00 | C |
| ATOM | 1118 | CD2 | PHE | A | 1046 | −1.858 | 13.517 | 3.415 | 1.00 | 1.00 | C |
| ATOM | 1119 | CE1 | PHE | A | 1046 | −0.266 | 15.704 | 3.875 | 1.00 | 1.00 | C |
| ATOM | 1120 | CE2 | PHE | A | 1046 | −2.295 | 14.490 | 4.293 | 1.00 | 1.00 | C |
| ATOM | 1121 | CZ | PHE | A | 1046 | −1.488 | 15.585 | 4.510 | 1.00 | 1.00 | C |
| ATOM | 1122 | HA | PHE | A | 1046 | 1.236 | 10.624 | 1.971 | 1.00 | 1.00 | H |
| ATOM | 1123 | HB1 | PHE | A | 1046 | −0.849 | 12.006 | 1.374 | 1.00 | 1.00 | H |
| ATOM | 1124 | HB2 | PHE | A | 1046 | 0.709 | 12.757 | 1.175 | 1.00 | 1.00 | H |
| ATOM | 1125 | HD2 | PHE | A | 1046 | −2.543 | 12.760 | 3.092 | 1.00 | 1.00 | H |
| ATOM | 1126 | HE2 | PHE | A | 1046 | −3.268 | 14.364 | 4.698 | 1.00 | 1.00 | H |
| ATOM | 1127 | HZ | PHE | A | 1046 | −1.752 | 16.372 | 5.182 | 1.00 | 1.00 | H |
| ATOM | 1128 | HE1 | PHE | A | 1046 | 0.212 | 16.635 | 3.901 | 1.00 | 1.00 | H |
| ATOM | 1129 | HD1 | PHE | A | 1046 | 1.293 | 14.720 | 2.845 | 1.00 | 1.00 | H |
| ATOM | 1130 | HN | PHE | A | 1046 | −0.722 | 10.950 | 4.239 | 1.00 | 1.00 | H |
| ATOM | 1131 | N | SER | A | 1047 | 2.025 | 10.996 | 4.826 | 1.00 | 1.00 | N |
| ATOM | 1132 | CA | SER | A | 1047 | 3.022 | 11.568 | 5.779 | 1.00 | 1.00 | C |
| ATOM | 1133 | C | SER | A | 1047 | 4.402 | 11.289 | 5.276 | 1.00 | 1.00 | C |
| ATOM | 1134 | O | SER | A | 1047 | 5.112 | 10.463 | 5.855 | 1.00 | 1.00 | O |
| ATOM | 1135 | CB | SER | A | 1047 | 2.825 | 11.065 | 7.224 | 1.00 | 1.00 | C |
| ATOM | 1136 | OG | SER | A | 1047 | 2.994 | 9.639 | 7.422 | 1.00 | 1.00 | O |
| ATOM | 1137 | HA | SER | A | 1047 | 2.972 | 12.680 | 5.777 | 1.00 | 1.00 | H |
| ATOM | 1138 | HB1 | SER | A | 1047 | 1.831 | 11.312 | 7.609 | 1.00 | 1.00 | H |
| ATOM | 1139 | HB2 | SER | A | 1047 | 3.539 | 11.572 | 7.866 | 1.00 | 1.00 | H |
| ATOM | 1140 | HG | SER | A | 1047 | 2.322 | 9.069 | 7.012 | 1.00 | 1.00 | H |
| ATOM | 1141 | HN | SER | A | 1047 | 1.605 | 10.091 | 4.965 | 1.00 | 1.00 | H |
| ATOM | 1142 | N | GLN | A | 1048 | 4.898 | 11.972 | 4.199 | 1.00 | 1.00 | N |
| ATOM | 1143 | CA | GLN | A | 1048 | 6.253 | 11.656 | 3.667 | 1.00 | 1.00 | C |
| ATOM | 1144 | C | GLN | A | 1048 | 7.307 | 12.423 | 4.446 | 1.00 | 1.00 | C |
| ATOM | 1145 | O | GLN | A | 1048 | 8.039 | 13.250 | 3.878 | 1.00 | 1.00 | O |
| ATOM | 1146 | CB | GLN | A | 1048 | 6.391 | 11.985 | 2.163 | 1.00 | 1.00 | C |
| ATOM | 1147 | CG | GLN | A | 1048 | 5.338 | 11.340 | 1.266 | 1.00 | 1.00 | C |
| ATOM | 1148 | CD | GLN | A | 1048 | 5.696 | 11.402 | −0.239 | 1.00 | 1.00 | C |
| ATOM | 1149 | OE1 | GLN | A | 1048 | 6.250 | 10.404 | −0.712 | 1.00 | 1.00 | O |
| ATOM | 1150 | NE2 | GLN | A | 1048 | 5.530 | 12.540 | −0.923 | 1.00 | 1.00 | N |
| ATOM | 1151 | HA | GLN | A | 1048 | 6.455 | 10.566 | 3.762 | 1.00 | 1.00 | H |
| ATOM | 1152 | HB1 | GLN | A | 1048 | 7.427 | 11.638 | 1.936 | 1.00 | 1.00 | H |
| ATOM | 1153 | HB2 | GLN | A | 1048 | 6.356 | 13.056 | 1.891 | 1.00 | 1.00 | H |
| ATOM | 1154 | HG1 | GLN | A | 1048 | 5.139 | 10.288 | 1.534 | 1.00 | 1.00 | H |
| ATOM | 1155 | HG2 | GLN | A | 1048 | 4.373 | 11.860 | 1.444 | 1.00 | 1.00 | H |
| ATOM | 1156 | HE22 | GLN | A | 1048 | 5.754 | 12.520 | −1.892 | 1.00 | 1.00 | H |
| ATOM | 1157 | HE21 | GLN | A | 1048 | 5.062 | 13.299 | −0.492 | 1.00 | 1.00 | H |
| ATOM | 1158 | HN | GLN | A | 1048 | 4.322 | 12.678 | 3.757 | 1.00 | 1.00 | H |
| ATOM | 1159 | N | PHE | A | 1049 | 7.448 | 12.195 | 5.760 | 1.00 | 1.00 | N |
| ATOM | 1160 | CA | PHE | A | 1049 | 8.498 | 12.912 | 6.571 | 1.00 | 1.00 | C |
| ATOM | 1161 | C | PHE | A | 1049 | 8.601 | 14.403 | 6.232 | 1.00 | 1.00 | C |
| ATOM | 1162 | O | PHE | A | 1049 | 7.665 | 15.130 | 6.512 | 1.00 | 1.00 | O |
| ATOM | 1163 | CB | PHE | A | 1049 | 9.801 | 12.078 | 6.511 | 1.00 | 1.00 | C |
| ATOM | 1164 | CG | PHE | A | 1049 | 9.473 | 10.773 | 7.198 | 1.00 | 1.00 | C |
| ATOM | 1165 | CD1 | PHE | A | 1049 | 9.854 | 10.496 | 8.519 | 1.00 | 1.00 | C |
| ATOM | 1166 | CD2 | PHE | A | 1049 | 8.902 | 9.694 | 6.495 | 1.00 | 1.00 | C |
| ATOM | 1167 | CE1 | PHE | A | 1049 | 9.626 | 9.285 | 9.188 | 1.00 | 1.00 | C |
| ATOM | 1168 | CE2 | PHE | A | 1049 | 8.482 | 8.542 | 7.201 | 1.00 | 1.00 | C |
| ATOM | 1169 | CZ | PHE | A | 1049 | 8.811 | 8.358 | 8.545 | 1.00 | 1.00 | C |
| ATOM | 1170 | HA | PHE | A | 1049 | 8.198 | 12.971 | 7.638 | 1.00 | 1.00 | H |
| ATOM | 1171 | HB1 | PHE | A | 1049 | 10.563 | 12.551 | 7.155 | 1.00 | 1.00 | H |
| ATOM | 1172 | HB2 | PHE | A | 1049 | 10.132 | 11.975 | 5.445 | 1.00 | 1.00 | H |
| ATOM | 1173 | HD2 | PHE | A | 1049 | 8.738 | 9.638 | 5.419 | 1.00 | 1.00 | H |
| ATOM | 1174 | HE2 | PHE | A | 1049 | 7.941 | 7.798 | 6.654 | 1.00 | 1.00 | H |
| ATOM | 1175 | HZ | PHE | A | 1049 | 8.432 | 7.522 | 9.132 | 1.00 | 1.00 | H |
| ATOM | 1176 | HE1 | PHE | A | 1049 | 10.105 | 9.034 | 10.133 | 1.00 | 1.00 | H |
| ATOM | 1177 | HD1 | PHE | A | 1049 | 10.439 | 11.238 | 9.063 | 1.00 | 1.00 | H |
| ATOM | 1178 | HN | PHE | A | 1049 | 6.838 | 11.539 | 6.215 | 1.00 | 1.00 | H |
| ATOM | 1179 | N | SER | A | 1050 | 9.677 | 14.898 | 5.553 | 1.00 | 1.00 | N |
| ATOM | 1180 | CA | SER | A | 1050 | 9.657 | 16.301 | 5.183 | 1.00 | 1.00 | C |
| ATOM | 1181 | C | SER | A | 1050 | 8.806 | 16.291 | 3.968 | 1.00 | 1.00 | C |
| ATOM | 1182 | O | SER | A | 1050 | 9.248 | 16.495 | 2.835 | 1.00 | 1.00 | O |
| ATOM | 1183 | CB | SER | A | 1050 | 11.091 | 16.966 | 4.968 | 1.00 | 1.00 | C |
| ATOM | 1184 | OG | SER | A | 1050 | 11.822 | 17.056 | 6.204 | 1.00 | 1.00 | O |
| ATOM | 1185 | HA | SER | A | 1050 | 9.134 | 16.968 | 5.888 | 1.00 | 1.00 | H |
| ATOM | 1186 | HB1 | SER | A | 1050 | 11.585 | 16.339 | 4.248 | 1.00 | 1.00 | H |
| ATOM | 1187 | HB2 | SER | A | 1050 | 11.028 | 18.029 | 4.549 | 1.00 | 1.00 | H |
| ATOM | 1188 | HG | SER | A | 1050 | 11.416 | 17.706 | 6.822 | 1.00 | 1.00 | H |
| ATOM | 1189 | HN | SER | A | 1050 | 10.417 | 14.348 | 5.200 | 1.00 | 1.00 | H |
| ATOM | 1190 | N | ARG | A | 1051 | 7.504 | 16.069 | 4.104 | 1.00 | 1.00 | N |
| ATOM | 1191 | CA | ARG | A | 1051 | 6.512 | 16.140 | 3.037 | 1.00 | 1.00 | C |
| ATOM | 1192 | C | ARG | A | 1051 | 6.472 | 17.509 | 2.374 | 1.00 | 1.00 | C |
| ATOM | 1193 | O | ARG | A | 1051 | 6.785 | 18.476 | 3.011 | 1.00 | 1.00 | O |
| ATOM | 1194 | CB | ARG | A | 1051 | 5.120 | 15.778 | 3.598 | 1.00 | 1.00 | C |
| ATOM | 1195 | CG | ARG | A | 1051 | 4.306 | 16.806 | 4.460 | 1.00 | 1.00 | C |
| ATOM | 1196 | CD | ARG | A | 1051 | 4.940 | 17.278 | 5.811 | 1.00 | 1.00 | C |
| ATOM | 1197 | NE | ARG | A | 1051 | 6.076 | 18.199 | 5.698 | 1.00 | 1.00 | N |
| ATOM | 1198 | CZ | ARG | A | 1051 | 6.823 | 18.520 | 6.683 | 1.00 | 1.00 | C |
| ATOM | 1199 | NH1 | ARG | A | 1051 | 6.585 | 18.076 | 7.890 | 1.00 | 1.00 | N |
| ATOM | 1200 | NH2 | ARG | A | 1051 | 7.854 | 19.308 | 6.424 | 1.00 | 1.00 | N |
| ATOM | 1201 | HA | ARG | A | 1051 | 6.832 | 15.389 | 2.281 | 1.00 | 1.00 | H |
| ATOM | 1202 | HB1 | ARG | A | 1051 | 4.471 | 15.533 | 2.718 | 1.00 | 1.00 | H |
| ATOM | 1203 | HB2 | ARG | A | 1051 | 5.249 | 14.823 | 4.155 | 1.00 | 1.00 | H |
| ATOM | 1204 | HG1 | ARG | A | 1051 | 4.005 | 17.775 | 3.978 | 1.00 | 1.00 | H |
| ATOM | 1205 | HG2 | ARG | A | 1051 | 3.346 | 16.301 | 4.662 | 1.00 | 1.00 | H |
| ATOM | 1206 | HD1 | ARG | A | 1051 | 4.146 | 17.821 | 6.416 | 1.00 | 1.00 | H |
| ATOM | 1207 | HD2 | ARG | A | 1051 | 5.223 | 16.302 | 6.247 | 1.00 | 1.00 | H |
| ATOM | 1208 | HE | ARG | A | 1051 | 6.253 | 18.609 | 4.683 | 1.00 | 1.00 | H |
| ATOM | 1209 | HH12 | ARG | A | 1051 | 7.259 | 18.162 | 8.677 | 1.00 | 1.00 | H |
| ATOM | 1210 | HH11 | ARG | A | 1051 | 5.682 | 17.702 | 8.148 | 1.00 | 1.00 | H |
| ATOM | 1211 | HH22 | ARG | A | 1051 | 8.490 | 19.556 | 7.201 | 1.00 | 1.00 | H |
| ATOM | 1212 | HH21 | ARG | A | 1051 | 8.113 | 19.593 | 5.446 | 1.00 | 1.00 | H |
| ATOM | 1213 | HN | ARG | A | 1051 | 7.091 | 15.980 | 5.023 | 1.00 | 1.00 | H |
| ATOM | 1214 | N | GLY | A | 1052 | 6.144 | 17.610 | 1.076 | 1.00 | 1.00 | N |
| ATOM | 1215 | CA | GLY | A | 1052 | 6.082 | 18.919 | 0.416 | 1.00 | 1.00 | C |
| ATOM | 1216 | C | GLY | A | 1052 | 6.344 | 18.699 | −1.076 | 1.00 | 1.00 | C |
| ATOM | 1217 | O | GLY | A | 1052 | 7.496 | 18.626 | −1.468 | 1.00 | 1.00 | O |
| ATOM | 1218 | HA2 | GLY | A | 1052 | 6.806 | 19.612 | 0.837 | 1.00 | 1.00 | H |
| ATOM | 1219 | HA1 | GLY | A | 1052 | 5.124 | 19.350 | 0.569 | 1.00 | 1.00 | H |
| ATOM | 1220 | HN | GLY | A | 1052 | 5.846 | 16.823 | 0.506 | 1.00 | 1.00 | H |
| ATOM | 1221 | N | ASN | A | 1053 | 5.319 | 18.634 | −1.957 | 1.00 | 1.00 | N |
| ATOM | 1222 | CA | ASN | A | 1053 | 5.571 | 18.512 | −3.401 | 1.00 | 1.00 | C |
| ATOM | 1223 | C | ASN | A | 1053 | 5.958 | 17.059 | −3.749 | 1.00 | 1.00 | C |
| ATOM | 1224 | O | ASN | A | 1053 | 5.080 | 16.261 | −3.510 | 1.00 | 1.00 | O |
| ATOM | 1225 | CB | ASN | A | 1053 | 6.435 | 19.666 | −3.989 | 1.00 | 1.00 | C |
| ATOM | 1226 | CG | ASN | A | 1053 | 6.220 | 19.804 | −5.457 | 1.00 | 1.00 | C |
| ATOM | 1227 | OD1 | ASN | A | 1053 | 7.032 | 19.326 | −6.235 | 1.00 | 1.00 | O |
| ATOM | 1228 | ND2 | ASN | A | 1053 | 5.086 | 20.449 | −5.832 | 1.00 | 1.00 | N |
| ATOM | 1229 | HA | ASN | A | 1053 | 4.610 | 18.552 | −3.953 | 1.00 | 1.00 | H |
| ATOM | 1230 | HB1 | ASN | A | 1053 | 6.204 | 20.551 | −3.410 | 1.00 | 1.00 | H |
| ATOM | 1231 | HB2 | ASN | A | 1053 | 7.529 | 19.499 | −3.827 | 1.00 | 1.00 | H |
| ATOM | 1232 | HD22 | ASN | A | 1053 | 4.824 | 20.564 | −6.801 | 1.00 | 1.00 | H |
| ATOM | 1233 | HD21 | ASN | A | 1053 | 4.556 | 20.789 | −5.135 | 1.00 | 1.00 | H |
| ATOM | 1234 | HN | ASN | A | 1053 | 4.314 | 18.623 | −1.676 | 1.00 | 1.00 | H |
| ATOM | 1235 | N | TYR | A | 1054 | 7.115 | 16.707 | −4.319 | 1.00 | 1.00 | N |
| ATOM | 1236 | CA | TYR | A | 1054 | 7.490 | 15.320 | −4.492 | 1.00 | 1.00 | C |
| ATOM | 1237 | C | TYR | A | 1054 | 8.413 | 14.937 | −5.648 | 1.00 | 1.00 | C |
| ATOM | 1238 | O | TYR | A | 1054 | 8.056 | 14.155 | −6.504 | 1.00 | 1.00 | O |
| ATOM | 1239 | CB | TYR | A | 1054 | 7.946 | 14.703 | −3.110 | 1.00 | 1.00 | C |
| ATOM | 1240 | CG | TYR | A | 1054 | 8.415 | 13.228 | −3.148 | 1.00 | 1.00 | C |
| ATOM | 1241 | CD1 | TYR | A | 1054 | 7.971 | 12.304 | −4.079 | 1.00 | 1.00 | C |
| ATOM | 1242 | CD2 | TYR | A | 1054 | 9.339 | 12.840 | −2.178 | 1.00 | 1.00 | C |
| ATOM | 1243 | CE1 | TYR | A | 1054 | 8.430 | 11.001 | −4.054 | 1.00 | 1.00 | C |
| ATOM | 1244 | CE2 | TYR | A | 1054 | 9.883 | 11.563 | −2.224 | 1.00 | 1.00 | C |
| ATOM | 1245 | CZ | TYR | A | 1054 | 9.480 | 10.613 | −3.186 | 1.00 | 1.00 | C |
| ATOM | 1246 | OH | TYR | A | 1054 | 10.162 | 9.431 | −3.347 | 1.00 | 1.00 | O |
| ATOM | 1247 | HA | TYR | A | 1054 | 6.591 | 14.758 | −4.725 | 1.00 | 1.00 | H |
| ATOM | 1248 | HB2 | TYR | A | 1054 | 8.807 | 15.291 | −2.736 | 1.00 | 1.00 | H |
| ATOM | 1249 | HB1 | TYR | A | 1054 | 7.162 | 14.845 | −2.378 | 1.00 | 1.00 | H |
| ATOM | 1250 | HD2 | TYR | A | 1054 | 9.517 | 13.532 | −1.381 | 1.00 | 1.00 | H |
| ATOM | 1251 | HE2 | TYR | A | 1054 | 10.632 | 11.272 | −1.505 | 1.00 | 1.00 | H |
| ATOM | 1252 | HE1 | TYR | A | 1054 | 8.050 | 10.266 | −4.751 | 1.00 | 1.00 | H |
| ATOM | 1253 | HD1 | TYR | A | 1054 | 7.259 | 12.641 | −4.834 | 1.00 | 1.00 | H |
| ATOM | 1254 | HH | TYR | A | 1054 | 10.018 | 8.870 | −2.588 | 1.00 | 1.00 | H |
| ATOM | 1255 | HN | TYR | A | 1054 | 7.851 | 17.300 | −4.544 | 1.00 | 1.00 | H |
| ATOM | 1256 | N | ARG | A | 1055 | 9.656 | 15.467 | −5.703 | 1.00 | 1.00 | N |
| ATOM | 1257 | CA | ARG | A | 1055 | 10.519 | 15.062 | −6.778 | 1.00 | 1.00 | C |
| ATOM | 1258 | C | ARG | A | 1055 | 9.965 | 15.381 | −8.133 | 1.00 | 1.00 | C |
| ATOM | 1259 | O | ARG | A | 1055 | 10.227 | 14.601 | −9.036 | 1.00 | 1.00 | O |
| ATOM | 1260 | CB | ARG | A | 1055 | 10.921 | 13.576 | −6.733 | 1.00 | 1.00 | C |
| ATOM | 1261 | CG | ARG | A | 1055 | 11.537 | 13.150 | −5.337 | 1.00 | 1.00 | C |
| ATOM | 1262 | CD | ARG | A | 1055 | 11.715 | 11.599 | −5.245 | 1.00 | 1.00 | C |
| ATOM | 1263 | NE | ARG | A | 1055 | 12.681 | 10.992 | −6.145 | 1.00 | 1.00 | N |
| ATOM | 1264 | CZ | ARG | A | 1055 | 12.890 | 9.687 | −6.214 | 1.00 | 1.00 | C |
| ATOM | 1265 | NH1 | ARG | A | 1055 | 12.252 | 8.780 | −5.489 | 1.00 | 1.00 | N |
| ATOM | 1266 | NH2 | ARG | A | 1055 | 13.798 | 9.351 | −7.104 | 1.00 | 1.00 | N |
| ATOM | 1267 | HA | ARG | A | 1055 | 11.388 | 15.676 | −6.840 | 1.00 | 1.00 | H |
| ATOM | 1268 | HB1 | ARG | A | 1055 | 10.057 | 12.926 | −6.897 | 1.00 | 1.00 | H |
| ATOM | 1269 | HB2 | ARG | A | 1055 | 11.634 | 13.380 | −7.558 | 1.00 | 1.00 | H |
| ATOM | 1270 | HG1 | ARG | A | 1055 | 12.508 | 13.712 | −5.108 | 1.00 | 1.00 | H |
| ATOM | 1271 | HG2 | ARG | A | 1055 | 10.849 | 13.428 | −4.516 | 1.00 | 1.00 | H |
| ATOM | 1272 | HD1 | ARG | A | 1055 | 12.053 | 11.359 | −4.190 | 1.00 | 1.00 | H |
| ATOM | 1273 | HD2 | ARG | A | 1055 | 10.754 | 11.135 | −5.390 | 1.00 | 1.00 | H |
| ATOM | 1274 | HE | ARG | A | 1055 | 13.173 | 11.645 | −6.742 | 1.00 | 1.00 | H |
| ATOM | 1275 | HH12 | ARG | A | 1055 | 12.593 | 7.800 | −5.568 | 1.00 | 1.00 | H |
| ATOM | 1276 | HH11 | ARG | A | 1055 | 11.615 | 9.066 | −4.733 | 1.00 | 1.00 | H |
| ATOM | 1277 | HH22 | ARG | A | 1055 | 14.051 | 8.360 | −7.286 | 1.00 | 1.00 | H |
| ATOM | 1278 | HH21 | ARG | A | 1055 | 14.306 | 10.056 | −7.659 | 1.00 | 1.00 | H |
| ATOM | 1279 | HN | ARG | A | 1055 | 9.988 | 16.103 | −4.991 | 1.00 | 1.00 | H |
| ATOM | 1280 | N | VAL | A | 1056 | 9.202 | 16.473 | −8.359 | 1.00 | 1.00 | N |
| ATOM | 1281 | CA | VAL | A | 1056 | 8.770 | 16.893 | −9.686 | 1.00 | 1.00 | C |
| ATOM | 1282 | C | VAL | A | 1056 | 8.505 | 18.362 | −9.888 | 1.00 | 1.00 | C |
| ATOM | 1283 | O | VAL | A | 1056 | 9.185 | 18.953 | −10.711 | 1.00 | 1.00 | O |
| ATOM | 1284 | CB | VAL | A | 1056 | 7.455 | 16.112 | −10.084 | 1.00 | 1.00 | C |
| ATOM | 1285 | CG1 | VAL | A | 1056 | 7.066 | 16.502 | −11.548 | 1.00 | 1.00 | C |
| ATOM | 1286 | CG2 | VAL | A | 1056 | 7.591 | 14.558 | −10.032 | 1.00 | 1.00 | C |
| ATOM | 1287 | HA | VAL | A | 1056 | 9.540 | 16.579 | −10.373 | 1.00 | 1.00 | H |
| ATOM | 1288 | HB | VAL | A | 1056 | 6.585 | 16.301 | −9.460 | 1.00 | 1.00 | H |
| ATOM | 1289 | HG11 | VAL | A | 1056 | 7.876 | 16.385 | −12.281 | 1.00 | 1.00 | H |
| ATOM | 1290 | HG12 | VAL | A | 1056 | 6.742 | 17.534 | −11.588 | 1.00 | 1.00 | H |
| ATOM | 1291 | HG13 | VAL | A | 1056 | 6.203 | 15.836 | −11.843 | 1.00 | 1.00 | H |
| ATOM | 1292 | HG21 | VAL | A | 1056 | 8.332 | 14.223 | −10.798 | 1.00 | 1.00 | H |
| ATOM | 1293 | HG22 | VAL | A | 1056 | 7.835 | 14.250 | −9.060 | 1.00 | 1.00 | H |
| ATOM | 1294 | HG23 | VAL | A | 1056 | 6.625 | 14.067 | −10.181 | 1.00 | 1.00 | H |
| ATOM | 1295 | HN | VAL | A | 1056 | 8.993 | 17.132 | −7.618 | 1.00 | 1.00 | H |
| ATOM | 1296 | N | SER | A | 1057 | 7.509 | 18.936 | −9.155 | 1.00 | 1.00 | N |
| ATOM | 1297 | CA | SER | A | 1057 | 6.985 | 20.332 | −9.409 | 1.00 | 1.00 | C |
| ATOM | 1298 | C | SER | A | 1057 | 5.496 | 20.339 | −9.523 | 1.00 | 1.00 | C |
| ATOM | 1299 | O | SER | A | 1057 | 4.763 | 20.349 | −8.522 | 1.00 | 1.00 | O |
| ATOM | 1300 | CB | SER | A | 1057 | 7.699 | 21.255 | −10.463 | 1.00 | 1.00 | C |
| ATOM | 1301 | OG | SER | A | 1057 | 7.564 | 20.901 | −11.794 | 1.00 | 1.00 | O |
| ATOM | 1302 | HA | SER | A | 1057 | 7.208 | 20.805 | −8.416 | 1.00 | 1.00 | H |
| ATOM | 1303 | HB1 | SER | A | 1057 | 7.205 | 22.198 | −10.334 | 1.00 | 1.00 | H |
| ATOM | 1304 | HB2 | SER | A | 1057 | 8.761 | 21.405 | −10.238 | 1.00 | 1.00 | H |
| ATOM | 1305 | HG | SER | A | 1057 | 7.996 | 20.093 | −12.041 | 1.00 | 1.00 | H |
| ATOM | 1306 | HN | SER | A | 1057 | 7.120 | 18.415 | −8.346 | 1.00 | 1.00 | H |
| ATOM | 1307 | N | TRP | A | 1058 | 4.870 | 20.373 | −10.727 | 1.00 | 1.00 | N |
| ATOM | 1308 | CA | TRP | A | 1058 | 3.445 | 20.509 | −10.895 | 1.00 | 1.00 | C |
| ATOM | 1309 | C | TRP | A | 1058 | 3.058 | 19.984 | −12.235 | 1.00 | 1.00 | C |
| ATOM | 1310 | O | TRP | A | 1058 | 2.866 | 20.800 | −13.120 | 1.00 | 1.00 | O |
| ATOM | 1311 | CB | TRP | A | 1058 | 3.179 | 22.028 | −10.784 | 1.00 | 1.00 | C |
| ATOM | 1312 | CG | TRP | A | 1058 | 3.665 | 22.687 | −9.506 | 1.00 | 1.00 | C |
| ATOM | 1313 | CD1 | TRP | A | 1058 | 4.699 | 23.599 | −9.341 | 1.00 | 1.00 | C |
| ATOM | 1314 | CD2 | TRP | A | 1058 | 3.147 | 22.472 | −8.117 | 1.00 | 1.00 | C |
| ATOM | 1315 | NE1 | TRP | A | 1058 | 4.850 | 23.909 | −8.074 | 1.00 | 1.00 | N |
| ATOM | 1316 | CE2 | TRP | A | 1058 | 3.922 | 23.285 | −7.329 | 1.00 | 1.00 | C |
| ATOM | 1317 | CE3 | TRP | A | 1058 | 2.161 | 21.666 | −7.574 | 1.00 | 1.00 | C |
| ATOM | 1318 | CZ2 | TRP | A | 1058 | 3.753 | 23.389 | −5.945 | 1.00 | 1.00 | C |
| ATOM | 1319 | CZ3 | TRP | A | 1058 | 1.987 | 21.671 | −6.191 | 1.00 | 1.00 | C |
| ATOM | 1320 | CH2 | TRP | A | 1058 | 2.718 | 22.613 | −5.396 | 1.00 | 1.00 | C |
| ATOM | 1321 | HA | TRP | A | 1058 | 2.925 | 19.952 | −10.114 | 1.00 | 1.00 | H |
| ATOM | 1322 | HB1 | TRP | A | 1058 | 3.696 | 22.603 | −11.620 | 1.00 | 1.00 | H |
| ATOM | 1323 | HB2 | TRP | A | 1058 | 2.095 | 22.175 | −10.851 | 1.00 | 1.00 | H |
| ATOM | 1324 | HE1 | TRP | A | 1058 | 5.553 | 24.563 | −7.694 | 1.00 | 1.00 | H |
| ATOM | 1325 | HD1 | TRP | A | 1058 | 5.344 | 24.056 | −10.071 | 1.00 | 1.00 | H |
| ATOM | 1326 | HZ2 | TRP | A | 1058 | 4.426 | 24.029 | −5.359 | 1.00 | 1.00 | H |
| ATOM | 1327 | HH2 | TRP | A | 1058 | 2.452 | 22.706 | −4.338 | 1.00 | 1.00 | H |
| ATOM | 1328 | HZ3 | TRP | A | 1058 | 1.313 | 21.006 | −5.640 | 1.00 | 1.00 | H |
| ATOM | 1329 | HE3 | TRP | A | 1058 | 1.544 | 21.113 | −8.208 | 1.00 | 1.00 | H |
| ATOM | 1330 | HN | TRP | A | 1058 | 5.490 | 20.361 | −11.529 | 1.00 | 1.00 | H |
| ATOM | 1331 | N | PRO | A | 1059 | 2.987 | 18.624 | −12.476 | 1.00 | 1.00 | N |
| ATOM | 1332 | CA | PRO | A | 1059 | 2.786 | 18.260 | −13.879 | 1.00 | 1.00 | C |
| ATOM | 1333 | C | PRO | A | 1059 | 1.323 | 18.384 | −14.144 | 1.00 | 1.00 | C |
| ATOM | 1334 | O | PRO | A | 1059 | 0.689 | 17.360 | −13.918 | 1.00 | 1.00 | O |
| ATOM | 1335 | CB | PRO | A | 1059 | 3.350 | 16.847 | −13.882 | 1.00 | 1.00 | C |
| ATOM | 1336 | CG | PRO | A | 1059 | 3.076 | 16.423 | −12.412 | 1.00 | 1.00 | C |
| ATOM | 1337 | CD | PRO | A | 1059 | 3.206 | 17.612 | −11.479 | 1.00 | 1.00 | C |
| ATOM | 1338 | HA | PRO | A | 1059 | 3.333 | 18.922 | −14.560 | 1.00 | 1.00 | H |
| ATOM | 1339 | HD2 | PRO | A | 1059 | 2.414 | 17.616 | −10.700 | 1.00 | 1.00 | H |
| ATOM | 1340 | HD1 | PRO | A | 1059 | 4.194 | 17.753 | −11.053 | 1.00 | 1.00 | H |
| ATOM | 1341 | HG2 | PRO | A | 1059 | 3.788 | 15.709 | −12.129 | 1.00 | 1.00 | H |
| ATOM | 1342 | HG1 | PRO | A | 1059 | 2.074 | 15.963 | −12.318 | 1.00 | 1.00 | H |
| ATOM | 1343 | HB1 | PRO | A | 1059 | 2.920 | 16.164 | −14.655 | 1.00 | 1.00 | H |
| ATOM | 1344 | HB2 | PRO | A | 1059 | 4.451 | 16.917 | −14.010 | 1.00 | 1.00 | H |
| ATOM | 1345 | N | LYS | A | 1060 | 0.768 | 19.588 | −14.556 | 1.00 | 1.00 | N |
| ATOM | 1346 | CA | LYS | A | 1060 | −0.669 | 19.695 | −14.694 | 1.00 | 1.00 | C |
| ATOM | 1347 | C | LYS | A | 1060 | −1.179 | 19.888 | −16.101 | 1.00 | 1.00 | C |
| ATOM | 1348 | O | LYS | A | 1060 | −0.397 | 20.348 | −16.950 | 1.00 | 1.00 | O |
| ATOM | 1349 | CB | LYS | A | 1060 | −1.126 | 20.947 | −13.863 | 1.00 | 1.00 | C |
| ATOM | 1350 | CG | LYS | A | 1060 | −0.898 | 20.840 | −12.321 | 1.00 | 1.00 | C |
| ATOM | 1351 | CD | LYS | A | 1060 | −1.557 | 22.027 | −11.553 | 1.00 | 1.00 | C |
| ATOM | 1352 | CE | LYS | A | 1060 | −1.442 | 21.706 | −10.044 | 1.00 | 1.00 | C |
| ATOM | 1353 | NZ | LYS | A | 1060 | −2.141 | 20.465 | −9.627 | 1.00 | 1.00 | N |
| ATOM | 1354 | HA | LYS | A | 1060 | −1.167 | 18.737 | −14.326 | 1.00 | 1.00 | H |
| ATOM | 1355 | HB1 | LYS | A | 1060 | −0.616 | 21.829 | −14.236 | 1.00 | 1.00 | H |
| ATOM | 1356 | HB2 | LYS | A | 1060 | −2.146 | 20.983 | −14.077 | 1.00 | 1.00 | H |
| ATOM | 1357 | HG1 | LYS | A | 1060 | −1.307 | 19.896 | −12.043 | 1.00 | 1.00 | H |
| ATOM | 1358 | HG2 | LYS | A | 1060 | 0.200 | 20.828 | −12.094 | 1.00 | 1.00 | H |
| ATOM | 1359 | HD1 | LYS | A | 1060 | −1.133 | 22.988 | −11.845 | 1.00 | 1.00 | H |
| ATOM | 1360 | HD2 | LYS | A | 1060 | −2.593 | 22.015 | −11.860 | 1.00 | 1.00 | H |
| ATOM | 1361 | HE1 | LYS | A | 1060 | −1.827 | 22.565 | −9.461 | 1.00 | 1.00 | H |
| ATOM | 1362 | HE2 | LYS | A | 1060 | −0.362 | 21.578 | −9.737 | 1.00 | 1.00 | H |
| ATOM | 1363 | HZ1 | LYS | A | 1060 | −3.201 | 20.439 | −9.913 | 1.00 | 1.00 | H |
| ATOM | 1364 | HZ2 | LYS | A | 1060 | −1.727 | 19.517 | −10.033 | 1.00 | 1.00 | H |
| ATOM | 1365 | HZ3 | LYS | A | 1060 | −2.045 | 20.337 | −8.558 | 1.00 | 1.00 | H |
| ATOM | 1366 | HN | LYS | A | 1060 | 1.338 | 20.411 | −14.681 | 1.00 | 1.00 | H |
| ATOM | 1367 | N | PHE | A | 1061 | −2.443 | 19.579 | −16.367 | 1.00 | 1.00 | N |
| ATOM | 1368 | CA | PHE | A | 1061 | −3.006 | 19.744 | −17.671 | 1.00 | 1.00 | C |
| ATOM | 1369 | C | PHE | A | 1061 | −4.526 | 19.639 | −17.532 | 1.00 | 1.00 | C |
| ATOM | 1370 | O | PHE | A | 1061 | −5.023 | 18.972 | −16.635 | 1.00 | 1.00 | O |
| ATOM | 1371 | CB | PHE | A | 1061 | −2.537 | 18.663 | −18.668 | 1.00 | 1.00 | C |
| ATOM | 1372 | CG | PHE | A | 1061 | −3.201 | 18.897 | −20.024 | 1.00 | 1.00 | C |
| ATOM | 1373 | CD1 | PHE | A | 1061 | −4.235 | 18.094 | −20.548 | 1.00 | 1.00 | C |
| ATOM | 1374 | CD2 | PHE | A | 1061 | −2.699 | 19.923 | −20.879 | 1.00 | 1.00 | C |
| ATOM | 1375 | CE1 | PHE | A | 1061 | −4.803 | 18.328 | −21.816 | 1.00 | 1.00 | C |
| ATOM | 1376 | CE2 | PHE | A | 1061 | −3.329 | 20.172 | −22.124 | 1.00 | 1.00 | C |
| ATOM | 1377 | CZ | PHE | A | 1061 | −4.398 | 19.402 | −22.593 | 1.00 | 1.00 | C |
| ATOM | 1378 | HA | PHE | A | 1061 | −2.705 | 20.716 | −18.149 | 1.00 | 1.00 | H |
| ATOM | 1379 | HB1 | PHE | A | 1061 | −1.450 | 18.746 | −18.725 | 1.00 | 1.00 | H |
| ATOM | 1380 | HB2 | PHE | A | 1061 | −2.862 | 17.631 | −18.258 | 1.00 | 1.00 | H |
| ATOM | 1381 | HD2 | PHE | A | 1061 | −1.871 | 20.513 | −20.596 | 1.00 | 1.00 | H |
| ATOM | 1382 | HE2 | PHE | A | 1061 | −2.987 | 21.030 | −22.782 | 1.00 | 1.00 | H |
| ATOM | 1383 | HZ | PHE | A | 1061 | −4.890 | 19.642 | −23.520 | 1.00 | 1.00 | H |
| ATOM | 1384 | HE1 | PHE | A | 1061 | −5.537 | 17.628 | −22.184 | 1.00 | 1.00 | H |
| ATOM | 1385 | HD1 | PHE | A | 1061 | −4.632 | 17.304 | −19.909 | 1.00 | 1.00 | H |
| ATOM | 1386 | HN | PHE | A | 1061 | −3.049 | 19.272 | −15.627 | 1.00 | 1.00 | H |
| ATOM | 1387 | N | ALA | A | 1062 | −5.376 | 20.284 | −18.349 | 1.00 | 1.00 | N |
| ATOM | 1388 | CA | ALA | A | 1062 | −6.871 | 20.160 | −18.256 | 1.00 | 1.00 | C |
| ATOM | 1389 | C | ALA | A | 1062 | −7.497 | 18.904 | −18.742 | 1.00 | 1.00 | C |
| ATOM | 1390 | O | ALA | A | 1062 | −7.107 | 18.453 | −19.815 | 1.00 | 1.00 | O |
| ATOM | 1391 | CB | ALA | A | 1062 | −7.550 | 21.504 | −18.742 | 1.00 | 1.00 | C |
| ATOM | 1392 | HA | ALA | A | 1062 | −7.044 | 20.137 | −17.179 | 1.00 | 1.00 | H |
| ATOM | 1393 | HB1 | ALA | A | 1062 | −8.643 | 21.417 | −18.713 | 1.00 | 1.00 | H |
| ATOM | 1394 | HB2 | ALA | A | 1062 | −7.194 | 22.384 | −18.132 | 1.00 | 1.00 | H |
| ATOM | 1395 | HB3 | ALA | A | 1062 | −7.335 | 21.666 | −19.792 | 1.00 | 1.00 | H |
| ATOM | 1396 | HN | ALA | A | 1062 | −4.973 | 20.784 | −19.105 | 1.00 | 1.00 | H |
| ATOM | 1397 | N | VAL | A | 1063 | −8.508 | 18.281 | −18.001 | 1.00 | 1.00 | N |
| ATOM | 1398 | CA | VAL | A | 1063 | −9.127 | 16.996 | −18.375 | 1.00 | 1.00 | C |
| ATOM | 1399 | C | VAL | A | 1063 | −10.646 | 17.053 | −18.223 | 1.00 | 1.00 | C |
| ATOM | 1400 | O | VAL | A | 1063 | −11.223 | 16.324 | −17.448 | 1.00 | 1.00 | O |
| ATOM | 1401 | CB | VAL | A | 1063 | −8.458 | 15.798 | −17.605 | 1.00 | 1.00 | C |
| ATOM | 1402 | CG1 | VAL | A | 1063 | −8.673 | 14.424 | −18.315 | 1.00 | 1.00 | C |
| ATOM | 1403 | CG2 | VAL | A | 1063 | −6.924 | 15.981 | −17.482 | 1.00 | 1.00 | C |
| ATOM | 1404 | HA | VAL | A | 1063 | −8.935 | 16.772 | −19.411 | 1.00 | 1.00 | H |
| ATOM | 1405 | HB | VAL | A | 1063 | −8.824 | 15.769 | −16.567 | 1.00 | 1.00 | H |
| ATOM | 1406 | HG11 | VAL | A | 1063 | −8.184 | 14.491 | −19.271 | 1.00 | 1.00 | H |
| ATOM | 1407 | HG12 | VAL | A | 1063 | −8.254 | 13.558 | −17.758 | 1.00 | 1.00 | H |
| ATOM | 1408 | HG13 | VAL | A | 1063 | −9.734 | 14.273 | −18.452 | 1.00 | 1.00 | H |
| ATOM | 1409 | HG21 | VAL | A | 1063 | −6.694 | 16.708 | −16.721 | 1.00 | 1.00 | H |
| ATOM | 1410 | HG22 | VAL | A | 1063 | −6.380 | 15.014 | −17.263 | 1.00 | 1.00 | H |
| ATOM | 1411 | HG23 | VAL | A | 1063 | −6.495 | 16.276 | −18.419 | 1.00 | 1.00 | H |
| ATOM | 1412 | HN | VAL | A | 1063 | −8.862 | 18.752 | −17.242 | 1.00 | 1.00 | H |
| ATOM | 1413 | N | PRO | A | 1064 | −11.422 | 17.810 | −19.050 | 1.00 | 1.00 | N |
| ATOM | 1414 | CA | PRO | A | 1064 | −12.896 | 17.729 | −19.072 | 1.00 | 1.00 | C |
| ATOM | 1415 | C | PRO | A | 1064 | −13.379 | 16.327 | −19.270 | 1.00 | 1.00 | C |
| ATOM | 1416 | O | PRO | A | 1064 | −14.451 | 16.018 | −18.805 | 1.00 | 1.00 | O |
| ATOM | 1417 | CB | PRO | A | 1064 | −13.215 | 18.655 | −20.320 | 1.00 | 1.00 | C |
| ATOM | 1418 | CG | PRO | A | 1064 | −12.035 | 19.651 | −20.380 | 1.00 | 1.00 | C |
| ATOM | 1419 | CD | PRO | A | 1064 | −10.832 | 18.727 | −20.001 | 1.00 | 1.00 | C |
| ATOM | 1420 | HA | PRO | A | 1064 | −13.353 | 18.213 | −18.137 | 1.00 | 1.00 | H |
| ATOM | 1421 | HD2 | PRO | A | 1064 | −10.376 | 18.193 | −20.883 | 1.00 | 1.00 | H |
| ATOM | 1422 | HD1 | PRO | A | 1064 | −10.059 | 19.413 | −19.567 | 1.00 | 1.00 | H |
| ATOM | 1423 | HG2 | PRO | A | 1064 | −11.862 | 20.242 | −21.329 | 1.00 | 1.00 | H |
| ATOM | 1424 | HG1 | PRO | A | 1064 | −12.194 | 20.321 | −19.520 | 1.00 | 1.00 | H |
| ATOM | 1425 | HB1 | PRO | A | 1064 | −13.191 | 18.082 | −21.270 | 1.00 | 1.00 | H |
| ATOM | 1426 | HB2 | PRO | A | 1064 | −14.212 | 19.142 | −20.220 | 1.00 | 1.00 | H |
| ATOM | 1427 | N | ASN | A | 1065 | −12.568 | 15.451 | −19.888 | 1.00 | 1.00 | N |
| ATOM | 1428 | CA | ASN | A | 1065 | −12.982 | 14.084 | −20.047 | 1.00 | 1.00 | C |
| ATOM | 1429 | C | ASN | A | 1065 | −13.510 | 13.475 | −18.724 | 1.00 | 1.00 | C |
| ATOM | 1430 | O | ASN | A | 1065 | −14.505 | 12.758 | −18.779 | 1.00 | 1.00 | O |
| ATOM | 1431 | CB | ASN | A | 1065 | −11.938 | 13.171 | −20.681 | 1.00 | 1.00 | C |
| ATOM | 1432 | CG | ASN | A | 1065 | −12.414 | 11.736 | −20.606 | 1.00 | 1.00 | C |
| ATOM | 1433 | OD1 | ASN | A | 1065 | −13.417 | 11.462 | −21.244 | 1.00 | 1.00 | O |
| ATOM | 1434 | ND2 | ASN | A | 1065 | −11.740 | 10.868 | −19.838 | 1.00 | 1.00 | N |
| ATOM | 1435 | HA | ASN | A | 1065 | −13.846 | 14.065 | −20.750 | 1.00 | 1.00 | H |
| ATOM | 1436 | HB1 | ASN | A | 1065 | −11.873 | 13.466 | −21.790 | 1.00 | 1.00 | H |
| ATOM | 1437 | HB2 | ASN | A | 1065 | −10.984 | 13.289 | −20.213 | 1.00 | 1.00 | H |
| ATOM | 1438 | HD22 | ASN | A | 1065 | −11.938 | 9.867 | −19.863 | 1.00 | 1.00 | H |
| ATOM | 1439 | HD21 | ASN | A | 1065 | −10.931 | 11.116 | −19.276 | 1.00 | 1.00 | H |
| ATOM | 1440 | HN | ASN | A | 1065 | −11.682 | 15.752 | −20.268 | 1.00 | 1.00 | H |
| ATOM | 1441 | N | LEU | A | 1066 | −12.865 | 13.747 | −17.595 | 1.00 | 1.00 | N |
| ATOM | 1442 | CA | LEU | A | 1066 | −13.406 | 13.181 | −16.401 | 1.00 | 1.00 | C |
| ATOM | 1443 | C | LEU | A | 1066 | −14.839 | 13.581 | −16.191 | 1.00 | 1.00 | C |
| ATOM | 1444 | O | LEU | A | 1066 | −15.673 | 12.707 | −16.066 | 1.00 | 1.00 | O |
| ATOM | 1445 | CB | LEU | A | 1066 | −12.637 | 13.545 | −15.112 | 1.00 | 1.00 | C |
| ATOM | 1446 | CG | LEU | A | 1066 | −11.130 | 13.449 | −15.083 | 1.00 | 1.00 | C |
| ATOM | 1447 | CD1 | LEU | A | 1066 | −10.571 | 13.752 | −13.678 | 1.00 | 1.00 | C |
| ATOM | 1448 | CD2 | LEU | A | 1066 | −10.473 | 12.150 | −15.604 | 1.00 | 1.00 | C |
| ATOM | 1449 | HA | LEU | A | 1066 | −13.235 | 12.093 | −16.596 | 1.00 | 1.00 | H |
| ATOM | 1450 | HB1 | LEU | A | 1066 | −12.862 | 14.580 | −14.804 | 1.00 | 1.00 | H |
| ATOM | 1451 | HB2 | LEU | A | 1066 | −13.011 | 12.894 | −14.286 | 1.00 | 1.00 | H |
| ATOM | 1452 | HG | LEU | A | 1066 | −10.739 | 14.317 | −15.655 | 1.00 | 1.00 | H |
| ATOM | 1453 | HD21 | LEU | A | 1066 | −10.727 | 11.316 | −14.940 | 1.00 | 1.00 | H |
| ATOM | 1454 | HD22 | LEU | A | 1066 | −10.799 | 11.894 | −16.596 | 1.00 | 1.00 | H |
| ATOM | 1455 | HD23 | LEU | A | 1066 | −9.364 | 12.291 | −15.642 | 1.00 | 1.00 | H |
| ATOM | 1456 | HD11 | LEU | A | 1066 | −9.526 | 13.536 | −13.570 | 1.00 | 1.00 | H |
| ATOM | 1457 | HD12 | LEU | A | 1066 | −10.796 | 14.780 | −13.332 | 1.00 | 1.00 | H |
| ATOM | 1458 | HD13 | LEU | A | 1066 | −11.014 | 13.114 | −12.952 | 1.00 | 1.00 | H |
| ATOM | 1459 | HN | LEU | A | 1066 | −12.041 | 14.308 | −17.614 | 1.00 | 1.00 | H |
| ATOM | 1460 | N | GLN | A | 1067 | −15.150 | 14.911 | −16.256 | 1.00 | 1.00 | N |
| ATOM | 1461 | CA | GLN | A | 1067 | −16.538 | 15.356 | −16.167 | 1.00 | 1.00 | C |
| ATOM | 1462 | C | GLN | A | 1067 | −17.365 | 14.534 | −17.142 | 1.00 | 1.00 | C |
| ATOM | 1463 | O | GLN | A | 1067 | −18.418 | 14.037 | −16.810 | 1.00 | 1.00 | O |
| ATOM | 1464 | CB | GLN | A | 1067 | −16.703 | 16.830 | −16.495 | 1.00 | 1.00 | C |
| ATOM | 1465 | CG | GLN | A | 1067 | −18.066 | 17.498 | −16.197 | 1.00 | 1.00 | C |
| ATOM | 1466 | CD | GLN | A | 1067 | −18.107 | 18.949 | −16.604 | 1.00 | 1.00 | C |
| ATOM | 1467 | OE1 | GLN | A | 1067 | −18.791 | 19.271 | −17.575 | 1.00 | 1.00 | O |
| ATOM | 1468 | NE2 | GLN | A | 1067 | −17.347 | 19.886 | −16.047 | 1.00 | 1.00 | N |
| ATOM | 1469 | HA | GLN | A | 1067 | −16.907 | 15.133 | −15.198 | 1.00 | 1.00 | H |
| ATOM | 1470 | HB1 | GLN | A | 1067 | −16.002 | 17.396 | −15.924 | 1.00 | 1.00 | H |
| ATOM | 1471 | HB2 | GLN | A | 1067 | −16.447 | 17.028 | −17.540 | 1.00 | 1.00 | H |
| ATOM | 1472 | HG1 | GLN | A | 1067 | −18.915 | 16.973 | −16.654 | 1.00 | 1.00 | H |
| ATOM | 1473 | HG2 | GLN | A | 1067 | −18.202 | 17.434 | −15.107 | 1.00 | 1.00 | H |
| ATOM | 1474 | HE22 | GLN | A | 1067 | −17.377 | 20.838 | −16.366 | 1.00 | 1.00 | H |
| ATOM | 1475 | HE21 | GLN | A | 1067 | −16.813 | 19.704 | −15.203 | 1.00 | 1.00 | H |
| ATOM | 1476 | HN | GLN | A | 1067 | −14.432 | 15.621 | −16.385 | 1.00 | 1.00 | H |
| ATOM | 1477 | N | SER | A | 1068 | −16.889 | 14.337 | −18.407 | 1.00 | 1.00 | N |
| ATOM | 1478 | CA | SER | A | 1068 | −17.773 | 13.622 | −19.384 | 1.00 | 1.00 | C |
| ATOM | 1479 | C | SER | A | 1068 | −18.008 | 12.165 | −19.084 | 1.00 | 1.00 | C |
| ATOM | 1480 | O | SER | A | 1068 | −19.095 | 11.592 | −19.226 | 1.00 | 1.00 | O |
| ATOM | 1481 | CB | SER | A | 1068 | −17.309 | 13.909 | −20.799 | 1.00 | 1.00 | C |
| ATOM | 1482 | OG | SER | A | 1068 | −18.173 | 13.426 | −21.871 | 1.00 | 1.00 | O |
| ATOM | 1483 | HA | SER | A | 1068 | −18.808 | 14.094 | −19.266 | 1.00 | 1.00 | H |
| ATOM | 1484 | HB1 | SER | A | 1068 | −17.311 | 14.988 | −20.829 | 1.00 | 1.00 | H |
| ATOM | 1485 | HB2 | SER | A | 1068 | −16.295 | 13.469 | −20.861 | 1.00 | 1.00 | H |
| ATOM | 1486 | HG | SER | A | 1068 | −19.085 | 13.706 | −21.793 | 1.00 | 1.00 | H |
| ATOM | 1487 | HN | SER | A | 1068 | −15.985 | 14.647 | −18.638 | 1.00 | 1.00 | H |
| ATOM | 1488 | N | LEU | A | 1069 | −16.982 | 11.406 | −18.611 | 1.00 | 1.00 | N |
| ATOM | 1489 | CA | LEU | A | 1069 | −17.213 | 10.002 | −18.299 | 1.00 | 1.00 | C |
| ATOM | 1490 | C | LEU | A | 1069 | −18.036 | 9.969 | −17.037 | 1.00 | 1.00 | C |
| ATOM | 1491 | O | LEU | A | 1069 | −18.896 | 9.116 | −16.855 | 1.00 | 1.00 | O |
| ATOM | 1492 | CB | LEU | A | 1069 | −15.916 | 9.197 | −18.064 | 1.00 | 1.00 | C |
| ATOM | 1493 | CG | LEU | A | 1069 | −14.996 | 8.946 | −19.312 | 1.00 | 1.00 | C |
| ATOM | 1494 | CD1 | LEU | A | 1069 | −13.834 | 8.026 | −18.890 | 1.00 | 1.00 | C |
| ATOM | 1495 | CD2 | LEU | A | 1069 | −15.738 | 8.383 | −20.580 | 1.00 | 1.00 | C |
| ATOM | 1496 | HA | LEU | A | 1069 | −17.773 | 9.460 | −19.077 | 1.00 | 1.00 | H |
| ATOM | 1497 | HB1 | LEU | A | 1069 | −15.378 | 9.642 | −17.234 | 1.00 | 1.00 | H |
| ATOM | 1498 | HB2 | LEU | A | 1069 | −16.288 | 8.271 | −17.596 | 1.00 | 1.00 | H |
| ATOM | 1499 | HG | LEU | A | 1069 | −14.643 | 9.969 | −19.480 | 1.00 | 1.00 | H |
| ATOM | 1500 | HD21 | LEU | A | 1069 | −15.985 | 7.349 | −20.479 | 1.00 | 1.00 | H |
| ATOM | 1501 | HD22 | LEU | A | 1069 | −16.611 | 8.972 | −20.865 | 1.00 | 1.00 | H |
| ATOM | 1502 | HD23 | LEU | A | 1069 | −14.997 | 8.453 | −21.386 | 1.00 | 1.00 | H |
| ATOM | 1503 | HD11 | LEU | A | 1069 | −13.307 | 8.421 | −17.997 | 1.00 | 1.00 | H |
| ATOM | 1504 | HD12 | LEU | A | 1069 | −14.233 | 7.001 | −18.707 | 1.00 | 1.00 | H |
| ATOM | 1505 | HD13 | LEU | A | 1069 | −13.094 | 7.905 | −19.712 | 1.00 | 1.00 | H |
| ATOM | 1506 | HN | LEU | A | 1069 | −16.145 | 11.855 | −18.331 | 1.00 | 1.00 | H |
| ATOM | 1507 | N | THR | A | 1070 | −17.788 | 10.870 | −16.029 | 1.00 | 1.00 | N |
| ATOM | 1508 | CA | THR | A | 1070 | −18.693 | 10.799 | −14.854 | 1.00 | 1.00 | C |
| ATOM | 1509 | C | THR | A | 1070 | −20.092 | 11.267 | −15.233 | 1.00 | 1.00 | C |
| ATOM | 1510 | O | THR | A | 1070 | −21.049 | 10.624 | −14.863 | 1.00 | 1.00 | O |
| ATOM | 1511 | CB | THR | A | 1070 | −18.158 | 11.669 | −13.675 | 1.00 | 1.00 | C |
| ATOM | 1512 | OG1 | THR | A | 1070 | −17.813 | 12.974 | −14.087 | 1.00 | 1.00 | O |
| ATOM | 1513 | CG2 | THR | A | 1070 | −16.890 | 10.959 | −13.143 | 1.00 | 1.00 | C |
| ATOM | 1514 | HA | THR | A | 1070 | −18.734 | 9.770 | −14.454 | 1.00 | 1.00 | H |
| ATOM | 1515 | HB | THR | A | 1070 | −18.878 | 11.684 | −12.864 | 1.00 | 1.00 | H |
| ATOM | 1516 | HG1 | THR | A | 1070 | −18.524 | 13.554 | −14.323 | 1.00 | 1.00 | H |
| ATOM | 1517 | HG23 | THR | A | 1070 | −17.042 | 9.976 | −12.604 | 1.00 | 1.00 | H |
| ATOM | 1518 | HG21 | THR | A | 1070 | −16.118 | 10.871 | −13.957 | 1.00 | 1.00 | H |
| ATOM | 1519 | HG22 | THR | A | 1070 | −16.506 | 11.619 | −12.344 | 1.00 | 1.00 | H |
| ATOM | 1520 | HN | THR | A | 1070 | −17.178 | 11.648 | −16.083 | 1.00 | 1.00 | H |
| ATOM | 1521 | N | ASN | A | 1071 | −20.295 | 12.290 | −16.075 | 1.00 | 1.00 | N |
| ATOM | 1522 | CA | ASN | A | 1071 | −21.620 | 12.591 | −16.515 | 1.00 | 1.00 | C |
| ATOM | 1523 | C | ASN | A | 1071 | −22.227 | 11.509 | −17.359 | 1.00 | 1.00 | C |
| ATOM | 1524 | O | ASN | A | 1071 | −23.437 | 11.327 | −17.333 | 1.00 | 1.00 | O |
| ATOM | 1525 | CB | ASN | A | 1071 | −21.598 | 13.845 | −17.332 | 1.00 | 1.00 | C |
| ATOM | 1526 | CG | ASN | A | 1071 | −23.056 | 14.261 | −17.569 | 1.00 | 1.00 | C |
| ATOM | 1527 | OD1 | ASN | A | 1071 | −23.600 | 14.063 | −18.637 | 1.00 | 1.00 | O |
| ATOM | 1528 | ND2 | ASN | A | 1071 | −23.723 | 14.851 | −16.551 | 1.00 | 1.00 | N |
| ATOM | 1529 | HA | ASN | A | 1071 | −22.238 | 12.759 | −15.608 | 1.00 | 1.00 | H |
| ATOM | 1530 | HB1 | ASN | A | 1071 | −21.075 | 14.705 | −16.910 | 1.00 | 1.00 | H |
| ATOM | 1531 | HB2 | ASN | A | 1071 | −21.101 | 13.620 | −18.303 | 1.00 | 1.00 | H |
| ATOM | 1532 | HD22 | ASN | A | 1071 | −24.645 | 15.100 | −16.739 | 1.00 | 1.00 | H |
| ATOM | 1533 | HD21 | ASN | A | 1071 | −23.358 | 15.069 | −15.695 | 1.00 | 1.00 | H |
| ATOM | 1534 | HN | ASN | A | 1071 | −19.501 | 12.752 | −16.457 | 1.00 | 1.00 | H |
| ATOM | 1535 | N | LEU | A | 1072 | −21.443 | 10.715 | −18.128 | 1.00 | 1.00 | N |
| ATOM | 1536 | CA | LEU | A | 1072 | −22.077 | 9.573 | −18.851 | 1.00 | 1.00 | C |
| ATOM | 1537 | C | LEU | A | 1072 | −22.399 | 8.431 | −17.907 | 1.00 | 1.00 | C |
| ATOM | 1538 | O | LEU | A | 1072 | −23.510 | 7.911 | −18.062 | 1.00 | 1.00 | O |
| ATOM | 1539 | CB | LEU | A | 1072 | −21.249 | 9.008 | −20.007 | 1.00 | 1.00 | C |
| ATOM | 1540 | CG | LEU | A | 1072 | −21.003 | 9.901 | −21.270 | 1.00 | 1.00 | C |
| ATOM | 1541 | CD1 | LEU | A | 1072 | −19.896 | 9.301 | −22.229 | 1.00 | 1.00 | C |
| ATOM | 1542 | CD2 | LEU | A | 1072 | −22.365 | 10.046 | −22.073 | 1.00 | 1.00 | C |
| ATOM | 1543 | HA | LEU | A | 1072 | −23.022 | 9.899 | −19.273 | 1.00 | 1.00 | H |
| ATOM | 1544 | HB1 | LEU | A | 1072 | −20.242 | 8.828 | −19.581 | 1.00 | 1.00 | H |
| ATOM | 1545 | HB2 | LEU | A | 1072 | −21.690 | 8.031 | −20.312 | 1.00 | 1.00 | H |
| ATOM | 1546 | HG | LEU | A | 1072 | −20.578 | 10.873 | −20.955 | 1.00 | 1.00 | H |
| ATOM | 1547 | HD21 | LEU | A | 1072 | −22.774 | 9.117 | −22.385 | 1.00 | 1.00 | H |
| ATOM | 1548 | HD22 | LEU | A | 1072 | −23.130 | 10.617 | −21.471 | 1.00 | 1.00 | H |
| ATOM | 1549 | HD23 | LEU | A | 1072 | −22.140 | 10.562 | −23.023 | 1.00 | 1.00 | H |
| ATOM | 1550 | HD11 | LEU | A | 1072 | −20.204 | 8.316 | −22.609 | 1.00 | 1.00 | H |
| ATOM | 1551 | HD12 | LEU | A | 1072 | −19.671 | 10.002 | −23.055 | 1.00 | 1.00 | H |
| ATOM | 1552 | HD13 | LEU | A | 1072 | −18.981 | 9.241 | −21.589 | 1.00 | 1.00 | H |
| ATOM | 1553 | HN | LEU | A | 1072 | −20.483 | 10.991 | −18.262 | 1.00 | 1.00 | H |
| ATOM | 1554 | N | LEU | A | 1073 | −21.457 | 8.098 | −17.000 | 1.00 | 1.00 | N |
| ATOM | 1555 | CA | LEU | A | 1073 | −21.692 | 6.990 | −16.034 | 1.00 | 1.00 | C |
| ATOM | 1556 | C | LEU | A | 1073 | −22.939 | 7.405 | −15.257 | 1.00 | 1.00 | C |
| ATOM | 1557 | O | LEU | A | 1073 | −23.826 | 6.566 | −15.029 | 1.00 | 1.00 | O |
| ATOM | 1558 | CB | LEU | A | 1073 | −20.515 | 6.801 | −15.044 | 1.00 | 1.00 | C |
| ATOM | 1559 | CG | LEU | A | 1073 | −20.793 | 5.854 | −13.848 | 1.00 | 1.00 | C |
| ATOM | 1560 | CD1 | LEU | A | 1073 | −21.212 | 4.400 | −14.230 | 1.00 | 1.00 | C |
| ATOM | 1561 | CD2 | LEU | A | 1073 | −19.526 | 5.798 | −12.932 | 1.00 | 1.00 | C |
| ATOM | 1562 | HA | LEU | A | 1073 | −21.936 | 6.120 | −16.628 | 1.00 | 1.00 | H |
| ATOM | 1563 | HB1 | LEU | A | 1073 | −19.698 | 6.473 | −15.752 | 1.00 | 1.00 | H |
| ATOM | 1564 | HB2 | LEU | A | 1073 | −20.231 | 7.787 | −14.600 | 1.00 | 1.00 | H |
| ATOM | 1565 | HG | LEU | A | 1073 | −21.642 | 6.346 | −13.288 | 1.00 | 1.00 | H |
| ATOM | 1566 | HD21 | LEU | A | 1073 | −19.253 | 6.821 | −12.562 | 1.00 | 1.00 | H |
| ATOM | 1567 | HD22 | LEU | A | 1073 | −19.741 | 5.071 | −12.123 | 1.00 | 1.00 | H |
| ATOM | 1568 | HD23 | LEU | A | 1073 | −18.693 | 5.465 | −13.507 | 1.00 | 1.00 | H |
| ATOM | 1569 | HD11 | LEU | A | 1073 | −21.501 | 3.850 | −13.323 | 1.00 | 1.00 | H |
| ATOM | 1570 | HD12 | LEU | A | 1073 | −22.042 | 4.402 | −14.922 | 1.00 | 1.00 | H |
| ATOM | 1571 | HD13 | LEU | A | 1073 | −20.367 | 3.859 | −14.717 | 1.00 | 1.00 | H |
| ATOM | 1572 | HN | LEU | A | 1073 | −20.593 | 8.611 | −16.946 | 1.00 | 1.00 | H |
| ATOM | 1573 | N | SER | A | 1074 | −23.105 | 8.663 | −14.778 | 1.00 | 1.00 | N |
| ATOM | 1574 | CA | SER | A | 1074 | −24.270 | 9.037 | −13.974 | 1.00 | 1.00 | C |
| ATOM | 1575 | C | SER | A | 1074 | −25.586 | 8.734 | −14.640 | 1.00 | 1.00 | C |
| ATOM | 1576 | O | SER | A | 1074 | −26.580 | 8.398 | −14.004 | 1.00 | 1.00 | O |
| ATOM | 1577 | CB | SER | A | 1074 | −24.189 | 10.516 | −13.553 | 1.00 | 1.00 | C |
| ATOM | 1578 | OG | SER | A | 1074 | −24.158 | 11.449 | −14.688 | 1.00 | 1.00 | O |
| ATOM | 1579 | HA | SER | A | 1074 | −24.195 | 8.412 | −13.040 | 1.00 | 1.00 | H |
| ATOM | 1580 | HB1 | SER | A | 1074 | −25.012 | 10.675 | −12.811 | 1.00 | 1.00 | H |
| ATOM | 1581 | HB2 | SER | A | 1074 | −23.255 | 10.616 | −12.985 | 1.00 | 1.00 | H |
| ATOM | 1582 | HG | SER | A | 1074 | −24.910 | 11.421 | −15.263 | 1.00 | 1.00 | H |
| ATOM | 1583 | HN | SER | A | 1074 | −22.440 | 9.376 | −15.019 | 1.00 | 1.00 | H |
| ATOM | 1584 | N | SER | A | 1075 | −25.671 | 8.822 | −16.003 | 1.00 | 1.00 | N |
| ATOM | 1585 | CA | SER | A | 1075 | −26.908 | 8.384 | −16.683 | 1.00 | 1.00 | C |
| ATOM | 1586 | C | SER | A | 1075 | −27.038 | 6.932 | −16.834 | 1.00 | 1.00 | C |
| ATOM | 1587 | O | SER | A | 1075 | −28.150 | 6.547 | −17.078 | 1.00 | 1.00 | O |
| ATOM | 1588 | CB | SER | A | 1075 | −27.145 | 9.028 | −18.092 | 1.00 | 1.00 | C |
| ATOM | 1589 | OG | SER | A | 1075 | −26.213 | 8.440 | −19.054 | 1.00 | 1.00 | O |
| ATOM | 1590 | HA | SER | A | 1075 | −27.751 | 8.642 | −16.058 | 1.00 | 1.00 | H |
| ATOM | 1591 | HB1 | SER | A | 1075 | −28.171 | 8.861 | −18.439 | 1.00 | 1.00 | H |
| ATOM | 1592 | HB2 | SER | A | 1075 | −27.003 | 10.124 | −17.930 | 1.00 | 1.00 | H |
| ATOM | 1593 | HG | SER | A | 1075 | −25.287 | 8.485 | −18.823 | 1.00 | 1.00 | H |
| ATOM | 1594 | HN | SER | A | 1075 | −24.852 | 9.122 | −16.485 | 1.00 | 1.00 | H |
| ATOM | 1595 | N | ASN | A | 1076 | −26.015 | 6.093 | −16.720 | 1.00 | 1.00 | N |
| ATOM | 1596 | CA | ASN | A | 1076 | −26.212 | 4.668 | −17.150 | 1.00 | 1.00 | C |
| ATOM | 1597 | C | ASN | A | 1076 | −27.100 | 3.942 | −16.086 | 1.00 | 1.00 | C |
| ATOM | 1598 | O | ASN | A | 1076 | −27.814 | 3.057 | −16.527 | 1.00 | 1.00 | O |
| ATOM | 1599 | CB | ASN | A | 1076 | −24.893 | 3.876 | −17.506 | 1.00 | 1.00 | C |
| ATOM | 1600 | CG | ASN | A | 1076 | −24.383 | 4.158 | −18.910 | 1.00 | 1.00 | C |
| ATOM | 1601 | OD1 | ASN | A | 1076 | −24.482 | 3.238 | −19.682 | 1.00 | 1.00 | O |
| ATOM | 1602 | ND2 | ASN | A | 1076 | −23.746 | 5.344 | −19.196 | 1.00 | 1.00 | N |
| ATOM | 1603 | HA | ASN | A | 1076 | −26.789 | 4.638 | −18.082 | 1.00 | 1.00 | H |
| ATOM | 1604 | HB1 | ASN | A | 1076 | −24.145 | 4.157 | −16.738 | 1.00 | 1.00 | H |
| ATOM | 1605 | HB2 | ASN | A | 1076 | −24.987 | 2.789 | −17.418 | 1.00 | 1.00 | H |
| ATOM | 1606 | HD22 | ASN | A | 1076 | −23.304 | 5.548 | −20.090 | 1.00 | 1.00 | H |
| ATOM | 1607 | HD21 | ASN | A | 1076 | −23.665 | 6.073 | −18.509 | 1.00 | 1.00 | H |
| ATOM | 1608 | HN | ASN | A | 1076 | −25.082 | 6.410 | −16.529 | 1.00 | 1.00 | H |
| ATOM | 1609 | N | LEU | A | 1077 | −26.892 | 4.268 | −14.798 | 1.00 | 1.00 | N |
| ATOM | 1610 | CA | LEU | A | 1077 | −27.718 | 3.742 | −13.686 | 1.00 | 1.00 | C |
| ATOM | 1611 | C | LEU | A | 1077 | −27.705 | 2.229 | −13.514 | 1.00 | 1.00 | C |
| ATOM | 1612 | O | LEU | A | 1077 | −27.660 | 1.448 | −14.460 | 1.00 | 1.00 | O |
| ATOM | 1613 | CB | LEU | A | 1077 | −29.119 | 4.307 | −13.693 | 1.00 | 1.00 | C |
| ATOM | 1614 | CG | LEU | A | 1077 | −29.131 | 5.881 | −13.614 | 1.00 | 1.00 | C |
| ATOM | 1615 | CD1 | LEU | A | 1077 | −30.570 | 6.428 | −13.896 | 1.00 | 1.00 | C |
| ATOM | 1616 | CD2 | LEU | A | 1077 | −28.611 | 6.504 | −12.313 | 1.00 | 1.00 | C |
| ATOM | 1617 | HA | LEU | A | 1077 | −27.185 | 4.095 | −12.806 | 1.00 | 1.00 | H |
| ATOM | 1618 | HB1 | LEU | A | 1077 | −29.700 | 3.805 | −12.898 | 1.00 | 1.00 | H |
| ATOM | 1619 | HB2 | LEU | A | 1077 | −29.574 | 4.040 | −14.668 | 1.00 | 1.00 | H |
| ATOM | 1620 | HG | LEU | A | 1077 | −28.487 | 6.203 | −14.444 | 1.00 | 1.00 | H |
| ATOM | 1621 | HD21 | LEU | A | 1077 | −29.214 | 6.241 | −11.413 | 1.00 | 1.00 | H |
| ATOM | 1622 | HD22 | LEU | A | 1077 | −27.534 | 6.306 | −12.105 | 1.00 | 1.00 | H |
| ATOM | 1623 | HD23 | LEU | A | 1077 | −28.764 | 7.603 | −12.335 | 1.00 | 1.00 | H |
| ATOM | 1624 | HD11 | LEU | A | 1077 | −31.246 | 5.940 | −13.192 | 1.00 | 1.00 | H |
| ATOM | 1625 | HD12 | LEU | A | 1077 | −30.777 | 6.215 | −14.975 | 1.00 | 1.00 | H |
| ATOM | 1626 | HD13 | LEU | A | 1077 | −30.554 | 7.543 | −13.754 | 1.00 | 1.00 | H |
| ATOM | 1627 | HN | LEU | A | 1077 | −26.184 | 4.923 | −14.573 | 1.00 | 1.00 | H |
| ATOM | 1628 | N | SER | A | 1078 | −27.860 | 1.697 | −12.237 | 1.00 | 1.00 | N |
| ATOM | 1629 | CA | SER | A | 1078 | −28.170 | 0.278 | −12.056 | 1.00 | 1.00 | C |
| ATOM | 1630 | C | SER | A | 1078 | −27.111 | −0.740 | −12.442 | 1.00 | 1.00 | C |
| ATOM | 1631 | O | SER | A | 1078 | −27.277 | −1.430 | −13.423 | 1.00 | 1.00 | O |
| ATOM | 1632 | CB | SER | A | 1078 | −29.579 | 0.024 | −12.646 | 1.00 | 1.00 | C |
| ATOM | 1633 | OG | SER | A | 1078 | −29.988 | −1.351 | −12.420 | 1.00 | 1.00 | O |
| ATOM | 1634 | HA | SER | A | 1078 | −28.324 | 0.115 | −10.945 | 1.00 | 1.00 | H |
| ATOM | 1635 | HB1 | SER | A | 1078 | −30.237 | 0.799 | −12.194 | 1.00 | 1.00 | H |
| ATOM | 1636 | HB2 | SER | A | 1078 | −29.572 | 0.240 | −13.724 | 1.00 | 1.00 | H |
| ATOM | 1637 | HG | SER | A | 1078 | −30.863 | −1.441 | −12.775 | 1.00 | 1.00 | H |
| ATOM | 1638 | HN | SER | A | 1078 | −27.887 | 2.327 | −11.431 | 1.00 | 1.00 | H |
| ATOM | 1639 | N | TRP | A | 1079 | −25.978 | −0.964 | −11.681 | 1.00 | 1.00 | N |
| ATOM | 1640 | CA | TRP | A | 1079 | −24.970 | −1.975 | −12.051 | 1.00 | 1.00 | C |
| ATOM | 1641 | C | TRP | A | 1079 | −23.943 | −2.343 | −10.975 | 1.00 | 1.00 | C |
| ATOM | 1642 | O | TRP | A | 1079 | −24.295 | −3.091 | −10.115 | 1.00 | 1.00 | O |
| ATOM | 1643 | CB | TRP | A | 1079 | −24.363 | −1.916 | −13.507 | 1.00 | 1.00 | C |
| ATOM | 1644 | CG | TRP | A | 1079 | −24.015 | −0.585 | −14.068 | 1.00 | 1.00 | C |
| ATOM | 1645 | CD1 | TRP | A | 1079 | −24.469 | 0.642 | −13.698 | 1.00 | 1.00 | C |
| ATOM | 1646 | CD2 | TRP | A | 1079 | −23.076 | −0.401 | −15.236 | 1.00 | 1.00 | C |
| ATOM | 1647 | NE1 | TRP | A | 1079 | −23.955 | 1.511 | −14.502 | 1.00 | 1.00 | N |
| ATOM | 1648 | CE2 | TRP | A | 1079 | −23.161 | 0.950 | −15.404 | 1.00 | 1.00 | C |
| ATOM | 1649 | CE3 | TRP | A | 1079 | −22.270 | −1.211 | −16.007 | 1.00 | 1.00 | C |
| ATOM | 1650 | CZ2 | TRP | A | 1079 | −22.431 | 1.550 | −16.461 | 1.00 | 1.00 | C |
| ATOM | 1651 | CZ3 | TRP | A | 1079 | −21.596 | −0.625 | −17.088 | 1.00 | 1.00 | C |
| ATOM | 1652 | CH2 | TRP | A | 1079 | −21.705 | 0.732 | −17.375 | 1.00 | 1.00 | C |
| ATOM | 1653 | HA | TRP | A | 1079 | −25.500 | −2.912 | −12.104 | 1.00 | 1.00 | H |
| ATOM | 1654 | HB1 | TRP | A | 1079 | −23.435 | −2.509 | −13.504 | 1.00 | 1.00 | H |
| ATOM | 1655 | HB2 | TRP | A | 1079 | −24.991 | −2.388 | −14.328 | 1.00 | 1.00 | H |
| ATOM | 1656 | HE1 | TRP | A | 1079 | −24.114 | 2.532 | −14.425 | 1.00 | 1.00 | H |
| ATOM | 1657 | HD1 | TRP | A | 1079 | −25.080 | 0.952 | −12.854 | 1.00 | 1.00 | H |
| ATOM | 1658 | HZ2 | TRP | A | 1079 | −22.428 | 2.616 | −16.591 | 1.00 | 1.00 | H |
| ATOM | 1659 | HH2 | TRP | A | 1079 | −21.252 | 1.117 | −18.249 | 1.00 | 1.00 | H |
| ATOM | 1660 | HZ3 | TRP | A | 1079 | −20.920 | −1.220 | −17.690 | 1.00 | 1.00 | H |
| ATOM | 1661 | HE3 | TRP | A | 1079 | −22.054 | −2.266 | −15.801 | 1.00 | 1.00 | H |
| ATOM | 1662 | HN | TRP | A | 1079 | −25.762 | −0.423 | −10.837 | 1.00 | 1.00 | H |
| ATOM | 1663 | N | LEU | A | 1080 | −22.700 | −1.792 | −11.089 | 1.00 | 1.00 | N |
| ATOM | 1664 | CA | LEU | A | 1080 | −21.584 | −2.254 | −10.268 | 1.00 | 1.00 | C |
| ATOM | 1665 | C | LEU | A | 1080 | −20.811 | −1.101 | −9.688 | 1.00 | 1.00 | C |
| ATOM | 1666 | O | LEU | A | 1080 | −20.950 | 0.005 | −10.133 | 1.00 | 1.00 | O |
| ATOM | 1667 | CB | LEU | A | 1080 | −20.441 | −3.016 | −11.017 | 1.00 | 1.00 | C |
| ATOM | 1668 | CG | LEU | A | 1080 | −20.826 | −4.258 | −11.883 | 1.00 | 1.00 | C |
| ATOM | 1669 | CD1 | LEU | A | 1080 | −19.588 | −4.881 | −12.618 | 1.00 | 1.00 | C |
| ATOM | 1670 | CD2 | LEU | A | 1080 | −21.377 | −5.336 | −10.920 | 1.00 | 1.00 | C |
| ATOM | 1671 | HA | LEU | A | 1080 | −21.889 | −2.916 | −9.459 | 1.00 | 1.00 | H |
| ATOM | 1672 | HB1 | LEU | A | 1080 | −19.960 | −2.303 | −11.744 | 1.00 | 1.00 | H |
| ATOM | 1673 | HB2 | LEU | A | 1080 | −19.667 | −3.281 | −10.340 | 1.00 | 1.00 | H |
| ATOM | 1674 | HG | LEU | A | 1080 | −21.643 | −4.010 | −12.587 | 1.00 | 1.00 | H |
| ATOM | 1675 | HD21 | LEU | A | 1080 | −22.341 | −5.020 | −10.582 | 1.00 | 1.00 | H |
| ATOM | 1676 | HD22 | LEU | A | 1080 | −20.689 | −5.488 | −10.085 | 1.00 | 1.00 | H |
| ATOM | 1677 | HD23 | LEU | A | 1080 | −21.477 | −6.373 | −11.317 | 1.00 | 1.00 | H |
| ATOM | 1678 | HD11 | LEU | A | 1080 | −18.733 | −5.130 | −11.971 | 1.00 | 1.00 | H |
| ATOM | 1679 | HD12 | LEU | A | 1080 | −19.232 | −4.119 | −13.335 | 1.00 | 1.00 | H |
| ATOM | 1680 | HD13 | LEU | A | 1080 | −19.893 | −5.784 | −13.153 | 1.00 | 1.00 | H |
| ATOM | 1681 | HN | LEU | A | 1080 | −22.490 | −1.072 | −11.757 | 1.00 | 1.00 | H |
| ATOM | 1682 | N | SER | A | 1081 | −19.941 | −1.344 | −8.681 | 1.00 | 1.00 | N |
| ATOM | 1683 | CA | SER | A | 1081 | −18.991 | −0.360 | −8.239 | 1.00 | 1.00 | C |
| ATOM | 1684 | C | SER | A | 1081 | −17.758 | −1.005 | −7.602 | 1.00 | 1.00 | C |
| ATOM | 1685 | O | SER | A | 1081 | −17.930 | −1.894 | −6.811 | 1.00 | 1.00 | O |
| ATOM | 1686 | CB | SER | A | 1081 | −19.537 | 0.505 | −7.057 | 1.00 | 1.00 | C |
| ATOM | 1687 | OG | SER | A | 1081 | −20.625 | 1.320 | −7.482 | 1.00 | 1.00 | O |
| ATOM | 1688 | HA | SER | A | 1081 | −18.636 | 0.244 | −9.061 | 1.00 | 1.00 | H |
| ATOM | 1689 | HB1 | SER | A | 1081 | −18.758 | 1.185 | −6.666 | 1.00 | 1.00 | H |
| ATOM | 1690 | HB2 | SER | A | 1081 | −19.856 | −0.125 | −6.196 | 1.00 | 1.00 | H |
| ATOM | 1691 | HG | SER | A | 1081 | −21.039 | 1.885 | −6.839 | 1.00 | 1.00 | H |
| ATOM | 1692 | HN | SER | A | 1081 | −20.022 | −2.240 | −8.215 | 1.00 | 1.00 | H |
| ATOM | 1693 | N | LEU | A | 1082 | −16.475 | −0.608 | −7.969 | 1.00 | 1.00 | N |
| ATOM | 1694 | CA | LEU | A | 1082 | −15.313 | −1.365 | −7.516 | 1.00 | 1.00 | C |
| ATOM | 1695 | C | LEU | A | 1082 | −14.034 | −0.533 | −7.285 | 1.00 | 1.00 | C |
| ATOM | 1696 | O | LEU | A | 1082 | −13.521 | −0.053 | −8.242 | 1.00 | 1.00 | O |
| ATOM | 1697 | CB | LEU | A | 1082 | −15.143 | −2.463 | −8.695 | 1.00 | 1.00 | C |
| ATOM | 1698 | CG | LEU | A | 1082 | −13.786 | −3.220 | −8.647 | 1.00 | 1.00 | C |
| ATOM | 1699 | CD1 | LEU | A | 1082 | −13.527 | −3.801 | −7.229 | 1.00 | 1.00 | C |
| ATOM | 1700 | CD2 | LEU | A | 1082 | −13.707 | −4.324 | −9.760 | 1.00 | 1.00 | C |
| ATOM | 1701 | HA | LEU | A | 1082 | −15.479 | −1.967 | −6.595 | 1.00 | 1.00 | H |
| ATOM | 1702 | HB1 | LEU | A | 1082 | −15.184 | −1.967 | −9.666 | 1.00 | 1.00 | H |
| ATOM | 1703 | HB2 | LEU | A | 1082 | −15.980 | −3.250 | −8.697 | 1.00 | 1.00 | H |
| ATOM | 1704 | HG | LEU | A | 1082 | −13.011 | −2.502 | −8.889 | 1.00 | 1.00 | H |
| ATOM | 1705 | HD21 | LEU | A | 1082 | −14.460 | −5.095 | −9.520 | 1.00 | 1.00 | H |
| ATOM | 1706 | HD22 | LEU | A | 1082 | −13.856 | −3.903 | −10.740 | 1.00 | 1.00 | H |
| ATOM | 1707 | HD23 | LEU | A | 1082 | −12.681 | −4.749 | −9.767 | 1.00 | 1.00 | H |
| ATOM | 1708 | HD11 | LEU | A | 1082 | −12.549 | −4.266 | −7.278 | 1.00 | 1.00 | H |
| ATOM | 1709 | HD12 | LEU | A | 1082 | −13.499 | −3.068 | −6.477 | 1.00 | 1.00 | H |
| ATOM | 1710 | HD13 | LEU | A | 1082 | −14.277 | −4.586 | −6.926 | 1.00 | 1.00 | H |
| ATOM | 1711 | HN | LEU | A | 1082 | −16.332 | 0.056 | −8.714 | 1.00 | 1.00 | H |
| ATOM | 1712 | N | ASP | A | 1083 | −13.593 | −0.411 | −5.990 | 1.00 | 1.00 | N |
| ATOM | 1713 | CA | ASP | A | 1083 | −12.300 | 0.283 | −5.667 | 1.00 | 1.00 | C |
| ATOM | 1714 | C | ASP | A | 1083 | −11.242 | −0.765 | −5.825 | 1.00 | 1.00 | C |
| ATOM | 1715 | O | ASP | A | 1083 | −11.321 | −1.749 | −5.077 | 1.00 | 1.00 | O |
| ATOM | 1716 | CB | ASP | A | 1083 | −12.082 | 0.955 | −4.254 | 1.00 | 1.00 | C |
| ATOM | 1717 | CG | ASP | A | 1083 | −10.967 | 2.021 | −3.992 | 1.00 | 1.00 | C |
| ATOM | 1718 | OD1 | ASP | A | 1083 | −11.119 | 3.207 | −4.265 | 1.00 | 1.00 | O |
| ATOM | 1719 | OD2 | ASP | A | 1083 | −9.895 | 1.695 | −3.449 | 1.00 | 1.00 | O |
| ATOM | 1720 | HA | ASP | A | 1083 | −12.198 | 1.111 | −6.349 | 1.00 | 1.00 | H |
| ATOM | 1721 | HB1 | ASP | A | 1083 | −11.824 | 0.173 | −3.539 | 1.00 | 1.00 | H |
| ATOM | 1722 | HB2 | ASP | A | 1083 | −13.092 | 1.419 | −3.958 | 1.00 | 1.00 | H |
| ATOM | 1723 | HN | ASP | A | 1083 | −14.107 | −0.766 | −5.247 | 1.00 | 1.00 | H |
| ATOM | 1724 | N | VAL | A | 1084 | −10.275 | −0.590 | −6.737 | 1.00 | 1.00 | N |
| ATOM | 1725 | CA | VAL | A | 1084 | −9.274 | −1.609 | −7.015 | 1.00 | 1.00 | C |
| ATOM | 1726 | C | VAL | A | 1084 | −8.045 | −1.410 | −6.141 | 1.00 | 1.00 | C |
| ATOM | 1727 | O | VAL | A | 1084 | −7.072 | −0.882 | −6.608 | 1.00 | 1.00 | O |
| ATOM | 1728 | CB | VAL | A | 1084 | −8.936 | −1.573 | −8.549 | 1.00 | 1.00 | C |
| ATOM | 1729 | CG1 | VAL | A | 1084 | −7.887 | −2.600 | −8.987 | 1.00 | 1.00 | C |
| ATOM | 1730 | CG2 | VAL | A | 1084 | −10.222 | −1.659 | −9.421 | 1.00 | 1.00 | C |
| ATOM | 1731 | HA | VAL | A | 1084 | −9.709 | −2.579 | −6.791 | 1.00 | 1.00 | H |
| ATOM | 1732 | HB | VAL | A | 1084 | −8.517 | −0.538 | −8.771 | 1.00 | 1.00 | H |
| ATOM | 1733 | HG11 | VAL | A | 1084 | −8.249 | −3.635 | −8.833 | 1.00 | 1.00 | H |
| ATOM | 1734 | HG12 | VAL | A | 1084 | −7.696 | −2.555 | −10.060 | 1.00 | 1.00 | H |
| ATOM | 1735 | HG13 | VAL | A | 1084 | −6.944 | −2.430 | −8.436 | 1.00 | 1.00 | H |
| ATOM | 1736 | HG21 | VAL | A | 1084 | −10.992 | −0.922 | −9.120 | 1.00 | 1.00 | H |
| ATOM | 1737 | HG22 | VAL | A | 1084 | −9.953 | −1.491 | −10.505 | 1.00 | 1.00 | H |
| ATOM | 1738 | HG23 | VAL | A | 1084 | −10.637 | −2.705 | −9.367 | 1.00 | 1.00 | H |
| ATOM | 1739 | HN | VAL | A | 1084 | −10.181 | 0.333 | −7.157 | 1.00 | 1.00 | H |
| ATOM | 1740 | N | SER | A | 1085 | −8.056 | −1.897 | −4.895 | 1.00 | 1.00 | N |
| ATOM | 1741 | CA | SER | A | 1085 | −6.850 | −1.786 | −4.026 | 1.00 | 1.00 | C |
| ATOM | 1742 | C | SER | A | 1085 | −5.691 | −2.619 | −4.539 | 1.00 | 1.00 | C |
| ATOM | 1743 | O | SER | A | 1085 | −5.266 | −3.599 | −3.941 | 1.00 | 1.00 | O |
| ATOM | 1744 | CB | SER | A | 1085 | −7.185 | −2.342 | −2.622 | 1.00 | 1.00 | C |
| ATOM | 1745 | OG | SER | A | 1085 | −6.127 | −2.078 | −1.636 | 1.00 | 1.00 | O |
| ATOM | 1746 | HA | SER | A | 1085 | −6.564 | −0.698 | −3.922 | 1.00 | 1.00 | H |
| ATOM | 1747 | HB1 | SER | A | 1085 | −7.410 | −3.430 | −2.696 | 1.00 | 1.00 | H |
| ATOM | 1748 | HB2 | SER | A | 1085 | −8.062 | −1.796 | −2.228 | 1.00 | 1.00 | H |
| ATOM | 1749 | HG | SER | A | 1085 | −5.933 | −1.130 | −1.502 | 1.00 | 1.00 | H |
| ATOM | 1750 | HN | SER | A | 1085 | −8.863 | −2.359 | −4.524 | 1.00 | 1.00 | H |
| ATOM | 1751 | N | ALA | A | 1086 | −5.034 | −2.201 | −5.641 | 1.00 | 1.00 | N |
| ATOM | 1752 | CA | ALA | A | 1086 | −3.970 | −2.958 | −6.273 | 1.00 | 1.00 | C |
| ATOM | 1753 | C | ALA | A | 1086 | −2.993 | −2.122 | −7.107 | 1.00 | 1.00 | C |
| ATOM | 1754 | O | ALA | A | 1086 | −1.818 | −2.246 | −6.825 | 1.00 | 1.00 | O |
| ATOM | 1755 | CB | ALA | A | 1086 | −4.431 | −4.135 | −7.198 | 1.00 | 1.00 | C |
| ATOM | 1756 | HA | ALA | A | 1086 | −3.401 | −3.374 | −5.427 | 1.00 | 1.00 | H |
| ATOM | 1757 | HB1 | ALA | A | 1086 | −3.508 | −4.728 | −7.471 | 1.00 | 1.00 | H |
| ATOM | 1758 | HB2 | ALA | A | 1086 | −5.062 | −4.795 | −6.561 | 1.00 | 1.00 | H |
| ATOM | 1759 | HB3 | ALA | A | 1086 | −4.971 | −3.675 | −8.059 | 1.00 | 1.00 | H |
| ATOM | 1760 | HN | ALA | A | 1086 | −5.434 | −1.396 | −6.140 | 1.00 | 1.00 | H |
| ATOM | 1761 | N | ALA | A | 1087 | −3.450 | −1.371 | −8.166 | 1.00 | 1.00 | N |
| ATOM | 1762 | CA | ALA | A | 1087 | −2.500 | −0.721 | −9.069 | 1.00 | 1.00 | C |
| ATOM | 1763 | C | ALA | A | 1087 | −1.439 | 0.009 | −8.310 | 1.00 | 1.00 | C |
| ATOM | 1764 | O | ALA | A | 1087 | −0.266 | −0.278 | −8.550 | 1.00 | 1.00 | O |
| ATOM | 1765 | CB | ALA | A | 1087 | −3.196 | 0.299 | −10.022 | 1.00 | 1.00 | C |
| ATOM | 1766 | HA | ALA | A | 1087 | −2.012 | −1.539 | −9.583 | 1.00 | 1.00 | H |
| ATOM | 1767 | HB1 | ALA | A | 1087 | −2.471 | 0.819 | −10.662 | 1.00 | 1.00 | H |
| ATOM | 1768 | HB2 | ALA | A | 1087 | −3.858 | −0.269 | −10.686 | 1.00 | 1.00 | H |
| ATOM | 1769 | HB3 | ALA | A | 1087 | −3.736 | 1.076 | −9.495 | 1.00 | 1.00 | H |
| ATOM | 1770 | HN | ALA | A | 1087 | −4.400 | −1.282 | −8.371 | 1.00 | 1.00 | H |
| ATOM | 1771 | N | PHE | A | 1088 | −1.822 | 0.946 | −7.423 | 1.00 | 1.00 | N |
| ATOM | 1772 | CA | PHE | A | 1088 | −0.794 | 1.712 | −6.728 | 1.00 | 1.00 | C |
| ATOM | 1773 | C | PHE | A | 1088 | −0.577 | 1.067 | −5.338 | 1.00 | 1.00 | C |
| ATOM | 1774 | O | PHE | A | 1088 | −0.572 | 1.771 | −4.350 | 1.00 | 1.00 | O |
| ATOM | 1775 | CB | PHE | A | 1088 | −1.168 | 3.159 | −6.721 | 1.00 | 1.00 | C |
| ATOM | 1776 | CG | PHE | A | 1088 | −0.908 | 3.894 | −8.028 | 1.00 | 1.00 | C |
| ATOM | 1777 | CD1 | PHE | A | 1088 | −0.468 | 3.296 | −9.228 | 1.00 | 1.00 | C |
| ATOM | 1778 | CD2 | PHE | A | 1088 | −1.155 | 5.285 | −8.039 | 1.00 | 1.00 | C |
| ATOM | 1779 | CE1 | PHE | A | 1088 | −0.344 | 4.098 | −10.350 | 1.00 | 1.00 | C |
| ATOM | 1780 | CE2 | PHE | A | 1088 | −1.127 | 6.038 | −9.197 | 1.00 | 1.00 | C |
| ATOM | 1781 | CZ | PHE | A | 1088 | −0.692 | 5.424 | −10.383 | 1.00 | 1.00 | C |
| ATOM | 1782 | HA | PHE | A | 1088 | 0.211 | 1.562 | −7.138 | 1.00 | 1.00 | H |
| ATOM | 1783 | HB1 | PHE | A | 1088 | −0.694 | 3.803 | −5.977 | 1.00 | 1.00 | H |
| ATOM | 1784 | HB2 | PHE | A | 1088 | −2.279 | 3.262 | −6.624 | 1.00 | 1.00 | H |
| ATOM | 1785 | HD2 | PHE | A | 1088 | −1.361 | 5.772 | −7.131 | 1.00 | 1.00 | H |
| ATOM | 1786 | HE2 | PHE | A | 1088 | −1.383 | 7.100 | −9.235 | 1.00 | 1.00 | H |
| ATOM | 1787 | HZ | PHE | A | 1088 | −0.559 | 6.029 | −11.282 | 1.00 | 1.00 | H |
| ATOM | 1788 | HE1 | PHE | A | 1088 | 0.127 | 3.540 | −11.213 | 1.00 | 1.00 | H |
| ATOM | 1789 | HD1 | PHE | A | 1088 | −0.255 | 2.216 | −9.266 | 1.00 | 1.00 | H |
| ATOM | 1790 | HN | PHE | A | 1088 | −2.755 | 1.120 | −7.230 | 1.00 | 1.00 | H |
| ATOM | 1791 | N | TYR | A | 1089 | −0.392 | −0.288 | −5.189 | 1.00 | 1.00 | N |
| ATOM | 1792 | CA | TYR | A | 1089 | −0.274 | −0.899 | −3.881 | 1.00 | 1.00 | C |
| ATOM | 1793 | C | TYR | A | 1089 | 0.364 | −2.284 | −3.802 | 1.00 | 1.00 | C |
| ATOM | 1794 | O | TYR | A | 1089 | 1.383 | −2.393 | −3.174 | 1.00 | 1.00 | O |
| ATOM | 1795 | CB | TYR | A | 1089 | −1.723 | −1.008 | −3.286 | 1.00 | 1.00 | C |
| ATOM | 1796 | CG | TYR | A | 1089 | −1.868 | −0.802 | −1.770 | 1.00 | 1.00 | C |
| ATOM | 1797 | CD1 | TYR | A | 1089 | −2.927 | −0.034 | −1.288 | 1.00 | 1.00 | C |
| ATOM | 1798 | CD2 | TYR | A | 1089 | −0.955 | −1.323 | −0.809 | 1.00 | 1.00 | C |
| ATOM | 1799 | CE1 | TYR | A | 1089 | −3.138 | 0.223 | 0.076 | 1.00 | 1.00 | C |
| ATOM | 1800 | CE2 | TYR | A | 1089 | −1.141 | −1.045 | 0.555 | 1.00 | 1.00 | C |
| ATOM | 1801 | CZ | TYR | A | 1089 | −2.223 | −0.290 | 1.005 | 1.00 | 1.00 | C |
| ATOM | 1802 | OH | TYR | A | 1089 | −2.373 | −0.075 | 2.401 | 1.00 | 1.00 | O |
| ATOM | 1803 | HA | TYR | A | 1089 | 0.303 | −0.285 | −3.220 | 1.00 | 1.00 | H |
| ATOM | 1804 | HB2 | TYR | A | 1089 | −2.121 | −2.000 | −3.539 | 1.00 | 1.00 | H |
| ATOM | 1805 | HB1 | TYR | A | 1089 | −2.345 | −0.279 | −3.752 | 1.00 | 1.00 | H |
| ATOM | 1806 | HD2 | TYR | A | 1089 | −0.137 | −1.916 | −1.153 | 1.00 | 1.00 | H |
| ATOM | 1807 | HE2 | TYR | A | 1089 | −0.406 | −1.427 | 1.249 | 1.00 | 1.00 | H |
| ATOM | 1808 | HE1 | TYR | A | 1089 | −3.987 | 0.775 | 0.407 | 1.00 | 1.00 | H |
| ATOM | 1809 | HD1 | TYR | A | 1089 | −3.627 | 0.416 | −2.005 | 1.00 | 1.00 | H |
| ATOM | 1810 | HH | TYR | A | 1089 | −3.116 | 0.484 | 2.621 | 1.00 | 1.00 | H |
| ATOM | 1811 | HN | TYR | A | 1089 | −0.525 | −0.866 | −5.977 | 1.00 | 1.00 | H |
| ATOM | 1812 | N | HIS | A | 1090 | −0.245 | −3.349 | −4.386 | 1.00 | 1.00 | N |
| ATOM | 1813 | CA | HIS | A | 1090 | 0.036 | −4.745 | −4.070 | 1.00 | 1.00 | C |
| ATOM | 1814 | C | HIS | A | 1090 | 0.495 | −5.617 | −5.216 | 1.00 | 1.00 | C |
| ATOM | 1815 | O | HIS | A | 1090 | −0.143 | −6.618 | −5.506 | 1.00 | 1.00 | O |
| ATOM | 1816 | CB | HIS | A | 1090 | −1.261 | −5.342 | −3.421 | 1.00 | 1.00 | C |
| ATOM | 1817 | CG | HIS | A | 1090 | −1.261 | −6.785 | −3.060 | 1.00 | 1.00 | C |
| ATOM | 1818 | ND1 | HIS | A | 1090 | −0.421 | −7.296 | −2.197 | 1.00 | 1.00 | N |
| ATOM | 1819 | CD2 | HIS | A | 1090 | −2.073 | −7.786 | −3.493 | 1.00 | 1.00 | C |
| ATOM | 1820 | CE1 | HIS | A | 1090 | −0.693 | −8.555 | −1.987 | 1.00 | 1.00 | C |
| ATOM | 1821 | NE2 | HIS | A | 1090 | −1.632 | −8.926 | −2.733 | 1.00 | 1.00 | N |
| ATOM | 1822 | HA | HIS | A | 1090 | 0.830 | −4.840 | −3.328 | 1.00 | 1.00 | H |
| ATOM | 1823 | HB1 | HIS | A | 1090 | −2.017 | −5.260 | −4.233 | 1.00 | 1.00 | H |
| ATOM | 1824 | HB2 | HIS | A | 1090 | −1.513 | −4.675 | −2.555 | 1.00 | 1.00 | H |
| ATOM | 1825 | HD2 | HIS | A | 1090 | −2.827 | −7.607 | −4.243 | 1.00 | 1.00 | H |
| ATOM | 1826 | HE1 | HIS | A | 1090 | −0.118 | −9.168 | −1.297 | 1.00 | 1.00 | H |
| ATOM | 1827 | HD1 | HIS | A | 1090 | 0.316 | −6.808 | −1.678 | 1.00 | 1.00 | H |
| ATOM | 1828 | HN | HIS | A | 1090 | −0.962 | −3.217 | −5.056 | 1.00 | 1.00 | H |
| ATOM | 1829 | N | LEU | A | 1091 | 1.650 | −5.280 | −5.850 | 1.00 | 1.00 | N |
| ATOM | 1830 | CA | LEU | A | 1091 | 2.139 | −6.088 | −6.984 | 1.00 | 1.00 | C |
| ATOM | 1831 | C | LEU | A | 1091 | 3.616 | −6.430 | −6.942 | 1.00 | 1.00 | C |
| ATOM | 1832 | O | LEU | A | 1091 | 4.344 | −5.673 | −6.286 | 1.00 | 1.00 | O |
| ATOM | 1833 | CB | LEU | A | 1091 | 1.830 | −5.255 | −8.251 | 1.00 | 1.00 | C |
| ATOM | 1834 | CG | LEU | A | 1091 | 0.299 | −5.235 | −8.560 | 1.00 | 1.00 | C |
| ATOM | 1835 | CD1 | LEU | A | 1091 | −0.079 | −4.065 | −9.559 | 1.00 | 1.00 | C |
| ATOM | 1836 | CD2 | LEU | A | 1091 | −0.133 | −6.621 | −9.117 | 1.00 | 1.00 | C |
| ATOM | 1837 | HA | LEU | A | 1091 | 1.687 | −7.083 | −6.966 | 1.00 | 1.00 | H |
| ATOM | 1838 | HB1 | LEU | A | 1091 | 2.348 | −5.650 | −9.171 | 1.00 | 1.00 | H |
| ATOM | 1839 | HB2 | LEU | A | 1091 | 2.217 | −4.217 | −8.066 | 1.00 | 1.00 | H |
| ATOM | 1840 | HG | LEU | A | 1091 | −0.322 | −5.071 | −7.639 | 1.00 | 1.00 | H |
| ATOM | 1841 | HD21 | LEU | A | 1091 | −0.073 | −7.480 | −8.458 | 1.00 | 1.00 | H |
| ATOM | 1842 | HD22 | LEU | A | 1091 | −1.154 | −6.399 | −9.445 | 1.00 | 1.00 | H |
| ATOM | 1843 | HD23 | LEU | A | 1091 | 0.457 | −6.827 | −10.034 | 1.00 | 1.00 | H |
| ATOM | 1844 | HD11 | LEU | A | 1091 | 0.496 | −4.148 | −10.520 | 1.00 | 1.00 | H |
| ATOM | 1845 | HD12 | LEU | A | 1091 | −1.144 | −4.138 | −9.783 | 1.00 | 1.00 | H |
| ATOM | 1846 | HD13 | LEU | A | 1091 | 0.089 | −3.060 | −9.098 | 1.00 | 1.00 | H |
| ATOM | 1847 | HN | LEU | A | 1091 | 2.232 | −4.502 | −5.500 | 1.00 | 1.00 | H |
| ATOM | 1848 | N | PRO | A | 1092 | 4.163 | −7.526 | −7.537 | 1.00 | 1.00 | N |
| ATOM | 1849 | CA | PRO | A | 1092 | 3.354 | −8.517 | −8.207 | 1.00 | 1.00 | C |
| ATOM | 1850 | C | PRO | A | 1092 | 2.776 | −9.467 | −7.154 | 1.00 | 1.00 | C |
| ATOM | 1851 | O | PRO | A | 1092 | 3.219 | −9.371 | −6.028 | 1.00 | 1.00 | O |
| ATOM | 1852 | CB | PRO | A | 1092 | 4.460 | −9.267 | −8.973 | 1.00 | 1.00 | C |
| ATOM | 1853 | CG | PRO | A | 1092 | 5.647 | −9.210 | −7.963 | 1.00 | 1.00 | C |
| ATOM | 1854 | CD | PRO | A | 1092 | 5.580 | −7.789 | −7.427 | 1.00 | 1.00 | C |
| ATOM | 1855 | HA | PRO | A | 1092 | 2.528 | −8.128 | −8.857 | 1.00 | 1.00 | H |
| ATOM | 1856 | HD2 | PRO | A | 1092 | 5.832 | −7.757 | −6.342 | 1.00 | 1.00 | H |
| ATOM | 1857 | HD1 | PRO | A | 1092 | 6.178 | −7.180 | −8.092 | 1.00 | 1.00 | H |
| ATOM | 1858 | HG2 | PRO | A | 1092 | 6.599 | −9.413 | −8.457 | 1.00 | 1.00 | H |
| ATOM | 1859 | HG1 | PRO | A | 1092 | 5.491 | −10.031 | −7.206 | 1.00 | 1.00 | H |
| ATOM | 1860 | HB1 | PRO | A | 1092 | 4.725 | −8.743 | −9.905 | 1.00 | 1.00 | H |
| ATOM | 1861 | HB2 | PRO | A | 1092 | 4.199 | −10.301 | −9.271 | 1.00 | 1.00 | H |
| ATOM | 1862 | N | LEU | A | 1093 | 1.854 | −10.428 | −7.421 | 1.00 | 1.00 | N |
| ATOM | 1863 | CA | LEU | A | 1093 | 1.576 | −11.535 | −6.460 | 1.00 | 1.00 | C |
| ATOM | 1864 | C | LEU | A | 1093 | 2.711 | −12.545 | −6.391 | 1.00 | 1.00 | C |
| ATOM | 1865 | O | LEU | A | 1093 | 2.555 | −13.721 | −6.661 | 1.00 | 1.00 | O |
| ATOM | 1866 | CB | LEU | A | 1093 | 1.015 | −11.068 | −5.067 | 1.00 | 1.00 | C |
| ATOM | 1867 | CG | LEU | A | 1093 | 0.654 | −12.292 | −4.168 | 1.00 | 1.00 | C |
| ATOM | 1868 | CD1 | LEU | A | 1093 | 0.544 | −11.938 | −2.648 | 1.00 | 1.00 | C |
| ATOM | 1869 | CD2 | LEU | A | 1093 | −0.666 | −12.993 | −4.524 | 1.00 | 1.00 | C |
| ATOM | 1870 | HA | LEU | A | 1093 | 0.691 | −12.037 | −6.939 | 1.00 | 1.00 | H |
| ATOM | 1871 | HB1 | LEU | A | 1093 | 0.122 | −10.396 | −5.129 | 1.00 | 1.00 | H |
| ATOM | 1872 | HB2 | LEU | A | 1093 | 1.855 | −10.516 | −4.546 | 1.00 | 1.00 | H |
| ATOM | 1873 | HG | LEU | A | 1093 | 1.492 | −13.012 | −4.182 | 1.00 | 1.00 | H |
| ATOM | 1874 | HD21 | LEU | A | 1093 | −1.561 | −12.336 | −4.542 | 1.00 | 1.00 | H |
| ATOM | 1875 | HD22 | LEU | A | 1093 | −0.580 | −13.503 | −5.539 | 1.00 | 1.00 | H |
| ATOM | 1876 | HD23 | LEU | A | 1093 | −0.845 | −13.812 | −3.857 | 1.00 | 1.00 | H |
| ATOM | 1877 | HD11 | LEU | A | 1093 | 1.501 | −11.650 | −2.236 | 1.00 | 1.00 | H |
| ATOM | 1878 | HD12 | LEU | A | 1093 | −0.173 | −11.132 | −2.450 | 1.00 | 1.00 | H |
| ATOM | 1879 | HD13 | LEU | A | 1093 | 0.286 | −12.792 | −2.071 | 1.00 | 1.00 | H |
| ATOM | 1880 | HN | LEU | A | 1093 | 1.401 | −10.426 | −8.266 | 1.00 | 1.00 | H |
| ATOM | 1881 | N | HIS | A | 1094 | 3.958 | −12.140 | −5.941 | 1.00 | 1.00 | N |
| ATOM | 1882 | CA | HIS | A | 1094 | 5.150 | −13.032 | −5.808 | 1.00 | 1.00 | C |
| ATOM | 1883 | C | HIS | A | 1094 | 6.114 | −12.377 | −4.787 | 1.00 | 1.00 | C |
| ATOM | 1884 | O | HIS | A | 1094 | 5.943 | −11.231 | −4.382 | 1.00 | 1.00 | O |
| ATOM | 1885 | CB | HIS | A | 1094 | 5.843 | −13.047 | −7.215 | 1.00 | 1.00 | C |
| ATOM | 1886 | CG | HIS | A | 1094 | 5.770 | −14.403 | −7.842 | 1.00 | 1.00 | C |
| ATOM | 1887 | ND1 | HIS | A | 1094 | 4.678 | −15.116 | −7.931 | 1.00 | 1.00 | N |
| ATOM | 1888 | CD2 | HIS | A | 1094 | 6.798 | −15.099 | −8.386 | 1.00 | 1.00 | C |
| ATOM | 1889 | CE1 | HIS | A | 1094 | 4.914 | −16.253 | −8.498 | 1.00 | 1.00 | C |
| ATOM | 1890 | NE2 | HIS | A | 1094 | 6.127 | −16.315 | −8.758 | 1.00 | 1.00 | N |
| ATOM | 1891 | HA | HIS | A | 1094 | 4.865 | −14.054 | −5.456 | 1.00 | 1.00 | H |
| ATOM | 1892 | HB1 | HIS | A | 1094 | 6.862 | −12.641 | −7.126 | 1.00 | 1.00 | H |
| ATOM | 1893 | HB2 | HIS | A | 1094 | 5.214 | −12.421 | −7.947 | 1.00 | 1.00 | H |
| ATOM | 1894 | HD2 | HIS | A | 1094 | 7.888 | −14.807 | −8.478 | 1.00 | 1.00 | H |
| ATOM | 1895 | HE1 | HIS | A | 1094 | 4.208 | −17.033 | −8.741 | 1.00 | 1.00 | H |
| ATOM | 1896 | HD1 | HIS | A | 1094 | 3.776 | −14.717 | −7.645 | 1.00 | 1.00 | H |
| ATOM | 1897 | HN | HIS | A | 1094 | 4.036 | −11.130 | −5.778 | 1.00 | 1.00 | H |
| ATOM | 1898 | N | PRO | A | 1095 | 7.166 | −13.095 | −4.298 | 1.00 | 1.00 | N |
| ATOM | 1899 | CA | PRO | A | 1095 | 8.168 | −12.401 | −3.496 | 1.00 | 1.00 | C |
| ATOM | 1900 | C | PRO | A | 1095 | 8.949 | −11.518 | −4.465 | 1.00 | 1.00 | C |
| ATOM | 1901 | O | PRO | A | 1095 | 10.075 | −11.840 | −4.828 | 1.00 | 1.00 | O |
| ATOM | 1902 | CB | PRO | A | 1095 | 9.090 | −13.609 | −3.025 | 1.00 | 1.00 | C |
| ATOM | 1903 | CG | PRO | A | 1095 | 8.823 | −14.749 | −4.054 | 1.00 | 1.00 | C |
| ATOM | 1904 | CD | PRO | A | 1095 | 7.402 | −14.492 | −4.649 | 1.00 | 1.00 | C |
| ATOM | 1905 | HA | PRO | A | 1095 | 7.772 | −11.735 | −2.693 | 1.00 | 1.00 | H |
| ATOM | 1906 | HD2 | PRO | A | 1095 | 6.755 | −15.160 | −4.095 | 1.00 | 1.00 | H |
| ATOM | 1907 | HD1 | PRO | A | 1095 | 7.489 | −14.813 | −5.720 | 1.00 | 1.00 | H |
| ATOM | 1908 | HG2 | PRO | A | 1095 | 9.088 | −15.792 | −3.769 | 1.00 | 1.00 | H |
| ATOM | 1909 | HG1 | PRO | A | 1095 | 9.530 | −14.431 | −4.828 | 1.00 | 1.00 | H |
| ATOM | 1910 | HB1 | PRO | A | 1095 | 8.715 | −13.957 | −2.046 | 1.00 | 1.00 | H |
| ATOM | 1911 | HB2 | PRO | A | 1095 | 10.120 | −13.316 | −2.847 | 1.00 | 1.00 | H |
| ATOM | 1912 | N | ALA | A | 1096 | 8.348 | −10.386 | −4.929 | 1.00 | 1.00 | N |
| ATOM | 1913 | CA | ALA | A | 1096 | 9.193 | −9.454 | −5.715 | 1.00 | 1.00 | C |
| ATOM | 1914 | C | ALA | A | 1096 | 8.524 | −8.133 | −5.936 | 1.00 | 1.00 | C |
| ATOM | 1915 | O | ALA | A | 1096 | 8.643 | −7.596 | −7.005 | 1.00 | 1.00 | O |
| ATOM | 1916 | CB | ALA | A | 1096 | 9.412 | −10.166 | −7.068 | 1.00 | 1.00 | C |
| ATOM | 1917 | HA | ALA | A | 1096 | 10.107 | −9.169 | −5.198 | 1.00 | 1.00 | H |
| ATOM | 1918 | HB1 | ALA | A | 1096 | 9.896 | −9.528 | −7.790 | 1.00 | 1.00 | H |
| ATOM | 1919 | HB2 | ALA | A | 1096 | 10.054 | −11.099 | −7.029 | 1.00 | 1.00 | H |
| ATOM | 1920 | HB3 | ALA | A | 1096 | 8.367 | −10.398 | −7.377 | 1.00 | 1.00 | H |
| ATOM | 1921 | HN | ALA | A | 1096 | 7.416 | −10.166 | −4.670 | 1.00 | 1.00 | H |
| ATOM | 1922 | N | ALA | A | 1097 | 7.941 | −7.531 | −4.899 | 1.00 | 1.00 | N |
| ATOM | 1923 | CA | ALA | A | 1097 | 7.477 | −6.130 | −5.084 | 1.00 | 1.00 | C |
| ATOM | 1924 | C | ALA | A | 1097 | 8.756 | −5.383 | −4.881 | 1.00 | 1.00 | C |
| ATOM | 1925 | O | ALA | A | 1097 | 8.986 | −4.961 | −3.734 | 1.00 | 1.00 | O |
| ATOM | 1926 | CB | ALA | A | 1097 | 6.395 | −5.751 | −4.057 | 1.00 | 1.00 | C |
| ATOM | 1927 | HA | ALA | A | 1097 | 7.158 | −5.902 | −6.122 | 1.00 | 1.00 | H |
| ATOM | 1928 | HB1 | ALA | A | 1097 | 6.000 | −4.713 | −4.125 | 1.00 | 1.00 | H |
| ATOM | 1929 | HB2 | ALA | A | 1097 | 5.566 | −6.449 | −4.097 | 1.00 | 1.00 | H |
| ATOM | 1930 | HB3 | ALA | A | 1097 | 6.761 | −5.823 | −2.990 | 1.00 | 1.00 | H |
| ATOM | 1931 | HN | ALA | A | 1097 | 7.984 | −7.895 | −3.955 | 1.00 | 1.00 | H |
| ATOM | 1932 | N | MET | A | 1098 | 9.590 | −5.193 | −5.898 | 1.00 | 1.00 | N |
| ATOM | 1933 | CA | MET | A | 1098 | 10.943 | −4.773 | −5.549 | 1.00 | 1.00 | C |
| ATOM | 1934 | C | MET | A | 1098 | 11.757 | −4.353 | −6.768 | 1.00 | 1.00 | C |
| ATOM | 1935 | O | MET | A | 1098 | 12.161 | −3.222 | −6.640 | 1.00 | 1.00 | O |
| ATOM | 1936 | CB | MET | A | 1098 | 11.620 | −5.915 | −4.732 | 1.00 | 1.00 | C |
| ATOM | 1937 | CG | MET | A | 1098 | 13.096 | −5.667 | −4.462 | 1.00 | 1.00 | C |
| ATOM | 1938 | SD | MET | A | 1098 | 14.114 | −5.995 | −5.888 | 1.00 | 1.00 | S |
| ATOM | 1939 | CE | MET | A | 1098 | 15.724 | −5.816 | −5.040 | 1.00 | 1.00 | C |
| ATOM | 1940 | HA | MET | A | 1098 | 10.829 | −3.853 | −4.943 | 1.00 | 1.00 | H |
| ATOM | 1941 | HB1 | MET | A | 1098 | 11.496 | −6.913 | −5.180 | 1.00 | 1.00 | H |
| ATOM | 1942 | HB2 | MET | A | 1098 | 11.141 | −5.917 | −3.750 | 1.00 | 1.00 | H |
| ATOM | 1943 | HG1 | MET | A | 1098 | 13.220 | −4.645 | −4.134 | 1.00 | 1.00 | H |
| ATOM | 1944 | HG2 | MET | A | 1098 | 13.429 | −6.338 | −3.646 | 1.00 | 1.00 | H |
| ATOM | 1945 | HE1 | MET | A | 1098 | 15.839 | −6.469 | −4.193 | 1.00 | 1.00 | H |
| ATOM | 1946 | HE2 | MET | A | 1098 | 16.497 | −6.028 | −5.750 | 1.00 | 1.00 | H |
| ATOM | 1947 | HE3 | MET | A | 1098 | 15.787 | −4.777 | −4.598 | 1.00 | 1.00 | H |
| ATOM | 1948 | HN | MET | A | 1098 | 9.324 | −5.528 | −6.797 | 1.00 | 1.00 | H |
| ATOM | 1949 | N | PRO | A | 1099 | 12.078 | −5.082 | −7.918 | 1.00 | 1.00 | N |
| ATOM | 1950 | CA | PRO | A | 1099 | 12.964 | −4.480 | −8.869 | 1.00 | 1.00 | C |
| ATOM | 1951 | C | PRO | A | 1099 | 12.765 | −3.045 | −9.345 | 1.00 | 1.00 | C |
| ATOM | 1952 | O | PRO | A | 1099 | 13.725 | −2.269 | −9.201 | 1.00 | 1.00 | O |
| ATOM | 1953 | CB | PRO | A | 1099 | 12.933 | −5.559 | −9.984 | 1.00 | 1.00 | C |
| ATOM | 1954 | CG | PRO | A | 1099 | 12.548 | −6.909 | −9.282 | 1.00 | 1.00 | C |
| ATOM | 1955 | CD | PRO | A | 1099 | 11.563 | −6.436 | −8.190 | 1.00 | 1.00 | C |
| ATOM | 1956 | HA | PRO | A | 1099 | 13.955 | −4.462 | −8.331 | 1.00 | 1.00 | H |
| ATOM | 1957 | HD2 | PRO | A | 1099 | 10.569 | −6.455 | −8.620 | 1.00 | 1.00 | H |
| ATOM | 1958 | HD1 | PRO | A | 1099 | 11.625 | −7.213 | −7.388 | 1.00 | 1.00 | H |
| ATOM | 1959 | HG2 | PRO | A | 1099 | 13.435 | −7.364 | −8.825 | 1.00 | 1.00 | H |
| ATOM | 1960 | HG1 | PRO | A | 1099 | 12.126 | −7.633 | −9.994 | 1.00 | 1.00 | H |
| ATOM | 1961 | HB1 | PRO | A | 1099 | 12.188 | −5.404 | −10.766 | 1.00 | 1.00 | H |
| ATOM | 1962 | HB2 | PRO | A | 1099 | 13.860 | −5.613 | −10.533 | 1.00 | 1.00 | H |
| ATOM | 1963 | N | HIS | A | 1100 | 11.613 | −2.563 | −9.875 | 1.00 | 1.00 | N |
| ATOM | 1964 | CA | HIS | A | 1100 | 10.370 | −3.347 | −10.064 | 1.00 | 1.00 | C |
| ATOM | 1965 | C | HIS | A | 1100 | 10.313 | −3.602 | −11.518 | 1.00 | 1.00 | C |
| ATOM | 1966 | O | HIS | A | 1100 | 10.715 | −2.796 | −12.332 | 1.00 | 1.00 | O |
| ATOM | 1967 | CB | HIS | A | 1100 | 9.130 | −2.485 | −9.611 | 1.00 | 1.00 | C |
| ATOM | 1968 | CG | HIS | A | 1100 | 7.828 | −3.147 | −9.907 | 1.00 | 1.00 | C |
| ATOM | 1969 | ND1 | HIS | A | 1100 | 7.276 | −4.121 | −9.235 | 1.00 | 1.00 | N |
| ATOM | 1970 | CD2 | HIS | A | 1100 | 6.995 | −2.806 | −10.896 | 1.00 | 1.00 | C |
| ATOM | 1971 | CE1 | HIS | A | 1100 | 6.115 | −4.425 | −9.738 | 1.00 | 1.00 | C |
| ATOM | 1972 | NE2 | HIS | A | 1100 | 5.876 | −3.721 | −10.753 | 1.00 | 1.00 | N |
| ATOM | 1973 | HA | HIS | A | 1100 | 10.301 | −4.270 | −9.498 | 1.00 | 1.00 | H |
| ATOM | 1974 | HB1 | HIS | A | 1100 | 9.022 | −1.488 | −10.110 | 1.00 | 1.00 | H |
| ATOM | 1975 | HB2 | HIS | A | 1100 | 9.274 | −2.271 | −8.529 | 1.00 | 1.00 | H |
| ATOM | 1976 | HD2 | HIS | A | 1100 | 7.198 | −2.024 | −11.608 | 1.00 | 1.00 | H |
| ATOM | 1977 | HE1 | HIS | A | 1100 | 5.403 | −5.126 | −9.381 | 1.00 | 1.00 | H |
| ATOM | 1978 | HD1 | HIS | A | 1100 | 7.646 | −4.498 | −8.335 | 1.00 | 1.00 | H |
| ATOM | 1979 | HN | HIS | A | 1100 | 11.669 | −1.604 | −10.247 | 1.00 | 1.00 | H |
| ATOM | 1980 | N | LEU | A | 1101 | 9.803 | −4.799 | −11.966 | 1.00 | 1.00 | N |
| ATOM | 1981 | CA | LEU | A | 1101 | 9.774 | −5.140 | −13.423 | 1.00 | 1.00 | C |
| ATOM | 1982 | C | LEU | A | 1101 | 8.608 | −6.009 | −13.780 | 1.00 | 1.00 | C |
| ATOM | 1983 | O | LEU | A | 1101 | 8.877 | −7.053 | −14.342 | 1.00 | 1.00 | O |
| ATOM | 1984 | CB | LEU | A | 1101 | 11.194 | −5.679 | −13.669 | 1.00 | 1.00 | C |
| ATOM | 1985 | CG | LEU | A | 1101 | 11.562 | −6.050 | −15.134 | 1.00 | 1.00 | C |
| ATOM | 1986 | CD1 | LEU | A | 1101 | 11.631 | −4.733 | −15.996 | 1.00 | 1.00 | C |
| ATOM | 1987 | CD2 | LEU | A | 1101 | 12.999 | −6.668 | −15.146 | 1.00 | 1.00 | C |
| ATOM | 1988 | HA | LEU | A | 1101 | 9.683 | −4.231 | −14.079 | 1.00 | 1.00 | H |
| ATOM | 1989 | HB1 | LEU | A | 1101 | 11.381 | −6.545 | −12.971 | 1.00 | 1.00 | H |
| ATOM | 1990 | HB2 | LEU | A | 1101 | 11.926 | −4.942 | −13.286 | 1.00 | 1.00 | H |
| ATOM | 1991 | HG | LEU | A | 1101 | 10.849 | −6.784 | −15.543 | 1.00 | 1.00 | H |
| ATOM | 1992 | HD21 | LEU | A | 1101 | 13.729 | −6.052 | −14.526 | 1.00 | 1.00 | H |
| ATOM | 1993 | HD22 | LEU | A | 1101 | 12.896 | −7.666 | −14.661 | 1.00 | 1.00 | H |
| ATOM | 1994 | HD23 | LEU | A | 1101 | 13.429 | −6.768 | −16.191 | 1.00 | 1.00 | H |
| ATOM | 1995 | HD11 | LEU | A | 1101 | 10.673 | −4.215 | −16.025 | 1.00 | 1.00 | H |
| ATOM | 1996 | HD12 | LEU | A | 1101 | 12.368 | −4.046 | −15.550 | 1.00 | 1.00 | H |
| ATOM | 1997 | HD13 | LEU | A | 1101 | 11.848 | −4.956 | −17.020 | 1.00 | 1.00 | H |
| ATOM | 1998 | HN | LEU | A | 1101 | 9.601 | −5.577 | −11.415 | 1.00 | 1.00 | H |
| ATOM | 1999 | N | LEU | A | 1102 | 7.373 | −5.552 | −13.390 | 1.00 | 1.00 | N |
| ATOM | 2000 | CA | LEU | A | 1102 | 6.202 | −6.364 | −13.741 | 1.00 | 1.00 | C |
| ATOM | 2001 | C | LEU | A | 1102 | 5.805 | −6.124 | −15.209 | 1.00 | 1.00 | C |
| ATOM | 2002 | O | LEU | A | 1102 | 5.408 | −4.991 | −15.419 | 1.00 | 1.00 | O |
| ATOM | 2003 | CB | LEU | A | 1102 | 4.997 | −5.992 | −12.804 | 1.00 | 1.00 | C |
| ATOM | 2004 | CG | LEU | A | 1102 | 3.655 | −6.723 | −13.169 | 1.00 | 1.00 | C |
| ATOM | 2005 | CD1 | LEU | A | 1102 | 3.715 | −8.290 | −13.243 | 1.00 | 1.00 | C |
| ATOM | 2006 | CD2 | LEU | A | 1102 | 2.570 | −6.309 | −12.150 | 1.00 | 1.00 | C |
| ATOM | 2007 | HA | LEU | A | 1102 | 6.469 | −7.426 | −13.627 | 1.00 | 1.00 | H |
| ATOM | 2008 | HB1 | LEU | A | 1102 | 4.865 | −4.886 | −12.897 | 1.00 | 1.00 | H |
| ATOM | 2009 | HB2 | LEU | A | 1102 | 5.326 | −6.317 | −11.819 | 1.00 | 1.00 | H |
| ATOM | 2010 | HG | LEU | A | 1102 | 3.306 | −6.365 | −14.186 | 1.00 | 1.00 | H |
| ATOM | 2011 | HD21 | LEU | A | 1102 | 2.846 | −6.751 | −11.166 | 1.00 | 1.00 | H |
| ATOM | 2012 | HD22 | LEU | A | 1102 | 2.527 | −5.210 | −12.093 | 1.00 | 1.00 | H |
| ATOM | 2013 | HD23 | LEU | A | 1102 | 1.599 | −6.753 | −12.410 | 1.00 | 1.00 | H |
| ATOM | 2014 | HD11 | LEU | A | 1102 | 2.830 | −8.690 | −13.775 | 1.00 | 1.00 | H |
| ATOM | 2015 | HD12 | LEU | A | 1102 | 4.592 | −8.547 | −13.880 | 1.00 | 1.00 | H |
| ATOM | 2016 | HD13 | LEU | A | 1102 | 3.878 | −8.818 | −12.305 | 1.00 | 1.00 | H |
| ATOM | 2017 | HN | LEU | A | 1102 | 7.327 | −4.708 | −12.845 | 1.00 | 1.00 | H |
| ATOM | 2018 | N | VAL | A | 1103 | 5.893 | −7.139 | −16.130 | 1.00 | 1.00 | N |
| ATOM | 2019 | CA | VAL | A | 1103 | 5.352 | −6.960 | −17.468 | 1.00 | 1.00 | C |
| ATOM | 2020 | C | VAL | A | 1103 | 4.650 | −8.238 | −17.904 | 1.00 | 1.00 | C |
| ATOM | 2021 | O | VAL | A | 1103 | 5.362 | −9.265 | −17.842 | 1.00 | 1.00 | O |
| ATOM | 2022 | CB | VAL | A | 1103 | 6.441 | −6.547 | −18.503 | 1.00 | 1.00 | C |
| ATOM | 2023 | CG1 | VAL | A | 1103 | 7.538 | −5.652 | −17.852 | 1.00 | 1.00 | C |
| ATOM | 2024 | CG2 | VAL | A | 1103 | 5.828 | −5.807 | −19.745 | 1.00 | 1.00 | C |
| ATOM | 2025 | HA | VAL | A | 1103 | 4.640 | −6.127 | −17.468 | 1.00 | 1.00 | H |
| ATOM | 2026 | HB | VAL | A | 1103 | 7.007 | −7.448 | −18.815 | 1.00 | 1.00 | H |
| ATOM | 2027 | HG11 | VAL | A | 1103 | 8.044 | −6.139 | −16.994 | 1.00 | 1.00 | H |
| ATOM | 2028 | HG12 | VAL | A | 1103 | 8.345 | −5.577 | −18.662 | 1.00 | 1.00 | H |
| ATOM | 2029 | HG13 | VAL | A | 1103 | 7.202 | −4.633 | −17.574 | 1.00 | 1.00 | H |
| ATOM | 2030 | HG21 | VAL | A | 1103 | 5.518 | −4.791 | −19.489 | 1.00 | 1.00 | H |
| ATOM | 2031 | HG22 | VAL | A | 1103 | 6.579 | −5.695 | −20.499 | 1.00 | 1.00 | H |
| ATOM | 2032 | HG23 | VAL | A | 1103 | 4.967 | −6.347 | −20.143 | 1.00 | 1.00 | H |
| ATOM | 2033 | HN | VAL | A | 1103 | 6.308 | −8.016 | −15.894 | 1.00 | 1.00 | H |
| ATOM | 2034 | N | GLY | A | 1104 | 3.316 | −8.171 | −18.274 | 1.00 | 1.00 | N |
| ATOM | 2035 | CA | GLY | A | 1104 | 2.623 | −9.405 | −18.555 | 1.00 | 1.00 | C |
| ATOM | 2036 | C | GLY | A | 1104 | 1.494 | −9.336 | −19.560 | 1.00 | 1.00 | C |
| ATOM | 2037 | O | GLY | A | 1104 | 1.287 | −8.270 | −20.132 | 1.00 | 1.00 | O |
| ATOM | 2038 | HA2 | GLY | A | 1104 | 2.108 | −9.666 | −17.612 | 1.00 | 1.00 | H |
| ATOM | 2039 | HA1 | GLY | A | 1104 | 3.350 | −10.202 | −18.649 | 1.00 | 1.00 | H |
| ATOM | 2040 | HN | GLY | A | 1104 | 2.811 | −7.350 | −18.379 | 1.00 | 1.00 | H |
| ATOM | 2041 | N | SER | A | 1105 | 0.740 | −10.471 | −19.715 | 1.00 | 1.00 | N |
| ATOM | 2042 | CA | SER | A | 1105 | −0.428 | −10.562 | −20.573 | 1.00 | 1.00 | C |
| ATOM | 2043 | C | SER | A | 1105 | −0.081 | −11.052 | −21.934 | 1.00 | 1.00 | C |
| ATOM | 2044 | O | SER | A | 1105 | 0.900 | −10.626 | −22.551 | 1.00 | 1.00 | O |
| ATOM | 2045 | CB | SER | A | 1105 | −1.165 | −9.239 | −20.825 | 1.00 | 1.00 | C |
| ATOM | 2046 | OG | SER | A | 1105 | −2.512 | −9.361 | −21.310 | 1.00 | 1.00 | O |
| ATOM | 2047 | HA | SER | A | 1105 | −1.161 | −11.250 | −20.130 | 1.00 | 1.00 | H |
| ATOM | 2048 | HB1 | SER | A | 1105 | −0.675 | −8.574 | −21.603 | 1.00 | 1.00 | H |
| ATOM | 2049 | HB2 | SER | A | 1105 | −1.138 | −8.677 | −19.920 | 1.00 | 1.00 | H |
| ATOM | 2050 | HG | SER | A | 1105 | −3.048 | −9.856 | −20.708 | 1.00 | 1.00 | H |
| ATOM | 2051 | HN | SER | A | 1105 | 0.947 | −11.329 | −19.170 | 1.00 | 1.00 | H |
| ATOM | 2052 | N | SER | A | 1106 | −0.906 | −11.991 | −22.459 | 1.00 | 1.00 | N |
| ATOM | 2053 | CA | SER | A | 1106 | −0.613 | −12.527 | −23.801 | 1.00 | 1.00 | C |
| ATOM | 2054 | C | SER | A | 1106 | 0.755 | −13.156 | −23.889 | 1.00 | 1.00 | C |
| ATOM | 2055 | O | SER | A | 1106 | 1.721 | −12.531 | −24.311 | 1.00 | 1.00 | O |
| ATOM | 2056 | CB | SER | A | 1106 | −0.811 | −11.453 | −24.904 | 1.00 | 1.00 | C |
| ATOM | 2057 | OG | SER | A | 1106 | −0.531 | −11.976 | −26.238 | 1.00 | 1.00 | O |
| ATOM | 2058 | HA | SER | A | 1106 | −1.293 | −13.330 | −24.064 | 1.00 | 1.00 | H |
| ATOM | 2059 | HB1 | SER | A | 1106 | −0.206 | −10.577 | −24.705 | 1.00 | 1.00 | H |
| ATOM | 2060 | HB2 | SER | A | 1106 | −1.882 | −11.053 | −24.886 | 1.00 | 1.00 | H |
| ATOM | 2061 | HG | SER | A | 1106 | 0.399 | −11.980 | −26.374 | 1.00 | 1.00 | H |
| ATOM | 2062 | HN | SER | A | 1106 | −1.677 | −12.383 | −21.914 | 1.00 | 1.00 | H |
| ATOM | 2063 | N | GLY | A | 1107 | 0.834 | −14.467 | −23.457 | 1.00 | 1.00 | N |
| ATOM | 2064 | CA | GLY | A | 1107 | 2.148 | −15.200 | −23.460 | 1.00 | 1.00 | C |
| ATOM | 2065 | C | GLY | A | 1107 | 2.868 | −15.166 | −22.152 | 1.00 | 1.00 | C |
| ATOM | 2066 | O | GLY | A | 1107 | 3.780 | −14.350 | −22.076 | 1.00 | 1.00 | O |
| ATOM | 2067 | HA2 | GLY | A | 1107 | 2.893 | −14.810 | −24.169 | 1.00 | 1.00 | H |
| ATOM | 2068 | HA1 | GLY | A | 1107 | 1.921 | −16.239 | −23.777 | 1.00 | 1.00 | H |
| ATOM | 2069 | HN | GLY | A | 1107 | −0.009 | −14.964 | −23.187 | 1.00 | 1.00 | H |
| ATOM | 2070 | N | LEU | A | 1108 | 2.642 | −16.087 | −21.177 | 1.00 | 1.00 | N |
| ATOM | 2071 | CA | LEU | A | 1108 | 3.579 | −16.164 | −20.056 | 1.00 | 1.00 | C |
| ATOM | 2072 | C | LEU | A | 1108 | 5.018 | −16.420 | −20.504 | 1.00 | 1.00 | C |
| ATOM | 2073 | O | LEU | A | 1108 | 5.920 | −15.749 | −20.009 | 1.00 | 1.00 | O |
| ATOM | 2074 | CB | LEU | A | 1108 | 3.175 | −17.126 | −18.938 | 1.00 | 1.00 | C |
| ATOM | 2075 | CG | LEU | A | 1108 | 4.178 | −17.250 | −17.744 | 1.00 | 1.00 | C |
| ATOM | 2076 | CD1 | LEU | A | 1108 | 4.582 | −15.938 | −17.124 | 1.00 | 1.00 | C |
| ATOM | 2077 | CD2 | LEU | A | 1108 | 3.647 | −18.262 | −16.639 | 1.00 | 1.00 | C |
| ATOM | 2078 | HA | LEU | A | 1108 | 3.584 | −15.177 | −19.627 | 1.00 | 1.00 | H |
| ATOM | 2079 | HB1 | LEU | A | 1108 | 2.939 | −18.151 | −19.405 | 1.00 | 1.00 | H |
| ATOM | 2080 | HB2 | LEU | A | 1108 | 2.171 | −16.868 | −18.569 | 1.00 | 1.00 | H |
| ATOM | 2081 | HG | LEU | A | 1108 | 5.082 | −17.775 | −18.188 | 1.00 | 1.00 | H |
| ATOM | 2082 | HD21 | LEU | A | 1108 | 4.419 | −18.534 | −15.870 | 1.00 | 1.00 | H |
| ATOM | 2083 | HD22 | LEU | A | 1108 | 3.337 | −19.173 | −17.105 | 1.00 | 1.00 | H |
| ATOM | 2084 | HD23 | LEU | A | 1108 | 2.773 | −17.777 | −16.140 | 1.00 | 1.00 | H |
| ATOM | 2085 | HD11 | LEU | A | 1108 | 5.218 | −15.347 | −17.732 | 1.00 | 1.00 | H |
| ATOM | 2086 | HD12 | LEU | A | 1108 | 5.079 | −16.095 | −16.169 | 1.00 | 1.00 | H |
| ATOM | 2087 | HD13 | LEU | A | 1108 | 3.606 | −15.346 | −17.011 | 1.00 | 1.00 | H |
| ATOM | 2088 | HN | LEU | A | 1108 | 1.880 | −16.708 | −21.231 | 1.00 | 1.00 | H |
| ATOM | 2089 | N | SER | A | 1109 | 5.179 | −17.447 | −21.378 | 1.00 | 1.00 | N |
| ATOM | 2090 | CA | SER | A | 1109 | 6.501 | −17.943 | −21.779 | 1.00 | 1.00 | C |
| ATOM | 2091 | C | SER | A | 1109 | 7.471 | −16.769 | −22.032 | 1.00 | 1.00 | C |
| ATOM | 2092 | O | SER | A | 1109 | 8.529 | −16.663 | −21.417 | 1.00 | 1.00 | O |
| ATOM | 2093 | CB | SER | A | 1109 | 6.448 | −18.887 | −23.032 | 1.00 | 1.00 | C |
| ATOM | 2094 | OG | SER | A | 1109 | 5.855 | −18.239 | −24.245 | 1.00 | 1.00 | O |
| ATOM | 2095 | HA | SER | A | 1109 | 6.871 | −18.496 | −20.883 | 1.00 | 1.00 | H |
| ATOM | 2096 | HB1 | SER | A | 1109 | 5.883 | −19.834 | −22.877 | 1.00 | 1.00 | H |
| ATOM | 2097 | HB2 | SER | A | 1109 | 7.516 | −19.105 | −23.232 | 1.00 | 1.00 | H |
| ATOM | 2098 | HG | SER | A | 1109 | 4.902 | −18.129 | −24.201 | 1.00 | 1.00 | H |
| ATOM | 2099 | HN | SER | A | 1109 | 4.389 | −17.950 | −21.734 | 1.00 | 1.00 | H |
| ATOM | 2100 | N | ARG | A | 1110 | 7.044 | −15.860 | −22.938 | 1.00 | 1.00 | N |
| ATOM | 2101 | CA | ARG | A | 1110 | 7.995 | −14.781 | −23.302 | 1.00 | 1.00 | C |
| ATOM | 2102 | C | ARG | A | 1110 | 8.407 | −13.958 | −22.095 | 1.00 | 1.00 | C |
| ATOM | 2103 | O | ARG | A | 1110 | 9.516 | −13.495 | −22.030 | 1.00 | 1.00 | O |
| ATOM | 2104 | CB | ARG | A | 1110 | 7.449 | −13.889 | −24.446 | 1.00 | 1.00 | C |
| ATOM | 2105 | CG | ARG | A | 1110 | 6.230 | −13.004 | −23.921 | 1.00 | 1.00 | C |
| ATOM | 2106 | CD | ARG | A | 1110 | 5.392 | −12.497 | −25.161 | 1.00 | 1.00 | C |
| ATOM | 2107 | NE | ARG | A | 1110 | 4.170 | −11.868 | −24.603 | 1.00 | 1.00 | N |
| ATOM | 2108 | CZ | ARG | A | 1110 | 4.093 | −10.624 | −24.167 | 1.00 | 1.00 | C |
| ATOM | 2109 | NH1 | ARG | A | 1110 | 5.108 | −9.796 | −24.145 | 1.00 | 1.00 | N |
| ATOM | 2110 | NH2 | ARG | A | 1110 | 2.909 | −10.249 | −23.737 | 1.00 | 1.00 | N |
| ATOM | 2111 | HA | ARG | A | 1110 | 8.906 | −15.239 | −23.622 | 1.00 | 1.00 | H |
| ATOM | 2112 | HB1 | ARG | A | 1110 | 7.101 | −14.509 | −25.280 | 1.00 | 1.00 | H |
| ATOM | 2113 | HB2 | ARG | A | 1110 | 8.292 | −13.240 | −24.783 | 1.00 | 1.00 | H |
| ATOM | 2114 | HG1 | ARG | A | 1110 | 6.660 | −12.177 | −23.272 | 1.00 | 1.00 | H |
| ATOM | 2115 | HG2 | ARG | A | 1110 | 5.619 | −13.682 | −23.244 | 1.00 | 1.00 | H |
| ATOM | 2116 | HD1 | ARG | A | 1110 | 5.078 | −13.396 | −25.651 | 1.00 | 1.00 | H |
| ATOM | 2117 | HD2 | ARG | A | 1110 | 6.059 | −11.951 | −25.810 | 1.00 | 1.00 | H |
| ATOM | 2118 | HE | ARG | A | 1110 | 3.317 | −12.385 | −24.612 | 1.00 | 1.00 | H |
| ATOM | 2119 | HH12 | ARG | A | 1110 | 5.000 | −8.791 | −23.750 | 1.00 | 1.00 | H |
| ATOM | 2120 | HH11 | ARG | A | 1110 | 6.015 | −10.113 | −24.453 | 1.00 | 1.00 | H |
| ATOM | 2121 | HH22 | ARG | A | 1110 | 2.759 | −9.310 | −23.318 | 1.00 | 1.00 | H |
| ATOM | 2122 | HH21 | ARG | A | 1110 | 2.046 | −10.875 | −23.741 | 1.00 | 1.00 | H |
| ATOM | 2123 | HN | ARG | A | 1110 | 6.157 | −15.980 | −23.374 | 1.00 | 1.00 | H |
| ATOM | 2124 | N | TYR | A | 1111 | 7.555 | −13.748 | −21.089 | 1.00 | 1.00 | N |
| ATOM | 2125 | CA | TYR | A | 1111 | 8.038 | −13.153 | −19.828 | 1.00 | 1.00 | C |
| ATOM | 2126 | C | TYR | A | 1111 | 9.068 | −13.981 | −19.133 | 1.00 | 1.00 | C |
| ATOM | 2127 | O | TYR | A | 1111 | 10.226 | −13.596 | −19.009 | 1.00 | 1.00 | O |
| ATOM | 2128 | CB | TYR | A | 1111 | 6.902 | −12.605 | −18.931 | 1.00 | 1.00 | C |
| ATOM | 2129 | CG | TYR | A | 1111 | 6.056 | −11.608 | −19.776 | 1.00 | 1.00 | C |
| ATOM | 2130 | CD1 | TYR | A | 1111 | 6.563 | −10.342 | −20.080 | 1.00 | 1.00 | C |
| ATOM | 2131 | CD2 | TYR | A | 1111 | 4.821 | −11.960 | −20.304 | 1.00 | 1.00 | C |
| ATOM | 2132 | CE1 | TYR | A | 1111 | 5.824 | −9.389 | −20.773 | 1.00 | 1.00 | C |
| ATOM | 2133 | CE2 | TYR | A | 1111 | 4.081 | −11.041 | −21.058 | 1.00 | 1.00 | C |
| ATOM | 2134 | CZ | TYR | A | 1111 | 4.529 | −9.704 | −21.240 | 1.00 | 1.00 | C |
| ATOM | 2135 | OH | TYR | A | 1111 | 3.712 | −8.761 | −21.876 | 1.00 | 1.00 | O |
| ATOM | 2136 | HA | TYR | A | 1111 | 8.570 | −12.216 | −20.191 | 1.00 | 1.00 | H |
| ATOM | 2137 | HB2 | TYR | A | 1111 | 7.301 | −12.047 | −18.068 | 1.00 | 1.00 | H |
| ATOM | 2138 | HB1 | TYR | A | 1111 | 6.309 | −13.431 | −18.521 | 1.00 | 1.00 | H |
| ATOM | 2139 | HD2 | TYR | A | 1111 | 4.470 | −12.940 | −20.140 | 1.00 | 1.00 | H |
| ATOM | 2140 | HE2 | TYR | A | 1111 | 3.096 | −11.327 | −21.427 | 1.00 | 1.00 | H |
| ATOM | 2141 | HE1 | TYR | A | 1111 | 6.315 | −8.402 | −21.048 | 1.00 | 1.00 | H |
| ATOM | 2142 | HD1 | TYR | A | 1111 | 7.540 | −10.111 | −19.709 | 1.00 | 1.00 | H |
| ATOM | 2143 | HH | TYR | A | 1111 | 3.720 | −7.931 | −21.402 | 1.00 | 1.00 | H |
| ATOM | 2144 | HN | TYR | A | 1111 | 6.628 | −14.092 | −21.066 | 1.00 | 1.00 | H |
| ATOM | 2145 | N | VAL | A | 1112 | 8.701 | −15.177 | −18.611 | 1.00 | 1.00 | N |
| ATOM | 2146 | CA | VAL | A | 1112 | 9.717 | −16.020 | −17.993 | 1.00 | 1.00 | C |
| ATOM | 2147 | C | VAL | A | 1112 | 10.992 | −16.104 | −18.848 | 1.00 | 1.00 | C |
| ATOM | 2148 | O | VAL | A | 1112 | 12.054 | −15.999 | −18.248 | 1.00 | 1.00 | O |
| ATOM | 2149 | CB | VAL | A | 1112 | 9.156 | −17.435 | −17.801 | 1.00 | 1.00 | C |
| ATOM | 2150 | CG1 | VAL | A | 1112 | 10.312 | −18.429 | −17.378 | 1.00 | 1.00 | C |
| ATOM | 2151 | CG2 | VAL | A | 1112 | 8.123 | −17.507 | −16.676 | 1.00 | 1.00 | C |
| ATOM | 2152 | HA | VAL | A | 1112 | 9.983 | −15.510 | −17.031 | 1.00 | 1.00 | H |
| ATOM | 2153 | HB | VAL | A | 1112 | 8.577 | −17.756 | −18.683 | 1.00 | 1.00 | H |
| ATOM | 2154 | HG11 | VAL | A | 1112 | 10.849 | −18.082 | −16.535 | 1.00 | 1.00 | H |
| ATOM | 2155 | HG12 | VAL | A | 1112 | 11.105 | −18.560 | −18.128 | 1.00 | 1.00 | H |
| ATOM | 2156 | HG13 | VAL | A | 1112 | 9.874 | −19.444 | −17.214 | 1.00 | 1.00 | H |
| ATOM | 2157 | HG21 | VAL | A | 1112 | 7.722 | −18.567 | −16.569 | 1.00 | 1.00 | H |
| ATOM | 2158 | HG22 | VAL | A | 1112 | 7.246 | −16.837 | −16.920 | 1.00 | 1.00 | H |
| ATOM | 2159 | HG23 | VAL | A | 1112 | 8.465 | −17.273 | −15.675 | 1.00 | 1.00 | H |
| ATOM | 2160 | HN | VAL | A | 1112 | 7.748 | −15.499 | −18.677 | 1.00 | 1.00 | H |
| ATOM | 2161 | N | ALA | A | 1113 | 10.940 | −16.236 | −20.181 | 1.00 | 1.00 | N |
| ATOM | 2162 | CA | ALA | A | 1113 | 12.166 | −16.325 | −20.955 | 1.00 | 1.00 | C |
| ATOM | 2163 | C | ALA | A | 1113 | 12.860 | −14.997 | −20.871 | 1.00 | 1.00 | C |
| ATOM | 2164 | O | ALA | A | 1113 | 13.974 | −14.960 | −20.403 | 1.00 | 1.00 | O |
| ATOM | 2165 | CB | ALA | A | 1113 | 11.911 | −16.632 | −22.443 | 1.00 | 1.00 | C |
| ATOM | 2166 | HA | ALA | A | 1113 | 12.767 | −17.170 | −20.580 | 1.00 | 1.00 | H |
| ATOM | 2167 | HB1 | ALA | A | 1113 | 11.445 | −17.600 | −22.574 | 1.00 | 1.00 | H |
| ATOM | 2168 | HB2 | ALA | A | 1113 | 12.870 | −16.646 | −22.949 | 1.00 | 1.00 | H |
| ATOM | 2169 | HB3 | ALA | A | 1113 | 11.323 | −15.833 | −22.943 | 1.00 | 1.00 | H |
| ATOM | 2170 | HN | ALA | A | 1113 | 10.072 | −16.239 | −20.666 | 1.00 | 1.00 | H |
| ATOM | 2171 | N | ARG | A | 1114 | 12.182 | −13.881 | −21.263 | 1.00 | 1.00 | N |
| ATOM | 2172 | CA | ARG | A | 1114 | 12.948 | −12.614 | −21.359 | 1.00 | 1.00 | C |
| ATOM | 2173 | C | ARG | A | 1114 | 12.991 | −11.926 | −19.975 | 1.00 | 1.00 | C |
| ATOM | 2174 | O | ARG | A | 1114 | 14.084 | −11.545 | −19.498 | 1.00 | 1.00 | O |
| ATOM | 2175 | CB | ARG | A | 1114 | 12.330 | −11.664 | −22.424 | 1.00 | 1.00 | C |
| ATOM | 2176 | CG | ARG | A | 1114 | 13.245 | −10.492 | −22.948 | 1.00 | 1.00 | C |
| ATOM | 2177 | CD | ARG | A | 1114 | 13.471 | −9.370 | −21.889 | 1.00 | 1.00 | C |
| ATOM | 2178 | NE | ARG | A | 1114 | 14.445 | −9.687 | −20.798 | 1.00 | 1.00 | N |
| ATOM | 2179 | CZ | ARG | A | 1114 | 14.593 | −8.958 | −19.715 | 1.00 | 1.00 | C |
| ATOM | 2180 | NH1 | ARG | A | 1114 | 13.880 | −7.902 | −19.485 | 1.00 | 1.00 | N |
| ATOM | 2181 | NH2 | ARG | A | 1114 | 15.479 | −9.307 | −18.836 | 1.00 | 1.00 | N |
| ATOM | 2182 | HA | ARG | A | 1114 | 13.973 | −12.832 | −21.666 | 1.00 | 1.00 | H |
| ATOM | 2183 | HB1 | ARG | A | 1114 | 11.332 | −11.238 | −22.114 | 1.00 | 1.00 | H |
| ATOM | 2184 | HB2 | ARG | A | 1114 | 12.140 | −12.314 | −23.314 | 1.00 | 1.00 | H |
| ATOM | 2185 | HG1 | ARG | A | 1114 | 12.702 | −10.056 | −23.810 | 1.00 | 1.00 | H |
| ATOM | 2186 | HG2 | ARG | A | 1114 | 14.204 | −10.823 | −23.358 | 1.00 | 1.00 | H |
| ATOM | 2187 | HD1 | ARG | A | 1114 | 12.503 | −9.216 | −21.478 | 1.00 | 1.00 | H |
| ATOM | 2188 | HD2 | ARG | A | 1114 | 13.802 | −8.449 | −22.363 | 1.00 | 1.00 | H |
| ATOM | 2189 | HE | ARG | A | 1114 | 15.051 | −10.516 | −20.947 | 1.00 | 1.00 | H |
| ATOM | 2190 | HH12 | ARG | A | 1114 | 14.015 | −7.327 | −18.666 | 1.00 | 1.00 | H |
| ATOM | 2191 | HH11 | ARG | A | 1114 | 13.216 | −7.533 | −20.173 | 1.00 | 1.00 | H |
| ATOM | 2192 | HH22 | ARG | A | 1114 | 15.676 | −8.762 | −17.943 | 1.00 | 1.00 | H |
| ATOM | 2193 | HH21 | ARG | A | 1114 | 16.040 | −10.167 | −18.981 | 1.00 | 1.00 | H |
| ATOM | 2194 | HN | ARG | A | 1114 | 11.119 | −13.932 | −21.488 | 1.00 | 1.00 | H |
| ATOM | 2195 | N | LEU | A | 1115 | 11.821 | −11.619 | −19.393 | 1.00 | 1.00 | N |
| ATOM | 2196 | CA | LEU | A | 1115 | 11.791 | −10.973 | −18.095 | 1.00 | 1.00 | C |
| ATOM | 2197 | C | LEU | A | 1115 | 12.716 | −11.707 | −17.199 | 1.00 | 1.00 | C |
| ATOM | 2198 | O | LEU | A | 1115 | 13.669 | −11.099 | −16.724 | 1.00 | 1.00 | O |
| ATOM | 2199 | CB | LEU | A | 1115 | 10.307 | −10.820 | −17.573 | 1.00 | 1.00 | C |
| ATOM | 2200 | CG | LEU | A | 1115 | 10.056 | −9.883 | −16.340 | 1.00 | 1.00 | C |
| ATOM | 2201 | CD1 | LEU | A | 1115 | 8.559 | −9.887 | −15.942 | 1.00 | 1.00 | C |
| ATOM | 2202 | CD2 | LEU | A | 1115 | 11.051 | −10.146 | −15.166 | 1.00 | 1.00 | C |
| ATOM | 2203 | HA | LEU | A | 1115 | 12.199 | −9.971 | −18.211 | 1.00 | 1.00 | H |
| ATOM | 2204 | HB1 | LEU | A | 1115 | 9.883 | −11.795 | −17.215 | 1.00 | 1.00 | H |
| ATOM | 2205 | HB2 | LEU | A | 1115 | 9.681 | −10.484 | −18.410 | 1.00 | 1.00 | H |
| ATOM | 2206 | HG | LEU | A | 1115 | 10.226 | −8.888 | −16.763 | 1.00 | 1.00 | H |
| ATOM | 2207 | HD21 | LEU | A | 1115 | 10.956 | −11.208 | −14.821 | 1.00 | 1.00 | H |
| ATOM | 2208 | HD22 | LEU | A | 1115 | 10.743 | −9.426 | −14.365 | 1.00 | 1.00 | H |
| ATOM | 2209 | HD23 | LEU | A | 1115 | 12.070 | −9.887 | −15.549 | 1.00 | 1.00 | H |
| ATOM | 2210 | HD11 | LEU | A | 1115 | 7.957 | −9.575 | −16.772 | 1.00 | 1.00 | H |
| ATOM | 2211 | HD12 | LEU | A | 1115 | 8.386 | −9.201 | −15.147 | 1.00 | 1.00 | H |
| ATOM | 2212 | HD13 | LEU | A | 1115 | 8.259 | −10.863 | −15.687 | 1.00 | 1.00 | H |
| ATOM | 2213 | HN | LEU | A | 1115 | 10.953 | −11.945 | −19.801 | 1.00 | 1.00 | H |
| ATOM | 2214 | N | SER | A | 1116 | 12.399 | −12.986 | −16.952 | 1.00 | 1.00 | N |
| ATOM | 2215 | CA | SER | A | 1116 | 13.301 | −13.796 | −16.107 | 1.00 | 1.00 | C |
| ATOM | 2216 | C | SER | A | 1116 | 13.378 | −13.340 | −14.652 | 1.00 | 1.00 | C |
| ATOM | 2217 | O | SER | A | 1116 | 13.013 | −14.133 | −13.812 | 1.00 | 1.00 | O |
| ATOM | 2218 | CB | SER | A | 1116 | 14.693 | −13.945 | −16.796 | 1.00 | 1.00 | C |
| ATOM | 2219 | OG | SER | A | 1116 | 15.553 | −14.621 | −15.875 | 1.00 | 1.00 | O |
| ATOM | 2220 | HA | SER | A | 1116 | 12.907 | −14.783 | −16.124 | 1.00 | 1.00 | H |
| ATOM | 2221 | HB1 | SER | A | 1116 | 15.058 | −12.965 | −17.172 | 1.00 | 1.00 | H |
| ATOM | 2222 | HB2 | SER | A | 1116 | 14.656 | −14.554 | −17.749 | 1.00 | 1.00 | H |
| ATOM | 2223 | HG | SER | A | 1116 | 16.378 | −14.895 | −16.258 | 1.00 | 1.00 | H |
| ATOM | 2224 | HN | SER | A | 1116 | 11.688 | −13.529 | −17.462 | 1.00 | 1.00 | H |
| ATOM | 2225 | N | SER | A | 1117 | 13.875 | −12.127 | −14.340 | 1.00 | 1.00 | N |
| ATOM | 2226 | CA | SER | A | 1117 | 14.086 | −11.818 | −12.916 | 1.00 | 1.00 | C |
| ATOM | 2227 | C | SER | A | 1117 | 12.878 | −12.071 | −12.004 | 1.00 | 1.00 | C |
| ATOM | 2228 | O | SER | A | 1117 | 11.768 | −12.035 | −12.498 | 1.00 | 1.00 | O |
| ATOM | 2229 | CB | SER | A | 1117 | 14.374 | −10.313 | −12.747 | 1.00 | 1.00 | C |
| ATOM | 2230 | OG | SER | A | 1117 | 15.665 | −9.951 | −13.181 | 1.00 | 1.00 | O |
| ATOM | 2231 | HA | SER | A | 1117 | 14.964 | −12.389 | −12.607 | 1.00 | 1.00 | H |
| ATOM | 2232 | HB1 | SER | A | 1117 | 14.480 | −9.997 | −11.698 | 1.00 | 1.00 | H |
| ATOM | 2233 | HB2 | SER | A | 1117 | 13.572 | −9.683 | −13.183 | 1.00 | 1.00 | H |
| ATOM | 2234 | HG | SER | A | 1117 | 15.864 | −10.036 | −14.098 | 1.00 | 1.00 | H |
| ATOM | 2235 | HN | SER | A | 1117 | 14.194 | −11.494 | −15.029 | 1.00 | 1.00 | H |
| ATOM | 2236 | N | ASN | A | 1118 | 13.159 | −12.257 | −10.673 | 1.00 | 1.00 | N |
| ATOM | 2237 | CA | ASN | A | 1118 | 12.121 | −12.657 | −9.756 | 1.00 | 1.00 | C |
| ATOM | 2238 | C | ASN | A | 1118 | 10.729 | −12.067 | −9.978 | 1.00 | 1.00 | C |
| ATOM | 2239 | O | ASN | A | 1118 | 9.806 | −12.791 | −9.646 | 1.00 | 1.00 | O |
| ATOM | 2240 | CB | ASN | A | 1118 | 12.485 | −12.443 | −8.304 | 1.00 | 1.00 | C |
| ATOM | 2241 | CG | ASN | A | 1118 | 12.656 | −10.989 | −7.978 | 1.00 | 1.00 | C |
| ATOM | 2242 | OD1 | ASN | A | 1118 | 12.407 | −10.138 | −8.819 | 1.00 | 1.00 | O |
| ATOM | 2243 | ND2 | ASN | A | 1118 | 13.114 | −10.551 | −6.763 | 1.00 | 1.00 | N |
| ATOM | 2244 | HA | ASN | A | 1118 | 11.900 | −13.683 | −9.986 | 1.00 | 1.00 | H |
| ATOM | 2245 | HB1 | ASN | A | 1118 | 13.392 | −13.002 | −8.069 | 1.00 | 1.00 | H |
| ATOM | 2246 | HB2 | ASN | A | 1118 | 11.715 | −12.824 | −7.590 | 1.00 | 1.00 | H |
| ATOM | 2247 | HD22 | ASN | A | 1118 | 13.219 | −9.591 | −6.655 | 1.00 | 1.00 | H |
| ATOM | 2248 | HD21 | ASN | A | 1118 | 13.372 | −11.224 | −6.006 | 1.00 | 1.00 | H |
| ATOM | 2249 | HN | ASN | A | 1118 | 14.136 | −12.225 | −10.365 | 1.00 | 1.00 | H |
| ATOM | 2250 | N | SER | A | 1119 | 10.457 | −10.877 | −10.569 | 1.00 | 1.00 | N |
| ATOM | 2251 | CA | SER | A | 1119 | 9.074 | −10.434 | −10.770 | 1.00 | 1.00 | C |
| ATOM | 2252 | C | SER | A | 1119 | 8.265 | −11.387 | −11.632 | 1.00 | 1.00 | C |
| ATOM | 2253 | O | SER | A | 1119 | 7.056 | −11.316 | −11.545 | 1.00 | 1.00 | O |
| ATOM | 2254 | CB | SER | A | 1119 | 9.053 | −9.048 | −11.522 | 1.00 | 1.00 | C |
| ATOM | 2255 | OG | SER | A | 1119 | 7.671 | −8.656 | −11.694 | 1.00 | 1.00 | O |
| ATOM | 2256 | HA | SER | A | 1119 | 8.527 | −10.322 | −9.830 | 1.00 | 1.00 | H |
| ATOM | 2257 | HB1 | SER | A | 1119 | 9.443 | −9.205 | −12.518 | 1.00 | 1.00 | H |
| ATOM | 2258 | HB2 | SER | A | 1119 | 9.691 | −8.258 | −11.061 | 1.00 | 1.00 | H |
| ATOM | 2259 | HG | SER | A | 1119 | 7.267 | −8.499 | −10.856 | 1.00 | 1.00 | H |
| ATOM | 2260 | HN | SER | A | 1119 | 11.215 | −10.305 | −10.875 | 1.00 | 1.00 | H |
| ATOM | 2261 | N | ARG | A | 1120 | 8.865 | −12.256 | −12.515 | 1.00 | 1.00 | N |
| ATOM | 2262 | CA | ARG | A | 1120 | 8.014 | −13.116 | −13.357 | 1.00 | 1.00 | C |
| ATOM | 2263 | C | ARG | A | 1120 | 6.892 | −13.792 | −12.624 | 1.00 | 1.00 | C |
| ATOM | 2264 | O | ARG | A | 1120 | 7.007 | −14.146 | −11.455 | 1.00 | 1.00 | O |
| ATOM | 2265 | CB | ARG | A | 1120 | 8.854 | −14.165 | −14.136 | 1.00 | 1.00 | C |
| ATOM | 2266 | CG | ARG | A | 1120 | 9.314 | −15.449 | −13.367 | 1.00 | 1.00 | C |
| ATOM | 2267 | CD | ARG | A | 1120 | 10.091 | −15.121 | −12.033 | 1.00 | 1.00 | C |
| ATOM | 2268 | NE | ARG | A | 1120 | 10.572 | −16.404 | −11.473 | 1.00 | 1.00 | N |
| ATOM | 2269 | CZ | ARG | A | 1120 | 11.729 | −16.974 | −11.769 | 1.00 | 1.00 | C |
| ATOM | 2270 | NH1 | ARG | A | 1120 | 12.566 | −16.469 | −12.619 | 1.00 | 1.00 | N |
| ATOM | 2271 | NH2 | ARG | A | 1120 | 12.029 | −18.057 | −11.137 | 1.00 | 1.00 | N |
| ATOM | 2272 | HA | ARG | A | 1120 | 7.641 | −12.344 | −14.041 | 1.00 | 1.00 | H |
| ATOM | 2273 | HB1 | ARG | A | 1120 | 9.757 | −13.615 | −14.518 | 1.00 | 1.00 | H |
| ATOM | 2274 | HB2 | ARG | A | 1120 | 8.277 | −14.473 | −15.047 | 1.00 | 1.00 | H |
| ATOM | 2275 | HG1 | ARG | A | 1120 | 9.962 | −16.051 | −13.976 | 1.00 | 1.00 | H |
| ATOM | 2276 | HG2 | ARG | A | 1120 | 8.393 | −16.029 | −13.193 | 1.00 | 1.00 | H |
| ATOM | 2277 | HD1 | ARG | A | 1120 | 9.432 | −14.680 | −11.317 | 1.00 | 1.00 | H |
| ATOM | 2278 | HD2 | ARG | A | 1120 | 10.855 | −14.342 | −12.157 | 1.00 | 1.00 | H |
| ATOM | 2279 | HE | ARG | A | 1120 | 9.967 | −16.856 | −10.760 | 1.00 | 1.00 | H |
| ATOM | 2280 | HH12 | ARG | A | 1120 | 13.469 | −16.899 | −12.829 | 1.00 | 1.00 | H |
| ATOM | 2281 | HH11 | ARG | A | 1120 | 12.343 | −15.631 | −13.199 | 1.00 | 1.00 | H |
| ATOM | 2282 | HH22 | ARG | A | 1120 | 12.919 | −18.532 | −11.328 | 1.00 | 1.00 | H |
| ATOM | 2283 | HH21 | ARG | A | 1120 | 11.387 | −18.547 | −10.442 | 1.00 | 1.00 | H |
| ATOM | 2284 | HN | ARG | A | 1120 | 9.867 | −12.216 | −12.572 | 1.00 | 1.00 | H |
| ATOM | 2285 | N | ILE | A | 1121 | 5.726 | −13.981 | −13.292 | 1.00 | 1.00 | N |
| ATOM | 2286 | CA | ILE | A | 1121 | 4.513 | −14.349 | −12.540 | 1.00 | 1.00 | C |
| ATOM | 2287 | C | ILE | A | 1121 | 3.355 | −14.670 | −13.476 | 1.00 | 1.00 | C |
| ATOM | 2288 | O | ILE | A | 1121 | 3.224 | −13.933 | −14.460 | 1.00 | 1.00 | O |
| ATOM | 2289 | CB | ILE | A | 1121 | 4.019 | −13.329 | −11.469 | 1.00 | 1.00 | C |
| ATOM | 2290 | CG1 | ILE | A | 1121 | 2.729 | −13.813 | −10.707 | 1.00 | 1.00 | C |
| ATOM | 2291 | CG2 | ILE | A | 1121 | 3.787 | −11.999 | −12.193 | 1.00 | 1.00 | C |
| ATOM | 2292 | CD1 | ILE | A | 1121 | 2.213 | −12.810 | −9.698 | 1.00 | 1.00 | C |
| ATOM | 2293 | HA | ILE | A | 1121 | 4.697 | −15.317 | −12.001 | 1.00 | 1.00 | H |
| ATOM | 2294 | HB | ILE | A | 1121 | 4.769 | −13.174 | −10.681 | 1.00 | 1.00 | H |
| ATOM | 2295 | HG11 | ILE | A | 1121 | 2.922 | −14.841 | −10.321 | 1.00 | 1.00 | H |
| ATOM | 2296 | HG12 | ILE | A | 1121 | 1.892 | −13.887 | −11.419 | 1.00 | 1.00 | H |
| ATOM | 2297 | HD11 | ILE | A | 1121 | 1.817 | −11.934 | −10.216 | 1.00 | 1.00 | H |
| ATOM | 2298 | HD12 | ILE | A | 1121 | 3.011 | −12.583 | −8.984 | 1.00 | 1.00 | H |
| ATOM | 2299 | HD13 | ILE | A | 1121 | 1.332 | −13.183 | −9.133 | 1.00 | 1.00 | H |
| ATOM | 2300 | HG21 | ILE | A | 1121 | 3.575 | −11.166 | −11.536 | 1.00 | 1.00 | H |
| ATOM | 2301 | HG22 | ILE | A | 1121 | 2.970 | −12.028 | −12.961 | 1.00 | 1.00 | H |
| ATOM | 2302 | HG23 | ILE | A | 1121 | 4.708 | −11.723 | −12.674 | 1.00 | 1.00 | H |
| ATOM | 2303 | HN | ILE | A | 1121 | 5.604 | −13.713 | −14.260 | 1.00 | 1.00 | H |
| ATOM | 2304 | N | PHE | A | 1122 | 2.523 | −15.677 | −13.227 | 1.00 | 1.00 | N |
| ATOM | 2305 | CA | PHE | A | 1122 | 1.317 | −15.919 | −14.087 | 1.00 | 1.00 | C |
| ATOM | 2306 | C | PHE | A | 1122 | 0.289 | −14.817 | −13.921 | 1.00 | 1.00 | C |
| ATOM | 2307 | O | PHE | A | 1122 | −0.762 | −15.093 | −13.338 | 1.00 | 1.00 | O |
| ATOM | 2308 | CB | PHE | A | 1122 | 0.718 | −17.315 | −13.781 | 1.00 | 1.00 | C |
| ATOM | 2309 | CG | PHE | A | 1122 | −0.476 | −17.728 | −14.695 | 1.00 | 1.00 | C |
| ATOM | 2310 | CD1 | PHE | A | 1122 | −0.333 | −17.850 | −16.067 | 1.00 | 1.00 | C |
| ATOM | 2311 | CD2 | PHE | A | 1122 | −1.730 | −17.988 | −14.133 | 1.00 | 1.00 | C |
| ATOM | 2312 | CE1 | PHE | A | 1122 | −1.390 | −18.311 | −16.881 | 1.00 | 1.00 | C |
| ATOM | 2313 | CE2 | PHE | A | 1122 | −2.824 | −18.391 | −14.913 | 1.00 | 1.00 | C |
| ATOM | 2314 | CZ | PHE | A | 1122 | −2.625 | −18.551 | −16.279 | 1.00 | 1.00 | C |
| ATOM | 2315 | HA | PHE | A | 1122 | 1.591 | −15.911 | −15.178 | 1.00 | 1.00 | H |
| ATOM | 2316 | HB1 | PHE | A | 1122 | 0.420 | −17.262 | −12.718 | 1.00 | 1.00 | H |
| ATOM | 2317 | HB2 | PHE | A | 1122 | 1.473 | −18.112 | −13.905 | 1.00 | 1.00 | H |
| ATOM | 2318 | HD2 | PHE | A | 1122 | −1.846 | −17.893 | −13.035 | 1.00 | 1.00 | H |
| ATOM | 2319 | HE2 | PHE | A | 1122 | −3.833 | −18.502 | −14.510 | 1.00 | 1.00 | H |
| ATOM | 2320 | HZ | PHE | A | 1122 | −3.448 | −18.913 | −16.874 | 1.00 | 1.00 | H |
| ATOM | 2321 | HE1 | PHE | A | 1122 | −1.259 | −18.447 | −17.909 | 1.00 | 1.00 | H |
| ATOM | 2322 | HD1 | PHE | A | 1122 | 0.589 | −17.613 | −16.654 | 1.00 | 1.00 | H |
| ATOM | 2323 | HN | PHE | A | 1122 | 2.639 | −16.283 | −12.442 | 1.00 | 1.00 | H |
| ATOM | 2324 | N | ASN | A | 1123 | 0.583 | −13.611 | −14.413 | 1.00 | 1.00 | N |
| ATOM | 2325 | CA | ASN | A | 1123 | −0.403 | −12.495 | −14.218 | 1.00 | 1.00 | C |
| ATOM | 2326 | C | ASN | A | 1123 | −0.998 | −11.957 | −15.526 | 1.00 | 1.00 | C |
| ATOM | 2327 | O | ASN | A | 1123 | −0.263 | −11.994 | −16.515 | 1.00 | 1.00 | O |
| ATOM | 2328 | CB | ASN | A | 1123 | 0.145 | −11.269 | −13.429 | 1.00 | 1.00 | C |
| ATOM | 2329 | CG | ASN | A | 1123 | −0.872 | −10.367 | −12.817 | 1.00 | 1.00 | C |
| ATOM | 2330 | OD1 | ASN | A | 1123 | −2.037 | −10.604 | −12.887 | 1.00 | 1.00 | O |
| ATOM | 2331 | ND2 | ASN | A | 1123 | −0.476 | −9.222 | −12.222 | 1.00 | 1.00 | N |
| ATOM | 2332 | HA | ASN | A | 1123 | −1.280 | −12.773 | −13.584 | 1.00 | 1.00 | H |
| ATOM | 2333 | HB1 | ASN | A | 1123 | 0.904 | −10.736 | −14.032 | 1.00 | 1.00 | H |
| ATOM | 2334 | HB2 | ASN | A | 1123 | 0.641 | −11.744 | −12.616 | 1.00 | 1.00 | H |
| ATOM | 2335 | HD22 | ASN | A | 1123 | −1.210 | −8.547 | −11.997 | 1.00 | 1.00 | H |
| ATOM | 2336 | HD21 | ASN | A | 1123 | 0.466 | −8.978 | −11.987 | 1.00 | 1.00 | H |
| ATOM | 2337 | HN | ASN | A | 1123 | 1.419 | −13.479 | −14.959 | 1.00 | 1.00 | H |
| ATOM | 2338 | N | TYR | A | 1124 | −2.215 | −11.410 | −15.516 | 1.00 | 1.00 | N |
| ATOM | 2339 | CA | TYR | A | 1124 | −2.912 | −10.891 | −16.737 | 1.00 | 1.00 | C |
| ATOM | 2340 | C | TYR | A | 1124 | −2.972 | −11.906 | −17.875 | 1.00 | 1.00 | C |
| ATOM | 2341 | O | TYR | A | 1124 | −3.485 | −11.480 | −18.900 | 1.00 | 1.00 | O |
| ATOM | 2342 | CB | TYR | A | 1124 | −2.153 | −9.635 | −17.176 | 1.00 | 1.00 | C |
| ATOM | 2343 | CG | TYR | A | 1124 | −1.938 | −8.590 | −16.088 | 1.00 | 1.00 | C |
| ATOM | 2344 | CD1 | TYR | A | 1124 | −2.957 | −8.112 | −15.279 | 1.00 | 1.00 | C |
| ATOM | 2345 | CD2 | TYR | A | 1124 | −0.662 | −8.093 | −15.817 | 1.00 | 1.00 | C |
| ATOM | 2346 | CE1 | TYR | A | 1124 | −2.716 | −7.111 | −14.336 | 1.00 | 1.00 | C |
| ATOM | 2347 | CE2 | TYR | A | 1124 | −0.357 | −7.199 | −14.777 | 1.00 | 1.00 | C |
| ATOM | 2348 | CZ | TYR | A | 1124 | −1.424 | −6.768 | −13.947 | 1.00 | 1.00 | C |
| ATOM | 2349 | OH | TYR | A | 1124 | −1.271 | −5.956 | −12.806 | 1.00 | 1.00 | O |
| ATOM | 2350 | HA | TYR | A | 1124 | −3.956 | −10.598 | −16.581 | 1.00 | 1.00 | H |
| ATOM | 2351 | HB2 | TYR | A | 1124 | −2.774 | −9.118 | −17.906 | 1.00 | 1.00 | H |
| ATOM | 2352 | HB1 | TYR | A | 1124 | −1.221 | −9.950 | −17.650 | 1.00 | 1.00 | H |
| ATOM | 2353 | HD2 | TYR | A | 1124 | 0.108 | −8.362 | −16.535 | 1.00 | 1.00 | H |
| ATOM | 2354 | HE2 | TYR | A | 1124 | 0.633 | −6.859 | −14.657 | 1.00 | 1.00 | H |
| ATOM | 2355 | HE1 | TYR | A | 1124 | −3.580 | −6.578 | −13.955 | 1.00 | 1.00 | H |
| ATOM | 2356 | HD1 | TYR | A | 1124 | −3.978 | −8.461 | −15.384 | 1.00 | 1.00 | H |
| ATOM | 2357 | HH | TYR | A | 1124 | −0.422 | −5.564 | −12.720 | 1.00 | 1.00 | H |
| ATOM | 2358 | HN | TYR | A | 1124 | −2.621 | −11.229 | −14.643 | 1.00 | 1.00 | H |
| ATOM | 2359 | N | GLN | A | 1125 | −2.555 | −13.175 | −17.808 | 1.00 | 1.00 | N |
| ATOM | 2360 | CA | GLN | A | 1125 | −3.026 | −14.086 | −18.876 | 1.00 | 1.00 | C |
| ATOM | 2361 | C | GLN | A | 1125 | −4.521 | −14.185 | −18.742 | 1.00 | 1.00 | C |
| ATOM | 2362 | O | GLN | A | 1125 | −4.864 | −14.867 | −17.797 | 1.00 | 1.00 | O |
| ATOM | 2363 | CB | GLN | A | 1125 | −2.379 | −15.510 | −18.785 | 1.00 | 1.00 | C |
| ATOM | 2364 | CG | GLN | A | 1125 | −0.989 | −15.592 | −19.456 | 1.00 | 1.00 | C |
| ATOM | 2365 | CD | GLN | A | 1125 | −0.138 | −14.394 | −19.061 | 1.00 | 1.00 | C |
| ATOM | 2366 | OE1 | GLN | A | 1125 | 0.283 | −13.593 | −19.875 | 1.00 | 1.00 | O |
| ATOM | 2367 | NE2 | GLN | A | 1125 | 0.132 | −14.238 | −17.773 | 1.00 | 1.00 | N |
| ATOM | 2368 | HA | GLN | A | 1125 | −2.724 | −13.610 | −19.844 | 1.00 | 1.00 | H |
| ATOM | 2369 | HB1 | GLN | A | 1125 | −3.026 | −16.335 | −19.150 | 1.00 | 1.00 | H |
| ATOM | 2370 | HB2 | GLN | A | 1125 | −2.279 | −15.746 | −17.716 | 1.00 | 1.00 | H |
| ATOM | 2371 | HG1 | GLN | A | 1125 | −1.051 | −15.620 | −20.552 | 1.00 | 1.00 | H |
| ATOM | 2372 | HG2 | GLN | A | 1125 | −0.424 | −16.454 | −19.083 | 1.00 | 1.00 | H |
| ATOM | 2373 | HE22 | GLN | A | 1125 | 0.760 | −13.504 | −17.446 | 1.00 | 1.00 | H |
| ATOM | 2374 | HE21 | GLN | A | 1125 | −0.122 | −14.869 | −17.072 | 1.00 | 1.00 | H |
| ATOM | 2375 | HN | GLN | A | 1125 | −2.129 | −13.513 | −16.988 | 1.00 | 1.00 | H |
| ATOM | 2376 | N | HIS | A | 1126 | −5.355 | −13.533 | −19.565 | 1.00 | 1.00 | N |
| ATOM | 2377 | CA | HIS | A | 1126 | −6.765 | −13.570 | −19.303 | 1.00 | 1.00 | C |
| ATOM | 2378 | C | HIS | A | 1126 | −7.556 | −13.546 | −20.569 | 1.00 | 1.00 | C |
| ATOM | 2379 | O | HIS | A | 1126 | −6.914 | −13.482 | −21.623 | 1.00 | 1.00 | O |
| ATOM | 2380 | CB | HIS | A | 1126 | −7.080 | −12.456 | −18.280 | 1.00 | 1.00 | C |
| ATOM | 2381 | CG | HIS | A | 1126 | −7.202 | −11.063 | −18.956 | 1.00 | 1.00 | C |
| ATOM | 2382 | ND1 | HIS | A | 1126 | −6.166 | −10.441 | −19.455 | 1.00 | 1.00 | N |
| ATOM | 2383 | CD2 | HIS | A | 1126 | −8.329 | −10.294 | −19.019 | 1.00 | 1.00 | C |
| ATOM | 2384 | CE1 | HIS | A | 1126 | −6.548 | −9.279 | −19.848 | 1.00 | 1.00 | C |
| ATOM | 2385 | NE2 | HIS | A | 1126 | −7.781 | −9.120 | −19.629 | 1.00 | 1.00 | N |
| ATOM | 2386 | HA | HIS | A | 1126 | −7.018 | −14.545 | −18.918 | 1.00 | 1.00 | H |
| ATOM | 2387 | HB1 | HIS | A | 1126 | −6.278 | −12.316 | −17.537 | 1.00 | 1.00 | H |
| ATOM | 2388 | HB2 | HIS | A | 1126 | −8.052 | −12.708 | −17.805 | 1.00 | 1.00 | H |
| ATOM | 2389 | HD2 | HIS | A | 1126 | −9.376 | −10.455 | −18.647 | 1.00 | 1.00 | H |
| ATOM | 2390 | HE1 | HIS | A | 1126 | −5.979 | −8.501 | −20.367 | 1.00 | 1.00 | H |
| ATOM | 2391 | HD1 | HIS | A | 1126 | −5.216 | −10.784 | −19.515 | 1.00 | 1.00 | H |
| ATOM | 2392 | HN | HIS | A | 1126 | −5.036 | −13.026 | −20.428 | 1.00 | 1.00 | H |
| ATOM | 2393 | N | GLY | A | 1127 | −8.898 | −13.496 | −20.516 | 1.00 | 1.00 | N |
| ATOM | 2394 | CA | GLY | A | 1127 | −9.668 | −13.355 | −21.767 | 1.00 | 1.00 | C |
| ATOM | 2395 | C | GLY | A | 1127 | −10.237 | −11.998 | −21.944 | 1.00 | 1.00 | C |
| ATOM | 2396 | O | GLY | A | 1127 | −11.465 | −11.858 | −21.993 | 1.00 | 1.00 | O |
| ATOM | 2397 | HA2 | GLY | A | 1127 | −10.460 | −14.094 | −21.701 | 1.00 | 1.00 | H |
| ATOM | 2398 | HA1 | GLY | A | 1127 | −9.020 | −13.607 | −22.640 | 1.00 | 1.00 | H |
| ATOM | 2399 | HN | GLY | A | 1127 | −9.347 | −13.632 | −19.630 | 1.00 | 1.00 | H |
| ATOM | 2400 | N | THR | A | 1128 | −9.443 | −10.895 | −22.071 | 1.00 | 1.00 | N |
| ATOM | 2401 | CA | THR | A | 1128 | −9.879 | −9.477 | −22.130 | 1.00 | 1.00 | C |
| ATOM | 2402 | C | THR | A | 1128 | −10.967 | −8.972 | −21.152 | 1.00 | 1.00 | C |
| ATOM | 2403 | O | THR | A | 1128 | −10.816 | −7.951 | −20.500 | 1.00 | 1.00 | O |
| ATOM | 2404 | CB | THR | A | 1128 | −10.195 | −8.961 | −23.559 | 1.00 | 1.00 | C |
| ATOM | 2405 | OG1 | THR | A | 1128 | −10.607 | −7.557 | −23.529 | 1.00 | 1.00 | O |
| ATOM | 2406 | CG2 | THR | A | 1128 | −11.136 | −9.840 | −24.374 | 1.00 | 1.00 | C |
| ATOM | 2407 | HA | THR | A | 1128 | −9.023 | −8.846 | −21.812 | 1.00 | 1.00 | H |
| ATOM | 2408 | HB | THR | A | 1128 | −9.248 | −9.002 | −24.138 | 1.00 | 1.00 | H |
| ATOM | 2409 | HG1 | THR | A | 1128 | −11.496 | −7.480 | −23.184 | 1.00 | 1.00 | H |
| ATOM | 2410 | HG23 | THR | A | 1128 | −11.298 | −9.363 | −25.332 | 1.00 | 1.00 | H |
| ATOM | 2411 | HG21 | THR | A | 1128 | −12.111 | −9.822 | −23.850 | 1.00 | 1.00 | H |
| ATOM | 2412 | HG22 | THR | A | 1128 | −10.734 | −10.841 | −24.417 | 1.00 | 1.00 | H |
| ATOM | 2413 | HN | THR | A | 1128 | −8.454 | −11.063 | −22.019 | 1.00 | 1.00 | H |
| ATOM | 2414 | N | MET | A | 1129 | −12.191 | −9.636 | −21.119 | 1.00 | 1.00 | N |
| ATOM | 2415 | CA | MET | A | 1129 | −13.340 | −9.053 | −20.366 | 1.00 | 1.00 | C |
| ATOM | 2416 | C | MET | A | 1129 | −13.954 | −7.964 | −21.239 | 1.00 | 1.00 | C |
| ATOM | 2417 | O | MET | A | 1129 | −15.008 | −8.202 | −21.817 | 1.00 | 1.00 | O |
| ATOM | 2418 | CB | MET | A | 1129 | −14.447 | −10.107 | −20.004 | 1.00 | 1.00 | C |
| ATOM | 2419 | CG | MET | A | 1129 | −13.827 | −11.324 | −19.258 | 1.00 | 1.00 | C |
| ATOM | 2420 | SD | MET | A | 1129 | −15.064 | −12.387 | −18.482 | 1.00 | 1.00 | S |
| ATOM | 2421 | CE | MET | A | 1129 | −15.552 | −13.170 | −20.078 | 1.00 | 1.00 | C |
| ATOM | 2422 | HA | MET | A | 1129 | −12.983 | −8.545 | −19.465 | 1.00 | 1.00 | H |
| ATOM | 2423 | HB1 | MET | A | 1129 | −14.990 | −10.467 | −20.914 | 1.00 | 1.00 | H |
| ATOM | 2424 | HB2 | MET | A | 1129 | −15.158 | −9.608 | −19.327 | 1.00 | 1.00 | H |
| ATOM | 2425 | HG1 | MET | A | 1129 | −13.263 | −10.919 | −18.451 | 1.00 | 1.00 | H |
| ATOM | 2426 | HG2 | MET | A | 1129 | −13.149 | −11.860 | −19.909 | 1.00 | 1.00 | H |
| ATOM | 2427 | HE1 | MET | A | 1129 | −16.049 | −12.422 | −20.629 | 1.00 | 1.00 | H |
| ATOM | 2428 | HE2 | MET | A | 1129 | −16.314 | −13.940 | −19.906 | 1.00 | 1.00 | H |
| ATOM | 2429 | HE3 | MET | A | 1129 | −14.690 | −13.602 | −20.612 | 1.00 | 1.00 | H |
| ATOM | 2430 | HN | MET | A | 1129 | −12.379 | −10.471 | −21.628 | 1.00 | 1.00 | H |
| ATOM | 2431 | N | GLN | A | 1130 | −13.316 | −6.777 | −21.352 | 1.00 | 1.00 | N |
| ATOM | 2432 | CA | GLN | A | 1130 | −13.896 | −5.700 | −22.115 | 1.00 | 1.00 | C |
| ATOM | 2433 | C | GLN | A | 1130 | −12.820 | −4.694 | −22.434 | 1.00 | 1.00 | C |
| ATOM | 2434 | O | GLN | A | 1130 | −11.947 | −4.537 | −21.601 | 1.00 | 1.00 | O |
| ATOM | 2435 | CB | GLN | A | 1130 | −15.108 | −5.124 | −21.354 | 1.00 | 1.00 | C |
| ATOM | 2436 | CG | GLN | A | 1130 | −15.947 | −4.150 | −22.251 | 1.00 | 1.00 | C |
| ATOM | 2437 | CD | GLN | A | 1130 | −16.265 | −4.686 | −23.651 | 1.00 | 1.00 | C |
| ATOM | 2438 | OE1 | GLN | A | 1130 | −16.203 | −3.930 | −24.590 | 1.00 | 1.00 | O |
| ATOM | 2439 | NE2 | GLN | A | 1130 | −16.587 | −5.989 | −23.917 | 1.00 | 1.00 | N |
| ATOM | 2440 | HA | GLN | A | 1130 | −14.171 | −6.163 | −23.079 | 1.00 | 1.00 | H |
| ATOM | 2441 | HB1 | GLN | A | 1130 | −14.743 | −4.629 | −20.387 | 1.00 | 1.00 | H |
| ATOM | 2442 | HB2 | GLN | A | 1130 | −15.755 | −5.951 | −21.029 | 1.00 | 1.00 | H |
| ATOM | 2443 | HG1 | GLN | A | 1130 | −15.399 | −3.220 | −22.409 | 1.00 | 1.00 | H |
| ATOM | 2444 | HG2 | GLN | A | 1130 | −16.856 | −3.773 | −21.761 | 1.00 | 1.00 | H |
| ATOM | 2445 | HE22 | GLN | A | 1130 | −16.714 | −6.359 | −24.849 | 1.00 | 1.00 | H |
| ATOM | 2446 | HE21 | GLN | A | 1130 | −16.659 | −6.665 | −23.144 | 1.00 | 1.00 | H |
| ATOM | 2447 | HN | GLN | A | 1130 | −12.436 | −6.641 | −20.891 | 1.00 | 1.00 | H |
| ATOM | 2448 | N | ASN | A | 1131 | −12.861 | −4.077 | −23.637 | 1.00 | 1.00 | N |
| ATOM | 2449 | CA | ASN | A | 1131 | −11.774 | −3.125 | −24.022 | 1.00 | 1.00 | C |
| ATOM | 2450 | C | ASN | A | 1131 | −11.143 | −2.310 | −22.889 | 1.00 | 1.00 | C |
| ATOM | 2451 | O | ASN | A | 1131 | −9.935 | −2.368 | −22.730 | 1.00 | 1.00 | O |
| ATOM | 2452 | CB | ASN | A | 1131 | −10.723 | −3.897 | −24.819 | 1.00 | 1.00 | C |
| ATOM | 2453 | CG | ASN | A | 1131 | −11.461 | −4.622 | −25.897 | 1.00 | 1.00 | C |
| ATOM | 2454 | OD1 | ASN | A | 1131 | −12.002 | −3.971 | −26.758 | 1.00 | 1.00 | O |
| ATOM | 2455 | ND2 | ASN | A | 1131 | −11.536 | −5.968 | −25.938 | 1.00 | 1.00 | N |
| ATOM | 2456 | HA | ASN | A | 1131 | −12.229 | −2.370 | −24.621 | 1.00 | 1.00 | H |
| ATOM | 2457 | HB1 | ASN | A | 1131 | −10.216 | −4.616 | −24.196 | 1.00 | 1.00 | H |
| ATOM | 2458 | HB2 | ASN | A | 1131 | −9.908 | −3.327 | −25.272 | 1.00 | 1.00 | H |
| ATOM | 2459 | HD22 | ASN | A | 1131 | −11.966 | −6.412 | −26.693 | 1.00 | 1.00 | H |
| ATOM | 2460 | HD21 | ASN | A | 1131 | −11.144 | −6.582 | −25.221 | 1.00 | 1.00 | H |
| ATOM | 2461 | HN | ASN | A | 1131 | −13.585 | −4.260 | −24.345 | 1.00 | 1.00 | H |
| ATOM | 2462 | N | LEU | A | 1132 | −12.023 | −1.631 | −22.086 | 1.00 | 1.00 | N |
| ATOM | 2463 | CA | LEU | A | 1132 | −11.514 | −1.000 | −20.872 | 1.00 | 1.00 | C |
| ATOM | 2464 | C | LEU | A | 1132 | −10.592 | −1.923 | −20.097 | 1.00 | 1.00 | C |
| ATOM | 2465 | O | LEU | A | 1132 | −9.443 | −1.581 | −19.943 | 1.00 | 1.00 | O |
| ATOM | 2466 | CB | LEU | A | 1132 | −12.627 | −0.375 | −19.965 | 1.00 | 1.00 | C |
| ATOM | 2467 | CG | LEU | A | 1132 | −12.323 | 0.858 | −19.081 | 1.00 | 1.00 | C |
| ATOM | 2468 | CD1 | LEU | A | 1132 | −13.620 | 1.318 | −18.335 | 1.00 | 1.00 | C |
| ATOM | 2469 | CD2 | LEU | A | 1132 | −11.117 | 0.659 | −18.126 | 1.00 | 1.00 | C |
| ATOM | 2470 | HA | LEU | A | 1132 | −10.976 | −0.094 | −21.212 | 1.00 | 1.00 | H |
| ATOM | 2471 | HB1 | LEU | A | 1132 | −13.055 | −1.152 | −19.346 | 1.00 | 1.00 | H |
| ATOM | 2472 | HB2 | LEU | A | 1132 | −13.467 | −0.043 | −20.649 | 1.00 | 1.00 | H |
| ATOM | 2473 | HG | LEU | A | 1132 | −12.020 | 1.694 | −19.677 | 1.00 | 1.00 | H |
| ATOM | 2474 | HD21 | LEU | A | 1132 | −11.341 | −0.320 | −17.621 | 1.00 | 1.00 | H |
| ATOM | 2475 | HD22 | LEU | A | 1132 | −10.920 | 1.421 | −17.367 | 1.00 | 1.00 | H |
| ATOM | 2476 | HD23 | LEU | A | 1132 | −10.192 | 0.476 | −18.718 | 1.00 | 1.00 | H |
| ATOM | 2477 | HD11 | LEU | A | 1132 | −14.093 | 0.452 | −17.796 | 1.00 | 1.00 | H |
| ATOM | 2478 | HD12 | LEU | A | 1132 | −14.380 | 1.708 | −19.043 | 1.00 | 1.00 | H |
| ATOM | 2479 | HD13 | LEU | A | 1132 | −13.357 | 2.113 | −17.578 | 1.00 | 1.00 | H |
| ATOM | 2480 | HN | LEU | A | 1132 | −13.023 | −1.690 | −22.239 | 1.00 | 1.00 | H |
| ATOM | 2481 | N | HIS | A | 1133 | −11.044 | −3.094 | −19.593 | 1.00 | 1.00 | N |
| ATOM | 2482 | CA | HIS | A | 1133 | −10.145 | −3.881 | −18.744 | 1.00 | 1.00 | C |
| ATOM | 2483 | C | HIS | A | 1133 | −8.786 | −4.227 | −19.329 | 1.00 | 1.00 | C |
| ATOM | 2484 | O | HIS | A | 1133 | −7.773 | −4.078 | −18.649 | 1.00 | 1.00 | O |
| ATOM | 2485 | CB | HIS | A | 1133 | −10.796 | −5.206 | −18.318 | 1.00 | 1.00 | C |
| ATOM | 2486 | CG | HIS | A | 1133 | −9.812 | −6.050 | −17.522 | 1.00 | 1.00 | C |
| ATOM | 2487 | ND1 | HIS | A | 1133 | −8.852 | −6.788 | −18.045 | 1.00 | 1.00 | N |
| ATOM | 2488 | CD2 | HIS | A | 1133 | −9.788 | −6.128 | −16.183 | 1.00 | 1.00 | C |
| ATOM | 2489 | CE1 | HIS | A | 1133 | −8.154 | −7.331 | −17.095 | 1.00 | 1.00 | C |
| ATOM | 2490 | NE2 | HIS | A | 1133 | −8.660 | −6.955 | −15.993 | 1.00 | 1.00 | N |
| ATOM | 2491 | HA | HIS | A | 1133 | −9.963 | −3.300 | −17.867 | 1.00 | 1.00 | H |
| ATOM | 2492 | HB1 | HIS | A | 1133 | −11.092 | −5.762 | −19.250 | 1.00 | 1.00 | H |
| ATOM | 2493 | HB2 | HIS | A | 1133 | −11.701 | −5.122 | −17.695 | 1.00 | 1.00 | H |
| ATOM | 2494 | HD2 | HIS | A | 1133 | −10.411 | −5.689 | −15.393 | 1.00 | 1.00 | H |
| ATOM | 2495 | HE1 | HIS | A | 1133 | −7.299 | −7.968 | −17.206 | 1.00 | 1.00 | H |
| ATOM | 2496 | HD1 | HIS | A | 1133 | −8.744 | −6.984 | −19.051 | 1.00 | 1.00 | H |
| ATOM | 2497 | HN | HIS | A | 1133 | −12.003 | −3.457 | −19.702 | 1.00 | 1.00 | H |
| ATOM | 2498 | N | ASP | A | 1134 | −8.750 | −4.639 | −20.615 | 1.00 | 1.00 | N |
| ATOM | 2499 | CA | ASP | A | 1134 | −7.421 | −4.946 | −21.196 | 1.00 | 1.00 | C |
| ATOM | 2500 | C | ASP | A | 1134 | −6.575 | −3.656 | −21.330 | 1.00 | 1.00 | C |
| ATOM | 2501 | O | ASP | A | 1134 | −5.377 | −3.677 | −21.118 | 1.00 | 1.00 | O |
| ATOM | 2502 | CB | ASP | A | 1134 | −7.599 | −5.627 | −22.575 | 1.00 | 1.00 | C |
| ATOM | 2503 | CG | ASP | A | 1134 | −6.322 | −6.099 | −23.228 | 1.00 | 1.00 | C |
| ATOM | 2504 | OD1 | ASP | A | 1134 | −5.650 | −7.009 | −22.629 | 1.00 | 1.00 | O |
| ATOM | 2505 | OD2 | ASP | A | 1134 | −5.934 | −5.617 | −24.324 | 1.00 | 1.00 | O |
| ATOM | 2506 | HA | ASP | A | 1134 | −6.910 | −5.665 | −20.546 | 1.00 | 1.00 | H |
| ATOM | 2507 | HB1 | ASP | A | 1134 | −8.037 | −4.845 | −23.237 | 1.00 | 1.00 | H |
| ATOM | 2508 | HB2 | ASP | A | 1134 | −8.251 | −6.507 | −22.430 | 1.00 | 1.00 | H |
| ATOM | 2509 | HN | ASP | A | 1134 | −9.624 | −4.719 | −21.187 | 1.00 | 1.00 | H |
| ATOM | 2510 | N | SER | A | 1135 | −7.168 | −2.496 | −21.662 | 1.00 | 1.00 | N |
| ATOM | 2511 | CA | SER | A | 1135 | −6.404 | −1.246 | −21.574 | 1.00 | 1.00 | C |
| ATOM | 2512 | C | SER | A | 1135 | −5.891 | −1.091 | −20.164 | 1.00 | 1.00 | C |
| ATOM | 2513 | O | SER | A | 1135 | −4.752 | −0.673 | −20.085 | 1.00 | 1.00 | O |
| ATOM | 2514 | CB | SER | A | 1135 | −7.279 | −0.039 | −22.006 | 1.00 | 1.00 | C |
| ATOM | 2515 | OG | SER | A | 1135 | −7.944 | 0.549 | −20.907 | 1.00 | 1.00 | O |
| ATOM | 2516 | HA | SER | A | 1135 | −5.542 | −1.329 | −22.221 | 1.00 | 1.00 | H |
| ATOM | 2517 | HB1 | SER | A | 1135 | −7.889 | −0.137 | −22.924 | 1.00 | 1.00 | H |
| ATOM | 2518 | HB2 | SER | A | 1135 | −6.571 | 0.742 | −22.346 | 1.00 | 1.00 | H |
| ATOM | 2519 | HG | SER | A | 1135 | −8.574 | −0.043 | −20.516 | 1.00 | 1.00 | H |
| ATOM | 2520 | HN | SER | A | 1135 | −8.142 | −2.430 | −21.890 | 1.00 | 1.00 | H |
| ATOM | 2521 | N | CYS | A | 1136 | −6.703 | −1.384 | −19.118 | 1.00 | 1.00 | N |
| ATOM | 2522 | CA | CYS | A | 1136 | −6.169 | −1.260 | −17.793 | 1.00 | 1.00 | C |
| ATOM | 2523 | C | CYS | A | 1136 | −5.008 | −2.168 | −17.671 | 1.00 | 1.00 | C |
| ATOM | 2524 | O | CYS | A | 1136 | −3.912 | −1.759 | −17.253 | 1.00 | 1.00 | O |
| ATOM | 2525 | CB | CYS | A | 1136 | −7.148 | −1.561 | −16.614 | 1.00 | 1.00 | C |
| ATOM | 2526 | SG | CYS | A | 1136 | −8.668 | −0.524 | −16.550 | 1.00 | 1.00 | S |
| ATOM | 2527 | HA | CYS | A | 1136 | −5.856 | −0.226 | −17.702 | 1.00 | 1.00 | H |
| ATOM | 2528 | HB1 | CYS | A | 1136 | −7.444 | −2.627 | −16.544 | 1.00 | 1.00 | H |
| ATOM | 2529 | HB2 | CYS | A | 1136 | −6.658 | −1.359 | −15.625 | 1.00 | 1.00 | H |
| ATOM | 2530 | HG | CYS | A | 1136 | −8.854 | −0.518 | −15.536 | 1.00 | 1.00 | H |
| ATOM | 2531 | HN | CYS | A | 1136 | −7.613 | −1.714 | −19.285 | 1.00 | 1.00 | H |
| ATOM | 2532 | N | SER | A | 1137 | −5.153 | −3.427 | −18.041 | 1.00 | 1.00 | N |
| ATOM | 2533 | CA | SER | A | 1137 | −3.988 | −4.337 | −18.028 | 1.00 | 1.00 | C |
| ATOM | 2534 | C | SER | A | 1137 | −2.743 | −3.650 | −18.636 | 1.00 | 1.00 | C |
| ATOM | 2535 | O | SER | A | 1137 | −1.763 | −3.564 | −17.943 | 1.00 | 1.00 | O |
| ATOM | 2536 | CB | SER | A | 1137 | −4.329 | −5.748 | −18.488 | 1.00 | 1.00 | C |
| ATOM | 2537 | OG | SER | A | 1137 | −3.130 | −6.487 | −18.749 | 1.00 | 1.00 | O |
| ATOM | 2538 | HA | SER | A | 1137 | −3.687 | −4.375 | −16.989 | 1.00 | 1.00 | H |
| ATOM | 2539 | HB1 | SER | A | 1137 | −4.909 | −5.517 | −19.422 | 1.00 | 1.00 | H |
| ATOM | 2540 | HB2 | SER | A | 1137 | −5.039 | −6.248 | −17.822 | 1.00 | 1.00 | H |
| ATOM | 2541 | HG | SER | A | 1137 | −2.760 | −6.824 | −17.966 | 1.00 | 1.00 | H |
| ATOM | 2542 | HN | SER | A | 1137 | −6.113 | −3.723 | −18.329 | 1.00 | 1.00 | H |
| ATOM | 2543 | N | ARG | A | 1138 | −2.760 | −3.135 | −19.883 | 1.00 | 1.00 | N |
| ATOM | 2544 | CA | ARG | A | 1138 | −1.490 | −2.506 | −20.364 | 1.00 | 1.00 | C |
| ATOM | 2545 | C | ARG | A | 1138 | −1.156 | −1.347 | −19.425 | 1.00 | 1.00 | C |
| ATOM | 2546 | O | ARG | A | 1138 | −0.035 | −1.273 | −18.948 | 1.00 | 1.00 | O |
| ATOM | 2547 | CB | ARG | A | 1138 | −1.474 | −1.985 | −21.854 | 1.00 | 1.00 | C |
| ATOM | 2548 | CG | ARG | A | 1138 | −0.850 | −2.958 | −22.900 | 1.00 | 1.00 | C |
| ATOM | 2549 | CD | ARG | A | 1138 | −1.951 | −4.003 | −23.330 | 1.00 | 1.00 | C |
| ATOM | 2550 | NE | ARG | A | 1138 | −2.270 | −5.014 | −22.332 | 1.00 | 1.00 | N |
| ATOM | 2551 | CZ | ARG | A | 1138 | −3.078 | −6.021 | −22.571 | 1.00 | 1.00 | C |
| ATOM | 2552 | NH1 | ARG | A | 1138 | −3.594 | −6.290 | −23.761 | 1.00 | 1.00 | N |
| ATOM | 2553 | NH2 | ARG | A | 1138 | −3.413 | −6.877 | −21.631 | 1.00 | 1.00 | N |
| ATOM | 2554 | HA | ARG | A | 1138 | −0.662 | −3.208 | −20.295 | 1.00 | 1.00 | H |
| ATOM | 2555 | HB1 | ARG | A | 1138 | −0.851 | −1.067 | −21.890 | 1.00 | 1.00 | H |
| ATOM | 2556 | HB2 | ARG | A | 1138 | −2.433 | −1.533 | −22.129 | 1.00 | 1.00 | H |
| ATOM | 2557 | HG1 | ARG | A | 1138 | 0.097 | −3.431 | −22.566 | 1.00 | 1.00 | H |
| ATOM | 2558 | HG2 | ARG | A | 1138 | −0.597 | −2.335 | −23.760 | 1.00 | 1.00 | H |
| ATOM | 2559 | HD1 | ARG | A | 1138 | −1.663 | −4.571 | −24.152 | 1.00 | 1.00 | H |
| ATOM | 2560 | HD2 | ARG | A | 1138 | −2.886 | −3.446 | −23.541 | 1.00 | 1.00 | H |
| ATOM | 2561 | HE | ARG | A | 1138 | −1.822 | −5.016 | −21.444 | 1.00 | 1.00 | H |
| ATOM | 2562 | HH12 | ARG | A | 1138 | −4.216 | −7.071 | −23.937 | 1.00 | 1.00 | H |
| ATOM | 2563 | HH11 | ARG | A | 1138 | −3.449 | −5.624 | −24.533 | 1.00 | 1.00 | H |
| ATOM | 2564 | HH22 | ARG | A | 1138 | −4.175 | −7.548 | −21.819 | 1.00 | 1.00 | H |
| ATOM | 2565 | HH21 | ARG | A | 1138 | −2.961 | −6.846 | −20.686 | 1.00 | 1.00 | H |
| ATOM | 2566 | HN | ARG | A | 1138 | −3.593 | −3.108 | −20.451 | 1.00 | 1.00 | H |
| ATOM | 2567 | N | ASN | A | 1139 | −2.124 | −0.442 | −19.278 | 1.00 | 1.00 | N |
| ATOM | 2568 | CA | ASN | A | 1139 | −1.752 | 0.806 | −18.613 | 1.00 | 1.00 | C |
| ATOM | 2569 | C | ASN | A | 1139 | −1.276 | 0.533 | −17.233 | 1.00 | 1.00 | C |
| ATOM | 2570 | O | ASN | A | 1139 | −0.390 | 1.278 | −16.803 | 1.00 | 1.00 | O |
| ATOM | 2571 | CB | ASN | A | 1139 | −2.940 | 1.775 | −18.582 | 1.00 | 1.00 | C |
| ATOM | 2572 | CG | ASN | A | 1139 | −2.470 | 3.027 | −17.912 | 1.00 | 1.00 | C |
| ATOM | 2573 | OD1 | ASN | A | 1139 | −1.704 | 3.783 | −18.533 | 1.00 | 1.00 | O |
| ATOM | 2574 | ND2 | ASN | A | 1139 | −2.887 | 3.279 | −16.637 | 1.00 | 1.00 | N |
| ATOM | 2575 | HA | ASN | A | 1139 | −0.924 | 1.282 | −19.175 | 1.00 | 1.00 | H |
| ATOM | 2576 | HB1 | ASN | A | 1139 | −3.830 | 1.377 | −18.085 | 1.00 | 1.00 | H |
| ATOM | 2577 | HB2 | ASN | A | 1139 | −3.232 | 1.964 | −19.623 | 1.00 | 1.00 | H |
| ATOM | 2578 | HD22 | ASN | A | 1139 | −2.557 | 4.103 | −16.179 | 1.00 | 1.00 | H |
| ATOM | 2579 | HD21 | ASN | A | 1139 | −3.442 | 2.708 | −16.055 | 1.00 | 1.00 | H |
| ATOM | 2580 | HN | ASN | A | 1139 | −3.046 | −0.681 | −19.541 | 1.00 | 1.00 | H |
| ATOM | 2581 | N | LEU | A | 1140 | −1.825 | −0.469 | −16.511 | 1.00 | 1.00 | N |
| ATOM | 2582 | CA | LEU | A | 1140 | −1.503 | −0.630 | −15.134 | 1.00 | 1.00 | C |
| ATOM | 2583 | C | LEU | A | 1140 | −0.074 | −1.001 | −15.080 | 1.00 | 1.00 | C |
| ATOM | 2584 | O | LEU | A | 1140 | 0.668 | −0.256 | −14.438 | 1.00 | 1.00 | O |
| ATOM | 2585 | CB | LEU | A | 1140 | −2.462 | −1.726 | −14.560 | 1.00 | 1.00 | C |
| ATOM | 2586 | CG | LEU | A | 1140 | −2.349 | −1.891 | −12.978 | 1.00 | 1.00 | C |
| ATOM | 2587 | CD1 | LEU | A | 1140 | −3.437 | −2.862 | −12.414 | 1.00 | 1.00 | C |
| ATOM | 2588 | CD2 | LEU | A | 1140 | −0.947 | −2.342 | −12.573 | 1.00 | 1.00 | C |
| ATOM | 2589 | HA | LEU | A | 1140 | −1.676 | 0.283 | −14.549 | 1.00 | 1.00 | H |
| ATOM | 2590 | HB1 | LEU | A | 1140 | −2.280 | −2.719 | −15.105 | 1.00 | 1.00 | H |
| ATOM | 2591 | HB2 | LEU | A | 1140 | −3.494 | −1.358 | −14.755 | 1.00 | 1.00 | H |
| ATOM | 2592 | HG | LEU | A | 1140 | −2.530 | −0.880 | −12.549 | 1.00 | 1.00 | H |
| ATOM | 2593 | HD21 | LEU | A | 1140 | −0.988 | −2.519 | −11.465 | 1.00 | 1.00 | H |
| ATOM | 2594 | HD22 | LEU | A | 1140 | −0.258 | −1.577 | −12.562 | 1.00 | 1.00 | H |
| ATOM | 2595 | HD23 | LEU | A | 1140 | −0.619 | −3.217 | −13.135 | 1.00 | 1.00 | H |
| ATOM | 2596 | HD11 | LEU | A | 1140 | −3.229 | −3.916 | −12.710 | 1.00 | 1.00 | H |
| ATOM | 2597 | HD12 | LEU | A | 1140 | −4.398 | −2.528 | −12.848 | 1.00 | 1.00 | H |
| ATOM | 2598 | HD13 | LEU | A | 1140 | −3.490 | −2.815 | −11.339 | 1.00 | 1.00 | H |
| ATOM | 2599 | HN | LEU | A | 1140 | −2.322 | −1.190 | −16.955 | 1.00 | 1.00 | H |
| ATOM | 2600 | N | TYR | A | 1141 | 0.383 | −2.084 | −15.689 | 1.00 | 1.00 | N |
| ATOM | 2601 | CA | TYR | A | 1141 | 1.784 | −2.353 | −15.613 | 1.00 | 1.00 | C |
| ATOM | 2602 | C | TYR | A | 1141 | 2.679 | −1.397 | −16.383 | 1.00 | 1.00 | C |
| ATOM | 2603 | O | TYR | A | 1141 | 3.718 | −0.994 | −15.902 | 1.00 | 1.00 | O |
| ATOM | 2604 | CB | TYR | A | 1141 | 2.156 | −3.870 | −15.820 | 1.00 | 1.00 | C |
| ATOM | 2605 | CG | TYR | A | 1141 | 1.799 | −4.310 | −17.206 | 1.00 | 1.00 | C |
| ATOM | 2606 | CD1 | TYR | A | 1141 | 0.658 | −5.128 | −17.411 | 1.00 | 1.00 | C |
| ATOM | 2607 | CD2 | TYR | A | 1141 | 2.555 | −3.963 | −18.324 | 1.00 | 1.00 | C |
| ATOM | 2608 | CE1 | TYR | A | 1141 | 0.424 | −5.669 | −18.677 | 1.00 | 1.00 | C |
| ATOM | 2609 | CE2 | TYR | A | 1141 | 2.283 | −4.471 | −19.595 | 1.00 | 1.00 | C |
| ATOM | 2610 | CZ | TYR | A | 1141 | 1.179 | −5.303 | −19.809 | 1.00 | 1.00 | C |
| ATOM | 2611 | OH | TYR | A | 1141 | 0.806 | −5.678 | −21.128 | 1.00 | 1.00 | O |
| ATOM | 2612 | HA | TYR | A | 1141 | 2.132 | −2.211 | −14.595 | 1.00 | 1.00 | H |
| ATOM | 2613 | HB2 | TYR | A | 1141 | 1.532 | −4.530 | −15.146 | 1.00 | 1.00 | H |
| ATOM | 2614 | HB1 | TYR | A | 1141 | 3.187 | −4.133 | −15.579 | 1.00 | 1.00 | H |
| ATOM | 2615 | HD2 | TYR | A | 1141 | 3.406 | −3.278 | −18.207 | 1.00 | 1.00 | H |
| ATOM | 2616 | HE2 | TYR | A | 1141 | 2.965 | −4.271 | −20.413 | 1.00 | 1.00 | H |
| ATOM | 2617 | HE1 | TYR | A | 1141 | −0.403 | −6.375 | −18.788 | 1.00 | 1.00 | H |
| ATOM | 2618 | HD1 | TYR | A | 1141 | −0.041 | −5.288 | −16.591 | 1.00 | 1.00 | H |
| ATOM | 2619 | HH | TYR | A | 1141 | 0.986 | −6.622 | −21.139 | 1.00 | 1.00 | H |
| ATOM | 2620 | HN | TYR | A | 1141 | −0.164 | −2.669 | −16.233 | 1.00 | 1.00 | H |
| ATOM | 2621 | N | VAL | A | 1142 | 2.284 | −0.965 | −17.573 | 1.00 | 1.00 | N |
| ATOM | 2622 | CA | VAL | A | 1142 | 3.132 | 0.003 | −18.277 | 1.00 | 1.00 | C |
| ATOM | 2623 | C | VAL | A | 1142 | 3.272 | 1.322 | −17.482 | 1.00 | 1.00 | C |
| ATOM | 2624 | O | VAL | A | 1142 | 4.414 | 1.753 | −17.297 | 1.00 | 1.00 | O |
| ATOM | 2625 | CB | VAL | A | 1142 | 2.604 | 0.393 | −19.704 | 1.00 | 1.00 | C |
| ATOM | 2626 | CG1 | VAL | A | 1142 | 3.428 | 1.535 | −20.262 | 1.00 | 1.00 | C |
| ATOM | 2627 | CG2 | VAL | A | 1142 | 2.523 | −0.771 | −20.695 | 1.00 | 1.00 | C |
| ATOM | 2628 | HA | VAL | A | 1142 | 4.140 | −0.442 | −18.370 | 1.00 | 1.00 | H |
| ATOM | 2629 | HB | VAL | A | 1142 | 1.562 | 0.790 | −19.559 | 1.00 | 1.00 | H |
| ATOM | 2630 | HG11 | VAL | A | 1142 | 4.498 | 1.335 | −20.198 | 1.00 | 1.00 | H |
| ATOM | 2631 | HG12 | VAL | A | 1142 | 3.225 | 2.481 | −19.773 | 1.00 | 1.00 | H |
| ATOM | 2632 | HG13 | VAL | A | 1142 | 3.118 | 1.704 | −21.325 | 1.00 | 1.00 | H |
| ATOM | 2633 | HG21 | VAL | A | 1142 | 3.502 | −0.993 | −21.152 | 1.00 | 1.00 | H |
| ATOM | 2634 | HG22 | VAL | A | 1142 | 1.806 | −0.510 | −21.502 | 1.00 | 1.00 | H |
| ATOM | 2635 | HG23 | VAL | A | 1142 | 2.227 | −1.734 | −20.170 | 1.00 | 1.00 | H |
| ATOM | 2636 | HN | VAL | A | 1142 | 1.421 | −1.248 | −17.995 | 1.00 | 1.00 | H |
| ATOM | 2637 | N | SER | A | 1143 | 2.189 | 1.974 | −17.006 | 1.00 | 1.00 | N |
| ATOM | 2638 | CA | SER | A | 1143 | 2.399 | 3.147 | −16.103 | 1.00 | 1.00 | C |
| ATOM | 2639 | C | SER | A | 1143 | 3.138 | 2.754 | −14.853 | 1.00 | 1.00 | C |
| ATOM | 2640 | O | SER | A | 1143 | 4.127 | 3.430 | −14.600 | 1.00 | 1.00 | O |
| ATOM | 2641 | CB | SER | A | 1143 | 1.022 | 3.809 | −15.734 | 1.00 | 1.00 | C |
| ATOM | 2642 | OG | SER | A | 1143 | 0.162 | 2.970 | −14.923 | 1.00 | 1.00 | O |
| ATOM | 2643 | HA | SER | A | 1143 | 3.028 | 3.886 | −16.594 | 1.00 | 1.00 | H |
| ATOM | 2644 | HB1 | SER | A | 1143 | 0.470 | 4.114 | −16.650 | 1.00 | 1.00 | H |
| ATOM | 2645 | HB2 | SER | A | 1143 | 1.135 | 4.652 | −15.026 | 1.00 | 1.00 | H |
| ATOM | 2646 | HG | SER | A | 1143 | −0.274 | 2.263 | −15.371 | 1.00 | 1.00 | H |
| ATOM | 2647 | HN | SER | A | 1143 | 1.322 | 1.603 | −17.291 | 1.00 | 1.00 | H |
| ATOM | 2648 | N | LEU | A | 1144 | 2.700 | 1.761 | −14.113 | 1.00 | 1.00 | N |
| ATOM | 2649 | CA | LEU | A | 1144 | 3.449 | 1.426 | −12.920 | 1.00 | 1.00 | C |
| ATOM | 2650 | C | LEU | A | 1144 | 4.926 | 1.275 | −13.269 | 1.00 | 1.00 | C |
| ATOM | 2651 | O | LEU | A | 1144 | 5.698 | 1.915 | −12.547 | 1.00 | 1.00 | O |
| ATOM | 2652 | CB | LEU | A | 1144 | 2.918 | 0.101 | −12.260 | 1.00 | 1.00 | C |
| ATOM | 2653 | CG | LEU | A | 1144 | 3.749 | −0.319 | −11.032 | 1.00 | 1.00 | C |
| ATOM | 2654 | CD1 | LEU | A | 1144 | 3.862 | 0.771 | −9.974 | 1.00 | 1.00 | C |
| ATOM | 2655 | CD2 | LEU | A | 1144 | 3.087 | −1.598 | −10.405 | 1.00 | 1.00 | C |
| ATOM | 2656 | HA | LEU | A | 1144 | 3.253 | 2.264 | −12.202 | 1.00 | 1.00 | H |
| ATOM | 2657 | HB1 | LEU | A | 1144 | 2.919 | −0.739 | −12.963 | 1.00 | 1.00 | H |
| ATOM | 2658 | HB2 | LEU | A | 1144 | 1.863 | 0.233 | −11.967 | 1.00 | 1.00 | H |
| ATOM | 2659 | HG | LEU | A | 1144 | 4.791 | −0.474 | −11.397 | 1.00 | 1.00 | H |
| ATOM | 2660 | HD21 | LEU | A | 1144 | 2.063 | −1.472 | −9.994 | 1.00 | 1.00 | H |
| ATOM | 2661 | HD22 | LEU | A | 1144 | 3.780 | −1.890 | −9.612 | 1.00 | 1.00 | H |
| ATOM | 2662 | HD23 | LEU | A | 1144 | 3.016 | −2.422 | −11.174 | 1.00 | 1.00 | H |
| ATOM | 2663 | HD11 | LEU | A | 1144 | 4.432 | 0.414 | −9.119 | 1.00 | 1.00 | H |
| ATOM | 2664 | HD12 | LEU | A | 1144 | 2.892 | 1.166 | −9.734 | 1.00 | 1.00 | H |
| ATOM | 2665 | HD13 | LEU | A | 1144 | 4.468 | 1.609 | −10.331 | 1.00 | 1.00 | H |
| ATOM | 2666 | HN | LEU | A | 1144 | 1.830 | 1.316 | −14.291 | 1.00 | 1.00 | H |
| ATOM | 2667 | N | LEU | A | 1145 | 5.369 | 0.609 | −14.367 | 1.00 | 1.00 | N |
| ATOM | 2668 | CA | LEU | A | 1145 | 6.798 | 0.419 | −14.652 | 1.00 | 1.00 | C |
| ATOM | 2669 | C | LEU | A | 1145 | 7.504 | 1.774 | −14.700 | 1.00 | 1.00 | C |
| ATOM | 2670 | O | LEU | A | 1145 | 8.503 | 2.007 | −14.047 | 1.00 | 1.00 | O |
| ATOM | 2671 | CB | LEU | A | 1145 | 6.962 | −0.392 | −15.994 | 1.00 | 1.00 | C |
| ATOM | 2672 | CG | LEU | A | 1145 | 8.499 | −0.559 | −16.314 | 1.00 | 1.00 | C |
| ATOM | 2673 | CD1 | LEU | A | 1145 | 9.206 | −1.431 | −15.196 | 1.00 | 1.00 | C |
| ATOM | 2674 | CD2 | LEU | A | 1145 | 8.648 | −1.290 | −17.707 | 1.00 | 1.00 | C |
| ATOM | 2675 | HA | LEU | A | 1145 | 7.210 | −0.120 | −13.827 | 1.00 | 1.00 | H |
| ATOM | 2676 | HB1 | LEU | A | 1145 | 6.511 | 0.200 | −16.814 | 1.00 | 1.00 | H |
| ATOM | 2677 | HB2 | LEU | A | 1145 | 6.423 | −1.338 | −15.793 | 1.00 | 1.00 | H |
| ATOM | 2678 | HG | LEU | A | 1145 | 9.128 | 0.379 | −16.455 | 1.00 | 1.00 | H |
| ATOM | 2679 | HD21 | LEU | A | 1145 | 9.725 | −1.542 | −17.850 | 1.00 | 1.00 | H |
| ATOM | 2680 | HD22 | LEU | A | 1145 | 8.432 | −0.590 | −18.517 | 1.00 | 1.00 | H |
| ATOM | 2681 | HD23 | LEU | A | 1145 | 8.079 | −2.249 | −17.837 | 1.00 | 1.00 | H |
| ATOM | 2682 | HD11 | LEU | A | 1145 | 10.154 | −1.845 | −15.455 | 1.00 | 1.00 | H |
| ATOM | 2683 | HD12 | LEU | A | 1145 | 8.562 | −2.304 | −15.116 | 1.00 | 1.00 | H |
| ATOM | 2684 | HD13 | LEU | A | 1145 | 9.309 | −1.009 | −14.204 | 1.00 | 1.00 | H |
| ATOM | 2685 | HN | LEU | A | 1145 | 4.696 | 0.273 | −15.011 | 1.00 | 1.00 | H |
| ATOM | 2686 | N | LEU | A | 1146 | 6.918 | 2.685 | −15.464 | 1.00 | 1.00 | N |
| ATOM | 2687 | CA | LEU | A | 1146 | 7.442 | 4.036 | −15.545 | 1.00 | 1.00 | C |
| ATOM | 2688 | C | LEU | A | 1146 | 7.495 | 4.730 | −14.233 | 1.00 | 1.00 | C |
| ATOM | 2689 | O | LEU | A | 1146 | 8.443 | 5.460 | −13.920 | 1.00 | 1.00 | O |
| ATOM | 2690 | CB | LEU | A | 1146 | 6.649 | 4.932 | −16.550 | 1.00 | 1.00 | C |
| ATOM | 2691 | CG | LEU | A | 1146 | 6.662 | 4.517 | −18.052 | 1.00 | 1.00 | C |
| ATOM | 2692 | CD1 | LEU | A | 1146 | 5.685 | 5.455 | −18.843 | 1.00 | 1.00 | C |
| ATOM | 2693 | CD2 | LEU | A | 1146 | 8.091 | 4.619 | −18.721 | 1.00 | 1.00 | C |
| ATOM | 2694 | HA | LEU | A | 1146 | 8.434 | 3.905 | −15.894 | 1.00 | 1.00 | H |
| ATOM | 2695 | HB1 | LEU | A | 1146 | 7.122 | 5.948 | −16.481 | 1.00 | 1.00 | H |
| ATOM | 2696 | HB2 | LEU | A | 1146 | 5.597 | 4.987 | −16.189 | 1.00 | 1.00 | H |
| ATOM | 2697 | HG | LEU | A | 1146 | 6.378 | 3.480 | −18.230 | 1.00 | 1.00 | H |
| ATOM | 2698 | HD21 | LEU | A | 1146 | 8.037 | 4.511 | −19.805 | 1.00 | 1.00 | H |
| ATOM | 2699 | HD22 | LEU | A | 1146 | 8.773 | 3.757 | −18.392 | 1.00 | 1.00 | H |
| ATOM | 2700 | HD23 | LEU | A | 1146 | 8.543 | 5.582 | −18.532 | 1.00 | 1.00 | H |
| ATOM | 2701 | HD11 | LEU | A | 1146 | 4.643 | 5.534 | −18.439 | 1.00 | 1.00 | H |
| ATOM | 2702 | HD12 | LEU | A | 1146 | 5.577 | 5.272 | −19.932 | 1.00 | 1.00 | H |
| ATOM | 2703 | HD13 | LEU | A | 1146 | 6.093 | 6.510 | −18.691 | 1.00 | 1.00 | H |
| ATOM | 2704 | HN | LEU | A | 1146 | 6.093 | 2.485 | −15.953 | 1.00 | 1.00 | H |
| ATOM | 2705 | N | LEU | A | 1147 | 6.472 | 4.539 | −13.418 | 1.00 | 1.00 | N |
| ATOM | 2706 | CA | LEU | A | 1147 | 6.426 | 5.262 | −12.130 | 1.00 | 1.00 | C |
| ATOM | 2707 | C | LEU | A | 1147 | 7.496 | 4.727 | −11.210 | 1.00 | 1.00 | C |
| ATOM | 2708 | O | LEU | A | 1147 | 8.312 | 5.455 | −10.630 | 1.00 | 1.00 | O |
| ATOM | 2709 | CB | LEU | A | 1147 | 5.079 | 5.276 | −11.412 | 1.00 | 1.00 | C |
| ATOM | 2710 | CG | LEU | A | 1147 | 3.905 | 5.942 | −12.191 | 1.00 | 1.00 | C |
| ATOM | 2711 | CD1 | LEU | A | 1147 | 2.548 | 5.729 | −11.449 | 1.00 | 1.00 | C |
| ATOM | 2712 | CD2 | LEU | A | 1147 | 4.228 | 7.452 | −12.438 | 1.00 | 1.00 | C |
| ATOM | 2713 | HA | LEU | A | 1147 | 6.744 | 6.293 | −12.341 | 1.00 | 1.00 | H |
| ATOM | 2714 | HB1 | LEU | A | 1147 | 5.234 | 5.778 | −10.454 | 1.00 | 1.00 | H |
| ATOM | 2715 | HB2 | LEU | A | 1147 | 4.738 | 4.274 | −11.155 | 1.00 | 1.00 | H |
| ATOM | 2716 | HG | LEU | A | 1147 | 3.716 | 5.481 | −13.166 | 1.00 | 1.00 | H |
| ATOM | 2717 | HD21 | LEU | A | 1147 | 5.122 | 7.611 | −13.082 | 1.00 | 1.00 | H |
| ATOM | 2718 | HD22 | LEU | A | 1147 | 4.357 | 7.997 | −11.499 | 1.00 | 1.00 | H |
| ATOM | 2719 | HD23 | LEU | A | 1147 | 3.431 | 7.933 | −12.956 | 1.00 | 1.00 | H |
| ATOM | 2720 | HD11 | LEU | A | 1147 | 2.317 | 4.705 | −11.189 | 1.00 | 1.00 | H |
| ATOM | 2721 | HD12 | LEU | A | 1147 | 1.694 | 6.176 | −12.045 | 1.00 | 1.00 | H |
| ATOM | 2722 | HD13 | LEU | A | 1147 | 2.488 | 6.344 | −10.524 | 1.00 | 1.00 | H |
| ATOM | 2723 | HN | LEU | A | 1147 | 5.773 | 3.835 | −13.611 | 1.00 | 1.00 | H |
| ATOM | 2724 | N | TYR | A | 1148 | 7.635 | 3.388 | −11.003 | 1.00 | 1.00 | N |
| ATOM | 2725 | CA | TYR | A | 1148 | 8.811 | 2.908 | −10.275 | 1.00 | 1.00 | C |
| ATOM | 2726 | C | TYR | A | 1148 | 10.073 | 3.391 | −10.974 | 1.00 | 1.00 | C |
| ATOM | 2727 | O | TYR | A | 1148 | 10.958 | 3.922 | −10.372 | 1.00 | 1.00 | O |
| ATOM | 2728 | CB | TYR | A | 1148 | 8.908 | 1.365 | −10.235 | 1.00 | 1.00 | C |
| ATOM | 2729 | CG | TYR | A | 1148 | 10.112 | 0.898 | −9.422 | 1.00 | 1.00 | C |
| ATOM | 2730 | CD1 | TYR | A | 1148 | 11.403 | 0.925 | −9.966 | 1.00 | 1.00 | C |
| ATOM | 2731 | CD2 | TYR | A | 1148 | 9.959 | 0.446 | −8.092 | 1.00 | 1.00 | C |
| ATOM | 2732 | CE1 | TYR | A | 1148 | 12.535 | 0.612 | −9.198 | 1.00 | 1.00 | C |
| ATOM | 2733 | CE2 | TYR | A | 1148 | 11.075 | 0.090 | −7.346 | 1.00 | 1.00 | C |
| ATOM | 2734 | CZ | TYR | A | 1148 | 12.367 | 0.063 | −7.914 | 1.00 | 1.00 | C |
| ATOM | 2735 | OH | TYR | A | 1148 | 13.452 | −0.458 | −7.222 | 1.00 | 1.00 | O |
| ATOM | 2736 | HA | TYR | A | 1148 | 8.771 | 3.256 | −9.232 | 1.00 | 1.00 | H |
| ATOM | 2737 | HB2 | TYR | A | 1148 | 8.886 | 0.836 | −11.209 | 1.00 | 1.00 | H |
| ATOM | 2738 | HB1 | TYR | A | 1148 | 7.989 | 1.022 | −9.710 | 1.00 | 1.00 | H |
| ATOM | 2739 | HD2 | TYR | A | 1148 | 8.971 | 0.366 | −7.706 | 1.00 | 1.00 | H |
| ATOM | 2740 | HE2 | TYR | A | 1148 | 10.967 | −0.221 | −6.282 | 1.00 | 1.00 | H |
| ATOM | 2741 | HE1 | TYR | A | 1148 | 13.517 | 0.683 | −9.556 | 1.00 | 1.00 | H |
| ATOM | 2742 | HD1 | TYR | A | 1148 | 11.486 | 1.142 | −11.005 | 1.00 | 1.00 | H |
| ATOM | 2743 | HH | TYR | A | 1148 | 13.851 | −1.056 | −7.845 | 1.00 | 1.00 | H |
| ATOM | 2744 | HN | TYR | A | 1148 | 7.046 | 2.706 | −11.417 | 1.00 | 1.00 | H |
| ATOM | 2745 | N | GLN | A | 1149 | 10.219 | 3.224 | −12.304 | 1.00 | 1.00 | N |
| ATOM | 2746 | CA | GLN | A | 1149 | 11.443 | 3.687 | −12.927 | 1.00 | 1.00 | C |
| ATOM | 2747 | C | GLN | A | 1149 | 11.689 | 5.187 | −12.632 | 1.00 | 1.00 | C |
| ATOM | 2748 | O | GLN | A | 1149 | 12.853 | 5.538 | −12.515 | 1.00 | 1.00 | O |
| ATOM | 2749 | CB | GLN | A | 1149 | 11.256 | 3.587 | −14.433 | 1.00 | 1.00 | C |
| ATOM | 2750 | CG | GLN | A | 1149 | 12.600 | 3.911 | −15.217 | 1.00 | 1.00 | C |
| ATOM | 2751 | CD | GLN | A | 1149 | 12.503 | 3.860 | −16.762 | 1.00 | 1.00 | C |
| ATOM | 2752 | OE1 | GLN | A | 1149 | 13.057 | 2.975 | −17.381 | 1.00 | 1.00 | O |
| ATOM | 2753 | NE2 | GLN | A | 1149 | 11.849 | 4.793 | −17.445 | 1.00 | 1.00 | N |
| ATOM | 2754 | HA | GLN | A | 1149 | 12.323 | 3.126 | −12.571 | 1.00 | 1.00 | H |
| ATOM | 2755 | HB1 | GLN | A | 1149 | 10.522 | 4.339 | −14.776 | 1.00 | 1.00 | H |
| ATOM | 2756 | HB2 | GLN | A | 1149 | 10.988 | 2.572 | −14.723 | 1.00 | 1.00 | H |
| ATOM | 2757 | HG1 | GLN | A | 1149 | 13.459 | 3.304 | −14.947 | 1.00 | 1.00 | H |
| ATOM | 2758 | HG2 | GLN | A | 1149 | 12.926 | 4.936 | −14.961 | 1.00 | 1.00 | H |
| ATOM | 2759 | HE22 | GLN | A | 1149 | 11.874 | 4.753 | −18.448 | 1.00 | 1.00 | H |
| ATOM | 2760 | HE21 | GLN | A | 1149 | 11.329 | 5.515 | −16.973 | 1.00 | 1.00 | H |
| ATOM | 2761 | HN | GLN | A | 1149 | 9.475 | 2.777 | −12.848 | 1.00 | 1.00 | H |
| ATOM | 2762 | N | THR | A | 1150 | 10.591 | 6.021 | −12.564 | 1.00 | 1.00 | N |
| ATOM | 2763 | CA | THR | A | 1150 | 10.744 | 7.475 | −12.380 | 1.00 | 1.00 | C |
| ATOM | 2764 | C | THR | A | 1150 | 11.060 | 7.796 | −10.909 | 1.00 | 1.00 | C |
| ATOM | 2765 | O | THR | A | 1150 | 12.048 | 8.480 | −10.651 | 1.00 | 1.00 | O |
| ATOM | 2766 | CB | THR | A | 1150 | 9.564 | 8.339 | −12.824 | 1.00 | 1.00 | C |
| ATOM | 2767 | OG1 | THR | A | 1150 | 9.436 | 8.261 | −14.284 | 1.00 | 1.00 | O |
| ATOM | 2768 | CG2 | THR | A | 1150 | 9.873 | 9.776 | −12.396 | 1.00 | 1.00 | C |
| ATOM | 2769 | HA | THR | A | 1150 | 11.636 | 7.836 | −12.963 | 1.00 | 1.00 | H |
| ATOM | 2770 | HB | THR | A | 1150 | 8.563 | 8.084 | −12.381 | 1.00 | 1.00 | H |
| ATOM | 2771 | HG1 | THR | A | 1150 | 9.073 | 7.425 | −14.633 | 1.00 | 1.00 | H |
| ATOM | 2772 | HG23 | THR | A | 1150 | 9.207 | 10.489 | −12.807 | 1.00 | 1.00 | H |
| ATOM | 2773 | HG21 | THR | A | 1150 | 10.835 | 10.125 | −12.854 | 1.00 | 1.00 | H |
| ATOM | 2774 | HG22 | THR | A | 1150 | 9.912 | 9.914 | −11.331 | 1.00 | 1.00 | H |
| ATOM | 2775 | HN | THR | A | 1150 | 9.627 | 5.761 | −12.622 | 1.00 | 1.00 | H |
| ATOM | 2776 | N | PHE | A | 1151 | 10.294 | 7.233 | −9.883 | 1.00 | 1.00 | N |
| ATOM | 2777 | CA | PHE | A | 1151 | 10.556 | 7.501 | −8.450 | 1.00 | 1.00 | C |
| ATOM | 2778 | C | PHE | A | 1151 | 11.306 | 6.307 | −7.827 | 1.00 | 1.00 | C |
| ATOM | 2779 | O | PHE | A | 1151 | 12.359 | 6.487 | −7.220 | 1.00 | 1.00 | O |
| ATOM | 2780 | CB | PHE | A | 1151 | 9.212 | 7.887 | −7.671 | 1.00 | 1.00 | C |
| ATOM | 2781 | CG | PHE | A | 1151 | 8.631 | 8.999 | −8.531 | 1.00 | 1.00 | C |
| ATOM | 2782 | CD1 | PHE | A | 1151 | 9.287 | 10.240 | −8.573 | 1.00 | 1.00 | C |
| ATOM | 2783 | CD2 | PHE | A | 1151 | 7.530 | 8.747 | −9.346 | 1.00 | 1.00 | C |
| ATOM | 2784 | CE1 | PHE | A | 1151 | 8.839 | 11.187 | −9.500 | 1.00 | 1.00 | C |
| ATOM | 2785 | CE2 | PHE | A | 1151 | 7.169 | 9.679 | −10.309 | 1.00 | 1.00 | C |
| ATOM | 2786 | CZ | PHE | A | 1151 | 7.801 | 10.902 | −10.380 | 1.00 | 1.00 | C |
| ATOM | 2787 | HA | PHE | A | 1151 | 11.298 | 8.301 | −8.417 | 1.00 | 1.00 | H |
| ATOM | 2788 | HB1 | PHE | A | 1151 | 9.356 | 8.287 | −6.641 | 1.00 | 1.00 | H |
| ATOM | 2789 | HB2 | PHE | A | 1151 | 8.535 | 7.032 | −7.662 | 1.00 | 1.00 | H |
| ATOM | 2790 | HD2 | PHE | A | 1151 | 6.971 | 7.846 | −9.252 | 1.00 | 1.00 | H |
| ATOM | 2791 | HE2 | PHE | A | 1151 | 6.335 | 9.380 | −10.999 | 1.00 | 1.00 | H |
| ATOM | 2792 | HZ | PHE | A | 1151 | 7.549 | 11.606 | −11.159 | 1.00 | 1.00 | H |
| ATOM | 2793 | HE1 | PHE | A | 1151 | 9.359 | 12.146 | −9.558 | 1.00 | 1.00 | H |
| ATOM | 2794 | HD1 | PHE | A | 1151 | 10.026 | 10.410 | −7.850 | 1.00 | 1.00 | H |
| ATOM | 2795 | HN | PHE | A | 1151 | 9.534 | 6.684 | −10.145 | 1.00 | 1.00 | H |
| ATOM | 2796 | N | GLY | A | 1152 | 10.678 | 5.116 | −7.944 | 1.00 | 1.00 | N |
| ATOM | 2797 | CA | GLY | A | 1152 | 11.260 | 3.951 | −7.322 | 1.00 | 1.00 | C |
| ATOM | 2798 | C | GLY | A | 1152 | 11.359 | 3.942 | −5.869 | 1.00 | 1.00 | C |
| ATOM | 2799 | O | GLY | A | 1152 | 10.586 | 3.257 | −5.193 | 1.00 | 1.00 | O |
| ATOM | 2800 | HA2 | GLY | A | 1152 | 12.251 | 3.836 | −7.787 | 1.00 | 1.00 | H |
| ATOM | 2801 | HA1 | GLY | A | 1152 | 10.669 | 3.030 | −7.635 | 1.00 | 1.00 | H |
| ATOM | 2802 | HN | GLY | A | 1152 | 9.824 | 5.093 | −8.451 | 1.00 | 1.00 | H |
| ATOM | 2803 | N | ARG | A | 1153 | 12.328 | 4.704 | −5.332 | 1.00 | 1.00 | N |
| ATOM | 2804 | CA | ARG | A | 1153 | 12.698 | 4.574 | −3.931 | 1.00 | 1.00 | C |
| ATOM | 2805 | C | ARG | A | 1153 | 12.956 | 5.904 | −3.260 | 1.00 | 1.00 | C |
| ATOM | 2806 | O | ARG | A | 1153 | 13.006 | 6.858 | −4.013 | 1.00 | 1.00 | O |
| ATOM | 2807 | CB | ARG | A | 1153 | 13.924 | 3.600 | −3.885 | 1.00 | 1.00 | C |
| ATOM | 2808 | CG | ARG | A | 1153 | 13.435 | 2.139 | −4.075 | 1.00 | 1.00 | C |
| ATOM | 2809 | CD | ARG | A | 1153 | 14.566 | 1.045 | −4.103 | 1.00 | 1.00 | C |
| ATOM | 2810 | NE | ARG | A | 1153 | 13.920 | −0.191 | −4.490 | 1.00 | 1.00 | N |
| ATOM | 2811 | CZ | ARG | A | 1153 | 13.389 | −0.997 | −3.593 | 1.00 | 1.00 | C |
| ATOM | 2812 | NH1 | ARG | A | 1153 | 13.407 | −0.844 | −2.298 | 1.00 | 1.00 | N |
| ATOM | 2813 | NH2 | ARG | A | 1153 | 12.720 | −1.994 | −4.101 | 1.00 | 1.00 | N |
| ATOM | 2814 | HA | ARG | A | 1153 | 11.814 | 4.217 | −3.359 | 1.00 | 1.00 | H |
| ATOM | 2815 | HB1 | ARG | A | 1153 | 14.448 | 3.728 | −2.939 | 1.00 | 1.00 | H |
| ATOM | 2816 | HB2 | ARG | A | 1153 | 14.676 | 3.819 | −4.699 | 1.00 | 1.00 | H |
| ATOM | 2817 | HG1 | ARG | A | 1153 | 12.951 | 2.076 | −5.021 | 1.00 | 1.00 | H |
| ATOM | 2818 | HG2 | ARG | A | 1153 | 12.701 | 1.812 | −3.267 | 1.00 | 1.00 | H |
| ATOM | 2819 | HD1 | ARG | A | 1153 | 15.202 | 1.099 | −3.260 | 1.00 | 1.00 | H |
| ATOM | 2820 | HD2 | ARG | A | 1153 | 15.264 | 1.417 | −4.894 | 1.00 | 1.00 | H |
| ATOM | 2821 | HE | ARG | A | 1153 | 13.874 | −0.374 | −5.512 | 1.00 | 1.00 | H |
| ATOM | 2822 | HH12 | ARG | A | 1153 | 12.833 | −1.483 | −1.758 | 1.00 | 1.00 | H |
| ATOM | 2823 | HH11 | ARG | A | 1153 | 14.027 | −0.175 | −1.807 | 1.00 | 1.00 | H |
| ATOM | 2824 | HH22 | ARG | A | 1153 | 12.271 | −2.669 | −3.458 | 1.00 | 1.00 | H |
| ATOM | 2825 | HH21 | ARG | A | 1153 | 12.614 | −2.141 | −5.096 | 1.00 | 1.00 | H |
| ATOM | 2826 | HN | ARG | A | 1153 | 12.963 | 5.221 | −5.880 | 1.00 | 1.00 | H |
| ATOM | 2827 | N | LYS | A | 1154 | 13.123 | 6.053 | −1.922 | 1.00 | 1.00 | N |
| ATOM | 2828 | CA | LYS | A | 1154 | 12.885 | 5.004 | −0.957 | 1.00 | 1.00 | C |
| ATOM | 2829 | C | LYS | A | 1154 | 11.483 | 5.298 | −0.382 | 1.00 | 1.00 | C |
| ATOM | 2830 | O | LYS | A | 1154 | 11.440 | 6.156 | 0.480 | 1.00 | 1.00 | O |
| ATOM | 2831 | CB | LYS | A | 1154 | 14.028 | 5.115 | 0.083 | 1.00 | 1.00 | C |
| ATOM | 2832 | CG | LYS | A | 1154 | 13.714 | 4.114 | 1.242 | 1.00 | 1.00 | C |
| ATOM | 2833 | CD | LYS | A | 1154 | 14.699 | 4.185 | 2.419 | 1.00 | 1.00 | C |
| ATOM | 2834 | CE | LYS | A | 1154 | 14.550 | 3.088 | 3.518 | 1.00 | 1.00 | C |
| ATOM | 2835 | NZ | LYS | A | 1154 | 14.928 | 1.682 | 3.208 | 1.00 | 1.00 | N |
| ATOM | 2836 | HA | LYS | A | 1154 | 12.847 | 3.988 | −1.343 | 1.00 | 1.00 | H |
| ATOM | 2837 | HB1 | LYS | A | 1154 | 14.060 | 6.127 | 0.459 | 1.00 | 1.00 | H |
| ATOM | 2838 | HB2 | LYS | A | 1154 | 14.956 | 4.857 | −0.417 | 1.00 | 1.00 | H |
| ATOM | 2839 | HG1 | LYS | A | 1154 | 13.754 | 3.086 | 0.819 | 1.00 | 1.00 | H |
| ATOM | 2840 | HG2 | LYS | A | 1154 | 12.772 | 4.250 | 1.740 | 1.00 | 1.00 | H |
| ATOM | 2841 | HD1 | LYS | A | 1154 | 14.559 | 5.190 | 2.845 | 1.00 | 1.00 | H |
| ATOM | 2842 | HD2 | LYS | A | 1154 | 15.753 | 4.078 | 2.079 | 1.00 | 1.00 | H |
| ATOM | 2843 | HE1 | LYS | A | 1154 | 13.478 | 3.095 | 3.743 | 1.00 | 1.00 | H |
| ATOM | 2844 | HE2 | LYS | A | 1154 | 15.038 | 3.438 | 4.413 | 1.00 | 1.00 | H |
| ATOM | 2845 | HZ1 | LYS | A | 1154 | 14.808 | 1.217 | 4.145 | 1.00 | 1.00 | H |
| ATOM | 2846 | HZ2 | LYS | A | 1154 | 15.916 | 1.486 | 2.925 | 1.00 | 1.00 | H |
| ATOM | 2847 | HZ3 | LYS | A | 1154 | 14.326 | 1.121 | 2.448 | 1.00 | 1.00 | H |
| ATOM | 2848 | HN | LYS | A | 1154 | 13.261 | 6.982 | −1.580 | 1.00 | 1.00 | H |
| ATOM | 2849 | N | LEU | A | 1155 | 10.368 | 4.584 | −0.750 | 1.00 | 1.00 | N |
| ATOM | 2850 | CA | LEU | A | 1155 | 9.192 | 4.686 | 0.056 | 1.00 | 1.00 | C |
| ATOM | 2851 | C | LEU | A | 1155 | 9.454 | 4.272 | 1.528 | 1.00 | 1.00 | C |
| ATOM | 2852 | O | LEU | A | 1155 | 9.425 | 3.096 | 1.843 | 1.00 | 1.00 | O |
| ATOM | 2853 | CB | LEU | A | 1155 | 8.070 | 3.732 | −0.516 | 1.00 | 1.00 | C |
| ATOM | 2854 | CG | LEU | A | 1155 | 6.733 | 3.804 | 0.233 | 1.00 | 1.00 | C |
| ATOM | 2855 | CD1 | LEU | A | 1155 | 6.017 | 5.197 | 0.245 | 1.00 | 1.00 | C |
| ATOM | 2856 | CD2 | LEU | A | 1155 | 5.779 | 2.774 | −0.382 | 1.00 | 1.00 | C |
| ATOM | 2857 | HA | LEU | A | 1155 | 8.899 | 5.768 | 0.040 | 1.00 | 1.00 | H |
| ATOM | 2858 | HB1 | LEU | A | 1155 | 8.525 | 2.739 | −0.516 | 1.00 | 1.00 | H |
| ATOM | 2859 | HB2 | LEU | A | 1155 | 7.831 | 4.106 | −1.548 | 1.00 | 1.00 | H |
| ATOM | 2860 | HG | LEU | A | 1155 | 6.798 | 3.641 | 1.377 | 1.00 | 1.00 | H |
| ATOM | 2861 | HD21 | LEU | A | 1155 | 6.137 | 1.752 | −0.319 | 1.00 | 1.00 | H |
| ATOM | 2862 | HD22 | LEU | A | 1155 | 5.518 | 3.025 | −1.400 | 1.00 | 1.00 | H |
| ATOM | 2863 | HD23 | LEU | A | 1155 | 4.827 | 2.798 | 0.218 | 1.00 | 1.00 | H |
| ATOM | 2864 | HD11 | LEU | A | 1155 | 5.743 | 5.472 | −0.762 | 1.00 | 1.00 | H |
| ATOM | 2865 | HD12 | LEU | A | 1155 | 6.682 | 5.959 | 0.634 | 1.00 | 1.00 | H |
| ATOM | 2866 | HD13 | LEU | A | 1155 | 5.069 | 5.216 | 0.849 | 1.00 | 1.00 | H |
| ATOM | 2867 | HN | LEU | A | 1155 | 10.423 | 3.905 | −1.482 | 1.00 | 1.00 | H |
| ATOM | 2868 | N | HIS | A | 1156 | 9.737 | 5.208 | 2.450 | 1.00 | 1.00 | N |
| ATOM | 2869 | CA | HIS | A | 1156 | 9.937 | 4.900 | 3.870 | 1.00 | 1.00 | C |
| ATOM | 2870 | C | HIS | A | 1156 | 8.638 | 4.596 | 4.513 | 1.00 | 1.00 | C |
| ATOM | 2871 | O | HIS | A | 1156 | 8.137 | 5.370 | 5.304 | 1.00 | 1.00 | O |
| ATOM | 2872 | CB | HIS | A | 1156 | 10.778 | 6.053 | 4.518 | 1.00 | 1.00 | C |
| ATOM | 2873 | CG | HIS | A | 1156 | 11.137 | 5.771 | 5.990 | 1.00 | 1.00 | C |
| ATOM | 2874 | ND1 | HIS | A | 1156 | 10.280 | 5.762 | 7.009 | 1.00 | 1.00 | N |
| ATOM | 2875 | CD2 | HIS | A | 1156 | 12.395 | 5.511 | 6.428 | 1.00 | 1.00 | C |
| ATOM | 2876 | CE1 | HIS | A | 1156 | 10.983 | 5.441 | 8.080 | 1.00 | 1.00 | C |
| ATOM | 2877 | NE2 | HIS | A | 1156 | 12.187 | 5.303 | 7.828 | 1.00 | 1.00 | N |
| ATOM | 2878 | HA | HIS | A | 1156 | 10.555 | 3.969 | 3.846 | 1.00 | 1.00 | H |
| ATOM | 2879 | HB1 | HIS | A | 1156 | 10.215 | 6.990 | 4.425 | 1.00 | 1.00 | H |
| ATOM | 2880 | HB2 | HIS | A | 1156 | 11.651 | 6.133 | 3.910 | 1.00 | 1.00 | H |
| ATOM | 2881 | HD2 | HIS | A | 1156 | 13.319 | 5.448 | 5.878 | 1.00 | 1.00 | H |
| ATOM | 2882 | HE1 | HIS | A | 1156 | 10.519 | 5.296 | 9.076 | 1.00 | 1.00 | H |
| ATOM | 2883 | HD1 | HIS | A | 1156 | 9.234 | 5.916 | 6.960 | 1.00 | 1.00 | H |
| ATOM | 2884 | HN | HIS | A | 1156 | 9.803 | 6.186 | 2.155 | 1.00 | 1.00 | H |
| ATOM | 2885 | N | LEU | A | 1157 | 8.056 | 3.445 | 4.117 | 1.00 | 1.00 | N |
| ATOM | 2886 | CA | LEU | A | 1157 | 6.794 | 2.916 | 4.719 | 1.00 | 1.00 | C |
| ATOM | 2887 | C | LEU | A | 1157 | 7.007 | 2.809 | 6.217 | 1.00 | 1.00 | C |
| ATOM | 2888 | O | LEU | A | 1157 | 8.154 | 2.531 | 6.571 | 1.00 | 1.00 | O |
| ATOM | 2889 | CB | LEU | A | 1157 | 6.297 | 1.635 | 3.970 | 1.00 | 1.00 | C |
| ATOM | 2890 | CG | LEU | A | 1157 | 5.014 | 0.959 | 4.584 | 1.00 | 1.00 | C |
| ATOM | 2891 | CD1 | LEU | A | 1157 | 4.339 | 0.197 | 3.476 | 1.00 | 1.00 | C |
| ATOM | 2892 | CD2 | LEU | A | 1157 | 5.392 | −0.021 | 5.734 | 1.00 | 1.00 | C |
| ATOM | 2893 | HA | LEU | A | 1157 | 6.037 | 3.672 | 4.525 | 1.00 | 1.00 | H |
| ATOM | 2894 | HB1 | LEU | A | 1157 | 7.114 | 0.885 | 4.019 | 1.00 | 1.00 | H |
| ATOM | 2895 | HB2 | LEU | A | 1157 | 6.159 | 1.863 | 2.912 | 1.00 | 1.00 | H |
| ATOM | 2896 | HG | LEU | A | 1157 | 4.421 | 1.723 | 5.056 | 1.00 | 1.00 | H |
| ATOM | 2897 | HD21 | LEU | A | 1157 | 4.528 | −0.445 | 6.240 | 1.00 | 1.00 | H |
| ATOM | 2898 | HD22 | LEU | A | 1157 | 6.064 | 0.440 | 6.497 | 1.00 | 1.00 | H |
| ATOM | 2899 | HD23 | LEU | A | 1157 | 6.005 | −0.778 | 5.302 | 1.00 | 1.00 | H |
| ATOM | 2900 | HD11 | LEU | A | 1157 | 5.089 | −0.382 | 2.889 | 1.00 | 1.00 | H |
| ATOM | 2901 | HD12 | LEU | A | 1157 | 3.688 | −0.601 | 3.806 | 1.00 | 1.00 | H |
| ATOM | 2902 | HD13 | LEU | A | 1157 | 3.823 | 0.950 | 2.853 | 1.00 | 1.00 | H |
| ATOM | 2903 | HN | LEU | A | 1157 | 8.415 | 2.896 | 3.377 | 1.00 | 1.00 | H |
| ATOM | 2904 | N | TYR | A | 1158 | 6.001 | 2.997 | 7.112 | 1.00 | 1.00 | N |
| ATOM | 2905 | CA | TYR | A | 1158 | 6.353 | 2.691 | 8.492 | 1.00 | 1.00 | C |
| ATOM | 2906 | C | TYR | A | 1158 | 5.180 | 2.340 | 9.420 | 1.00 | 1.00 | C |
| ATOM | 2907 | O | TYR | A | 1158 | 5.231 | 2.582 | 10.620 | 1.00 | 1.00 | O |
| ATOM | 2908 | CB | TYR | A | 1158 | 7.108 | 3.911 | 9.064 | 1.00 | 1.00 | C |
| ATOM | 2909 | CG | TYR | A | 1158 | 6.248 | 5.186 | 9.219 | 1.00 | 1.00 | C |
| ATOM | 2910 | CD1 | TYR | A | 1158 | 5.856 | 5.665 | 10.473 | 1.00 | 1.00 | C |
| ATOM | 2911 | CD2 | TYR | A | 1158 | 5.938 | 5.989 | 8.107 | 1.00 | 1.00 | C |
| ATOM | 2912 | CE1 | TYR | A | 1158 | 5.305 | 6.954 | 10.640 | 1.00 | 1.00 | C |
| ATOM | 2913 | CE2 | TYR | A | 1158 | 5.365 | 7.274 | 8.256 | 1.00 | 1.00 | C |
| ATOM | 2914 | CZ | TYR | A | 1158 | 5.140 | 7.799 | 9.536 | 1.00 | 1.00 | C |
| ATOM | 2915 | OH | TYR | A | 1158 | 4.730 | 9.142 | 9.708 | 1.00 | 1.00 | O |
| ATOM | 2916 | HA | TYR | A | 1158 | 6.993 | 1.801 | 8.552 | 1.00 | 1.00 | H |
| ATOM | 2917 | HB2 | TYR | A | 1158 | 7.952 | 4.117 | 8.428 | 1.00 | 1.00 | H |
| ATOM | 2918 | HB1 | TYR | A | 1158 | 7.505 | 3.602 | 10.063 | 1.00 | 1.00 | H |
| ATOM | 2919 | HD2 | TYR | A | 1158 | 6.128 | 5.658 | 7.128 | 1.00 | 1.00 | H |
| ATOM | 2920 | HE2 | TYR | A | 1158 | 5.152 | 7.853 | 7.423 | 1.00 | 1.00 | H |
| ATOM | 2921 | HE1 | TYR | A | 1158 | 5.011 | 7.328 | 11.643 | 1.00 | 1.00 | H |
| ATOM | 2922 | HD1 | TYR | A | 1158 | 6.076 | 5.039 | 11.331 | 1.00 | 1.00 | H |
| ATOM | 2923 | HH | TYR | A | 1158 | 4.229 | 9.453 | 8.961 | 1.00 | 1.00 | H |
| ATOM | 2924 | HN | TYR | A | 1158 | 5.103 | 3.351 | 6.854 | 1.00 | 1.00 | H |
| ATOM | 2925 | N | SER | A | 1159 | 4.126 | 1.736 | 8.901 | 1.00 | 1.00 | N |
| ATOM | 2926 | CA | SER | A | 1159 | 3.050 | 1.306 | 9.867 | 1.00 | 1.00 | C |
| ATOM | 2927 | C | SER | A | 1159 | 3.532 | 0.234 | 10.847 | 1.00 | 1.00 | C |
| ATOM | 2928 | O | SER | A | 1159 | 3.112 | 0.276 | 12.022 | 1.00 | 1.00 | O |
| ATOM | 2929 | CB | SER | A | 1159 | 1.900 | 0.681 | 9.043 | 1.00 | 1.00 | C |
| ATOM | 2930 | OG | SER | A | 1159 | 0.955 | 0.054 | 9.927 | 1.00 | 1.00 | O |
| ATOM | 2931 | HA | SER | A | 1159 | 2.737 | 2.175 | 10.411 | 1.00 | 1.00 | H |
| ATOM | 2932 | HB1 | SER | A | 1159 | 2.270 | −0.076 | 8.309 | 1.00 | 1.00 | H |
| ATOM | 2933 | HB2 | SER | A | 1159 | 1.416 | 1.452 | 8.527 | 1.00 | 1.00 | H |
| ATOM | 2934 | HG | SER | A | 1159 | 0.221 | −0.389 | 9.507 | 1.00 | 1.00 | H |
| ATOM | 2935 | HN | SER | A | 1159 | 4.069 | 1.542 | 7.910 | 1.00 | 1.00 | H |
| ATOM | 2936 | CB | HIE | A | 1160 | 4.117 | −3.099 | 10.768 | 1.00 | 1.00 | C |
| ATOM | 2937 | CG | HIE | A | 1160 | 4.124 | −4.317 | 11.624 | 1.00 | 1.00 | C |
| ATOM | 2938 | ND1 | HIE | A | 1160 | 4.956 | −4.587 | 12.771 | 1.00 | 1.00 | N |
| ATOM | 2939 | CD2 | HIE | A | 1160 | 3.396 | −5.438 | 11.595 | 1.00 | 1.00 | C |
| ATOM | 2940 | CE1 | HIE | A | 1160 | 4.629 | −5.686 | 13.310 | 1.00 | 1.00 | C |
| ATOM | 2941 | N | HIE | A | 1160 | 4.296 | −0.779 | 10.385 | 1.00 | 1.00 | N |
| ATOM | 2942 | CA | HIE | A | 1160 | 4.764 | −1.796 | 11.317 | 1.00 | 1.00 | C |
| ATOM | 2943 | C | HIE | A | 1160 | 6.255 | −1.683 | 11.254 | 1.00 | 1.00 | C |
| ATOM | 2944 | O | HIE | A | 1160 | 6.830 | −2.629 | 10.714 | 1.00 | 1.00 | O |
| ATOM | 2945 | HB2 | HIE | A | 1160 | 4.557 | −3.371 | 9.774 | 1.00 | 1.00 | H |
| ATOM | 2946 | NE2 | HIE | A | 1160 | 3.708 | −6.240 | 12.583 | 1.00 | 1.00 | N |
| ATOM | 2947 | HB1 | HIE | A | 1160 | 3.051 | −2.840 | 10.493 | 1.00 | 1.00 | H |
| ATOM | 2948 | HA | HIE | A | 1160 | 4.444 | −1.752 | 12.362 | 1.00 | 1.00 | H |
| ATOM | 2949 | HD2 | HIE | A | 1160 | 2.690 | −5.691 | 10.834 | 1.00 | 1.00 | H |
| ATOM | 2950 | HE1 | HIE | A | 1160 | 5.062 | −6.124 | 14.199 | 1.00 | 1.00 | H |
| ATOM | 2951 | H | HIE | A | 1160 | 4.535 | −0.797 | 9.393 | 1.00 | 1.00 | H |
| ATOM | 2952 | HE2 | HIE | A | 1160 | 3.265 | −7.102 | 12.803 | 1.00 | 1.00 | H |
| ATOM | 2953 | N | PRO | A | 1161 | 6.878 | −0.617 | 11.721 | 1.00 | 1.00 | N |
| ATOM | 2954 | CA | PRO | A | 1161 | 8.205 | −0.223 | 11.276 | 1.00 | 1.00 | C |
| ATOM | 2955 | C | PRO | A | 1161 | 9.034 | −1.099 | 10.378 | 1.00 | 1.00 | C |
| ATOM | 2956 | O | PRO | A | 1161 | 10.041 | −1.609 | 10.812 | 1.00 | 1.00 | O |
| ATOM | 2957 | CB | PRO | A | 1161 | 8.815 | 0.267 | 12.641 | 1.00 | 1.00 | C |
| ATOM | 2958 | CG | PRO | A | 1161 | 7.597 | 0.913 | 13.337 | 1.00 | 1.00 | C |
| ATOM | 2959 | CD | PRO | A | 1161 | 6.327 | 0.101 | 12.818 | 1.00 | 1.00 | C |
| ATOM | 2960 | HA | PRO | A | 1161 | 8.147 | 0.686 | 10.627 | 1.00 | 1.00 | H |
| ATOM | 2961 | HD2 | PRO | A | 1161 | 6.004 | −0.539 | 13.658 | 1.00 | 1.00 | H |
| ATOM | 2962 | HD1 | PRO | A | 1161 | 5.511 | 0.708 | 12.448 | 1.00 | 1.00 | H |
| ATOM | 2963 | HG2 | PRO | A | 1161 | 7.706 | 1.032 | 14.432 | 1.00 | 1.00 | H |
| ATOM | 2964 | HG1 | PRO | A | 1161 | 7.452 | 1.930 | 12.974 | 1.00 | 1.00 | H |
| ATOM | 2965 | HB1 | PRO | A | 1161 | 9.646 | 1.022 | 12.625 | 1.00 | 1.00 | H |
| ATOM | 2966 | HB2 | PRO | A | 1161 | 9.075 | −0.599 | 13.268 | 1.00 | 1.00 | H |
| ATOM | 2967 | N | ILE | A | 1162 | 8.492 | −1.232 | 9.178 | 1.00 | 1.00 | N |
| ATOM | 2968 | CA | ILE | A | 1162 | 9.331 | −1.794 | 8.107 | 1.00 | 1.00 | C |
| ATOM | 2969 | C | ILE | A | 1162 | 9.517 | −0.643 | 7.063 | 1.00 | 1.00 | C |
| ATOM | 2970 | O | ILE | A | 1162 | 8.550 | 0.090 | 6.779 | 1.00 | 1.00 | O |
| ATOM | 2971 | CB | ILE | A | 1162 | 8.575 | −3.048 | 7.512 | 1.00 | 1.00 | C |
| ATOM | 2972 | CG1 | ILE | A | 1162 | 8.937 | −4.316 | 8.376 | 1.00 | 1.00 | C |
| ATOM | 2973 | CG2 | ILE | A | 1162 | 8.806 | −3.205 | 6.008 | 1.00 | 1.00 | C |
| ATOM | 2974 | CD1 | ILE | A | 1162 | 8.327 | −5.606 | 7.791 | 1.00 | 1.00 | C |
| ATOM | 2975 | HA | ILE | A | 1162 | 10.332 | −2.034 | 8.496 | 1.00 | 1.00 | H |
| ATOM | 2976 | HB | ILE | A | 1162 | 7.484 | −2.938 | 7.629 | 1.00 | 1.00 | H |
| ATOM | 2977 | HG11 | ILE | A | 1162 | 8.690 | −4.246 | 9.429 | 1.00 | 1.00 | H |
| ATOM | 2978 | HG12 | ILE | A | 1162 | 10.041 | −4.429 | 8.224 | 1.00 | 1.00 | H |
| ATOM | 2979 | HD11 | ILE | A | 1162 | 8.503 | −6.402 | 8.489 | 1.00 | 1.00 | H |
| ATOM | 2980 | HD12 | ILE | A | 1162 | 8.803 | −5.952 | 6.827 | 1.00 | 1.00 | H |
| ATOM | 2981 | HD13 | ILE | A | 1162 | 7.303 | −5.531 | 7.508 | 1.00 | 1.00 | H |
| ATOM | 2982 | HG21 | ILE | A | 1162 | 9.848 | −3.338 | 5.853 | 1.00 | 1.00 | H |
| ATOM | 2983 | HG22 | ILE | A | 1162 | 8.544 | −2.271 | 5.530 | 1.00 | 1.00 | H |
| ATOM | 2984 | HG23 | ILE | A | 1162 | 8.243 | −4.016 | 5.470 | 1.00 | 1.00 | H |
| ATOM | 2985 | HN | ILE | A | 1162 | 7.605 | −0.891 | 8.877 | 1.00 | 1.00 | H |
| ATOM | 2986 | N | ILE | A | 1163 | 10.738 | −0.465 | 6.547 | 1.00 | 1.00 | N |
| ATOM | 2987 | CA | ILE | A | 1163 | 11.014 | 0.720 | 5.697 | 1.00 | 1.00 | C |
| ATOM | 2988 | C | ILE | A | 1163 | 11.721 | 0.253 | 4.450 | 1.00 | 1.00 | C |
| ATOM | 2989 | O | ILE | A | 1163 | 12.775 | 0.651 | 4.061 | 1.00 | 1.00 | O |
| ATOM | 2990 | CB | ILE | A | 1163 | 11.904 | 1.702 | 6.550 | 1.00 | 1.00 | C |
| ATOM | 2991 | CG1 | ILE | A | 1163 | 13.188 | 0.985 | 7.060 | 1.00 | 1.00 | C |
| ATOM | 2992 | CG2 | ILE | A | 1163 | 11.073 | 2.232 | 7.720 | 1.00 | 1.00 | C |
| ATOM | 2993 | CD1 | ILE | A | 1163 | 14.275 | 1.954 | 7.617 | 1.00 | 1.00 | C |
| ATOM | 2994 | HA | ILE | A | 1163 | 10.135 | 1.241 | 5.325 | 1.00 | 1.00 | H |
| ATOM | 2995 | HB | ILE | A | 1163 | 12.159 | 2.543 | 5.885 | 1.00 | 1.00 | H |
| ATOM | 2996 | HG11 | ILE | A | 1163 | 13.701 | 0.327 | 6.357 | 1.00 | 1.00 | H |
| ATOM | 2997 | HG12 | ILE | A | 1163 | 12.875 | 0.311 | 7.858 | 1.00 | 1.00 | H |
| ATOM | 2998 | HD11 | ILE | A | 1163 | 14.652 | 2.557 | 6.801 | 1.00 | 1.00 | H |
| ATOM | 2999 | HD12 | ILE | A | 1163 | 15.123 | 1.296 | 7.956 | 1.00 | 1.00 | H |
| ATOM | 3000 | HD13 | ILE | A | 1163 | 14.021 | 2.542 | 8.494 | 1.00 | 1.00 | H |
| ATOM | 3001 | HG21 | ILE | A | 1163 | 10.265 | 2.852 | 7.351 | 1.00 | 1.00 | H |
| ATOM | 3002 | HG22 | ILE | A | 1163 | 11.752 | 2.895 | 8.324 | 1.00 | 1.00 | H |
| ATOM | 3003 | HG23 | ILE | A | 1163 | 10.673 | 1.425 | 8.335 | 1.00 | 1.00 | H |
| ATOM | 3004 | HN | ILE | A | 1163 | 11.524 | −1.071 | 6.724 | 1.00 | 1.00 | H |
| ATOM | 3005 | N | LEU | A | 1164 | 11.055 | −0.722 | 3.715 | 1.00 | 1.00 | N |
| ATOM | 3006 | CA | LEU | A | 1164 | 11.716 | −1.337 | 2.536 | 1.00 | 1.00 | C |
| ATOM | 3007 | C | LEU | A | 1164 | 12.153 | −0.249 | 1.560 | 1.00 | 1.00 | C |
| ATOM | 3008 | O | LEU | A | 1164 | 13.360 | −0.138 | 1.377 | 1.00 | 1.00 | O |
| ATOM | 3009 | CB | LEU | A | 1164 | 10.820 | −2.370 | 1.756 | 1.00 | 1.00 | C |
| ATOM | 3010 | CG | LEU | A | 1164 | 10.336 | −3.635 | 2.607 | 1.00 | 1.00 | C |
| ATOM | 3011 | CD1 | LEU | A | 1164 | 9.303 | −4.595 | 1.989 | 1.00 | 1.00 | C |
| ATOM | 3012 | CD2 | LEU | A | 1164 | 11.516 | −4.513 | 3.067 | 1.00 | 1.00 | C |
| ATOM | 3013 | HA | LEU | A | 1164 | 12.599 | −1.940 | 2.915 | 1.00 | 1.00 | H |
| ATOM | 3014 | HB1 | LEU | A | 1164 | 9.884 | −1.968 | 1.350 | 1.00 | 1.00 | H |
| ATOM | 3015 | HB2 | LEU | A | 1164 | 11.389 | −2.781 | 0.892 | 1.00 | 1.00 | H |
| ATOM | 3016 | HG | LEU | A | 1164 | 9.869 | −3.292 | 3.491 | 1.00 | 1.00 | H |
| ATOM | 3017 | HD21 | LEU | A | 1164 | 11.231 | −5.492 | 3.488 | 1.00 | 1.00 | H |
| ATOM | 3018 | HD22 | LEU | A | 1164 | 12.107 | −3.960 | 3.875 | 1.00 | 1.00 | H |
| ATOM | 3019 | HD23 | LEU | A | 1164 | 12.142 | −4.758 | 2.183 | 1.00 | 1.00 | H |
| ATOM | 3020 | HD11 | LEU | A | 1164 | 8.983 | −5.300 | 2.793 | 1.00 | 1.00 | H |
| ATOM | 3021 | HD12 | LEU | A | 1164 | 9.796 | −5.124 | 1.130 | 1.00 | 1.00 | H |
| ATOM | 3022 | HD13 | LEU | A | 1164 | 8.478 | −4.091 | 1.523 | 1.00 | 1.00 | H |
| ATOM | 3023 | HN | LEU | A | 1164 | 10.234 | −1.147 | 4.022 | 1.00 | 1.00 | H |
| ATOM | 3024 | N | GLY | A | 1165 | 11.219 | 0.537 | 0.997 | 1.00 | 1.00 | N |
| ATOM | 3025 | CA | GLY | A | 1165 | 11.501 | 1.442 | −0.081 | 1.00 | 1.00 | C |
| ATOM | 3026 | C | GLY | A | 1165 | 10.576 | 1.497 | −1.276 | 1.00 | 1.00 | C |
| ATOM | 3027 | O | GLY | A | 1165 | 10.674 | 2.392 | −2.095 | 1.00 | 1.00 | O |
| ATOM | 3028 | HA2 | GLY | A | 1165 | 12.540 | 1.298 | −0.504 | 1.00 | 1.00 | H |
| ATOM | 3029 | HA1 | GLY | A | 1165 | 11.423 | 2.417 | 0.327 | 1.00 | 1.00 | H |
| ATOM | 3030 | HN | GLY | A | 1165 | 10.257 | 0.482 | 1.374 | 1.00 | 1.00 | H |
| ATOM | 3031 | N | PHE | A | 1166 | 9.651 | 0.513 | −1.452 | 1.00 | 1.00 | N |
| ATOM | 3032 | CA | PHE | A | 1166 | 8.673 | 0.625 | −2.474 | 1.00 | 1.00 | C |
| ATOM | 3033 | C | PHE | A | 1166 | 7.432 | −0.191 | −2.246 | 1.00 | 1.00 | C |
| ATOM | 3034 | O | PHE | A | 1166 | 7.608 | −1.168 | −1.595 | 1.00 | 1.00 | O |
| ATOM | 3035 | CB | PHE | A | 1166 | 9.362 | 0.029 | −3.755 | 1.00 | 1.00 | C |
| ATOM | 3036 | CG | PHE | A | 1166 | 8.326 | −0.256 | −4.883 | 1.00 | 1.00 | C |
| ATOM | 3037 | CD1 | PHE | A | 1166 | 7.643 | 0.785 | −5.571 | 1.00 | 1.00 | C |
| ATOM | 3038 | CD2 | PHE | A | 1166 | 8.019 | −1.608 | −5.280 | 1.00 | 1.00 | C |
| ATOM | 3039 | CE1 | PHE | A | 1166 | 6.659 | 0.502 | −6.520 | 1.00 | 1.00 | C |
| ATOM | 3040 | CE2 | PHE | A | 1166 | 7.002 | −1.864 | −6.217 | 1.00 | 1.00 | C |
| ATOM | 3041 | CZ | PHE | A | 1166 | 6.355 | −0.820 | −6.867 | 1.00 | 1.00 | C |
| ATOM | 3042 | HA | PHE | A | 1166 | 8.309 | 1.654 | −2.556 | 1.00 | 1.00 | H |
| ATOM | 3043 | HB1 | PHE | A | 1166 | 10.057 | −0.772 | −3.542 | 1.00 | 1.00 | H |
| ATOM | 3044 | HB2 | PHE | A | 1166 | 10.062 | 0.875 | −4.068 | 1.00 | 1.00 | H |
| ATOM | 3045 | HD2 | PHE | A | 1166 | 8.638 | −2.405 | −4.844 | 1.00 | 1.00 | H |
| ATOM | 3046 | HE2 | PHE | A | 1166 | 6.722 | −2.847 | −6.493 | 1.00 | 1.00 | H |
| ATOM | 3047 | HZ | PHE | A | 1166 | 5.680 | −1.027 | −7.621 | 1.00 | 1.00 | H |
| ATOM | 3048 | HE1 | PHE | A | 1166 | 6.110 | 1.250 | −7.070 | 1.00 | 1.00 | H |
| ATOM | 3049 | HD1 | PHE | A | 1166 | 7.814 | 1.866 | −5.413 | 1.00 | 1.00 | H |
| ATOM | 3050 | HN | PHE | A | 1166 | 9.555 | −0.261 | −0.850 | 1.00 | 1.00 | H |
| ATOM | 3051 | N | ARG | A | 1167 | 6.223 | 0.175 | −2.711 | 1.00 | 1.00 | N |
| ATOM | 3052 | CA | ARG | A | 1167 | 5.018 | −0.721 | −2.779 | 1.00 | 1.00 | C |
| ATOM | 3053 | C | ARG | A | 1167 | 3.816 | 0.159 | −3.052 | 1.00 | 1.00 | C |
| ATOM | 3054 | O | ARG | A | 1167 | 3.293 | 0.126 | −4.180 | 1.00 | 1.00 | O |
| ATOM | 3055 | CB | ARG | A | 1167 | 4.763 | −1.609 | −1.520 | 1.00 | 1.00 | C |
| ATOM | 3056 | CG | ARG | A | 1167 | 5.473 | −2.994 | −1.711 | 1.00 | 1.00 | C |
| ATOM | 3057 | CD | ARG | A | 1167 | 5.895 | −3.551 | −0.303 | 1.00 | 1.00 | C |
| ATOM | 3058 | NE | ARG | A | 1167 | 6.782 | −4.733 | −0.583 | 1.00 | 1.00 | N |
| ATOM | 3059 | CZ | ARG | A | 1167 | 8.042 | −4.620 | −0.945 | 1.00 | 1.00 | C |
| ATOM | 3060 | NH1 | ARG | A | 1167 | 8.670 | −3.510 | −1.162 | 1.00 | 1.00 | N |
| ATOM | 3061 | NH2 | ARG | A | 1167 | 8.739 | −5.734 | −1.067 | 1.00 | 1.00 | N |
| ATOM | 3062 | HA | ARG | A | 1167 | 5.074 | −1.365 | −3.664 | 1.00 | 1.00 | H |
| ATOM | 3063 | HB1 | ARG | A | 1167 | 3.684 | −1.817 | −1.326 | 1.00 | 1.00 | H |
| ATOM | 3064 | HB2 | ARG | A | 1167 | 5.131 | −1.109 | −0.576 | 1.00 | 1.00 | H |
| ATOM | 3065 | HG1 | ARG | A | 1167 | 6.348 | −2.908 | −2.430 | 1.00 | 1.00 | H |
| ATOM | 3066 | HG2 | ARG | A | 1167 | 4.693 | −3.640 | −2.192 | 1.00 | 1.00 | H |
| ATOM | 3067 | HD1 | ARG | A | 1167 | 6.419 | −2.927 | 0.425 | 1.00 | 1.00 | H |
| ATOM | 3068 | HD2 | ARG | A | 1167 | 4.939 | −3.815 | 0.183 | 1.00 | 1.00 | H |
| ATOM | 3069 | HE | ARG | A | 1167 | 6.383 | −5.638 | −0.393 | 1.00 | 1.00 | H |
| ATOM | 3070 | HH12 | ARG | A | 1167 | 9.691 | −3.482 | −1.363 | 1.00 | 1.00 | H |
| ATOM | 3071 | HH11 | ARG | A | 1167 | 8.209 | −2.618 | −1.075 | 1.00 | 1.00 | H |
| ATOM | 3072 | HH22 | ARG | A | 1167 | 9.726 | −5.676 | −1.363 | 1.00 | 1.00 | H |
| ATOM | 3073 | HH21 | ARG | A | 1167 | 8.321 | −6.639 | −0.932 | 1.00 | 1.00 | H |
| ATOM | 3074 | HN | ARG | A | 1167 | 6.131 | 1.018 | −3.197 | 1.00 | 1.00 | H |
| ATOM | 3075 | N | LYS | A | 1168 | 3.281 | 0.928 | −2.076 | 1.00 | 1.00 | N |
| ATOM | 3076 | CA | LYS | A | 1168 | 2.253 | 1.911 | −2.360 | 1.00 | 1.00 | C |
| ATOM | 3077 | C | LYS | A | 1168 | 3.037 | 3.035 | −3.011 | 1.00 | 1.00 | C |
| ATOM | 3078 | O | LYS | A | 1168 | 3.463 | 3.913 | −2.284 | 1.00 | 1.00 | O |
| ATOM | 3079 | CB | LYS | A | 1168 | 1.475 | 2.285 | −1.102 | 1.00 | 1.00 | C |
| ATOM | 3080 | CG | LYS | A | 1168 | 0.106 | 2.991 | −1.428 | 1.00 | 1.00 | C |
| ATOM | 3081 | CD | LYS | A | 1168 | 0.031 | 4.160 | −2.384 | 1.00 | 1.00 | C |
| ATOM | 3082 | CE | LYS | A | 1168 | −1.465 | 4.592 | −2.743 | 1.00 | 1.00 | C |
| ATOM | 3083 | NZ | LYS | A | 1168 | −2.334 | 3.454 | −3.242 | 1.00 | 1.00 | N |
| ATOM | 3084 | HA | LYS | A | 1168 | 1.553 | 1.556 | −3.100 | 1.00 | 1.00 | H |
| ATOM | 3085 | HB1 | LYS | A | 1168 | 2.081 | 2.987 | −0.512 | 1.00 | 1.00 | H |
| ATOM | 3086 | HB2 | LYS | A | 1168 | 1.369 | 1.404 | −0.457 | 1.00 | 1.00 | H |
| ATOM | 3087 | HG1 | LYS | A | 1168 | −0.548 | 2.255 | −1.820 | 1.00 | 1.00 | H |
| ATOM | 3088 | HG2 | LYS | A | 1168 | −0.295 | 3.299 | −0.451 | 1.00 | 1.00 | H |
| ATOM | 3089 | HD1 | LYS | A | 1168 | 0.501 | 5.018 | −1.893 | 1.00 | 1.00 | H |
| ATOM | 3090 | HD2 | LYS | A | 1168 | 0.491 | 3.950 | −3.365 | 1.00 | 1.00 | H |
| ATOM | 3091 | HE1 | LYS | A | 1168 | −1.457 | 5.419 | −3.494 | 1.00 | 1.00 | H |
| ATOM | 3092 | HE2 | LYS | A | 1168 | −1.865 | 5.025 | −1.793 | 1.00 | 1.00 | H |
| ATOM | 3093 | HZ1 | LYS | A | 1168 | −1.872 | 2.865 | −4.054 | 1.00 | 1.00 | H |
| ATOM | 3094 | HZ2 | LYS | A | 1168 | −2.746 | 2.731 | −2.542 | 1.00 | 1.00 | H |
| ATOM | 3095 | HZ3 | LYS | A | 1168 | −3.346 | 3.762 | −3.546 | 1.00 | 1.00 | H |
| ATOM | 3096 | HN | LYS | A | 1168 | 3.622 | 0.917 | −1.121 | 1.00 | 1.00 | H |
| ATOM | 3097 | N | ILE | A | 1169 | 3.300 | 2.959 | −4.356 | 1.00 | 1.00 | N |
| ATOM | 3098 | CA | ILE | A | 1169 | 4.018 | 4.049 | −5.018 | 1.00 | 1.00 | C |
| ATOM | 3099 | C | ILE | A | 1169 | 3.540 | 5.362 | −4.450 | 1.00 | 1.00 | C |
| ATOM | 3100 | O | ILE | A | 1169 | 2.314 | 5.567 | −4.363 | 1.00 | 1.00 | O |
| ATOM | 3101 | CB | ILE | A | 1169 | 3.841 | 3.961 | −6.579 | 1.00 | 1.00 | C |
| ATOM | 3102 | CG1 | ILE | A | 1169 | 4.675 | 4.971 | −7.397 | 1.00 | 1.00 | C |
| ATOM | 3103 | CG2 | ILE | A | 1169 | 2.377 | 4.226 | −6.992 | 1.00 | 1.00 | C |
| ATOM | 3104 | CD1 | ILE | A | 1169 | 6.056 | 4.377 | −7.688 | 1.00 | 1.00 | C |
| ATOM | 3105 | HA | ILE | A | 1169 | 5.048 | 3.915 | −4.745 | 1.00 | 1.00 | H |
| ATOM | 3106 | HB | ILE | A | 1169 | 4.130 | 2.926 | −6.782 | 1.00 | 1.00 | H |
| ATOM | 3107 | HG11 | ILE | A | 1169 | 4.177 | 5.187 | −8.361 | 1.00 | 1.00 | H |
| ATOM | 3108 | HG12 | ILE | A | 1169 | 4.766 | 5.923 | −6.815 | 1.00 | 1.00 | H |
| ATOM | 3109 | HD11 | ILE | A | 1169 | 6.812 | 5.053 | −8.122 | 1.00 | 1.00 | H |
| ATOM | 3110 | HD12 | ILE | A | 1169 | 6.451 | 4.017 | −6.729 | 1.00 | 1.00 | H |
| ATOM | 3111 | HD13 | ILE | A | 1169 | 5.863 | 3.484 | −8.316 | 1.00 | 1.00 | H |
| ATOM | 3112 | HG21 | ILE | A | 1169 | 2.050 | 5.212 | −6.785 | 1.00 | 1.00 | H |
| ATOM | 3113 | HG22 | ILE | A | 1169 | 2.226 | 4.020 | −8.066 | 1.00 | 1.00 | H |
| ATOM | 3114 | HG23 | ILE | A | 1169 | 1.664 | 3.558 | −6.460 | 1.00 | 1.00 | H |
| ATOM | 3115 | HN | ILE | A | 1169 | 2.972 | 2.173 | −4.927 | 1.00 | 1.00 | H |
| ATOM | 3116 | N | PRO | A | 1170 | 4.421 | 6.268 | −3.897 | 1.00 | 1.00 | N |
| ATOM | 3117 | CA | PRO | A | 1170 | 3.911 | 7.236 | −2.964 | 1.00 | 1.00 | C |
| ATOM | 3118 | C | PRO | A | 1170 | 2.816 | 8.170 | −3.446 | 1.00 | 1.00 | C |
| ATOM | 3119 | O | PRO | A | 1170 | 2.575 | 8.228 | −4.649 | 1.00 | 1.00 | O |
| ATOM | 3120 | CB | PRO | A | 1170 | 5.195 | 7.907 | −2.452 | 1.00 | 1.00 | C |
| ATOM | 3121 | CG | PRO | A | 1170 | 6.296 | 7.468 | −3.461 | 1.00 | 1.00 | C |
| ATOM | 3122 | CD | PRO | A | 1170 | 5.891 | 6.082 | −3.985 | 1.00 | 1.00 | C |
| ATOM | 3123 | HA | PRO | A | 1170 | 3.514 | 6.682 | −2.109 | 1.00 | 1.00 | H |
| ATOM | 3124 | HD2 | PRO | A | 1170 | 6.312 | 5.973 | −5.036 | 1.00 | 1.00 | H |
| ATOM | 3125 | HD1 | PRO | A | 1170 | 6.229 | 5.253 | −3.364 | 1.00 | 1.00 | H |
| ATOM | 3126 | HG2 | PRO | A | 1170 | 7.327 | 7.591 | −3.033 | 1.00 | 1.00 | H |
| ATOM | 3127 | HG1 | PRO | A | 1170 | 6.314 | 8.266 | −4.258 | 1.00 | 1.00 | H |
| ATOM | 3128 | HB1 | PRO | A | 1170 | 5.444 | 7.577 | −1.456 | 1.00 | 1.00 | H |
| ATOM | 3129 | HB2 | PRO | A | 1170 | 5.091 | 8.986 | −2.344 | 1.00 | 1.00 | H |
| ATOM | 3130 | N | MET | A | 1171 | 2.179 | 8.912 | −2.480 | 1.00 | 1.00 | N |
| ATOM | 3131 | CA | MET | A | 1171 | 0.990 | 9.726 | −2.796 | 1.00 | 1.00 | C |
| ATOM | 3132 | C | MET | A | 1171 | 1.387 | 11.164 | −3.139 | 1.00 | 1.00 | C |
| ATOM | 3133 | O | MET | A | 1171 | 0.827 | 11.663 | −4.116 | 1.00 | 1.00 | O |
| ATOM | 3134 | CB | MET | A | 1171 | −0.004 | 9.796 | −1.621 | 1.00 | 1.00 | C |
| ATOM | 3135 | CG | MET | A | 1171 | −0.828 | 8.521 | −1.412 | 1.00 | 1.00 | C |
| ATOM | 3136 | SD | MET | A | 1171 | −1.719 | 8.581 | 0.203 | 1.00 | 1.00 | S |
| ATOM | 3137 | CE | MET | A | 1171 | −3.145 | 9.684 | −0.084 | 1.00 | 1.00 | C |
| ATOM | 3138 | HA | MET | A | 1171 | 0.521 | 9.314 | −3.719 | 1.00 | 1.00 | H |
| ATOM | 3139 | HB1 | MET | A | 1171 | −0.712 | 10.636 | −1.706 | 1.00 | 1.00 | H |
| ATOM | 3140 | HB2 | MET | A | 1171 | 0.563 | 10.069 | −0.701 | 1.00 | 1.00 | H |
| ATOM | 3141 | HG1 | MET | A | 1171 | −1.462 | 8.441 | −2.304 | 1.00 | 1.00 | H |
| ATOM | 3142 | HG2 | MET | A | 1171 | −0.066 | 7.689 | −1.438 | 1.00 | 1.00 | H |
| ATOM | 3143 | HE1 | MET | A | 1171 | −3.724 | 9.329 | −0.914 | 1.00 | 1.00 | H |
| ATOM | 3144 | HE2 | MET | A | 1171 | −3.763 | 9.665 | 0.820 | 1.00 | 1.00 | H |
| ATOM | 3145 | HE3 | MET | A | 1171 | 2.803 | 10.709 | −0.281 | 1.00 | 1.00 | H |
| ATOM | 3146 | HN | MET | A | 1171 | 2.509 | 8.828 | −1.552 | 1.00 | 1.00 | H |
| ATOM | 3147 | N | GLY | A | 1172 | 2.329 | 11.774 | −2.393 | 1.00 | 1.00 | N |
| ATOM | 3148 | CA | GLY | A | 1172 | 2.668 | 13.164 | −2.714 | 1.00 | 1.00 | C |
| ATOM | 3149 | C | GLY | A | 1172 | 3.642 | 13.127 | −3.845 | 1.00 | 1.00 | C |
| ATOM | 3150 | O | GLY | A | 1172 | 4.832 | 13.173 | −3.542 | 1.00 | 1.00 | O |
| ATOM | 3151 | HA2 | GLY | A | 1172 | 3.179 | 13.683 | −1.852 | 1.00 | 1.00 | H |
| ATOM | 3152 | HA1 | GLY | A | 1172 | 1.751 | 13.780 | −2.982 | 1.00 | 1.00 | H |
| ATOM | 3153 | HN | GLY | A | 1172 | 2.687 | 11.308 | −1.573 | 1.00 | 1.00 | H |
| ATOM | 3154 | N | VAL | A | 1173 | 3.204 | 12.975 | −5.124 | 1.00 | 1.00 | N |
| ATOM | 3155 | CA | VAL | A | 1173 | 4.096 | 12.698 | −6.238 | 1.00 | 1.00 | C |
| ATOM | 3156 | C | VAL | A | 1173 | 3.342 | 13.296 | −7.416 | 1.00 | 1.00 | C |
| ATOM | 3157 | O | VAL | A | 1173 | 2.566 | 12.542 | −7.993 | 1.00 | 1.00 | O |
| ATOM | 3158 | CB | VAL | A | 1173 | 4.414 | 11.165 | −6.434 | 1.00 | 1.00 | C |
| ATOM | 3159 | CG1 | VAL | A | 1173 | 5.480 | 10.818 | −7.518 | 1.00 | 1.00 | C |
| ATOM | 3160 | CG2 | VAL | A | 1173 | 4.713 | 10.422 | −5.122 | 1.00 | 1.00 | C |
| ATOM | 3161 | HA | VAL | A | 1173 | 5.045 | 13.230 | −6.077 | 1.00 | 1.00 | H |
| ATOM | 3162 | HB | VAL | A | 1173 | 3.538 | 10.640 | −6.830 | 1.00 | 1.00 | H |
| ATOM | 3163 | HG11 | VAL | A | 1173 | 5.279 | 11.300 | −8.480 | 1.00 | 1.00 | H |
| ATOM | 3164 | HG12 | VAL | A | 1173 | 6.477 | 11.099 | −7.196 | 1.00 | 1.00 | H |
| ATOM | 3165 | HG13 | VAL | A | 1173 | 5.583 | 9.782 | −7.751 | 1.00 | 1.00 | H |
| ATOM | 3166 | HG21 | VAL | A | 1173 | 5.664 | 10.652 | −4.660 | 1.00 | 1.00 | H |
| ATOM | 3167 | HG22 | VAL | A | 1173 | 4.815 | 9.361 | −5.393 | 1.00 | 1.00 | H |
| ATOM | 3168 | HG23 | VAL | A | 1173 | 3.847 | 10.594 | −4.437 | 1.00 | 1.00 | H |
| ATOM | 3169 | HN | VAL | A | 1173 | 2.233 | 12.941 | −5.343 | 1.00 | 1.00 | H |
| ATOM | 3170 | N | GLY | A | 1174 | 3.612 | 14.583 | −7.755 | 1.00 | 1.00 | N |
| ATOM | 3171 | CA | GLY | A | 1174 | 2.895 | 15.130 | −8.888 | 1.00 | 1.00 | C |
| ATOM | 3172 | C | GLY | A | 1174 | 2.517 | 14.183 | −9.990 | 1.00 | 1.00 | C |
| ATOM | 3173 | O | GLY | A | 1174 | 1.408 | 14.146 | −10.463 | 1.00 | 1.00 | O |
| ATOM | 3174 | HA2 | GLY | A | 1174 | 3.622 | 15.883 | −9.311 | 1.00 | 1.00 | H |
| ATOM | 3175 | HA1 | GLY | A | 1174 | 2.007 | 15.668 | −8.617 | 1.00 | 1.00 | H |
| ATOM | 3176 | HN | GLY | A | 1174 | 4.223 | 15.158 | −7.199 | 1.00 | 1.00 | H |
| ATOM | 3177 | N | LEU | A | 1175 | 3.511 | 13.401 | −10.479 | 1.00 | 1.00 | N |
| ATOM | 3178 | CA | LEU | A | 1175 | 3.265 | 12.633 | −11.697 | 1.00 | 1.00 | C |
| ATOM | 3179 | C | LEU | A | 1175 | 2.394 | 11.407 | −11.510 | 1.00 | 1.00 | C |
| ATOM | 3180 | O | LEU | A | 1175 | 1.823 | 10.940 | −12.492 | 1.00 | 1.00 | O |
| ATOM | 3181 | CB | LEU | A | 1175 | 4.643 | 12.155 | −12.213 | 1.00 | 1.00 | C |
| ATOM | 3182 | CG | LEU | A | 1175 | 4.680 | 11.560 | −13.666 | 1.00 | 1.00 | C |
| ATOM | 3183 | CD1 | LEU | A | 1175 | 4.363 | 12.488 | −14.906 | 1.00 | 1.00 | C |
| ATOM | 3184 | CD2 | LEU | A | 1175 | 6.104 | 10.909 | −13.912 | 1.00 | 1.00 | C |
| ATOM | 3185 | HA | LEU | A | 1175 | 2.773 | 13.298 | −12.487 | 1.00 | 1.00 | H |
| ATOM | 3186 | HB1 | LEU | A | 1175 | 4.992 | 11.389 | −11.464 | 1.00 | 1.00 | H |
| ATOM | 3187 | HB2 | LEU | A | 1175 | 5.305 | 13.043 | −12.255 | 1.00 | 1.00 | H |
| ATOM | 3188 | HG | LEU | A | 1175 | 3.882 | 10.763 | −13.678 | 1.00 | 1.00 | H |
| ATOM | 3189 | HD21 | LEU | A | 1175 | 6.277 | 10.021 | −13.225 | 1.00 | 1.00 | H |
| ATOM | 3190 | HD22 | LEU | A | 1175 | 6.144 | 10.377 | −14.896 | 1.00 | 1.00 | H |
| ATOM | 3191 | HD23 | LEU | A | 1175 | 6.913 | 11.585 | −13.857 | 1.00 | 1.00 | H |
| ATOM | 3192 | HD11 | LEU | A | 1175 | 5.142 | 13.247 | −15.051 | 1.00 | 1.00 | H |
| ATOM | 3193 | HD12 | LEU | A | 1175 | 4.251 | 11.976 | −15.875 | 1.00 | 1.00 | H |
| ATOM | 3194 | HD13 | LEU | A | 1175 | 3.380 | 13.035 | −14.791 | 1.00 | 1.00 | H |
| ATOM | 3195 | HN | LEU | A | 1175 | 4.347 | 13.328 | −9.919 | 1.00 | 1.00 | H |
| ATOM | 3196 | N | SER | A | 1176 | 2.339 | 10.846 | −10.264 | 1.00 | 1.00 | N |
| ATOM | 3197 | CA | SER | A | 1176 | 1.660 | 9.550 | −10.152 | 1.00 | 1.00 | C |
| ATOM | 3198 | C | SER | A | 1176 | 0.217 | 9.484 | −10.591 | 1.00 | 1.00 | C |
| ATOM | 3199 | O | SER | A | 1176 | −0.074 | 8.685 | −11.460 | 1.00 | 1.00 | O |
| ATOM | 3200 | CB | SER | A | 1176 | 1.906 | 8.824 | −8.797 | 1.00 | 1.00 | C |
| ATOM | 3201 | OG | SER | A | 1176 | 1.104 | 7.640 | −8.803 | 1.00 | 1.00 | O |
| ATOM | 3202 | HA | SER | A | 1176 | 2.180 | 8.815 | −10.873 | 1.00 | 1.00 | H |
| ATOM | 3203 | HB1 | SER | A | 1176 | 1.496 | 9.461 | −7.997 | 1.00 | 1.00 | H |
| ATOM | 3204 | HB2 | SER | A | 1176 | 3.033 | 8.608 | −8.590 | 1.00 | 1.00 | H |
| ATOM | 3205 | HG | SER | A | 1176 | 1.337 | 7.119 | −8.035 | 1.00 | 1.00 | H |
| ATOM | 3206 | HN | SER | A | 1176 | 2.777 | 11.263 | −9.456 | 1.00 | 1.00 | H |
| ATOM | 3207 | N | PRO | A | 1177 | −0.745 | 10.235 | −10.022 | 1.00 | 1.00 | N |
| ATOM | 3208 | CA | PRO | A | 1177 | −2.120 | 10.188 | −10.541 | 1.00 | 1.00 | C |
| ATOM | 3209 | C | PRO | A | 1177 | −2.261 | 10.821 | −11.925 | 1.00 | 1.00 | C |
| ATOM | 3210 | O | PRO | A | 1177 | 3.320 | 10.640 | −12.518 | 1.00 | 1.00 | O |
| ATOM | 3211 | CB | PRO | A | 1177 | −2.813 | 11.110 | −9.429 | 1.00 | 1.00 | C |
| ATOM | 3212 | CG | PRO | A | 1177 | −1.688 | 12.098 | −9.063 | 1.00 | 1.00 | C |
| ATOM | 3213 | CD | PRO | A | 1177 | −0.516 | 11.097 | −8.876 | 1.00 | 1.00 | C |
| ATOM | 3214 | HA | PRO | A | 1177 | −2.484 | 9.178 | −10.593 | 1.00 | 1.00 | H |
| ATOM | 3215 | HD2 | PRO | A | 1177 | 0.451 | 11.687 | −8.839 | 1.00 | 1.00 | H |
| ATOM | 3216 | HD1 | PRO | A | 1177 | −0.674 | 10.536 | −7.949 | 1.00 | 1.00 | H |
| ATOM | 3217 | HG2 | PRO | A | 1177 | −1.946 | 12.562 | −8.162 | 1.00 | 1.00 | H |
| ATOM | 3218 | HG1 | PRO | A | 1177 | −1.439 | 12.829 | −9.865 | 1.00 | 1.00 | H |
| ATOM | 3219 | HB1 | PRO | A | 1177 | −3.011 | 10.425 | −8.560 | 1.00 | 1.00 | H |
| ATOM | 3220 | HB2 | PRO | A | 1177 | −3.753 | 11.534 | −9.790 | 1.00 | 1.00 | H |
| ATOM | 3221 | N | PHE | A | 1178 | −1.258 | 11.499 | −12.499 | 1.00 | 1.00 | N |
| ATOM | 3222 | CA | PHE | A | 1178 | −1.329 | 12.082 | −13.832 | 1.00 | 1.00 | C |
| ATOM | 3223 | C | PHE | A | 1178 | −1.357 | 11.000 | −14.914 | 1.00 | 1.00 | C |
| ATOM | 3224 | O | PHE | A | 1178 | −2.038 | 11.128 | −15.904 | 1.00 | 1.00 | O |
| ATOM | 3225 | CB | PHE | A | 1178 | −0.134 | 13.002 | −14.118 | 1.00 | 1.00 | C |
| ATOM | 3226 | CG | PHE | A | 1178 | −0.299 | 13.873 | −15.418 | 1.00 | 1.00 | C |
| ATOM | 3227 | CD1 | PHE | A | 1178 | 0.460 | 13.650 | −16.594 | 1.00 | 1.00 | C |
| ATOM | 3228 | CD2 | PHE | A | 1178 | −1.162 | 14.965 | −15.308 | 1.00 | 1.00 | C |
| ATOM | 3229 | CE1 | PHE | A | 1178 | 0.167 | 14.402 | −17.701 | 1.00 | 1.00 | C |
| ATOM | 3230 | CE2 | PHE | A | 1178 | −1.355 | 15.786 | −16.410 | 1.00 | 1.00 | C |
| ATOM | 3231 | CZ | PHE | A | 1178 | −0.695 | 15.488 | −17.610 | 1.00 | 1.00 | C |
| ATOM | 3232 | HA | PHE | A | 1178 | −2.272 | 12.713 | −13.931 | 1.00 | 1.00 | H |
| ATOM | 3233 | HB1 | PHE | A | 1178 | 0.032 | 13.693 | −13.257 | 1.00 | 1.00 | H |
| ATOM | 3234 | HB2 | PHE | A | 1178 | 0.727 | 12.348 | −14.196 | 1.00 | 1.00 | H |
| ATOM | 3235 | HD2 | PHE | A | 1178 | −1.614 | 15.188 | −14.373 | 1.00 | 1.00 | H |
| ATOM | 3236 | HE2 | PHE | A | 1178 | −1.998 | 16.650 | −16.267 | 1.00 | 1.00 | H |
| ATOM | 3237 | HZ | PHE | A | 1178 | −0.830 | 16.073 | −18.478 | 1.00 | 1.00 | H |
| ATOM | 3238 | HE1 | PHE | A | 1178 | 0.600 | 14.092 | −18.620 | 1.00 | 1.00 | H |
| ATOM | 3239 | HD1 | PHE | A | 1178 | 1.312 | 12.958 | −16.620 | 1.00 | 1.00 | H |
| ATOM | 3240 | HN | PHE | A | 1178 | −0.418 | 11.627 | −11.948 | 1.00 | 1.00 | H |
| ATOM | 3241 | N | LEU | A | 1179 | −0.569 | 9.911 | −14.788 | 1.00 | 1.00 | N |
| ATOM | 3242 | CA | LEU | A | 1179 | −0.665 | 8.793 | −15.707 | 1.00 | 1.00 | C |
| ATOM | 3243 | C | LEU | A | 1179 | −2.069 | 8.206 | −15.512 | 1.00 | 1.00 | C |
| ATOM | 3244 | O | LEU | A | 1179 | −2.648 | 7.740 | −16.479 | 1.00 | 1.00 | O |
| ATOM | 3245 | CB | LEU | A | 1179 | 0.464 | 7.712 | −15.544 | 1.00 | 1.00 | C |
| ATOM | 3246 | CG | LEU | A | 1179 | 1.683 | 8.106 | −16.406 | 1.00 | 1.00 | C |
| ATOM | 3247 | CD1 | LEU | A | 1179 | 2.260 | 9.495 | −15.962 | 1.00 | 1.00 | C |
| ATOM | 3248 | CD2 | LEU | A | 1179 | 2.710 | 6.935 | −16.407 | 1.00 | 1.00 | C |
| ATOM | 3249 | HA | LEU | A | 1179 | −0.660 | 9.082 | −16.776 | 1.00 | 1.00 | H |
| ATOM | 3250 | HB1 | LEU | A | 1179 | 0.746 | 7.494 | −14.476 | 1.00 | 1.00 | H |
| ATOM | 3251 | HB2 | LEU | A | 1179 | −0.018 | 6.798 | −15.955 | 1.00 | 1.00 | H |
| ATOM | 3252 | HG | LEU | A | 1179 | 1.387 | 8.184 | −17.490 | 1.00 | 1.00 | H |
| ATOM | 3253 | HD21 | LEU | A | 1179 | 2.159 | 6.072 | −16.828 | 1.00 | 1.00 | H |
| ATOM | 3254 | HD22 | LEU | A | 1179 | 3.540 | 7.195 | −17.069 | 1.00 | 1.00 | H |
| ATOM | 3255 | HD23 | LEU | A | 1179 | 2.998 | 6.713 | −15.406 | 1.00 | 1.00 | H |
| ATOM | 3256 | HD11 | LEU | A | 1179 | 2.402 | 9.459 | −14.895 | 1.00 | 1.00 | H |
| ATOM | 3257 | HD12 | LEU | A | 1179 | 1.644 | 10.340 | −16.215 | 1.00 | 1.00 | H |
| ATOM | 3258 | HD13 | LEU | A | 1179 | 3.219 | 9.656 | −16.471 | 1.00 | 1.00 | H |
| ATOM | 3259 | HN | LEU | A | 1179 | −0.009 | 9.864 | −14.000 | 1.00 | 1.00 | H |
| ATOM | 3260 | N | LEU | A | 1180 | −2.613 | 8.208 | −14.285 | 1.00 | 1.00 | N |
| ATOM | 3261 | CA | LEU | A | 1180 | −4.037 | 7.784 | −14.174 | 1.00 | 1.00 | C |
| ATOM | 3262 | C | LEU | A | 1180 | −5.034 | 8.684 | −14.899 | 1.00 | 1.00 | C |
| ATOM | 3263 | O | LEU | A | 1180 | −5.938 | 8.193 | −15.557 | 1.00 | 1.00 | O |
| ATOM | 3264 | CB | LEU | A | 1180 | −4.534 | 7.537 | −12.683 | 1.00 | 1.00 | C |
| ATOM | 3265 | CG | LEU | A | 1180 | −3.811 | 6.465 | −11.823 | 1.00 | 1.00 | C |
| ATOM | 3266 | CD1 | LEU | A | 1180 | −4.282 | 6.358 | −10.318 | 1.00 | 1.00 | C |
| ATOM | 3267 | CD2 | LEU | A | 1180 | −3.788 | 5.009 | −12.430 | 1.00 | 1.00 | C |
| ATOM | 3268 | HA | LEU | A | 1180 | −4.072 | 6.837 | −14.711 | 1.00 | 1.00 | H |
| ATOM | 3269 | HB1 | LEU | A | 1180 | −4.458 | 8.429 | −12.040 | 1.00 | 1.00 | H |
| ATOM | 3270 | HB2 | LEU | A | 1180 | −5.550 | 7.253 | −12.810 | 1.00 | 1.00 | H |
| ATOM | 3271 | HG | LEU | A | 1180 | −2.732 | 6.731 | −11.855 | 1.00 | 1.00 | H |
| ATOM | 3272 | HD21 | LEU | A | 1180 | −3.432 | 5.014 | −13.469 | 1.00 | 1.00 | H |
| ATOM | 3273 | HD22 | LEU | A | 1180 | −4.768 | 4.573 | −12.517 | 1.00 | 1.00 | H |
| ATOM | 3274 | HD23 | LEU | A | 1180 | −3.090 | 4.266 | −11.941 | 1.00 | 1.00 | H |
| ATOM | 3275 | HD11 | LEU | A | 1180 | −3.679 | 5.633 | −9.826 | 1.00 | 1.00 | H |
| ATOM | 3276 | HD12 | LEU | A | 1180 | −5.329 | 6.150 | −10.239 | 1.00 | 1.00 | H |
| ATOM | 3277 | HD13 | LEU | A | 1180 | −4.110 | 7.309 | −9.810 | 1.00 | 1.00 | H |
| ATOM | 3278 | HN | LEU | A | 1180 | −2.102 | 8.439 | −13.414 | 1.00 | 1.00 | H |
| ATOM | 3279 | N | ALA | A | 1181 | −4.891 | 10.018 | −14.689 | 1.00 | 1.00 | N |
| ATOM | 3280 | CA | ALA | A | 1181 | −5.698 | 10.967 | −15.460 | 1.00 | 1.00 | C |
| ATOM | 3281 | C | ALA | A | 1181 | −5.498 | 10.776 | −16.983 | 1.00 | 1.00 | C |
| ATOM | 3282 | O | ALA | A | 1181 | −6.493 | 10.675 | −17.702 | 1.00 | 1.00 | O |
| ATOM | 3283 | CB | ALA | A | 1181 | −5.324 | 12.459 | −15.130 | 1.00 | 1.00 | C |
| ATOM | 3284 | HA | ALA | A | 1181 | −6.724 | 10.795 | −15.240 | 1.00 | 1.00 | H |
| ATOM | 3285 | HB1 | ALA | A | 1181 | −5.562 | 12.531 | −14.062 | 1.00 | 1.00 | H |
| ATOM | 3286 | HB2 | ALA | A | 1181 | −4.276 | 12.759 | −15.337 | 1.00 | 1.00 | H |
| ATOM | 3287 | HB3 | ALA | A | 1181 | −6.001 | 13.098 | −15.681 | 1.00 | 1.00 | H |
| ATOM | 3288 | HN | ALA | A | 1181 | −4.148 | 10.358 | −14.143 | 1.00 | 1.00 | H |
| ATOM | 3289 | N | GLN | A | 1182 | −4.236 | 10.767 | −17.521 | 1.00 | 1.00 | N |
| ATOM | 3290 | CA | GLN | A | 1182 | −4.072 | 10.684 | −18.980 | 1.00 | 1.00 | C |
| ATOM | 3291 | C | GLN | A | 1182 | −4.770 | 9.404 | −19.366 | 1.00 | 1.00 | C |
| ATOM | 3292 | O | GLN | A | 1182 | −5.570 | 9.338 | −20.286 | 1.00 | 1.00 | O |
| ATOM | 3293 | CB | GLN | A | 1182 | −2.595 | 10.644 | −19.394 | 1.00 | 1.00 | C |
| ATOM | 3294 | CG | GLN | A | 1182 | −1.900 | 12.036 | −19.233 | 1.00 | 1.00 | C |
| ATOM | 3295 | CD | GLN | A | 1182 | −0.420 | 11.888 | −19.533 | 1.00 | 1.00 | C |
| ATOM | 3296 | OE1 | GLN | A | 1182 | 0.256 | 11.016 | −19.029 | 1.00 | 1.00 | O |
| ATOM | 3297 | NE2 | GLN | A | 1182 | 0.145 | 12.691 | −20.456 | 1.00 | 1.00 | N |
| ATOM | 3298 | HA | GLN | A | 1182 | −4.593 | 11.604 | −19.352 | 1.00 | 1.00 | H |
| ATOM | 3299 | HB1 | GLN | A | 1182 | −2.577 | 10.511 | −20.482 | 1.00 | 1.00 | H |
| ATOM | 3300 | HB2 | GLN | A | 1182 | −2.100 | 9.845 | −18.806 | 1.00 | 1.00 | H |
| ATOM | 3301 | HG1 | GLN | A | 1182 | −2.302 | 12.787 | −19.978 | 1.00 | 1.00 | H |
| ATOM | 3302 | HG2 | GLN | A | 1182 | −1.942 | 12.444 | −18.235 | 1.00 | 1.00 | H |
| ATOM | 3303 | HE22 | GLN | A | 1182 | 1.074 | 12.556 | −20.747 | 1.00 | 1.00 | H |
| ATOM | 3304 | HE21 | GLN | A | 1182 | −0.324 | 13.479 | −20.830 | 1.00 | 1.00 | H |
| ATOM | 3305 | HN | GLN | A | 1182 | −3.486 | 10.925 | −16.924 | 1.00 | 1.00 | H |
| ATOM | 3306 | N | PHE | A | 1183 | −4.399 | 8.287 | −18.665 | 1.00 | 1.00 | N |
| ATOM | 3307 | CA | PHE | A | 1183 | −5.062 | 6.974 | −18.909 | 1.00 | 1.00 | C |
| ATOM | 3308 | C | PHE | A | 1183 | −6.541 | 7.137 | −18.907 | 1.00 | 1.00 | C |
| ATOM | 3309 | O | PHE | A | 1183 | −7.202 | 6.566 | −19.764 | 1.00 | 1.00 | O |
| ATOM | 3310 | CB | PHE | A | 1183 | −4.538 | 5.902 | −17.902 | 1.00 | 1.00 | C |
| ATOM | 3311 | CG | PHE | A | 1183 | −5.395 | 4.618 | −17.982 | 1.00 | 1.00 | C |
| ATOM | 3312 | CD1 | PHE | A | 1183 | −6.258 | 4.282 | −16.943 | 1.00 | 1.00 | C |
| ATOM | 3313 | CD2 | PHE | A | 1183 | −5.276 | 3.769 | −19.099 | 1.00 | 1.00 | C |
| ATOM | 3314 | CE1 | PHE | A | 1183 | −7.031 | 3.094 | −17.033 | 1.00 | 1.00 | C |
| ATOM | 3315 | CE2 | PHE | A | 1183 | −5.950 | 2.566 | −19.142 | 1.00 | 1.00 | C |
| ATOM | 3316 | CZ | PHE | A | 1183 | −6.880 | 2.260 | −18.124 | 1.00 | 1.00 | C |
| ATOM | 3317 | HA | PHE | A | 1183 | −4.771 | 6.684 | −19.899 | 1.00 | 1.00 | H |
| ATOM | 3318 | HB1 | PHE | A | 1183 | −4.724 | 6.417 | −16.942 | 1.00 | 1.00 | H |
| ATOM | 3319 | HB2 | PHE | A | 1183 | −3.450 | 5.623 | −17.993 | 1.00 | 1.00 | H |
| ATOM | 3320 | HD2 | PHE | A | 1183 | −4.615 | 4.162 | −19.891 | 1.00 | 1.00 | H |
| ATOM | 3321 | HE2 | PHE | A | 1183 | −5.766 | 1.920 | −19.960 | 1.00 | 1.00 | H |
| ATOM | 3322 | HZ | PHE | A | 1183 | −7.530 | 1.416 | −18.276 | 1.00 | 1.00 | H |
| ATOM | 3323 | HE1 | PHE | A | 1183 | −7.689 | 2.776 | −16.268 | 1.00 | 1.00 | H |
| ATOM | 3324 | HD1 | PHE | A | 1183 | −6.334 | 4.896 | −16.052 | 1.00 | 1.00 | H |
| ATOM | 3325 | HN | PHE | A | 1183 | −3.714 | 8.346 | −17.953 | 1.00 | 1.00 | H |
| ATOM | 3326 | N | THR | A | 1184 | −7.206 | 7.838 | −17.954 | 1.00 | 1.00 | N |
| ATOM | 3327 | CA | THR | A | 1184 | −8.657 | 7.971 | −18.080 | 1.00 | 1.00 | C |
| ATOM | 3328 | C | THR | A | 1184 | −8.894 | 8.636 | −19.451 | 1.00 | 1.00 | C |
| ATOM | 3329 | O | THR | A | 1184 | −9.716 | 8.064 | −20.128 | 1.00 | 1.00 | O |
| ATOM | 3330 | CB | THR | A | 1184 | −9.194 | 8.817 | −16.920 | 1.00 | 1.00 | C |
| ATOM | 3331 | OG1 | THR | A | 1184 | −8.664 | 8.195 | −15.711 | 1.00 | 1.00 | O |
| ATOM | 3332 | CG2 | THR | A | 1184 | −10.727 | 8.690 | −16.781 | 1.00 | 1.00 | C |
| ATOM | 3333 | HA | THR | A | 1184 | −9.062 | 6.947 | −18.125 | 1.00 | 1.00 | H |
| ATOM | 3334 | HB | THR | A | 1184 | −8.876 | 9.814 | −16.974 | 1.00 | 1.00 | H |
| ATOM | 3335 | HG1 | THR | A | 1184 | −8.924 | 8.523 | −14.865 | 1.00 | 1.00 | H |
| ATOM | 3336 | HG23 | THR | A | 1184 | −11.203 | 9.157 | −17.692 | 1.00 | 1.00 | H |
| ATOM | 3337 | HG21 | THR | A | 1184 | −11.028 | 7.646 | −16.673 | 1.00 | 1.00 | H |
| ATOM | 3338 | HG22 | THR | A | 1184 | −11.152 | 9.189 | −15.886 | 1.00 | 1.00 | H |
| ATOM | 3339 | HN | THR | A | 1184 | −6.686 | 8.304 | −17.178 | 1.00 | 1.00 | H |
| ATOM | 3340 | N | SER | A | 1185 | −8.197 | 9.701 | −19.929 | 1.00 | 1.00 | N |
| ATOM | 3341 | CA | SER | A | 1185 | −8.305 | 10.134 | −21.329 | 1.00 | 1.00 | C |
| ATOM | 3342 | C | SER | A | 1185 | −8.169 | 8.924 | −22.214 | 1.00 | 1.00 | C |
| ATOM | 3343 | O | SER | A | 1185 | −8.959 | 8.780 | −23.130 | 1.00 | 1.00 | O |
| ATOM | 3344 | CB | SER | A | 1185 | −7.374 | 11.293 | −21.780 | 1.00 | 1.00 | C |
| ATOM | 3345 | OG | SER | A | 1185 | −7.759 | 11.902 | −23.026 | 1.00 | 1.00 | O |
| ATOM | 3346 | HA | SER | A | 1185 | −9.290 | 10.592 | −21.405 | 1.00 | 1.00 | H |
| ATOM | 3347 | HB1 | SER | A | 1185 | −6.338 | 10.918 | −21.845 | 1.00 | 1.00 | H |
| ATOM | 3348 | HB2 | SER | A | 1185 | −7.420 | 12.054 | −20.980 | 1.00 | 1.00 | H |
| ATOM | 3349 | HG | SER | A | 1185 | −7.701 | 11.226 | −23.703 | 1.00 | 1.00 | H |
| ATOM | 3350 | HN | SER | A | 1185 | −7.517 | 10.113 | −19.342 | 1.00 | 1.00 | H |
| ATOM | 3351 | N | ALA | A | 1186 | −7.164 | 8.065 | −22.049 | 1.00 | 1.00 | N |
| ATOM | 3352 | CA | ALA | A | 1186 | −7.202 | 6.908 | −22.915 | 1.00 | 1.00 | C |
| ATOM | 3353 | C | ALA | A | 1186 | −8.516 | 6.123 | −22.766 | 1.00 | 1.00 | C |
| ATOM | 3354 | O | ALA | A | 1186 | −8.882 | 5.571 | −23.815 | 1.00 | 1.00 | O |
| ATOM | 3355 | CB | ALA | A | 1186 | −5.896 | 6.083 | −22.759 | 1.00 | 1.00 | C |
| ATOM | 3356 | HA | ALA | A | 1186 | −7.242 | 7.260 | −24.002 | 1.00 | 1.00 | H |
| ATOM | 3357 | HB1 | ALA | A | 1186 | −5.760 | 5.404 | −23.603 | 1.00 | 1.00 | H |
| ATOM | 3358 | HB2 | ALA | A | 1186 | −5.046 | 6.762 | −22.634 | 1.00 | 1.00 | H |
| ATOM | 3359 | HB3 | ALA | A | 1186 | −6.003 | 5.552 | −21.816 | 1.00 | 1.00 | H |
| ATOM | 3360 | HN | ALA | A | 1186 | −6.532 | 8.152 | −21.311 | 1.00 | 1.00 | H |
| ATOM | 3361 | N | ILE | A | 1187 | −9.211 | 6.080 | −21.634 | 1.00 | 1.00 | N |
| ATOM | 3362 | CA | ILE | A | 1187 | −10.563 | 5.485 | −21.655 | 1.00 | 1.00 | C |
| ATOM | 3363 | C | ILE | A | 1187 | −11.561 | 6.268 | −22.453 | 1.00 | 1.00 | C |
| ATOM | 3364 | O | ILE | A | 1187 | −12.392 | 5.691 | −23.134 | 1.00 | 1.00 | O |
| ATOM | 3365 | CB | ILE | A | 1187 | −11.103 | 5.086 | −20.269 | 1.00 | 1.00 | C |
| ATOM | 3366 | CG1 | ILE | A | 1187 | −10.144 | 4.114 | −19.474 | 1.00 | 1.00 | C |
| ATOM | 3367 | CG2 | ILE | A | 1187 | −12.516 | 4.434 | −20.397 | 1.00 | 1.00 | C |
| ATOM | 3368 | CD1 | ILE | A | 1187 | −9.448 | 2.959 | −20.316 | 1.00 | 1.00 | C |
| ATOM | 3369 | HA | ILE | A | 1187 | −10.469 | 4.606 | −22.238 | 1.00 | 1.00 | H |
| ATOM | 3370 | HB | ILE | A | 1187 | −11.290 | 5.966 | −19.643 | 1.00 | 1.00 | H |
| ATOM | 3371 | HG11 | ILE | A | 1187 | −9.312 | 4.745 | −19.122 | 1.00 | 1.00 | H |
| ATOM | 3372 | HG12 | ILE | A | 1187 | −10.591 | 3.726 | −18.568 | 1.00 | 1.00 | H |
| ATOM | 3373 | HD11 | ILE | A | 1187 | −10.181 | 2.383 | −20.916 | 1.00 | 1.00 | H |
| ATOM | 3374 | HD12 | ILE | A | 1187 | −8.615 | 3.404 | −20.925 | 1.00 | 1.00 | H |
| ATOM | 3375 | HD13 | ILE | A | 1187 | −9.011 | 2.278 | −19.608 | 1.00 | 1.00 | H |
| ATOM | 3376 | HG21 | ILE | A | 1187 | −12.527 | 3.643 | −21.168 | 1.00 | 1.00 | H |
| ATOM | 3377 | HG22 | ILE | A | 1187 | −12.847 | 3.922 | −19.424 | 1.00 | 1.00 | H |
| ATOM | 3378 | HG23 | ILE | A | 1187 | −13.271 | 5.202 | −20.697 | 1.00 | 1.00 | H |
| ATOM | 3379 | HN | ILE | A | 1187 | −8.848 | 6.524 | −20.804 | 1.00 | 1.00 | H |
| ATOM | 3380 | N | CYS | A | 1188 | −11.446 | 7.611 | −22.353 | 1.00 | 1.00 | N |
| ATOM | 3381 | CA | CYS | A | 1188 | −12.216 | 8.460 | −23.238 | 1.00 | 1.00 | C |
| ATOM | 3382 | C | CYS | A | 1188 | −12.107 | 7.883 | −24.603 | 1.00 | 1.00 | C |
| ATOM | 3383 | O | CYS | A | 1188 | −13.097 | 7.644 | −25.280 | 1.00 | 1.00 | O |
| ATOM | 3384 | CB | CYS | A | 1188 | −11.623 | 9.879 | −23.343 | 1.00 | 1.00 | C |
| ATOM | 3385 | SG | CYS | A | 1188 | −12.756 | 11.068 | −24.162 | 1.00 | 1.00 | S |
| ATOM | 3386 | HA | CYS | A | 1188 | −13.264 | 8.490 | −22.934 | 1.00 | 1.00 | H |
| ATOM | 3387 | HB1 | CYS | A | 1188 | −11.440 | 10.249 | −22.315 | 1.00 | 1.00 | H |
| ATOM | 3388 | HB2 | CYS | A | 1188 | −10.671 | 9.976 | −23.923 | 1.00 | 1.00 | H |
| ATOM | 3389 | HG | CYS | A | 1188 | −12.108 | 11.830 | −24.258 | 1.00 | 1.00 | H |
| ATOM | 3390 | HN | CYS | A | 1188 | −10.808 | 7.988 | −21.671 | 1.00 | 1.00 | H |
| ATOM | 3391 | N | SER | A | 1189 | −10.835 | 7.543 | −25.027 | 1.00 | 1.00 | N |
| ATOM | 3392 | CA | SER | A | 1189 | −10.685 | 7.039 | −26.408 | 1.00 | 1.00 | C |
| ATOM | 3393 | C | SER | A | 1189 | −11.465 | 5.739 | −26.573 | 1.00 | 1.00 | C |
| ATOM | 3394 | O | SER | A | 1189 | −12.279 | 5.676 | −27.495 | 1.00 | 1.00 | O |
| ATOM | 3395 | CB | SER | A | 1189 | −9.198 | 6.815 | −26.826 | 1.00 | 1.00 | C |
| ATOM | 3396 | OG | SER | A | 1189 | −8.501 | 5.670 | −26.365 | 1.00 | 1.00 | O |
| ATOM | 3397 | HA | SER | A | 1189 | −11.134 | 7.804 | −27.138 | 1.00 | 1.00 | H |
| ATOM | 3398 | HB1 | SER | A | 1189 | −9.173 | 6.636 | −27.942 | 1.00 | 1.00 | H |
| ATOM | 3399 | HB2 | SER | A | 1189 | −8.638 | 7.705 | −26.512 | 1.00 | 1.00 | H |
| ATOM | 3400 | HG | SER | A | 1189 | −8.375 | 5.667 | −25.431 | 1.00 | 1.00 | H |
| ATOM | 3401 | HN | SER | A | 1189 | −9.975 | 7.671 | −24.485 | 1.00 | 1.00 | H |
| ATOM | 3402 | N | VAL | A | 1190 | −11.185 | 4.677 | −25.795 | 1.00 | 1.00 | N |
| ATOM | 3403 | CA | VAL | A | 1190 | −11.822 | 3.361 | −26.161 | 1.00 | 1.00 | C |
| ATOM | 3404 | C | VAL | A | 1190 | −13.394 | 3.508 | −25.977 | 1.00 | 1.00 | C |
| ATOM | 3405 | O | VAL | A | 1190 | −14.209 | 2.963 | −26.739 | 1.00 | 1.00 | O |
| ATOM | 3406 | CB | VAL | A | 1190 | −11.165 | 2.069 | −25.530 | 1.00 | 1.00 | C |
| ATOM | 3407 | CG1 | VAL | A | 1190 | −9.678 | 1.848 | −25.884 | 1.00 | 1.00 | C |
| ATOM | 3408 | CG2 | VAL | A | 1190 | −11.343 | 1.874 | −24.045 | 1.00 | 1.00 | C |
| ATOM | 3409 | HA | VAL | A | 1190 | −11.695 | 3.271 | −27.259 | 1.00 | 1.00 | H |
| ATOM | 3410 | HB | VAL | A | 1190 | −11.687 | 1.228 | −25.938 | 1.00 | 1.00 | H |
| ATOM | 3411 | HG11 | VAL | A | 1190 | −9.091 | 2.637 | −25.395 | 1.00 | 1.00 | H |
| ATOM | 3412 | HG12 | VAL | A | 1190 | −9.482 | 1.923 | −26.980 | 1.00 | 1.00 | H |
| ATOM | 3413 | HG13 | VAL | A | 1190 | −9.270 | 0.885 | −25.560 | 1.00 | 1.00 | H |
| ATOM | 3414 | HG21 | VAL | A | 1190 | −11.063 | 0.864 | −23.686 | 1.00 | 1.00 | H |
| ATOM | 3415 | HG22 | VAL | A | 1190 | −10.704 | 2.616 | −23.553 | 1.00 | 1.00 | H |
| ATOM | 3416 | HG23 | VAL | A | 1190 | −12.401 | 2.094 | −23.724 | 1.00 | 1.00 | H |
| ATOM | 3417 | HN | VAL | A | 1190 | −10.519 | 4.707 | −25.008 | 1.00 | 1.00 | H |
| ATOM | 3418 | N | VAL | A | 1191 | −13.827 | 4.243 | −24.916 | 1.00 | 1.00 | N |
| ATOM | 3419 | CA | VAL | A | 1191 | −15.254 | 4.468 | −24.789 | 1.00 | 1.00 | C |
| ATOM | 3420 | C | VAL | A | 1191 | −15.897 | 5.198 | −25.961 | 1.00 | 1.00 | C |
| ATOM | 3421 | O | VAL | A | 1191 | −16.947 | 4.782 | −26.497 | 1.00 | 1.00 | O |
| ATOM | 3422 | CB | VAL | A | 1191 | −15.551 | 5.099 | −23.406 | 1.00 | 1.00 | C |
| ATOM | 3423 | CG1 | VAL | A | 1191 | −16.936 | 5.890 | −23.317 | 1.00 | 1.00 | C |
| ATOM | 3424 | CG2 | VAL | A | 1191 | −15.495 | 3.988 | −22.317 | 1.00 | 1.00 | C |
| ATOM | 3425 | HA | VAL | A | 1191 | −15.850 | 3.558 | −24.721 | 1.00 | 1.00 | H |
| ATOM | 3426 | HB | VAL | A | 1191 | −14.794 | 5.912 | −23.161 | 1.00 | 1.00 | H |
| ATOM | 3427 | HG11 | VAL | A | 1191 | −16.824 | 6.849 | −23.917 | 1.00 | 1.00 | H |
| ATOM | 3428 | HG12 | VAL | A | 1191 | −17.774 | 5.331 | −23.736 | 1.00 | 1.00 | H |
| ATOM | 3429 | HG13 | VAL | A | 1191 | −17.190 | 6.153 | −22.291 | 1.00 | 1.00 | H |
| ATOM | 3430 | HG21 | VAL | A | 1191 | −16.396 | 3.364 | −22.416 | 1.00 | 1.00 | H |
| ATOM | 3431 | HG22 | VAL | A | 1191 | −14.646 | 3.289 | −22.345 | 1.00 | 1.00 | H |
| ATOM | 3432 | HG23 | VAL | A | 1191 | −15.513 | 4.452 | −21.330 | 1.00 | 1.00 | H |
| ATOM | 3433 | HN | VAL | A | 1191 | −13.191 | 4.551 | −24.226 | 1.00 | 1.00 | H |
| ATOM | 3434 | N | ARG | A | 1192 | −15.250 | 6.282 | −26.470 | 1.00 | 1.00 | N |
| ATOM | 3435 | CA | ARG | A | 1192 | −15.726 | 6.827 | −27.730 | 1.00 | 1.00 | C |
| ATOM | 3436 | C | ARG | A | 1192 | −15.679 | 5.712 | −28.759 | 1.00 | 1.00 | C |
| ATOM | 3437 | O | ARG | A | 1192 | −16.673 | 5.468 | −29.428 | 1.00 | 1.00 | O |
| ATOM | 3438 | CB | ARG | A | 1192 | −14.873 | 8.047 | −28.215 | 1.00 | 1.00 | C |
| ATOM | 3439 | CG | ARG | A | 1192 | −15.549 | 9.379 | −27.669 | 1.00 | 1.00 | C |
| ATOM | 3440 | CD | ARG | A | 1192 | −15.695 | 9.449 | −26.156 | 1.00 | 1.00 | C |
| ATOM | 3441 | NE | ARG | A | 1192 | −16.339 | 10.708 | −25.746 | 1.00 | 1.00 | N |
| ATOM | 3442 | CZ | ARG | A | 1192 | −16.450 | 11.075 | −24.490 | 1.00 | 1.00 | C |
| ATOM | 3443 | NH1 | ARG | A | 1192 | −15.995 | 10.342 | −23.494 | 1.00 | 1.00 | N |
| ATOM | 3444 | NH2 | ARG | A | 1192 | −17.078 | 12.235 | −24.233 | 1.00 | 1.00 | N |
| ATOM | 3445 | HA | ARG | A | 1192 | −16.798 | 7.060 | −27.583 | 1.00 | 1.00 | H |
| ATOM | 3446 | HB1 | ARG | A | 1192 | −14.922 | 8.121 | −29.308 | 1.00 | 1.00 | H |
| ATOM | 3447 | HB2 | ARG | A | 1192 | −13.848 | 7.987 | −27.883 | 1.00 | 1.00 | H |
| ATOM | 3448 | HG1 | ARG | A | 1192 | −14.915 | 10.220 | −28.088 | 1.00 | 1.00 | H |
| ATOM | 3449 | HG2 | ARG | A | 1192 | −16.535 | 9.521 | −28.086 | 1.00 | 1.00 | H |
| ATOM | 3450 | HD1 | ARG | A | 1192 | −16.335 | 8.652 | −25.819 | 1.00 | 1.00 | H |
| ATOM | 3451 | HD2 | ARG | A | 1192 | −14.694 | 9.230 | −25.763 | 1.00 | 1.00 | H |
| ATOM | 3452 | HE | ARG | A | 1192 | −16.697 | 11.317 | −26.474 | 1.00 | 1.00 | H |
| ATOM | 3453 | HH12 | ARG | A | 1192 | −16.032 | 10.720 | −22.511 | 1.00 | 1.00 | H |
| ATOM | 3454 | HH11 | ARG | A | 1192 | −15.539 | 9.450 | −23.619 | 1.00 | 1.00 | H |
| ATOM | 3455 | HH22 | ARG | A | 1192 | −17.255 | 12.515 | −23.248 | 1.00 | 1.00 | H |
| ATOM | 3456 | HH21 | ARG | A | 1192 | −17.466 | 12.806 | −24.972 | 1.00 | 1.00 | H |
| ATOM | 3457 | HN | ARG | A | 1192 | −14.416 | 6.686 | −26.038 | 1.00 | 1.00 | H |
| ATOM | 3458 | N | ARG | A | 1193 | −14.568 | 4.990 | −28.979 | 1.00 | 1.00 | N |
| ATOM | 3459 | CA | ARG | A | 1193 | −14.596 | 3.880 | −29.899 | 1.00 | 1.00 | C |
| ATOM | 3460 | C | ARG | A | 1193 | −15.880 | 3.087 | −29.744 | 1.00 | 1.00 | C |
| ATOM | 3461 | O | ARG | A | 1193 | −16.593 | 2.807 | −30.694 | 1.00 | 1.00 | O |
| ATOM | 3462 | CB | ARG | A | 1193 | −13.390 | 2.965 | −29.795 | 1.00 | 1.00 | C |
| ATOM | 3463 | CG | ARG | A | 1193 | −13.343 | 1.980 | −31.031 | 1.00 | 1.00 | C |
| ATOM | 3464 | CD | ARG | A | 1193 | −14.035 | 0.557 | −30.871 | 1.00 | 1.00 | C |
| ATOM | 3465 | NE | ARG | A | 1193 | −13.357 | −0.155 | −29.803 | 1.00 | 1.00 | N |
| ATOM | 3466 | CZ | ARG | A | 1193 | −13.643 | −1.376 | −29.408 | 1.00 | 1.00 | C |
| ATOM | 3467 | NH1 | ARG | A | 1193 | −14.612 | −2.083 | −29.853 | 1.00 | 1.00 | N |
| ATOM | 3468 | NH2 | ARG | A | 1193 | −12.936 | −1.832 | −28.418 | 1.00 | 1.00 | N |
| ATOM | 3469 | HA | ARG | A | 1193 | −14.545 | 4.332 | −30.868 | 1.00 | 1.00 | H |
| ATOM | 3470 | HB1 | ARG | A | 1193 | −13.376 | 2.389 | −28.841 | 1.00 | 1.00 | H |
| ATOM | 3471 | HB2 | ARG | A | 1193 | −12.478 | 3.556 | −29.845 | 1.00 | 1.00 | H |
| ATOM | 3472 | HG1 | ARG | A | 1193 | −13.751 | 2.467 | −31.935 | 1.00 | 1.00 | H |
| ATOM | 3473 | HG2 | ARG | A | 1193 | −12.306 | 1.702 | −31.354 | 1.00 | 1.00 | H |
| ATOM | 3474 | HD1 | ARG | A | 1193 | −15.089 | 0.762 | −30.678 | 1.00 | 1.00 | H |
| ATOM | 3475 | HD2 | ARG | A | 1193 | −13.982 | 0.105 | −31.883 | 1.00 | 1.00 | H |
| ATOM | 3476 | HE | ARG | A | 1193 | −12.508 | 0.319 | −29.393 | 1.00 | 1.00 | H |
| ATOM | 3477 | HH12 | ARG | A | 1193 | −14.756 | −3.062 | −29.561 | 1.00 | 1.00 | H |
| ATOM | 3478 | HH11 | ARG | A | 1193 | −15.241 | −1.746 | −30.595 | 1.00 | 1.00 | H |
| ATOM | 3479 | HH22 | ARG | A | 1193 | −13.075 | −2.780 | −28.063 | 1.00 | 1.00 | H |
| ATOM | 3480 | HH21 | ARG | A | 1193 | −12.175 | −1.345 | −27.983 | 1.00 | 1.00 | H |
| ATOM | 3481 | HN | ARG | A | 1193 | −13.773 | 5.114 | −28.364 | 1.00 | 1.00 | H |
| ATOM | 3482 | N | ALA | A | 1194 | −16.257 | 2.756 | −28.480 | 1.00 | 1.00 | N |
| ATOM | 3483 | CA | ALA | A | 1194 | −17.617 | 2.074 | −28.302 | 1.00 | 1.00 | C |
| ATOM | 3484 | C | ALA | A | 1194 | −17.498 | 0.563 | −28.547 | 1.00 | 1.00 | C |
| ATOM | 3485 | O | ALA | A | 1194 | −16.460 | 0.073 | −28.977 | 1.00 | 1.00 | O |
| ATOM | 3486 | CB | ALA | A | 1194 | −18.799 | 2.646 | −29.140 | 1.00 | 1.00 | C |
| ATOM | 3487 | HA | ALA | A | 1194 | −17.873 | 2.269 | −27.238 | 1.00 | 1.00 | H |
| ATOM | 3488 | HB1 | ALA | A | 1194 | −18.869 | 2.258 | −30.180 | 1.00 | 1.00 | H |
| ATOM | 3489 | HB2 | ALA | A | 1194 | −19.813 | 2.425 | −28.651 | 1.00 | 1.00 | H |
| ATOM | 3490 | HB3 | ALA | A | 1194 | −18.732 | 3.737 | −29.285 | 1.00 | 1.00 | H |
| ATOM | 3491 | HN | ALA | A | 1194 | −15.703 | 2.951 | −27.674 | 1.00 | 1.00 | H |
| ATOM | 3492 | N | PHE | A | 1195 | −18.560 | −0.261 | −28.214 | 1.00 | 1.00 | N |
| ATOM | 3493 | CA | PHE | A | 1195 | −18.399 | −1.706 | −28.289 | 1.00 | 1.00 | C |
| ATOM | 3494 | C | PHE | A | 1195 | −19.735 | −2.324 | −28.776 | 1.00 | 1.00 | C |
| ATOM | 3495 | O | PHE | A | 1195 | −20.682 | −1.545 | −28.741 | 1.00 | 1.00 | O |
| ATOM | 3496 | CB | PHE | A | 1195 | −17.977 | −2.282 | −26.922 | 1.00 | 1.00 | C |
| ATOM | 3497 | CG | PHE | A | 1195 | −16.938 | −1.333 | −26.221 | 1.00 | 1.00 | C |
| ATOM | 3498 | CD1 | PHE | A | 1195 | −15.573 | −1.523 | −26.421 | 1.00 | 1.00 | C |
| ATOM | 3499 | CD2 | PHE | A | 1195 | −17.383 | −0.307 | −25.358 | 1.00 | 1.00 | C |
| ATOM | 3500 | CE1 | PHE | A | 1195 | −14.668 | −0.618 | −25.868 | 1.00 | 1.00 | C |
| ATOM | 3501 | CE2 | PHE | A | 1195 | −16.484 | 0.598 | −24.792 | 1.00 | 1.00 | C |
| ATOM | 3502 | CZ | PHE | A | 1195 | −15.110 | 0.400 | −25.046 | 1.00 | 1.00 | C |
| ATOM | 3503 | HA | PHE | A | 1195 | −17.661 | −1.974 | −29.031 | 1.00 | 1.00 | H |
| ATOM | 3504 | HB1 | PHE | A | 1195 | −17.478 | −3.255 | −27.117 | 1.00 | 1.00 | H |
| ATOM | 3505 | HB2 | PHE | A | 1195 | −18.850 | −2.480 | −26.238 | 1.00 | 1.00 | H |
| ATOM | 3506 | HD2 | PHE | A | 1195 | −18.462 | −0.175 | −25.256 | 1.00 | 1.00 | H |
| ATOM | 3507 | HE2 | PHE | A | 1195 | −16.800 | 1.401 | −24.164 | 1.00 | 1.00 | H |
| ATOM | 3508 | HZ | PHE | A | 1195 | −14.384 | 1.013 | −24.458 | 1.00 | 1.00 | H |
| ATOM | 3509 | HE1 | PHE | A | 1195 | −13.607 | −0.660 | −26.032 | 1.00 | 1.00 | H |
| ATOM | 3510 | HD1 | PHE | A | 1195 | −15.190 | −2.423 | −26.968 | 1.00 | 1.00 | H |
| ATOM | 3511 | HN | PHE | A | 1195 | −19.436 | 0.091 | −27.783 | 1.00 | 1.00 | H |
| ATOM | 3512 | N | PRO | A | 1196 | −19.889 | −3.623 | −29.149 | 1.00 | 1.00 | N |
| ATOM | 3513 | CA | PRO | A | 1196 | −21.176 | −4.038 | −29.691 | 1.00 | 1.00 | C |
| ATOM | 3514 | C | PRO | A | 1196 | −22.305 | −3.987 | −28.726 | 1.00 | 1.00 | C |
| ATOM | 3515 | O | PRO | A | 1196 | −23.396 | −3.572 | −29.083 | 1.00 | 1.00 | O |
| ATOM | 3516 | CB | PRO | A | 1196 | −20.820 | −5.541 | −30.052 | 1.00 | 1.00 | C |
| ATOM | 3517 | CG | PRO | A | 1196 | −19.308 | −5.478 | −30.296 | 1.00 | 1.00 | C |
| ATOM | 3518 | CD | PRO | A | 1196 | −18.794 | −4.545 | −29.200 | 1.00 | 1.00 | C |
| ATOM | 3519 | HA | PRO | A | 1196 | −21.426 | −3.486 | −30.561 | 1.00 | 1.00 | H |
| ATOM | 3520 | HD2 | PRO | A | 1196 | −18.611 | −5.023 | −28.224 | 1.00 | 1.00 | H |
| ATOM | 3521 | HD1 | PRO | A | 1196 | −17.794 | −4.228 | −29.613 | 1.00 | 1.00 | H |
| ATOM | 3522 | HG2 | PRO | A | 1196 | −19.207 | −4.978 | −31.293 | 1.00 | 1.00 | H |
| ATOM | 3523 | HG1 | PRO | A | 1196 | −18.826 | −6.457 | −30.257 | 1.00 | 1.00 | H |
| ATOM | 3524 | HB1 | PRO | A | 1196 | −21.382 | −5.871 | −30.949 | 1.00 | 1.00 | H |
| ATOM | 3525 | HB2 | PRO | A | 1196 | −21.036 | −6.220 | −29.237 | 1.00 | 1.00 | H |
| ATOM | 3526 | N | HIE | A | 1197 | −22.078 | −4.442 | −27.474 | 1.00 | 1.00 | N |
| ATOM | 3527 | CA | HIE | A | 1197 | −23.163 | −4.316 | −26.461 | 1.00 | 1.00 | C |
| ATOM | 3528 | C | HIE | A | 1197 | −22.525 | −4.223 | −25.102 | 1.00 | 1.00 | C |
| ATOM | 3529 | O | HIE | A | 1197 | −23.027 | −4.857 | −24.182 | 1.00 | 1.00 | O |
| ATOM | 3530 | H | HIE | A | 1197 | −21.171 | −4.796 | −27.220 | 1.00 | 1.00 | H |
| ATOM | 3531 | CB | HIE | A | 1197 | −24.141 | −5.461 | −26.532 | 1.00 | 1.00 | C |
| ATOM | 3532 | HB2 | HIE | A | 1197 | −24.570 | −5.524 | −27.564 | 1.00 | 1.00 | H |
| ATOM | 3533 | CG | HIE | A | 1197 | −23.424 | −6.734 | −26.316 | 1.00 | 1.00 | C |
| ATOM | 3534 | ND1 | HIE | A | 1197 | −23.250 | −7.356 | −25.037 | 1.00 | 1.00 | N |
| ATOM | 3535 | CD2 | HIE | A | 1197 | −22.820 | −7.582 | −27.164 | 1.00 | 1.00 | C |
| ATOM | 3536 | HA | HIE | A | 1197 | −23.747 | −3.431 | −26.668 | 1.00 | 1.00 | H |
| ATOM | 3537 | CE1 | HIE | A | 1197 | −22.502 | −8.388 | −25.196 | 1.00 | 1.00 | C |
| ATOM | 3538 | NE2 | HIE | A | 1197 | −22.223 | −8.522 | −26.448 | 1.00 | 1.00 | N |
| ATOM | 3539 | HB1 | HIE | A | 1197 | −25.035 | −5.359 | −25.845 | 1.00 | 1.00 | H |
| ATOM | 3540 | HD2 | HIE | A | 1197 | −22.734 | −7.423 | −28.264 | 1.00 | 1.00 | H |
| ATOM | 3541 | HE1 | HIE | A | 1197 | −22.213 | −9.064 | −24.447 | 1.00 | 1.00 | H |
| ATOM | 3542 | HE2 | HIE | A | 1197 | −21.625 | −9.305 | −26.817 | 1.00 | 1.00 | H |
| ATOM | 3543 | N | CYS | A | 1198 | −21.375 | −3.527 | −24.896 | 1.00 | 1.00 | N |
| ATOM | 3544 | CA | CYS | A | 1198 | −20.612 | −3.835 | −23.683 | 1.00 | 1.00 | C |
| ATOM | 3545 | C | CYS | A | 1198 | −19.834 | −2.604 | −23.272 | 1.00 | 1.00 | C |
| ATOM | 3546 | O | CYS | A | 1198 | −18.658 | −2.432 | −23.519 | 1.00 | 1.00 | O |
| ATOM | 3547 | CB | CYS | A | 1198 | −19.579 | −4.959 | −23.925 | 1.00 | 1.00 | C |
| ATOM | 3548 | SG | CYS | A | 1198 | −20.399 | −6.526 | −24.173 | 1.00 | 1.00 | S |
| ATOM | 3549 | HA | CYS | A | 1198 | −21.265 | −4.089 | −22.839 | 1.00 | 1.00 | H |
| ATOM | 3550 | HB1 | CYS | A | 1198 | −18.900 | −4.851 | −24.759 | 1.00 | 1.00 | H |
| ATOM | 3551 | HB2 | CYS | A | 1198 | −18.995 | −5.076 | −23.013 | 1.00 | 1.00 | H |
| ATOM | 3552 | HG | CYS | A | 1198 | −19.595 | −7.081 | −24.483 | 1.00 | 1.00 | H |
| ATOM | 3553 | HN | CYS | A | 1198 | −21.041 | −2.893 | −25.587 | 1.00 | 1.00 | H |
| ATOM | 3554 | N | LEU | A | 1199 | −20.546 | −1.672 | −22.546 | 1.00 | 1.00 | N |
| ATOM | 3555 | CA | LEU | A | 1199 | −19.927 | −0.417 | −22.072 | 1.00 | 1.00 | C |
| ATOM | 3556 | C | LEU | A | 1199 | −19.363 | −0.595 | −20.665 | 1.00 | 1.00 | C |
| ATOM | 3557 | O | LEU | A | 1199 | −19.752 | −1.550 | −20.030 | 1.00 | 1.00 | O |
| ATOM | 3558 | CB | LEU | A | 1199 | −21.069 | 0.679 | −22.196 | 1.00 | 1.00 | C |
| ATOM | 3559 | CG | LEU | A | 1199 | −20.728 | 2.186 | −21.929 | 1.00 | 1.00 | C |
| ATOM | 3560 | CD1 | LEU | A | 1199 | −19.671 | 2.733 | −22.942 | 1.00 | 1.00 | C |
| ATOM | 3561 | CD2 | LEU | A | 1199 | −22.051 | 2.988 | −22.149 | 1.00 | 1.00 | C |
| ATOM | 3562 | HA | LEU | A | 1199 | −19.044 | −0.102 | −22.683 | 1.00 | 1.00 | H |
| ATOM | 3563 | HB1 | LEU | A | 1199 | −21.956 | 0.405 | −21.562 | 1.00 | 1.00 | H |
| ATOM | 3564 | HB2 | LEU | A | 1199 | −21.378 | 0.575 | −23.277 | 1.00 | 1.00 | H |
| ATOM | 3565 | HG | LEU | A | 1199 | −20.299 | 2.407 | −20.937 | 1.00 | 1.00 | H |
| ATOM | 3566 | HD21 | LEU | A | 1199 | −22.429 | 2.870 | −23.193 | 1.00 | 1.00 | H |
| ATOM | 3567 | HD22 | LEU | A | 1199 | −22.856 | 2.688 | −21.456 | 1.00 | 1.00 | H |
| ATOM | 3568 | HD23 | LEU | A | 1199 | −21.815 | 4.092 | −22.004 | 1.00 | 1.00 | H |
| ATOM | 3569 | HD11 | LEU | A | 1199 | −18.670 | 2.336 | −22.709 | 1.00 | 1.00 | H |
| ATOM | 3570 | HD12 | LEU | A | 1199 | −20.004 | 2.447 | −23.915 | 1.00 | 1.00 | H |
| ATOM | 3571 | HD13 | LEU | A | 1199 | −19.575 | 3.821 | −23.029 | 1.00 | 1.00 | H |
| ATOM | 3572 | HN | LEU | A | 1199 | −21.514 | −1.853 | −22.370 | 1.00 | 1.00 | H |
| ATOM | 3573 | N | ALA | A | 1200 | −18.508 | 0.358 | −20.172 | 1.00 | 1.00 | N |
| ATOM | 3574 | CA | ALA | A | 1200 | −17.935 | 0.285 | −18.812 | 1.00 | 1.00 | C |
| ATOM | 3575 | C | ALA | A | 1200 | −17.362 | 1.605 | −18.373 | 1.00 | 1.00 | C |
| ATOM | 3576 | O | ALA | A | 1200 | −17.255 | 2.446 | −19.209 | 1.00 | 1.00 | O |
| ATOM | 3577 | CB | ALA | A | 1200 | −16.882 | −0.845 | −18.951 | 1.00 | 1.00 | C |
| ATOM | 3578 | HA | ALA | A | 1200 | −18.705 | 0.058 | −18.072 | 1.00 | 1.00 | H |
| ATOM | 3579 | HB1 | ALA | A | 1200 | −17.264 | −1.761 | −19.432 | 1.00 | 1.00 | H |
| ATOM | 3580 | HB2 | ALA | A | 1200 | −16.063 | −0.387 | −19.533 | 1.00 | 1.00 | H |
| ATOM | 3581 | HB3 | ALA | A | 1200 | −16.439 | −1.125 | −17.944 | 1.00 | 1.00 | H |
| ATOM | 3582 | HN | ALA | A | 1200 | −18.212 | 1.152 | −20.718 | 1.00 | 1.00 | H |
| ATOM | 3583 | N | PHE | A | 1201 | −16.915 | 1.804 | −17.136 | 1.00 | 1.00 | N |
| ATOM | 3584 | CA | PHE | A | 1201 | −16.267 | 3.080 | −16.850 | 1.00 | 1.00 | C |
| ATOM | 3585 | C | PHE | A | 1201 | −15.223 | 3.098 | −15.749 | 1.00 | 1.00 | C |
| ATOM | 3586 | O | PHE | A | 1201 | −15.128 | 2.054 | −15.148 | 1.00 | 1.00 | O |
| ATOM | 3587 | CB | PHE | A | 1201 | −17.316 | 4.155 | −16.454 | 1.00 | 1.00 | C |
| ATOM | 3588 | CG | PHE | A | 1201 | −18.303 | 4.433 | −17.577 | 1.00 | 1.00 | C |
| ATOM | 3589 | CD1 | PHE | A | 1201 | −19.578 | 3.908 | −17.584 | 1.00 | 1.00 | C |
| ATOM | 3590 | CD2 | PHE | A | 1201 | −17.953 | 5.341 | −18.565 | 1.00 | 1.00 | C |
| ATOM | 3591 | CE1 | PHE | A | 1201 | −20.545 | 4.446 | −18.433 | 1.00 | 1.00 | C |
| ATOM | 3592 | CE2 | PHE | A | 1201 | −18.895 | 5.832 | −19.470 | 1.00 | 1.00 | C |
| ATOM | 3593 | CZ | PHE | A | 1201 | −20.224 | 5.416 | −19.378 | 1.00 | 1.00 | C |
| ATOM | 3594 | HA | PHE | A | 1201 | −15.733 | 3.356 | −17.734 | 1.00 | 1.00 | H |
| ATOM | 3595 | HB1 | PHE | A | 1201 | −16.872 | 5.092 | −16.152 | 1.00 | 1.00 | H |
| ATOM | 3596 | HB2 | PHE | A | 1201 | −17.944 | 3.787 | −15.586 | 1.00 | 1.00 | H |
| ATOM | 3597 | HD2 | PHE | A | 1201 | −16.909 | 5.710 | −18.596 | 1.00 | 1.00 | H |
| ATOM | 3598 | HE2 | PHE | A | 1201 | −18.657 | 6.564 | −20.245 | 1.00 | 1.00 | H |
| ATOM | 3599 | HZ | PHE | A | 1201 | −20.973 | 5.730 | −20.071 | 1.00 | 1.00 | H |
| ATOM | 3600 | HE1 | PHE | A | 1201 | −21.567 | 4.033 | −18.444 | 1.00 | 1.00 | H |
| ATOM | 3601 | HD1 | PHE | A | 1201 | −19.861 | 3.123 | −16.898 | 1.00 | 1.00 | H |
| ATOM | 3602 | HN | PHE | A | 1201 | −16.914 | 1.057 | −16.481 | 1.00 | 1.00 | H |
| ATOM | 3603 | N | SER | A | 1202 | −14.438 | 4.188 | −15.677 | 1.00 | 1.00 | N |
| ATOM | 3604 | CA | SER | A | 1202 | −13.332 | 4.241 | −14.674 | 1.00 | 1.00 | C |
| ATOM | 3605 | C | SER | A | 1202 | −12.951 | 5.596 | −14.067 | 1.00 | 1.00 | C |
| ATOM | 3606 | O | SER | A | 1202 | −13.123 | 6.592 | −14.762 | 1.00 | 1.00 | O |
| ATOM | 3607 | CB | SER | A | 1202 | −12.054 | 3.592 | −15.239 | 1.00 | 1.00 | C |
| ATOM | 3608 | OG | SER | A | 1202 | −11.574 | 4.218 | −16.422 | 1.00 | 1.00 | O |
| ATOM | 3609 | HA | SER | A | 1202 | −13.644 | 3.666 | −13.783 | 1.00 | 1.00 | H |
| ATOM | 3610 | HB1 | SER | A | 1202 | −12.310 | 2.549 | −15.484 | 1.00 | 1.00 | H |
| ATOM | 3611 | HB2 | SER | A | 1202 | −11.225 | 3.618 | −14.542 | 1.00 | 1.00 | H |
| ATOM | 3612 | HG | SER | A | 1202 | −11.198 | 5.049 | −16.215 | 1.00 | 1.00 | H |
| ATOM | 3613 | HN | SER | A | 1202 | −14.535 | 4.896 | −16.380 | 1.00 | 1.00 | H |
| ATOM | 3614 | N | TYR | A | 1203 | −12.471 | 5.610 | −12.807 | 1.00 | 1.00 | N |
| ATOM | 3615 | CA | TYR | A | 1203 | −12.058 | 6.860 | −12.104 | 1.00 | 1.00 | C |
| ATOM | 3616 | C | TYR | A | 1203 | −10.901 | 6.554 | −11.119 | 1.00 | 1.00 | C |
| ATOM | 3617 | O | TYR | A | 1203 | −11.206 | 6.213 | −10.025 | 1.00 | 1.00 | O |
| ATOM | 3618 | CB | TYR | A | 1203 | −13.288 | 7.487 | −11.427 | 1.00 | 1.00 | C |
| ATOM | 3619 | CG | TYR | A | 1203 | −13.038 | 8.955 | −11.074 | 1.00 | 1.00 | C |
| ATOM | 3620 | CD1 | TYR | A | 1203 | −13.544 | 10.001 | −11.838 | 1.00 | 1.00 | C |
| ATOM | 3621 | CD2 | TYR | A | 1203 | −12.283 | 9.319 | −9.944 | 1.00 | 1.00 | C |
| ATOM | 3622 | CE1 | TYR | A | 1203 | −13.382 | 11.334 | −11.478 | 1.00 | 1.00 | C |
| ATOM | 3623 | CE2 | TYR | A | 1203 | −12.037 | 10.668 | −9.601 | 1.00 | 1.00 | C |
| ATOM | 3624 | CZ | TYR | A | 1203 | −12.682 | 11.647 | −10.342 | 1.00 | 1.00 | C |
| ATOM | 3625 | OH | TYR | A | 1203 | −12.600 | 12.962 | −9.950 | 1.00 | 1.00 | O |
| ATOM | 3626 | HA | TYR | A | 1203 | −11.655 | 7.548 | −12.870 | 1.00 | 1.00 | H |
| ATOM | 3627 | HB2 | TYR | A | 1203 | −13.602 | 7.001 | −10.516 | 1.00 | 1.00 | H |
| ATOM | 3628 | HB1 | TYR | A | 1203 | −14.110 | 7.472 | −12.193 | 1.00 | 1.00 | H |
| ATOM | 3629 | HD2 | TYR | A | 1203 | −11.845 | 8.575 | −9.348 | 1.00 | 1.00 | H |
| ATOM | 3630 | HE2 | TYR | A | 1203 | −11.419 | 10.924 | −8.778 | 1.00 | 1.00 | H |
| ATOM | 3631 | HE1 | TYR | A | 1203 | −13.707 | 12.091 | −12.169 | 1.00 | 1.00 | H |
| ATOM | 3632 | HD1 | TYR | A | 1203 | −14.055 | 9.777 | −12.791 | 1.00 | 1.00 | H |
| ATOM | 3633 | HH | TYR | A | 1203 | −11.882 | 13.224 | −9.357 | 1.00 | 1.00 | H |
| ATOM | 3634 | HN | TYR | A | 1203 | −12.352 | 4.739 | −12.277 | 1.00 | 1.00 | H |
| ATOM | 3635 | N | MET | A | 1204 | −9.630 | 6.730 | −11.455 | 1.00 | 1.00 | N |
| ATOM | 3636 | CA | MET | A | 1204 | −8.511 | 6.426 | −10.540 | 1.00 | 1.00 | C |
| ATOM | 3637 | C | MET | A | 1204 | −8.577 | 4.947 | −10.144 | 1.00 | 1.00 | C |
| ATOM | 3638 | O | MET | A | 1204 | −8.605 | 4.109 | −11.037 | 1.00 | 1.00 | O |
| ATOM | 3639 | CB | MET | A | 1204 | −8.503 | 7.545 | −9.414 | 1.00 | 1.00 | C |
| ATOM | 3640 | CG | MET | A | 1204 | −8.273 | 8.984 | −10.029 | 1.00 | 1.00 | C |
| ATOM | 3641 | SD | MET | A | 1204 | −6.694 | 9.115 | −10.854 | 1.00 | 1.00 | S |
| ATOM | 3642 | CE | MET | A | 1204 | −6.780 | 10.947 | −11.186 | 1.00 | 1.00 | C |
| ATOM | 3643 | HA | MET | A | 1204 | −7.551 | 6.521 | −11.013 | 1.00 | 1.00 | H |
| ATOM | 3644 | HB1 | MET | A | 1204 | −9.432 | 7.634 | −8.938 | 1.00 | 1.00 | H |
| ATOM | 3645 | HB2 | MET | A | 1204 | −7.736 | 7.358 | −8.605 | 1.00 | 1.00 | H |
| ATOM | 3646 | HG1 | MET | A | 1204 | −8.322 | 9.751 | −9.231 | 1.00 | 1.00 | H |
| ATOM | 3647 | HG2 | MET | A | 1204 | −9.152 | 9.231 | −10.665 | 1.00 | 1.00 | H |
| ATOM | 3648 | HE1 | MET | A | 1204 | −5.895 | 11.190 | −11.714 | 1.00 | 1.00 | H |
| ATOM | 3649 | HE2 | MET | A | 1204 | −6.821 | 11.404 | −10.174 | 1.00 | 1.00 | H |
| ATOM | 3650 | HE3 | MET | A | 1204 | −7.635 | 11.213 | −11.826 | 1.00 | 1.00 | H |
| ATOM | 3651 | HN | MET | A | 1204 | −9.362 | 6.961 | −12.390 | 1.00 | 1.00 | H |
| ATOM | 3652 | N | ASP | A | 1205 | −8.570 | 4.530 | −8.825 | 1.00 | 1.00 | N |
| ATOM | 3653 | CA | ASP | A | 1205 | −8.641 | 3.078 | −8.525 | 1.00 | 1.00 | C |
| ATOM | 3654 | C | ASP | A | 1205 | −10.081 | 2.743 | −8.380 | 1.00 | 1.00 | C |
| ATOM | 3655 | O | ASP | A | 1205 | −10.472 | 2.137 | −7.391 | 1.00 | 1.00 | O |
| ATOM | 3656 | CB | ASP | A | 1205 | −7.845 | 2.657 | −7.262 | 1.00 | 1.00 | C |
| ATOM | 3657 | CG | ASP | A | 1205 | −8.498 | 2.915 | −5.861 | 1.00 | 1.00 | C |
| ATOM | 3658 | OD1 | ASP | A | 1205 | −9.420 | 3.771 | −5.877 | 1.00 | 1.00 | O |
| ATOM | 3659 | OD2 | ASP | A | 1205 | −8.132 | 2.302 | −4.788 | 1.00 | 1.00 | O |
| ATOM | 3660 | HA | ASP | A | 1205 | −8.217 | 2.539 | −9.391 | 1.00 | 1.00 | H |
| ATOM | 3661 | HB1 | ASP | A | 1205 | −6.868 | 3.189 | −7.285 | 1.00 | 1.00 | H |
| ATOM | 3662 | HB2 | ASP | A | 1205 | −7.722 | 1.577 | −7.352 | 1.00 | 1.00 | H |
| ATOM | 3663 | HN | ASP | A | 1205 | −8.641 | 5.187 | −8.116 | 1.00 | 1.00 | H |
| ATOM | 3664 | N | ASP | A | 1206 | −10.983 | 3.146 | −9.280 | 1.00 | 1.00 | N |
| ATOM | 3665 | CA | ASP | A | 1206 | −12.423 | 2.887 | −9.079 | 1.00 | 1.00 | C |
| ATOM | 3666 | C | ASP | A | 1206 | −13.199 | 2.657 | −10.343 | 1.00 | 1.00 | C |
| ATOM | 3667 | O | ASP | A | 1206 | −13.264 | 3.418 | −11.290 | 1.00 | 1.00 | O |
| ATOM | 3668 | CB | ASP | A | 1206 | −13.051 | 4.057 | −8.321 | 1.00 | 1.00 | C |
| ATOM | 3669 | CG | ASP | A | 1206 | −12.194 | 4.197 | −7.110 | 1.00 | 1.00 | C |
| ATOM | 3670 | OD1 | ASP | A | 1206 | −11.165 | 4.853 | −7.023 | 1.00 | 1.00 | O |
| ATOM | 3671 | OD2 | ASP | A | 1206 | −12.455 | 3.693 | −6.027 | 1.00 | 1.00 | O |
| ATOM | 3672 | HA | ASP | A | 1206 | −12.539 | 1.984 | −8.437 | 1.00 | 1.00 | H |
| ATOM | 3673 | HB1 | ASP | A | 1206 | −14.075 | 3.751 | −7.970 | 1.00 | 1.00 | H |
| ATOM | 3674 | HB2 | ASP | A | 1206 | −13.083 | 5.065 | −8.754 | 1.00 | 1.00 | H |
| ATOM | 3675 | HN | ASP | A | 1206 | −10.793 | 3.745 | −10.075 | 1.00 | 1.00 | H |
| ATOM | 3676 | N | VAL | A | 1207 | −13.866 | 1.461 | −10.432 | 1.00 | 1.00 | N |
| ATOM | 3677 | CA | VAL | A | 1207 | −14.365 | 1.071 | −11.762 | 1.00 | 1.00 | C |
| ATOM | 3678 | C | VAL | A | 1207 | −15.709 | 0.400 | −11.785 | 1.00 | 1.00 | C |
| ATOM | 3679 | O | VAL | A | 1207 | −16.231 | 0.032 | −10.743 | 1.00 | 1.00 | O |
| ATOM | 3680 | CB | VAL | A | 1207 | −13.272 | 0.196 | −12.460 | 1.00 | 1.00 | C |
| ATOM | 3681 | CG1 | VAL | A | 1207 | −11.852 | 0.794 | −12.522 | 1.00 | 1.00 | C |
| ATOM | 3682 | CG2 | VAL | A | 1207 | −13.222 | −1.198 | −11.764 | 1.00 | 1.00 | C |
| ATOM | 3683 | HA | VAL | A | 1207 | −14.484 | 1.969 | −12.402 | 1.00 | 1.00 | H |
| ATOM | 3684 | HB | VAL | A | 1207 | −13.630 | −0.073 | −13.461 | 1.00 | 1.00 | H |
| ATOM | 3685 | HG11 | VAL | A | 1207 | −11.109 | 0.164 | −13.129 | 1.00 | 1.00 | H |
| ATOM | 3686 | HG12 | VAL | A | 1207 | −11.877 | 1.785 | −12.970 | 1.00 | 1.00 | H |
| ATOM | 3687 | HG13 | VAL | A | 1207 | −11.441 | 0.836 | −11.503 | 1.00 | 1.00 | H |
| ATOM | 3688 | HG21 | VAL | A | 1207 | −14.181 | −1.722 | −11.773 | 1.00 | 1.00 | H |
| ATOM | 3689 | HG22 | VAL | A | 1207 | −12.480 | −1.869 | −12.206 | 1.00 | 1.00 | H |
| ATOM | 3690 | HG23 | VAL | A | 1207 | −12.965 | −1.003 | −10.741 | 1.00 | 1.00 | H |
| ATOM | 3691 | HN | VAL | A | 1207 | −13.953 | 0.772 | −9.706 | 1.00 | 1.00 | H |
| ATOM | 3692 | N | VAL | A | 1208 | −16.172 | 0.324 | −13.032 | 1.00 | 1.00 | N |
| ATOM | 3693 | CA | VAL | A | 1208 | −17.507 | −0.241 | −13.314 | 1.00 | 1.00 | C |
| ATOM | 3694 | C | VAL | A | 1208 | −17.316 | −1.114 | −14.525 | 1.00 | 1.00 | C |
| ATOM | 3695 | O | VAL | A | 1208 | −17.475 | −0.571 | −15.619 | 1.00 | 1.00 | O |
| ATOM | 3696 | CB | VAL | A | 1208 | −18.550 | 0.858 | −13.611 | 1.00 | 1.00 | C |
| ATOM | 3697 | CG1 | VAL | A | 1208 | −19.951 | 0.316 | −13.959 | 1.00 | 1.00 | C |
| ATOM | 3698 | CG2 | VAL | A | 1208 | −18.524 | 1.820 | −12.364 | 1.00 | 1.00 | C |
| ATOM | 3699 | HA | VAL | A | 1208 | −17.900 | −0.832 | −12.542 | 1.00 | 1.00 | H |
| ATOM | 3700 | HB | VAL | A | 1208 | −18.320 | 1.547 | −14.427 | 1.00 | 1.00 | H |
| ATOM | 3701 | HG11 | VAL | A | 1208 | −19.862 | −0.484 | −14.674 | 1.00 | 1.00 | H |
| ATOM | 3702 | HG12 | VAL | A | 1208 | −20.522 | −0.035 | −13.092 | 1.00 | 1.00 | H |
| ATOM | 3703 | HG13 | VAL | A | 1208 | −20.560 | 1.055 | −14.457 | 1.00 | 1.00 | H |
| ATOM | 3704 | HG21 | VAL | A | 1208 | −17.590 | 2.346 | −12.267 | 1.00 | 1.00 | H |
| ATOM | 3705 | HG22 | VAL | A | 1208 | −19.334 | 2.594 | −12.407 | 1.00 | 1.00 | H |
| ATOM | 3706 | HG23 | VAL | A | 1208 | −18.593 | 1.155 | −11.453 | 1.00 | 1.00 | H |
| ATOM | 3707 | HN | VAL | A | 1208 | −15.747 | 0.776 | −13.830 | 1.00 | 1.00 | H |
| ATOM | 3708 | N | LEU | A | 1209 | −16.991 | −2.445 | −14.390 | 1.00 | 1.00 | N |
| ATOM | 3709 | CA | LEU | A | 1209 | −16.640 | −3.307 | −15.539 | 1.00 | 1.00 | C |
| ATOM | 3710 | C | LEU | A | 1209 | −17.734 | −4.275 | −15.780 | 1.00 | 1.00 | C |
| ATOM | 3711 | O | LEU | A | 1209 | −17.509 | −5.470 | −15.799 | 1.00 | 1.00 | O |
| ATOM | 3712 | CB | LEU | A | 1209 | −15.315 | −4.011 | −15.135 | 1.00 | 1.00 | C |
| ATOM | 3713 | CG | LEU | A | 1209 | −14.113 | −3.105 | −14.851 | 1.00 | 1.00 | C |
| ATOM | 3714 | CD1 | LEU | A | 1209 | −12.900 | −4.006 | −14.431 | 1.00 | 1.00 | C |
| ATOM | 3715 | CD2 | LEU | A | 1209 | −13.720 | −2.278 | −16.078 | 1.00 | 1.00 | C |
| ATOM | 3716 | HA | LEU | A | 1209 | −16.504 | −2.784 | −16.531 | 1.00 | 1.00 | H |
| ATOM | 3717 | HB1 | LEU | A | 1209 | −15.105 | −4.733 | −15.919 | 1.00 | 1.00 | H |
| ATOM | 3718 | HB2 | LEU | A | 1209 | −15.465 | −4.561 | −14.236 | 1.00 | 1.00 | H |
| ATOM | 3719 | HG | LEU | A | 1209 | −14.339 | −2.417 | −14.005 | 1.00 | 1.00 | H |
| ATOM | 3720 | HD21 | LEU | A | 1209 | −13.557 | −2.816 | −17.031 | 1.00 | 1.00 | H |
| ATOM | 3721 | HD22 | LEU | A | 1209 | −14.448 | −1.525 | −16.362 | 1.00 | 1.00 | H |
| ATOM | 3722 | HD23 | LEU | A | 1209 | −12.788 | −1.701 | −15.879 | 1.00 | 1.00 | H |
| ATOM | 3723 | HD11 | LEU | A | 1209 | −12.662 | −4.766 | −15.181 | 1.00 | 1.00 | H |
| ATOM | 3724 | HD12 | LEU | A | 1209 | −11.972 | −3.436 | −14.209 | 1.00 | 1.00 | H |
| ATOM | 3725 | HD13 | LEU | A | 1209 | −13.079 | −4.665 | −13.584 | 1.00 | 1.00 | H |
| ATOM | 3726 | HN | LEU | A | 1209 | −16.954 | −2.849 | −13.492 | 1.00 | 1.00 | H |
| ATOM | 3727 | N | GLY | A | 1210 | −18.963 | −3.841 | −15.957 | 1.00 | 1.00 | N |
| ATOM | 3728 | CA | GLY | A | 1210 | −20.053 | −4.801 | −16.265 | 1.00 | 1.00 | C |
| ATOM | 3729 | C | GLY | A | 1210 | −20.285 | −5.112 | −17.679 | 1.00 | 1.00 | C |
| ATOM | 3730 | O | GLY | A | 1210 | −21.136 | −5.920 | −17.933 | 1.00 | 1.00 | O |
| ATOM | 3731 | HA2 | GLY | A | 1210 | −21.012 | −4.420 | −15.929 | 1.00 | 1.00 | H |
| ATOM | 3732 | HA1 | GLY | A | 1210 | −19.883 | −5.754 | −15.749 | 1.00 | 1.00 | H |
| ATOM | 3733 | HN | GLY | A | 1210 | −19.128 | −2.869 | −15.942 | 1.00 | 1.00 | H |
| ATOM | 3734 | N | ALA | A | 1211 | −19.653 | −4.494 | −18.702 | 1.00 | 1.00 | N |
| ATOM | 3735 | CA | ALA | A | 1211 | −20.062 | −4.863 | −20.069 | 1.00 | 1.00 | C |
| ATOM | 3736 | C | ALA | A | 1211 | −21.578 | −4.877 | −20.270 | 1.00 | 1.00 | C |
| ATOM | 3737 | O | ALA | A | 1211 | −22.166 | −5.758 | −20.873 | 1.00 | 1.00 | O |
| ATOM | 3738 | CB | ALA | A | 1211 | −19.367 | −6.218 | −20.343 | 1.00 | 1.00 | C |
| ATOM | 3739 | HA | ALA | A | 1211 | −19.618 | −4.188 | −20.795 | 1.00 | 1.00 | H |
| ATOM | 3740 | HB1 | ALA | A | 1211 | −18.289 | −5.957 | −20.421 | 1.00 | 1.00 | H |
| ATOM | 3741 | HB2 | ALA | A | 1211 | −19.420 | −6.961 | −19.516 | 1.00 | 1.00 | H |
| ATOM | 3742 | HB3 | ALA | A | 1211 | −19.713 | −6.636 | −21.317 | 1.00 | 1.00 | H |
| ATOM | 3743 | HN | ALA | A | 1211 | −18.834 | −3.990 | −18.531 | 1.00 | 1.00 | H |
| ATOM | 3744 | N | LYS | A | 1212 | −22.253 | −3.854 | −19.666 | 1.00 | 1.00 | N |
| ATOM | 3745 | CA | LYS | A | 1212 | −23.693 | −3.848 | −19.504 | 1.00 | 1.00 | C |
| ATOM | 3746 | C | LYS | A | 1212 | −24.475 | −4.295 | −20.710 | 1.00 | 1.00 | C |
| ATOM | 3747 | O | LYS | A | 1212 | −23.948 | −4.321 | −21.778 | 1.00 | 1.00 | O |
| ATOM | 3748 | CB | LYS | A | 1212 | −24.099 | −2.401 | −18.997 | 1.00 | 1.00 | C |
| ATOM | 3749 | CG | LYS | A | 1212 | −25.590 | −2.293 | −18.556 | 1.00 | 1.00 | C |
| ATOM | 3750 | CD | LYS | A | 1212 | −25.799 | −0.919 | −17.875 | 1.00 | 1.00 | C |
| ATOM | 3751 | CE | LYS | A | 1212 | −27.250 | −0.739 | −17.362 | 1.00 | 1.00 | C |
| ATOM | 3752 | NZ | LYS | A | 1212 | −27.495 | 0.481 | −16.549 | 1.00 | 1.00 | N |
| ATOM | 3753 | HA | LYS | A | 1212 | −24.016 | −4.490 | −18.662 | 1.00 | 1.00 | H |
| ATOM | 3754 | HB1 | LYS | A | 1212 | −23.844 | −1.686 | −19.808 | 1.00 | 1.00 | H |
| ATOM | 3755 | HB2 | LYS | A | 1212 | −23.509 | −2.195 | −18.148 | 1.00 | 1.00 | H |
| ATOM | 3756 | HG1 | LYS | A | 1212 | −25.837 | −3.132 | −17.908 | 1.00 | 1.00 | H |
| ATOM | 3757 | HG2 | LYS | A | 1212 | −26.164 | −2.389 | −19.491 | 1.00 | 1.00 | H |
| ATOM | 3758 | HD1 | LYS | A | 1212 | −25.572 | −0.160 | −18.607 | 1.00 | 1.00 | H |
| ATOM | 3759 | HD2 | LYS | A | 1212 | −25.082 | −0.865 | −17.024 | 1.00 | 1.00 | H |
| ATOM | 3760 | HE1 | LYS | A | 1212 | −28.032 | −0.812 | −18.143 | 1.00 | 1.00 | H |
| ATOM | 3761 | HE2 | LYS | A | 1212 | −27.372 | −1.571 | −16.654 | 1.00 | 1.00 | H |
| ATOM | 3762 | HZ1 | LYS | A | 1212 | −27.653 | 1.379 | −17.161 | 1.00 | 1.00 | H |
| ATOM | 3763 | HZ2 | LYS | A | 1212 | −28.325 | 0.486 | −15.918 | 1.00 | 1.00 | H |
| ATOM | 3764 | HZ3 | LYS | A | 1212 | −26.701 | 0.653 | −15.839 | 1.00 | 1.00 | H |
| ATOM | 3765 | HN | LYS | A | 1212 | −21.738 | −3.170 | −19.235 | 1.00 | 1.00 | H |
| ATOM | 3766 | N | SER | A | 1213 | −25.760 | −4.646 | −20.542 | 1.00 | 1.00 | N |
| ATOM | 3767 | CA | SER | A | 1213 | −26.758 | −4.542 | −21.599 | 1.00 | 1.00 | C |
| ATOM | 3768 | C | SER | A | 1213 | −28.117 | −5.132 | −21.207 | 1.00 | 1.00 | C |
| ATOM | 3769 | O | SER | A | 1213 | −29.132 | −4.471 | −21.330 | 1.00 | 1.00 | O |
| ATOM | 3770 | CB | SER | A | 1213 | −26.285 | −5.090 | −22.979 | 1.00 | 1.00 | C |
| ATOM | 3771 | OG | SER | A | 1213 | −25.685 | −6.412 | −22.983 | 1.00 | 1.00 | O |
| ATOM | 3772 | HA | SER | A | 1213 | −26.992 | −3.457 | −21.743 | 1.00 | 1.00 | H |
| ATOM | 3773 | HB1 | SER | A | 1213 | −25.638 | −4.414 | −23.503 | 1.00 | 1.00 | H |
| ATOM | 3774 | HB2 | SER | A | 1213 | −27.190 | −5.213 | −23.614 | 1.00 | 1.00 | H |
| ATOM | 3775 | HG | SER | A | 1213 | −26.282 | −7.094 | −22.733 | 1.00 | 1.00 | H |
| ATOM | 3776 | HN | SER | A | 1213 | −26.039 | −4.762 | −19.598 | 1.00 | 1.00 | H |
| ATOM | 3777 | N | VAL | A | 1214 | −28.138 | −6.422 | −20.693 | 1.00 | 1.00 | N |
| ATOM | 3778 | CA | VAL | A | 1214 | −29.348 | −7.114 | −20.236 | 1.00 | 1.00 | C |
| ATOM | 3779 | C | VAL | A | 1214 | −29.099 | −7.666 | −18.837 | 1.00 | 1.00 | C |
| ATOM | 3780 | O | VAL | A | 1214 | −29.582 | −8.767 | −18.502 | 1.00 | 1.00 | O |
| ATOM | 3781 | CB | VAL | A | 1214 | −29.977 | −8.078 | −21.286 | 1.00 | 1.00 | C |
| ATOM | 3782 | CG1 | VAL | A | 1214 | −30.404 | −7.295 | −22.561 | 1.00 | 1.00 | C |
| ATOM | 3783 | CG2 | VAL | A | 1214 | −29.089 | −9.323 | −21.686 | 1.00 | 1.00 | C |
| ATOM | 3784 | HA | VAL | A | 1214 | −30.029 | −6.265 | −20.078 | 1.00 | 1.00 | H |
| ATOM | 3785 | HB | VAL | A | 1214 | −30.958 | −8.361 | −20.870 | 1.00 | 1.00 | H |
| ATOM | 3786 | HG11 | VAL | A | 1214 | −31.015 | −6.361 | −22.344 | 1.00 | 1.00 | H |
| ATOM | 3787 | HG12 | VAL | A | 1214 | −30.968 | −7.871 | −23.263 | 1.00 | 1.00 | H |
| ATOM | 3788 | HG13 | VAL | A | 1214 | −29.534 | −7.056 | −23.133 | 1.00 | 1.00 | H |
| ATOM | 3789 | HG21 | VAL | A | 1214 | −29.061 | −9.958 | −20.740 | 1.00 | 1.00 | H |
| ATOM | 3790 | HG22 | VAL | A | 1214 | −29.650 | −9.892 | −22.471 | 1.00 | 1.00 | H |
| ATOM | 3791 | HG23 | VAL | A | 1214 | −28.086 | −9.095 | −22.002 | 1.00 | 1.00 | H |
| ATOM | 3792 | HN | VAL | A | 1214 | −27.302 | −6.978 | −20.631 | 1.00 | 1.00 | H |
| ATOM | 3793 | N | GLN | A | 1215 | −28.334 | −6.932 | −18.006 | 1.00 | 1.00 | N |
| ATOM | 3794 | CA | GLN | A | 1215 | −28.095 | −7.350 | −16.605 | 1.00 | 1.00 | C |
| ATOM | 3795 | C | GLN | A | 1215 | −27.475 | −8.673 | −16.479 | 1.00 | 1.00 | C |
| ATOM | 3796 | O | GLN | A | 1215 | −27.659 | −9.484 | −15.553 | 1.00 | 1.00 | O |
| ATOM | 3797 | CB | GLN | A | 1215 | −29.330 | −7.103 | −15.751 | 1.00 | 1.00 | C |
| ATOM | 3798 | CG | GLN | A | 1215 | −30.040 | −5.767 | −16.129 | 1.00 | 1.00 | C |
| ATOM | 3799 | CD | GLN | A | 1215 | −29.052 | −4.597 | −15.892 | 1.00 | 1.00 | C |
| ATOM | 3800 | OE1 | GLN | A | 1215 | −28.748 | −3.951 | −16.885 | 1.00 | 1.00 | O |
| ATOM | 3801 | NE2 | GLN | A | 1215 | −28.533 | −4.325 | −14.682 | 1.00 | 1.00 | N |
| ATOM | 3802 | HA | GLN | A | 1215 | −27.396 | −6.606 | −16.194 | 1.00 | 1.00 | H |
| ATOM | 3803 | HB1 | GLN | A | 1215 | −30.009 | −7.942 | −15.880 | 1.00 | 1.00 | H |
| ATOM | 3804 | HB2 | GLN | A | 1215 | −28.981 | −7.198 | −14.723 | 1.00 | 1.00 | H |
| ATOM | 3805 | HG1 | GLN | A | 1215 | −30.356 | −5.876 | −17.149 | 1.00 | 1.00 | H |
| ATOM | 3806 | HG2 | GLN | A | 1215 | −30.931 | −5.621 | −15.551 | 1.00 | 1.00 | H |
| ATOM | 3807 | HE22 | GLN | A | 1215 | −27.880 | −3.532 | −14.502 | 1.00 | 1.00 | H |
| ATOM | 3808 | HE21 | GLN | A | 1215 | −28.685 | −4.887 | −13.896 | 1.00 | 1.00 | H |
| ATOM | 3809 | HN | GLN | A | 1215 | −28.033 | −6.014 | −18.250 | 1.00 | 1.00 | H |
| ATOM | 3810 | N | HIS | A | 1216 | −26.588 | −8.995 | −17.481 | 1.00 | 1.00 | N |
| ATOM | 3811 | CA | HIS | A | 1216 | −25.737 | −10.201 | −17.388 | 1.00 | 1.00 | C |
| ATOM | 3812 | C | HIS | A | 1216 | −24.581 | −9.832 | −16.510 | 1.00 | 1.00 | C |
| ATOM | 3813 | O | HIS | A | 1216 | −23.486 | −9.902 | −16.989 | 1.00 | 1.00 | O |
| ATOM | 3814 | CB | HIS | A | 1216 | −25.329 | −10.656 | −18.763 | 1.00 | 1.00 | C |
| ATOM | 3815 | CG | HIS | A | 1216 | −24.448 | −9.722 | −19.575 | 1.00 | 1.00 | C |
| ATOM | 3816 | ND1 | HIS | A | 1216 | −23.173 | −9.551 | −19.425 | 1.00 | 1.00 | N |
| ATOM | 3817 | CD2 | HIS | A | 1216 | −24.818 | −9.026 | −20.647 | 1.00 | 1.00 | C |
| ATOM | 3818 | CE1 | HIS | A | 1216 | −22.687 | −8.768 | −20.366 | 1.00 | 1.00 | C |
| ATOM | 3819 | NE2 | HIS | A | 1216 | −23.630 | −8.405 | −21.093 | 1.00 | 1.00 | N |
| ATOM | 3820 | HA | HIS | A | 1216 | −26.290 | −10.946 | −16.881 | 1.00 | 1.00 | H |
| ATOM | 3821 | HB1 | HIS | A | 1216 | −24.812 | −11.587 | −18.725 | 1.00 | 1.00 | H |
| ATOM | 3822 | HB2 | HIS | A | 1216 | −26.230 | −10.778 | −19.373 | 1.00 | 1.00 | H |
| ATOM | 3823 | HD2 | HIS | A | 1216 | −25.848 | −9.063 | −21.040 | 1.00 | 1.00 | H |
| ATOM | 3824 | HE1 | HIS | A | 1216 | −21.626 | −8.484 | −20.515 | 1.00 | 1.00 | H |
| ATOM | 3825 | HD1 | HIS | A | 1216 | −22.592 | −10.002 | −18.689 | 1.00 | 1.00 | H |
| ATOM | 3826 | HN | HIS | A | 1216 | −26.475 | −8.428 | −18.268 | 1.00 | 1.00 | H |
| ATOM | 3827 | N | LEU | A | 1217 | −24.787 | −9.449 | −15.198 | 1.00 | 1.00 | N |
| ATOM | 3828 | CA | LEU | A | 1217 | −23.637 | −9.198 | −14.266 | 1.00 | 1.00 | C |
| ATOM | 3829 | C | LEU | A | 1217 | −23.354 | −10.363 | −13.307 | 1.00 | 1.00 | C |
| ATOM | 3830 | O | LEU | A | 1217 | −22.953 | −10.115 | −12.162 | 1.00 | 1.00 | O |
| ATOM | 3831 | CB | LEU | A | 1217 | −23.924 | −7.958 | −13.403 | 1.00 | 1.00 | C |
| ATOM | 3832 | CG | LEU | A | 1217 | −24.353 | −6.615 | −14.107 | 1.00 | 1.00 | C |
| ATOM | 3833 | CD1 | LEU | A | 1217 | −24.753 | −5.609 | −13.046 | 1.00 | 1.00 | C |
| ATOM | 3834 | CD2 | LEU | A | 1217 | −23.200 | −5.970 | −14.947 | 1.00 | 1.00 | C |
| ATOM | 3835 | HA | LEU | A | 1217 | −22.666 | −8.943 | −14.723 | 1.00 | 1.00 | H |
| ATOM | 3836 | HB1 | LEU | A | 1217 | −24.770 | −8.242 | −12.782 | 1.00 | 1.00 | H |
| ATOM | 3837 | HB2 | LEU | A | 1217 | −23.114 | −7.761 | −12.720 | 1.00 | 1.00 | H |
| ATOM | 3838 | HG | LEU | A | 1217 | −25.213 | −6.801 | −14.735 | 1.00 | 1.00 | H |
| ATOM | 3839 | HD21 | LEU | A | 1217 | −23.366 | −5.005 | −15.369 | 1.00 | 1.00 | H |
| ATOM | 3840 | HD22 | LEU | A | 1217 | −22.318 | −5.934 | −14.303 | 1.00 | 1.00 | H |
| ATOM | 3841 | HD23 | LEU | A | 1217 | −22.848 | −6.625 | −15.769 | 1.00 | 1.00 | H |
| ATOM | 3842 | HD11 | LEU | A | 1217 | −25.544 | −6.060 | −12.383 | 1.00 | 1.00 | H |
| ATOM | 3843 | HD12 | LEU | A | 1217 | −25.233 | −4.807 | −13.542 | 1.00 | 1.00 | H |
| ATOM | 3844 | HD13 | LEU | A | 1217 | −23.872 | −5.241 | −12.481 | 1.00 | 1.00 | H |
| ATOM | 3845 | HN | LEU | A | 1217 | −25.693 | −9.497 | −14.786 | 1.00 | 1.00 | H |
| ATOM | 3846 | N | GLU | A | 1218 | −23.489 | −11.657 | −13.712 | 1.00 | 1.00 | N |
| ATOM | 3847 | CA | GLU | A | 1218 | −23.146 | −12.732 | −12.813 | 1.00 | 1.00 | C |
| ATOM | 3848 | C | GLU | A | 1218 | −22.028 | −13.555 | −13.354 | 1.00 | 1.00 | C |
| ATOM | 3849 | O | GLU | A | 1218 | −20.952 | −13.535 | −12.780 | 1.00 | 1.00 | O |
| ATOM | 3850 | CB | GLU | A | 1218 | −24.499 | −13.489 | −12.546 | 1.00 | 1.00 | C |
| ATOM | 3851 | CG | GLU | A | 1218 | −25.753 | −12.609 | −12.336 | 1.00 | 1.00 | C |
| ATOM | 3852 | CD | GLU | A | 1218 | −25.551 | −11.591 | −11.209 | 1.00 | 1.00 | C |
| ATOM | 3853 | OE1 | GLU | A | 1218 | −24.994 | −11.946 | −10.125 | 1.00 | 1.00 | O |
| ATOM | 3854 | OE2 | GLU | A | 1218 | −25.906 | −10.409 | −11.334 | 1.00 | 1.00 | O |
| ATOM | 3855 | HA | GLU | A | 1218 | −22.826 | −12.428 | −11.809 | 1.00 | 1.00 | H |
| ATOM | 3856 | HB1 | GLU | A | 1218 | −24.545 | −14.139 | −11.599 | 1.00 | 1.00 | H |
| ATOM | 3857 | HB2 | GLU | A | 1218 | −24.725 | −14.057 | −13.463 | 1.00 | 1.00 | H |
| ATOM | 3858 | HG1 | GLU | A | 1218 | −25.993 | −12.040 | −13.224 | 1.00 | 1.00 | H |
| ATOM | 3859 | HG2 | GLU | A | 1218 | −26.581 | −13.255 | −12.049 | 1.00 | 1.00 | H |
| ATOM | 3860 | HN | GLU | A | 1218 | −23.733 | −11.868 | −14.684 | 1.00 | 1.00 | H |
| ATOM | 3861 | N | SER | A | 1219 | −22.100 | −14.320 | −14.483 | 1.00 | 1.00 | N |
| ATOM | 3862 | CA | SER | A | 1219 | −20.900 | −14.972 | −14.987 | 1.00 | 1.00 | C |
| ATOM | 3863 | C | SER | A | 1219 | −19.811 | −14.081 | −15.539 | 1.00 | 1.00 | C |
| ATOM | 3864 | O | SER | A | 1219 | −18.609 | −14.187 | −15.170 | 1.00 | 1.00 | O |
| ATOM | 3865 | CB | SER | A | 1219 | −21.329 | −16.010 | −16.035 | 1.00 | 1.00 | C |
| ATOM | 3866 | OG | SER | A | 1219 | −22.463 | −16.737 | −15.444 | 1.00 | 1.00 | O |
| ATOM | 3867 | HA | SER | A | 1219 | −20.481 | −15.549 | −14.119 | 1.00 | 1.00 | H |
| ATOM | 3868 | HB1 | SER | A | 1219 | −21.622 | −15.509 | −16.947 | 1.00 | 1.00 | H |
| ATOM | 3869 | HB2 | SER | A | 1219 | −20.489 | −16.677 | −16.342 | 1.00 | 1.00 | H |
| ATOM | 3870 | HG | SER | A | 1219 | −22.276 | −17.238 | −14.654 | 1.00 | 1.00 | H |
| ATOM | 3871 | HN | SER | A | 1219 | −22.982 | −14.448 | −14.969 | 1.00 | 1.00 | H |
| ATOM | 3872 | N | LEU | A | 1220 | −20.074 | −13.127 | −16.512 | 1.00 | 1.00 | N |
| ATOM | 3873 | CA | LEU | A | 1220 | −18.939 | −12.311 | −16.939 | 1.00 | 1.00 | C |
| ATOM | 3874 | C | LEU | A | 1220 | −18.426 | −11.491 | −15.734 | 1.00 | 1.00 | C |
| ATOM | 3875 | O | LEU | A | 1220 | −17.266 | −11.198 | −15.723 | 1.00 | 1.00 | O |
| ATOM | 3876 | CB | LEU | A | 1220 | −19.398 | −11.398 | −18.121 | 1.00 | 1.00 | C |
| ATOM | 3877 | CG | LEU | A | 1220 | −18.351 | −10.300 | −18.524 | 1.00 | 1.00 | C |
| ATOM | 3878 | CD1 | LEU | A | 1220 | −18.444 | −10.003 | −20.054 | 1.00 | 1.00 | C |
| ATOM | 3879 | CD2 | LEU | A | 1220 | −18.606 | −8.970 | −17.785 | 1.00 | 1.00 | C |
| ATOM | 3880 | HA | LEU | A | 1220 | −18.203 | −13.035 | −17.343 | 1.00 | 1.00 | H |
| ATOM | 3881 | HB1 | LEU | A | 1220 | −19.700 | −12.053 | −19.000 | 1.00 | 1.00 | H |
| ATOM | 3882 | HB2 | LEU | A | 1220 | −20.281 | −10.948 | −17.770 | 1.00 | 1.00 | H |
| ATOM | 3883 | HG | LEU | A | 1220 | −17.302 | −10.647 | −18.423 | 1.00 | 1.00 | H |
| ATOM | 3884 | HD21 | LEU | A | 1220 | −18.526 | −9.100 | −16.688 | 1.00 | 1.00 | H |
| ATOM | 3885 | HD22 | LEU | A | 1220 | −17.894 | −8.160 | −18.123 | 1.00 | 1.00 | H |
| ATOM | 3886 | HD23 | LEU | A | 1220 | −19.604 | −8.663 | −18.073 | 1.00 | 1.00 | H |
| ATOM | 3887 | HD11 | LEU | A | 1220 | −17.945 | −9.047 | −20.219 | 1.00 | 1.00 | H |
| ATOM | 3888 | HD12 | LEU | A | 1220 | −19.479 | −9.952 | −20.306 | 1.00 | 1.00 | H |
| ATOM | 3889 | HD13 | LEU | A | 1220 | −17.924 | −10.744 | −20.672 | 1.00 | 1.00 | H |
| ATOM | 3890 | HN | LEU | A | 1220 | −21.058 | −12.965 | −16.744 | 1.00 | 1.00 | H |
| ATOM | 3891 | N | PHE | A | 1221 | −19.270 | −11.235 | −14.657 | 1.00 | 1.00 | N |
| ATOM | 3892 | CA | PHE | A | 1221 | −18.778 | −10.634 | −13.379 | 1.00 | 1.00 | C |
| ATOM | 3893 | C | PHE | A | 1221 | −17.855 | −11.596 | −12.738 | 1.00 | 1.00 | C |
| ATOM | 3894 | O | PHE | A | 1221 | −16.751 | −11.192 | −12.452 | 1.00 | 1.00 | O |
| ATOM | 3895 | CB | PHE | A | 1221 | −19.920 | −10.146 | −12.476 | 1.00 | 1.00 | C |
| ATOM | 3896 | CG | PHE | A | 1221 | −19.390 | −9.634 | −11.133 | 1.00 | 1.00 | C |
| ATOM | 3897 | CD1 | PHE | A | 1221 | −19.222 | −8.266 | −11.036 | 1.00 | 1.00 | C |
| ATOM | 3898 | CD2 | PHE | A | 1221 | −19.073 | −10.500 | −10.085 | 1.00 | 1.00 | C |
| ATOM | 3899 | CE1 | PHE | A | 1221 | −18.781 | −7.722 | −9.842 | 1.00 | 1.00 | C |
| ATOM | 3900 | CE2 | PHE | A | 1221 | −18.608 | −9.951 | −8.874 | 1.00 | 1.00 | C |
| ATOM | 3901 | CZ | PHE | A | 1221 | −18.580 | −8.560 | −8.721 | 1.00 | 1.00 | C |
| ATOM | 3902 | HA | PHE | A | 1221 | −18.194 | −9.713 | −13.649 | 1.00 | 1.00 | H |
| ATOM | 3903 | HB1 | PHE | A | 1221 | −20.483 | −9.361 | −13.033 | 1.00 | 1.00 | H |
| ATOM | 3904 | HB2 | PHE | A | 1221 | −20.676 | −10.986 | −12.402 | 1.00 | 1.00 | H |
| ATOM | 3905 | HD2 | PHE | A | 1221 | −19.248 | −11.561 | −10.206 | 1.00 | 1.00 | H |
| ATOM | 3906 | HE2 | PHE | A | 1221 | −18.348 | −10.618 | −8.056 | 1.00 | 1.00 | H |
| ATOM | 3907 | HZ | PHE | A | 1221 | −18.294 | −8.123 | −7.779 | 1.00 | 1.00 | H |
| ATOM | 3908 | HE1 | PHE | A | 1221 | −18.535 | −6.712 | −9.833 | 1.00 | 1.00 | H |
| ATOM | 3909 | HD1 | PHE | A | 1221 | −19.384 | −7.634 | −11.910 | 1.00 | 1.00 | H |
| ATOM | 3910 | HN | PHE | A | 1221 | −20.214 | −11.510 | −14.690 | 1.00 | 1.00 | H |
| ATOM | 3911 | N | THR | A | 1222 | −18.267 | −12.857 | −12.484 | 1.00 | 1.00 | N |
| ATOM | 3912 | CA | THR | A | 1222 | −17.281 | −13.748 | −11.810 | 1.00 | 1.00 | C |
| ATOM | 3913 | C | THR | A | 1222 | −16.012 | −13.976 | −12.640 | 1.00 | 1.00 | C |
| ATOM | 3914 | O | THR | A | 1222 | −14.905 | −13.925 | −12.125 | 1.00 | 1.00 | O |
| ATOM | 3915 | CB | THR | A | 1222 | −17.847 | −15.173 | −11.466 | 1.00 | 1.00 | C |
| ATOM | 3916 | OG1 | THR | A | 1222 | −18.255 | −15.763 | −12.727 | 1.00 | 1.00 | O |
| ATOM | 3917 | CG2 | THR | A | 1222 | −18.974 | −15.144 | −10.383 | 1.00 | 1.00 | C |
| ATOM | 3918 | HA | THR | A | 1222 | −16.955 | −13.243 | −10.872 | 1.00 | 1.00 | H |
| ATOM | 3919 | HB | THR | A | 1222 | −16.969 | −15.740 | −11.054 | 1.00 | 1.00 | H |
| ATOM | 3920 | HG1 | THR | A | 1222 | −18.704 | −16.578 | −12.544 | 1.00 | 1.00 | H |
| ATOM | 3921 | HG23 | THR | A | 1222 | −19.757 | −14.478 | −10.788 | 1.00 | 1.00 | H |
| ATOM | 3922 | HG21 | THR | A | 1222 | −19.309 | −16.160 | −10.175 | 1.00 | 1.00 | H |
| ATOM | 3923 | HG22 | THR | A | 1222 | −18.629 | −14.760 | −9.423 | 1.00 | 1.00 | H |
| ATOM | 3924 | HN | THR | A | 1222 | −19.183 | −13.138 | −12.734 | 1.00 | 1.00 | H |
| ATOM | 3925 | N | ALA | A | 1223 | −16.122 | −14.273 | −13.960 | 1.00 | 1.00 | N |
| ATOM | 3926 | CA | ALA | A | 1223 | −14.952 | −14.330 | −14.822 | 1.00 | 1.00 | C |
| ATOM | 3927 | C | ALA | A | 1223 | −14.101 | −13.046 | −14.815 | 1.00 | 1.00 | C |
| ATOM | 3928 | O | ALA | A | 1223 | −12.916 | −13.181 | −14.596 | 1.00 | 1.00 | O |
| ATOM | 3929 | CB | ALA | A | 1223 | −15.294 | −14.755 | −16.299 | 1.00 | 1.00 | C |
| ATOM | 3930 | HA | ALA | A | 1223 | −14.314 | −15.152 | −14.419 | 1.00 | 1.00 | H |
| ATOM | 3931 | HB1 | ALA | A | 1223 | −14.456 | −14.843 | −16.962 | 1.00 | 1.00 | H |
| ATOM | 3932 | HB2 | ALA | A | 1223 | −15.769 | −15.760 | −16.224 | 1.00 | 1.00 | H |
| ATOM | 3933 | HB3 | ALA | A | 1223 | −16.017 | −14.046 | −16.663 | 1.00 | 1.00 | H |
| ATOM | 3934 | HN | ALA | A | 1223 | −17.062 | −14.375 | −14.326 | 1.00 | 1.00 | H |
| ATOM | 3935 | N | VAL | A | 1224 | −14.611 | −11.803 | −14.951 | 1.00 | 1.00 | N |
| ATOM | 3936 | CA | VAL | A | 1224 | −13.850 | −10.591 | −14.707 | 1.00 | 1.00 | C |
| ATOM | 3937 | C | VAL | A | 1224 | −13.231 | −10.392 | −13.336 | 1.00 | 1.00 | C |
| ATOM | 3938 | O | VAL | A | 1224 | −12.035 | −10.187 | −13.246 | 1.00 | 1.00 | O |
| ATOM | 3939 | CB | VAL | A | 1224 | −14.717 | −9.292 | −14.844 | 1.00 | 1.00 | C |
| ATOM | 3940 | CG1 | VAL | A | 1224 | −14.085 | −7.975 | −14.193 | 1.00 | 1.00 | C |
| ATOM | 3941 | CG2 | VAL | A | 1224 | −15.010 | −9.052 | −16.361 | 1.00 | 1.00 | C |
| ATOM | 3942 | HA | VAL | A | 1224 | −13.043 | −10.492 | −15.483 | 1.00 | 1.00 | H |
| ATOM | 3943 | HB | VAL | A | 1224 | −15.631 | −9.413 | −14.246 | 1.00 | 1.00 | H |
| ATOM | 3944 | HG11 | VAL | A | 1224 | −13.020 | −7.884 | −14.572 | 1.00 | 1.00 | H |
| ATOM | 3945 | HG12 | VAL | A | 1224 | −14.598 | −7.047 | −14.490 | 1.00 | 1.00 | H |
| ATOM | 3946 | HG13 | VAL | A | 1224 | −14.088 | −8.057 | −13.121 | 1.00 | 1.00 | H |
| ATOM | 3947 | HG21 | VAL | A | 1224 | −15.486 | −9.915 | −16.872 | 1.00 | 1.00 | H |
| ATOM | 3948 | HG22 | VAL | A | 1224 | −15.681 | −8.183 | −16.541 | 1.00 | 1.00 | H |
| ATOM | 3949 | HG23 | VAL | A | 1224 | −14.088 | −8.801 | −16.900 | 1.00 | 1.00 | H |
| ATOM | 3950 | HN | VAL | A | 1224 | −15.609 | −11.708 | −15.051 | 1.00 | 1.00 | H |
| ATOM | 3951 | N | THR | A | 1225 | −14.023 | −10.547 | −12.271 | 1.00 | 1.00 | N |
| ATOM | 3952 | CA | THR | A | 1225 | −13.399 | −10.380 | −10.975 | 1.00 | 1.00 | C |
| ATOM | 3953 | C | THR | A | 1225 | −12.441 | −11.528 | −10.734 | 1.00 | 1.00 | C |
| ATOM | 3954 | O | THR | A | 1225 | −11.496 | −11.381 | −10.016 | 1.00 | 1.00 | O |
| ATOM | 3955 | CB | THR | A | 1225 | −14.356 | −10.275 | −9.760 | 1.00 | 1.00 | C |
| ATOM | 3956 | OG1 | THR | A | 1225 | −15.044 | −11.501 | −9.799 | 1.00 | 1.00 | O |
| ATOM | 3957 | CG2 | THR | A | 1225 | −15.310 | −9.102 | −9.837 | 1.00 | 1.00 | C |
| ATOM | 3958 | HA | THR | A | 1225 | −12.768 | −9.462 | −10.914 | 1.00 | 1.00 | H |
| ATOM | 3959 | HB | THR | A | 1225 | −13.754 | −10.293 | −8.834 | 1.00 | 1.00 | H |
| ATOM | 3960 | HG1 | THR | A | 1225 | −15.640 | −11.737 | −9.093 | 1.00 | 1.00 | H |
| ATOM | 3961 | HG23 | THR | A | 1225 | −15.982 | −8.949 | −9.017 | 1.00 | 1.00 | H |
| ATOM | 3962 | HG21 | THR | A | 1225 | −15.953 | −9.185 | −10.746 | 1.00 | 1.00 | H |
| ATOM | 3963 | HG22 | THR | A | 1225 | −14.668 | −8.182 | −9.900 | 1.00 | 1.00 | H |
| ATOM | 3964 | HN | THR | A | 1225 | −15.038 | −10.731 | −12.344 | 1.00 | 1.00 | H |
| ATOM | 3965 | N | ASN | A | 1226 | −12.672 | −12.758 | −11.202 | 1.00 | 1.00 | N |
| ATOM | 3966 | CA | ASN | A | 1226 | −11.762 | −13.886 | −10.988 | 1.00 | 1.00 | C |
| ATOM | 3967 | C | ASN | A | 1226 | −10.427 | −13.661 | −11.739 | 1.00 | 1.00 | C |
| ATOM | 3968 | O | ASN | A | 1226 | −9.354 | −13.909 | −11.184 | 1.00 | 1.00 | O |
| ATOM | 3969 | CB | ASN | A | 1226 | −12.259 | −15.227 | −11.522 | 1.00 | 1.00 | C |
| ATOM | 3970 | CG | ASN | A | 1226 | −11.211 | −16.351 | −11.297 | 1.00 | 1.00 | C |
| ATOM | 3971 | OD1 | ASN | A | 1226 | −11.372 | −17.070 | −10.316 | 1.00 | 1.00 | O |
| ATOM | 3972 | ND2 | ASN | A | 1226 | −10.156 | −16.522 | −12.127 | 1.00 | 1.00 | N |
| ATOM | 3973 | HA | ASN | A | 1226 | −11.601 | −13.928 | −9.870 | 1.00 | 1.00 | H |
| ATOM | 3974 | HB1 | ASN | A | 1226 | −13.151 | −15.559 | −10.906 | 1.00 | 1.00 | H |
| ATOM | 3975 | HB2 | ASN | A | 1226 | −12.605 | −15.184 | −12.598 | 1.00 | 1.00 | H |
| ATOM | 3976 | HD22 | ASN | A | 1226 | −9.498 | −17.241 | −11.874 | 1.00 | 1.00 | H |
| ATOM | 3977 | HD21 | ASN | A | 1226 | −10.003 | −16.038 | −12.998 | 1.00 | 1.00 | H |
| ATOM | 3978 | HN | ASN | A | 1226 | −13.480 | −12.910 | −11.739 | 1.00 | 1.00 | H |
| ATOM | 3979 | N | PHE | A | 1227 | −10.547 | −13.219 | −13.008 | 1.00 | 1.00 | N |
| ATOM | 3980 | CA | PHE | A | 1227 | −9.334 | −12.847 | −13.684 | 1.00 | 1.00 | C |
| ATOM | 3981 | C | PHE | A | 1227 | −8.675 | −11.733 | −12.940 | 1.00 | 1.00 | C |
| ATOM | 3982 | O | PHE | A | 1227 | −7.463 | −11.769 | −12.795 | 1.00 | 1.00 | O |
| ATOM | 3983 | CB | PHE | A | 1227 | −9.610 | −12.371 | −15.127 | 1.00 | 1.00 | C |
| ATOM | 3984 | CG | PHE | A | 1227 | −10.001 | −13.479 | −16.131 | 1.00 | 1.00 | C |
| ATOM | 3985 | CD1 | PHE | A | 1227 | −11.167 | −13.420 | −16.917 | 1.00 | 1.00 | C |
| ATOM | 3986 | CD2 | PHE | A | 1227 | −9.074 | −14.537 | −16.313 | 1.00 | 1.00 | C |
| ATOM | 3987 | CE1 | PHE | A | 1227 | −11.490 | −14.422 | −17.810 | 1.00 | 1.00 | C |
| ATOM | 3988 | CE2 | PHE | A | 1227 | −9.387 | −15.568 | −17.182 | 1.00 | 1.00 | C |
| ATOM | 3989 | CZ | PHE | A | 1227 | −10.603 | −15.486 | −17.890 | 1.00 | 1.00 | C |
| ATOM | 3990 | HA | PHE | A | 1227 | −8.583 | −13.688 | −13.678 | 1.00 | 1.00 | H |
| ATOM | 3991 | HB1 | PHE | A | 1227 | −10.341 | −11.531 | −15.156 | 1.00 | 1.00 | H |
| ATOM | 3992 | HB2 | PHE | A | 1227 | −8.653 | −11.958 | −15.518 | 1.00 | 1.00 | H |
| ATOM | 3993 | HD2 | PHE | A | 1227 | −8.177 | −14.646 | −15.781 | 1.00 | 1.00 | H |
| ATOM | 3994 | HE2 | PHE | A | 1227 | −8.685 | −16.422 | −17.343 | 1.00 | 1.00 | H |
| ATOM | 3995 | HZ | PHE | A | 1227 | −10.864 | −16.305 | −18.531 | 1.00 | 1.00 | H |
| ATOM | 3996 | HE1 | PHE | A | 1227 | −12.381 | −14.359 | −18.412 | 1.00 | 1.00 | H |
| ATOM | 3997 | HD1 | PHE | A | 1227 | −11.880 | −12.572 | −16.926 | 1.00 | 1.00 | H |
| ATOM | 3998 | HN | PHE | A | 1227 | −11.402 | −13.068 | −13.460 | 1.00 | 1.00 | H |
| ATOM | 3999 | N | LEU | A | 1228 | −9.397 | −10.699 | −12.421 | 1.00 | 1.00 | N |
| ATOM | 4000 | CA | LEU | A | 1228 | −8.685 | −9.577 | −11.793 | 1.00 | 1.00 | C |
| ATOM | 4001 | C | LEU | A | 1228 | −8.133 | −10.040 | −10.463 | 1.00 | 1.00 | C |
| ATOM | 4002 | O | LEU | A | 1228 | −7.012 | −9.649 | −10.076 | 1.00 | 1.00 | O |
| ATOM | 4003 | CB | LEU | A | 1228 | −9.637 | −8.376 | −11.608 | 1.00 | 1.00 | C |
| ATOM | 4004 | CG | LEU | A | 1228 | −9.052 | −6.975 | −11.102 | 1.00 | 1.00 | C |
| ATOM | 4005 | CD1 | LEU | A | 1228 | −7.923 | −6.403 | −11.975 | 1.00 | 1.00 | C |
| ATOM | 4006 | CD2 | LEU | A | 1228 | −10.163 | −5.891 | −10.948 | 1.00 | 1.00 | C |
| ATOM | 4007 | HA | LEU | A | 1228 | −7.797 | −9.322 | −12.363 | 1.00 | 1.00 | H |
| ATOM | 4008 | HB1 | LEU | A | 1228 | −10.116 | −8.163 | −12.565 | 1.00 | 1.00 | H |
| ATOM | 4009 | HB2 | LEU | A | 1228 | −10.411 | −8.768 | −10.965 | 1.00 | 1.00 | H |
| ATOM | 4010 | HG | LEU | A | 1228 | −8.561 | −7.152 | −10.095 | 1.00 | 1.00 | H |
| ATOM | 4011 | HD21 | LEU | A | 1228 | −9.785 | −4.923 | −10.615 | 1.00 | 1.00 | H |
| ATOM | 4012 | HD22 | LEU | A | 1228 | −10.628 | −5.798 | −11.945 | 1.00 | 1.00 | H |
| ATOM | 4013 | HD23 | LEU | A | 1228 | −10.868 | −6.311 | −10.185 | 1.00 | 1.00 | H |
| ATOM | 4014 | HD11 | LEU | A | 1228 | −8.154 | −6.274 | −13.077 | 1.00 | 1.00 | H |
| ATOM | 4015 | HD12 | LEU | A | 1228 | −7.575 | −5.403 | −11.608 | 1.00 | 1.00 | H |
| ATOM | 4016 | HD13 | LEU | A | 1228 | −7.060 | −7.052 | −11.969 | 1.00 | 1.00 | H |
| ATOM | 4017 | HN | LEU | A | 1228 | −10.389 | −10.762 | −12.531 | 1.00 | 1.00 | H |
| ATOM | 4018 | N | LEU | A | 1229 | −8.914 | −10.872 | −9.740 | 1.00 | 1.00 | N |
| ATOM | 4019 | CA | LEU | A | 1229 | −8.524 | −11.224 | −8.359 | 1.00 | 1.00 | C |
| ATOM | 4020 | C | LEU | A | 1229 | −7.736 | −12.516 | −8.252 | 1.00 | 1.00 | C |
| ATOM | 4021 | O | LEU | A | 1229 | −6.652 | −12.535 | −7.666 | 1.00 | 1.00 | O |
| ATOM | 4022 | CB | LEU | A | 1229 | −9.837 | −11.279 | −7.506 | 1.00 | 1.00 | C |
| ATOM | 4023 | CG | LEU | A | 1229 | −9.625 | −11.527 | −5.966 | 1.00 | 1.00 | C |
| ATOM | 4024 | CD1 | LEU | A | 1229 | −10.893 | −11.060 | −5.203 | 1.00 | 1.00 | C |
| ATOM | 4025 | CD2 | LEU | A | 1229 | −9.396 | −13.052 | −5.649 | 1.00 | 1.00 | C |
| ATOM | 4026 | HA | LEU | A | 1229 | −7.933 | −10.419 | −7.954 | 1.00 | 1.00 | H |
| ATOM | 4027 | HB1 | LEU | A | 1229 | −10.271 | −10.264 | −7.681 | 1.00 | 1.00 | H |
| ATOM | 4028 | HB2 | LEU | A | 1229 | −10.547 | −11.970 | −7.907 | 1.00 | 1.00 | H |
| ATOM | 4029 | HG | LEU | A | 1229 | −8.764 | −10.923 | −5.633 | 1.00 | 1.00 | H |
| ATOM | 4030 | HD21 | LEU | A | 1229 | −8.531 | −13.525 | −6.111 | 1.00 | 1.00 | H |
| ATOM | 4031 | HD22 | LEU | A | 1229 | −9.379 | −13.162 | −4.567 | 1.00 | 1.00 | H |
| ATOM | 4032 | HD23 | LEU | A | 1229 | −10.286 | −13.595 | −6.018 | 1.00 | 1.00 | H |
| ATOM | 4033 | HD11 | LEU | A | 1229 | −10.895 | −9.991 | −5.090 | 1.00 | 1.00 | H |
| ATOM | 4034 | HD12 | LEU | A | 1229 | −11.857 | −11.401 | −5.626 | 1.00 | 1.00 | H |
| ATOM | 4035 | HD13 | LEU | A | 1229 | −10.880 | −11.452 | −4.169 | 1.00 | 1.00 | H |
| ATOM | 4036 | HN | LEU | A | 1229 | −9.797 | −11.195 | −10.111 | 1.00 | 1.00 | H |
| ATOM | 4037 | N | SER | A | 1230 | −8.252 | −13.577 | −8.849 | 1.00 | 1.00 | N |
| ATOM | 4038 | CA | SER | A | 1230 | −7.611 | −14.885 | −8.674 | 1.00 | 1.00 | C |
| ATOM | 4039 | C | SER | A | 1230 | −6.632 | −15.225 | −9.728 | 1.00 | 1.00 | C |
| ATOM | 4040 | O | SER | A | 1230 | −6.808 | −16.235 | −10.409 | 1.00 | 1.00 | O |
| ATOM | 4041 | CB | SER | A | 1230 | −8.699 | −15.984 | −8.499 | 1.00 | 1.00 | C |
| ATOM | 4042 | OG | SER | A | 1230 | −8.062 | −17.163 | −8.003 | 1.00 | 1.00 | O |
| ATOM | 4043 | HA | SER | A | 1230 | −7.033 | −14.890 | −7.763 | 1.00 | 1.00 | H |
| ATOM | 4044 | HB1 | SER | A | 1230 | −9.437 | −15.563 | −7.782 | 1.00 | 1.00 | H |
| ATOM | 4045 | HB2 | SER | A | 1230 | −9.290 | −16.218 | −9.389 | 1.00 | 1.00 | H |
| ATOM | 4046 | HG | SER | A | 1230 | −7.460 | −17.562 | −8.642 | 1.00 | 1.00 | H |
| ATOM | 4047 | HN | SER | A | 1230 | −9.059 | −13.506 | −9.446 | 1.00 | 1.00 | H |
| ATOM | 4048 | N | LEU | A | 1231 | −5.608 | −14.402 | −10.001 | 1.00 | 1.00 | N |
| ATOM | 4049 | CA | LEU | A | 1231 | −4.710 | −14.705 | −11.134 | 1.00 | 1.00 | C |
| ATOM | 4050 | C | LEU | A | 1231 | −3.267 | −14.380 | −10.847 | 1.00 | 1.00 | C |
| ATOM | 4051 | O | LEU | A | 1231 | −2.483 | −15.318 | −10.804 | 1.00 | 1.00 | O |
| ATOM | 4052 | CB | LEU | A | 1231 | −5.240 | −13.890 | −12.333 | 1.00 | 1.00 | C |
| ATOM | 4053 | CG | LEU | A | 1231 | −4.460 | −13.963 | −13.687 | 1.00 | 1.00 | C |
| ATOM | 4054 | CD1 | LEU | A | 1231 | −4.218 | −15.407 | −14.180 | 1.00 | 1.00 | C |
| ATOM | 4055 | CD2 | LEU | A | 1231 | −5.188 | −13.086 | −14.727 | 1.00 | 1.00 | C |
| ATOM | 4056 | HA | LEU | A | 1231 | −4.754 | −15.767 | −11.522 | 1.00 | 1.00 | H |
| ATOM | 4057 | HB1 | LEU | A | 1231 | −6.276 | −14.171 | −12.572 | 1.00 | 1.00 | H |
| ATOM | 4058 | HB2 | LEU | A | 1231 | −5.225 | −12.849 | −12.073 | 1.00 | 1.00 | H |
| ATOM | 4059 | HG | LEU | A | 1231 | −3.475 | −13.581 | −13.477 | 1.00 | 1.00 | H |
| ATOM | 4060 | HD21 | LEU | A | 1231 | −4.620 | −12.993 | −15.675 | 1.00 | 1.00 | H |
| ATOM | 4061 | HD22 | LEU | A | 1231 | −6.184 | −13.553 | −14.939 | 1.00 | 1.00 | H |
| ATOM | 4062 | HD23 | LEU | A | 1231 | −5.298 | −12.061 | −14.302 | 1.00 | 1.00 | H |
| ATOM | 4063 | HD11 | LEU | A | 1231 | −3.508 | −15.980 | −13.573 | 1.00 | 1.00 | H |
| ATOM | 4064 | HD12 | LEU | A | 1231 | −5.167 | −15.925 | −14.244 | 1.00 | 1.00 | H |
| ATOM | 4065 | HD13 | LEU | A | 1231 | −3.777 | −15.247 | −15.194 | 1.00 | 1.00 | H |
| ATOM | 4066 | HN | LEU | A | 1231 | −5.521 | −13.533 | −9.482 | 1.00 | 1.00 | H |
| ATOM | 4067 | N | GLY | A | 1232 | −2.921 | −13.109 | −10.615 | 1.00 | 1.00 | N |
| ATOM | 4068 | CA | GLY | A | 1232 | −1.574 | −12.805 | −10.153 | 1.00 | 1.00 | C |
| ATOM | 4069 | C | GLY | A | 1232 | −1.550 | −11.704 | −9.095 | 1.00 | 1.00 | C |
| ATOM | 4070 | O | GLY | A | 1232 | −0.517 | −11.044 | −9.036 | 1.00 | 1.00 | O |
| ATOM | 4071 | HA2 | GLY | A | 1232 | −0.952 | −12.494 | −11.047 | 1.00 | 1.00 | H |
| ATOM | 4072 | HA1 | GLY | A | 1232 | −1.076 | −13.718 | −9.728 | 1.00 | 1.00 | H |
| ATOM | 4073 | HN | GLY | A | 1232 | −3.495 | −12.310 | −10.758 | 1.00 | 1.00 | H |
| ATOM | 4074 | N | ILE | A | 1233 | −2.671 | −11.564 | −8.354 | 1.00 | 1.00 | N |
| ATOM | 4075 | CA | ILE | A | 1233 | −2.849 | −10.365 | −7.450 | 1.00 | 1.00 | C |
| ATOM | 4076 | C | ILE | A | 1233 | −3.611 | −10.783 | −6.194 | 1.00 | 1.00 | C |
| ATOM | 4077 | O | ILE | A | 1233 | −3.108 | −10.539 | −5.099 | 1.00 | 1.00 | O |
| ATOM | 4078 | CB | ILE | A | 1233 | −3.501 | −9.172 | −8.180 | 1.00 | 1.00 | C |
| ATOM | 4079 | CG1 | ILE | A | 1233 | −3.056 | −8.935 | −9.642 | 1.00 | 1.00 | C |
| ATOM | 4080 | CG2 | ILE | A | 1233 | −3.397 | −7.803 | −7.428 | 1.00 | 1.00 | C |
| ATOM | 4081 | CD1 | ILE | A | 1233 | −3.777 | −7.847 | −10.453 | 1.00 | 1.00 | C |
| ATOM | 4082 | HA | ILE | A | 1233 | −1.881 | −10.031 | −7.117 | 1.00 | 1.00 | H |
| ATOM | 4083 | HB | ILE | A | 1233 | −4.556 | −9.473 | −8.213 | 1.00 | 1.00 | H |
| ATOM | 4084 | HG11 | ILE | A | 1233 | −3.195 | −9.906 | −10.095 | 1.00 | 1.00 | H |
| ATOM | 4085 | HG12 | ILE | A | 1233 | −1.965 | −8.878 | −9.679 | 1.00 | 1.00 | H |
| ATOM | 4086 | HD11 | ILE | A | 1233 | −4.867 | −7.933 | −10.445 | 1.00 | 1.00 | H |
| ATOM | 4087 | HD12 | ILE | A | 1233 | −3.469 | −6.864 | −10.129 | 1.00 | 1.00 | H |
| ATOM | 4088 | HD13 | ILE | A | 1233 | −3.499 | −7.889 | −11.493 | 1.00 | 1.00 | H |
| ATOM | 4089 | HG21 | ILE | A | 1233 | −2.354 | −7.460 | −7.339 | 1.00 | 1.00 | H |
| ATOM | 4090 | HG22 | ILE | A | 1233 | −4.022 | −7.093 | −7.911 | 1.00 | 1.00 | H |
| ATOM | 4091 | HG23 | ILE | A | 1233 | −3.764 | −7.901 | −6.389 | 1.00 | 1.00 | H |
| ATOM | 4092 | HN | ILE | A | 1233 | −3.411 | −12.245 | −8.460 | 1.00 | 1.00 | H |
| ATOM | 4093 | N | HIE | A | 1234 | −4.822 | −11.374 | −6.277 | 1.00 | 1.00 | N |
| ATOM | 4094 | CA | HIE | A | 1234 | −5.637 | −11.555 | −5.111 | 1.00 | 1.00 | C |
| ATOM | 4095 | C | HIE | A | 1234 | −5.668 | −10.251 | −4.287 | 1.00 | 1.00 | C |
| ATOM | 4096 | O | HIE | A | 1234 | −5.074 | −10.230 | −3.212 | 1.00 | 1.00 | O |
| ATOM | 4097 | CB | HIE | A | 1234 | −4.959 | −12.785 | −4.406 | 1.00 | 1.00 | C |
| ATOM | 4098 | CG | HIE | A | 1234 | −5.411 | −12.993 | −3.030 | 1.00 | 1.00 | C |
| ATOM | 4099 | ND1 | HIE | A | 1234 | −5.027 | −12.329 | −1.826 | 1.00 | 1.00 | N |
| ATOM | 4100 | CD2 | HIE | A | 1234 | −6.259 | −13.932 | −2.588 | 1.00 | 1.00 | C |
| ATOM | 4101 | CE1 | HIE | A | 1234 | −5.537 | −12.905 | −0.845 | 1.00 | 1.00 | C |
| ATOM | 4102 | NE2 | HIE | A | 1234 | −6.309 | −13.866 | −1.303 | 1.00 | 1.00 | N |
| ATOM | 4103 | HA | HIE | A | 1234 | −6.693 | −11.810 | −5.350 | 1.00 | 1.00 | H |
| ATOM | 4104 | HB1 | HIE | A | 1234 | −5.288 | −13.644 | −5.035 | 1.00 | 1.00 | H |
| ATOM | 4105 | HB2 | HIE | A | 1234 | −3.865 | −12.707 | −4.468 | 1.00 | 1.00 | H |
| ATOM | 4106 | HD2 | HIE | A | 1234 | −6.710 | −14.568 | −3.301 | 1.00 | 1.00 | H |
| ATOM | 4107 | HE2 | HIE | A | 1234 | −6.872 | −14.508 | −0.693 | 1.00 | 1.00 | H |
| ATOM | 4108 | HE1 | HIE | A | 1234 | −5.402 | −12.664 | 0.179 | 1.00 | 1.00 | H |
| ATOM | 4109 | HN | HIE | A | 1234 | −5.283 | −11.512 | −7.184 | 1.00 | 1.00 | H |
| ATOM | 4110 | N | LEU | A | 1235 | −6.327 | −9.183 | −4.820 | 1.00 | 1.00 | N |
| ATOM | 4111 | CA | LEU | A | 1235 | −6.329 | −7.899 | −4.125 | 1.00 | 1.00 | C |
| ATOM | 4112 | C | LEU | A | 1235 | −7.276 | −7.878 | −2.969 | 1.00 | 1.00 | C |
| ATOM | 4113 | O | LEU | A | 1235 | −7.875 | −8.926 | −2.720 | 1.00 | 1.00 | O |
| ATOM | 4114 | CB | LEU | A | 1235 | −6.560 | −6.694 | −5.027 | 1.00 | 1.00 | C |
| ATOM | 4115 | CG | LEU | A | 1235 | −8.030 | −6.511 | −5.512 | 1.00 | 1.00 | C |
| ATOM | 4116 | CD1 | LEU | A | 1235 | −8.080 | −5.183 | −6.240 | 1.00 | 1.00 | C |
| ATOM | 4117 | CD2 | LEU | A | 1235 | −8.669 | −7.612 | −6.394 | 1.00 | 1.00 | C |
| ATOM | 4118 | HA | LEU | A | 1235 | −5.300 | −7.768 | −3.692 | 1.00 | 1.00 | H |
| ATOM | 4119 | HB1 | LEU | A | 1235 | −6.219 | −5.790 | −4.540 | 1.00 | 1.00 | H |
| ATOM | 4120 | HB2 | LEU | A | 1235 | −5.890 | −6.922 | −5.893 | 1.00 | 1.00 | H |
| ATOM | 4121 | HG | LEU | A | 1235 | −8.702 | −6.435 | −4.601 | 1.00 | 1.00 | H |
| ATOM | 4122 | HD21 | LEU | A | 1235 | −7.979 | −7.823 | −7.279 | 1.00 | 1.00 | H |
| ATOM | 4123 | HD22 | LEU | A | 1235 | −8.934 | −8.562 | −5.915 | 1.00 | 1.00 | H |
| ATOM | 4124 | HD23 | LEU | A | 1235 | −9.606 | −7.257 | −6.865 | 1.00 | 1.00 | H |
| ATOM | 4125 | HD11 | LEU | A | 1235 | −9.121 | −4.844 | −6.472 | 1.00 | 1.00 | H |
| ATOM | 4126 | HD12 | LEU | A | 1235 | −7.545 | −5.311 | −7.160 | 1.00 | 1.00 | H |
| ATOM | 4127 | HD13 | LEU | A | 1235 | −7.684 | −4.369 | −5.621 | 1.00 | 1.00 | H |
| ATOM | 4128 | HN | LEU | A | 1235 | −6.809 | −9.330 | −5.635 | 1.00 | 1.00 | H |
| ATOM | 4129 | N | ASN | A | 1236 | −7.450 | −6.753 | −2.288 | 1.00 | 1.00 | N |
| ATOM | 4130 | CA | ASN | A | 1236 | −8.581 | −6.620 | −1.370 | 1.00 | 1.00 | C |
| ATOM | 4131 | C | ASN | A | 1236 | −9.536 | −5.633 | −1.963 | 1.00 | 1.00 | C |
| ATOM | 4132 | O | ASN | A | 1236 | −9.385 | −4.439 | −1.682 | 1.00 | 1.00 | O |
| ATOM | 4133 | CB | ASN | A | 1236 | −8.232 | −5.959 | 0.008 | 1.00 | 1.00 | C |
| ATOM | 4134 | CG | ASN | A | 1236 | −7.358 | −4.732 | 0.048 | 1.00 | 1.00 | C |
| ATOM | 4135 | OD1 | ASN | A | 1236 | −7.740 | −3.647 | 0.445 | 1.00 | 1.00 | O |
| ATOM | 4136 | ND2 | ASN | A | 1236 | −6.074 | −4.864 | −0.298 | 1.00 | 1.00 | N |
| ATOM | 4137 | HA | ASN | A | 1236 | −9.089 | −7.552 | −1.084 | 1.00 | 1.00 | H |
| ATOM | 4138 | HB1 | ASN | A | 1236 | −9.124 | −5.695 | 0.584 | 1.00 | 1.00 | H |
| ATOM | 4139 | HB2 | ASN | A | 1236 | −7.783 | −6.716 | 0.632 | 1.00 | 1.00 | H |
| ATOM | 4140 | HD22 | ASN | A | 1236 | −5.600 | −4.003 | −0.397 | 1.00 | 1.00 | H |
| ATOM | 4141 | HD21 | ASN | A | 1236 | −5.607 | −5.750 | −0.555 | 1.00 | 1.00 | H |
| ATOM | 4142 | HN | ASN | A | 1236 | −6.871 | −5.973 | −2.419 | 1.00 | 1.00 | H |
| ATOM | 4143 | N | PRO | A | 1237 | −10.487 | −5.925 | −2.875 | 1.00 | 1.00 | N |
| ATOM | 4144 | CA | PRO | A | 1237 | −11.219 | −4.865 | −3.496 | 1.00 | 1.00 | C |
| ATOM | 4145 | C | PRO | A | 1237 | −12.197 | −4.245 | −2.517 | 1.00 | 1.00 | C |
| ATOM | 4146 | O | PRO | A | 1237 | −12.703 | −5.027 | −1.728 | 1.00 | 1.00 | O |
| ATOM | 4147 | CB | PRO | A | 1237 | −11.892 | −5.568 | −4.679 | 1.00 | 1.00 | C |
| ATOM | 4148 | CG | PRO | A | 1237 | −12.140 | −6.955 | −4.066 | 1.00 | 1.00 | C |
| ATOM | 4149 | CD | PRO | A | 1237 | −10.956 | −7.299 | −3.091 | 1.00 | 1.00 | C |
| ATOM | 4150 | HA | PRO | A | 1237 | −10.521 | −4.089 | −3.845 | 1.00 | 1.00 | H |
| ATOM | 4151 | HD2 | PRO | A | 1237 | −10.209 | −7.909 | −3.589 | 1.00 | 1.00 | H |
| ATOM | 4152 | HD1 | PRO | A | 1237 | −11.367 | −7.825 | −2.247 | 1.00 | 1.00 | H |
| ATOM | 4153 | HG2 | PRO | A | 1237 | −12.303 | −7.728 | −4.813 | 1.00 | 1.00 | H |
| ATOM | 4154 | HG1 | PRO | A | 1237 | −13.043 | −6.834 | −3.516 | 1.00 | 1.00 | H |
| ATOM | 4155 | HB1 | PRO | A | 1237 | −12.815 | −5.110 | −4.982 | 1.00 | 1.00 | H |
| ATOM | 4156 | HB2 | PRO | A | 1237 | −11.186 | −5.534 | −5.491 | 1.00 | 1.00 | H |
| ATOM | 4157 | N | ASN | A | 1238 | −12.552 | −2.944 | −2.659 | 1.00 | 1.00 | N |
| ATOM | 4158 | CA | ASN | A | 1238 | −13.742 | −2.410 | −1.957 | 1.00 | 1.00 | C |
| ATOM | 4159 | C | ASN | A | 1238 | −14.921 | −2.371 | −2.978 | 1.00 | 1.00 | C |
| ATOM | 4160 | O | ASN | A | 1238 | −14.560 | −2.127 | −4.103 | 1.00 | 1.00 | O |
| ATOM | 4161 | CB | ASN | A | 1238 | −13.562 | −1.073 | −1.161 | 1.00 | 1.00 | C |
| ATOM | 4162 | CG | ASN | A | 1238 | −12.432 | −1.362 | −0.176 | 1.00 | 1.00 | C |
| ATOM | 4163 | OD1 | ASN | A | 1238 | −12.799 | −1.584 | 0.943 | 1.00 | 1.00 | O |
| ATOM | 4164 | ND2 | ASN | A | 1238 | −11.152 | −1.466 | −0.574 | 1.00 | 1.00 | N |
| ATOM | 4165 | HA | ASN | A | 1238 | −14.058 | −3.086 | −1.142 | 1.00 | 1.00 | H |
| ATOM | 4166 | HB1 | ASN | A | 1238 | −13.318 | −0.228 | −1.791 | 1.00 | 1.00 | H |
| ATOM | 4167 | HB2 | ASN | A | 1238 | −14.463 | −0.811 | −0.587 | 1.00 | 1.00 | H |
| ATOM | 4168 | HD22 | ASN | A | 1238 | −10.447 | −1.762 | 0.103 | 1.00 | 1.00 | H |
| ATOM | 4169 | HD21 | ASN | A | 1238 | −10.906 | −1.245 | −1.501 | 1.00 | 1.00 | H |
| ATOM | 4170 | HN | ASN | A | 1238 | −12.107 | −2.391 | −3.383 | 1.00 | 1.00 | H |
| ATOM | 4171 | N | LYS | A | 1239 | −16.247 | −2.584 | −2.682 | 1.00 | 1.00 | N |
| ATOM | 4172 | CA | LYS | A | 1239 | −17.163 | −2.868 | −3.772 | 1.00 | 1.00 | C |
| ATOM | 4173 | C | LYS | A | 1239 | −18.635 | −2.853 | −3.476 | 1.00 | 1.00 | C |
| ATOM | 4174 | O | LYS | A | 1239 | −18.991 | −2.995 | −2.296 | 1.00 | 1.00 | O |
| ATOM | 4175 | CB | LYS | A | 1239 | −16.806 | −4.258 | −4.348 | 1.00 | 1.00 | C |
| ATOM | 4176 | CG | LYS | A | 1239 | −16.673 | −5.523 | −3.370 | 1.00 | 1.00 | C |
| ATOM | 4177 | CD | LYS | A | 1239 | −15.569 | −5.468 | −2.248 | 1.00 | 1.00 | C |
| ATOM | 4178 | CE | LYS | A | 1239 | −15.228 | −6.838 | −1.584 | 1.00 | 1.00 | C |
| ATOM | 4179 | NZ | LYS | A | 1239 | −14.107 | −6.804 | −0.652 | 1.00 | 1.00 | N |
| ATOM | 4180 | HA | LYS | A | 1239 | −16.980 | −2.051 | −4.514 | 1.00 | 1.00 | H |
| ATOM | 4181 | HB1 | LYS | A | 1239 | −17.515 | −4.487 | −5.152 | 1.00 | 1.00 | H |
| ATOM | 4182 | HB2 | LYS | A | 1239 | −15.857 | −4.153 | −4.905 | 1.00 | 1.00 | H |
| ATOM | 4183 | HG1 | LYS | A | 1239 | −16.449 | −6.391 | −3.995 | 1.00 | 1.00 | H |
| ATOM | 4184 | HG2 | LYS | A | 1239 | −17.625 | −5.775 | −2.904 | 1.00 | 1.00 | H |
| ATOM | 4185 | HD1 | LYS | A | 1239 | −14.740 | −5.012 | −2.754 | 1.00 | 1.00 | H |
| ATOM | 4186 | HD2 | LYS | A | 1239 | −15.937 | −4.759 | −1.454 | 1.00 | 1.00 | H |
| ATOM | 4187 | HE1 | LYS | A | 1239 | −16.142 | −7.224 | −1.134 | 1.00 | 1.00 | H |
| ATOM | 4188 | HE2 | LYS | A | 1239 | −15.008 | −7.473 | −2.440 | 1.00 | 1.00 | H |
| ATOM | 4189 | HZ1 | LYS | A | 1239 | −13.764 | −7.746 | −0.359 | 1.00 | 1.00 | H |
| ATOM | 4190 | HZ2 | LYS | A | 1239 | −14.092 | −6.226 | 0.290 | 1.00 | 1.00 | H |
| ATOM | 4191 | HZ3 | LYS | A | 1239 | −13.210 | −6.403 | −1.055 | 1.00 | 1.00 | H |
| ATOM | 4192 | HN | LYS | A | 1239 | −16.575 | −2.542 | −1.738 | 1.00 | 1.00 | H |
| ATOM | 4193 | N | THR | A | 1240 | −19.502 | −2.760 | −4.544 | 1.00 | 1.00 | N |
| ATOM | 4194 | CA | THR | A | 1240 | −20.962 | −2.921 | −4.434 | 1.00 | 1.00 | C |
| ATOM | 4195 | C | THR | A | 1240 | −21.466 | −3.518 | −5.710 | 1.00 | 1.00 | C |
| ATOM | 4196 | O | THR | A | 1240 | −20.897 | −3.145 | −6.716 | 1.00 | 1.00 | O |
| ATOM | 4197 | CB | THR | A | 1240 | −21.694 | −1.556 | −4.131 | 1.00 | 1.00 | C |
| ATOM | 4198 | OG1 | THR | A | 1240 | −20.921 | −0.803 | −3.183 | 1.00 | 1.00 | O |
| ATOM | 4199 | CG2 | THR | A | 1240 | −23.054 | −1.811 | −3.472 | 1.00 | 1.00 | C |
| ATOM | 4200 | HA | THR | A | 1240 | −21.137 | −3.624 | −3.640 | 1.00 | 1.00 | H |
| ATOM | 4201 | HB | THR | A | 1240 | −21.789 | −0.921 | −5.077 | 1.00 | 1.00 | H |
| ATOM | 4202 | HG1 | THR | A | 1240 | −20.702 | −1.250 | −2.359 | 1.00 | 1.00 | H |
| ATOM | 4203 | HG23 | THR | A | 1240 | −23.501 | −0.946 | −3.009 | 1.00 | 1.00 | H |
| ATOM | 4204 | HG21 | THR | A | 1240 | −23.775 | −2.232 | −4.161 | 1.00 | 1.00 | H |
| ATOM | 4205 | HG22 | THR | A | 1240 | −22.959 | −2.511 | −2.612 | 1.00 | 1.00 | H |
| ATOM | 4206 | HN | THR | A | 1240 | −19.124 | −2.640 | −5.465 | 1.00 | 1.00 | H |
| ATOM | 4207 | N | LYS | A | 1241 | −22.450 | −4.502 | −5.645 | 1.00 | 1.00 | N |
| ATOM | 4208 | CA | LYS | A | 1241 | −22.675 | −5.354 | −6.833 | 1.00 | 1.00 | C |
| ATOM | 4209 | C | LYS | A | 1241 | −24.155 | −5.567 | −7.143 | 1.00 | 1.00 | C |
| ATOM | 4210 | O | LYS | A | 1241 | −24.677 | −6.407 | −6.422 | 1.00 | 1.00 | O |
| ATOM | 4211 | CB | LYS | A | 1241 | −21.907 | −6.590 | −6.372 | 1.00 | 1.00 | C |
| ATOM | 4212 | CG | LYS | A | 1241 | −21.544 | −7.632 | −7.481 | 1.00 | 1.00 | C |
| ATOM | 4213 | CD | LYS | A | 1241 | −22.838 | −8.375 | −7.998 | 1.00 | 1.00 | C |
| ATOM | 4214 | CE | LYS | A | 1241 | −22.532 | −9.456 | −9.033 | 1.00 | 1.00 | C |
| ATOM | 4215 | NZ | LYS | A | 1241 | −23.724 | −9.964 | −9.718 | 1.00 | 1.00 | N |
| ATOM | 4216 | HA | LYS | A | 1241 | −22.157 | −4.965 | −7.740 | 1.00 | 1.00 | H |
| ATOM | 4217 | HB1 | LYS | A | 1241 | −22.349 | −7.064 | −5.481 | 1.00 | 1.00 | H |
| ATOM | 4218 | HB2 | LYS | A | 1241 | −20.925 | −6.292 | −6.052 | 1.00 | 1.00 | H |
| ATOM | 4219 | HG1 | LYS | A | 1241 | −21.086 | −7.129 | −8.300 | 1.00 | 1.00 | H |
| ATOM | 4220 | HG2 | LYS | A | 1241 | −20.841 | −8.340 | −7.082 | 1.00 | 1.00 | H |
| ATOM | 4221 | HD1 | LYS | A | 1241 | −23.490 | −8.798 | −7.202 | 1.00 | 1.00 | H |
| ATOM | 4222 | HD2 | LYS | A | 1241 | −23.433 | −7.649 | −8.594 | 1.00 | 1.00 | H |
| ATOM | 4223 | HE1 | LYS | A | 1241 | −21.835 | −8.994 | −9.776 | 1.00 | 1.00 | H |
| ATOM | 4224 | HE2 | LYS | A | 1241 | −22.071 | −10.339 | −8.609 | 1.00 | 1.00 | H |
| ATOM | 4225 | HZ1 | LYS | A | 1241 | −24.221 | −9.304 | −10.401 | 1.00 | 1.00 | H |
| ATOM | 4226 | HZ2 | LYS | A | 1241 | −23.498 | −10.771 | −10.453 | 1.00 | 1.00 | H |
| ATOM | 4227 | HZ3 | LYS | A | 1241 | −24.507 | −10.477 | −9.197 | 1.00 | 1.00 | H |
| ATOM | 4228 | HN | LYS | A | 1241 | −22.946 | −4.719 | −4.759 | 1.00 | 1.00 | H |
| ATOM | 4229 | N | ARG | A | 1242 | −24.781 | −4.811 | −8.097 | 1.00 | 1.00 | N |
| ATOM | 4230 | CA | ARG | A | 1242 | −26.219 | −5.111 | −8.334 | 1.00 | 1.00 | C |
| ATOM | 4231 | C | ARG | A | 1242 | −27.190 | −5.242 | −7.203 | 1.00 | 1.00 | C |
| ATOM | 4232 | O | ARG | A | 1242 | −28.052 | −4.368 | −7.139 | 1.00 | 1.00 | O |
| ATOM | 4233 | CB | ARG | A | 1242 | −26.148 | −6.431 | −9.171 | 1.00 | 1.00 | C |
| ATOM | 4234 | CG | ARG | A | 1242 | −27.596 | −6.807 | −9.648 | 1.00 | 1.00 | C |
| ATOM | 4235 | CD | ARG | A | 1242 | −27.651 | −8.073 | −10.541 | 1.00 | 1.00 | C |
| ATOM | 4236 | NE | ARG | A | 1242 | −28.913 | −8.123 | −11.401 | 1.00 | 1.00 | N |
| ATOM | 4237 | CZ | ARG | A | 1242 | −29.148 | −9.130 | −12.225 | 1.00 | 1.00 | C |
| ATOM | 4238 | NH1 | ARG | A | 1242 | −28.323 | −10.109 | −12.472 | 1.00 | 1.00 | N |
| ATOM | 4239 | NH2 | ARG | A | 1242 | −30.330 | −9.078 | −12.848 | 1.00 | 1.00 | N |
| ATOM | 4240 | HA | ARG | A | 1242 | −26.603 | −4.383 | −9.047 | 1.00 | 1.00 | H |
| ATOM | 4241 | HB1 | ARG | A | 1242 | −25.812 | −7.324 | −8.584 | 1.00 | 1.00 | H |
| ATOM | 4242 | HB2 | ARG | A | 1242 | −25.427 | −6.248 | −9.947 | 1.00 | 1.00 | H |
| ATOM | 4243 | HG1 | ARG | A | 1242 | −28.384 | −6.993 | −8.845 | 1.00 | 1.00 | H |
| ATOM | 4244 | HG2 | ARG | A | 1242 | −27.900 | −6.016 | −10.267 | 1.00 | 1.00 | H |
| ATOM | 4245 | HD1 | ARG | A | 1242 | −26.762 | −8.037 | −11.176 | 1.00 | 1.00 | H |
| ATOM | 4246 | HD2 | ARG | A | 1242 | −27.479 | −8.985 | −9.945 | 1.00 | 1.00 | H |
| ATOM | 4247 | HE | ARG | A | 1242 | −29.596 | −7.365 | −11.340 | 1.00 | 1.00 | H |
| ATOM | 4248 | HH12 | ARG | A | 1242 | −28.566 | −10.827 | −13.161 | 1.00 | 1.00 | H |
| ATOM | 4249 | HH11 | ARG | A | 1242 | −27.432 | −10.174 | −11.969 | 1.00 | 1.00 | H |
| ATOM | 4250 | HH22 | ARG | A | 1242 | −30.593 | −9.809 | −13.564 | 1.00 | 1.00 | H |
| ATOM | 4251 | HH21 | ARG | A | 1242 | −31.013 | −8.355 | −12.607 | 1.00 | 1.00 | H |
| ATOM | 4252 | HN | ARG | A | 1242 | −24.367 | −4.132 | −8.622 | 1.00 | 1.00 | H |
| ATOM | 4253 | N | TRP | A | 1243 | −27.177 | −6.290 | −6.378 | 1.00 | 1.00 | N |
| ATOM | 4254 | CA | TRP | A | 1243 | −28.386 | −6.555 | −5.592 | 1.00 | 1.00 | C |
| ATOM | 4255 | C | TRP | A | 1243 | −28.556 | −5.409 | −4.649 | 1.00 | 1.00 | C |
| ATOM | 4256 | O | TRP | A | 1243 | −27.551 | −4.969 | −4.121 | 1.00 | 1.00 | O |
| ATOM | 4257 | CB | TRP | A | 1243 | −28.297 | −7.951 | −4.905 | 1.00 | 1.00 | C |
| ATOM | 4258 | CG | TRP | A | 1243 | −27.954 | −8.978 | −5.907 | 1.00 | 1.00 | C |
| ATOM | 4259 | CD1 | TRP | A | 1243 | −26.818 | −9.698 | −5.971 | 1.00 | 1.00 | C |
| ATOM | 4260 | CD2 | TRP | A | 1243 | −28.767 | −9.443 | −7.095 | 1.00 | 1.00 | C |
| ATOM | 4261 | NE1 | TRP | A | 1243 | −26.892 | −10.545 | −6.928 | 1.00 | 1.00 | N |
| ATOM | 4262 | CE2 | TRP | A | 1243 | −28.002 | −10.419 | −7.617 | 1.00 | 1.00 | C |
| ATOM | 4263 | CE3 | TRP | A | 1243 | −29.949 | −9.056 | −7.694 | 1.00 | 1.00 | C |
| ATOM | 4264 | CZ2 | TRP | A | 1243 | −28.340 | −11.191 | −8.704 | 1.00 | 1.00 | C |
| ATOM | 4265 | CZ3 | TRP | A | 1243 | −30.327 | −9.787 | −8.827 | 1.00 | 1.00 | C |
| ATOM | 4266 | CH2 | TRP | A | 1243 | −29.568 | −10.890 | −9.303 | 1.00 | 1.00 | C |
| ATOM | 4267 | HA | TRP | A | 1243 | −29.235 | −6.508 | −6.219 | 1.00 | 1.00 | H |
| ATOM | 4268 | HB1 | TRP | A | 1243 | −27.396 | −7.882 | −4.249 | 1.00 | 1.00 | H |
| ATOM | 4269 | HB2 | TRP | A | 1243 | −29.169 | −8.158 | −4.255 | 1.00 | 1.00 | H |
| ATOM | 4270 | HE1 | TRP | A | 1243 | −26.198 | −11.272 | −7.095 | 1.00 | 1.00 | H |
| ATOM | 4271 | HD1 | TRP | A | 1243 | −25.930 | −9.600 | −5.341 | 1.00 | 1.00 | H |
| ATOM | 4272 | HZ2 | TRP | A | 1243 | −27.714 | −12.008 | −9.043 | 1.00 | 1.00 | H |
| ATOM | 4273 | HH2 | TRP | A | 1243 | −29.970 | −11.509 | −10.097 | 1.00 | 1.00 | H |
| ATOM | 4274 | HZ3 | TRP | A | 1243 | −31.204 | −9.581 | −9.356 | 1.00 | 1.00 | H |
| ATOM | 4275 | HE3 | TRP | A | 1243 | −30.545 | −8.254 | −7.291 | 1.00 | 1.00 | H |
| ATOM | 4276 | HN | TRP | A | 1243 | −26.408 | −6.874 | −6.260 | 1.00 | 1.00 | H |
| ATOM | 4277 | N | GLY | A | 1244 | −29.808 | −4.876 | −4.476 | 1.00 | 1.00 | N |
| ATOM | 4278 | CA | GLY | A | 1244 | −29.978 | −3.608 | −3.779 | 1.00 | 1.00 | C |
| ATOM | 4279 | C | GLY | A | 1244 | −29.944 | −2.412 | −4.717 | 1.00 | 1.00 | C |
| ATOM | 4280 | O | GLY | A | 1244 | −30.594 | −1.434 | −4.354 | 1.00 | 1.00 | O |
| ATOM | 4281 | HA2 | GLY | A | 1244 | −29.200 | −3.437 | −2.975 | 1.00 | 1.00 | H |
| ATOM | 4282 | HA1 | GLY | A | 1244 | −30.960 | −3.667 | −3.268 | 1.00 | 1.00 | H |
| ATOM | 4283 | HN | GLY | A | 1244 | −30.615 | −5.277 | −4.904 | 1.00 | 1.00 | H |
| ATOM | 4284 | N | TYR | A | 1245 | −29.193 | −2.386 | −5.863 | 1.00 | 1.00 | N |
| ATOM | 4285 | CA | TYR | A | 1245 | −29.274 | −1.212 | −6.730 | 1.00 | 1.00 | C |
| ATOM | 4286 | C | TYR | A | 1245 | −28.841 | 0.009 | −5.916 | 1.00 | 1.00 | C |
| ATOM | 4287 | O | TYR | A | 1245 | −29.394 | 1.024 | −6.202 | 1.00 | 1.00 | O |
| ATOM | 4288 | CB | TYR | A | 1245 | −30.636 | −1.225 | −7.573 | 1.00 | 1.00 | C |
| ATOM | 4289 | CG | TYR | A | 1245 | −30.680 | −2.567 | −8.351 | 1.00 | 1.00 | C |
| ATOM | 4290 | CD1 | TYR | A | 1245 | −30.096 | −2.590 | −9.604 | 1.00 | 1.00 | C |
| ATOM | 4291 | CD2 | TYR | A | 1245 | −31.248 | −3.693 | −7.734 | 1.00 | 1.00 | C |
| ATOM | 4292 | CE1 | TYR | A | 1245 | −30.137 | −3.759 | −10.331 | 1.00 | 1.00 | C |
| ATOM | 4293 | CE2 | TYR | A | 1245 | −31.309 | −4.875 | −8.508 | 1.00 | 1.00 | C |
| ATOM | 4294 | CZ | TYR | A | 1245 | −30.755 | −4.901 | −9.797 | 1.00 | 1.00 | C |
| ATOM | 4295 | OH | TYR | A | 1245 | −30.806 | −6.088 | −10.524 | 1.00 | 1.00 | O |
| ATOM | 4296 | HA | TYR | A | 1245 | −28.436 | −1.412 | −7.394 | 1.00 | 1.00 | H |
| ATOM | 4297 | HB2 | TYR | A | 1245 | −31.572 | −1.109 | −6.910 | 1.00 | 1.00 | H |
| ATOM | 4298 | HB1 | TYR | A | 1245 | −30.655 | −0.425 | −8.306 | 1.00 | 1.00 | H |
| ATOM | 4299 | HD2 | TYR | A | 1245 | −31.677 | −3.706 | −6.753 | 1.00 | 1.00 | H |
| ATOM | 4300 | HE2 | TYR | A | 1245 | −31.817 | −5.741 | −8.186 | 1.00 | 1.00 | H |
| ATOM | 4301 | HE1 | TYR | A | 1245 | −29.657 | −3.801 | −11.325 | 1.00 | 1.00 | H |
| ATOM | 4302 | HD1 | TYR | A | 1245 | −29.553 | −1.738 | −9.975 | 1.00 | 1.00 | H |
| ATOM | 4303 | HH | TYR | A | 1245 | −31.567 | −6.027 | −11.096 | 1.00 | 1.00 | H |
| ATOM | 4304 | HN | TYR | A | 1245 | −28.632 | −3.158 | −6.228 | 1.00 | 1.00 | H |
| ATOM | 4305 | N | SER | A | 1246 | −27.911 | −0.129 | −4.938 | 1.00 | 1.00 | N |
| ATOM | 4306 | CA | SER | A | 1246 | −27.437 | 0.959 | −4.083 | 1.00 | 1.00 | C |
| ATOM | 4307 | C | SER | A | 1246 | −25.950 | 1.057 | −4.346 | 1.00 | 1.00 | C |
| ATOM | 4308 | O | SER | A | 1246 | −25.128 | 0.813 | −3.465 | 1.00 | 1.00 | O |
| ATOM | 4309 | CB | SER | A | 1246 | −27.670 | 0.502 | −2.614 | 1.00 | 1.00 | C |
| ATOM | 4310 | OG | SER | A | 1246 | −26.887 | −0.682 | −2.295 | 1.00 | 1.00 | O |
| ATOM | 4311 | HA | SER | A | 1246 | −27.951 | 1.952 | −4.288 | 1.00 | 1.00 | H |
| ATOM | 4312 | HB1 | SER | A | 1246 | −27.425 | 1.364 | −1.959 | 1.00 | 1.00 | H |
| ATOM | 4313 | HB2 | SER | A | 1246 | −28.712 | 0.209 | −2.522 | 1.00 | 1.00 | H |
| ATOM | 4314 | HG | SER | A | 1246 | −25.976 | −0.461 | −2.327 | 1.00 | 1.00 | H |
| ATOM | 4315 | HN | SER | A | 1246 | −27.528 | −1.052 | −4.743 | 1.00 | 1.00 | H |
| ATOM | 4316 | N | LEU | A | 1247 | −25.584 | 1.399 | −5.608 | 1.00 | 1.00 | N |
| ATOM | 4317 | CA | LEU | A | 1247 | −24.202 | 1.437 | −6.027 | 1.00 | 1.00 | C |
| ATOM | 4318 | C | LEU | A | 1247 | −23.564 | 2.809 | −5.582 | 1.00 | 1.00 | C |
| ATOM | 4319 | O | LEU | A | 1247 | −23.796 | 3.800 | −6.276 | 1.00 | 1.00 | O |
| ATOM | 4320 | CB | LEU | A | 1247 | −24.107 | 1.221 | −7.583 | 1.00 | 1.00 | C |
| ATOM | 4321 | CG | LEU | A | 1247 | −24.394 | −0.264 | −8.053 | 1.00 | 1.00 | C |
| ATOM | 4322 | CD1 | LEU | A | 1247 | −23.403 | −1.201 | −7.343 | 1.00 | 1.00 | C |
| ATOM | 4323 | CD2 | LEU | A | 1247 | −25.805 | −0.775 | −7.836 | 1.00 | 1.00 | C |
| ATOM | 4324 | HA | LEU | A | 1247 | −23.565 | 0.734 | −5.458 | 1.00 | 1.00 | H |
| ATOM | 4325 | HB1 | LEU | A | 1247 | −23.154 | 1.605 | −7.979 | 1.00 | 1.00 | H |
| ATOM | 4326 | HB2 | LEU | A | 1247 | −24.920 | 1.759 | −8.031 | 1.00 | 1.00 | H |
| ATOM | 4327 | HG | LEU | A | 1247 | −24.123 | −0.185 | −9.136 | 1.00 | 1.00 | H |
| ATOM | 4328 | HD21 | LEU | A | 1247 | −26.431 | 0.029 | −8.257 | 1.00 | 1.00 | H |
| ATOM | 4329 | HD22 | LEU | A | 1247 | −26.050 | −1.723 | −8.325 | 1.00 | 1.00 | H |
| ATOM | 4330 | HD23 | LEU | A | 1247 | −26.110 | −0.909 | −6.785 | 1.00 | 1.00 | H |
| ATOM | 4331 | HD11 | LEU | A | 1247 | −23.714 | −1.322 | −6.294 | 1.00 | 1.00 | H |
| ATOM | 4332 | HD12 | LEU | A | 1247 | −23.401 | −2.198 | −7.840 | 1.00 | 1.00 | H |
| ATOM | 4333 | HD13 | LEU | A | 1247 | −22.328 | −0.770 | −7.433 | 1.00 | 1.00 | H |
| ATOM | 4334 | HN | LEU | A | 1247 | −26.204 | 1.725 | −6.260 | 1.00 | 1.00 | H |
| ATOM | 4335 | N | HIS | A | 1248 | −22.772 | 2.887 | −4.491 | 1.00 | 1.00 | N |
| ATOM | 4336 | CA | HIS | A | 1248 | −22.075 | 4.139 | −4.277 | 1.00 | 1.00 | C |
| ATOM | 4337 | C | HIS | A | 1248 | −21.156 | 4.383 | −5.495 | 1.00 | 1.00 | C |
| ATOM | 4338 | O | HIS | A | 1248 | −20.589 | 3.384 | −5.944 | 1.00 | 1.00 | O |
| ATOM | 4339 | CB | HIS | A | 1248 | −21.106 | 4.200 | −3.091 | 1.00 | 1.00 | C |
| ATOM | 4340 | CG | HIS | A | 1248 | −20.120 | 3.061 | −3.041 | 1.00 | 1.00 | C |
| ATOM | 4341 | ND1 | HIS | A | 1248 | −19.045 | 3.081 | −3.731 | 1.00 | 1.00 | N |
| ATOM | 4342 | CD2 | HIS | A | 1248 | −20.156 | 1.951 | −2.315 | 1.00 | 1.00 | C |
| ATOM | 4343 | CE1 | HIS | A | 1248 | −18.294 | 2.075 | −3.480 | 1.00 | 1.00 | C |
| ATOM | 4344 | NE2 | HIS | A | 1248 | −18.873 | 1.345 | −2.639 | 1.00 | 1.00 | N |
| ATOM | 4345 | HA | HIS | A | 1248 | −22.739 | 5.032 | −4.178 | 1.00 | 1.00 | H |
| ATOM | 4346 | HB1 | HIS | A | 1248 | −21.765 | 4.249 | −2.155 | 1.00 | 1.00 | H |
| ATOM | 4347 | HB2 | HIS | A | 1248 | −20.527 | 5.131 | −3.034 | 1.00 | 1.00 | H |
| ATOM | 4348 | HD2 | HIS | A | 1248 | −20.953 | 1.575 | −1.634 | 1.00 | 1.00 | H |
| ATOM | 4349 | HE1 | HIS | A | 1248 | −17.315 | 1.877 | −3.944 | 1.00 | 1.00 | H |
| ATOM | 4350 | HD1 | HIS | A | 1248 | −18.776 | 3.809 | −4.398 | 1.00 | 1.00 | H |
| ATOM | 4351 | HN | HIS | A | 1248 | −22.668 | 2.082 | −3.898 | 1.00 | 1.00 | H |
| ATOM | 4352 | N | PHE | A | 1249 | −20.936 | 5.662 | −6.009 | 1.00 | 1.00 | N |
| ATOM | 4353 | CA | PHE | A | 1249 | −19.874 | 5.829 | −6.946 | 1.00 | 1.00 | C |
| ATOM | 4354 | C | PHE | A | 1249 | −19.692 | 7.291 | −7.267 | 1.00 | 1.00 | C |
| ATOM | 4355 | O | PHE | A | 1249 | −20.633 | 7.912 | −7.709 | 1.00 | 1.00 | O |
| ATOM | 4356 | CB | PHE | A | 1249 | −20.131 | 5.138 | −8.284 | 1.00 | 1.00 | C |
| ATOM | 4357 | CG | PHE | A | 1249 | −18.794 | 4.902 | −9.043 | 1.00 | 1.00 | C |
| ATOM | 4358 | CD1 | PHE | A | 1249 | −17.987 | 3.792 | −8.841 | 1.00 | 1.00 | C |
| ATOM | 4359 | CD2 | PHE | A | 1249 | −18.355 | 5.871 | −9.935 | 1.00 | 1.00 | C |
| ATOM | 4360 | CE1 | PHE | A | 1249 | −16.861 | 3.502 | −9.614 | 1.00 | 1.00 | C |
| ATOM | 4361 | CE2 | PHE | A | 1249 | −17.208 | 5.611 | −10.711 | 1.00 | 1.00 | C |
| ATOM | 4362 | CZ | PHE | A | 1249 | −16.462 | 4.442 | −10.538 | 1.00 | 1.00 | C |
| ATOM | 4363 | HA | PHE | A | 1249 | −18.946 | 5.470 | −6.528 | 1.00 | 1.00 | H |
| ATOM | 4364 | HB1 | PHE | A | 1249 | −20.731 | 5.863 | −8.840 | 1.00 | 1.00 | H |
| ATOM | 4365 | HB2 | PHE | A | 1249 | −20.724 | 4.224 | −8.227 | 1.00 | 1.00 | H |
| ATOM | 4366 | HD2 | PHE | A | 1249 | −18.907 | 6.804 | −10.062 | 1.00 | 1.00 | H |
| ATOM | 4367 | HE2 | PHE | A | 1249 | −16.904 | 6.251 | −11.527 | 1.00 | 1.00 | H |
| ATOM | 4368 | HZ | PHE | A | 1249 | −15.574 | 4.264 | −11.144 | 1.00 | 1.00 | H |
| ATOM | 4369 | HE1 | PHE | A | 1249 | −16.311 | 2.541 | −9.516 | 1.00 | 1.00 | H |
| ATOM | 4370 | HD1 | PHE | A | 1249 | −18.249 | 3.083 | −8.054 | 1.00 | 1.00 | H |
| ATOM | 4371 | HN | PHE | A | 1249 | −21.488 | 6.447 | −5.732 | 1.00 | 1.00 | H |
| ATOM | 4372 | N | MET | A | 1250 | −18.503 | 7.877 | −7.118 | 1.00 | 1.00 | N |
| ATOM | 4373 | CA | MET | A | 1250 | −18.339 | 9.265 | −7.534 | 1.00 | 1.00 | C |
| ATOM | 4374 | C | MET | A | 1250 | −19.281 | 10.205 | −6.801 | 1.00 | 1.00 | C |
| ATOM | 4375 | O | MET | A | 1250 | −19.979 | 11.007 | −7.448 | 1.00 | 1.00 | O |
| ATOM | 4376 | CB | MET | A | 1250 | −18.372 | 9.462 | −9.104 | 1.00 | 1.00 | C |
| ATOM | 4377 | CG | MET | A | 1250 | −18.009 | 10.928 | −9.503 | 1.00 | 1.00 | C |
| ATOM | 4378 | SD | MET | A | 1250 | −16.215 | 11.204 | −9.672 | 1.00 | 1.00 | S |
| ATOM | 4379 | CE | MET | A | 1250 | −16.184 | 13.079 | −9.677 | 1.00 | 1.00 | C |
| ATOM | 4380 | HA | MET | A | 1250 | −17.387 | 9.701 | −7.175 | 1.00 | 1.00 | H |
| ATOM | 4381 | HB1 | MET | A | 1250 | −19.372 | 9.244 | −9.441 | 1.00 | 1.00 | H |
| ATOM | 4382 | HB2 | MET | A | 1250 | −17.652 | 8.798 | −9.561 | 1.00 | 1.00 | H |
| ATOM | 4383 | HG1 | MET | A | 1250 | −18.459 | 11.179 | −10.463 | 1.00 | 1.00 | H |
| ATOM | 4384 | HG2 | MET | A | 1250 | −18.242 | 11.669 | −8.753 | 1.00 | 1.00 | H |
| ATOM | 4385 | HE1 | MET | A | 1250 | −15.101 | 13.371 | −9.847 | 1.00 | 1.00 | H |
| ATOM | 4386 | HE2 | MET | A | 1250 | −16.615 | 13.461 | −8.731 | 1.00 | 1.00 | H |
| ATOM | 4387 | HE3 | MET | A | 1250 | −16.746 | 13.410 | −10.633 | 1.00 | 1.00 | H |
| ATOM | 4388 | HN | MET | A | 1250 | −17.718 | 7.409 | −6.652 | 1.00 | 1.00 | H |
| ATOM | 4389 | N | GLY | A | 1251 | −19.396 | 10.213 | −5.447 | 1.00 | 1.00 | N |
| ATOM | 4390 | CA | GLY | A | 1251 | −20.192 | 11.219 | −4.852 | 1.00 | 1.00 | C |
| ATOM | 4391 | C | GLY | A | 1251 | −21.659 | 11.161 | −5.153 | 1.00 | 1.00 | C |
| ATOM | 4392 | O | GLY | A | 1251 | −22.387 | 12.123 | −4.910 | 1.00 | 1.00 | O |
| ATOM | 4393 | HA2 | GLY | A | 1251 | −19.791 | 12.140 | −5.170 | 1.00 | 1.00 | H |
| ATOM | 4394 | HA1 | GLY | A | 1251 | −20.009 | 11.053 | −3.764 | 1.00 | 1.00 | H |
| ATOM | 4395 | HN | GLY | A | 1251 | −18.883 | 9.501 | −4.894 | 1.00 | 1.00 | H |
| ATOM | 4396 | N | TYR | A | 1252 | −22.149 | 9.968 | −5.534 | 1.00 | 1.00 | N |
| ATOM | 4397 | CA | TYR | A | 1252 | −23.601 | 9.801 | −5.606 | 1.00 | 1.00 | C |
| ATOM | 4398 | C | TYR | A | 1252 | −23.933 | 8.329 | −5.680 | 1.00 | 1.00 | C |
| ATOM | 4399 | O | TYR | A | 1252 | −22.975 | 7.546 | −5.532 | 1.00 | 1.00 | O |
| ATOM | 4400 | CB | TYR | A | 1252 | −24.090 | 10.628 | −6.849 | 1.00 | 1.00 | C |
| ATOM | 4401 | CG | TYR | A | 1252 | −23.019 | 10.957 | −7.884 | 1.00 | 1.00 | C |
| ATOM | 4402 | CD1 | TYR | A | 1252 | −22.577 | 10.008 | −8.809 | 1.00 | 1.00 | C |
| ATOM | 4403 | CD2 | TYR | A | 1252 | −22.383 | 12.223 | −7.898 | 1.00 | 1.00 | C |
| ATOM | 4404 | CE1 | TYR | A | 1252 | −21.857 | 10.482 | −9.916 | 1.00 | 1.00 | C |
| ATOM | 4405 | CE2 | TYR | A | 1252 | −21.465 | 12.588 | −8.918 | 1.00 | 1.00 | C |
| ATOM | 4406 | CZ | TYR | A | 1252 | −21.312 | 11.771 | −10.047 | 1.00 | 1.00 | C |
| ATOM | 4407 | OH | TYR | A | 1252 | −20.726 | 12.256 | −11.215 | 1.00 | 1.00 | O |
| ATOM | 4408 | HA | TYR | A | 1252 | −24.126 | 10.112 | −4.676 | 1.00 | 1.00 | H |
| ATOM | 4409 | HB2 | TYR | A | 1252 | −24.595 | 11.574 | −6.513 | 1.00 | 1.00 | H |
| ATOM | 4410 | HB1 | TYR | A | 1252 | −24.770 | 10.028 | −7.472 | 1.00 | 1.00 | H |
| ATOM | 4411 | HD2 | TYR | A | 1252 | −22.703 | 12.952 | −7.119 | 1.00 | 1.00 | H |
| ATOM | 4412 | HE2 | TYR | A | 1252 | −20.860 | 13.460 | −8.774 | 1.00 | 1.00 | H |
| ATOM | 4413 | HE1 | TYR | A | 1252 | −21.692 | 9.832 | −10.733 | 1.00 | 1.00 | H |
| ATOM | 4414 | HD1 | TYR | A | 1252 | −22.788 | 8.921 | −8.684 | 1.00 | 1.00 | H |
| ATOM | 4415 | HH | TYR | A | 1252 | −20.332 | 13.125 | −11.144 | 1.00 | 1.00 | H |
| ATOM | 4416 | HN | TYR | A | 1252 | −21.613 | 9.168 | −5.685 | 1.00 | 1.00 | H |
| ATOM | 4417 | N | VAL | A | 1253 | −25.269 | 8.018 | −5.903 | 1.00 | 1.00 | N |
| ATOM | 4418 | CA | VAL | A | 1253 | −25.689 | 6.642 | −6.042 | 1.00 | 1.00 | C |
| ATOM | 4419 | C | VAL | A | 1253 | −25.936 | 6.342 | −7.505 | 1.00 | 1.00 | C |
| ATOM | 4420 | O | VAL | A | 1253 | −26.500 | 7.171 | −8.157 | 1.00 | 1.00 | O |
| ATOM | 4421 | CB | VAL | A | 1253 | −27.007 | 6.334 | −5.225 | 1.00 | 1.00 | C |
| ATOM | 4422 | CG1 | VAL | A | 1253 | −27.240 | 4.800 | −5.238 | 1.00 | 1.00 | C |
| ATOM | 4423 | CG2 | VAL | A | 1253 | −27.030 | 6.910 | −3.789 | 1.00 | 1.00 | C |
| ATOM | 4424 | HA | VAL | A | 1253 | −24.928 | 6.077 | −5.621 | 1.00 | 1.00 | H |
| ATOM | 4425 | HB | VAL | A | 1253 | −27.882 | 6.796 | −5.723 | 1.00 | 1.00 | H |
| ATOM | 4426 | HG11 | VAL | A | 1253 | −27.293 | 4.405 | −6.224 | 1.00 | 1.00 | H |
| ATOM | 4427 | HG12 | VAL | A | 1253 | −26.441 | 4.230 | −4.663 | 1.00 | 1.00 | H |
| ATOM | 4428 | HG13 | VAL | A | 1253 | −28.196 | 4.596 | −4.708 | 1.00 | 1.00 | H |
| ATOM | 4429 | HG21 | VAL | A | 1253 | −26.910 | 8.007 | −3.800 | 1.00 | 1.00 | H |
| ATOM | 4430 | HG22 | VAL | A | 1253 | −26.154 | 6.502 | −3.320 | 1.00 | 1.00 | H |
| ATOM | 4431 | HG23 | VAL | A | 1253 | −27.964 | 6.640 | −3.267 | 1.00 | 1.00 | H |
| ATOM | 4432 | HN | VAL | A | 1253 | −25.979 | 8.745 | −5.936 | 1.00 | 1.00 | H |
| ATOM | 4433 | N | ILE | A | 1254 | −25.484 | 5.191 | −8.063 | 1.00 | 1.00 | N |
| ATOM | 4434 | CA | ILE | A | 1254 | −25.705 | 4.875 | −9.472 | 1.00 | 1.00 | C |
| ATOM | 4435 | C | ILE | A | 1254 | −26.942 | 3.962 | −9.550 | 1.00 | 1.00 | C |
| ATOM | 4436 | O | ILE | A | 1254 | −26.880 | 2.841 | −10.051 | 1.00 | 1.00 | O |
| ATOM | 4437 | CB | ILE | A | 1254 | −24.438 | 4.381 | −10.164 | 1.00 | 1.00 | C |
| ATOM | 4438 | CG1 | ILE | A | 1254 | −23.231 | 5.303 | −9.905 | 1.00 | 1.00 | C |
| ATOM | 4439 | CG2 | ILE | A | 1254 | −24.562 | 3.996 | −11.645 | 1.00 | 1.00 | C |
| ATOM | 4440 | CD1 | ILE | A | 1254 | −23.284 | 6.580 | −10.725 | 1.00 | 1.00 | C |
| ATOM | 4441 | HA | ILE | A | 1254 | −25.969 | 5.789 | −10.015 | 1.00 | 1.00 | H |
| ATOM | 4442 | HB | ILE | A | 1254 | −24.182 | 3.476 | −9.604 | 1.00 | 1.00 | H |
| ATOM | 4443 | HG11 | ILE | A | 1254 | −23.134 | 5.689 | −8.868 | 1.00 | 1.00 | H |
| ATOM | 4444 | HG12 | ILE | A | 1254 | −22.315 | 4.734 | −10.096 | 1.00 | 1.00 | H |
| ATOM | 4445 | HD11 | ILE | A | 1254 | −24.172 | 7.212 | −10.418 | 1.00 | 1.00 | H |
| ATOM | 4446 | HD12 | ILE | A | 1254 | −22.430 | 7.263 | −10.607 | 1.00 | 1.00 | H |
| ATOM | 4447 | HD13 | ILE | A | 1254 | −23.407 | 6.348 | −11.795 | 1.00 | 1.00 | H |
| ATOM | 4448 | HG21 | ILE | A | 1254 | −25.049 | 4.710 | −12.331 | 1.00 | 1.00 | H |
| ATOM | 4449 | HG22 | ILE | A | 1254 | −23.549 | 3.763 | −12.071 | 1.00 | 1.00 | H |
| ATOM | 4450 | HG23 | ILE | A | 1254 | −25.168 | 3.055 | −11.770 | 1.00 | 1.00 | H |
| ATOM | 4451 | HN | ILE | A | 1254 | −25.087 | 4.465 | −7.506 | 1.00 | 1.00 | H |
| ATOM | 4452 | N | GLY | A | 1255 | −28.092 | 4.483 | −9.062 | 1.00 | 1.00 | N |
| ATOM | 4453 | CA | GLY | A | 1255 | −29.325 | 3.663 | −8.957 | 1.00 | 1.00 | C |
| ATOM | 4454 | C | GLY | A | 1255 | −30.431 | 4.538 | −8.437 | 1.00 | 1.00 | C |
| ATOM | 4455 | O | GLY | A | 1255 | −31.519 | 4.530 | −9.005 | 1.00 | 1.00 | O |
| ATOM | 4456 | HA2 | GLY | A | 1255 | −29.190 | 2.769 | −8.303 | 1.00 | 1.00 | H |
| ATOM | 4457 | HA1 | GLY | A | 1255 | −29.595 | 3.325 | −9.915 | 1.00 | 1.00 | H |
| ATOM | 4458 | HN | GLY | A | 1255 | −28.108 | 5.433 | −8.745 | 1.00 | 1.00 | H |
| ATOM | 4459 | N | CYS | A | 1256 | −30.245 | 5.355 | −7.341 | 1.00 | 1.00 | N |
| ATOM | 4460 | CA | CYS | A | 1256 | −31.382 | 6.027 | −6.722 | 1.00 | 1.00 | C |
| ATOM | 4461 | C | CYS | A | 1256 | −31.250 | 7.538 | −6.620 | 1.00 | 1.00 | C |
| ATOM | 4462 | O | CYS | A | 1256 | −31.571 | 8.130 | −5.595 | 1.00 | 1.00 | O |
| ATOM | 4463 | CB | CYS | A | 1256 | −31.811 | 5.452 | −5.356 | 1.00 | 1.00 | C |
| ATOM | 4464 | SG | CYS | A | 1256 | −30.532 | 5.619 | −4.039 | 1.00 | 1.00 | S |
| ATOM | 4465 | HA | CYS | A | 1256 | −32.209 | 5.931 | −7.410 | 1.00 | 1.00 | H |
| ATOM | 4466 | HB1 | CYS | A | 1256 | −31.890 | 4.373 | −5.556 | 1.00 | 1.00 | H |
| ATOM | 4467 | HB2 | CYS | A | 1256 | −32.774 | 5.819 | −4.970 | 1.00 | 1.00 | H |
| ATOM | 4468 | HG | CYS | A | 1256 | −30.512 | 6.621 | −4.029 | 1.00 | 1.00 | H |
| ATOM | 4469 | HN | CYS | A | 1256 | −29.418 | 5.391 | −6.833 | 1.00 | 1.00 | H |
| ATOM | 4470 | N | TYR | A | 1257 | −30.709 | 8.170 | −7.682 | 1.00 | 1.00 | N |
| ATOM | 4471 | CA | TYR | A | 1257 | −30.564 | 9.629 | −7.705 | 1.00 | 1.00 | C |
| ATOM | 4472 | C | TYR | A | 1257 | −29.543 | 10.121 | −6.723 | 1.00 | 1.00 | C |
| ATOM | 4473 | O | TYR | A | 1257 | −28.500 | 10.598 | −7.146 | 1.00 | 1.00 | O |
| ATOM | 4474 | CB | TYR | A | 1257 | −31.919 | 10.342 | −7.500 | 1.00 | 1.00 | C |
| ATOM | 4475 | CG | TYR | A | 1257 | −31.797 | 11.864 | −7.577 | 1.00 | 1.00 | C |
| ATOM | 4476 | CD1 | TYR | A | 1257 | −31.758 | 12.647 | −6.399 | 1.00 | 1.00 | C |
| ATOM | 4477 | CD2 | TYR | A | 1257 | −31.745 | 12.544 | −8.790 | 1.00 | 1.00 | C |
| ATOM | 4478 | CE1 | TYR | A | 1257 | −31.523 | 14.046 | −6.421 | 1.00 | 1.00 | C |
| ATOM | 4479 | CE2 | TYR | A | 1257 | −31.625 | 13.951 | −8.818 | 1.00 | 1.00 | C |
| ATOM | 4480 | CZ | TYR | A | 1257 | −31.498 | 14.679 | −7.670 | 1.00 | 1.00 | C |
| ATOM | 4481 | OH | TYR | A | 1257 | −31.310 | 16.032 | −7.730 | 1.00 | 1.00 | O |
| ATOM | 4482 | HA | TYR | A | 1257 | −30.222 | 9.938 | −8.733 | 1.00 | 1.00 | H |
| ATOM | 4483 | HB2 | TYR | A | 1257 | −32.573 | 9.986 | −8.268 | 1.00 | 1.00 | H |
| ATOM | 4484 | HB1 | TYR | A | 1257 | −32.477 | 10.194 | −6.548 | 1.00 | 1.00 | H |
| ATOM | 4485 | HD2 | TYR | A | 1257 | −31.721 | 12.005 | −9.733 | 1.00 | 1.00 | H |
| ATOM | 4486 | HE2 | TYR | A | 1257 | −31.601 | 14.408 | −9.765 | 1.00 | 1.00 | H |
| ATOM | 4487 | HE1 | TYR | A | 1257 | −31.439 | 14.609 | −5.487 | 1.00 | 1.00 | H |
| ATOM | 4488 | HD1 | TYR | A | 1257 | −31.816 | 12.167 | −5.464 | 1.00 | 1.00 | H |
| ATOM | 4489 | HH | TYR | A | 1257 | −30.667 | 16.358 | −8.335 | 1.00 | 1.00 | H |
| ATOM | 4490 | HN | TYR | A | 1257 | −30.440 | 7.600 | −8.494 | 1.00 | 1.00 | H |
| ATOM | 4491 | N | GLY | A | 1258 | −29.761 | 10.022 | −5.414 | 1.00 | 1.00 | N |
| ATOM | 4492 | CA | GLY | A | 1258 | −28.692 | 10.385 | −4.448 | 1.00 | 1.00 | C |
| ATOM | 4493 | C | GLY | A | 1258 | −28.375 | 11.873 | −4.506 | 1.00 | 1.00 | C |
| ATOM | 4494 | O | GLY | A | 1258 | −28.927 | 12.584 | −3.689 | 1.00 | 1.00 | O |
| ATOM | 4495 | HA2 | GLY | A | 1258 | −27.792 | 9.855 | −4.748 | 1.00 | 1.00 | H |
| ATOM | 4496 | HA1 | GLY | A | 1258 | −28.996 | 10.030 | −3.450 | 1.00 | 1.00 | H |
| ATOM | 4497 | HN | GLY | A | 1258 | −30.604 | 9.688 | −4.997 | 1.00 | 1.00 | H |
| ATOM | 4498 | N | SER | A | 1259 | −27.499 | 12.346 | −5.411 | 1.00 | 1.00 | N |
| ATOM | 4499 | CA | SER | A | 1259 | −27.186 | 13.765 | −5.525 | 1.00 | 1.00 | C |
| ATOM | 4500 | C | SER | A | 1259 | −26.784 | 14.193 | −6.919 | 1.00 | 1.00 | C |
| ATOM | 4501 | O | SER | A | 1259 | −25.603 | 14.421 | −7.139 | 1.00 | 1.00 | O |
| ATOM | 4502 | CB | SER | A | 1259 | −26.135 | 13.929 | −4.449 | 1.00 | 1.00 | C |
| ATOM | 4503 | OG | SER | A | 1259 | −25.726 | 15.265 | −4.261 | 1.00 | 1.00 | O |
| ATOM | 4504 | HA | SER | A | 1259 | −28.079 | 14.438 | −5.359 | 1.00 | 1.00 | H |
| ATOM | 4505 | HB1 | SER | A | 1259 | −26.503 | 13.602 | −3.463 | 1.00 | 1.00 | H |
| ATOM | 4506 | HB2 | SER | A | 1259 | −25.234 | 13.296 | −4.655 | 1.00 | 1.00 | H |
| ATOM | 4507 | HG | SER | A | 1259 | −24.939 | 15.400 | −3.744 | 1.00 | 1.00 | H |
| ATOM | 4508 | HN | SER | A | 1259 | −27.031 | 11.668 | −6.025 | 1.00 | 1.00 | H |
| ATOM | 4509 | N | LEU | A | 1260 | −27.670 | 14.348 | −7.920 | 1.00 | 1.00 | N |
| ATOM | 4510 | CA | LEU | A | 1260 | −27.251 | 14.602 | −9.326 | 1.00 | 1.00 | C |
| ATOM | 4511 | C | LEU | A | 1260 | −28.127 | 15.660 | −9.896 | 1.00 | 1.00 | C |
| ATOM | 4512 | O | LEU | A | 1260 | −29.216 | 15.837 | −9.386 | 1.00 | 1.00 | O |
| ATOM | 4513 | CB | LEU | A | 1260 | −27.453 | 13.336 | −10.159 | 1.00 | 1.00 | C |
| ATOM | 4514 | CG | LEU | A | 1260 | −26.534 | 12.123 | −9.882 | 1.00 | 1.00 | C |
| ATOM | 4515 | CD1 | LEU | A | 1260 | −27.167 | 10.904 | −10.581 | 1.00 | 1.00 | C |
| ATOM | 4516 | CD2 | LEU | A | 1260 | −25.110 | 12.492 | −10.348 | 1.00 | 1.00 | C |
| ATOM | 4517 | HA | LEU | A | 1260 | −26.212 | 14.977 | −9.369 | 1.00 | 1.00 | H |
| ATOM | 4518 | HB1 | LEU | A | 1260 | −28.564 | 13.101 | −10.020 | 1.00 | 1.00 | H |
| ATOM | 4519 | HB2 | LEU | A | 1260 | −27.309 | 13.553 | −11.214 | 1.00 | 1.00 | H |
| ATOM | 4520 | HG | LEU | A | 1260 | −26.540 | 11.924 | −8.818 | 1.00 | 1.00 | H |
| ATOM | 4521 | HD21 | LEU | A | 1260 | −24.410 | 11.696 | −10.307 | 1.00 | 1.00 | H |
| ATOM | 4522 | HD22 | LEU | A | 1260 | −25.069 | 12.762 | −11.373 | 1.00 | 1.00 | H |
| ATOM | 4523 | HD23 | LEU | A | 1260 | −24.772 | 13.333 | −9.756 | 1.00 | 1.00 | H |
| ATOM | 4524 | HD11 | LEU | A | 1260 | −28.170 | 10.665 | −10.168 | 1.00 | 1.00 | H |
| ATOM | 4525 | HD12 | LEU | A | 1260 | −26.527 | 10.065 | −10.283 | 1.00 | 1.00 | H |
| ATOM | 4526 | HD13 | LEU | A | 1260 | −27.241 | 11.095 | −11.641 | 1.00 | 1.00 | H |
| ATOM | 4527 | HN | LEU | A | 1260 | −28.633 | 14.171 | −7.833 | 1.00 | 1.00 | H |
| ATOM | 4528 | N | PRO | A | 1261 | −27.729 | 16.463 | −10.910 | 1.00 | 1.00 | N |
| ATOM | 4529 | CA | PRO | A | 1261 | −26.389 | 16.398 | −11.523 | 1.00 | 1.00 | C |
| ATOM | 4530 | C | PRO | A | 1261 | −25.454 | 17.204 | −10.656 | 1.00 | 1.00 | C |
| ATOM | 4531 | O | PRO | A | 1261 | −25.834 | 18.231 | −10.072 | 1.00 | 1.00 | O |
| ATOM | 4532 | CB | PRO | A | 1261 | −26.611 | 17.107 | −12.864 | 1.00 | 1.00 | C |
| ATOM | 4533 | CG | PRO | A | 1261 | −27.849 | 18.026 | −12.657 | 1.00 | 1.00 | C |
| ATOM | 4534 | CD | PRO | A | 1261 | −28.726 | 17.329 | −11.559 | 1.00 | 1.00 | C |
| ATOM | 4535 | HA | PRO | A | 1261 | −26.055 | 15.320 | −11.752 | 1.00 | 1.00 | H |
| ATOM | 4536 | HD2 | PRO | A | 1261 | −29.537 | 16.707 | −12.022 | 1.00 | 1.00 | H |
| ATOM | 4537 | HD1 | PRO | A | 1261 | −29.206 | 18.072 | −10.907 | 1.00 | 1.00 | H |
| ATOM | 4538 | HG2 | PRO | A | 1261 | −28.450 | 18.046 | −13.575 | 1.00 | 1.00 | H |
| ATOM | 4539 | HG1 | PRO | A | 1261 | −27.584 | 19.051 | −12.393 | 1.00 | 1.00 | H |
| ATOM | 4540 | HB1 | PRO | A | 1261 | −25.760 | 17.687 | −13.203 | 1.00 | 1.00 | H |
| ATOM | 4541 | HB2 | PRO | A | 1261 | −26.854 | 16.363 | −13.671 | 1.00 | 1.00 | H |
| ATOM | 4542 | N | GLN | A | 1262 | −24.188 | 16.742 | −10.523 | 1.00 | 1.00 | N |
| ATOM | 4543 | CA | GLN | A | 1262 | −23.280 | 17.386 | −9.557 | 1.00 | 1.00 | C |
| ATOM | 4544 | C | GLN | A | 1262 | −23.026 | 18.855 | −9.780 | 1.00 | 1.00 | C |
| ATOM | 4545 | O | GLN | A | 1262 | −22.852 | 19.633 | −8.842 | 1.00 | 1.00 | O |
| ATOM | 4546 | CB | GLN | A | 1262 | −21.890 | 16.651 | −9.382 | 1.00 | 1.00 | C |
| ATOM | 4547 | CG | GLN | A | 1262 | −21.004 | 16.730 | −10.669 | 1.00 | 1.00 | C |
| ATOM | 4548 | CD | GLN | A | 1262 | −19.784 | 15.823 | −10.614 | 1.00 | 1.00 | C |
| ATOM | 4549 | OE1 | GLN | A | 1262 | −19.827 | 14.828 | −11.314 | 1.00 | 1.00 | O |
| ATOM | 4550 | NE2 | GLN | A | 1262 | −18.763 | 16.037 | −9.749 | 1.00 | 1.00 | N |
| ATOM | 4551 | HA | GLN | A | 1262 | −23.791 | 17.276 | −8.589 | 1.00 | 1.00 | H |
| ATOM | 4552 | HB1 | GLN | A | 1262 | −21.373 | 17.172 | −8.526 | 1.00 | 1.00 | H |
| ATOM | 4553 | HB2 | GLN | A | 1262 | −22.153 | 15.577 | −9.144 | 1.00 | 1.00 | H |
| ATOM | 4554 | HG1 | GLN | A | 1262 | −21.587 | 16.531 | −11.641 | 1.00 | 1.00 | H |
| ATOM | 4555 | HG2 | GLN | A | 1262 | −20.612 | 17.761 | −10.724 | 1.00 | 1.00 | H |
| ATOM | 4556 | HE22 | GLN | A | 1262 | −17.960 | 15.420 | −9.706 | 1.00 | 1.00 | H |
| ATOM | 4557 | HE21 | GLN | A | 1262 | −18.885 | 16.778 | −9.043 | 1.00 | 1.00 | H |
| ATOM | 4558 | HN | GLN | A | 1262 | −23.904 | 15.893 | −10.973 | 1.00 | 1.00 | H |
| ATOM | 4559 | N | ASP | A | 1263 | −23.099 | 19.292 | −11.079 | 1.00 | 1.00 | N |
| ATOM | 4560 | CA | ASP | A | 1263 | −22.915 | 20.739 | −11.346 | 1.00 | 1.00 | C |
| ATOM | 4561 | C | ASP | A | 1263 | −23.983 | 21.438 | −10.492 | 1.00 | 1.00 | C |
| ATOM | 4562 | O | ASP | A | 1263 | −23.726 | 22.359 | −9.720 | 1.00 | 1.00 | O |
| ATOM | 4563 | CB | ASP | A | 1263 | −23.033 | 21.137 | −12.797 | 1.00 | 1.00 | C |
| ATOM | 4564 | CG | ASP | A | 1263 | −22.690 | 22.569 | −12.921 | 1.00 | 1.00 | C |
| ATOM | 4565 | OD1 | ASP | A | 1263 | −23.240 | 23.312 | −13.738 | 1.00 | 1.00 | O |
| ATOM | 4566 | OD2 | ASP | A | 1263 | −21.842 | 23.056 | −12.148 | 1.00 | 1.00 | O |
| ATOM | 4567 | HA | ASP | A | 1263 | −21.915 | 21.048 | −11.048 | 1.00 | 1.00 | H |
| ATOM | 4568 | HB1 | ASP | A | 1263 | −22.359 | 20.439 | −13.333 | 1.00 | 1.00 | H |
| ATOM | 4569 | HB2 | ASP | A | 1263 | −24.061 | 20.949 | −13.100 | 1.00 | 1.00 | H |
| ATOM | 4570 | HN | ASP | A | 1263 | −23.278 | 18.674 | −11.837 | 1.00 | 1.00 | H |
| ATOM | 4571 | N | HIS | A | 1264 | −25.253 | 21.014 | −10.578 | 1.00 | 1.00 | N |
| ATOM | 4572 | CA | HIS | A | 1264 | −26.330 | 21.704 | −9.848 | 1.00 | 1.00 | C |
| ATOM | 4573 | C | HIS | A | 1264 | −26.414 | 21.361 | −8.355 | 1.00 | 1.00 | C |
| ATOM | 4574 | O | HIS | A | 1264 | −26.275 | 22.238 | −7.541 | 1.00 | 1.00 | O |
| ATOM | 4575 | CB | HIS | A | 1264 | −27.701 | 21.563 | −10.568 | 1.00 | 1.00 | C |
| ATOM | 4576 | CG | HIS | A | 1264 | −27.785 | 21.939 | −12.052 | 1.00 | 1.00 | C |
| ATOM | 4577 | ND1 | HIS | A | 1264 | −28.864 | 21.843 | −12.795 | 1.00 | 1.00 | N |
| ATOM | 4578 | CD2 | HIS | A | 1264 | −26.768 | 22.481 | −12.744 | 1.00 | 1.00 | C |
| ATOM | 4579 | CE1 | HIS | A | 1264 | −28.615 | 22.288 | −13.967 | 1.00 | 1.00 | C |
| ATOM | 4580 | NE2 | HIS | A | 1264 | −27.424 | 22.647 | −14.014 | 1.00 | 1.00 | N |
| ATOM | 4581 | HA | HIS | A | 1264 | −26.226 | 22.792 | −10.009 | 1.00 | 1.00 | H |
| ATOM | 4582 | HB1 | HIS | A | 1264 | −28.105 | 20.567 | −10.516 | 1.00 | 1.00 | H |
| ATOM | 4583 | HB2 | HIS | A | 1264 | −28.460 | 22.183 | −10.057 | 1.00 | 1.00 | H |
| ATOM | 4584 | HD2 | HIS | A | 1264 | −25.789 | 22.754 | −12.534 | 1.00 | 1.00 | H |
| ATOM | 4585 | HE1 | HIS | A | 1264 | −29.180 | 22.471 | −14.844 | 1.00 | 1.00 | H |
| ATOM | 4586 | HD1 | HIS | A | 1264 | −29.741 | 21.436 | −12.473 | 1.00 | 1.00 | H |
| ATOM | 4587 | HN | HIS | A | 1264 | −25.485 | 20.235 | −11.157 | 1.00 | 1.00 | H |
| ATOM | 4588 | N | ILE | A | 1265 | −26.756 | 20.088 | −8.011 | 1.00 | 1.00 | N |
| ATOM | 4589 | CA | ILE | A | 1265 | −27.074 | 19.753 | −6.596 | 1.00 | 1.00 | C |
| ATOM | 4590 | C | ILE | A | 1265 | −25.791 | 19.433 | −5.755 | 1.00 | 1.00 | C |
| ATOM | 4591 | O | ILE | A | 1265 | −25.956 | 18.986 | −4.623 | 1.00 | 1.00 | O |
| ATOM | 4592 | CB | ILE | A | 1265 | −28.145 | 18.576 | −6.535 | 1.00 | 1.00 | C |
| ATOM | 4593 | CG1 | ILE | A | 1265 | −28.878 | 18.641 | −5.160 | 1.00 | 1.00 | C |
| ATOM | 4594 | CG2 | ILE | A | 1265 | −27.527 | 17.186 | −6.849 | 1.00 | 1.00 | C |
| ATOM | 4595 | CD1 | ILE | A | 1265 | −29.984 | 17.571 | −5.136 | 1.00 | 1.00 | C |
| ATOM | 4596 | HA | ILE | A | 1265 | −27.555 | 20.668 | −6.132 | 1.00 | 1.00 | H |
| ATOM | 4597 | HB | ILE | A | 1265 | −28.842 | 18.816 | −7.332 | 1.00 | 1.00 | H |
| ATOM | 4598 | HG11 | ILE | A | 1265 | −28.222 | 18.343 | −4.283 | 1.00 | 1.00 | H |
| ATOM | 4599 | HG12 | ILE | A | 1265 | −29.285 | 19.621 | −4.927 | 1.00 | 1.00 | H |
| ATOM | 4600 | HD11 | ILE | A | 1265 | −30.563 | 17.540 | −4.183 | 1.00 | 1.00 | H |
| ATOM | 4601 | HD12 | ILE | A | 1265 | −30.678 | 17.779 | −5.947 | 1.00 | 1.00 | H |
| ATOM | 4602 | HD13 | ILE | A | 1265 | −29.572 | 16.577 | −5.395 | 1.00 | 1.00 | H |
| ATOM | 4603 | HG21 | ILE | A | 1265 | −27.151 | 16.741 | −5.952 | 1.00 | 1.00 | H |
| ATOM | 4604 | HG22 | ILE | A | 1265 | −28.329 | 16.640 | −7.355 | 1.00 | 1.00 | H |
| ATOM | 4605 | HG23 | ILE | A | 1265 | −26.716 | 17.395 | −7.579 | 1.00 | 1.00 | H |
| ATOM | 4606 | HN | ILE | A | 1265 | −26.753 | 19.377 | −8.699 | 1.00 | 1.00 | H |
| ATOM | 4607 | N | ILE | A | 1266 | −24.576 | 19.767 | −6.300 | 1.00 | 1.00 | N |
| ATOM | 4608 | CA | ILE | A | 1266 | −23.394 | 19.877 | −5.494 | 1.00 | 1.00 | C |
| ATOM | 4609 | C | ILE | A | 1266 | −22.687 | 21.188 | −5.757 | 1.00 | 1.00 | C |
| ATOM | 4610 | O | ILE | A | 1266 | −22.428 | 21.904 | −4.809 | 1.00 | 1.00 | O |
| ATOM | 4611 | CB | ILE | A | 1266 | −22.313 | 18.730 | −5.593 | 1.00 | 1.00 | C |
| ATOM | 4612 | CG1 | ILE | A | 1266 | −23.000 | 17.416 | −5.240 | 1.00 | 1.00 | C |
| ATOM | 4613 | CG2 | ILE | A | 1266 | −21.076 | 19.059 | −4.673 | 1.00 | 1.00 | C |
| ATOM | 4614 | CD1 | ILE | A | 1266 | −22.118 | 16.139 | −5.224 | 1.00 | 1.00 | C |
| ATOM | 4615 | HA | ILE | A | 1266 | −23.680 | 19.931 | −4.466 | 1.00 | 1.00 | H |
| ATOM | 4616 | HB | ILE | A | 1266 | −21.833 | 18.720 | −6.591 | 1.00 | 1.00 | H |
| ATOM | 4617 | HG11 | ILE | A | 1266 | −23.452 | 17.489 | −4.219 | 1.00 | 1.00 | H |
| ATOM | 4618 | HG12 | ILE | A | 1266 | −23.837 | 17.199 | −5.904 | 1.00 | 1.00 | H |
| ATOM | 4619 | HD11 | ILE | A | 1266 | −21.575 | 16.062 | −6.151 | 1.00 | 1.00 | H |
| ATOM | 4620 | HD12 | ILE | A | 1266 | −21.409 | 16.196 | −4.393 | 1.00 | 1.00 | H |
| ATOM | 4621 | HD13 | ILE | A | 1266 | −22.824 | 15.284 | −5.074 | 1.00 | 1.00 | H |
| ATOM | 4622 | HG21 | ILE | A | 1266 | −20.327 | 18.235 | −4.775 | 1.00 | 1.00 | H |
| ATOM | 4623 | HG22 | ILE | A | 1266 | −20.522 | 19.980 | −4.891 | 1.00 | 1.00 | H |
| ATOM | 4624 | HG23 | ILE | A | 1266 | −21.490 | 19.157 | −3.669 | 1.00 | 1.00 | H |
| ATOM | 4625 | HN | ILE | A | 1266 | −24.454 | 20.019 | −7.282 | 1.00 | 1.00 | H |
| ATOM | 4626 | N | GLN | A | 1267 | −22.348 | 21.576 | −7.045 | 1.00 | 1.00 | N |
| ATOM | 4627 | CA | GLN | A | 1267 | −21.567 | 22.786 | −7.244 | 1.00 | 1.00 | C |
| ATOM | 4628 | C | GLN | A | 1267 | −22.368 | 24.018 | −7.125 | 1.00 | 1.00 | C |
| ATOM | 4629 | O | GLN | A | 1267 | −21.944 | 24.996 | −6.479 | 1.00 | 1.00 | O |
| ATOM | 4630 | CB | GLN | A | 1267 | −20.708 | 22.772 | −8.553 | 1.00 | 1.00 | C |
| ATOM | 4631 | CG | GLN | A | 1267 | −19.626 | 21.634 | −8.437 | 1.00 | 1.00 | C |
| ATOM | 4632 | CD | GLN | A | 1267 | −18.789 | 21.975 | −7.231 | 1.00 | 1.00 | C |
| ATOM | 4633 | OE1 | GLN | A | 1267 | −18.459 | 23.122 | −7.041 | 1.00 | 1.00 | O |
| ATOM | 4634 | NE2 | GLN | A | 1267 | −18.464 | 21.005 | −6.337 | 1.00 | 1.00 | N |
| ATOM | 4635 | HA | GLN | A | 1267 | −20.919 | 22.842 | −6.410 | 1.00 | 1.00 | H |
| ATOM | 4636 | HB1 | GLN | A | 1267 | −21.265 | 22.528 | −9.441 | 1.00 | 1.00 | H |
| ATOM | 4637 | HB2 | GLN | A | 1267 | −20.177 | 23.704 | −8.782 | 1.00 | 1.00 | H |
| ATOM | 4638 | HG1 | GLN | A | 1267 | −20.115 | 20.664 | −8.294 | 1.00 | 1.00 | H |
| ATOM | 4639 | HG2 | GLN | A | 1267 | −19.032 | 21.526 | −9.379 | 1.00 | 1.00 | H |
| ATOM | 4640 | HE22 | GLN | A | 1267 | −17.946 | 21.314 | −5.553 | 1.00 | 1.00 | H |
| ATOM | 4641 | HE21 | GLN | A | 1267 | −18.690 | 20.022 | −6.416 | 1.00 | 1.00 | H |
| ATOM | 4642 | HN | GLN | A | 1267 | −22.537 | 21.007 | −7.827 | 1.00 | 1.00 | H |
| ATOM | 4643 | N | LYS | A | 1268 | −23.614 | 24.109 | −7.736 | 1.00 | 1.00 | N |
| ATOM | 4644 | CA | LYS | A | 1268 | −24.357 | 25.351 | −7.569 | 1.00 | 1.00 | C |
| ATOM | 4645 | C | LYS | A | 1268 | −24.857 | 25.458 | −6.151 | 1.00 | 1.00 | C |
| ATOM | 4646 | O | LYS | A | 1268 | −24.789 | 26.481 | −5.511 | 1.00 | 1.00 | O |
| ATOM | 4647 | CB | LYS | A | 1268 | −25.425 | 25.527 | −8.724 | 1.00 | 1.00 | C |
| ATOM | 4648 | CG | LYS | A | 1268 | −24.847 | 26.163 | −10.048 | 1.00 | 1.00 | C |
| ATOM | 4649 | CD | LYS | A | 1268 | −23.759 | 25.354 | −10.762 | 1.00 | 1.00 | C |
| ATOM | 4650 | CE | LYS | A | 1268 | −23.152 | 26.182 | −11.950 | 1.00 | 1.00 | C |
| ATOM | 4651 | NZ | LYS | A | 1268 | −22.147 | 25.335 | −12.718 | 1.00 | 1.00 | N |
| ATOM | 4652 | HA | LYS | A | 1268 | −23.745 | 26.170 | −7.689 | 1.00 | 1.00 | H |
| ATOM | 4653 | HB1 | LYS | A | 1268 | −25.957 | 24.564 | −8.808 | 1.00 | 1.00 | H |
| ATOM | 4654 | HB2 | LYS | A | 1268 | −26.193 | 26.274 | −8.333 | 1.00 | 1.00 | H |
| ATOM | 4655 | HG1 | LYS | A | 1268 | −25.689 | 26.211 | −10.742 | 1.00 | 1.00 | H |
| ATOM | 4656 | HG2 | LYS | A | 1268 | −24.533 | 27.183 | −9.906 | 1.00 | 1.00 | H |
| ATOM | 4657 | HD1 | LYS | A | 1268 | −23.018 | 25.071 | −10.011 | 1.00 | 1.00 | H |
| ATOM | 4658 | HD2 | LYS | A | 1268 | −24.142 | 24.415 | −11.186 | 1.00 | 1.00 | H |
| ATOM | 4659 | HE1 | LYS | A | 1268 | −23.990 | 26.514 | −12.597 | 1.00 | 1.00 | H |
| ATOM | 4660 | HE2 | LYS | A | 1268 | −22.684 | 27.098 | −11.586 | 1.00 | 1.00 | H |
| ATOM | 4661 | HZ1 | LYS | A | 1268 | −21.538 | 24.673 | −12.118 | 1.00 | 1.00 | H |
| ATOM | 4662 | HZ2 | LYS | A | 1268 | −22.571 | 24.768 | −13.502 | 1.00 | 1.00 | H |
| ATOM | 4663 | HZ3 | LYS | A | 1268 | −21.373 | 26.022 | −13.128 | 1.00 | 1.00 | H |
| ATOM | 4664 | HN | LYS | A | 1268 | −23.953 | 23.326 | −8.303 | 1.00 | 1.00 | H |
| ATOM | 4665 | N | ILE | A | 1269 | −25.405 | 24.379 | −5.510 | 1.00 | 1.00 | N |
| ATOM | 4666 | CA | ILE | A | 1269 | −25.536 | 24.397 | −4.075 | 1.00 | 1.00 | C |
| ATOM | 4667 | C | ILE | A | 1269 | −24.207 | 24.774 | −3.362 | 1.00 | 1.00 | C |
| ATOM | 4668 | O | ILE | A | 1269 | −24.263 | 25.511 | −2.388 | 1.00 | 1.00 | O |
| ATOM | 4669 | CB | ILE | A | 1269 | −26.398 | 23.233 | −3.442 | 1.00 | 1.00 | C |
| ATOM | 4670 | CG1 | ILE | A | 1269 | −25.644 | 21.926 | −3.454 | 1.00 | 1.00 | C |
| ATOM | 4671 | CG2 | ILE | A | 1269 | −27.807 | 23.040 | −3.988 | 1.00 | 1.00 | C |
| ATOM | 4672 | CD1 | ILE | A | 1269 | −26.489 | 20.824 | −2.726 | 1.00 | 1.00 | C |
| ATOM | 4673 | HA | ILE | A | 1269 | −26.219 | 25.238 | −3.847 | 1.00 | 1.00 | H |
| ATOM | 4674 | HB | ILE | A | 1269 | −26.524 | 23.472 | −2.357 | 1.00 | 1.00 | H |
| ATOM | 4675 | HG11 | ILE | A | 1269 | −25.476 | 21.677 | −4.494 | 1.00 | 1.00 | H |
| ATOM | 4676 | HG12 | ILE | A | 1269 | −24.670 | 22.106 | −2.995 | 1.00 | 1.00 | H |
| ATOM | 4677 | HD11 | ILE | A | 1269 | −27.290 | 20.427 | −3.327 | 1.00 | 1.00 | H |
| ATOM | 4678 | HD12 | ILE | A | 1269 | −25.856 | 20.001 | −2.525 | 1.00 | 1.00 | H |
| ATOM | 4679 | HD13 | ILE | A | 1269 | −26.893 | 21.125 | −1.724 | 1.00 | 1.00 | H |
| ATOM | 4680 | HG21 | ILE | A | 1269 | −27.645 | 22.850 | −5.051 | 1.00 | 1.00 | H |
| ATOM | 4681 | HG22 | ILE | A | 1269 | −28.453 | 22.275 | −3.523 | 1.00 | 1.00 | H |
| ATOM | 4682 | HG23 | ILE | A | 1269 | −28.310 | 23.987 | −3.895 | 1.00 | 1.00 | H |
| ATOM | 4683 | HN | ILE | A | 1269 | −25.572 | 23.569 | −6.085 | 1.00 | 1.00 | H |
| ATOM | 4684 | N | LYS | A | 1270 | −22.998 | 24.367 | −3.808 | 1.00 | 1.00 | N |
| ATOM | 4685 | CA | LYS | A | 1270 | −21.745 | 24.846 | −3.219 | 1.00 | 1.00 | C |
| ATOM | 4686 | C | LYS | A | 1270 | −21.699 | 26.323 | −3.332 | 1.00 | 1.00 | C |
| ATOM | 4687 | O | LYS | A | 1270 | −21.368 | 27.008 | −2.367 | 1.00 | 1.00 | O |
| ATOM | 4688 | CB | LYS | A | 1270 | −20.488 | 24.170 | −3.815 | 1.00 | 1.00 | C |
| ATOM | 4689 | CG | LYS | A | 1270 | −19.062 | 24.642 | −3.403 | 1.00 | 1.00 | C |
| ATOM | 4690 | CD | LYS | A | 1270 | −18.692 | 26.089 | −3.852 | 1.00 | 1.00 | C |
| ATOM | 4691 | CE | LYS | A | 1270 | −18.816 | 26.359 | −5.398 | 1.00 | 1.00 | C |
| ATOM | 4692 | NZ | LYS | A | 1270 | −17.843 | 25.701 | −6.342 | 1.00 | 1.00 | N |
| ATOM | 4693 | HA | LYS | A | 1270 | −21.706 | 24.621 | −2.133 | 1.00 | 1.00 | H |
| ATOM | 4694 | HB1 | LYS | A | 1270 | −20.529 | 23.122 | −3.480 | 1.00 | 1.00 | H |
| ATOM | 4695 | HB2 | LYS | A | 1270 | −20.388 | 24.144 | −4.864 | 1.00 | 1.00 | H |
| ATOM | 4696 | HG1 | LYS | A | 1270 | −18.876 | 24.479 | −2.314 | 1.00 | 1.00 | H |
| ATOM | 4697 | HG2 | LYS | A | 1270 | −18.323 | 24.018 | −3.912 | 1.00 | 1.00 | H |
| ATOM | 4698 | HD1 | LYS | A | 1270 | −19.276 | 26.822 | −3.296 | 1.00 | 1.00 | H |
| ATOM | 4699 | HD2 | LYS | A | 1270 | −17.622 | 26.268 | −3.540 | 1.00 | 1.00 | H |
| ATOM | 4700 | HE1 | LYS | A | 1270 | −19.788 | 26.149 | −5.863 | 1.00 | 1.00 | H |
| ATOM | 4701 | HE2 | LYS | A | 1270 | −18.721 | 27.447 | −5.542 | 1.00 | 1.00 | H |
| ATOM | 4702 | HZ1 | LYS | A | 1270 | −17.731 | 26.159 | −7.315 | 1.00 | 1.00 | H |
| ATOM | 4703 | HZ2 | LYS | A | 1270 | −16.873 | 25.946 | −6.065 | 1.00 | 1.00 | H |
| ATOM | 4704 | HZ3 | LYS | A | 1270 | −17.841 | 24.633 | −6.358 | 1.00 | 1.00 | H |
| ATOM | 4705 | HN | LYS | A | 1270 | −22.915 | 23.714 | −4.596 | 1.00 | 1.00 | H |
| ATOM | 4706 | N | GLU | A | 1271 | −22.134 | 26.979 | −4.458 | 1.00 | 1.00 | N |
| ATOM | 4707 | CA | GLU | A | 1271 | −22.408 | 28.402 | −4.462 | 1.00 | 1.00 | C |
| ATOM | 4708 | C | GLU | A | 1271 | −23.162 | 28.805 | −3.230 | 1.00 | 1.00 | C |
| ATOM | 4709 | O | GLU | A | 1271 | −22.599 | 29.692 | −2.598 | 1.00 | 1.00 | O |
| ATOM | 4710 | CB | GLU | A | 1271 | −22.928 | 29.016 | −5.806 | 1.00 | 1.00 | C |
| ATOM | 4711 | CG | GLU | A | 1271 | −24.374 | 29.519 | −5.829 | 1.00 | 1.00 | C |
| ATOM | 4712 | CD | GLU | A | 1271 | −24.500 | 30.969 | −5.382 | 1.00 | 1.00 | C |
| ATOM | 4713 | OE1 | GLU | A | 1271 | −23.748 | 31.432 | −4.489 | 1.00 | 1.00 | O |
| ATOM | 4714 | OE2 | GLU | A | 1271 | −25.377 | 31.706 | −5.866 | 1.00 | 1.00 | O |
| ATOM | 4715 | HA | GLU | A | 1271 | −21.391 | 28.822 | −4.345 | 1.00 | 1.00 | H |
| ATOM | 4716 | HB1 | GLU | A | 1271 | −22.931 | 28.302 | −6.614 | 1.00 | 1.00 | H |
| ATOM | 4717 | HB2 | GLU | A | 1271 | −22.353 | 29.882 | −6.162 | 1.00 | 1.00 | H |
| ATOM | 4718 | HG1 | GLU | A | 1271 | −24.752 | 29.499 | −6.897 | 1.00 | 1.00 | H |
| ATOM | 4719 | HG2 | GLU | A | 1271 | −25.039 | 28.861 | −5.281 | 1.00 | 1.00 | H |
| ATOM | 4720 | HN | GLU | A | 1271 | −22.287 | 26.431 | −5.283 | 1.00 | 1.00 | H |
| ATOM | 4721 | N | CYS | A | 1272 | −24.377 | 28.177 | −2.953 | 1.00 | 1.00 | N |
| ATOM | 4722 | CA | CYS | A | 1272 | −25.028 | 28.618 | −1.728 | 1.00 | 1.00 | C |
| ATOM | 4723 | C | CYS | A | 1272 | −24.019 | 28.778 | −0.634 | 1.00 | 1.00 | C |
| ATOM | 4724 | O | CYS | A | 1272 | −23.905 | 29.881 | −0.068 | 1.00 | 1.00 | O |
| ATOM | 4725 | CB | CYS | A | 1272 | −26.287 | 27.868 | −1.090 | 1.00 | 1.00 | C |
| ATOM | 4726 | SG | CYS | A | 1272 | −26.038 | 26.266 | −0.273 | 1.00 | 1.00 | S |
| ATOM | 4727 | HA | CYS | A | 1272 | −25.479 | 29.580 | −1.983 | 1.00 | 1.00 | H |
| ATOM | 4728 | HB1 | CYS | A | 1272 | −27.037 | 27.708 | −1.889 | 1.00 | 1.00 | H |
| ATOM | 4729 | HB2 | CYS | A | 1272 | −26.851 | 28.515 | −0.364 | 1.00 | 1.00 | H |
| ATOM | 4730 | HN | CYS | A | 1272 | −24.742 | 27.449 | −3.500 | 1.00 | 1.00 | H |
| ATOM | 4731 | N | PHE | A | 1273 | −23.218 | 27.701 | −0.319 | 1.00 | 1.00 | N |
| ATOM | 4732 | CA | PHE | A | 1273 | −22.126 | 27.837 | 0.652 | 1.00 | 1.00 | C |
| ATOM | 4733 | C | PHE | A | 1273 | −21.307 | 29.088 | 0.340 | 1.00 | 1.00 | C |
| ATOM | 4734 | O | PHE | A | 1273 | −21.192 | 29.971 | 1.188 | 1.00 | 1.00 | O |
| ATOM | 4735 | CB | PHE | A | 1273 | −21.253 | 26.564 | 0.608 | 1.00 | 1.00 | C |
| ATOM | 4736 | CG | PHE | A | 1273 | −19.840 | 26.746 | 1.152 | 1.00 | 1.00 | C |
| ATOM | 4737 | CD1 | PHE | A | 1273 | −19.619 | 27.238 | 2.433 | 1.00 | 1.00 | C |
| ATOM | 4738 | CD2 | PHE | A | 1273 | −18.685 | 26.442 | 0.409 | 1.00 | 1.00 | C |
| ATOM | 4739 | CE1 | PHE | A | 1273 | −18.356 | 27.482 | 2.917 | 1.00 | 1.00 | C |
| ATOM | 4740 | CE2 | PHE | A | 1273 | −17.392 | 26.603 | 0.952 | 1.00 | 1.00 | C |
| ATOM | 4741 | CZ | PHE | A | 1273 | −17.228 | 27.227 | 2.183 | 1.00 | 1.00 | C |
| ATOM | 4742 | HA | PHE | A | 1273 | −22.454 | 28.073 | 1.656 | 1.00 | 1.00 | H |
| ATOM | 4743 | HB1 | PHE | A | 1273 | −21.021 | 26.253 | −0.433 | 1.00 | 1.00 | H |
| ATOM | 4744 | HB2 | PHE | A | 1273 | −21.839 | 25.724 | 1.065 | 1.00 | 1.00 | H |
| ATOM | 4745 | HD2 | PHE | A | 1273 | −18.776 | 26.146 | −0.609 | 1.00 | 1.00 | H |
| ATOM | 4746 | HE2 | PHE | A | 1273 | −16.550 | 26.261 | 0.441 | 1.00 | 1.00 | H |
| ATOM | 4747 | HZ | PHE | A | 1273 | −16.332 | 27.509 | 2.645 | 1.00 | 1.00 | H |
| ATOM | 4748 | HE1 | PHE | A | 1273 | −18.212 | 27.892 | 3.911 | 1.00 | 1.00 | H |
| ATOM | 4749 | HD1 | PHE | A | 1273 | −20.413 | 27.389 | 3.153 | 1.00 | 1.00 | H |
| ATOM | 4750 | HN | PHE | A | 1273 | −23.401 | 26.877 | −0.828 | 1.00 | 1.00 | H |
| ATOM | 4751 | N | ARG | A | 1274 | −20.694 | 29.098 | −0.853 | 1.00 | 1.00 | N |
| ATOM | 4752 | CA | ARG | A | 1274 | −19.579 | 30.021 | −0.925 | 1.00 | 1.00 | C |
| ATOM | 4753 | C | ARG | A | 1274 | −20.163 | 31.425 | −0.719 | 1.00 | 1.00 | C |
| ATOM | 4754 | O | ARG | A | 1274 | −19.492 | 32.211 | −0.080 | 1.00 | 1.00 | O |
| ATOM | 4755 | CB | ARG | A | 1274 | −18.682 | 29.902 | −2.184 | 1.00 | 1.00 | C |
| ATOM | 4756 | CG | ARG | A | 1274 | −17.410 | 30.836 | −2.132 | 1.00 | 1.00 | C |
| ATOM | 4757 | CD | ARG | A | 1274 | −16.402 | 30.500 | −0.986 | 1.00 | 1.00 | C |
| ATOM | 4758 | NE | ARG | A | 1274 | −15.137 | 31.089 | −1.376 | 1.00 | 1.00 | N |
| ATOM | 4759 | CZ | ARG | A | 1274 | −13.912 | 30.624 | −1.146 | 1.00 | 1.00 | C |
| ATOM | 4760 | NH1 | ARG | A | 1274 | −13.583 | 29.569 | −0.395 | 1.00 | 1.00 | N |
| ATOM | 4761 | NH2 | ARG | A | 1274 | −12.938 | 31.256 | −1.722 | 1.00 | 1.00 | N |
| ATOM | 4762 | HA | ARG | A | 1274 | −18.858 | 29.846 | −0.105 | 1.00 | 1.00 | H |
| ATOM | 4763 | HB1 | ARG | A | 1274 | −19.333 | 30.210 | −2.995 | 1.00 | 1.00 | H |
| ATOM | 4764 | HB2 | ARG | A | 1274 | −18.353 | 28.852 | −2.354 | 1.00 | 1.00 | H |
| ATOM | 4765 | HG1 | ARG | A | 1274 | −17.689 | 31.915 | −2.089 | 1.00 | 1.00 | H |
| ATOM | 4766 | HG2 | ARG | A | 1274 | −16.919 | 30.664 | −3.134 | 1.00 | 1.00 | H |
| ATOM | 4767 | HD1 | ARG | A | 1274 | −16.351 | 29.381 | −1.000 | 1.00 | 1.00 | H |
| ATOM | 4768 | HD2 | ARG | A | 1274 | −16.685 | 30.950 | 0.001 | 1.00 | 1.00 | H |
| ATOM | 4769 | HE | ARG | A | 1274 | −15.196 | 31.983 | −1.860 | 1.00 | 1.00 | H |
| ATOM | 4770 | HH12 | ARG | A | 1274 | −12.634 | 29.263 | −0.260 | 1.00 | 1.00 | H |
| ATOM | 4771 | HH11 | ARG | A | 1274 | −14.328 | 28.981 | −0.018 | 1.00 | 1.00 | H |
| ATOM | 4772 | HH22 | ARG | A | 1274 | −12.016 | 30.905 | −1.563 | 1.00 | 1.00 | H |
| ATOM | 4773 | HH21 | ARG | A | 1274 | −13.043 | 32.123 | −2.304 | 1.00 | 1.00 | H |
| ATOM | 4774 | HN | ARG | A | 1274 | −20.789 | 28.397 | −1.533 | 1.00 | 1.00 | H |
| ATOM | 4775 | N | LYS | A | 1275 | −21.373 | 31.708 | −1.231 | 1.00 | 1.00 | N |
| ATOM | 4776 | CA | LYS | A | 1275 | −21.857 | 33.144 | −1.277 | 1.00 | 1.00 | C |
| ATOM | 4777 | C | LYS | A | 1275 | −22.813 | 33.412 | −0.131 | 1.00 | 1.00 | C |
| ATOM | 4778 | O | LYS | A | 1275 | −23.423 | 34.485 | −0.106 | 1.00 | 1.00 | O |
| ATOM | 4779 | CB | LYS | A | 1275 | −22.345 | 33.517 | −2.687 | 1.00 | 1.00 | C |
| ATOM | 4780 | CG | LYS | A | 1275 | −22.401 | 35.015 | −3.034 | 1.00 | 1.00 | C |
| ATOM | 4781 | CD | LYS | A | 1275 | −23.367 | 35.262 | −4.262 | 1.00 | 1.00 | C |
| ATOM | 4782 | CE | LYS | A | 1275 | −22.855 | 34.715 | −5.616 | 1.00 | 1.00 | C |
| ATOM | 4783 | NZ | LYS | A | 1275 | −23.375 | 33.350 | −5.857 | 1.00 | 1.00 | N |
| ATOM | 4784 | HA | LYS | A | 1275 | −21.030 | 33.833 | −1.205 | 1.00 | 1.00 | H |
| ATOM | 4785 | HB1 | LYS | A | 1275 | −23.300 | 33.033 | −2.796 | 1.00 | 1.00 | H |
| ATOM | 4786 | HB2 | LYS | A | 1275 | −21.716 | 33.097 | −3.464 | 1.00 | 1.00 | H |
| ATOM | 4787 | HG1 | LYS | A | 1275 | −21.440 | 35.406 | −3.271 | 1.00 | 1.00 | H |
| ATOM | 4788 | HG2 | LYS | A | 1275 | −22.870 | 35.619 | −2.241 | 1.00 | 1.00 | H |
| ATOM | 4789 | HD1 | LYS | A | 1275 | −23.440 | 36.378 | −4.380 | 1.00 | 1.00 | H |
| ATOM | 4790 | HD2 | LYS | A | 1275 | −24.400 | 34.928 | −4.074 | 1.00 | 1.00 | H |
| ATOM | 4791 | HE1 | LYS | A | 1275 | −21.753 | 34.731 | −5.653 | 1.00 | 1.00 | H |
| ATOM | 4792 | HE2 | LYS | A | 1275 | −23.224 | 35.452 | −6.394 | 1.00 | 1.00 | H |
| ATOM | 4793 | HZ1 | LYS | A | 1275 | −24.403 | 33.206 | −5.742 | 1.00 | 1.00 | H |
| ATOM | 4794 | HZ2 | LYS | A | 1275 | −22.887 | 32.634 | −5.250 | 1.00 | 1.00 | H |
| ATOM | 4795 | HZ3 | LYS | A | 1275 | −23.085 | 33.074 | −6.889 | 1.00 | 1.00 | H |
| ATOM | 4796 | HN | LYS | A | 1275 | −22.017 | 31.066 | −1.644 | 1.00 | 1.00 | H |
| ATOM | 4797 | N | LEU | A | 1276 | −23.067 | 32.472 | 0.832 | 1.00 | 1.00 | N |
| ATOM | 4798 | CA | LEU | A | 1276 | −24.034 | 32.794 | 1.881 | 1.00 | 1.00 | C |
| ATOM | 4799 | C | LEU | A | 1276 | −23.840 | 34.182 | 2.478 | 1.00 | 1.00 | C |
| ATOM | 4800 | O | LEU | A | 1276 | −24.836 | 34.803 | 2.705 | 1.00 | 1.00 | O |
| ATOM | 4801 | CB | LEU | A | 1276 | −24.072 | 31.704 | 3.046 | 1.00 | 1.00 | C |
| ATOM | 4802 | CG | LEU | A | 1276 | −25.471 | 31.180 | 3.431 | 1.00 | 1.00 | C |
| ATOM | 4803 | CD1 | LEU | A | 1276 | −26.311 | 32.295 | 4.042 | 1.00 | 1.00 | C |
| ATOM | 4804 | CD2 | LEU | A | 1276 | −26.275 | 30.318 | 2.425 | 1.00 | 1.00 | C |
| ATOM | 4805 | HA | LEU | A | 1276 | −25.010 | 32.685 | 1.410 | 1.00 | 1.00 | H |
| ATOM | 4806 | HB1 | LEU | A | 1276 | −23.521 | 30.832 | 2.725 | 1.00 | 1.00 | H |
| ATOM | 4807 | HB2 | LEU | A | 1276 | −23.478 | 32.043 | 3.905 | 1.00 | 1.00 | H |
| ATOM | 4808 | HG | LEU | A | 1276 | −25.269 | 30.442 | 4.225 | 1.00 | 1.00 | H |
| ATOM | 4809 | HD21 | LEU | A | 1276 | −26.551 | 30.897 | 1.548 | 1.00 | 1.00 | H |
| ATOM | 4810 | HD22 | LEU | A | 1276 | −25.663 | 29.476 | 2.133 | 1.00 | 1.00 | H |
| ATOM | 4811 | HD23 | LEU | A | 1276 | −27.191 | 29.945 | 2.853 | 1.00 | 1.00 | H |
| ATOM | 4812 | HD11 | LEU | A | 1276 | −26.667 | 32.997 | 3.275 | 1.00 | 1.00 | H |
| ATOM | 4813 | HD12 | LEU | A | 1276 | −27.168 | 31.843 | 4.535 | 1.00 | 1.00 | H |
| ATOM | 4814 | HD13 | LEU | A | 1276 | −25.722 | 32.832 | 4.797 | 1.00 | 1.00 | H |
| ATOM | 4815 | HN | LEU | A | 1276 | −22.672 | 31.534 | 0.763 | 1.00 | 1.00 | H |
| ATOM | 4816 | N | PRO | A | 1277 | −22.620 | 34.703 | 2.794 | 1.00 | 1.00 | N |
| ATOM | 4817 | CA | PRO | A | 1277 | −22.479 | 35.984 | 3.442 | 1.00 | 1.00 | C |
| ATOM | 4818 | C | PRO | A | 1277 | −22.884 | 36.048 | 4.922 | 1.00 | 1.00 | C |
| ATOM | 4819 | O | PRO | A | 1277 | −23.209 | 37.099 | 5.413 | 1.00 | 1.00 | O |
| ATOM | 4820 | CB | PRO | A | 1277 | −20.923 | 36.184 | 3.310 | 1.00 | 1.00 | C |
| ATOM | 4821 | CG | PRO | A | 1277 | −20.345 | 34.757 | 3.209 | 1.00 | 1.00 | C |
| ATOM | 4822 | CD | PRO | A | 1277 | −21.418 | 33.956 | 2.494 | 1.00 | 1.00 | C |
| ATOM | 4823 | HA | PRO | A | 1277 | −22.953 | 36.812 | 2.941 | 1.00 | 1.00 | H |
| ATOM | 4824 | HD2 | PRO | A | 1277 | −21.494 | 32.912 | 2.770 | 1.00 | 1.00 | H |
| ATOM | 4825 | HD1 | PRO | A | 1277 | −21.124 | 34.112 | 1.465 | 1.00 | 1.00 | H |
| ATOM | 4826 | HG2 | PRO | A | 1277 | −20.242 | 34.391 | 4.261 | 1.00 | 1.00 | H |
| ATOM | 4827 | HG1 | PRO | A | 1277 | −19.359 | 34.682 | 2.736 | 1.00 | 1.00 | H |
| ATOM | 4828 | HB1 | PRO | A | 1277 | −20.663 | 36.739 | 2.400 | 1.00 | 1.00 | H |
| ATOM | 4829 | HB2 | PRO | A | 1277 | −20.556 | 36.732 | 4.196 | 1.00 | 1.00 | H |
| ATOM | 4830 | N | VAL | A | 1278 | −22.690 | 34.915 | 5.699 | 1.00 | 1.00 | N |
| ATOM | 4831 | CA | VAL | A | 1278 | −23.044 | 34.901 | 7.103 | 1.00 | 1.00 | C |
| ATOM | 4832 | C | VAL | A | 1278 | −24.554 | 34.810 | 7.284 | 1.00 | 1.00 | C |
| ATOM | 4833 | O | VAL | A | 1278 | −25.044 | 33.788 | 7.744 | 1.00 | 1.00 | O |
| ATOM | 4834 | CB | VAL | A | 1278 | −22.242 | 35.880 | 7.989 | 1.00 | 1.00 | C |
| ATOM | 4835 | CG1 | VAL | A | 1278 | −22.677 | 35.726 | 9.498 | 1.00 | 1.00 | C |
| ATOM | 4836 | CG2 | VAL | A | 1278 | −20.730 | 35.639 | 7.776 | 1.00 | 1.00 | C |
| ATOM | 4837 | HA | VAL | A | 1278 | −22.687 | 33.976 | 7.450 | 1.00 | 1.00 | H |
| ATOM | 4838 | HB | VAL | A | 1278 | −22.491 | 36.871 | 7.671 | 1.00 | 1.00 | H |
| ATOM | 4839 | HG11 | VAL | A | 1278 | −22.474 | 34.687 | 9.924 | 1.00 | 1.00 | H |
| ATOM | 4840 | HG12 | VAL | A | 1278 | −22.248 | 36.541 | 10.174 | 1.00 | 1.00 | H |
| ATOM | 4841 | HG13 | VAL | A | 1278 | −23.823 | 35.700 | 9.597 | 1.00 | 1.00 | H |
| ATOM | 4842 | HG21 | VAL | A | 1278 | −20.446 | 34.672 | 8.184 | 1.00 | 1.00 | H |
| ATOM | 4843 | HG22 | VAL | A | 1278 | −20.516 | 35.658 | 6.691 | 1.00 | 1.00 | H |
| ATOM | 4844 | HG23 | VAL | A | 1278 | −20.122 | 36.459 | 8.179 | 1.00 | 1.00 | H |
| ATOM | 4845 | HN | VAL | A | 1278 | −22.438 | 34.017 | 5.306 | 1.00 | 1.00 | H |
| ATOM | 4846 | N | ASN | A | 1279 | −25.220 | 35.925 | 6.932 | 1.00 | 1.00 | N |
| ATOM | 4847 | CA | ASN | A | 1279 | −26.686 | 35.935 | 6.993 | 1.00 | 1.00 | C |
| ATOM | 4848 | C | ASN | A | 1279 | −27.224 | 35.800 | 8.423 | 1.00 | 1.00 | C |
| ATOM | 4849 | O | ASN | A | 1279 | −27.783 | 36.760 | 8.868 | 1.00 | 1.00 | O |
| ATOM | 4850 | CB | ASN | A | 1279 | −27.343 | 34.900 | 6.086 | 1.00 | 1.00 | C |
| ATOM | 4851 | CG | ASN | A | 1279 | −28.812 | 35.143 | 6.189 | 1.00 | 1.00 | C |
| ATOM | 4852 | OD1 | ASN | A | 1279 | −29.348 | 36.154 | 5.752 | 1.00 | 1.00 | O |
| ATOM | 4853 | ND2 | ASN | A | 1279 | −29.582 | 34.219 | 6.717 | 1.00 | 1.00 | N |
| ATOM | 4854 | HA | ASN | A | 1279 | −26.933 | 36.968 | 6.736 | 1.00 | 1.00 | H |
| ATOM | 4855 | HB1 | ASN | A | 1279 | −27.081 | 35.007 | 5.001 | 1.00 | 1.00 | H |
| ATOM | 4856 | HB2 | ASN | A | 1279 | −27.014 | 33.909 | 6.372 | 1.00 | 1.00 | H |
| ATOM | 4857 | HD22 | ASN | A | 1279 | −29.182 | 33.457 | 7.260 | 1.00 | 1.00 | H |
| ATOM | 4858 | HD21 | ASN | A | 1279 | −30.512 | 34.488 | 6.813 | 1.00 | 1.00 | H |
| ATOM | 4859 | HN | ASN | A | 1279 | −24.791 | 36.746 | 6.529 | 1.00 | 1.00 | H |
| ATOM | 4860 | N | ARG | A | 1280 | −26.981 | 34.700 | 9.150 | 1.00 | 1.00 | N |
| ATOM | 4861 | CA | ARG | A | 1280 | −27.561 | 34.508 | 10.472 | 1.00 | 1.00 | C |
| ATOM | 4862 | C | ARG | A | 1280 | −26.852 | 35.337 | 11.541 | 1.00 | 1.00 | C |
| ATOM | 4863 | O | ARG | A | 1280 | −26.796 | 36.531 | 11.341 | 1.00 | 1.00 | O |
| ATOM | 4864 | CB | ARG | A | 1280 | −29.132 | 34.758 | 10.506 | 1.00 | 1.00 | C |
| ATOM | 4865 | CG | ARG | A | 1280 | −29.881 | 34.295 | 11.779 | 1.00 | 1.00 | C |
| ATOM | 4866 | CD | ARG | A | 1280 | −31.027 | 33.296 | 11.485 | 1.00 | 1.00 | C |
| ATOM | 4867 | NE | ARG | A | 1280 | −30.568 | 32.038 | 10.855 | 1.00 | 1.00 | N |
| ATOM | 4868 | CZ | ARG | A | 1280 | −31.330 | 31.094 | 10.461 | 1.00 | 1.00 | C |
| ATOM | 4869 | NH1 | ARG | A | 1280 | −32.659 | 31.124 | 10.547 | 1.00 | 1.00 | N |
| ATOM | 4870 | NH2 | ARG | A | 1280 | −30.810 | 30.013 | 9.918 | 1.00 | 1.00 | N |
| ATOM | 4871 | HA | ARG | A | 1280 | −27.373 | 33.457 | 10.683 | 1.00 | 1.00 | H |
| ATOM | 4872 | HB1 | ARG | A | 1280 | −29.623 | 34.288 | 9.668 | 1.00 | 1.00 | H |
| ATOM | 4873 | HB2 | ARG | A | 1280 | −29.306 | 35.811 | 10.414 | 1.00 | 1.00 | H |
| ATOM | 4874 | HG1 | ARG | A | 1280 | −29.128 | 33.779 | 12.441 | 1.00 | 1.00 | H |
| ATOM | 4875 | HG2 | ARG | A | 1280 | −30.193 | 35.226 | 12.335 | 1.00 | 1.00 | H |
| ATOM | 4876 | HD1 | ARG | A | 1280 | −31.409 | 33.099 | 12.485 | 1.00 | 1.00 | H |
| ATOM | 4877 | HD2 | ARG | A | 1280 | −31.762 | 33.853 | 10.863 | 1.00 | 1.00 | H |
| ATOM | 4878 | HE | ARG | A | 1280 | −29.569 | 31.926 | 10.706 | 1.00 | 1.00 | H |
| ATOM | 4879 | HH12 | ARG | A | 1280 | −33.243 | 30.327 | 10.265 | 1.00 | 1.00 | H |
| ATOM | 4880 | HH11 | ARG | A | 1280 | −33.169 | 31.878 | 10.997 | 1.00 | 1.00 | H |
| ATOM | 4881 | HH22 | ARG | A | 1280 | −31.380 | 29.292 | 9.535 | 1.00 | 1.00 | H |
| ATOM | 4882 | HH21 | ARG | A | 1280 | −29.798 | 29.869 | 9.857 | 1.00 | 1.00 | H |
| ATOM | 4883 | HN | ARG | A | 1280 | −26.387 | 34.023 | 8.749 | 1.00 | 1.00 | H |
| ATOM | 4884 | N | PRO | A | 1281 | −26.232 | 34.822 | 12.622 | 1.00 | 1.00 | N |
| ATOM | 4885 | CA | PRO | A | 1281 | −26.173 | 33.406 | 12.934 | 1.00 | 1.00 | C |
| ATOM | 4886 | C | PRO | A | 1281 | −25.129 | 32.840 | 12.082 | 1.00 | 1.00 | C |
| ATOM | 4887 | O | PRO | A | 1281 | −24.527 | 33.527 | 11.249 | 1.00 | 1.00 | O |
| ATOM | 4888 | CB | PRO | A | 1281 | −25.770 | 33.527 | 14.449 | 1.00 | 1.00 | C |
| ATOM | 4889 | CG | PRO | A | 1281 | −24.763 | 34.737 | 14.388 | 1.00 | 1.00 | C |
| ATOM | 4890 | CD | PRO | A | 1281 | −25.546 | 35.737 | 13.526 | 1.00 | 1.00 | C |
| ATOM | 4891 | HA | PRO | A | 1281 | −27.069 | 32.853 | 12.847 | 1.00 | 1.00 | H |
| ATOM | 4892 | HD2 | PRO | A | 1281 | −24.912 | 36.493 | 13.042 | 1.00 | 1.00 | H |
| ATOM | 4893 | HD1 | PRO | A | 1281 | −26.295 | 36.311 | 14.117 | 1.00 | 1.00 | H |
| ATOM | 4894 | HG2 | PRO | A | 1281 | −23.853 | 34.527 | 13.890 | 1.00 | 1.00 | H |
| ATOM | 4895 | HG1 | PRO | A | 1281 | −24.536 | 35.126 | 15.392 | 1.00 | 1.00 | H |
| ATOM | 4896 | HB1 | PRO | A | 1281 | −26.669 | 33.840 | 15.024 | 1.00 | 1.00 | H |
| ATOM | 4897 | HB2 | PRO | A | 1281 | −25.316 | 32.650 | 14.914 | 1.00 | 1.00 | H |
| ATOM | 4898 | N | ILE | A | 1282 | −24.846 | 31.537 | 12.266 | 1.00 | 1.00 | N |
| ATOM | 4899 | CA | ILE | A | 1282 | −23.810 | 30.838 | 11.489 | 1.00 | 1.00 | C |
| ATOM | 4900 | C | ILE | A | 1282 | −24.490 | 29.970 | 10.437 | 1.00 | 1.00 | C |
| ATOM | 4901 | O | ILE | A | 1282 | −24.272 | 28.768 | 10.407 | 1.00 | 1.00 | O |
| ATOM | 4902 | CB | ILE | A | 1282 | −22.785 | 30.072 | 12.346 | 1.00 | 1.00 | C |
| ATOM | 4903 | CG1 | ILE | A | 1282 | −22.350 | 30.966 | 13.551 | 1.00 | 1.00 | C |
| ATOM | 4904 | CG2 | ILE | A | 1282 | −21.588 | 29.657 | 11.506 | 1.00 | 1.00 | C |
| ATOM | 4905 | CD1 | ILE | A | 1282 | −21.409 | 30.255 | 14.535 | 1.00 | 1.00 | C |
| ATOM | 4906 | HA | ILE | A | 1282 | −23.193 | 31.650 | 10.949 | 1.00 | 1.00 | H |
| ATOM | 4907 | HB | ILE | A | 1282 | −23.201 | 29.188 | 12.872 | 1.00 | 1.00 | H |
| ATOM | 4908 | HG11 | ILE | A | 1282 | −21.840 | 31.868 | 13.147 | 1.00 | 1.00 | H |
| ATOM | 4909 | HG12 | ILE | A | 1282 | −23.266 | 31.263 | 14.120 | 1.00 | 1.00 | H |
| ATOM | 4910 | HD11 | ILE | A | 1282 | −21.481 | 30.761 | 15.516 | 1.00 | 1.00 | H |
| ATOM | 4911 | HD12 | ILE | A | 1282 | −21.639 | 29.125 | 14.694 | 1.00 | 1.00 | H |
| ATOM | 4912 | HD13 | ILE | A | 1282 | −20.369 | 30.325 | 14.136 | 1.00 | 1.00 | H |
| ATOM | 4913 | HG21 | ILE | A | 1282 | −20.854 | 29.038 | 12.065 | 1.00 | 1.00 | H |
| ATOM | 4914 | HG22 | ILE | A | 1282 | −21.099 | 30.560 | 11.107 | 1.00 | 1.00 | H |
| ATOM | 4915 | HG23 | ILE | A | 1282 | −21.922 | 29.083 | 10.634 | 1.00 | 1.00 | H |
| ATOM | 4916 | HN | ILE | A | 1282 | −25.356 | 30.916 | 12.888 | 1.00 | 1.00 | H |
| ATOM | 4917 | N | ASP | A | 1283 | −25.353 | 30.588 | 9.630 | 1.00 | 1.00 | N |
| ATOM | 4918 | CA | ASP | A | 1283 | −25.942 | 29.814 | 8.537 | 1.00 | 1.00 | C |
| ATOM | 4919 | C | ASP | A | 1283 | −24.818 | 29.383 | 7.572 | 1.00 | 1.00 | C |
| ATOM | 4920 | O | ASP | A | 1283 | −24.874 | 28.307 | 7.014 | 1.00 | 1.00 | O |
| ATOM | 4921 | CB | ASP | A | 1283 | −27.009 | 30.600 | 7.815 | 1.00 | 1.00 | C |
| ATOM | 4922 | CG | ASP | A | 1283 | −28.119 | 31.135 | 8.667 | 1.00 | 1.00 | C |
| ATOM | 4923 | OD1 | ASP | A | 1283 | −28.398 | 30.693 | 9.815 | 1.00 | 1.00 | O |
| ATOM | 4924 | OD2 | ASP | A | 1283 | −28.864 | 32.100 | 8.281 | 1.00 | 1.00 | O |
| ATOM | 4925 | HA | ASP | A | 1283 | −26.528 | 28.925 | 8.905 | 1.00 | 1.00 | H |
| ATOM | 4926 | HB1 | ASP | A | 1283 | −26.524 | 31.439 | 7.337 | 1.00 | 1.00 | H |
| ATOM | 4927 | HB2 | ASP | A | 1283 | −27.482 | 29.955 | 7.068 | 1.00 | 1.00 | H |
| ATOM | 4928 | HN | ASP | A | 1283 | −25.513 | 31.584 | 9.624 | 1.00 | 1.00 | H |
| ATOM | 4929 | N | TRP | A | 1284 | −23.721 | 30.235 | 7.313 | 1.00 | 1.00 | N |
| ATOM | 4930 | CA | TRP | A | 1284 | −22.729 | 29.896 | 6.261 | 1.00 | 1.00 | C |
| ATOM | 4931 | C | TRP | A | 1284 | −22.305 | 28.439 | 6.340 | 1.00 | 1.00 | C |
| ATOM | 4932 | O | TRP | A | 1284 | −22.266 | 27.642 | 5.401 | 1.00 | 1.00 | O |
| ATOM | 4933 | CB | TRP | A | 1284 | −21.542 | 30.912 | 6.364 | 1.00 | 1.00 | C |
| ATOM | 4934 | CG | TRP | A | 1284 | −20.588 | 30.909 | 5.219 | 1.00 | 1.00 | C |
| ATOM | 4935 | CD1 | TRP | A | 1284 | −20.707 | 30.214 | 4.098 | 1.00 | 1.00 | C |
| ATOM | 4936 | CD2 | TRP | A | 1284 | −19.335 | 31.722 | 5.085 | 1.00 | 1.00 | C |
| ATOM | 4937 | NE1 | TRP | A | 1284 | −19.700 | 30.533 | 3.260 | 1.00 | 1.00 | N |
| ATOM | 4938 | CE2 | TRP | A | 1284 | −18.909 | 31.469 | 3.803 | 1.00 | 1.00 | C |
| ATOM | 4939 | CE3 | TRP | A | 1284 | −18.654 | 32.635 | 5.885 | 1.00 | 1.00 | C |
| ATOM | 4940 | CZ2 | TRP | A | 1284 | −17.832 | 32.143 | 3.264 | 1.00 | 1.00 | C |
| ATOM | 4941 | CZ3 | TRP | A | 1284 | −17.571 | 33.368 | 5.369 | 1.00 | 1.00 | C |
| ATOM | 4942 | CH2 | TRP | A | 1284 | −17.174 | 33.098 | 4.063 | 1.00 | 1.00 | C |
| ATOM | 4943 | HA | TRP | A | 1284 | −23.203 | 29.936 | 5.285 | 1.00 | 1.00 | H |
| ATOM | 4944 | HB1 | TRP | A | 1284 | −21.947 | 31.904 | 6.409 | 1.00 | 1.00 | H |
| ATOM | 4945 | HB2 | TRP | A | 1284 | −21.051 | 30.760 | 7.316 | 1.00 | 1.00 | H |
| ATOM | 4946 | HE1 | TRP | A | 1284 | −19.602 | 30.180 | 2.304 | 1.00 | 1.00 | H |
| ATOM | 4947 | HD1 | TRP | A | 1284 | −21.451 | 29.468 | 3.810 | 1.00 | 1.00 | H |
| ATOM | 4948 | HZ2 | TRP | A | 1284 | −17.493 | 31.990 | 2.220 | 1.00 | 1.00 | H |
| ATOM | 4949 | HH2 | TRP | A | 1284 | −16.255 | 33.610 | 3.689 | 1.00 | 1.00 | H |
| ATOM | 4950 | HZ3 | TRP | A | 1284 | −17.109 | 34.134 | 6.001 | 1.00 | 1.00 | H |
| ATOM | 4951 | HE3 | TRP | A | 1284 | −18.998 | 32.828 | 6.925 | 1.00 | 1.00 | H |
| ATOM | 4952 | HN | TRP | A | 1284 | −23.697 | 31.162 | 7.700 | 1.00 | 1.00 | H |
| ATOM | 4953 | N | LYS | A | 1285 | −21.955 | 28.062 | 7.583 | 1.00 | 1.00 | N |
| ATOM | 4954 | CA | LYS | A | 1285 | −21.533 | 26.684 | 7.777 | 1.00 | 1.00 | C |
| ATOM | 4955 | C | LYS | A | 1285 | −22.606 | 25.619 | 7.405 | 1.00 | 1.00 | C |
| ATOM | 4956 | O | LYS | A | 1285 | −22.306 | 24.502 | 6.951 | 1.00 | 1.00 | O |
| ATOM | 4957 | CB | LYS | A | 1285 | −20.969 | 26.405 | 9.189 | 1.00 | 1.00 | C |
| ATOM | 4958 | CG | LYS | A | 1285 | −20.067 | 25.134 | 9.175 | 1.00 | 1.00 | C |
| ATOM | 4959 | CD | LYS | A | 1285 | −19.300 | 24.988 | 10.546 | 1.00 | 1.00 | C |
| ATOM | 4960 | CE | LYS | A | 1285 | −20.286 | 24.902 | 11.734 | 1.00 | 1.00 | C |
| ATOM | 4961 | NZ | LYS | A | 1285 | −19.555 | 24.619 | 13.019 | 1.00 | 1.00 | N |
| ATOM | 4962 | HA | LYS | A | 1285 | −20.715 | 26.518 | 7.090 | 1.00 | 1.00 | H |
| ATOM | 4963 | HB1 | LYS | A | 1285 | −20.315 | 27.235 | 9.562 | 1.00 | 1.00 | H |
| ATOM | 4964 | HB2 | LYS | A | 1285 | −21.813 | 26.314 | 9.860 | 1.00 | 1.00 | H |
| ATOM | 4965 | HG1 | LYS | A | 1285 | −20.758 | 24.307 | 8.949 | 1.00 | 1.00 | H |
| ATOM | 4966 | HG2 | LYS | A | 1285 | −19.312 | 25.149 | 8.374 | 1.00 | 1.00 | H |
| ATOM | 4967 | HD1 | LYS | A | 1285 | −18.622 | 24.104 | 10.463 | 1.00 | 1.00 | H |
| ATOM | 4968 | HD2 | LYS | A | 1285 | −18.680 | 25.857 | 10.708 | 1.00 | 1.00 | H |
| ATOM | 4969 | HE1 | LYS | A | 1285 | −20.908 | 25.852 | 11.809 | 1.00 | 1.00 | H |
| ATOM | 4970 | HE2 | LYS | A | 1285 | −21.049 | 24.174 | 11.540 | 1.00 | 1.00 | H |
| ATOM | 4971 | HZ1 | LYS | A | 1285 | −18.986 | 23.682 | 12.997 | 1.00 | 1.00 | H |
| ATOM | 4972 | HZ2 | LYS | A | 1285 | −18.904 | 25.452 | 13.305 | 1.00 | 1.00 | H |
| ATOM | 4973 | HZ3 | LYS | A | 1285 | −20.145 | 24.672 | 13.932 | 1.00 | 1.00 | H |
| ATOM | 4974 | HN | LYS | A | 1285 | −21.920 | 28.704 | 8.393 | 1.00 | 1.00 | H |
| ATOM | 4975 | N | VAL | A | 1286 | −23.912 | 25.892 | 7.722 | 1.00 | 1.00 | N |
| ATOM | 4976 | CA | VAL | A | 1286 | −24.941 | 24.887 | 7.381 | 1.00 | 1.00 | C |
| ATOM | 4977 | C | VAL | A | 1286 | −25.000 | 24.666 | 5.909 | 1.00 | 1.00 | C |
| ATOM | 4978 | O | VAL | A | 1286 | −25.057 | 23.503 | 5.535 | 1.00 | 1.00 | O |
| ATOM | 4979 | CB | VAL | A | 1286 | −26.369 | 24.928 | 8.015 | 1.00 | 1.00 | C |
| ATOM | 4980 | CG1 | VAL | A | 1286 | −26.278 | 25.212 | 9.554 | 1.00 | 1.00 | C |
| ATOM | 4981 | CG2 | VAL | A | 1286 | −27.386 | 25.824 | 7.284 | 1.00 | 1.00 | C |
| ATOM | 4982 | HA | VAL | A | 1286 | −24.502 | 23.895 | 7.686 | 1.00 | 1.00 | H |
| ATOM | 4983 | HB | VAL | A | 1286 | −26.746 | 23.950 | 7.948 | 1.00 | 1.00 | H |
| ATOM | 4984 | HG11 | VAL | A | 1286 | −25.456 | 24.579 | 9.967 | 1.00 | 1.00 | H |
| ATOM | 4985 | HG12 | VAL | A | 1286 | −25.989 | 26.309 | 9.749 | 1.00 | 1.00 | H |
| ATOM | 4986 | HG13 | VAL | A | 1286 | −27.223 | 25.031 | 10.104 | 1.00 | 1.00 | H |
| ATOM | 4987 | HG21 | VAL | A | 1286 | −27.164 | 25.871 | 6.178 | 1.00 | 1.00 | H |
| ATOM | 4988 | HG22 | VAL | A | 1286 | −28.473 | 25.508 | 7.527 | 1.00 | 1.00 | H |
| ATOM | 4989 | HG23 | VAL | A | 1286 | −27.244 | 26.850 | 7.667 | 1.00 | 1.00 | H |
| ATOM | 4990 | HN | VAL | A | 1286 | −24.200 | 26.780 | 8.013 | 1.00 | 1.00 | H |
| ATOM | 4991 | N | CYS | A | 1287 | −24.882 | 25.584 | 4.956 | 1.00 | 1.00 | N |
| ATOM | 4992 | CA | CYS | A | 1287 | −24.666 | 25.224 | 3.534 | 1.00 | 1.00 | C |
| ATOM | 4993 | C | CYS | A | 1287 | −23.279 | 24.651 | 3.394 | 1.00 | 1.00 | C |
| ATOM | 4994 | O | CYS | A | 1287 | −23.189 | 23.646 | 2.732 | 1.00 | 1.00 | O |
| ATOM | 4995 | CB | CYS | A | 1287 | −24.803 | 26.428 | 2.546 | 1.00 | 1.00 | C |
| ATOM | 4996 | SG | CYS | A | 1287 | −26.401 | 26.576 | 1.679 | 1.00 | 1.00 | S |
| ATOM | 4997 | HA | CYS | A | 1287 | −25.421 | 24.464 | 3.303 | 1.00 | 1.00 | H |
| ATOM | 4998 | HB1 | CYS | A | 1287 | −24.506 | 27.401 | 3.066 | 1.00 | 1.00 | H |
| ATOM | 4999 | HB2 | CYS | A | 1287 | −24.092 | 26.152 | 1.726 | 1.00 | 1.00 | H |
| ATOM | 5000 | HN | CYS | A | 1287 | −24.787 | 26.558 | 5.209 | 1.00 | 1.00 | H |
| ATOM | 5001 | N | GLN | A | 1288 | −22.199 | 25.190 | 4.040 | 1.00 | 1.00 | N |
| ATOM | 5002 | CA | GLN | A | 1288 | −20.889 | 24.505 | 3.872 | 1.00 | 1.00 | C |
| ATOM | 5003 | C | GLN | A | 1288 | −20.953 | 22.968 | 4.034 | 1.00 | 1.00 | C |
| ATOM | 5004 | O | GLN | A | 1288 | −20.626 | 22.242 | 3.088 | 1.00 | 1.00 | O |
| ATOM | 5005 | CB | GLN | A | 1288 | −19.833 | 25.009 | 4.912 | 1.00 | 1.00 | C |
| ATOM | 5006 | CG | GLN | A | 1288 | −18.351 | 24.690 | 4.566 | 1.00 | 1.00 | C |
| ATOM | 5007 | CD | GLN | A | 1288 | −17.440 | 25.303 | 5.596 | 1.00 | 1.00 | C |
| ATOM | 5008 | OE1 | GLN | A | 1288 | −17.929 | 26.122 | 6.376 | 1.00 | 1.00 | O |
| ATOM | 5009 | NE2 | GLN | A | 1288 | −16.173 | 24.837 | 5.587 | 1.00 | 1.00 | N |
| ATOM | 5010 | HA | GLN | A | 1288 | −20.377 | 24.727 | 2.887 | 1.00 | 1.00 | H |
| ATOM | 5011 | HB1 | GLN | A | 1288 | −19.997 | 24.573 | 5.928 | 1.00 | 1.00 | H |
| ATOM | 5012 | HB2 | GLN | A | 1288 | −20.005 | 26.076 | 5.038 | 1.00 | 1.00 | H |
| ATOM | 5013 | HG1 | GLN | A | 1288 | −18.289 | 23.625 | 4.533 | 1.00 | 1.00 | H |
| ATOM | 5014 | HG2 | GLN | A | 1288 | −18.085 | 24.965 | 3.553 | 1.00 | 1.00 | H |
| ATOM | 5015 | HE22 | GLN | A | 1288 | −15.502 | 25.206 | 6.238 | 1.00 | 1.00 | H |
| ATOM | 5016 | HE21 | GLN | A | 1288 | −15.880 | 24.085 | 5.031 | 1.00 | 1.00 | H |
| ATOM | 5017 | HN | GLN | A | 1288 | −22.281 | 25.997 | 4.567 | 1.00 | 1.00 | H |
| ATOM | 5018 | N | ARG | A | 1289 | −21.392 | 22.473 | 5.191 | 1.00 | 1.00 | N |
| ATOM | 5019 | CA | ARG | A | 1289 | −21.449 | 20.979 | 5.448 | 1.00 | 1.00 | C |
| ATOM | 5020 | C | ARG | A | 1289 | −22.850 | 20.434 | 5.293 | 1.00 | 1.00 | C |
| ATOM | 5021 | O | ARG | A | 1289 | −22.838 | 19.206 | 5.337 | 1.00 | 1.00 | O |
| ATOM | 5022 | CB | ARG | A | 1289 | −20.782 | 20.562 | 6.807 | 1.00 | 1.00 | C |
| ATOM | 5023 | CG | ARG | A | 1289 | −19.343 | 21.192 | 6.988 | 1.00 | 1.00 | C |
| ATOM | 5024 | CD | ARG | A | 1289 | −18.291 | 21.005 | 5.872 | 1.00 | 1.00 | C |
| ATOM | 5025 | NE | ARG | A | 1289 | −17.962 | 19.617 | 5.478 | 1.00 | 1.00 | N |
| ATOM | 5026 | CZ | ARG | A | 1289 | −17.211 | 19.325 | 4.416 | 1.00 | 1.00 | C |
| ATOM | 5027 | NH1 | ARG | A | 1289 | −16.627 | 20.215 | 3.647 | 1.00 | 1.00 | N |
| ATOM | 5028 | NH2 | ARG | A | 1289 | −17.063 | 18.063 | 4.155 | 1.00 | 1.00 | N |
| ATOM | 5029 | HA | ARG | A | 1289 | −20.833 | 20.443 | 4.754 | 1.00 | 1.00 | H |
| ATOM | 5030 | HB1 | ARG | A | 1289 | −20.739 | 19.454 | 7.023 | 1.00 | 1.00 | H |
| ATOM | 5031 | HB2 | ARG | A | 1289 | −21.432 | 20.968 | 7.605 | 1.00 | 1.00 | H |
| ATOM | 5032 | HG1 | ARG | A | 1289 | −19.443 | 22.232 | 7.281 | 1.00 | 1.00 | H |
| ATOM | 5033 | HG2 | ARG | A | 1289 | −18.833 | 20.651 | 7.843 | 1.00 | 1.00 | H |
| ATOM | 5034 | HD1 | ARG | A | 1289 | −18.739 | 21.477 | 4.956 | 1.00 | 1.00 | H |
| ATOM | 5035 | HD2 | ARG | A | 1289 | −17.316 | 21.491 | 6.091 | 1.00 | 1.00 | H |
| ATOM | 5036 | HE | ARG | A | 1289 | −18.447 | 18.851 | 5.946 | 1.00 | 1.00 | H |
| ATOM | 5037 | HH12 | ARG | A | 1289 | −16.147 | 19.911 | 2.804 | 1.00 | 1.00 | H |
| ATOM | 5038 | HH11 | ARG | A | 1289 | −16.723 | 21.211 | 3.837 | 1.00 | 1.00 | H |
| ATOM | 5039 | HH22 | ARG | A | 1289 | −16.578 | 17.777 | 3.316 | 1.00 | 1.00 | H |
| ATOM | 5040 | HH21 | ARG | A | 1289 | −17.446 | 17.328 | 4.682 | 1.00 | 1.00 | H |
| ATOM | 5041 | HN | ARG | A | 1289 | −21.746 | 23.047 | 5.935 | 1.00 | 1.00 | H |
| ATOM | 5042 | N | ILE | A | 1290 | −24.029 | 21.104 | 5.065 | 1.00 | 1.00 | N |
| ATOM | 5043 | CA | ILE | A | 1290 | −25.199 | 20.409 | 4.492 | 1.00 | 1.00 | C |
| ATOM | 5044 | C | ILE | A | 1290 | −24.738 | 20.093 | 3.114 | 1.00 | 1.00 | C |
| ATOM | 5045 | O | ILE | A | 1290 | −24.827 | 18.945 | 2.738 | 1.00 | 1.00 | O |
| ATOM | 5046 | CB | ILE | A | 1290 | −26.564 | 21.164 | 4.445 | 1.00 | 1.00 | C |
| ATOM | 5047 | CG1 | ILE | A | 1290 | −27.144 | 21.374 | 5.911 | 1.00 | 1.00 | C |
| ATOM | 5048 | CG2 | ILE | A | 1290 | −27.589 | 20.357 | 3.587 | 1.00 | 1.00 | C |
| ATOM | 5049 | CD1 | ILE | A | 1290 | −28.258 | 22.462 | 5.926 | 1.00 | 1.00 | C |
| ATOM | 5050 | HA | ILE | A | 1290 | −25.348 | 19.470 | 5.101 | 1.00 | 1.00 | H |
| ATOM | 5051 | HB | ILE | A | 1290 | −26.421 | 22.203 | 3.996 | 1.00 | 1.00 | H |
| ATOM | 5052 | HG11 | ILE | A | 1290 | −27.587 | 20.432 | 6.327 | 1.00 | 1.00 | H |
| ATOM | 5053 | HG12 | ILE | A | 1290 | −26.308 | 21.737 | 6.585 | 1.00 | 1.00 | H |
| ATOM | 5054 | HD11 | ILE | A | 1290 | −28.641 | 22.447 | 6.939 | 1.00 | 1.00 | H |
| ATOM | 5055 | HD12 | ILE | A | 1290 | −29.036 | 22.304 | 5.151 | 1.00 | 1.00 | H |
| ATOM | 5056 | HD13 | ILE | A | 1290 | −27.946 | 23.491 | 5.755 | 1.00 | 1.00 | H |
| ATOM | 5057 | HG21 | ILE | A | 1290 | −27.167 | 19.995 | 2.670 | 1.00 | 1.00 | H |
| ATOM | 5058 | HG22 | ILE | A | 1290 | −28.480 | 20.948 | 3.393 | 1.00 | 1.00 | H |
| ATOM | 5059 | HG23 | ILE | A | 1290 | −27.894 | 19.413 | 4.137 | 1.00 | 1.00 | H |
| ATOM | 5060 | HN | ILE | A | 1290 | −24.124 | 22.088 | 5.229 | 1.00 | 1.00 | H |
| ATOM | 5061 | N | VAL | A | 1291 | −24.239 | 21.031 | 2.334 | 1.00 | 1.00 | N |
| ATOM | 5062 | CA | VAL | A | 1291 | −23.758 | 20.681 | 0.964 | 1.00 | 1.00 | C |
| ATOM | 5063 | C | VAL | A | 1291 | −22.719 | 19.577 | 1.056 | 1.00 | 1.00 | C |
| ATOM | 5064 | O | VAL | A | 1291 | −22.837 | 18.617 | 0.321 | 1.00 | 1.00 | O |
| ATOM | 5065 | CB | VAL | A | 1291 | −23.121 | 21.836 | 0.148 | 1.00 | 1.00 | C |
| ATOM | 5066 | CG1 | VAL | A | 1291 | −22.367 | 21.316 | −1.151 | 1.00 | 1.00 | C |
| ATOM | 5067 | CG2 | VAL | A | 1291 | −24.145 | 22.950 | −0.186 | 1.00 | 1.00 | C |
| ATOM | 5068 | HA | VAL | A | 1291 | −24.658 | 20.317 | 0.330 | 1.00 | 1.00 | H |
| ATOM | 5069 | HB | VAL | A | 1291 | −22.349 | 22.272 | 0.752 | 1.00 | 1.00 | H |
| ATOM | 5070 | HG11 | VAL | A | 1291 | −21.924 | 22.095 | −1.786 | 1.00 | 1.00 | H |
| ATOM | 5071 | HG12 | VAL | A | 1291 | −21.578 | 20.572 | −0.957 | 1.00 | 1.00 | H |
| ATOM | 5072 | HG13 | VAL | A | 1291 | −23.140 | 20.784 | −1.738 | 1.00 | 1.00 | H |
| ATOM | 5073 | HG21 | VAL | A | 1291 | −24.961 | 22.541 | −0.786 | 1.00 | 1.00 | H |
| ATOM | 5074 | HG22 | VAL | A | 1291 | −24.553 | 23.343 | 0.731 | 1.00 | 1.00 | H |
| ATOM | 5075 | HG23 | VAL | A | 1291 | −23.695 | 23.764 | −0.752 | 1.00 | 1.00 | H |
| ATOM | 5076 | HN | VAL | A | 1291 | −24.072 | 21.937 | 2.683 | 1.00 | 1.00 | H |
| ATOM | 5077 | N | GLY | A | 1292 | −21.680 | 19.743 | 1.925 | 1.00 | 1.00 | N |
| ATOM | 5078 | CA | GLY | A | 1292 | −20.756 | 18.618 | 2.128 | 1.00 | 1.00 | C |
| ATOM | 5079 | C | GLY | A | 1292 | −21.518 | 17.368 | 2.405 | 1.00 | 1.00 | C |
| ATOM | 5080 | O | GLY | A | 1292 | −21.404 | 16.429 | 1.654 | 1.00 | 1.00 | O |
| ATOM | 5081 | HA2 | GLY | A | 1292 | −20.090 | 18.886 | 2.900 | 1.00 | 1.00 | H |
| ATOM | 5082 | HA1 | GLY | A | 1292 | −20.189 | 18.685 | 1.202 | 1.00 | 1.00 | H |
| ATOM | 5083 | HN | GLY | A | 1292 | −21.547 | 20.589 | 2.495 | 1.00 | 1.00 | H |
| ATOM | 5084 | N | LEU | A | 1293 | −22.288 | 17.318 | 3.509 | 1.00 | 1.00 | N |
| ATOM | 5085 | CA | LEU | A | 1293 | −22.853 | 16.043 | 3.938 | 1.00 | 1.00 | C |
| ATOM | 5086 | C | LEU | A | 1293 | −23.660 | 15.500 | 2.777 | 1.00 | 1.00 | C |
| ATOM | 5087 | O | LEU | A | 1293 | −23.602 | 14.291 | 2.562 | 1.00 | 1.00 | O |
| ATOM | 5088 | CB | LEU | A | 1293 | −23.786 | 16.313 | 5.181 | 1.00 | 1.00 | C |
| ATOM | 5089 | CG | LEU | A | 1293 | −24.323 | 14.954 | 5.735 | 1.00 | 1.00 | C |
| ATOM | 5090 | CD1 | LEU | A | 1293 | −23.229 | 13.957 | 6.249 | 1.00 | 1.00 | C |
| ATOM | 5091 | CD2 | LEU | A | 1293 | −25.425 | 15.232 | 6.797 | 1.00 | 1.00 | C |
| ATOM | 5092 | HA | LEU | A | 1293 | −22.039 | 15.362 | 4.191 | 1.00 | 1.00 | H |
| ATOM | 5093 | HB1 | LEU | A | 1293 | −24.578 | 16.981 | 4.837 | 1.00 | 1.00 | H |
| ATOM | 5094 | HB2 | LEU | A | 1293 | −23.295 | 16.857 | 5.993 | 1.00 | 1.00 | H |
| ATOM | 5095 | HG | LEU | A | 1293 | −24.926 | 14.462 | 4.932 | 1.00 | 1.00 | H |
| ATOM | 5096 | HD21 | LEU | A | 1293 | −25.898 | 14.249 | 7.026 | 1.00 | 1.00 | H |
| ATOM | 5097 | HD22 | LEU | A | 1293 | −24.960 | 15.651 | 7.725 | 1.00 | 1.00 | H |
| ATOM | 5098 | HD23 | LEU | A | 1293 | −26.201 | 15.951 | 6.435 | 1.00 | 1.00 | H |
| ATOM | 5099 | HD11 | LEU | A | 1293 | −22.687 | 13.486 | 5.449 | 1.00 | 1.00 | H |
| ATOM | 5100 | HD12 | LEU | A | 1293 | −22.495 | 14.505 | 6.842 | 1.00 | 1.00 | H |
| ATOM | 5101 | HD13 | LEU | A | 1293 | −23.727 | 13.212 | 6.853 | 1.00 | 1.00 | H |
| ATOM | 5102 | HN | LEU | A | 1293 | −22.372 | 18.140 | 4.079 | 1.00 | 1.00 | H |
| ATOM | 5103 | N | LEU | A | 1294 | −24.387 | 16.328 | 1.962 | 1.00 | 1.00 | N |
| ATOM | 5104 | CA | LEU | A | 1294 | −25.163 | 15.668 | 0.916 | 1.00 | 1.00 | C |
| ATOM | 5105 | C | LEU | A | 1294 | −24.195 | 14.975 | −0.083 | 1.00 | 1.00 | C |
| ATOM | 5106 | O | LEU | A | 1294 | −24.331 | 13.816 | −0.397 | 1.00 | 1.00 | O |
| ATOM | 5107 | CB | LEU | A | 1294 | −26.218 | 16.551 | 0.156 | 1.00 | 1.00 | C |
| ATOM | 5108 | CG | LEU | A | 1294 | −27.019 | 15.788 | −0.933 | 1.00 | 1.00 | C |
| ATOM | 5109 | CD1 | LEU | A | 1294 | −28.049 | 14.762 | −0.438 | 1.00 | 1.00 | C |
| ATOM | 5110 | CD2 | LEU | A | 1294 | −27.829 | 16.828 | −1.784 | 1.00 | 1.00 | C |
| ATOM | 5111 | HA | LEU | A | 1294 | −25.828 | 14.912 | 1.343 | 1.00 | 1.00 | H |
| ATOM | 5112 | HB1 | LEU | A | 1294 | −25.616 | 17.340 | −0.349 | 1.00 | 1.00 | H |
| ATOM | 5113 | HB2 | LEU | A | 1294 | −26.942 | 17.032 | 0.829 | 1.00 | 1.00 | H |
| ATOM | 5114 | HG | LEU | A | 1294 | −26.377 | 15.136 | −1.568 | 1.00 | 1.00 | H |
| ATOM | 5115 | HD21 | LEU | A | 1294 | −28.414 | 16.337 | −2.587 | 1.00 | 1.00 | H |
| ATOM | 5116 | HD22 | LEU | A | 1294 | −28.587 | 17.436 | −1.216 | 1.00 | 1.00 | H |
| ATOM | 5117 | HD23 | LEU | A | 1294 | −27.113 | 17.569 | −2.229 | 1.00 | 1.00 | H |
| ATOM | 5118 | HD11 | LEU | A | 1294 | −28.664 | 15.362 | 0.202 | 1.00 | 1.00 | H |
| ATOM | 5119 | HD12 | LEU | A | 1294 | −28.591 | 14.307 | −1.290 | 1.00 | 1.00 | H |
| ATOM | 5120 | HD13 | LEU | A | 1294 | −27.589 | 13.884 | 0.100 | 1.00 | 1.00 | H |
| ATOM | 5121 | HN | LEU | A | 1294 | −24.496 | 17.321 | 2.088 | 1.00 | 1.00 | H |
| ATOM | 5122 | N | GLY | A | 1295 | −23.225 | 15.729 | −0.655 | 1.00 | 1.00 | N |
| ATOM | 5123 | CA | GLY | A | 1295 | −22.317 | 15.047 | −1.600 | 1.00 | 1.00 | C |
| ATOM | 5124 | C | GLY | A | 1295 | −21.521 | 13.872 | −0.969 | 1.00 | 1.00 | C |
| ATOM | 5125 | O | GLY | A | 1295 | −21.392 | 12.842 | −1.610 | 1.00 | 1.00 | O |
| ATOM | 5126 | HA2 | GLY | A | 1295 | −21.531 | 15.810 | −1.917 | 1.00 | 1.00 | H |
| ATOM | 5127 | HA1 | GLY | A | 1295 | −22.772 | 14.705 | −2.529 | 1.00 | 1.00 | H |
| ATOM | 5128 | HN | GLY | A | 1295 | −23.065 | 16.709 | −0.403 | 1.00 | 1.00 | H |
| ATOM | 5129 | N | PHE | A | 1296 | −21.035 | 14.020 | 0.272 | 1.00 | 1.00 | N |
| ATOM | 5130 | CA | PHE | A | 1296 | −20.367 | 12.901 | 0.937 | 1.00 | 1.00 | C |
| ATOM | 5131 | C | PHE | A | 1296 | −21.308 | 11.818 | 1.459 | 1.00 | 1.00 | C |
| ATOM | 5132 | O | PHE | A | 1296 | −20.882 | 10.686 | 1.508 | 1.00 | 1.00 | O |
| ATOM | 5133 | CB | PHE | A | 1296 | −19.471 | 13.486 | 2.037 | 1.00 | 1.00 | C |
| ATOM | 5134 | CG | PHE | A | 1296 | −18.879 | 12.326 | 2.879 | 1.00 | 1.00 | C |
| ATOM | 5135 | CD1 | PHE | A | 1296 | −17.816 | 11.596 | 2.337 | 1.00 | 1.00 | C |
| ATOM | 5136 | CD2 | PHE | A | 1296 | −19.393 | 12.034 | 4.151 | 1.00 | 1.00 | C |
| ATOM | 5137 | CE1 | PHE | A | 1296 | −17.387 | 10.456 | 2.964 | 1.00 | 1.00 | C |
| ATOM | 5138 | CE2 | PHE | A | 1296 | −18.809 | 10.971 | 4.840 | 1.00 | 1.00 | C |
| ATOM | 5139 | CZ | PHE | A | 1296 | −17.851 | 10.152 | 4.254 | 1.00 | 1.00 | C |
| ATOM | 5140 | HA | PHE | A | 1296 | −19.732 | 12.341 | 0.210 | 1.00 | 1.00 | H |
| ATOM | 5141 | HB1 | PHE | A | 1296 | −20.116 | 14.119 | 2.688 | 1.00 | 1.00 | H |
| ATOM | 5142 | HB2 | PHE | A | 1296 | −18.763 | 14.124 | 1.499 | 1.00 | 1.00 | H |
| ATOM | 5143 | HD2 | PHE | A | 1296 | −20.206 | 12.582 | 4.623 | 1.00 | 1.00 | H |
| ATOM | 5144 | HE2 | PHE | A | 1296 | −19.057 | 10.723 | 5.856 | 1.00 | 1.00 | H |
| ATOM | 5145 | HZ | PHE | A | 1296 | −17.494 | 9.302 | 4.804 | 1.00 | 1.00 | H |
| ATOM | 5146 | HE1 | PHE | A | 1296 | −16.664 | 9.862 | 2.404 | 1.00 | 1.00 | H |
| ATOM | 5147 | HD1 | PHE | A | 1296 | −17.317 | 11.922 | 1.440 | 1.00 | 1.00 | H |
| ATOM | 5148 | HN | PHE | A | 1296 | −21.241 | 14.818 | 0.840 | 1.00 | 1.00 | H |
| ATOM | 5149 | N | ALA | A | 1297 | −22.562 | 12.097 | 1.878 | 1.00 | 1.00 | N |
| ATOM | 5150 | CA | ALA | A | 1297 | −23.413 | 11.025 | 2.368 | 1.00 | 1.00 | C |
| ATOM | 5151 | C | ALA | A | 1297 | −24.054 | 10.314 | 1.244 | 1.00 | 1.00 | C |
| ATOM | 5152 | O | ALA | A | 1297 | −24.071 | 9.085 | 1.299 | 1.00 | 1.00 | O |
| ATOM | 5153 | CB | ALA | A | 1297 | −24.579 | 11.506 | 3.256 | 1.00 | 1.00 | C |
| ATOM | 5154 | HA | ALA | A | 1297 | −22.846 | 10.374 | 3.041 | 1.00 | 1.00 | H |
| ATOM | 5155 | HB1 | ALA | A | 1297 | −25.266 | 10.703 | 3.651 | 1.00 | 1.00 | H |
| ATOM | 5156 | HB2 | ALA | A | 1297 | −24.142 | 12.032 | 4.124 | 1.00 | 1.00 | H |
| ATOM | 5157 | HB3 | ALA | A | 1297 | −25.086 | 12.269 | 2.636 | 1.00 | 1.00 | H |
| ATOM | 5158 | HN | ALA | A | 1297 | −22.910 | 13.051 | 1.858 | 1.00 | 1.00 | H |
| ATOM | 5159 | N | ALA | A | 1298 | −24.555 | 10.972 | 0.170 | 1.00 | 1.00 | N |
| ATOM | 5160 | CA | ALA | A | 1298 | −25.210 | 10.256 | −0.945 | 1.00 | 1.00 | C |
| ATOM | 5161 | C | ALA | A | 1298 | −24.470 | 8.996 | −1.349 | 1.00 | 1.00 | C |
| ATOM | 5162 | O | ALA | A | 1298 | −25.143 | 7.965 | −1.331 | 1.00 | 1.00 | O |
| ATOM | 5163 | CB | ALA | A | 1298 | −25.423 | 11.143 | −2.207 | 1.00 | 1.00 | C |
| ATOM | 5164 | HA | ALA | A | 1298 | −26.212 | 9.912 | −0.647 | 1.00 | 1.00 | H |
| ATOM | 5165 | HB1 | ALA | A | 1298 | −25.717 | 10.662 | −3.116 | 1.00 | 1.00 | H |
| ATOM | 5166 | HB2 | ALA | A | 1298 | −26.154 | 11.910 | −1.990 | 1.00 | 1.00 | H |
| ATOM | 5167 | HB3 | ALA | A | 1298 | −24.536 | 11.685 | −2.406 | 1.00 | 1.00 | H |
| ATOM | 5168 | HN | ALA | A | 1298 | −24.448 | 11.946 | 0.093 | 1.00 | 1.00 | H |
| ATOM | 5169 | N | PRO | A | 1299 | −23.165 | 8.930 | −1.686 | 1.00 | 1.00 | N |
| ATOM | 5170 | CA | PRO | A | 1299 | −22.610 | 7.606 | −1.942 | 1.00 | 1.00 | C |
| ATOM | 5171 | C | PRO | A | 1299 | −22.766 | 6.828 | −0.660 | 1.00 | 1.00 | C |
| ATOM | 5172 | O | PRO | A | 1299 | −23.394 | 5.773 | −0.717 | 1.00 | 1.00 | O |
| ATOM | 5173 | CB | PRO | A | 1299 | −21.130 | 8.014 | −2.205 | 1.00 | 1.00 | C |
| ATOM | 5174 | CG | PRO | A | 1299 | −20.921 | 9.287 | −1.426 | 1.00 | 1.00 | C |
| ATOM | 5175 | CD | PRO | A | 1299 | −22.266 | 10.052 | −1.590 | 1.00 | 1.00 | C |
| ATOM | 5176 | HA | PRO | A | 1299 | −23.038 | 7.151 | −2.833 | 1.00 | 1.00 | H |
| ATOM | 5177 | HD2 | PRO | A | 1299 | −22.467 | 10.718 | −0.735 | 1.00 | 1.00 | H |
| ATOM | 5178 | HD1 | PRO | A | 1299 | −22.232 | 10.660 | −2.522 | 1.00 | 1.00 | H |
| ATOM | 5179 | HG2 | PRO | A | 1299 | −20.077 | 9.958 | −1.715 | 1.00 | 1.00 | H |
| ATOM | 5180 | HG1 | PRO | A | 1299 | −20.796 | 9.026 | −0.406 | 1.00 | 1.00 | H |
| ATOM | 5181 | HB1 | PRO | A | 1299 | −20.955 | 8.397 | −3.271 | 1.00 | 1.00 | H |
| ATOM | 5182 | HB2 | PRO | A | 1299 | −20.384 | 7.217 | −1.913 | 1.00 | 1.00 | H |
| ATOM | 5183 | H31 | PRO | A | 1299 | −22.431 | 7.050 | 0.365 | 1.00 | 1.00 | H |
| TER | | | | | | | | | | | |
| ATOM | 5184 | P | G | B | 1 | 9.978 | 18.634 | 9.126 | 1.00 | 1.00 | P |
| ATOM | 5185 | O1P | G | B | 1 | 10.277 | 17.475 | 9.966 | 1.00 | 1.00 | O |
| ATOM | 5186 | O2P | G | B | 1 | 10.102 | 18.062 | 7.766 | 1.00 | 1.00 | O |
| ATOM | 5187 | O5* | G | B | 1 | 8.510 | 19.136 | 9.514 | 1.00 | 1.00 | O |
| ATOM | 5188 | C5* | G | B | 1 | 8.248 | 19.280 | 10.931 | 1.00 | 1.00 | C |
| ATOM | 5189 | C4* | G | B | 1 | 6.746 | 19.746 | 11.168 | 1.00 | 1.00 | C |
| ATOM | 5190 | O4* | G | B | 1 | 6.518 | 19.998 | 12.557 | 1.00 | 1.00 | O |
| ATOM | 5191 | C1* | G | B | 1 | 5.335 | 20.855 | 12.697 | 1.00 | 1.00 | C |
| ATOM | 5192 | C2* | G | B | 1 | 5.612 | 21.906 | 11.578 | 1.00 | 1.00 | C |
| ATOM | 5193 | C3* | G | B | 1 | 6.415 | 21.088 | 10.493 | 1.00 | 1.00 | C |
| ATOM | 5194 | O3* | G | B | 1 | 5.718 | 20.964 | 9.265 | 1.00 | 1.00 | O |
| ATOM | 5195 | N9 | G | B | 1 | 5.412 | 21.337 | 14.003 | 1.00 | 1.00 | N |
| ATOM | 5196 | C8 | G | B | 1 | 5.143 | 22.572 | 14.356 | 1.00 | 1.00 | C |
| ATOM | 5197 | N7 | G | B | 1 | 5.247 | 22.678 | 15.573 | 1.00 | 1.00 | N |
| ATOM | 5198 | C5 | G | B | 1 | 5.683 | 21.440 | 16.154 | 1.00 | 1.00 | C |
| ATOM | 5199 | O6 | G | B | 1 | 5.978 | 21.702 | 18.480 | 1.00 | 1.00 | O |
| ATOM | 5200 | C6 | G | B | 1 | 6.043 | 20.972 | 17.505 | 1.00 | 1.00 | C |
| ATOM | 5201 | N1 | G | B | 1 | 6.476 | 19.724 | 17.548 | 1.00 | 1.00 | N |
| ATOM | 5202 | N2 | G | B | 1 | 6.914 | 17.651 | 16.668 | 1.00 | 1.00 | N |
| ATOM | 5203 | C2 | G | B | 1 | 6.528 | 18.879 | 16.468 | 1.00 | 1.00 | C |
| ATOM | 5204 | N3 | G | B | 1 | 6.179 | 19.274 | 15.283 | 1.00 | 1.00 | N |
| ATOM | 5205 | C4 | G | B | 1 | 5.768 | 20.640 | 15.077 | 1.00 | 1.00 | C |
| ATOM | 5206 | H5*1 | G | B | 1 | 8.998 | 20.043 | 11.193 | 1.00 | 1.00 | H |
| ATOM | 5207 | H5*2 | G | B | 1 | 8.486 | 18.304 | 11.400 | 1.00 | 1.00 | H |
| ATOM | 5208 | H4* | G | B | 1 | 6.016 | 18.952 | 10.935 | 1.00 | 1.00 | H |
| ATOM | 5209 | H1* | G | B | 1 | 4.424 | 20.186 | 12.584 | 1.00 | 1.00 | H |
| ATOM | 5210 | H2*1 | G | B | 1 | 4.666 | 22.418 | 11.192 | 1.00 | 1.00 | H |
| ATOM | 5211 | H2*2 | G | B | 1 | 6.285 | 22.640 | 12.065 | 1.00 | 1.00 | H |
| ATOM | 5212 | H3* | G | B | 1 | 7.347 | 21.621 | 10.220 | 1.00 | 1.00 | H |
| ATOM | 5213 | H8 | G | B | 1 | 4.823 | 23.435 | 13.769 | 1.00 | 1.00 | H |
| ATOM | 5214 | H1 | G | B | 1 | 6.878 | 19.425 | 18.396 | 1.00 | 1.00 | H |
| ATOM | 5215 | H21 | G | B | 1 | 6.964 | 16.996 | 15.892 | 1.00 | 1.00 | H |
| ATOM | 5216 | H22 | G | B | 1 | 7.155 | 17.326 | 17.602 | 1.00 | 1.00 | H |
| ATOM | 5217 | H7 | G | B | 1 | 10.699 | 19.344 | 9.220 | 1.00 | 1.00 | H |
| ATOM | 5218 | P | C | B | 2 | 4.267 | 20.344 | 9.004 | 1.00 | 1.00 | P |
| ATOM | 5219 | O1P | C | B | 2 | 3.540 | 20.364 | 10.306 | 1.00 | 1.00 | O |
| ATOM | 5220 | O2P | C | B | 2 | 4.527 | 18.955 | 8.532 | 1.00 | 1.00 | O |
| ATOM | 5221 | O5* | C | B | 2 | 3.530 | 21.270 | 7.815 | 1.00 | 1.00 | O |
| ATOM | 5222 | C5* | C | B | 2 | 3.449 | 20.849 | 6.433 | 1.00 | 1.00 | C |
| ATOM | 5223 | C4* | C | B | 2 | 2.281 | 19.883 | 6.091 | 1.00 | 1.00 | C |
| ATOM | 5224 | O4* | C | B | 2 | 2.138 | 18.943 | 7.135 | 1.00 | 1.00 | O |
| ATOM | 5225 | C1* | C | B | 2 | 0.717 | 18.660 | 7.292 | 1.00 | 1.00 | C |
| ATOM | 5226 | C2* | C | B | 2 | 0.259 | 20.093 | 7.262 | 1.00 | 1.00 | C |
| ATOM | 5227 | C3* | C | B | 2 | 0.885 | 20.556 | 5.946 | 1.00 | 1.00 | C |
| ATOM | 5228 | O3* | C | B | 2 | 0.194 | 19.995 | 4.783 | 1.00 | 1.00 | O |
| ATOM | 5229 | N1 | C | B | 2 | 0.191 | 18.057 | 8.505 | 1.00 | 1.00 | N |
| ATOM | 5230 | C6 | C | B | 2 | 1.013 | 17.927 | 9.608 | 1.00 | 1.00 | C |
| ATOM | 5231 | C5 | C | B | 2 | 0.476 | 17.687 | 10.797 | 1.00 | 1.00 | C |
| ATOM | 5232 | N4 | C | B | 2 | −1.449 | 17.099 | 12.119 | 1.00 | 1.00 | N |
| ATOM | 5233 | C4 | C | B | 2 | −0.988 | 17.392 | 10.928 | 1.00 | 1.00 | C |
| ATOM | 5234 | N3 | C | B | 2 | −1.705 | 17.494 | 9.917 | 1.00 | 1.00 | N |
| ATOM | 5235 | O2 | C | B | 2 | −1.942 | 17.972 | 7.742 | 1.00 | 1.00 | O |
| ATOM | 5236 | C2 | C | B | 2 | −1.144 | 17.855 | 8.619 | 1.00 | 1.00 | C |
| ATOM | 5237 | H5*1 | C | B | 2 | 4.388 | 20.292 | 6.198 | 1.00 | 1.00 | H |
| ATOM | 5238 | H5*2 | C | B | 2 | 3.339 | 21.768 | 5.845 | 1.00 | 1.00 | H |
| ATOM | 5239 | H4* | C | B | 2 | 2.440 | 19.341 | 5.153 | 1.00 | 1.00 | H |
| ATOM | 5240 | H1* | C | B | 2 | 0.443 | 18.085 | 6.408 | 1.00 | 1.00 | H |
| ATOM | 5241 | H2*1 | C | B | 2 | −0.852 | 20.244 | 7.232 | 1.00 | 1.00 | H |
| ATOM | 5242 | H2*2 | C | B | 2 | 0.620 | 20.576 | 8.166 | 1.00 | 1.00 | H |
| ATOM | 5243 | H3* | C | B | 2 | 0.944 | 21.697 | 5.877 | 1.00 | 1.00 | H |
| ATOM | 5244 | H6 | C | B | 2 | 2.077 | 18.043 | 9.585 | 1.00 | 1.00 | H |
| ATOM | 5245 | H5 | C | B | 2 | 1.051 | 17.689 | 11.755 | 1.00 | 1.00 | H |
| ATOM | 5246 | H41 | C | B | 2 | −2.492 | 16.979 | 12.204 | 1.00 | 1.00 | H |
| ATOM | 5247 | H42 | C | B | 2 | −0.832 | 17.071 | 12.983 | 1.00 | 1.00 | H |
| ATOM | 5248 | P | T | B | 3 | 0.531 | 20.461 | 3.283 | 1.00 | 1.00 | P |
| ATOM | 5249 | O1P | T | B | 3 | 1.714 | 21.375 | 3.428 | 1.00 | 1.00 | O |
| ATOM | 5250 | O2P | T | B | 3 | −0.563 | 21.190 | 2.607 | 1.00 | 1.00 | O |
| ATOM | 5251 | O5* | T | B | 3 | 0.867 | 19.198 | 2.338 | 1.00 | 1.00 | O |
| ATOM | 5252 | C5* | T | B | 3 | 2.104 | 19.085 | 1.624 | 1.00 | 1.00 | C |
| ATOM | 5253 | C4* | T | B | 3 | 2.230 | 17.859 | 0.722 | 1.00 | 1.00 | C |
| ATOM | 5254 | O4* | T | B | 3 | 1.867 | 16.569 | 1.217 | 1.00 | 1.00 | O |
| ATOM | 5255 | C1* | T | B | 3 | 1.388 | 15.704 | 0.194 | 1.00 | 1.00 | C |
| ATOM | 5256 | C2* | T | B | 3 | 1.647 | 16.528 | −1.104 | 1.00 | 1.00 | C |
| ATOM | 5257 | C3* | T | B | 3 | 1.498 | 17.993 | −0.621 | 1.00 | 1.00 | C |
| ATOM | 5258 | O3* | T | B | 3 | 2.178 | 18.878 | −1.514 | 1.00 | 1.00 | O |
| ATOM | 5259 | N1 | T | B | 3 | −0.073 | 15.623 | 0.222 | 1.00 | 1.00 | N |
| ATOM | 5260 | C2 | T | B | 3 | −0.638 | 14.661 | −0.549 | 1.00 | 1.00 | C |
| ATOM | 5261 | N3 | T | B | 3 | −1.957 | 14.543 | −0.598 | 1.00 | 1.00 | N |
| ATOM | 5262 | C4 | T | B | 3 | −2.745 | 15.471 | 0.002 | 1.00 | 1.00 | C |
| ATOM | 5263 | C5 | T | B | 3 | −2.177 | 16.579 | 0.805 | 1.00 | 1.00 | C |
| ATOM | 5264 | C6 | T | B | 3 | −0.822 | 16.506 | 0.920 | 1.00 | 1.00 | C |
| ATOM | 5265 | O2 | T | B | 3 | 0.061 | 13.901 | −1.193 | 1.00 | 1.00 | O |
| ATOM | 5266 | O4 | T | B | 3 | −3.954 | 15.429 | −0.123 | 1.00 | 1.00 | O |
| ATOM | 5267 | H5*1 | T | B | 3 | 2.902 | 19.048 | 2.380 | 1.00 | 1.00 | H |
| ATOM | 5268 | H5*2 | T | B | 3 | 2.172 | 20.025 | 1.032 | 1.00 | 1.00 | H |
| ATOM | 5269 | H4* | T | B | 3 | 3.290 | 17.742 | 0.435 | 1.00 | 1.00 | H |
| ATOM | 5270 | H1* | T | B | 3 | 1.883 | 14.726 | 0.261 | 1.00 | 1.00 | H |
| ATOM | 5271 | H2*1 | T | B | 3 | 2.665 | 16.338 | −1.409 | 1.00 | 1.00 | H |
| ATOM | 5272 | H2*2 | T | B | 3 | 0.940 | 16.332 | −1.878 | 1.00 | 1.00 | H |
| ATOM | 5273 | H3* | T | B | 3 | 0.444 | 18.369 | −0.486 | 1.00 | 1.00 | H |
| ATOM | 5274 | C5M | T | B | 3 | −2.995 | 17.692 | 1.395 | 1.00 | 1.00 | C |
| ATOM | 5275 | H3 | T | B | 3 | −2.354 | 13.838 | −1.154 | 1.00 | 1.00 | H |
| ATOM | 5276 | H6 | T | B | 3 | −0.396 | 17.254 | 1.605 | 1.00 | 1.00 | H |
| ATOM | 5277 | H51 | T | B | 3 | −2.442 | 18.470 | 1.922 | 1.00 | 1.00 | H |
| ATOM | 5278 | H52 | T | B | 3 | −3.470 | 18.142 | 0.549 | 1.00 | 1.00 | H |
| ATOM | 5279 | H53 | T | B | 3 | −3.669 | 17.252 | 2.154 | 1.00 | 1.00 | H |
| ATOM | 5280 | P | C | B | 4 | 1.561 | 19.388 | −2.878 | 1.00 | 1.00 | P |
| ATOM | 5281 | O1P | C | B | 4 | 2.677 | 20.130 | −3.600 | 1.00 | 1.00 | O |
| ATOM | 5282 | O2P | C | B | 4 | 0.383 | 20.212 | −2.556 | 1.00 | 1.00 | O |
| ATOM | 5283 | O5* | C | B | 4 | 1.047 | 18.176 | −3.736 | 1.00 | 1.00 | O |
| ATOM | 5284 | C5* | C | B | 4 | 2.000 | 17.454 | −4.536 | 1.00 | 1.00 | C |
| ATOM | 5285 | C4* | C | B | 4 | 1.184 | 16.382 | −5.282 | 1.00 | 1.00 | C |
| ATOM | 5286 | O4* | C | B | 4 | 0.388 | 15.518 | −4.414 | 1.00 | 1.00 | O |
| ATOM | 5287 | C1* | C | B | 4 | −0.688 | 14.937 | −5.214 | 1.00 | 1.00 | C |
| ATOM | 5288 | C2* | C | B | 4 | −0.631 | 15.630 | −6.572 | 1.00 | 1.00 | C |
| ATOM | 5289 | C3* | C | B | 4 | 0.117 | 16.950 | −6.225 | 1.00 | 1.00 | C |
| ATOM | 5290 | O3* | C | B | 4 | 0.785 | 17.584 | −7.342 | 1.00 | 1.00 | O |
| ATOM | 5291 | N1 | C | B | 4 | −1.934 | 15.167 | −4.500 | 1.00 | 1.00 | N |
| ATOM | 5292 | C6 | C | B | 4 | −2.059 | 16.149 | −3.529 | 1.00 | 1.00 | C |
| ATOM | 5293 | C5 | C | B | 4 | −3.193 | 16.353 | −2.851 | 1.00 | 1.00 | C |
| ATOM | 5294 | N4 | C | B | 4 | −5.517 | 15.681 | −2.416 | 1.00 | 1.00 | N |
| ATOM | 5295 | C4 | C | B | 4 | −4.389 | 15.482 | −3.064 | 1.00 | 1.00 | C |
| ATOM | 5296 | N3 | C | B | 4 | −4.253 | 14.585 | −3.968 | 1.00 | 1.00 | N |
| ATOM | 5297 | O2 | C | B | 4 | −3.029 | 13.620 | −5.620 | 1.00 | 1.00 | O |
| ATOM | 5298 | C2 | C | B | 4 | −3.030 | 14.446 | −4.755 | 1.00 | 1.00 | C |
| ATOM | 5299 | H5*1 | C | B | 4 | 2.709 | 16.938 | −3.850 | 1.00 | 1.00 | H |
| ATOM | 5300 | H5*2 | C | B | 4 | 2.618 | 18.047 | −5.232 | 1.00 | 1.00 | H |
| ATOM | 5301 | H4* | C | B | 4 | 1.816 | 15.761 | −5.860 | 1.00 | 1.00 | H |
| ATOM | 5302 | H1* | C | B | 4 | −0.404 | 13.904 | −5.379 | 1.00 | 1.00 | H |
| ATOM | 5303 | H2*1 | C | B | 4 | −0.113 | 15.024 | −7.307 | 1.00 | 1.00 | H |
| ATOM | 5304 | H2*2 | C | B | 4 | −1.598 | 15.862 | −7.024 | 1.00 | 1.00 | H |
| ATOM | 5305 | H3* | C | B | 4 | −0.515 | 17.660 | −5.704 | 1.00 | 1.00 | H |
| ATOM | 5306 | H6 | C | B | 4 | −1.232 | 16.784 | −3.287 | 1.00 | 1.00 | H |
| ATOM | 5307 | H5 | C | B | 4 | −3.265 | 17.160 | −2.124 | 1.00 | 1.00 | H |
| ATOM | 5308 | H41 | C | B | 4 | −6.260 | 15.014 | −2.594 | 1.00 | 1.00 | H |
| ATOM | 5309 | H42 | C | B | 4 | −5.629 | 16.394 | −1.695 | 1.00 | 1.00 | H |
| ATOM | 5310 | P | C | B | 5 | −0.082 | 18.421 | −8.434 | 1.00 | 1.00 | P |
| ATOM | 5311 | O1P | C | B | 5 | 0.753 | 19.086 | −9.468 | 1.00 | 1.00 | O |
| ATOM | 5312 | O2P | C | B | 5 | −0.938 | 19.477 | −7.812 | 1.00 | 1.00 | O |
| ATOM | 5313 | O5* | C | B | 5 | −1.252 | 17.568 | −9.193 | 1.00 | 1.00 | O |
| ATOM | 5314 | C5* | C | B | 5 | −0.945 | 16.544 | −10.159 | 1.00 | 1.00 | C |
| ATOM | 5315 | C4* | C | B | 5 | −2.253 | 15.860 | −10.519 | 1.00 | 1.00 | C |
| ATOM | 5316 | O4* | C | B | 5 | −2.788 | 15.182 | −9.353 | 1.00 | 1.00 | O |
| ATOM | 5317 | C1* | C | B | 5 | −4.211 | 15.075 | −9.504 | 1.00 | 1.00 | C |
| ATOM | 5318 | C2* | C | B | 5 | −4.606 | 15.929 | −10.715 | 1.00 | 1.00 | C |
| ATOM | 5319 | C3* | C | B | 5 | −3.400 | 16.849 | −10.827 | 1.00 | 1.00 | C |
| ATOM | 5320 | O3* | C | B | 5 | −3.195 | 17.595 | −12.046 | 1.00 | 1.00 | O |
| ATOM | 5321 | N1 | C | B | 5 | −4.866 | 15.581 | −8.255 | 1.00 | 1.00 | N |
| ATOM | 5322 | C6 | C | B | 5 | −4.260 | 16.608 | −7.510 | 1.00 | 1.00 | C |
| ATOM | 5323 | C5 | C | B | 5 | −4.745 | 16.993 | −6.318 | 1.00 | 1.00 | C |
| ATOM | 5324 | N4 | C | B | 5 | −6.514 | 16.782 | −4.720 | 1.00 | 1.00 | N |
| ATOM | 5325 | C4 | C | B | 5 | −5.986 | 16.360 | −5.816 | 1.00 | 1.00 | C |
| ATOM | 5326 | N3 | C | B | 5 | −6.565 | 15.501 | −6.568 | 1.00 | 1.00 | N |
| ATOM | 5327 | O2 | C | B | 5 | −6.532 | 14.166 | −8.366 | 1.00 | 1.00 | O |
| ATOM | 5328 | C2 | C | B | 5 | −5.951 | 15.023 | −7.758 | 1.00 | 1.00 | C |
| ATOM | 5329 | H5*1 | C | B | 5 | −0.240 | 15.825 | −9.713 | 1.00 | 1.00 | H |
| ATOM | 5330 | H5*2 | C | B | 5 | −0.456 | 17.026 | −11.048 | 1.00 | 1.00 | H |
| ATOM | 5331 | H4* | C | B | 5 | −2.112 | 15.168 | −11.381 | 1.00 | 1.00 | H |
| ATOM | 5332 | H1* | C | B | 5 | −4.475 | 14.004 | −9.663 | 1.00 | 1.00 | H |
| ATOM | 5333 | H2*1 | C | B | 5 | −4.669 | 15.306 | −11.628 | 1.00 | 1.00 | H |
| ATOM | 5334 | H2*2 | C | B | 5 | −5.536 | 16.501 | −10.550 | 1.00 | 1.00 | H |
| ATOM | 5335 | H3* | C | B | 5 | −3.591 | 17.543 | −9.995 | 1.00 | 1.00 | H |
| ATOM | 5336 | H6 | C | B | 5 | −3.337 | 17.169 | −7.851 | 1.00 | 1.00 | H |
| ATOM | 5337 | H5 | C | B | 5 | −4.194 | 17.786 | −5.803 | 1.00 | 1.00 | H |
| ATOM | 5338 | H41 | C | B | 5 | −7.404 | 16.352 | −4.396 | 1.00 | 1.00 | H |
| ATOM | 5339 | H42 | C | B | 5 | −6.101 | 17.579 | −4.246 | 1.00 | 1.00 | H |
| ATOM | 5340 | P | G | B | 6 | −4.141 | 18.837 | −12.375 | 1.00 | 1.00 | P |
| ATOM | 5341 | O1P | G | B | 6 | −3.892 | 19.366 | −13.746 | 1.00 | 1.00 | O |
| ATOM | 5342 | O2P | G | B | 6 | −3.858 | 19.867 | −11.325 | 1.00 | 1.00 | O |
| ATOM | 5343 | O5* | G | B | 6 | −5.626 | 18.343 | −12.302 | 1.00 | 1.00 | O |
| ATOM | 5344 | C5* | G | B | 6 | −6.042 | 17.556 | −13.417 | 1.00 | 1.00 | C |
| ATOM | 5345 | C4* | G | B | 6 | −7.460 | 17.098 | −13.243 | 1.00 | 1.00 | C |
| ATOM | 5346 | O4* | G | B | 6 | −7.649 | 16.422 | −12.004 | 1.00 | 1.00 | O |
| ATOM | 5347 | C1* | G | B | 6 | −9.012 | 16.648 | −11.571 | 1.00 | 1.00 | C |
| ATOM | 5348 | C2* | G | B | 6 | −9.665 | 17.662 | −12.569 | 1.00 | 1.00 | C |
| ATOM | 5349 | C3* | G | B | 6 | −8.399 | 18.287 | −13.229 | 1.00 | 1.00 | C |
| ATOM | 5350 | O3* | G | B | 6 | −8.613 | 18.684 | −14.589 | 1.00 | 1.00 | O |
| ATOM | 5351 | N9 | G | B | 6 | −9.007 | 17.278 | −10.242 | 1.00 | 1.00 | N |
| ATOM | 5352 | C8 | G | B | 6 | −8.002 | 17.936 | −9.762 | 1.00 | 1.00 | C |
| ATOM | 5353 | N7 | G | B | 6 | −8.243 | 18.346 | −8.613 | 1.00 | 1.00 | N |
| ATOM | 5354 | C5 | G | B | 6 | −9.547 | 17.905 | −8.229 | 1.00 | 1.00 | C |
| ATOM | 5355 | O6 | G | B | 6 | −10.018 | 18.697 | −6.117 | 1.00 | 1.00 | O |
| ATOM | 5356 | C6 | G | B | 6 | −10.426 | 18.019 | −7.054 | 1.00 | 1.00 | C |
| ATOM | 5357 | N1 | G | B | 6 | −11.585 | 17.363 | −7.121 | 1.00 | 1.00 | N |
| ATOM | 5358 | N2 | G | B | 6 | −13.217 | 16.295 | −8.350 | 1.00 | 1.00 | N |
| ATOM | 5359 | C2 | G | B | 6 | −12.001 | 16.769 | −8.278 | 1.00 | 1.00 | C |
| ATOM | 5360 | N3 | G | B | 6 | −11.237 | 16.666 | −9.295 | 1.00 | 1.00 | N |
| ATOM | 5361 | C4 | G | B | 6 | −9.901 | 17.258 | −9.311 | 1.00 | 1.00 | C |
| ATOM | 5362 | H5*1 | G | B | 6 | −5.424 | 16.682 | −13.501 | 1.00 | 1.00 | H |
| ATOM | 5363 | H5*2 | G | B | 6 | −5.913 | 18.140 | −14.341 | 1.00 | 1.00 | H |
| ATOM | 5364 | H4* | G | B | 6 | −7.856 | 16.388 | −13.972 | 1.00 | 1.00 | H |
| ATOM | 5365 | H1* | G | B | 6 | −9.590 | 15.714 | −11.561 | 1.00 | 1.00 | H |
| ATOM | 5366 | H2*1 | G | B | 6 | −10.202 | 17.179 | −13.354 | 1.00 | 1.00 | H |
| ATOM | 5367 | H2*2 | G | B | 6 | −10.335 | 18.377 | −12.078 | 1.00 | 1.00 | H |
| ATOM | 5368 | H3* | G | B | 6 | −8.035 | 19.065 | −12.481 | 1.00 | 1.00 | H |
| ATOM | 5369 | H8 | G | B | 6 | −7.050 | 18.175 | −10.196 | 1.00 | 1.00 | H |
| ATOM | 5370 | H1 | G | B | 6 | −12.148 | 17.353 | −6.308 | 1.00 | 1.00 | H |
| ATOM | 5371 | H21 | G | B | 6 | −13.585 | 15.802 | −9.236 | 1.00 | 1.00 | H |
| ATOM | 5372 | H22 | G | B | 6 | −13.840 | 16.331 | −7.544 | 1.00 | 1.00 | H |
| ATOM | 5373 | P | G | B | 7 | −9.381 | 20.019 | −15.030 | 1.00 | 1.00 | P |
| ATOM | 5374 | O1P | G | B | 7 | −9.383 | 20.234 | −16.502 | 1.00 | 1.00 | O |
| ATOM | 5375 | O2P | G | B | 7 | −8.636 | 21.113 | −14.333 | 1.00 | 1.00 | O |
| ATOM | 5376 | O5* | G | B | 7 | −10.895 | 20.032 | −14.650 | 1.00 | 1.00 | O |
| ATOM | 5377 | C5* | G | B | 7 | −11.912 | 19.244 | −15.204 | 1.00 | 1.00 | C |
| ATOM | 5378 | C4* | G | B | 7 | −13.143 | 19.170 | −14.242 | 1.00 | 1.00 | C |
| ATOM | 5379 | O4* | G | B | 7 | −12.862 | 18.629 | −12.908 | 1.00 | 1.00 | O |
| ATOM | 5380 | C1* | G | B | 7 | −13.712 | 19.248 | −11.948 | 1.00 | 1.00 | C |
| ATOM | 5381 | C2* | G | B | 7 | −14.637 | 20.219 | −12.763 | 1.00 | 1.00 | C |
| ATOM | 5382 | C3* | G | B | 7 | −13.666 | 20.583 | −13.910 | 1.00 | 1.00 | C |
| ATOM | 5383 | O3* | G | B | 7 | −14.394 | 21.039 | −15.085 | 1.00 | 1.00 | O |
| ATOM | 5384 | N9 | G | B | 7 | −12.822 | 19.896 | −10.989 | 1.00 | 1.00 | N |
| ATOM | 5385 | C8 | G | B | 7 | −11.666 | 20.404 | −11.172 | 1.00 | 1.00 | C |
| ATOM | 5386 | N7 | G | B | 7 | −11.146 | 20.780 | −10.079 | 1.00 | 1.00 | N |
| ATOM | 5387 | C5 | G | B | 7 | −12.153 | 20.611 | −9.054 | 1.00 | 1.00 | C |
| ATOM | 5388 | O6 | G | B | 7 | −11.342 | 21.402 | −7.046 | 1.00 | 1.00 | O |
| ATOM | 5389 | C6 | G | B | 7 | −12.325 | 20.932 | −7.642 | 1.00 | 1.00 | C |
| ATOM | 5390 | N1 | G | B | 7 | −13.586 | 20.654 | −7.142 | 1.00 | 1.00 | N |
| ATOM | 5391 | N2 | G | B | 7 | −15.788 | 20.065 | −7.313 | 1.00 | 1.00 | N |
| ATOM | 5392 | C2 | G | B | 7 | −14.613 | 20.196 | −7.887 | 1.00 | 1.00 | C |
| ATOM | 5393 | N3 | G | B | 7 | −14.428 | 19.864 | −9.077 | 1.00 | 1.00 | N |
| ATOM | 5394 | C4 | G | B | 7 | −13.140 | 20.057 | −9.740 | 1.00 | 1.00 | C |
| ATOM | 5395 | H5*1 | G | B | 7 | −11.488 | 18.243 | −15.345 | 1.00 | 1.00 | H |
| ATOM | 5396 | H5*2 | G | B | 7 | −12.200 | 19.667 | −16.154 | 1.00 | 1.00 | H |
| ATOM | 5397 | H4* | G | B | 7 | −13.884 | 18.515 | −14.728 | 1.00 | 1.00 | H |
| ATOM | 5398 | H1* | G | B | 7 | −14.276 | 18.485 | −11.444 | 1.00 | 1.00 | H |
| ATOM | 5399 | H2*1 | G | B | 7 | −15.524 | 19.683 | −13.102 | 1.00 | 1.00 | H |
| ATOM | 5400 | H2*2 | G | B | 7 | −14.974 | 21.042 | −12.106 | 1.00 | 1.00 | H |
| ATOM | 5401 | H3* | G | B | 7 | −12.801 | 21.258 | −13.602 | 1.00 | 1.00 | H |
| ATOM | 5402 | H8 | G | B | 7 | −11.021 | 20.576 | −12.017 | 1.00 | 1.00 | H |
| ATOM | 5403 | H1 | G | B | 7 | −13.731 | 20.886 | −6.174 | 1.00 | 1.00 | H |
| ATOM | 5404 | H21 | G | B | 7 | −16.529 | 19.735 | −7.918 | 1.00 | 1.00 | H |
| ATOM | 5405 | H22 | G | B | 7 | −15.973 | 20.310 | −6.337 | 1.00 | 1.00 | H |
| ATOM | 5406 | P | C | B | 8 | −15.013 | 22.538 | −15.034 | 1.00 | 1.00 | P |
| ATOM | 5407 | O1P | C | B | 8 | −16.043 | 22.433 | −16.113 | 1.00 | 1.00 | O |
| ATOM | 5408 | O2P | C | B | 8 | −13.947 | 23.570 | −15.359 | 1.00 | 1.00 | O |
| ATOM | 5409 | O5* | C | B | 8 | −15.783 | 22.905 | −13.691 | 1.00 | 1.00 | O |
| ATOM | 5410 | C5* | C | B | 8 | −17.195 | 22.716 | −13.384 | 1.00 | 1.00 | C |
| ATOM | 5411 | C4* | C | B | 8 | −17.523 | 23.090 | −11.904 | 1.00 | 1.00 | C |
| ATOM | 5412 | O4* | C | B | 8 | −16.493 | 22.558 | −11.084 | 1.00 | 1.00 | O |
| ATOM | 5413 | C1* | C | B | 8 | −16.378 | 23.332 | −9.935 | 1.00 | 1.00 | C |
| ATOM | 5414 | C2* | C | B | 8 | −16.908 | 24.778 | −10.308 | 1.00 | 1.00 | C |
| ATOM | 5415 | C3* | C | B | 8 | −17.317 | 24.596 | −11.774 | 1.00 | 1.00 | C |
| ATOM | 5416 | O3* | C | B | 8 | −18.514 | 25.243 | −12.158 | 1.00 | 1.00 | O |
| ATOM | 5417 | N1 | C | B | 8 | −14.975 | 23.496 | −9.588 | 1.00 | 1.00 | N |
| ATOM | 5418 | C6 | C | B | 8 | −14.006 | 23.448 | −10.525 | 1.00 | 1.00 | C |
| ATOM | 5419 | C5 | C | B | 8 | −12.708 | 23.571 | −10.200 | 1.00 | 1.00 | C |
| ATOM | 5420 | N4 | C | B | 8 | −11.045 | 23.957 | −8.560 | 1.00 | 1.00 | N |
| ATOM | 5421 | C4 | C | B | 8 | −12.314 | 23.881 | −8.840 | 1.00 | 1.00 | C |
| ATOM | 5422 | N3 | C | B | 8 | −13.228 | 23.990 | −7.980 | 1.00 | 1.00 | N |
| ATOM | 5423 | O2 | C | B | 8 | −15.439 | 23.995 | −7.385 | 1.00 | 1.00 | O |
| ATOM | 5424 | C2 | C | B | 8 | −14.646 | 23.864 | −8.319 | 1.00 | 1.00 | C |
| ATOM | 5425 | H5*1 | C | B | 8 | −17.328 | 21.646 | −13.529 | 1.00 | 1.00 | H |
| ATOM | 5426 | H5*2 | C | B | 8 | −17.927 | 23.210 | −14.046 | 1.00 | 1.00 | H |
| ATOM | 5427 | H4* | C | B | 8 | −18.572 | 22.879 | −11.608 | 1.00 | 1.00 | H |
| ATOM | 5428 | H1* | C | B | 8 | −16.927 | 22.835 | −9.149 | 1.00 | 1.00 | H |
| ATOM | 5429 | H2*1 | C | B | 8 | −17.732 | 24.903 | −9.615 | 1.00 | 1.00 | H |
| ATOM | 5430 | H2*2 | C | B | 8 | −16.148 | 25.607 | −10.341 | 1.00 | 1.00 | H |
| ATOM | 5431 | H3* | C | B | 8 | −16.564 | 24.948 | −12.437 | 1.00 | 1.00 | H |
| ATOM | 5432 | H6 | C | B | 8 | −14.227 | 23.270 | −11.602 | 1.00 | 1.00 | H |
| ATOM | 5433 | H5 | C | B | 8 | −11.974 | 23.522 | −11.001 | 1.00 | 1.00 | H |
| ATOM | 5434 | H41 | C | B | 8 | −10.754 | 24.151 | −7.564 | 1.00 | 1.00 | H |
| ATOM | 5435 | H42 | C | B | 8 | −10.281 | 23.841 | −9.293 | 1.00 | 1.00 | H |
| ATOM | 5436 | P | G | B | 9 | −18.789 | 26.828 | −12.316 | 1.00 | 1.00 | P |
| ATOM | 5437 | O1P | G | B | 9 | −20.178 | 27.026 | −12.741 | 1.00 | 1.00 | O |
| ATOM | 5438 | O2P | G | B | 9 | −17.741 | 27.664 | −12.965 | 1.00 | 1.00 | O |
| ATOM | 5439 | O5* | G | B | 9 | −18.832 | 27.287 | −10.786 | 1.00 | 1.00 | O |
| ATOM | 5440 | C5* | G | B | 9 | −19.889 | 27.068 | −9.894 | 1.00 | 1.00 | C |
| ATOM | 5441 | C4* | G | B | 9 | −19.641 | 27.900 | −8.611 | 1.00 | 1.00 | C |
| ATOM | 5442 | O4* | G | B | 9 | −18.346 | 27.598 | −8.073 | 1.00 | 1.00 | O |
| ATOM | 5443 | C1* | G | B | 9 | −17.591 | 28.747 | −7.830 | 1.00 | 1.00 | C |
| ATOM | 5444 | C2* | G | B | 9 | −18.220 | 29.831 | −8.743 | 1.00 | 1.00 | C |
| ATOM | 5445 | C3* | G | B | 9 | −19.695 | 29.399 | −8.929 | 1.00 | 1.00 | C |
| ATOM | 5446 | O3* | G | B | 9 | −20.601 | 30.061 | −8.001 | 1.00 | 1.00 | O |
| ATOM | 5447 | N9 | G | B | 9 | −16.203 | 28.325 | −8.032 | 1.00 | 1.00 | N |
| ATOM | 5448 | C8 | G | B | 9 | −15.746 | 28.016 | −9.201 | 1.00 | 1.00 | C |
| ATOM | 5449 | N7 | G | B | 9 | −14.519 | 27.739 | −9.094 | 1.00 | 1.00 | N |
| ATOM | 5450 | C5 | G | B | 9 | −14.086 | 27.936 | −7.742 | 1.00 | 1.00 | C |
| ATOM | 5451 | O6 | G | B | 9 | −11.796 | 27.602 | −7.445 | 1.00 | 1.00 | O |
| ATOM | 5452 | C6 | G | B | 9 | −12.856 | 27.908 | −6.922 | 1.00 | 1.00 | C |
| ATOM | 5453 | N1 | G | B | 9 | −12.987 | 28.216 | −5.621 | 1.00 | 1.00 | N |
| ATOM | 5454 | N2 | G | B | 9 | −14.134 | 28.801 | −3.738 | 1.00 | 1.00 | N |
| ATOM | 5455 | C2 | G | B | 9 | −14.102 | 28.544 | −5.021 | 1.00 | 1.00 | C |
| ATOM | 5456 | N3 | G | B | 9 | −15.189 | 28.579 | −5.707 | 1.00 | 1.00 | N |
| ATOM | 5457 | C4 | G | B | 9 | −15.200 | 28.314 | −7.138 | 1.00 | 1.00 | C |
| ATOM | 5458 | H5*1 | G | B | 9 | −19.897 | 26.001 | −9.773 | 1.00 | 1.00 | H |
| ATOM | 5459 | H5*2 | G | B | 9 | −20.904 | 27.286 | −10.243 | 1.00 | 1.00 | H |
| ATOM | 5460 | H4* | G | B | 9 | −20.493 | 27.668 | −7.986 | 1.00 | 1.00 | H |
| ATOM | 5461 | H1* | G | B | 9 | −17.779 | 29.094 | −6.784 | 1.00 | 1.00 | H |
| ATOM | 5462 | H2*1 | G | B | 9 | −18.114 | 30.826 | −8.268 | 1.00 | 1.00 | H |
| ATOM | 5463 | H2*2 | G | B | 9 | −17.673 | 29.813 | −9.697 | 1.00 | 1.00 | H |
| ATOM | 5464 | H3* | G | B | 9 | −20.015 | 29.601 | −9.962 | 1.00 | 1.00 | H |
| ATOM | 5465 | H8 | G | B | 9 | −16.314 | 27.961 | −10.108 | 1.00 | 1.00 | H |
| ATOM | 5466 | H1 | G | B | 9 | −12.110 | 28.116 | −5.121 | 1.00 | 1.00 | H |
| ATOM | 5467 | H21 | G | B | 9 | −15.028 | 29.144 | −3.313 | 1.00 | 1.00 | H |
| ATOM | 5468 | H22 | G | B | 9 | −13.284 | 28.700 | −3.156 | 1.00 | 1.00 | H |
| ATOM | 5469 | P | C | B | 10 | −20.868 | 31.636 | −8.095 | 1.00 | 1.00 | P |
| ATOM | 5470 | O1P | C | B | 10 | −22.094 | 31.996 | −7.319 | 1.00 | 1.00 | O |
| ATOM | 5471 | O2P | C | B | 10 | −21.176 | 32.136 | −9.466 | 1.00 | 1.00 | O |
| ATOM | 5472 | O5* | C | B | 10 | −19.589 | 32.264 | −7.457 | 1.00 | 1.00 | O |
| ATOM | 5473 | C5* | C | B | 10 | −19.587 | 32.170 | −6.031 | 1.00 | 1.00 | C |
| ATOM | 5474 | C4* | C | B | 10 | −18.234 | 32.618 | −5.427 | 1.00 | 1.00 | C |
| ATOM | 5475 | O4* | C | B | 10 | −17.161 | 31.747 | −5.882 | 1.00 | 1.00 | O |
| ATOM | 5476 | C1* | C | B | 10 | −15.928 | 32.412 | −5.519 | 1.00 | 1.00 | C |
| ATOM | 5477 | C2* | C | B | 10 | −16.244 | 33.921 | −5.479 | 1.00 | 1.00 | C |
| ATOM | 5478 | C3* | C | B | 10 | −17.758 | 34.026 | −5.851 | 1.00 | 1.00 | C |
| ATOM | 5479 | O3* | C | B | 10 | −18.438 | 34.942 | −5.015 | 1.00 | 1.00 | O |
| ATOM | 5480 | N1 | C | B | 10 | −14.974 | 32.009 | −6.543 | 1.00 | 1.00 | N |
| ATOM | 5481 | C6 | C | B | 10 | −15.334 | 31.783 | −7.832 | 1.00 | 1.00 | C |
| ATOM | 5482 | C5 | C | B | 10 | −14.504 | 31.274 | −8.746 | 1.00 | 1.00 | C |
| ATOM | 5483 | N4 | C | B | 10 | −12.215 | 30.493 | −9.197 | 1.00 | 1.00 | N |
| ATOM | 5484 | C4 | C | B | 10 | −13.099 | 30.948 | −8.353 | 1.00 | 1.00 | C |
| ATOM | 5485 | N3 | C | B | 10 | −12.782 | 31.195 | −7.157 | 1.00 | 1.00 | N |
| ATOM | 5486 | O2 | C | B | 10 | −13.330 | 31.894 | −5.025 | 1.00 | 1.00 | O |
| ATOM | 5487 | C2 | C | B | 10 | −13.693 | 31.747 | −6.183 | 1.00 | 1.00 | C |
| ATOM | 5488 | H5*1 | C | B | 10 | −19.750 | 31.127 | −5.738 | 1.00 | 1.00 | H |
| ATOM | 5489 | H5*2 | C | B | 10 | −20.401 | 32.754 | −5.639 | 1.00 | 1.00 | H |
| ATOM | 5490 | H4* | C | B | 10 | −18.231 | 32.619 | −4.335 | 1.00 | 1.00 | H |
| ATOM | 5491 | H1* | C | B | 10 | −15.752 | 31.976 | −4.493 | 1.00 | 1.00 | H |
| ATOM | 5492 | H2*1 | C | B | 10 | −16.119 | 34.314 | −4.465 | 1.00 | 1.00 | H |
| ATOM | 5493 | H2*2 | C | B | 10 | −15.586 | 34.527 | −6.168 | 1.00 | 1.00 | H |
| ATOM | 5494 | H3* | C | B | 10 | −17.962 | 34.301 | −6.906 | 1.00 | 1.00 | H |
| ATOM | 5495 | H6 | C | B | 10 | −16.315 | 32.055 | −8.126 | 1.00 | 1.00 | H |
| ATOM | 5496 | H5 | C | B | 10 | −14.816 | 31.091 | −9.769 | 1.00 | 1.00 | H |
| ATOM | 5497 | H41 | C | B | 10 | −11.203 | 30.370 | −8.919 | 1.00 | 1.00 | H |
| ATOM | 5498 | H42 | C | B | 10 | −12.493 | 30.353 | −10.167 | 1.00 | 1.00 | H |
| ATOM | 5499 | P | T | B | 11 | −18.279 | 36.516 | −5.075 | 1.00 | 1.00 | P |
| ATOM | 5500 | O1P | T | B | 11 | −19.363 | 37.115 | −4.226 | 1.00 | 1.00 | O |
| ATOM | 5501 | O2P | T | B | 11 | −18.482 | 36.915 | −6.493 | 1.00 | 1.00 | O |
| ATOM | 5502 | O5* | T | B | 11 | −16.793 | 36.910 | −4.660 | 1.00 | 1.00 | O |
| ATOM | 5503 | C5* | T | B | 11 | −16.357 | 37.084 | −3.309 | 1.00 | 1.00 | C |
| ATOM | 5504 | C4* | T | B | 11 | −14.832 | 37.055 | −3.440 | 1.00 | 1.00 | C |
| ATOM | 5505 | O4* | T | B | 11 | −14.273 | 35.984 | −4.219 | 1.00 | 1.00 | O |
| ATOM | 5506 | C1* | T | B | 11 | −12.956 | 36.338 | −4.625 | 1.00 | 1.00 | C |
| ATOM | 5507 | C2* | T | B | 11 | −12.976 | 37.890 | −4.772 | 1.00 | 1.00 | C |
| ATOM | 5508 | C3* | T | B | 11 | −14.291 | 38.381 | −4.071 | 1.00 | 1.00 | C |
| ATOM | 5509 | O3* | T | B | 11 | −14.074 | 39.278 | −2.958 | 1.00 | 1.00 | O |
| ATOM | 5510 | N1 | T | B | 11 | −12.650 | 35.651 | −5.866 | 1.00 | 1.00 | N |
| ATOM | 5511 | C6 | T | B | 11 | −13.576 | 35.693 | −6.870 | 1.00 | 1.00 | C |
| ATOM | 5512 | C5M | T | B | 11 | −14.499 | 35.102 | −9.088 | 1.00 | 1.00 | C |
| ATOM | 5513 | C5 | T | B | 11 | −13.418 | 35.051 | −8.047 | 1.00 | 1.00 | C |
| ATOM | 5514 | O4 | T | B | 11 | −11.879 | 33.791 | −9.285 | 1.00 | 1.00 | O |
| ATOM | 5515 | C4 | T | B | 11 | −12.126 | 34.332 | −8.222 | 1.00 | 1.00 | C |
| ATOM | 5516 | N3 | T | B | 11 | −11.277 | 34.282 | −7.192 | 1.00 | 1.00 | N |
| ATOM | 5517 | O2 | T | B | 11 | −10.662 | 34.801 | −5.083 | 1.00 | 1.00 | O |
| ATOM | 5518 | C2 | T | B | 11 | −11.476 | 34.922 | −5.995 | 1.00 | 1.00 | C |
| ATOM | 5519 | H5*1 | T | B | 11 | −16.698 | 36.180 | −2.794 | 1.00 | 1.00 | H |
| ATOM | 5520 | H5*2 | T | B | 11 | −16.792 | 37.930 | −2.754 | 1.00 | 1.00 | H |
| ATOM | 5521 | H4* | T | B | 11 | −14.429 | 36.883 | −2.427 | 1.00 | 1.00 | H |
| ATOM | 5522 | H1* | T | B | 11 | −12.277 | 36.042 | −3.793 | 1.00 | 1.00 | H |
| ATOM | 5523 | H2*1 | T | B | 11 | −12.156 | 38.288 | −4.177 | 1.00 | 1.00 | H |
| ATOM | 5524 | H2*2 | T | B | 11 | −12.967 | 38.234 | −5.798 | 1.00 | 1.00 | H |
| ATOM | 5525 | H3* | T | B | 11 | −15.092 | 38.843 | −4.705 | 1.00 | 1.00 | H |
| ATOM | 5526 | H6 | T | B | 11 | −14.525 | 36.230 | −6.847 | 1.00 | 1.00 | H |
| ATOM | 5527 | H51 | T | B | 11 | −14.117 | 35.443 | −10.085 | 1.00 | 1.00 | H |
| ATOM | 5528 | H52 | T | B | 11 | −14.785 | 34.065 | −9.271 | 1.00 | 1.00 | H |
| ATOM | 5529 | H53 | T | B | 11 | −15.415 | 35.686 | −8.986 | 1.00 | 1.00 | H |
| ATOM | 5530 | H3 | T | B | 11 | −10.496 | 33.752 | −7.471 | 1.00 | 1.00 | H |
| ATOM | 5531 | P | C | B | 12 | −13.415 | 40.706 | −2.886 | 1.00 | 1.00 | P |
| ATOM | 5532 | O1P | C | B | 12 | −13.642 | 41.103 | −1.467 | 1.00 | 1.00 | O |
| ATOM | 5533 | O2P | C | B | 12 | −14.098 | 41.613 | −3.866 | 1.00 | 1.00 | O |
| ATOM | 5534 | O5* | C | B | 12 | −11.843 | 40.616 | −3.145 | 1.00 | 1.00 | O |
| ATOM | 5535 | C5* | C | B | 12 | −10.814 | 40.226 | −2.254 | 1.00 | 1.00 | C |
| ATOM | 5536 | C4* | C | B | 12 | −9.533 | 40.006 | −3.032 | 1.00 | 1.00 | C |
| ATOM | 5537 | O4* | C | B | 12 | −9.828 | 39.108 | −4.120 | 1.00 | 1.00 | O |
| ATOM | 5538 | C1* | C | B | 12 | −8.793 | 39.119 | −5.112 | 1.00 | 1.00 | C |
| ATOM | 5539 | C2* | C | B | 12 | −8.527 | 40.652 | −5.180 | 1.00 | 1.00 | C |
| ATOM | 5540 | C3* | C | B | 12 | −9.043 | 41.210 | −3.828 | 1.00 | 1.00 | C |
| ATOM | 5541 | O3* | C | B | 12 | −8.024 | 41.758 | −3.056 | 1.00 | 1.00 | O |
| ATOM | 5542 | N1 | C | B | 12 | −9.340 | 38.646 | −6.376 | 1.00 | 1.00 | N |
| ATOM | 5543 | C6 | C | B | 12 | −10.544 | 39.083 | −6.828 | 1.00 | 1.00 | C |
| ATOM | 5544 | C5 | C | B | 12 | −11.132 | 38.633 | −7.960 | 1.00 | 1.00 | C |
| ATOM | 5545 | N4 | C | B | 12 | −10.987 | 37.086 | −9.833 | 1.00 | 1.00 | N |
| ATOM | 5546 | C4 | C | B | 12 | −10.507 | 37.585 | −8.729 | 1.00 | 1.00 | C |
| ATOM | 5547 | N3 | C | B | 12 | −9.350 | 37.240 | −8.359 | 1.00 | 1.00 | N |
| ATOM | 5548 | O2 | C | B | 12 | −7.532 | 37.374 | −7.017 | 1.00 | 1.00 | O |
| ATOM | 5549 | C2 | C | B | 12 | −8.700 | 37.720 | −7.139 | 1.00 | 1.00 | C |
| ATOM | 5550 | H5*1 | C | B | 12 | −11.151 | 39.385 | −1.598 | 1.00 | 1.00 | H |
| ATOM | 5551 | H5*2 | C | B | 12 | −10.687 | 41.048 | −1.556 | 1.00 | 1.00 | H |
| ATOM | 5552 | H4* | C | B | 12 | −8.752 | 39.564 | −2.367 | 1.00 | 1.00 | H |
| ATOM | 5553 | H1* | C | B | 12 | −7.939 | 38.522 | −4.753 | 1.00 | 1.00 | H |
| ATOM | 5554 | H2*1 | C | B | 12 | −7.496 | 40.835 | −5.312 | 1.00 | 1.00 | H |
| ATOM | 5555 | H2*2 | C | B | 12 | −9.129 | 41.158 | −5.971 | 1.00 | 1.00 | H |
| ATOM | 5556 | H3* | C | B | 12 | −9.932 | 41.872 | −4.071 | 1.00 | 1.00 | H |
| ATOM | 5557 | H6 | C | B | 12 | −11.048 | 39.851 | −6.222 | 1.00 | 1.00 | H |
| ATOM | 5558 | H5 | C | B | 12 | −12.083 | 39.029 | −8.265 | 1.00 | 1.00 | H |
| ATOM | 5559 | H41 | C | B | 12 | −10.412 | 36.479 | −10.450 | 1.00 | 1.00 | H |
| ATOM | 5560 | H42 | C | B | 12 | −11.906 | 37.388 | −10.178 | 1.00 | 1.00 | H |
| ATOM | 5561 | P | G | B | 13 | −7.073 | 43.034 | −3.229 | 1.00 | 1.00 | P |
| ATOM | 5562 | O1P | G | B | 13 | −6.297 | 43.476 | −2.031 | 1.00 | 1.00 | O |
| ATOM | 5563 | O2P | G | B | 13 | −7.802 | 44.182 | −3.858 | 1.00 | 1.00 | O |
| ATOM | 5564 | O5* | G | B | 13 | −5.904 | 42.576 | −4.284 | 1.00 | 1.00 | O |
| ATOM | 5565 | C5* | G | B | 13 | −4.859 | 41.753 | −3.818 | 1.00 | 1.00 | C |
| ATOM | 5566 | C4* | G | B | 13 | −3.974 | 41.438 | −5.065 | 1.00 | 1.00 | C |
| ATOM | 5567 | O4* | G | B | 13 | −4.793 | 40.766 | −6.057 | 1.00 | 1.00 | O |
| ATOM | 5568 | C1* | G | B | 13 | −4.535 | 41.391 | −7.341 | 1.00 | 1.00 | C |
| ATOM | 5569 | C2* | G | B | 13 | −4.284 | 42.898 | −6.955 | 1.00 | 1.00 | C |
| ATOM | 5570 | C3* | G | B | 13 | −3.412 | 42.750 | −5.683 | 1.00 | 1.00 | C |
| ATOM | 5571 | O3* | G | B | 13 | −2.080 | 42.382 | −6.130 | 1.00 | 1.00 | O |
| ATOM | 5572 | N9 | G | B | 13 | −5.677 | 41.168 | −8.227 | 1.00 | 1.00 | N |
| ATOM | 5573 | C8 | G | B | 13 | −6.843 | 41.756 | −8.064 | 1.00 | 1.00 | C |
| ATOM | 5574 | N7 | G | B | 13 | −7.637 | 41.377 | −8.968 | 1.00 | 1.00 | N |
| ATOM | 5575 | C5 | G | B | 13 | −6.989 | 40.374 | −9.757 | 1.00 | 1.00 | C |
| ATOM | 5576 | O6 | G | B | 13 | −8.544 | 39.475 | −11.238 | 1.00 | 1.00 | O |
| ATOM | 5577 | C6 | G | B | 13 | −7.384 | 39.551 | −10.884 | 1.00 | 1.00 | C |
| ATOM | 5578 | N1 | G | B | 13 | −6.342 | 38.812 | −11.396 | 1.00 | 1.00 | N |
| ATOM | 5579 | N2 | G | B | 13 | −4.181 | 38.090 | −11.521 | 1.00 | 1.00 | N |
| ATOM | 5580 | C2 | G | B | 13 | −5.060 | 38.825 | −10.921 | 1.00 | 1.00 | C |
| ATOM | 5581 | N3 | G | B | 13 | −4.746 | 39.470 | −9.877 | 1.00 | 1.00 | N |
| ATOM | 5582 | C4 | G | B | 13 | −5.770 | 40.320 | −9.243 | 1.00 | 1.00 | C |
| ATOM | 5583 | H5*1 | G | B | 13 | −5.397 | 40.818 | −3.475 | 1.00 | 1.00 | H |
| ATOM | 5584 | H5*2 | G | B | 13 | −4.170 | 42.094 | −3.068 | 1.00 | 1.00 | H |
| ATOM | 5585 | H4* | G | B | 13 | −3.115 | 40.786 | −4.876 | 1.00 | 1.00 | H |
| ATOM | 5586 | H1* | G | B | 13 | −3.729 | 40.852 | −7.891 | 1.00 | 1.00 | H |
| ATOM | 5587 | H2*1 | G | B | 13 | −3.788 | 43.453 | −7.719 | 1.00 | 1.00 | H |
| ATOM | 5588 | H2*2 | G | B | 13 | −5.234 | 43.527 | −6.763 | 1.00 | 1.00 | H |
| ATOM | 5589 | H3* | G | B | 13 | −3.402 | 43.611 | −5.019 | 1.00 | 1.00 | H |
| ATOM | 5590 | H8 | G | B | 13 | −7.186 | 42.491 | −7.351 | 1.00 | 1.00 | H |
| ATOM | 5591 | H1 | G | B | 13 | −6.591 | 38.261 | −12.223 | 1.00 | 1.00 | H |
| ATOM | 5592 | H21 | G | B | 13 | −3.216 | 37.998 | −11.125 | 1.00 | 1.00 | H |
| ATOM | 5593 | H22 | G | B | 13 | −4.417 | 37.621 | −12.389 | 1.00 | 1.00 | H |
| ATOM | 5594 | P | A | B | 14 | −0.974 | 43.331 | −6.757 | 1.00 | 1.00 | P |
| ATOM | 5595 | O1P | A | B | 14 | 0.147 | 43.235 | −5.788 | 1.00 | 1.00 | O |
| ATOM | 5596 | O2P | A | B | 14 | −1.472 | 44.751 | −6.655 | 1.00 | 1.00 | O |
| ATOM | 5597 | O5* | A | B | 14 | −0.623 | 42.891 | −8.251 | 1.00 | 1.00 | O |
| ATOM | 5598 | C5* | A | B | 14 | 0.267 | 41.766 | −8.359 | 1.00 | 1.00 | C |
| ATOM | 5599 | C4* | A | B | 14 | 0.314 | 41.376 | −9.873 | 1.00 | 1.00 | C |
| ATOM | 5600 | O4* | A | B | 14 | −1.048 | 40.979 | −10.210 | 1.00 | 1.00 | O |
| ATOM | 5601 | C1* | A | B | 14 | −1.349 | 41.351 | −11.568 | 1.00 | 1.00 | C |
| ATOM | 5602 | C2* | A | B | 14 | −0.416 | 42.533 | −11.868 | 1.00 | 1.00 | C |
| ATOM | 5603 | C3* | A | B | 14 | 0.722 | 42.546 | −10.835 | 1.00 | 1.00 | C |
| ATOM | 5604 | O3* | A | B | 14 | 1.981 | 42.171 | −11.453 | 1.00 | 1.00 | O |
| ATOM | 5605 | N9 | A | B | 14 | −2.777 | 41.736 | −11.686 | 1.00 | 1.00 | N |
| ATOM | 5606 | C8 | A | B | 14 | −3.393 | 42.442 | −10.799 | 1.00 | 1.00 | C |
| ATOM | 5607 | N7 | A | B | 14 | −4.627 | 42.559 | −11.041 | 1.00 | 1.00 | N |
| ATOM | 5608 | C5 | A | B | 14 | −4.926 | 41.880 | −12.201 | 1.00 | 1.00 | C |
| ATOM | 5609 | N6 | A | B | 14 | −7.298 | 42.162 | −12.605 | 1.00 | 1.00 | N |
| ATOM | 5610 | C6 | A | B | 14 | −6.059 | 41.644 | −12.950 | 1.00 | 1.00 | C |
| ATOM | 5611 | N1 | A | B | 14 | −5.893 | 40.830 | −14.024 | 1.00 | 1.00 | N |
| ATOM | 5612 | C2 | A | B | 14 | −4.714 | 40.179 | −14.298 | 1.00 | 1.00 | C |
| ATOM | 5613 | N3 | A | B | 14 | −3.618 | 40.506 | −13.598 | 1.00 | 1.00 | N |
| ATOM | 5614 | C4 | A | B | 14 | −3.697 | 41.358 | −12.585 | 1.00 | 1.00 | C |
| ATOM | 5615 | H5*1 | A | B | 14 | −0.070 | 40.993 | −7.669 | 1.00 | 1.00 | H |
| ATOM | 5616 | H5*2 | A | B | 14 | 1.258 | 42.090 | −8.054 | 1.00 | 1.00 | H |
| ATOM | 5617 | H4* | A | B | 14 | 1.017 | 40.523 | −10.041 | 1.00 | 1.00 | H |
| ATOM | 5618 | H1* | A | B | 14 | −1.126 | 40.492 | −12.184 | 1.00 | 1.00 | H |
| ATOM | 5619 | H2*1 | A | B | 14 | 0.042 | 42.568 | −12.867 | 1.00 | 1.00 | H |
| ATOM | 5620 | H2*2 | A | B | 14 | −0.979 | 43.504 | −11.787 | 1.00 | 1.00 | H |
| ATOM | 5621 | H3* | A | B | 14 | 0.770 | 43.486 | −10.207 | 1.00 | 1.00 | H |
| ATOM | 5622 | H8 | A | B | 14 | −2.827 | 42.787 | −9.970 | 1.00 | 1.00 | H |
| ATOM | 5623 | H61 | A | B | 14 | −7.406 | 42.643 | −11.681 | 1.00 | 1.00 | H |
| ATOM | 5624 | H62 | A | B | 14 | −8.115 | 41.987 | −13.191 | 1.00 | 1.00 | H |
| ATOM | 5625 | H2 | A | B | 14 | −4.637 | 39.457 | −15.074 | 1.00 | 1.00 | H |
| ATOM | 5626 | P | A | B | 15 | 2.802 | 42.972 | −12.572 | 1.00 | 1.00 | P |
| ATOM | 5627 | O1P | A | B | 15 | 4.188 | 42.421 | −12.603 | 1.00 | 1.00 | O |
| ATOM | 5628 | O2P | A | B | 15 | 2.881 | 44.321 | −12.020 | 1.00 | 1.00 | O |
| ATOM | 5629 | O5* | A | B | 15 | 2.170 | 42.882 | −14.040 | 1.00 | 1.00 | O |
| ATOM | 5630 | C5* | A | B | 15 | 2.031 | 41.643 | −14.749 | 1.00 | 1.00 | C |
| ATOM | 5631 | C4* | A | B | 15 | 1.120 | 41.842 | −15.968 | 1.00 | 1.00 | C |
| ATOM | 5632 | O4* | A | B | 15 | −0.159 | 42.194 | −15.418 | 1.00 | 1.00 | O |
| ATOM | 5633 | C1* | A | B | 15 | −0.768 | 43.197 | −16.209 | 1.00 | 1.00 | C |
| ATOM | 5634 | C2* | A | B | 15 | 0.453 | 44.129 | −16.425 | 1.00 | 1.00 | C |
| ATOM | 5635 | C3* | A | B | 15 | 1.490 | 43.056 | −16.860 | 1.00 | 1.00 | C |
| ATOM | 5636 | O3* | A | B | 15 | 1.154 | 42.647 | −18.183 | 1.00 | 1.00 | O |
| ATOM | 5637 | N9 | A | B | 15 | −1.824 | 43.770 | −15.348 | 1.00 | 1.00 | N |
| ATOM | 5638 | C8 | A | B | 15 | −1.738 | 44.435 | −14.218 | 1.00 | 1.00 | C |
| ATOM | 5639 | N7 | A | B | 15 | −2.903 | 44.749 | −13.791 | 1.00 | 1.00 | N |
| ATOM | 5640 | C5 | A | B | 15 | −3.865 | 44.242 | −14.573 | 1.00 | 1.00 | C |
| ATOM | 5641 | N6 | A | B | 15 | −5.818 | 44.901 | −13.515 | 1.00 | 1.00 | N |
| ATOM | 5642 | C6 | A | B | 15 | −5.252 | 44.343 | −14.589 | 1.00 | 1.00 | C |
| ATOM | 5643 | N1 | A | B | 15 | −5.855 | 43.927 | −15.707 | 1.00 | 1.00 | N |
| ATOM | 5644 | C2 | A | B | 15 | −5.205 | 43.155 | −16.606 | 1.00 | 1.00 | C |
| ATOM | 5645 | N3 | A | B | 15 | −3.874 | 42.988 | −16.576 | 1.00 | 1.00 | N |
| ATOM | 5646 | C4 | A | B | 15 | −3.171 | 43.579 | −15.600 | 1.00 | 1.00 | C |
| ATOM | 5647 | H5*1 | A | B | 15 | 1.565 | 40.899 | −14.050 | 1.00 | 1.00 | H |
| ATOM | 5648 | H5*2 | A | B | 15 | 3.024 | 41.294 | −15.047 | 1.00 | 1.00 | H |
| ATOM | 5649 | H4* | A | B | 15 | 1.095 | 40.898 | −16.542 | 1.00 | 1.00 | H |
| ATOM | 5650 | H1* | A | B | 15 | −1.184 | 42.882 | −17.172 | 1.00 | 1.00 | H |
| ATOM | 5651 | H2*1 | A | B | 15 | 0.327 | 44.839 | −17.249 | 1.00 | 1.00 | H |
| ATOM | 5652 | H2*2 | A | B | 15 | 0.758 | 44.690 | −15.550 | 1.00 | 1.00 | H |
| ATOM | 5653 | H3* | A | B | 15 | 2.535 | 43.337 | −16.677 | 1.00 | 1.00 | H |
| ATOM | 5654 | H8 | A | B | 15 | −0.821 | 44.738 | −13.674 | 1.00 | 1.00 | H |
| ATOM | 5655 | H61 | A | B | 15 | −5.235 | 45.212 | −12.697 | 1.00 | 1.00 | H |
| ATOM | 5656 | H62 | A | B | 15 | −6.839 | 44.805 | −13.371 | 1.00 | 1.00 | H |
| ATOM | 5657 | H2 | A | B | 15 | −5.818 | 42.644 | −17.364 | 1.00 | 1.00 | H |
| ATOM | 5658 | H9 | A | B | 15 | 1.328 | 43.353 | −18.798 | 1.00 | 1.00 | H |
| TER | | | | | | | | | | | |
| HETATM | 5659 | H5*1 | DRG | C | 1 | −6.234 | 4.404 | −4.753 | 1.00 | 1.00 | H |
| HETATM | 5660 | H5*2 | DRG | C | 1 | −7.640 | 5.215 | −5.457 | 1.00 | 1.00 | H |
| HETATM | 5661 | H4* | DRG | C | 1 | −5.518 | 6.203 | −6.211 | 1.00 | 1.00 | H |
| HETATM | 5662 | H1* | DRG | C | 1 | −4.682 | 9.088 | −5.766 | 1.00 | 1.00 | H |
| HETATM | 5663 | H2*1 | DRG | C | 1 | −3.036 | 7.500 | −5.113 | 1.00 | 1.00 | H |
| HETATM | 5664 | H2*2 | DRG | C | 1 | −3.432 | 7.765 | −3.331 | 1.00 | 1.00 | H |
| HETATM | 5665 | H3* | DRG | C | 1 | −4.886 | 5.962 | −3.282 | 1.00 | 1.00 | H |
| HETATM | 5666 | H8 | DRG | C | 1 | −7.116 | 8.923 | −3.087 | 1.00 | 1.00 | H |
| HETATM | 5667 | H61 | DRG | C | 1 | −6.048 | 12.553 | −0.414 | 1.00 | 1.00 | H |
| HETATM | 5668 | H62 | DRG | C | 1 | −4.643 | 13.636 | −0.176 | 1.00 | 1.00 | H |
| HETATM | 5669 | H2 | DRG | C | 1 | −1.642 | 12.255 | −3.458 | 1.00 | 1.00 | H |
| HETATM | 5670 | O1 | DRG | C | 1 | −6.465 | 4.206 | −1.473 | 1.00 | 1.00 | O |
| HETATM | 5671 | H3 | DRG | C | 1 | −3.408 | 5.274 | −5.618 | 1.00 | 1.00 | H |
| HETATM | 5672 | P | DRG | C | 1 | −7.712 | 4.826 | −2.256 | 1.00 | 1.00 | P |
| HETATM | 5673 | O1P | DRG | C | 1 | −8.592 | 5.594 | −1.295 | 1.00 | 1.00 | O |
| HETATM | 5674 | O2P | DRG | C | 1 | −8.561 | 3.811 | −2.977 | 1.00 | 1.00 | O |
| HETATM | 5675 | O5* | DRG | C | 1 | −7.262 | 5.761 | −3.432 | 1.00 | 1.00 | O |
| HETATM | 5676 | C5* | DRG | C | 1 | −6.840 | 5.335 | −4.712 | 1.00 | 1.00 | C |
| HETATM | 5677 | C4* | DRG | C | 1 | −5.821 | 6.420 | −5.169 | 1.00 | 1.00 | C |
| HETATM | 5678 | O4* | DRG | C | 1 | −6.218 | 7.779 | −4.952 | 1.00 | 1.00 | O |
| HETATM | 5679 | C1* | DRG | C | 1 | −4.947 | 8.538 | −4.797 | 1.00 | 1.00 | C |
| HETATM | 5680 | C2* | DRG | C | 1 | −3.853 | 7.586 | −4.341 | 1.00 | 1.00 | C |
| HETATM | 5681 | C3* | DRG | C | 1 | −4.533 | 6.224 | −4.325 | 1.00 | 1.00 | C |
| HETATM | 5682 | O3* | DRG | C | 1 | −3.692 | 5.130 | −4.720 | 1.00 | 1.00 | O |
| HETATM | 5683 | N9 | DRG | C | 1 | −5.231 | 9.507 | −3.766 | 1.00 | 1.00 | N |
| HETATM | 5684 | C8 | DRG | C | 1 | −6.272 | 9.528 | −3.047 | 1.00 | 1.00 | C |
| HETATM | 5685 | N7 | DRG | C | 1 | −6.158 | 10.412 | −2.154 | 1.00 | 1.00 | N |
| HETATM | 5686 | C5 | DRG | C | 1 | −5.018 | 11.103 | −2.345 | 1.00 | 1.00 | C |
| HETATM | 5687 | N6 | DRG | C | 1 | −5.085 | 12.834 | −0.637 | 1.00 | 1.00 | N |
| HETATM | 5688 | C6 | DRG | C | 1 | −4.479 | 12.217 | −1.694 | 1.00 | 1.00 | C |
| HETATM | 5689 | N1 | DRG | C | 1 | −3.292 | 12.621 | −2.168 | 1.00 | 1.00 | N |
| HETATM | 5690 | C2 | DRG | C | 1 | −2.646 | 11.967 | −3.180 | 1.00 | 1.00 | C |
| HETATM | 5691 | N3 | DRG | C | 1 | −3.200 | 10.926 | −3.832 | 1.00 | 1.00 | N |
| HETATM | 5692 | C4 | DRG | C | 1 | −4.378 | 10.496 | −3.400 | 1.00 | 1.00 | C |
| HETATM | 5693 | P12 | DRG | C | 1 | −5.757 | 2.877 | −2.006 | 1.00 | 1.00 | P |
| HETATM | 5694 | O12 | DRG | C | 1 | −6.628 | 2.525 | −3.129 | 1.00 | 1.00 | O |
| HETATM | 5695 | O13 | DRG | C | 1 | −4.368 | 2.965 | −2.594 | 1.00 | 1.00 | O |
| HETATM | 5696 | O14 | DRG | C | 1 | −5.954 | 1.686 | −0.980 | 1.00 | 1.00 | O |
| HETATM | 5697 | P12 | DRG | C | 1 | −7.421 | 1.164 | −0.904 | 1.00 | 1.00 | P |
| HETATM | 5698 | O12 | DRG | C | 1 | −7.795 | 0.208 | 0.168 | 1.00 | 1.00 | O |
| HETATM | 5699 | O13 | DRG | C | 1 | −8.524 | 2.044 | −1.374 | 1.00 | 1.00 | O |
| HETATM | 5700 | O14 | DRG | C | 1 | −7.878 | 0.803 | −2.282 | 1.00 | 1.00 | O |
| TER | | | | | | | | | | | |
| ATOM | 5701 | P | T | D | 1 | −16.243 | 44.859 | −18.466 | 1.00 | 1.00 | P |
| ATOM | 5702 | O1P | T | D | 1 | −15.981 | 46.317 | −18.398 | 1.00 | 1.00 | O |
| ATOM | 5703 | O2P | T | D | 1 | −17.352 | 44.483 | −19.420 | 1.00 | 1.00 | O |
| ATOM | 5704 | O5* | T | D | 1 | −14.832 | 44.218 | −18.868 | 1.00 | 1.00 | O |
| ATOM | 5705 | C5* | T | D | 1 | −14.342 | 44.382 | −20.210 | 1.00 | 1.00 | C |
| ATOM | 5706 | C4* | T | D | 1 | −12.864 | 43.864 | −20.288 | 1.00 | 1.00 | C |
| ATOM | 5707 | O4* | T | D | 1 | −12.002 | 44.648 | −19.443 | 1.00 | 1.00 | O |
| ATOM | 5708 | C1* | T | D | 1 | −10.766 | 43.887 | −19.189 | 1.00 | 1.00 | C |
| ATOM | 5709 | C2* | T | D | 1 | −11.059 | 42.405 | −19.588 | 1.00 | 1.00 | C |
| ATOM | 5710 | C3* | T | D | 1 | −12.609 | 42.444 | −19.799 | 1.00 | 1.00 | C |
| ATOM | 5711 | O3* | T | D | 1 | −13.085 | 41.480 | −20.721 | 1.00 | 1.00 | O |
| ATOM | 5712 | N1 | T | D | 1 | −10.333 | 44.120 | −17.843 | 1.00 | 1.00 | N |
| ATOM | 5713 | C6 | T | D | 1 | −11.192 | 44.693 | −16.964 | 1.00 | 1.00 | C |
| ATOM | 5714 | C5M | T | D | 1 | −11.609 | 45.628 | −14.657 | 1.00 | 1.00 | C |
| ATOM | 5715 | C5 | T | D | 1 | −10.813 | 44.955 | −15.700 | 1.00 | 1.00 | C |
| ATOM | 5716 | O4 | T | D | 1 | −9.026 | 44.806 | −14.152 | 1.00 | 1.00 | O |
| ATOM | 5717 | C4 | T | D | 1 | −9.440 | 44.585 | −15.281 | 1.00 | 1.00 | C |
| ATOM | 5718 | N3 | T | D | 1 | −8.643 | 43.979 | −16.206 | 1.00 | 1.00 | N |
| ATOM | 5719 | O2 | T | D | 1 | −8.246 | 43.474 | −18.290 | 1.00 | 1.00 | O |
| ATOM | 5720 | C2 | T | D | 1 | −9.069 | 43.818 | −17.478 | 1.00 | 1.00 | C |
| ATOM | 5721 | H5*1 | T | D | 1 | −14.331 | 45.478 | −20.389 | 1.00 | 1.00 | H |
| ATOM | 5722 | H5*2 | T | D | 1 | −15.053 | 43.979 | −20.941 | 1.00 | 1.00 | H |
| ATOM | 5723 | H4* | T | D | 1 | −12.472 | 43.952 | −21.370 | 1.00 | 1.00 | H |
| ATOM | 5724 | H1* | T | D | 1 | −9.908 | 44.287 | −19.814 | 1.00 | 1.00 | H |
| ATOM | 5725 | H2*1 | T | D | 1 | −10.558 | 42.206 | −20.542 | 1.00 | 1.00 | H |
| ATOM | 5726 | H2*2 | T | D | 1 | −10.661 | 41.605 | −18.974 | 1.00 | 1.00 | H |
| ATOM | 5727 | H3* | T | D | 1 | −13.066 | 42.351 | −18.795 | 1.00 | 1.00 | H |
| ATOM | 5728 | H6 | T | D | 1 | −12.210 | 45.079 | −17.201 | 1.00 | 1.00 | H |
| ATOM | 5729 | H51 | T | D | 1 | −11.410 | 46.728 | −14.678 | 1.00 | 1.00 | H |
| ATOM | 5730 | H52 | T | D | 1 | −12.668 | 45.494 | −14.745 | 1.00 | 1.00 | H |
| ATOM | 5731 | H53 | T | D | 1 | −11.352 | 45.216 | −13.697 | 1.00 | 1.00 | H |
| ATOM | 5732 | H3 | T | D | 1 | −7.705 | 43.640 | −15.928 | 1.00 | 1.00 | H |
| ATOM | 5733 | H10 | T | D | 1 | −16.450 | 44.625 | −17.502 | 1.00 | 1.00 | H |
| ATOM | 5734 | P | T | D | 2 | −13.141 | 39.897 | −20.668 | 1.00 | 1.00 | P |
| ATOM | 5735 | O1P | T | D | 2 | −13.867 | 39.327 | −21.867 | 1.00 | 1.00 | O |
| ATOM | 5736 | O2P | T | D | 2 | −13.779 | 39.372 | −19.436 | 1.00 | 1.00 | O |
| ATOM | 5737 | O5* | T | D | 2 | −11.632 | 39.399 | −20.790 | 1.00 | 1.00 | O |
| ATOM | 5738 | C5* | T | D | 2 | −10.592 | 39.382 | −21.789 | 1.00 | 1.00 | C |
| ATOM | 5739 | C4* | T | D | 2 | −9.268 | 38.934 | −21.167 | 1.00 | 1.00 | C |
| ATOM | 5740 | O4* | T | D | 2 | −8.991 | 39.812 | −20.107 | 1.00 | 1.00 | O |
| ATOM | 5741 | C1* | T | D | 2 | −8.246 | 39.047 | −19.100 | 1.00 | 1.00 | C |
| ATOM | 5742 | C2* | T | D | 2 | −8.761 | 37.545 | −19.130 | 1.00 | 1.00 | C |
| ATOM | 5743 | C3* | T | D | 2 | −9.363 | 37.500 | −20.590 | 1.00 | 1.00 | C |
| ATOM | 5744 | O3* | T | D | 2 | −8.718 | 36.581 | −21.484 | 1.00 | 1.00 | O |
| ATOM | 5745 | N1 | T | D | 2 | −8.584 | 39.583 | −17.816 | 1.00 | 1.00 | N |
| ATOM | 5746 | C6 | T | D | 2 | −9.946 | 39.723 | −17.505 | 1.00 | 1.00 | C |
| ATOM | 5747 | C5M | T | D | 2 | −11.751 | 40.621 | −16.089 | 1.00 | 1.00 | C |
| ATOM | 5748 | C5 | T | D | 2 | −10.294 | 40.349 | −16.375 | 1.00 | 1.00 | C |
| ATOM | 5749 | O4 | T | D | 2 | −9.635 | 41.444 | −14.420 | 1.00 | 1.00 | O |
| ATOM | 5750 | C4 | T | D | 2 | −9.277 | 40.831 | −15.423 | 1.00 | 1.00 | C |
| ATOM | 5751 | N3 | T | D | 2 | −7.989 | 40.616 | −15.779 | 1.00 | 1.00 | N |
| ATOM | 5752 | O2 | T | D | 2 | −6.475 | 40.024 | −17.274 | 1.00 | 1.00 | O |
| ATOM | 5753 | C2 | T | D | 2 | −7.666 | 40.078 | −16.969 | 1.00 | 1.00 | C |
| ATOM | 5754 | H5*1 | T | D | 2 | −10.389 | 40.377 | −22.227 | 1.00 | 1.00 | H |
| ATOM | 5755 | H5*2 | T | D | 2 | −10.896 | 38.692 | −22.671 | 1.00 | 1.00 | H |
| ATOM | 5756 | H4* | T | D | 2 | −8.408 | 38.930 | −21.886 | 1.00 | 1.00 | H |
| ATOM | 5757 | H1* | T | D | 2 | −7.209 | 39.123 | −19.408 | 1.00 | 1.00 | H |
| ATOM | 5758 | H2*1 | T | D | 2 | −7.827 | 36.907 | −18.990 | 1.00 | 1.00 | H |
| ATOM | 5759 | H2*2 | T | D | 2 | −9.482 | 37.317 | −18.346 | 1.00 | 1.00 | H |
| ATOM | 5760 | H3* | T | D | 2 | −10.401 | 37.123 | −20.490 | 1.00 | 1.00 | H |
| ATOM | 5761 | H6 | T | D | 2 | −10.702 | 39.367 | −18.213 | 1.00 | 1.00 | H |
| ATOM | 5762 | H51 | T | D | 2 | −11.907 | 41.728 | −15.904 | 1.00 | 1.00 | H |
| ATOM | 5763 | H52 | T | D | 2 | −12.322 | 40.362 | −17.012 | 1.00 | 1.00 | H |
| ATOM | 5764 | H53 | T | D | 2 | −12.139 | 39.972 | −15.256 | 1.00 | 1.00 | H |
| ATOM | 5765 | H3 | T | D | 2 | −7.281 | 40.874 | −15.170 | 1.00 | 1.00 | H |
| ATOM | 5766 | P | C | D | 3 | −8.448 | 34.971 | −21.337 | 1.00 | 1.00 | P |
| ATOM | 5767 | O1P | C | D | 3 | −7.679 | 34.400 | −22.490 | 1.00 | 1.00 | O |
| ATOM | 5768 | O2P | C | D | 3 | −9.781 | 34.262 | −21.219 | 1.00 | 1.00 | O |
| ATOM | 5769 | O5* | C | D | 3 | −7.434 | 34.614 | −20.122 | 1.00 | 1.00 | O |
| ATOM | 5770 | C5* | C | D | 3 | −6.022 | 34.909 | −20.312 | 1.00 | 1.00 | C |
| ATOM | 5771 | C4* | C | D | 3 | −5.324 | 34.967 | −18.928 | 1.00 | 1.00 | C |
| ATOM | 5772 | O4* | C | D | 3 | −5.903 | 36.023 | −18.087 | 1.00 | 1.00 | O |
| ATOM | 5773 | C1* | C | D | 3 | −5.548 | 35.700 | −16.772 | 1.00 | 1.00 | C |
| ATOM | 5774 | C2* | C | D | 3 | −5.670 | 34.147 | −16.741 | 1.00 | 1.00 | C |
| ATOM | 5775 | C3* | C | D | 3 | −5.530 | 33.660 | −18.198 | 1.00 | 1.00 | C |
| ATOM | 5776 | O3* | C | D | 3 | −4.393 | 32.862 | −18.477 | 1.00 | 1.00 | O |
| ATOM | 5777 | N1 | C | D | 3 | −6.597 | 36.322 | −15.965 | 1.00 | 1.00 | N |
| ATOM | 5778 | C6 | C | D | 3 | −7.938 | 36.212 | −16.241 | 1.00 | 1.00 | C |
| ATOM | 5779 | C5 | C | D | 3 | −8.866 | 36.871 | −15.557 | 1.00 | 1.00 | C |
| ATOM | 5780 | N4 | C | D | 3 | −9.363 | 38.397 | −13.748 | 1.00 | 1.00 | N |
| ATOM | 5781 | C4 | C | D | 3 | −8.446 | 37.675 | −14.377 | 1.00 | 1.00 | C |
| ATOM | 5782 | N3 | C | D | 3 | −7.240 | 37.665 | −14.024 | 1.00 | 1.00 | N |
| ATOM | 5783 | O2 | C | D | 3 | −5.122 | 37.022 | −14.336 | 1.00 | 1.00 | O |
| ATOM | 5784 | C2 | C | D | 3 | −6.260 | 36.949 | −14.794 | 1.00 | 1.00 | C |
| ATOM | 5785 | H5*1 | C | D | 3 | −6.065 | 35.893 | −20.778 | 1.00 | 1.00 | H |
| ATOM | 5786 | H5*2 | C | D | 3 | −5.502 | 34.266 | −20.980 | 1.00 | 1.00 | H |
| ATOM | 5787 | H4* | C | D | 3 | −4.197 | 35.194 | −19.014 | 1.00 | 1.00 | H |
| ATOM | 5788 | H1* | C | D | 3 | −4.501 | 36.070 | −16.502 | 1.00 | 1.00 | H |
| ATOM | 5789 | H2*1 | C | D | 3 | −4.832 | 33.835 | −16.143 | 1.00 | 1.00 | H |
| ATOM | 5790 | H2*2 | C | D | 3 | −6.586 | 33.834 | −16.247 | 1.00 | 1.00 | H |
| ATOM | 5791 | H3* | C | D | 3 | −6.506 | 33.214 | −18.523 | 1.00 | 1.00 | H |
| ATOM | 5792 | H6 | C | D | 3 | −8.239 | 35.621 | −17.104 | 1.00 | 1.00 | H |
| ATOM | 5793 | H5 | C | D | 3 | −9.877 | 36.860 | −15.869 | 1.00 | 1.00 | H |
| ATOM | 5794 | H41 | C | D | 3 | −9.106 | 38.950 | −12.937 | 1.00 | 1.00 | H |
| ATOM | 5795 | H42 | C | D | 3 | −10.331 | 38.394 | −14.074 | 1.00 | 1.00 | H |
| ATOM | 5796 | P | G | D | 4 | −3.845 | 31.501 | −17.802 | 1.00 | 1.00 | P |
| ATOM | 5797 | O1P | G | D | 4 | −2.595 | 31.040 | −18.476 | 1.00 | 1.00 | O |
| ATOM | 5798 | O2P | G | D | 4 | −4.922 | 30.498 | −17.944 | 1.00 | 1.00 | O |
| ATOM | 5799 | O5* | G | D | 4 | −3.351 | 31.774 | −16.299 | 1.00 | 1.00 | O |
| ATOM | 5800 | C5* | G | D | 4 | −2.175 | 32.555 | −15.920 | 1.00 | 1.00 | C |
| ATOM | 5801 | C4* | G | D | 4 | −2.219 | 32.938 | −14.460 | 1.00 | 1.00 | C |
| ATOM | 5802 | O4* | G | D | 4 | −3.463 | 33.619 | −14.269 | 1.00 | 1.00 | O |
| ATOM | 5803 | C1* | G | D | 4 | −3.811 | 33.531 | −12.854 | 1.00 | 1.00 | C |
| ATOM | 5804 | C2* | G | D | 4 | −3.504 | 32.096 | −12.443 | 1.00 | 1.00 | C |
| ATOM | 5805 | C3* | G | D | 4 | −2.327 | 31.764 | −13.437 | 1.00 | 1.00 | C |
| ATOM | 5806 | O3* | G | D | 4 | −1.042 | 31.561 | −12.831 | 1.00 | 1.00 | O |
| ATOM | 5807 | N9 | G | D | 4 | −5.248 | 33.785 | −12.718 | 1.00 | 1.00 | N |
| ATOM | 5808 | C8 | G | D | 4 | −6.150 | 33.270 | −13.510 | 1.00 | 1.00 | C |
| ATOM | 5809 | N7 | G | D | 4 | −7.277 | 33.714 | −13.212 | 1.00 | 1.00 | N |
| ATOM | 5810 | C5 | G | D | 4 | −7.131 | 34.630 | −12.128 | 1.00 | 1.00 | C |
| ATOM | 5811 | O6 | G | D | 4 | −9.213 | 35.446 | −11.535 | 1.00 | 1.00 | O |
| ATOM | 5812 | C6 | G | D | 4 | −8.000 | 35.489 | −11.338 | 1.00 | 1.00 | C |
| ATOM | 5813 | N1 | G | D | 4 | −7.412 | 36.205 | −10.388 | 1.00 | 1.00 | N |
| ATOM | 5814 | N2 | G | D | 4 | −5.600 | 36.721 | −9.057 | 1.00 | 1.00 | N |
| ATOM | 5815 | C2 | G | D | 4 | −6.071 | 36.066 | −10.094 | 1.00 | 1.00 | C |
| ATOM | 5816 | N3 | G | D | 4 | −5.317 | 35.274 | −10.745 | 1.00 | 1.00 | N |
| ATOM | 5817 | C4 | G | D | 4 | −5.867 | 34.541 | −11.849 | 1.00 | 1.00 | C |
| ATOM | 5818 | H5*1 | G | D | 4 | −2.067 | 33.508 | −16.507 | 1.00 | 1.00 | H |
| ATOM | 5819 | H5*2 | G | D | 4 | −1.276 | 32.004 | −16.217 | 1.00 | 1.00 | H |
| ATOM | 5820 | H4* | G | D | 4 | −1.371 | 33.585 | −14.200 | 1.00 | 1.00 | H |
| ATOM | 5821 | H1* | G | D | 4 | −3.265 | 34.301 | −12.232 | 1.00 | 1.00 | H |
| ATOM | 5822 | H2*1 | G | D | 4 | −3.168 | 32.086 | −11.421 | 1.00 | 1.00 | H |
| ATOM | 5823 | H2*2 | G | D | 4 | −4.436 | 31.527 | −12.517 | 1.00 | 1.00 | H |
| ATOM | 5824 | H3* | G | D | 4 | −2.603 | 30.854 | −13.926 | 1.00 | 1.00 | H |
| ATOM | 5825 | H8 | G | D | 4 | −6.022 | 32.557 | −14.353 | 1.00 | 1.00 | H |
| ATOM | 5826 | H1 | G | D | 4 | −7.970 | 36.736 | −9.870 | 1.00 | 1.00 | H |
| ATOM | 5827 | H21 | G | D | 4 | −4.590 | 36.663 | −8.848 | 1.00 | 1.00 | H |
| ATOM | 5828 | H22 | G | D | 4 | −6.225 | 37.206 | −8.390 | 1.00 | 1.00 | H |
| ATOM | 5829 | P | A | D | 5 | −0.638 | 30.399 | −11.761 | 1.00 | 1.00 | P |
| ATOM | 5830 | O1P | A | D | 5 | 0.865 | 30.376 | −11.845 | 1.00 | 1.00 | O |
| ATOM | 5831 | O2P | A | D | 5 | −1.276 | 29.073 | −11.979 | 1.00 | 1.00 | O |
| ATOM | 5832 | O5* | A | D | 5 | −1.042 | 30.957 | −10.328 | 1.00 | 1.00 | O |
| ATOM | 5833 | C5* | A | D | 5 | −0.461 | 32.189 | −9.805 | 1.00 | 1.00 | C |
| ATOM | 5834 | C4* | A | D | 5 | −1.310 | 32.726 | −8.600 | 1.00 | 1.00 | C |
| ATOM | 5835 | O4* | A | D | 5 | −2.631 | 32.989 | −9.008 | 1.00 | 1.00 | O |
| ATOM | 5836 | C1* | A | D | 5 | −3.588 | 32.785 | −7.964 | 1.00 | 1.00 | C |
| ATOM | 5837 | C2* | A | D | 5 | −3.011 | 31.503 | −7.317 | 1.00 | 1.00 | C |
| ATOM | 5838 | C3* | A | D | 5 | −1.510 | 31.644 | −7.517 | 1.00 | 1.00 | C |
| ATOM | 5839 | O3* | A | D | 5 | −0.711 | 32.149 | −6.364 | 1.00 | 1.00 | O |
| ATOM | 5840 | N9 | A | D | 5 | −4.928 | 32.556 | −8.467 | 1.00 | 1.00 | N |
| ATOM | 5841 | C8 | A | D | 5 | −5.210 | 31.756 | −9.442 | 1.00 | 1.00 | C |
| ATOM | 5842 | N7 | A | D | 5 | −6.436 | 31.804 | −9.707 | 1.00 | 1.00 | N |
| ATOM | 5843 | C5 | A | D | 5 | −7.059 | 32.694 | −8.933 | 1.00 | 1.00 | C |
| ATOM | 5844 | N6 | A | D | 5 | −9.220 | 32.767 | −9.873 | 1.00 | 1.00 | N |
| ATOM | 5845 | C6 | A | D | 5 | −8.357 | 33.186 | −8.912 | 1.00 | 1.00 | C |
| ATOM | 5846 | N1 | A | D | 5 | −8.675 | 33.979 | −7.867 | 1.00 | 1.00 | N |
| ATOM | 5847 | C2 | A | D | 5 | −7.758 | 34.249 | −6.907 | 1.00 | 1.00 | C |
| ATOM | 5848 | N3 | A | D | 5 | −6.454 | 33.898 | −7.006 | 1.00 | 1.00 | N |
| ATOM | 5849 | C4 | A | D | 5 | −6.088 | 33.148 | −8.055 | 1.00 | 1.00 | C |
| ATOM | 5850 | H5*1 | A | D | 5 | −0.467 | 32.942 | −10.606 | 1.00 | 1.00 | H |
| ATOM | 5851 | H5*2 | A | D | 5 | 0.594 | 32.054 | −9.476 | 1.00 | 1.00 | H |
| ATOM | 5852 | H4* | A | D | 5 | −0.880 | 33.689 | −8.233 | 1.00 | 1.00 | H |
| ATOM | 5853 | H1* | A | D | 5 | −3.565 | 33.636 | −7.249 | 1.00 | 1.00 | H |
| ATOM | 5854 | H2*1 | A | D | 5 | −3.226 | 31.457 | −6.272 | 1.00 | 1.00 | H |
| ATOM | 5855 | H2*2 | A | D | 5 | −3.402 | 30.591 | −7.799 | 1.00 | 1.00 | H |
| ATOM | 5856 | H3* | A | D | 5 | −1.097 | 30.643 | −7.734 | 1.00 | 1.00 | H |
| ATOM | 5857 | H8 | A | D | 5 | −4.465 | 31.101 | −9.906 | 1.00 | 1.00 | H |
| ATOM | 5858 | H61 | A | D | 5 | −8.886 | 32.245 | −10.707 | 1.00 | 1.00 | H |
| ATOM | 5859 | H62 | A | D | 5 | −10.173 | 33.081 | −9.832 | 1.00 | 1.00 | H |
| ATOM | 5860 | H2 | A | D | 5 | −8.076 | 34.627 | −5.980 | 1.00 | 1.00 | H |
| ATOM | 5861 | P | G | D | 6 | −0.501 | 31.223 | −5.077 | 1.00 | 1.00 | P |
| ATOM | 5862 | O1P | G | D | 6 | 0.585 | 31.922 | −4.324 | 1.00 | 1.00 | O |
| ATOM | 5863 | O2P | G | D | 6 | −0.113 | 29.894 | −5.590 | 1.00 | 1.00 | O |
| ATOM | 5864 | O5* | G | D | 6 | −1.854 | 31.175 | −4.280 | 1.00 | 1.00 | O |
| ATOM | 5865 | C5* | G | D | 6 | −2.056 | 32.043 | −3.145 | 1.00 | 1.00 | C |
| ATOM | 5866 | C4* | G | D | 6 | −3.564 | 31.854 | −2.696 | 1.00 | 1.00 | C |
| ATOM | 5867 | O4* | G | D | 6 | −4.398 | 31.933 | −3.906 | 1.00 | 1.00 | O |
| ATOM | 5868 | C1* | G | D | 6 | −5.693 | 31.373 | −3.599 | 1.00 | 1.00 | C |
| ATOM | 5869 | C2* | G | D | 6 | −5.387 | 30.262 | −2.601 | 1.00 | 1.00 | C |
| ATOM | 5870 | C3* | G | D | 6 | −3.891 | 30.459 | −2.163 | 1.00 | 1.00 | C |
| ATOM | 5871 | O3* | G | D | 6 | −3.636 | 30.171 | −0.697 | 1.00 | 1.00 | O |
| ATOM | 5872 | N9 | G | D | 6 | −6.309 | 30.833 | −4.801 | 1.00 | 1.00 | N |
| ATOM | 5873 | C8 | G | D | 6 | −5.705 | 30.191 | −5.713 | 1.00 | 1.00 | C |
| ATOM | 5874 | N7 | G | D | 6 | −6.462 | 29.981 | −6.693 | 1.00 | 1.00 | N |
| ATOM | 5875 | C5 | G | D | 6 | −7.760 | 30.545 | −6.353 | 1.00 | 1.00 | C |
| ATOM | 5876 | O6 | G | D | 6 | −9.318 | 30.204 | −8.057 | 1.00 | 1.00 | O |
| ATOM | 5877 | C6 | G | D | 6 | −9.094 | 30.666 | −6.947 | 1.00 | 1.00 | C |
| ATOM | 5878 | N1 | G | D | 6 | −10.037 | 31.214 | −6.116 | 1.00 | 1.00 | N |
| ATOM | 5879 | N2 | G | D | 6 | −10.757 | 32.325 | −4.171 | 1.00 | 1.00 | N |
| ATOM | 5880 | C2 | G | D | 6 | −9.791 | 31.753 | −4.885 | 1.00 | 1.00 | C |
| ATOM | 5881 | N3 | G | D | 6 | −8.603 | 31.715 | −4.429 | 1.00 | 1.00 | N |
| ATOM | 5882 | C4 | G | D | 6 | −7.538 | 31.050 | −5.151 | 1.00 | 1.00 | C |
| ATOM | 5883 | H5*1 | G | D | 6 | −1.957 | 33.089 | −3.429 | 1.00 | 1.00 | H |
| ATOM | 5884 | H5*2 | G | D | 6 | −1.424 | 31.804 | −2.259 | 1.00 | 1.00 | H |
| ATOM | 5885 | H4* | G | D | 6 | −3.789 | 32.688 | −1.971 | 1.00 | 1.00 | H |
| ATOM | 5886 | H1* | G | D | 6 | −6.302 | 32.186 | −3.163 | 1.00 | 1.00 | H |
| ATOM | 5887 | H2*1 | G | D | 6 | −6.079 | 30.438 | −1.718 | 1.00 | 1.00 | H |
| ATOM | 5888 | H2*2 | G | D | 6 | −5.560 | 29.235 | −2.929 | 1.00 | 1.00 | H |
| ATOM | 5889 | H3* | G | D | 6 | −3.222 | 29.761 | −2.689 | 1.00 | 1.00 | H |
| ATOM | 5890 | H8 | G | D | 6 | −4.665 | 29.856 | −5.507 | 1.00 | 1.00 | H |
| ATOM | 5891 | H1 | G | D | 6 | −11.000 | 31.250 | −6.505 | 1.00 | 1.00 | H |
| ATOM | 5892 | H21 | G | D | 6 | −10.535 | 32.744 | −3.284 | 1.00 | 1.00 | H |
| ATOM | 5893 | H22 | G | D | 6 | −11.698 | 32.358 | −4.598 | 1.00 | 1.00 | H |
| ATOM | 5894 | P | C | D | 7 | −4.089 | 28.730 | −0.128 | 1.00 | 1.00 | P |
| ATOM | 5895 | O1P | C | D | 7 | −3.467 | 28.470 | 1.188 | 1.00 | 1.00 | O |
| ATOM | 5896 | O2P | C | D | 7 | −3.689 | 27.651 | −1.082 | 1.00 | 1.00 | O |
| ATOM | 5897 | O5* | C | D | 7 | −5.652 | 28.568 | 0.182 | 1.00 | 1.00 | O |
| ATOM | 5898 | C5* | C | D | 7 | −6.393 | 29.034 | 1.344 | 1.00 | 1.00 | C |
| ATOM | 5899 | C4* | C | D | 7 | −7.962 | 29.050 | 1.204 | 1.00 | 1.00 | C |
| ATOM | 5900 | O4* | C | D | 7 | −8.319 | 29.915 | 0.083 | 1.00 | 1.00 | O |
| ATOM | 5901 | C1* | C | D | 7 | −9.557 | 29.417 | −0.495 | 1.00 | 1.00 | C |
| ATOM | 5902 | C2* | C | D | 7 | −9.876 | 28.134 | 0.274 | 1.00 | 1.00 | C |
| ATOM | 5903 | C3* | C | D | 7 | −8.517 | 27.671 | 0.923 | 1.00 | 1.00 | C |
| ATOM | 5904 | O3* | C | D | 7 | −8.644 | 26.677 | 1.952 | 1.00 | 1.00 | O |
| ATOM | 5905 | N1 | C | D | 7 | −9.442 | 29.021 | −1.904 | 1.00 | 1.00 | N |
| ATOM | 5906 | C6 | C | D | 7 | −8.289 | 28.552 | −2.436 | 1.00 | 1.00 | C |
| ATOM | 5907 | C5 | C | D | 7 | −8.177 | 28.153 | −3.685 | 1.00 | 1.00 | C |
| ATOM | 5908 | N4 | C | D | 7 | −9.191 | 27.831 | −5.848 | 1.00 | 1.00 | N |
| ATOM | 5909 | C4 | C | D | 7 | −9.305 | 28.172 | −4.624 | 1.00 | 1.00 | C |
| ATOM | 5910 | N3 | C | D | 7 | −10.452 | 28.557 | −4.124 | 1.00 | 1.00 | N |
| ATOM | 5911 | O2 | C | D | 7 | −11.681 | 29.094 | −2.324 | 1.00 | 1.00 | O |
| ATOM | 5912 | C2 | C | D | 7 | −10.548 | 28.951 | −2.757 | 1.00 | 1.00 | C |
| ATOM | 5913 | H5*1 | C | D | 7 | −6.074 | 30.078 | 1.474 | 1.00 | 1.00 | H |
| ATOM | 5914 | H5*2 | C | D | 7 | −6.040 | 28.514 | 2.266 | 1.00 | 1.00 | H |
| ATOM | 5915 | H4* | C | D | 7 | −8.543 | 29.542 | 2.074 | 1.00 | 1.00 | H |
| ATOM | 5916 | H1* | C | D | 7 | −10.263 | 30.245 | −0.340 | 1.00 | 1.00 | H |
| ATOM | 5917 | H2*1 | C | D | 7 | −10.565 | 28.330 | 1.103 | 1.00 | 1.00 | H |
| ATOM | 5918 | H2*2 | C | D | 7 | −10.366 | 27.333 | −0.366 | 1.00 | 1.00 | H |
| ATOM | 5919 | H3* | C | D | 7 | −7.942 | 27.164 | 0.178 | 1.00 | 1.00 | H |
| ATOM | 5920 | H6 | C | D | 7 | −7.416 | 28.456 | −1.754 | 1.00 | 1.00 | H |
| ATOM | 5921 | H5 | C | D | 7 | −7.307 | 27.713 | −4.083 | 1.00 | 1.00 | H |
| ATOM | 5922 | H41 | C | D | 7 | −9.972 | 27.886 | −6.470 | 1.00 | 1.00 | H |
| ATOM | 5923 | H42 | C | D | 7 | −8.286 | 27.480 | −6.140 | 1.00 | 1.00 | H |
| ATOM | 5924 | P | G | D | 8 | −9.568 | 26.635 | 3.200 | 1.00 | 1.00 | P |
| ATOM | 5925 | O1P | G | D | 8 | −9.692 | 28.018 | 3.725 | 1.00 | 1.00 | O |
| ATOM | 5926 | O2P | G | D | 8 | −9.135 | 25.590 | 4.197 | 1.00 | 1.00 | O |
| ATOM | 5927 | O5* | G | D | 8 | −10.921 | 26.231 | 2.493 | 1.00 | 1.00 | O |
| ATOM | 5928 | C5* | G | D | 8 | −12.258 | 26.666 | 2.813 | 1.00 | 1.00 | C |
| ATOM | 5929 | C4* | G | D | 8 | −13.190 | 26.239 | 1.669 | 1.00 | 1.00 | C |
| ATOM | 5930 | O4* | G | D | 8 | −12.582 | 26.458 | 0.391 | 1.00 | 1.00 | O |
| ATOM | 5931 | C1* | G | D | 8 | −12.062 | 25.178 | −0.133 | 1.00 | 1.00 | C |
| ATOM | 5932 | C2* | G | D | 8 | −13.234 | 24.273 | 0.292 | 1.00 | 1.00 | C |
| ATOM | 5933 | C3* | G | D | 8 | −13.415 | 24.686 | 1.794 | 1.00 | 1.00 | C |
| ATOM | 5934 | O3* | G | D | 8 | −14.783 | 24.321 | 2.141 | 1.00 | 1.00 | O |
| ATOM | 5935 | N9 | G | D | 8 | −11.536 | 25.186 | −1.505 | 1.00 | 1.00 | N |
| ATOM | 5936 | C8 | G | D | 8 | −10.225 | 25.235 | −1.769 | 1.00 | 1.00 | C |
| ATOM | 5937 | N7 | G | D | 8 | −10.011 | 25.198 | −2.987 | 1.00 | 1.00 | N |
| ATOM | 5938 | C5 | G | D | 8 | −11.308 | 25.042 | −3.672 | 1.00 | 1.00 | C |
| ATOM | 5939 | O6 | G | D | 8 | −10.952 | 24.971 | −6.008 | 1.00 | 1.00 | O |
| ATOM | 5940 | C6 | G | D | 8 | −11.757 | 24.943 | −5.043 | 1.00 | 1.00 | C |
| ATOM | 5941 | N1 | G | D | 8 | −13.086 | 24.742 | −5.235 | 1.00 | 1.00 | N |
| ATOM | 5942 | N2 | G | D | 8 | −15.204 | 24.472 | −4.339 | 1.00 | 1.00 | N |
| ATOM | 5943 | C2 | G | D | 8 | −13.950 | 24.736 | −4.131 | 1.00 | 1.00 | C |
| ATOM | 5944 | N3 | G | D | 8 | −13.542 | 24.931 | −2.917 | 1.00 | 1.00 | N |
| ATOM | 5945 | C4 | G | D | 8 | −12.146 | 25.066 | −2.652 | 1.00 | 1.00 | C |
| ATOM | 5946 | H5*1 | G | D | 8 | −12.310 | 27.777 | 2.830 | 1.00 | 1.00 | H |
| ATOM | 5947 | H5*2 | G | D | 8 | −12.521 | 26.310 | 3.826 | 1.00 | 1.00 | H |
| ATOM | 5948 | H4* | G | D | 8 | −14.155 | 26.812 | 1.742 | 1.00 | 1.00 | H |
| ATOM | 5949 | H1* | G | D | 8 | −11.254 | 24.839 | 0.441 | 1.00 | 1.00 | H |
| ATOM | 5950 | H2*1 | G | D | 8 | −14.154 | 24.430 | −0.326 | 1.00 | 1.00 | H |
| ATOM | 5951 | H2*2 | G | D | 8 | −12.906 | 23.235 | 0.173 | 1.00 | 1.00 | H |
| ATOM | 5952 | H3* | G | D | 8 | −12.707 | 24.199 | 2.435 | 1.00 | 1.00 | H |
| ATOM | 5953 | H8 | G | D | 8 | −9.457 | 25.270 | −0.997 | 1.00 | 1.00 | H |
| ATOM | 5954 | H1 | G | D | 8 | −13.347 | 24.549 | −6.172 | 1.00 | 1.00 | H |
| ATOM | 5955 | H21 | G | D | 8 | −15.908 | 24.447 | −3.579 | 1.00 | 1.00 | H |
| ATOM | 5956 | H22 | G | D | 8 | −15.549 | 24.219 | −5.294 | 1.00 | 1.00 | H |
| ATOM | 5957 | P | C | D | 9 | −15.053 | 22.849 | 2.818 | 1.00 | 1.00 | P |
| ATOM | 5958 | O1P | C | D | 9 | −14.255 | 21.814 | 2.101 | 1.00 | 1.00 | O |
| ATOM | 5959 | O2P | C | D | 9 | −14.813 | 22.707 | 4.272 | 1.00 | 1.00 | O |
| ATOM | 5960 | O5* | C | D | 9 | −16.617 | 22.548 | 2.651 | 1.00 | 1.00 | O |
| ATOM | 5961 | C5* | C | D | 9 | −17.237 | 22.870 | 1.412 | 1.00 | 1.00 | C |
| ATOM | 5962 | C4* | C | D | 9 | −16.580 | 22.260 | 0.178 | 1.00 | 1.00 | C |
| ATOM | 5963 | O4* | C | D | 9 | −16.947 | 22.838 | −1.157 | 1.00 | 1.00 | O |
| ATOM | 5964 | C1* | C | D | 9 | −16.606 | 21.891 | −2.166 | 1.00 | 1.00 | C |
| ATOM | 5965 | C2* | C | D | 9 | −17.183 | 20.631 | −1.418 | 1.00 | 1.00 | C |
| ATOM | 5966 | C3* | C | D | 9 | −16.702 | 20.701 | 0.036 | 1.00 | 1.00 | C |
| ATOM | 5967 | O3* | C | D | 9 | −17.607 | 20.021 | 0.911 | 1.00 | 1.00 | O |
| ATOM | 5968 | N1 | C | D | 9 | −15.239 | 21.765 | −2.737 | 1.00 | 1.00 | N |
| ATOM | 5969 | C6 | C | D | 9 | −14.138 | 21.654 | −1.946 | 1.00 | 1.00 | C |
| ATOM | 5970 | C5 | C | D | 9 | −12.946 | 21.724 | −2.530 | 1.00 | 1.00 | C |
| ATOM | 5971 | N4 | C | D | 9 | −11.517 | 22.087 | −4.433 | 1.00 | 1.00 | N |
| ATOM | 5972 | C4 | C | D | 9 | −12.691 | 21.942 | −3.916 | 1.00 | 1.00 | C |
| ATOM | 5973 | N3 | C | D | 9 | −13.763 | 21.891 | −4.642 | 1.00 | 1.00 | N |
| ATOM | 5974 | O2 | C | D | 9 | −16.019 | 21.853 | −4.875 | 1.00 | 1.00 | O |
| ATOM | 5975 | C2 | C | D | 9 | −15.089 | 21.781 | −4.072 | 1.00 | 1.00 | C |
| ATOM | 5976 | H5*1 | C | D | 9 | −17.284 | 23.934 | 1.216 | 1.00 | 1.00 | H |
| ATOM | 5977 | H5*2 | C | D | 9 | −18.288 | 22.615 | 1.382 | 1.00 | 1.00 | H |
| ATOM | 5978 | H4* | C | D | 9 | −15.559 | 22.664 | 0.145 | 1.00 | 1.00 | H |
| ATOM | 5979 | H1* | C | D | 9 | −17.346 | 21.933 | −2.961 | 1.00 | 1.00 | H |
| ATOM | 5980 | H2*1 | C | D | 9 | −18.248 | 20.664 | −1.382 | 1.00 | 1.00 | H |
| ATOM | 5981 | H2*2 | C | D | 9 | −16.950 | 19.727 | −1.913 | 1.00 | 1.00 | H |
| ATOM | 5982 | H3* | C | D | 9 | −15.677 | 20.303 | 0.247 | 1.00 | 1.00 | H |
| ATOM | 5983 | H6 | C | D | 9 | −14.037 | 21.495 | −0.871 | 1.00 | 1.00 | H |
| ATOM | 5984 | H5 | C | D | 9 | −12.014 | 21.625 | −1.914 | 1.00 | 1.00 | H |
| ATOM | 5985 | H41 | C | D | 9 | −11.405 | 22.255 | −5.455 | 1.00 | 1.00 | H |
| ATOM | 5986 | H42 | C | D | 9 | −10.697 | 21.958 | −3.804 | 1.00 | 1.00 | H |
| ATOM | 5987 | P | C | D | 10 | −17.498 | 18.423 | 0.975 | 1.00 | 1.00 | P |
| ATOM | 5988 | O1P | C | D | 10 | −18.258 | 17.779 | 2.068 | 1.00 | 1.00 | O |
| ATOM | 5989 | O2P | C | D | 10 | −16.209 | 18.275 | 1.701 | 1.00 | 1.00 | O |
| ATOM | 5990 | O5* | C | D | 10 | −17.474 | 17.680 | −0.436 | 1.00 | 1.00 | O |
| ATOM | 5991 | C5* | C | D | 10 | −18.648 | 17.405 | −1.205 | 1.00 | 1.00 | C |
| ATOM | 5992 | C4* | C | D | 10 | −18.255 | 16.860 | −2.583 | 1.00 | 1.00 | C |
| ATOM | 5993 | O4* | C | D | 10 | −17.581 | 17.887 | −3.352 | 1.00 | 1.00 | O |
| ATOM | 5994 | C1* | C | D | 10 | −16.671 | 17.195 | −4.300 | 1.00 | 1.00 | C |
| ATOM | 5995 | C2* | C | D | 10 | −16.917 | 15.672 | −3.994 | 1.00 | 1.00 | C |
| ATOM | 5996 | C3* | C | D | 10 | −17.342 | 15.612 | −2.542 | 1.00 | 1.00 | C |
| ATOM | 5997 | O3* | C | D | 10 | −18.058 | 14.441 | −2.227 | 1.00 | 1.00 | O |
| ATOM | 5998 | N1 | C | D | 10 | −15.316 | 17.633 | −4.129 | 1.00 | 1.00 | N |
| ATOM | 5999 | C6 | C | D | 10 | −14.853 | 17.945 | −2.906 | 1.00 | 1.00 | C |
| ATOM | 6000 | C5 | C | D | 10 | −13.599 | 18.351 | −2.744 | 1.00 | 1.00 | C |
| ATOM | 6001 | N4 | C | D | 10 | −11.430 | 18.804 | −3.750 | 1.00 | 1.00 | N |
| ATOM | 6002 | C4 | C | D | 10 | −12.671 | 18.387 | −3.869 | 1.00 | 1.00 | C |
| ATOM | 6003 | N3 | C | D | 10 | −13.092 | 18.023 | −4.992 | 1.00 | 1.00 | N |
| ATOM | 6004 | O2 | C | D | 10 | −14.761 | 17.356 | −6.302 | 1.00 | 1.00 | O |
| ATOM | 6005 | C2 | C | D | 10 | −14.461 | 17.630 | −5.138 | 1.00 | 1.00 | C |
| ATOM | 6006 | H5*1 | C | D | 10 | −19.258 | 18.283 | −1.313 | 1.00 | 1.00 | H |
| ATOM | 6007 | H5*2 | C | D | 10 | −19.255 | 16.626 | −0.744 | 1.00 | 1.00 | H |
| ATOM | 6008 | H4* | C | D | 10 | −19.159 | 16.636 | −3.115 | 1.00 | 1.00 | H |
| ATOM | 6009 | H1* | C | D | 10 | −16.965 | 17.412 | −5.309 | 1.00 | 1.00 | H |
| ATOM | 6010 | H2*1 | C | D | 10 | −17.775 | 15.367 | −4.585 | 1.00 | 1.00 | H |
| ATOM | 6011 | H2*2 | C | D | 10 | −16.004 | 15.085 | −4.295 | 1.00 | 1.00 | H |
| ATOM | 6012 | H3* | C | D | 10 | −16.475 | 15.656 | −1.893 | 1.00 | 1.00 | H |
| ATOM | 6013 | H6 | C | D | 10 | −15.479 | 17.869 | −2.006 | 1.00 | 1.00 | H |
| ATOM | 6014 | H5 | C | D | 10 | −13.112 | 18.633 | −1.752 | 1.00 | 1.00 | H |
| ATOM | 6015 | H41 | C | D | 10 | −10.777 | 18.733 | −4.580 | 1.00 | 1.00 | H |
| ATOM | 6016 | H42 | C | D | 10 | −11.042 | 19.096 | −2.828 | 1.00 | 1.00 | H |
| ATOM | 6017 | P | G | D | 11 | −17.342 | 13.006 | −2.163 | 1.00 | 1.00 | P |
| ATOM | 6018 | O1P | G | D | 11 | −16.496 | 13.027 | −0.907 | 1.00 | 1.00 | O |
| ATOM | 6019 | O2P | G | D | 11 | −18.397 | 11.953 | −2.074 | 1.00 | 1.00 | O |
| ATOM | 6020 | O5* | G | D | 11 | −16.404 | 12.786 | −3.421 | 1.00 | 1.00 | O |
| ATOM | 6021 | C5* | G | D | 11 | −16.969 | 12.312 | −4.704 | 1.00 | 1.00 | C |
| ATOM | 6022 | C4* | G | D | 11 | −15.888 | 12.053 | −5.821 | 1.00 | 1.00 | C |
| ATOM | 6023 | O4* | G | D | 11 | −15.143 | 13.165 | −6.222 | 1.00 | 1.00 | O |
| ATOM | 6024 | C1* | G | D | 11 | −13.890 | 12.708 | −6.638 | 1.00 | 1.00 | C |
| ATOM | 6025 | C2* | G | D | 11 | −13.905 | 11.164 | −6.407 | 1.00 | 1.00 | C |
| ATOM | 6026 | C3* | G | D | 11 | −14.949 | 10.960 | −5.378 | 1.00 | 1.00 | C |
| ATOM | 6027 | O3* | G | D | 11 | −15.741 | 9.762 | −5.361 | 1.00 | 1.00 | O |
| ATOM | 6028 | N9 | G | D | 11 | −12.932 | 13.417 | −5.795 | 1.00 | 1.00 | N |
| ATOM | 6029 | C8 | G | D | 11 | −13.106 | 13.851 | −4.547 | 1.00 | 1.00 | C |
| ATOM | 6030 | N7 | G | D | 11 | −12.068 | 14.428 | −4.123 | 1.00 | 1.00 | N |
| ATOM | 6031 | C5 | G | D | 11 | −11.042 | 14.387 | −5.163 | 1.00 | 1.00 | C |
| ATOM | 6032 | O6 | G | D | 11 | −9.082 | 15.500 | −4.573 | 1.00 | 1.00 | O |
| ATOM | 6033 | C6 | G | D | 11 | −9.652 | 14.837 | −5.422 | 1.00 | 1.00 | C |
| ATOM | 6034 | N1 | G | D | 11 | −9.098 | 14.449 | −6.570 | 1.00 | 1.00 | N |
| ATOM | 6035 | N2 | G | D | 11 | −9.123 | 13.453 | −8.574 | 1.00 | 1.00 | N |
| ATOM | 6036 | C2 | G | D | 11 | −9.790 | 13.767 | −7.512 | 1.00 | 1.00 | C |
| ATOM | 6037 | N3 | G | D | 11 | −11.008 | 13.414 | −7.350 | 1.00 | 1.00 | N |
| ATOM | 6038 | C4 | G | D | 11 | −11.702 | 13.695 | −6.123 | 1.00 | 1.00 | C |
| ATOM | 6039 | H5*1 | G | D | 11 | −17.672 | 13.025 | −5.112 | 1.00 | 1.00 | H |
| ATOM | 6040 | H5*2 | G | D | 11 | −17.533 | 11.367 | −4.445 | 1.00 | 1.00 | H |
| ATOM | 6041 | H4* | G | D | 11 | −16.389 | 11.746 | −6.714 | 1.00 | 1.00 | H |
| ATOM | 6042 | H1* | G | D | 11 | −13.760 | 12.876 | −7.706 | 1.00 | 1.00 | H |
| ATOM | 6043 | H2*1 | G | D | 11 | −14.203 | 10.672 | −7.391 | 1.00 | 1.00 | H |
| ATOM | 6044 | H2*2 | G | D | 11 | −12.907 | 10.870 | −6.070 | 1.00 | 1.00 | H |
| ATOM | 6045 | H3* | G | D | 11 | −14.654 | 11.258 | −4.383 | 1.00 | 1.00 | H |
| ATOM | 6046 | H8 | G | D | 11 | −14.004 | 13.823 | −3.965 | 1.00 | 1.00 | H |
| ATOM | 6047 | H1 | G | D | 11 | −8.131 | 14.794 | −6.720 | 1.00 | 1.00 | H |
| ATOM | 6048 | H21 | G | D | 11 | −9.585 | 12.905 | −9.261 | 1.00 | 1.00 | H |
| ATOM | 6049 | H22 | G | D | 11 | −8.150 | 13.722 | −8.725 | 1.00 | 1.00 | H |
| ATOM | 6050 | P | G | D | 12 | −15.163 | 8.312 | −5.126 | 1.00 | 1.00 | P |
| ATOM | 6051 | O1P | G | D | 12 | −15.735 | 7.446 | −6.208 | 1.00 | 1.00 | O |
| ATOM | 6052 | O2P | G | D | 12 | −15.593 | 7.702 | −3.827 | 1.00 | 1.00 | O |
| ATOM | 6053 | O5* | G | D | 12 | −13.587 | 8.250 | −5.257 | 1.00 | 1.00 | O |
| ATOM | 6054 | C5* | G | D | 12 | −13.099 | 7.659 | −6.443 | 1.00 | 1.00 | C |
| ATOM | 6055 | C4* | G | D | 12 | −11.527 | 7.698 | −6.443 | 1.00 | 1.00 | C |
| ATOM | 6056 | O4* | G | D | 12 | −11.057 | 9.072 | −6.557 | 1.00 | 1.00 | O |
| ATOM | 6057 | C1* | G | D | 12 | −9.716 | 9.150 | −6.104 | 1.00 | 1.00 | C |
| ATOM | 6058 | C2* | G | D | 12 | −9.446 | 7.793 | −5.431 | 1.00 | 1.00 | C |
| ATOM | 6059 | C3* | G | D | 12 | −10.813 | 7.163 | −5.160 | 1.00 | 1.00 | C |
| ATOM | 6060 | O3* | G | D | 12 | −10.865 | 5.753 | −4.931 | 1.00 | 1.00 | O |
| ATOM | 6061 | N9 | G | D | 12 | −9.502 | 10.296 | −5.215 | 1.00 | 1.00 | N |
| ATOM | 6062 | C8 | G | D | 12 | −10.333 | 10.699 | −4.320 | 1.00 | 1.00 | C |
| ATOM | 6063 | N7 | G | D | 12 | −9.912 | 11.691 | −3.691 | 1.00 | 1.00 | N |
| ATOM | 6064 | C5 | G | D | 12 | −8.618 | 12.015 | −4.172 | 1.00 | 1.00 | C |
| ATOM | 6065 | O6 | G | D | 12 | −7.654 | 13.784 | −2.998 | 1.00 | 1.00 | O |
| ATOM | 6066 | C6 | G | D | 12 | −7.543 | 12.976 | −3.890 | 1.00 | 1.00 | C |
| ATOM | 6067 | N1 | G | D | 12 | −6.420 | 12.966 | −4.673 | 1.00 | 1.00 | N |
| ATOM | 6068 | N2 | G | D | 12 | −5.287 | 12.039 | −6.388 | 1.00 | 1.00 | N |
| ATOM | 6069 | C2 | G | D | 12 | −6.329 | 11.999 | −5.670 | 1.00 | 1.00 | C |
| ATOM | 6070 | N3 | G | D | 12 | −7.242 | 11.106 | −5.899 | 1.00 | 1.00 | N |
| ATOM | 6071 | C4 | G | D | 12 | −8.476 | 11.143 | −5.151 | 1.00 | 1.00 | C |
| ATOM | 6072 | H5*1 | G | D | 12 | −13.372 | 8.291 | −7.312 | 1.00 | 1.00 | H |
| ATOM | 6073 | H5*2 | G | D | 12 | −13.460 | 6.618 | −6.601 | 1.00 | 1.00 | H |
| ATOM | 6074 | H4* | G | D | 12 | −11.141 | 7.182 | −7.315 | 1.00 | 1.00 | H |
| ATOM | 6075 | H1* | G | D | 12 | −9.057 | 9.337 | −6.984 | 1.00 | 1.00 | H |
| ATOM | 6076 | H2*1 | G | D | 12 | −8.848 | 7.131 | −6.094 | 1.00 | 1.00 | H |
| ATOM | 6077 | H2*2 | G | D | 12 | −8.831 | 7.933 | −4.505 | 1.00 | 1.00 | H |
| ATOM | 6078 | H3* | G | D | 12 | −11.236 | 7.777 | −4.335 | 1.00 | 1.00 | H |
| ATOM | 6079 | H8 | G | D | 12 | −11.295 | 10.174 | −4.089 | 1.00 | 1.00 | H |
| ATOM | 6080 | H1 | G | D | 12 | −5.628 | 13.545 | −4.457 | 1.00 | 1.00 | H |
| ATOM | 6081 | H21 | G | D | 12 | −5.229 | 11.417 | −7.174 | 1.00 | 1.00 | H |
| ATOM | 6082 | H22 | G | D | 12 | −4.501 | 12.670 | −6.257 | 1.00 | 1.00 | H |
| ATOM | 6083 | H11 | G | D | 12 | −10.197 | 5.671 | −4.205 | 1.00 | 1.00 | H |
| TER | | | | | | | | | | | |
| HETATM | 6084 | MG1 | MG | E | 1 | −10.966 | 4.075 | −5.574 | 1.00 | 1.00 | MG |
| TER | | | | | | | | | | | |
| HETATM | 6085 | MG1 | MG | F | 1 | −8.325 | 2.204 | −3.133 | 1.00 | 1.00 | MG |
| TER | | | | | | | | | | | |
| HETATM | 6086 | X | X | G | 1 | −2.975 | −10.873 | −2.518 | 1.00 | 1.00 | X |
| TER | | | | | | | | | | | |
| HETATM | 6087 | X | X | H | 1 | −23.388 | −6.544 | −22.744 | 1.00 | 1.00 | X |
| TER | | | | | | | | | | | |
| HETATM | 6088 | X | X | I | 1 | 6.776 | −5.202 | 11.238 | 1.00 | 1.00 | X |
| CONECT | 5659 | 5676 | | | | | | | | | |
| CONECT | 5660 | 5676 | | | | | | | | | |
| CONECT | 5661 | 5677 | | | | | | | | | |
| CONECT | 5662 | 5679 | | | | | | | | | |
| CONECT | 5663 | 5680 | | | | | | | | | |
| CONECT | 5664 | 5680 | | | | | | | | | |
| CONECT | 5665 | 5681 | | | | | | | | | |
| CONECT | 5666 | 5684 | | | | | | | | | |
| CONECT | 5667 | 5687 | | | | | | | | | |
| CONECT | 5668 | 5687 | | | | | | | | | |
| CONECT | 5669 | 5690 | | | | | | | | | |
| CONECT | 5670 | 5672 | 5693 | | | | | | | | |
| CONECT | 5671 | 5682 | | | | | | | | | |
| CONECT | 5672 | 5670 | 5673 | 5674 | 5675 | | | | | | |
| CONECT | 5673 | 5672 | | | | | | | | | |
| CONECT | 5674 | 5672 | | | | | | | | | |
| CONECT | 5675 | 5672 | 5676 | | | | | | | | |
| CONECT | 5676 | 5660 | 5659 | 5675 | 5677 | | | | | | |
| CONECT | 5677 | 5661 | 5676 | 5678 | 5681 | | | | | | |
| CONECT | 5678 | 5677 | 5679 | | | | | | | | |
| CONECT | 5679 | 5662 | 5678 | 5680 | 5683 | | | | | | |
| CONECT | 5680 | 5679 | 5664 | 5663 | 5681 | | | | | | |
| CONECT | 5681 | 5680 | 5665 | 5677 | 5682 | | | | | | |
| CONECT | 5682 | 5681 | 5671 | | | | | | | | |
| CONECT | 5683 | 5679 | 5684 | 5692 | | | | | | | |
| CONECT | 5684 | 5683 | 5666 | 5685 | | | | | | | |
| CONECT | 5685 | 5684 | 5686 | | | | | | | | |
| CONECT | 5686 | 5685 | 5688 | 5692 | | | | | | | |
| CONECT | 5687 | 5668 | 5667 | 5688 | | | | | | | |
| CONECT | 5688 | 5687 | 5686 | 5689 | | | | | | | |
| CONECT | 5689 | 5688 | 5690 | | | | | | | | |
| CONECT | 5690 | 5669 | 5689 | 5691 | | | | | | | |
| CONECT | 5691 | 5690 | 5692 | | | | | | | | |
| CONECT | 5692 | 5683 | 5686 | 5691 | | | | | | | |
| CONECT | 5693 | 5670 | 5694 | 5695 | 5696 | | | | | | |
| CONECT | 5694 | 5693 | | | | | | | | | |
| CONECT | 5695 | 5693 | | | | | | | | | |
| CONECT | 5696 | 5693 | 5697 | | | | | | | | |
| CONECT | 5697 | 5696 | 5698 | 5699 | 5700 | | | | | | |
| CONECT | 5698 | 5697 | | | | | | | | | |
| CONECT | 5699 | 5697 | | | | | | | | | |
| CONECT | 5700 | 5697 | | | | | | | | | |
| END | | | | | | | | | | | |

Due to sortware incompatabilities with negative residue numbering, residues in the model in Table 6 are numbered in column 5 with an extra 1000 added. Since protein numbering convention does not include a zero, residue 1000 given in column 5 of Table 6 would correspond to −1, residue 999 to −2, residue 998 to −3, and so on. In the same light, residue 1001 corresponds to amino acid residue 1, residue 1002 corresponds to amino acid residue 2, and so on.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

### BIBLIOGRAPHY

Allen et al., Hepatology 27(6): 1670-1677, 1998
Bartenschlager and Schaller, EMBO J. 7: 4185-4192, 1992
Bartholomesuz et al., Viral Hepatitis Reviews 4: 167-187, 1998
Chang et al., Proc. Natl. Acad. Sci. USA 87: 5158-5162, 1990
Coates et al., Antimicrob. Agents Chemother. 36: 733-739, 1992
Das et al., J. Virol. 75(10): 4771-4779, 2001
Dienstag et al., N. Engl. J. Med. 341: 1256-1263, 1999
Doong et al., Proc. Natl. Acad. Sci. USA 88: 8495-8499, 1991
Fiser et al., Protein Science 9: 1753-1773, 2000
Gardsvoll et al., J Biol. Chem. 274(53): 37995-38003, 1999
Georgiadis et al., Structure 3: 879, 1995
Hoyer-Hansen et al., FEBS Lett. 420(1): 79-85, 1997
Jarvis and Faulds, Drugs 58: 101-141, 1999
Jones, Threader 2; 2.5 ed.: Department of Biological Sciences, University of Warwick
Khan et al., Biochem Biophys Res Commun. 299(3):438-45, 2002
Lanford et al., J. Virol. 73: 1885-1893, 1999
Lesburg et al., Nat. Struct. Biol. 6(10): 937-943, 1999
Liaw et al., Hepatology 30: 567-572, 1999
Mack et al., J. Virol. 62: 4786-4790, 1988
Nakamura et al., Science 277: 955-959, 1997
Ploug et al., Biochemistry 33(30): 8991-8997, 1994
Ploug et al., Biochemistry 34(39): 12524-12534, 1995
Ploug et al., Biochemistry 37(11): 3612-3622, 1998
Ploug, Biochemistry 37(47): 16494-16505, 1998
Poch et al., European Molecular Biology Organisation 8: 3867-3874, 1989
Radziwil et al., J. Virol. 64: 613-620, 1990
Rodgers et al., Proc. Natl. Acad. Sci. USA 92(4): 1222-1226, 1995
Sali and Blundell, Journal of Molecular Biology 234: 779-815, 1993
Sawaya et al., Science 264(5167): 1930-1935, 1994
Stephens et al., Biochemistry 31: 7572-7579, 1992
Stuyver et al., Hepatology 33(3): 751-757, 2001
Tavis et al., J. Virol. 72: 5789-5796, 1998
Toh et al., Nature 305: 827-829, 1983
Trips Sybyl; version 6.8 ed.: 1699 South Hanley Road, St Louis, Mo., 63144, USA
Urban et al., J. Gen. Virol. 79: 1121-1131, 1998
Wrobel et al., Proc. Natl. Acad. Sci. USA 95(2): 638-645, 1998
Wulfing et al., Biol. Chem. 269(4):2895-901, 1994
Xiong and Eickbush, EMBO J. 9(10): 3353-3362, 1990
Zhu et al., Antimicrob. Agents Chemother. 42: 1805-1810, 1998

We claim:

1. A method for identifying the spatial position of an amino acid adjacent to an amino acid mutation conferring resistance to a DNA polymerase antagonist within a reverse transcriptase domain of a DNA polymerase from a Hepatitis B virus (HBV), said method comprising:
comparing the atomic coordinates of a DNA polymerase from an HBV of genotype D as set forth in Table 6 with a mutation selected from the group consisting of: rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, s110V/I, sY134N, sW172STOP/W, K32M/F/P/S/T/W/Y/V/A/R/N/D/C/Q/E/G/H/I/L/deletion; N33D/C/Q/E/G/H/mL/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H90I/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion; and
identifying the amino acids that are spatially adjacent to the mutated amino acid.

2. The method of claim 1, wherein the variant HBV polymerase comprises a mutation at a position selected from the list consisting of:
rtA21, rtA38, rtY54, rtN76, rtL91, rtF122, rtY124, rtT128, rtQ130, rtT184, rtM204, rtS202, rtH248, rtY252, rtS21, rtN/S/T/I/V53, rtY54, rtS57, rtL91, rtS116, rtL122, rtF122, rtN124, rtY124 rtH126, rtY126, rtT128N, rtP130, rtD131, rtV134, rtY135, rtY141, rtL145, rtF151, rtL180, rtA181, rtS202, rtI204, rtK212, rtL217, rtS219, rtI235, rtN236, rtN238, sP120, sM125, sS126, sT127, sT118, sM133, sM133, sF134, sS143, sD144, sG145, sW172, sI195, sS207, sY225, spacerL97, spacerK115, spacerH116, spacerL128, spacerS137, spacerR139, spacerF142, rtA97, rtH126, rtS135, rtM204, PreS1 N114, PreS1 T115, PreS2 F22, PreS2 V39, PreS2 P52, sL89, sT118, sF161, sE164, sI195, sI208, PreS1 E86, PreS1 N91, PreS2 P41, sQ30, sP120, sL176, sV194, rtS21, rtL122, rtN124, rtH126, rtP130, rtD131, rtY135, rtN/S/T/I/V53, rtY126, rtS202, rtI204, rtI235, sM125, sT127, sT118, sM133, sF134, sI195, sS207, sY225, rtG172, rtG174, rtP177, rtL180, rtT184, sR160, sE164, sF170, sL175, sQ181, sC/W182, sW196, sW196, sW196, sM198, sW199, sS204, sY206, sS210, sS210, sL216, sY255, rtL77, rtL77, rtL80, rtL80, rtH90, rtS117, rt125, rt128, rtQ125, rtQ125, rtY126Q, rtL128, rtT128, rtL132, rtN134, rtS137, rtN139, rtN139, rtY141, rtV/G142, rtL147, rtK149, rtG153, rtR153, rtW153, rtW153, rtF166, rtI169, rtF178, rtI187, rtI187, rtV191, rtV191, rtN202, rtS202, rtS202, rtS213, rtV/G214, rtS219, rtS219, rtN/Q238, rtN/S/H238, rtN/S/H/T238, rtR242, rtR242, rtN248, rtI253, s118-207, s117-120, sI68, sC69, sL109, sG112, sS17, sT118, sK122, sT123, sT126, sT131, sN131, sM133, sM133, sY/F134, sC139, sK141, sD144, sG145, rtT128, rtL82, rtT135, rtT150, rtV163, rtT184, rtA200, rtF202, rtS213, rtQ215, rtS219, rtA222, rtI224, rtL229, rtL235, rtN238, rtS78, rt116DEL122, rtI163, rtL180, rtE8, rtV23, rtD31, rtY53, rtV58, rtA/S21, rtV/I/N/S/T53, rtV/I/N/S/T53, rtS/T/N/H/A54, PreS2 L11, PreS2 R17, DEL PreS2 18-21, PreS2 T30, PreS2 N54, sT13, PreS2 Q1, PreS2 Q1, rtH90, rtL/F108, rtL157, rtA181, rtV207, rtP109, rtN/H/A/S/Q238, s181, sP214, sF83, sL173, sW199, sI126, sK160, sS174, sA84, sS210, sC69, sC76, si110, sY134 or sW172.

3. The method of claim 1, wherein the DNA polymerase antagonist is a nucleoside to nucleotide analog and is selected from the group consisting of: ADV, LMV, FCV, FTC, ETV, DAPD, TDF and DXG.

4. A computer-assisted method to identify a potential HBV DNA polymerase antagonist comprising the steps of:
(a) inputting into a progammed computer data comprising atomic co-ordinates of a wild-type HBV polymerase of genotype D as set forth in Table 6;
(b) identifying a spatially adjacent amino acid in a variant HBV DNA polymerase, wherein the variant is a mutation selected from the group consisting of: rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T15S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP13.0Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
said variant exhibiting resistance to a DNA polymerase antagonist;
(c) generating, using computer methods, a set of atomic co-ordinates of a structure that possesses stereochemical complementarity to the atomic co-ordinates defined in (a) or a subset thereof, thereby generating a criteria data set;
(d) inputting, using the processor, the criteria data set to a computer database of chemical structures;
(e) selecting from the database, using computer methods, chemical structures that are similar to the criteria data set; and
(f) outputting the selected chemical structures that are similar to a portion of the criteria data set;
wherein the chemical structures are putative antagonists of the HBV polymerases.

5. The computer-assisted method of claim 4, further comprising the step of obtaining the putative antagonists having a chemical structure selected in steps (e) and (f) and testing the antagonist or the ability to modulate at least one functional activity of an HBV polymerase.

6. A computer or a software component thereof that produces a three-dimensional representation of a molecule or molecular complex, which comprises a three-dimensional representation of a homolog of the molecule or molecular complex, which comprises a three-dimensional representation of a homolog of the molecule or molecular complex, in which the homolog comprises a domain that has a root mean square deviation from the backbone atoms of the amino acids of not more than 1.5 Å, in which the computer comprises:
(a) a machine-readable data storage medium comprising a data storage material encoded with machine-readable data, wherein the data comprises the structure co-ordinates of an HBV polymerase of genotype D as set forth in Table 6;
(b) identifying spatially adjacent amino acids in a variant HBV polymerase selected from the group consisting of: rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, s1195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL801, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/mL/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/mL/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
said DNA polymerase exhibiting resistance to an antagonist;
(c) a working memory for storing instructions for processing the machine-readable data;
(d) a central-processing unit coupled to the working memory and to the machine-readable data storage medium for processing the machine-readable data into the three-dimensional representation; and
(e) a display coupled to the central-processing unit for displaying the three-dimensional representation.

7. A computer or a software component thereof that determines the structure co-ordinates corresponding to a three-dimensional structure of a molecule or molecular complex comprising an HBV polymerase, said computer comprises:
(a) a machine-readable data storage medium comprising a data storage material encoded with machine-readable data, in which the data comprises at least a portion of the structural co-ordinates of a wild-type HBV polymerase as defined in Table 6;
(b) identifying spatially adjacent amino acid in a variant HBV polymerase ahving a mutation selected from the group consisting of: rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, si110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
said variant DNA polymerase exhibiting resistance to an antagonist;
(c) a machine-readable data storage medium comprising a data storage material encoded with machine-readable data, wherein the data comprises atomic co-ordinates of differences between the wild type and variant HBV DNA polymerase;
(d) a working memory for storing instructions for processing the machine-readable data of (a) and (b) and (c);
(e) a central-processing unit coupled to the working memory and to the machine-readable data storage medium of (a) and (b) for performing a transformation of the machine readable data of (a) and for processing the machine-readable data of (b) into structure co-ordinates; and
(f) a display coupled to the central-processing unit for displaying the structure co-ordinates of the molecule or molecular complex.

8. A computer-assisted method to identify or design HBV DNA polymerase antagonists that bind to a domain of HBV polymerase comprising the steps of:
(a) inputting into a progammed computer data comprising the atomic co-ordinates of a wild-type HBV polymerase as set forth in Table 6;
(b) identifying a spatially adjacent amino acid from a variant HBV DNA polymerase selected from the group consisting of: 28-36, 39-45, 59-66, 69-70, 73-93, 167-184, 198-213, 230-241 and 245-257 and/or at position numbers 4-10, 24-27, 46-58, 67-68, 71-72, 94-120, 165-166, 185-197, 214-227, 242-244 and 258-266;
said variant exhibiting resistance to an antagonist;
(c) generating, using computer methods, a set of atomic co-ordinates of the variant thereby generating a criteria data set;
(d) with a processor, screening a database of chemical strctures that meet the criteria data set; and
(e) outputting the selected chemical structures that are similar to the criteria data set.

9. An antagonist identified by the method of claims 6-8 that interacts with an HBV polymerase.

10. The antagonist of claim 9, wherein the agent inhibits or reduces the activity of the HBV polymerase.

11. The antagonist of claim 9, wherein the antagonist is a nucleoside or nucleotide analog.

12. The antagonist of claim 11, wherein the antagonist is a nucleotide analog.

13. The antagonist of claim 11, wherein the nucleoside or nucleotide analog is selected from the group consisting of: ADV, LM, FCV, FTC, ETV, DAPD, TDF and DXG.

14. The antagonist of claim 9, wherein the HBV polymerase comprises a mutation at amino acid residue position numbers selected from the group consisting of: 28-36, 39-45, 59-66, 69-70, 73-93, 167-184, 198-213, 230-241 and 245-257 of the rt domain.

15. The antagonist of claim 9, wherein the HBV polymerase comprises a mutation at amino acid residue position numbers selected from the group consisting of: 4-10, 24-27, 46-58, 67-68, 71-72, 94-120, 165-166, 185-197, 214-227, 242-244 and 258-266 of the rt domain.

16. The antagonist of claim 9, wherein the HBV polymerase comprises a mutation at selected from the group consisting of:
rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T15, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM1981, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, s118-207, s117-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, s110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35V/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A/R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/Y/V/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion.

17. The antagonist of claim 9, wherein the HBV polymerase comprises a mutation selected from the group consisting of: rtA21, rtA38, rtY54, rtN76, rtL91, rtF122, rtY124, rtT128, rtQ130, rtT184, rtM204, rtS202, rtH248, rtY252, rtS21, rtN/S/T/I/V53, rtY54, rtS57, rtL91, rtS116, rtL122, rtF122, rtN124, rtY124 rtH126, rtY126, rtT128N, rtP130, rtD131, rtV134, rtY135, rtY141, rtL145, rtF151, rtL180, rtA181, rtS202, rtI204, rtK212, rtL217, rtS219, rtI235, rtN236, rtN238, sP120, sM125, sS126, sT127, sT118, sM133, sM133, sF134, sS143, sD144, sG145, sW172, sI195, sS207, sY225, spacerL97, spacerK115, spacerH116, spacerL128, spacerS137, spacerR139, spacerF142, rtA97, rtH126, rtS135, rtM204, PreS1 N114, PreS1 T115, PreS2 F22, PreS2 V39, PreS2 P52, sL89, sT118, sF161, sE164, sI195, sI208, PreS1 E86, PreS1 N91, PreS2 P41, sQ30, sP120, sL176, sV194, rtS21, rtL122, rtN124, rtH126, rtP130, rtD131, rtY135, rtN/S/T/I/V53, rtY126, rtS202, rtI204, rtI235, sM125, sT127, sT118, sM133, sF134, sI195, sS207, sY225, rtG172, rtG174, rtP177, rtL180, rtT184, sR160, sE164, sF170, sL175, sQ181, sC/W182, sW196, sW196, sW196, sM198, sW199, sS204, sY206, sS210, sS210, sL216, sY255, rtL77, rtL77, rtL80, rtL80, rtH90, rtS117, rt125, rt128, rtQ125, rtQ125, rtY126Q, rtL128, rtT128, rtL132, rtN134, rtS137, rtN139, rtN139, rtY141, rtV/G142, rtL147, rtK149, rtG153, rtR153, rtW153, rtW153, rtF166, rtI169, rtF178, rtI187, rtI187, rtV191, rtV191, rtN202, rtS202, rtS202, rtS213, rtV/G214, rtS219, rtS219, rtN/Q238, rtN/S/H238, rtN/S/H/T238, rtR242, rtR242, rtN248, rtI253, s118-207, s117-120, sI68, sC69, sL109, sG112, sS17, sT118, sK122, sT123, sT126, sT131, sN131, sM133, sM133, sY/F134, sC139, sK141, sD144, sG145, rtT128, rtL82, rtT135, rtT150, rtV163, rtT184, rtA200, rtF202, rtS213, rtQ215, rtS219, rtA222, rtI224, rtL229, rtL235, rtN238, rtS78, rt116DEL122, rtI163, rtL180, rtE8, rtV23, rtD31, rtY53, rtV58, rtA/S21, rtV/I/N/S/T53, rtV/I/N/S/T53, rtS/T/N/H/A54, PreS2 L11, PreS2 R17, DEL PreS2 18-21, PreS2 T30, PreS2 N54, sT13, PreS2 Q1, PreS2 Q1, rtH90, rtL/F108, rtL157, rtA181, rtV207, rtP109, rtN/H/A/S/Q238, s181, sP214, sF83, sL173, sW199, sI126, sK160, sS174, sA84, sS210, sC69, sC76, si110, sY134 and sW172.

18. The antagonist of claim 9, wherein the antagonist is used therapeutically to inhibit HBV replication.

19. The antagonist of claim 9, wherein the antagonist is used diagnostically.

20. A composition comprising the antagonist of claim 9, together with one or more pharmaceutically acceptable carriers and/or diluents.

21. A method of identifying an agent capable of interacting with a variant DNA polymerase or from an HBV resistant to a DNA polymerase antagonist, the variant comprising a mutation selected from the group consisting of: rtA21S, rtA38E, rtY54H, rtN76D, rtL91I, rtF122L, rtY124H, rtT128N, rtQ130P, rtT184G, rtM204V/I, rtS202I, rtH248N, rtY252L, rtS21A, rtN/S/T/I/V53D, rtY54H, rtS57P, rtL91I, rtS116P, rtL122F, rtF122L, rtN124H, rtY124H, rtH126R, rtY126Q, rtT128N, rtP130Q, rtD131N, rtV134D, rtY135C, rtY141Y/F, rtL145M, rtF151T/F, rtL180M, rtA181T, rtS202G, rtI204V, rtK212R, rtL217R, rtS219A, rtI235I/M, rtN236T, rtN238D, sP120T, sM125T, sS126T, sT127A, sT118R, sM133L/M, sM133T, sF134V, sS143S/T, sD144A, sG145A, sW172Stop, sI195M, sS207R, sY225Y/C, spacerL97I, spacerK115R, spacerH116L, spacerL128F, spacerS137G, spacerR139G, spacerF142S, rtA97V, rtH126R, rtS135Y, rtM204I, PreS1 N114D, PreS1 T115S, PreS2 F22L, PreS2 V39A, PreS2 P52L, sL89V, sT118A, sF161L, sE164D, sI195M, sI208T, PreS1 E86Q, PreS1 N91K, PreS2 P41H, sQ30K, sP120T, sL176V, sV194F, rtS21A, rtL122F, rtN124H, rtH126R, rtP130Q, rtD131N, rtY135C, rtN/S/T/I/V53D, rtY126Q, rtS202G, rtI204V, rtI235I/M, sM125T, sT127A, sT118R, sM133T, sF134V, sI195M, sS207R, sY225Y/C, rtG172E, rtG174C, rtP177L, rtL180V, rtT184S, sR160N, sE164D, sF170L, sL175L/S, sQ181E/G/Q, sC/W182Y/STOP, sW196L, sW196S, sW196STOP, sM198I, sW199S, sS204T, sY206N, sS210K, sS210R, sL216STOP, sY255F, rtL77L/F, rtL77L/M/V, rtL80I, rtL80V, rtH90N/H, rtS117S/Y, rt125DELrt128, rtQ125K, rtQ125N, rtY126Q, rtL128L/M, rtT128A, rtL132L/M, rtN134G, rtS137T, rtN139H, rtN139K, rtY141Y/STOP, rtV/G142L, rtL147L/W, rtK149R, rtG153E, rtR153Q, rtW153S, rtW153Q, rtF166L, rtI169L, rtF178F/L, rtI187L, rtI187I/V, rtV191I, rtV191V/I, rtN202S, rtS202S/C, rtS202G, rtS213T, rtV/G214E, rtS219A, rtS219P, rtN/Q238H, rtN/S/H238N/K, rtN/S/H/T238/T/A/S/L, rtR242R/K, rtR242R/S, rtN248H, rtI253A, sI18-207, si17-120DEL, sI68I/M, sC69F/L, sL109I/L, sG112R, sS17T, sT118R, sK122R, sT123P, sT126S, sT131N, sN131T, sM133K/M, sM133I, sY/F134S, sC139C/G, sK141E, sD144E, sG145R, rtT128T/I, rtL82M, rtT135C, rtT150A, rtV163I, rtT184S, rtA200V, rtF202V, rtS213T, rtQ215H, rtS219A, rtA222T, rtI224S, rtL229M, rtL235I, rtN238S, rtS78T, rt116DEL122, rtI163V, rtL180V, rtE8A, rtV23I, rtD31D/G, rtY53D, rtV58V/I, rtA/S21T, rtV/I/N/S/T53D, rtV/I/N/S/T53Y, rtS/T/N/H/A54Y/H, PreS2 L11L/A, PreS2 R171, DEL PreS2 18-21, PreS2 T30A, PreS2 N54H, sT13T/A, PreS2 Q1V, PreS2 Q1M, rtH90D, rtL/F108L, rtL157L/M, rtA181V, rtV207I, rtP109S, rtN/H/A/S/Q238K, s181M, sP214Q, sF83S, sL173F, sW199L, sI126T, sK160R, sS174N, sA84V, sS210N, sC69STOP/C, sC76Y, s1110V/I, sY134N, sW172STOP/W, K32M/F/P/S/T/W/Y/V/A/R/N/D/C/Q/E/G/H/I/L/deletion; N33D/C/Q/E/G/H/I/L/K/M/F/P/S/T/W/Y/V/A/R/deletion; P34S/T/W/Y/V/A/R/N/D/C/Q/E/G/H/I/L/K/M/F/deletion; H35I/L/K/M/F/P/S/T/W/Y/V/A/R/N/D/C/Q/E/G/deletion; T37W/Y/V/A/R/N/D/C/Q/E/G/H/I/L/K/M/F/P/S/deletion; P59S/T/W/Y/V/A/R/N/D/C/Q/E/G/H/I/L/K/M/F/deletion; K60M/F/P/S/T/W/Y/V/A/R/N/D/C/Q/E/G/H/I/L/deletion; F61P/S/T/W/Y/V/A/R/N/D/C/Q/E/G/H/I/L/K/M/deletion; A62R/N/D/C/Q/E/G/H/I/L/K/M/F/P/S/T/W/Y/V/deletion; V63A/R/N/D/C/Q/E/G/H/I/L/K/M/F/P/S/T/W/Y/deletion; D83C/Q/E/G/H/I/L/K/M/F/P/S/T/W/Y/V/A/R/N/deletion; V84A/R/N/D/C/Q/E/G/H/I/L/K/M/F/P/S/T/W/Y/deletion; S85T/W/Y/V/A/R/N/D/C/Q/E/G/H/I/L/K/M/F/P/deletion; A86R/N/D/C/Q/E/G/H/I/L/K/M/F/P/S/T/W/YV/deletion; Y89V/A R/N/D/C/Q/E/G/H/I/L/K/M/F/P/S/T/W/deletion; H901/L/K/M/F/P/S/T/W/Y/V/A/R/N/D/C/Q/E/G/deletion; I/L91K/M/F/P/S/T/W/Y/V/A/R/N/D/C/Q/E/G/H/deletion; P177S/T/W/Y/V/A/R/N/D/C/Q/E/G/H/I/L/K/M/F/deletion; F178P/S/T/W/Y/V/A/R/N/D/C/Q/E/G/H/I/L/K/M/deletion; L179K/M/F/P/S/T/W/Y/V/A/R/N/D/C/Q/E/G/H/I/deletion; L180K/M/F/P/S/T/W/Y/V/A/R/N/D/C/Q/E/G/H/I/deletion; A181R/N/D/C/Q/E/G/H/I/L/K/M/F/P/S/T/W/Y/V/deletion; Q183E/G/H/I/L/K/M/F/P/S/T/W/Y/V/A/R/N/D/C/deletion; F183P/S/T/W/Y/V/A/R/N/D/C/Q/E/G/H/I/L/K/M/deletion; T184W/Y/V/A/R/N/D/C/Q/E/G/H/I/L/K/M/F/P/S/deletion; Y203V/A/R/N/D/C/Q/E/G/H/I/L/K/M/F/P/S/T/W/deletion; M204F/P/S/T/W/Y/V/A/R/N/D/C/Q/E/G/H/I/L/K/deletion; L235K/M/F/P/S/T/W/Y/V/A/R/N/D/C/Q/E/G/H/I/deletion; N236D/C/Q/E/G/H/I/L/K/M/F/P/S/T/W/Y/V/A/R/deletion; T237W/Y/V/A/R/N/D/C/Q/E/G/H/I/L/K/M/F/P/S/deletion; P237S/T/W/Y/V/A/R/N/D/C/Q/E/G/H/I/L/K/M/F/deletion; N238D/C/Q/E/G/H/I/L/K/M/F/P/S/T/W/Y/V/A/R/deletion; H238I/L/K/M/F/P/S/T/W/Y/V/A/R/N/D/C/Q/E/G/deletion; A238R/N/D/C/Q/E/G/H/I/L/K/M/F/P/S/T/W/YV/deletion; S239T/W/Y/V/A/R/N/D/C/Q/E/G/H/I/L/K/M/F/P/deletion; Q238E/G/H/I/L/K/M/F/P/S/T/W/Y/V/A/R/N/D/C/deletion; K239M/F/P/S/T/W/Y/V/A/R/N/D/C/Q/E/G/H/I/L/deletion; L247K/M/F/P/S/T/W/Y/V/A/R/N/D/C/Q/E/G/H/I/deletion; N248D/C/Q/E/G/H/I/L/K/M/F/P/S/T/W/Y/V/A/R/deletion; H248I/L/K/M/F/P/S/T/W/Y/V/A/R/N/D/C/Q/E/G/deletion; F249P/S/T/W/Y/V/A/R/N/D/C/Q/E/G/H/I/L/K/M/deletion; M250F/P/S/T/W/Y/V/A/R/N/D/C/Q/E/G/H/I/L/K/deletion; G251H/I/L/K/M/F/P/S/T/W/Y/V/A/R/N/D/C/Q/E/deletion; and V251A/R/N/D/C/Q/E/G/H/I/L/K/M/F/P/S/T/W/Y/deletion;
the method comprising:
(a) mapping a mutation in the variant HBV polymerase to a wild-type HBV DNA polymerase as defined in atomic coordinates as set forth in Table 6; and
(b) designing an agent to interact with an HBV DNA polymerase having a chainge in the coordinates.

22. The method of claim 21, wherein the variant HBV DNA polymerase comprises a mutation at a position selected from the group consisting of: rtA21, rtA38, rtY54, rtN76, rtL91, rtF122, rtY124, rtT128, rtQ130, rtT184, rtM204, rtS202, rtH248, rtY252, rtS21, rtN/S/T/I/V53, rtY54, rtS57, rtL91, rtS116, rtL122, rtF122, rtN124, rtY124 rtH126, rtY126, rtT128N, rtP130, rtD131, rtV134, rtY135, rtY141, rtL145, rtF151, rtL180, rtA181, rtS202, rtI204, rtK212, rtL217, rtS219, rtI235, rtN236, rtN238, sP120, sM125, sS126, sT127, sT118, sM133, sM133, sF134, sS143, sD144, sG145, sW172, sI195, sS207, sY225, spacerL97, spacerK115, spacerH116, spacerL128, spacerS137, spacerR139, spacerF142, rtA97, rtH126, rtS135, rtM204, PreS1 N114, PreS1 T115, PreS2 F22, PreS2 V39, PreS2 P52, sL89, sT118, sF161, sE164, sI195, sI208, PreS1 E86, PreS1 N91, PreS2 P41, sQ30, sP120, sL176, sV194, rtS21, rtL122, rtN124, rtH126, rtP130, rtD131, rtY135, rtN/S/T/I/V53, rtY126, rtS202, rtI204, rtI235, sM125, sT127, sT118, sM133, sF134, sI195, sS207, sY225, rtG172, rtG174, rtP177, rtL180, rtT184, sR160, sE164, sF170, sL175, sQ181, sC/W182, sW196, sW196, sW196, sM198, sW199, sS204, sY206, sS210, sS210, sL216, sY255, rtL77, rtL77, rtL80, rtL80, rtH90, rtS117, rt125, rt128, rtQ125, rtQ125, rtY126Q, rtL128, rtT128, rtL132, rtN134, rtS137, rtN139, rtN139, rtY141, rtV/G142, rtL147, rtK149, rtG153, rtR153, rtW153, rtW153, rtF166, rtI169, rtF178, rtI187, rtI187, rtV191, rtV191, rtN202, rtS202, rtS202, rtS213, rtV/G214, rtS219, rtS219, rtN/Q238, rtN/S/H238, rtN/S/H/T238, rtR242, rtR242, rtN248, rtI253, s118-207, s117-120, sI68, sC69, sL109, sG112, sS17, sT118, sK122, sT123, sT126, sT131, sN131, sM133, sM133, sY/F134, sC139, sK141, sD144, sG145, rtT128, rtL82, rtT135, rtT150, rtV163, rtT184, rtA200, rtF202, rtS213, rtQ215, rtS219, rtA222, rtI224, rtL229, rtL235, rtN238, rtS78, rt116DEL122, rtI163, rtL180, rtE8, rtV23, rtD31, rtY53, rtV58, rtA/S21, rtV/I/N/S/T53, rtV/I/N/S/T53, rtS/T/N/H/A54, PreS2 L11, PreS2 R17, DEL PreS2 18-21, PreS2 T30, PreS2 N54, sT13, PreS2 Q1, PreS2 Q1, rtH90, rtL/F108, rtL157, rtA181, rtV207, rtP109, rtN/H/A/S/Q238, s181, sP214, sF83, sL173, sW199, sI126, sK160, sS174, sA84, sS210, sC69, sC76, si110, sY134 and sW172.

23. The method of claim 22, wherein the variant HBV DNA polymerase is resistant to a nucleoside or nucleotide analog.

24. The method of claim 23, wherein the nucleoside or nucleotide analog is selected from the group consisting of: ADV, LM, FCV, FTC, ETV, DAPD, TDF and DXG.

25. Use of an HBV DNA polymerase comprising amino acid residues selected from the group consisting of: (i) rtE1, rtH12, rtH13, rtH160, rtA162; (ii) rtC-9, rtH-6, rtH90, rtL93, rtH234; and (iii) rtH197, rtC198, rtH216 and rtC213, the amino acid residues defining a metal binding site in the screening of a medicament that inhibits DNA polymerase activity.

26. The use of claim 25, further comprising amino acid residues 205 and 206 and/or amino acid residue 33.

27. A method for screening for an agent capable of binding to and/or inhibiting an BHV polymerase, the method comprising: identifying a compound that is capable of binding, associating with or otherwise interacting with a region of an HBV polymerase selected from the group consisting of:
(i) rtE1, rtH12, rtH13, rtH160 and rtA162;
(ii) rtC-9, rtH-6, rtH90, rtL93, rtH234; and
(iii) rtH197, rtC198, rtH216 and rtC213
wherein said region is a metal ion binding site.

28. The method of claim 27, wherein the agent is further capable of binding to a region of the HBV DNA polymerase defined by amino acid residues 205 and 26 and/or amino acid residue 83.

29. The method of claim 27, wherein the agent inhibits or reduces the binding of a metal ion to a region or near amino acid residues selected from the group consisting of:
(i) rtE1, rtH12, rtH13, rtH160 and rtA162;
(ii) rtC-9, rtH-6, rtH90, rtL93, rtH234; and
(iii) rtH197, rtC198, rtH216 and rtC213
wherein said region is a metal ion binding site.

30. The method of claim 27, wherein the agent inhibits or reduces the activity or reduces the activity of HBV polymerase.

31. An isolated agent identified by the method of claim 27.

32. A vaccine comprising an agent of claim 27 and one or more pharmaceutically acceptable carriers and/or diluents.

33. A diagnostic agent comprising a molecule capable of binding, associating with or interacting with a region of an HBV DNA polymerase defined at or near amino acid residues selected from the group consisting of:
(i) rtE1, rtH12, rtH13, rtH160 and rtA162;
(ii) rtC-9, rtH-6, rtH90, rtL93, rtH234; and
(iii) rtH197, rtC198, rtH216 and rtC213,
wherein said region is a metal ion binding site.

34. The diagnostic agent of claim 33 linked or coupled to a reporter molecule.

35. The diagnostic agent of claim 34, wherein the reporter molecule is or is coupled to an antibody or antigen-binding fragment thereof.

36. A method of detecting an HBV, the method comprising screening for binding of the diagnostic agent of claim 33.
